(19) United States
(12) Patent Application Publication
(10) Pub. No.: US 2002/0115550 A1
(43) Pub. Date: Aug. 22, 2002

(54) Substrate made of glass ceramics

(76) Inventors: Hideki Kawai, Nishinomiya-shi (JP); Toshiharu Mori, Osaka (JP)

Correspondence Address: BURNS DOANE SWECKER & MATHIS L L P, POST OFFICE BOX 1404, ALEXANDRIA, VA, 22313-1404, US

(21) Appl. No.: 09/986,360

(22) Filed: Nov. 8, 2001

(30) Foreign Application Priority Data
Aug. 11, 2000 (JP) 2001-341224
Sep. 11, 2000 (JP) 2001-341442
Sep. 11, 2000 (JP) 2001-341443
Aug. 11, 2000 (JP) 2001-341221
Aug. 11, 2000 (JP) 2001-341222
Aug. 11, 2000 (JP) 2001-341223

(51) Int. Cl. C03C 10/12; C03C 3/097

(52) U.S. Cl. 501/7; 501/63

(57) ABSTRACT

A substrate satisfies following conditional formulas (1) and (2):

0<Co<150 (1)

70<C.T.E<150 (2)

where Co represents the amount [ppb] of migration of alkali metal components with respect to water per substrate for a 2.5-inch disk [ppb], and C.T.E represents a thermal expansion coefficient [×10⁻⁷/?] at 25? to 100?.

### RELATED APPLICATION

This application is based on applications No.2000-341224, 2000-341442, 2000-341443, 2000-341221, 2000-341222 and 2000-341223, filed in Japan, the content of which is hereby incorporated by reference.

### FIELD OF THE INVENTION

The present invention relates to substrates for use in information recording media such as magnetic disks, optical disks and magneto-optical disks, or to a crystallized glass composition and a crystallized glass substrate formed of the same which are particularly suitable for optical filters to be used in optical communication systems or the like.

### DESCRIPTION OF THE PRIOR ART

A magnetic recording device for use in a computer or the like comprises a magnetic recording medium having a magnetic disk as a substrate and a magnetic head for reproducing recorded information as principal elements thereof. Substrates put to practice for use in such magnetic disks include aluminum substrates, glass substrates and like substrates. Among them, glass substrates receive the most attention because they are excellent in surface smoothness and mechanical strength. Of such glass substrates, there are known a chemically reinforced glass substrate having a glass substrate surface reinforced by ion exchange and a crystallized glass substrate having reinforced binding by causing precipitation of crystalline components on a substrate.

Such a chemically reinforced glass substrate, however, involves a problem that it cannot have high strength and high rigidity because of its material characteristics. In contrast, the crystallized glass substrate is receiving attention as a material overcoming the drawbacks of the aluminum substrate and chemically reinforced glass substrate.

Meanwhile, in optical communication systems there has conventionally been used an optical filter having an interference film and exercising the function of a band pass filter which permits only light having a specific wavelength to pass therethrough. Among such optical communication systems, WDM (Wavelength Division Multiplexing) of optical communication, on which attention has been focused recently, is required to accommodate to high density wave by setting very narrow the bandwidth of light having a wavelength permitted to pass through. For this reason, an optical material satisfying predetermined thermal expansion characteristics, mechanical characteristics and ray transmissivity at a time is now desired. Crystallized glass is receiving attention as a material satisfying such requirements.

Such crystallized glass substrates include crystallized glass substrates for magnetic disks having lithium disilicate crystal (Li₂O SiO2) as their predominant crystalline phase, which are proposed in Japanese Laid-Open Patent Application Nos. 11-16142, 11-16143, 10-226532 and 9-208260.

Such a crystallized glass substrate having lithium disilicate crystal (Li₂O SiO2) as its predominant crystalline phase has a feature that it has a high expansion coefficient, which is close to the thermal expansion coefficient of a stainless steel material forming a chucking member used in incorporating the substrate into an apparatus. Therefore, such a crystallized glass substrate is characterized that the substrate in a state incorporated as a magnetic disk in an apparatus is hard to crack even when heated by a motor rotating the disk or the like. Crystallized glass having lithium disilicate crystal (Li2C) SiO2) as its predominant crystalline phase, however, suffers from a problem that it has a very large value of corrosion (paricularly a large migration of alkali metal components from the substrate). Such a large migration of alkali metal components causes a protective layer or magnetic recording layer formed on the crystallized glass substrate to be eroded by the alkali metal components, thus lowering the smoothness of the magnetic disk or deteriorating the protective layer or magnetic recording layer by modification.

Japanese Laid-Open Patent Application Nos. 9-100137 and 6-206736 propose crystallized glass substrates having crystal of either mullite or cordierite as their predominant crystalline phase,

Such a crystallized glass substrate having crystal of either mullite or cordierite as its predominant crystalline phase, however, has a low thermal expansion coefficient though its corrosiveness due to alkali metal components is low. Therefore, it is possible that such a crystallized glass substrate in a state incorporated as a magnetic disk in an apparatus cracks when heated by a motor rotating the disk or the like. Further, the crystallized glass substrate having crystal of either mullite or cordierite as its predominant crystalline phase has an additional problem of very poor workability in smoothing the substrate.

### SUMMARY OF THE INVENTION

An object of the present invention is to provide an improved crystallized glass substrate.

A further object of the present invention is to provide a crystallized glass substrate which has a high thermal expansion coefficient and satisfactory workability while causing less corrosion due to its alkali metal components.

### DESCRIPTION OF THE PREFERRED EMBODIMENT

Hereinafter, embodiments of the present invention will be described.

A crystallized glass substrate according to each embodiment of the present invention satisfies the following conditional formula (1):

0<Co<150 (1)

where Co represents the amount [ppb] of migration of alkali metal components with respect to water per substrate for a 2.5-inch disk [ppb].

The conditional formula (1) specifies the range of the amount of migration of alkali metal components from the substrate to water. The value of corrosion due to alkali metal components is represented by the amount [ppb] of alkali metal components eluted with respect to water per substrate for a 2.5-inch disk. Migration of alkali metal components in an amount of more than 150 [ppb] is not desirable because the alkali metal components erode the protective layer or magnetic recording layer formed on the crystallized glass substrate thereby markedly lowering the smoothness of the magnetic disk or heavily deteriorating the protective layer or magnetic recording layer by modification. Particularly, a crystallized glass substrate with the amount of migration in a range exceeding 150 [ppb] is not desirable because it allows its alkali metal components to be eluted in too large an amount so that the protective layer or magnetic layer formed on the substrate is heavily eroded.

A crystallized glass substrate according to each embodiment of the present invention satisfies the following conditional formula (2):

70<C.T.E<150 (2)

where C.T.E represents a thermal expansion coefficient [×10] at 25 to 100.

The conditional formula (2) determines a condition related to thermal expansion and specifies the range to be satisfied by the crystallized glass substrate as the value range of thermal expansion coefficient [×10⁻⁷/] at 25 to 100 . In recent years, higher precision is required in the positioning of a magnetic head and a magnetic recording medium (crystallized glass substrate) with increasing recording density of the magnetic recording medium and, hence, higher size precision is required for not only the crystallized glass substrate but also other constituents. Further, differences in thermal expansion coefficient between the crystallized glass substrate and other constituents cannot be neglected in maintaining such a high size precision. In the case of magnetic recording apparatus, many constituents are frequently formed of stainless metal materials, which generally have thermal expansion coefficients [×10/] at 25 to 100 ranging between 90×10⁻⁷/ and 100×10⁻⁷/. It is therefore desirable that the crystallized glass substrate have a thermal expansion coefficient corresponding to this range. That is, a crystallized glass substrate having a thermal expansion coefficient of more than the upper limit or less than the lower limit of the conditional formula (2) is not desirable because the difference in thermal expansion coefficient between the crystallized glass substrate and each of other constituents becomes too large, so that the required size precision cannot be maintained or the crystallized glass substrate may be broken to the worst.

A crystallized glass substrate according to each embodiment of the present invention satisfies the following conditional formula (3):

1.0<P/PLi<1.5 (3)

where P represents the amount of a loss [μg/min] per unit time resulting from grinding or abrading when the substrate is abraded using cerium oxide (average particle diameter: 0.5 μm) as an abrasive under a pressure of 100 g/cm² to attain a surface smoothness of 3 Å; and PLi represents the amount of a loss [μg/min] per unit time resulting from grinding or abrading when a lithium disilicate-type crystallized glass substrate is ground or abraded under the same conditions as above to attain a surface smoothness of 3+.

The conditional formula (3) specifies the processing rate of the crystallized glass substrate of the present invention relative to that of the prior art lithium disilicate-type crystallized glass substrate. If the value of P/PLi is less than the lower limit of the conditional formula (3), the superiority of the substrate of the present invention over the prior art lithium disilicate-type crystallized glass substrate is lost. The value of P/PLi exceeding the upper limit of the conditional formula (3) is not desirable because the probability of breakage (occurrence of crack, pinto, scratch or the like) rises rapidly.

A crystallized glass substrate according to each embodiment of the present invention satisfies the following conditional formula (4):

28<E/ρ<36 (4)

where E represents the Young's modulus [GPa] of the substrate, and p represents the specific gravity of the substrate.

The conditional formula (4) specifies the ratio between the Young's modulus and the specific gravity of the substrate and serves to limit the range of the resonance frequency inherent to the crystallized glass substrate by mainly specifying a physical characteristic of the substrate. The E/ρ value of less than the lower limit of the conditional formula (4) is not desirable because the substrate has too low a resonance frequency and hence raises a problem of resonance with a magnetic recording apparatus while, at the same time, exhibiting lowered rigidity. The E/ρ value of more than the upper limit of the conditional formula (4) is not desirable either, because the substrate has too high a resonance frequency, with the result that versatile designing materials for magnetic recording apparatus become unusable, which necessitating a separate special design. When the E/ρ value is within the range specified by the conditional formula (4), the substrate has a resonance frequency higher than the resonance frequency band of aluminum substrates which has conventionally raised a problem and, hence the resonance frequency of the substrate can be set substantially equal to that of a general-purpose substrate made of a typical glass material. Thus, the sharing of manufacturing equipment can be increased, leading to a cost reduction of magnetic recording apparatus.

The glasses of the present invention may have one or more crystalline phase and amorphous phase. The crystalline phase represent about 50 to 60 percent of the total glass composition. Preferred embodiments include a main crystalline phase of, for example, christbalite, quartz, lithium aluminosilicate, zinc silicate and lithium disilicate which desirably represents at least about 80 percent by weight of the total of all crystalline phases. Preferred embodiments may also include a secondary crystalline phase of, for example christbalite, quartz, lithium aluminosilicate, zinc silicate and lithium disilicate which desirably represents less than about 20 percent by weight of the total crystalline phase. More specific embodiments of the present invention are described below.

[First Embodiment]

A crystallized glass substrate according to the first embodiment contains the following ingredients in respective amounts in % by weight:

about 65% to about 70% by weight SiO₂;

about 3% to about 10% by weight Al₂O₃;

about 3% to about 10% by weight ZnO;

about 4% to about 8% by weight Li₂O;

about 1% to about 5% by weight ZrO₂; and

about 1% to about 5% by weight P₂O₅.

In the system having the glass ingredients stated above, SiO₂ is a glass forming oxide and is a constituent of cristobalite, cristobalite solid solution, quartz and quartz solid solution precipitated as predominant crystalline phases. In the first embodiment, the amount of SiO₂ that is less than 65% by weight is not desirable because the aforementioned crystals are hard to precipitate. The amount of SiO₂ that is more than 70% by weight is not desirable either, because the glass composition has a higher melting point as well as a higher devitrification property and hence exhibits an inferior melting property.

Al₂O₃ is an intermediate oxide of glass and becomes a constituent of crystalline phases of lithium alumincsilicate and lithium aluminosilicate solid solution if precipitated as secondary crystalline phases. In the first embodiment, if the amount of Al₂O₃ is less than 3% by weight, desired mechanical strength and chemical durability cannot be obtained. On the other hand, if it is more than 10% by weight, the glass composition has a higher melting temperature, so that the melting property and devitrification property thereof become inferior.

ZnO serves as a fluxing agent and hence assists in precipitation of homogeneous crystal. In the case where lithium zinc silicate and lithium zinc silicate solid solution precipitate, ZnO becomes a constituent of these crystalline phases. In the first embodiment, if the amount of ZnO is less than 3% by weight, a sufficient improvement in homogenization of crystal is not achieved. On the other hand, if the amount of ZnO is more than 10% by weight, the glass composition becomes stabilized and, hence, crystallization thereof is restrained, resulting in a difficulty in attaining a desired strength.

Li₂O serves as a fluxing agent and hence improves the stability of the glass composition under production. In the case where lithium aluminosilicate, lithium aluminosilicate solid solution, lithium zinc silicate and lithium zinc silicate solid solution precipitate, Li₂O becomes a constituent of these crystalline phases. In the first embodiment, if the amount of Li₂O is less than 4% by weight, the glass composition has an inferior melting property. On the other hand, if the amount of Li₂O is more than 8% by weight, crystalline phases of lithium monosilicate (Li₂O2), lithium disilicate (Li2O SiO2) and the like precipitate as crystalline layers, with the result that the value of corrosion due to aforementioned alkali metal components becomes large, which undesirably causes elution of the alkali metal components from the substrate.

ZrO₂ effectively functions as a nucleating agent as well as a glass modifying oxide. In the first embodiment, if the amount of ZrO₂ is less than 1% by weight, required nucleation does not occur and, further, the chemical durability and the migration resistance of the substrate lower, affecting the magnetic recording layer. If it is more than 5% by weight, on the other hand, the glass composition has a higher melting temperature and is susceptible to devitrification, rendering melt molding difficult. Further, it is possible that resulting crystal grains become coarse, or that a precipitated crystalline phase varies, making it difficult to obtain desired characteristics. Furthermore, a fine and homogeneous crystalline structure cannot be obtained and, hence, an abrading process cannot yield a magnetic disk having a surface with a required smoothness.

P₂O₅ serves as a fluxing agent as well as a nucleating agent causing a silicate-type crystal to precipitate and is an important ingredient for crystal to uniformly precipitate throughout the overall glass. In the first embodiment, if the amount of P₂O₅ is less than 1% by weight, required nucleation does not occur and, further, the chemical durability and the migration resistance of the substrate lower, affecting the magnetic recording layer. If it is more than 5% by weight, on the other hand, the glass composition has a higher melting temperature and is susceptible to devitrification, rendering melt molding difficult. Further, it is possible that resulting crystal grains become coarse, that a precipitated crystalline phase varies, making it difficult to obtain desired characteristics, or that an abrading process cannot yield a magnetic disk having a surface with a required smoothness. Moreover, the reactivity of the glass composition with materials forming a furnace used in the melting process becomes higher and the devitrification property is enhanced as well, resulting in the melt molding process having lowered productivity. In addition, the stability of the glass structure lowers, so that elution of alkali metal components becomes likely.

The crystallized glass substrate manufacturing process proceeds as follows. Raw materials containing major components of a glass substrate to be finally produced are sufficiently mixed together in predetermined proportions and then melted in a platinum or brick crucible. The resulting melt is then cast into a mold to form an approximated shape of an intended substrate, followed by annealing to room temperature. Subsequently, the molded product is kept at a primary heat treatment temperature of 500 to 600 for a primary treatment time (heat treatment) to allow nucleation to occur, followed by being kept at a secondary heat treatment of 600 to 700 for a secondary treatment time to allow crystal nuclei to grow. By subjecting the resultant to slow cooling, intended crystallized glass is obtained.

Further, the crystallized glass is ground or abraded to desired shape and thickness for use as a crystallized glass substrate.

With respect to the crystallized glass substrate defined by the aforementioned essential ingredients according to the first embodiment of the present invention, the ranges specified by the conditional formulae (1) to (4), respectively, are optimized as follows:

30<Co<100 (1a)

70<C.T.E<120 (2a)

1.0<R/RLi<1.5 (3a)

28<E/ρ<35 (4a)

The following ingredients each in an amount within a predetermined value range in % by weight may be added to the first embodiment. The addition of each of the following ingredients enables adjustment of the Young's modulus E [GPa] and the specific gravity p of the substrate and hence enables adjustment of the value of E/p.

MgO acting as a fluxing agent may be added to the first embodiment. The addition of MgO causes granular crystals to agglomerate into a mass of crystal grains. However, if the amount of MgO is less than 0.5% by weight, the operating temperature range becomes narrower, while no improvement is made in the chemical durability of the glass matrix phase. On the other hand, if it is more than 5% by weight, other crystalline phases precipitate, making it difficult to attain a desired strength. With the addition of MgO, the Young modulus E of the substrate tends to increase, while the specific gravity p of the substrate tends to decrease. Accordingly, the value of E/ρ increases, so that the resonance frequency of the substrate tends to increase.

CaO acting as a fluxing agent may be added to the first embodiment. CaO is capable of imparting the glass composition with a higher melting property and ensuring the formation of a stabilized crystalline phase. If the amount of CaO is less than 0.5% by weight, a sufficient improvement in melting property cannot be expected. If it is more than 5% by weight, on the other hand, the glass becomes stabilized and hence is restrained from crystallizing, making it difficult to attain a desired strength. With the addition of CaO, the Young modulus E of the substrate tends to increase, while the specific gravity ρ of the substrate tends to decrease. Accordingly, the value of E/ρ increases, so that the resonance frequency of the substrate tends to increase.

BaO acting as a fluxing agent may be added to the first embodiment. BaO is capable of imparting the glass composition with a higher melting property and ensuring the formation of a stabilized crystalline phase. If the amount of BaO is less than 0.5% by weight, a sufficient improvement in melting property cannot be expected. If it is more than 5% by weight, on the other hand, the glass becomes stabilized and hence is restrained from crystallizing, making it difficult to attain a desired strength. With the addition of BaO, the Young modulus E of the substrate tends to decrease, while the specific gravity p of the substrate tends to increase steeply. Accordingly, the value of E/ρ decreases, so that the resonance frequency of the substrate tends to lower.

SrO acting as a fluxing agent may be added to the first embodiment. SrO is capable of imparting the glass composition with a higher melting property and ensuring the formation of a stabilized crystalline phase. If the amount of SrO is less than 0.5% by weight, a sufficient improvement in melting property cannot be expected. If it is more than 5% by weight, on the other hand, the glass becomes stabilized and hence is restrained from crystallizing, making it difficult to attain a desired strength. With the addition of SrO, the Young modulus E of the substrate tends to decrease, while the specific gravity p of the substrate tends to increase. Accordingly, the value of E/ρ decreases, so that the resonance frequency of the substrate tends to lower.

Y₂O₃ acting as a fluxing agent may be added to the first embodiment. However, if the amount of Y₂O₃ is less than 0.1% by weight, a sufficient improvement in rigidity cannot be expected. If it is more than 5% by weight, the precipitation of crystal is restrained and, hence, sufficient crystallinity cannot be attained, with the result that desired characteristics cannot be attained. With the addition of Y₂O₃, the Young modulus E of the substrate tends to increase steeply, while the specific gravity p of the substrate tends to increase. Accordingly, the value of E/ρ increases, so that the resonance frequency of the substrate tends to increase.

Nb₂O₅ acting as a fluxing agent may be added to the first embodiment. Nb₂O₅ acts to cause a nucleating substance to increase. However, if the amount of Nb₂O₅ is less than 0.1% by weight, a sufficient improvement in rigidity cannot be expected. If it is more than 5% by weight, on the other hand, crystallization of glass becomes instable and, hence, control over the precipitated crystalline phases becomes impossible, resulting in a difficulty in attaining desired characteristics. With the addition of Nb₂O₅, the Young modulus E of the substrate tends to increase steeply, while the specific gravity p of the substrate tends to increase. Accordingly, the value of E/ρ increases, so that the resonance frequency of the substrate tends to increase.

Ta₂O₅ acting as a fluxing agent may be added to the first embodiment. Ta₂O₅ provides improvements in melting property and strength as well as in the chemical durability of the glass matrix phase. However, if the amount of Ta₂O₅ is less than 0.1% by weight, a sufficient improvement in rigidity cannot be expected. If it is more than 5% by weight, on the other hand, crystallization of glass becomes instable and, hence, control over the precipitated crystalline phases becomes impossible, resulting in a difficulty in attaining desired characteristics. With the addition of Ta₂O₅, the Young modulus E of the substrate tends to increase steeply, while the specific gravity p of the substrate tends to increase. Accordingly, the value of E/ρ increases, so that the resonance frequency of the substrate tends to increase.

La₂O₅ acting as a fluxing agent may be added to the first embodiment. La₂O₅ provides improvements in melting property and strength as well as in the chemical durability of the glass matrix phase. However, if the amount of La₂O₅ is less than 0.1% by weight, a sufficient improvement in rigidity cannot be expected. If it is more than 5% by weight, on the other hand, crystallization of glass becomes instable and, hence, control over the precipitated crystalline phases becomes impossible, resulting in a difficulty in attaining desired characteristics. With the addition of La₂O₅, the Young's modulus E of the substrate tends to increase steeply, while the specific gravity p of the substrate tends to increase. Accordingly, the value of E/ρ increases, so that the resonance frequency of the substrate tends to increase.

Sb₂O₃ working as a clarifier may be added to the first embodiment. Sb₂O₃ improves the stability of the glass composition under production. The addition of Sb₂O₃ in an amount of not more than 2% by weight is sufficient. If the amount of Sb₂O₃ is more than 2% by weight, crystallization of glass becomes instable and, hence, control over the precipitated crystalline phases becomes impossible, resulting in a difficulty in attaining desired characteristics.

[Second Embodiment]

A crystallized glass substrate according to the second embodiment contains the following ingredients in respective amounts in % by weight:

about 55% to about 65% by weight SiO₂;

about 3% to about 10% by weight Al₂O₃;

about 5% to about 20% by weight ZnO;

about 4% to about 8% by weight Li₂O,

about 1% to about 5% by weight ZrO₂; and

about 1% to about 5% by weight P₂O₅.

In the system having the glass ingredients stated above, SiO₂ is a glass forming oxide and is a constituent of cristobalite, cristobalite solid solution, quartz and quartz solid solution precipitated as predominant crystalline phases. In the second embodiment, the amount of SiO₂ that is less than 55% by weight is not desirable because the aforementioned crystals are hard to precipitate. The amount of SiO₂ that is more than 65% by weight is not desirable either, because the glass composition has a higher melting point as well as a higher devitrification property and hence exhibits an inferior melting property.

Al₂O₃is an intermediate oxide of glass and becomes a constituent of crystalline phases of lithium aluminosilicate and lithium aluminosilicate solid solution if precipitated as secondary crystalline phases. In the second embodiment, if the amount of Al₂O₃ is less than 3% by weight, desired mechanical strength and chemical durability cannot be obtained. On the other hand, if it is more than 10% by weight, the glass composition has a higher melting temperature, so that the melting property and devitrification property thereof become inferior.

ZnO serves as a fluxing agent and hence assists in precipitation of homogeneous crystal. In the case where lithium zinc silicate and lithium zinc silicate solid solution precipitate, ZnO becomes a constituent of these crystalline phases. In the second embodiment, if the amount of ZnO is less than 5% by weight, a sufficient improvement in homogenization of crystal is not achieved. On the other hand, if the amount of ZnO is more than 20% by weight, the glass becomes stabilized and, hence, crystallization thereof is restrained, resulting in a difficulty in attaining a desired strength.

Li₂O serves as a fluxing agent and hence improves the stability of the glass composition under production. In the case where lithium aluminosilicate, lithium aluminosilicate solid solution, lithium zinc silicate and lithium zinc silicate solid solution precipitate, Li₂O becomes a constituent of these crystalline phases. In the second embodiment, if the amount of Li₂O is less than 4% by weight, the glass composition has an inferior melting property. On the other hand, if the amount of Li₂O is more than 8% by weight, crystalline phases of lithium monosilicate (Li₂O iO2), lithium disilicate (Li2O SiO2) and the like precipitate as crystalline layers, with the result that the value of corrosion due to aforementioned alkali metal components becomes large, which undesirably causes elution of the alkali metal components from the substrate.

ZrO₂ effectively functions as a nucleating agent as well as a glass modifying oxide. In the second embodiment, if the amount of ZrO₂ is less than 1% by weight, required nucleation does not occur and, further, the chemical durability and the migration resistance of the substrate lower, affecting the magnetic recording layer. If it is more than 5% by weight, on the other hand, the glass composition has a higher melting temperature and is susceptible to devitrification, rendering melt molding difficult. Further, it is possible that resulting crystal grains become coarse, or that a precipitated crystalline phase varies, making it difficult to obtain desired characteristics. Furthermore, a fine and homogeneous crystalline structure cannot be obtained and, hence, an abrading process cannot yield a magnetic disk having a surface with a required smoothness.

P₂O₅ serves as a fluxing agent as well as a nucleating agent causing a silicate-type crystal to precipitate and is an important ingredient for crystal to uniformly precipitate throughout the overall glass. In the second embodiment, if the amount of P₂O₅ is less than 1% by weight, required nucleation does not occur and, further, the chemical durability and the migration resistance of the substrate lower, affecting the magnetic recording layer. If it is more than 5% by weight, on the other hand, the glass composition has a higher melting temperature and is susceptible to devitrification, rendering melt molding difficult. Further, it is possible that resulting crystal grains become coarse, that a precipitated crystalline phase varies, making it difficult to obtain desired characteristics, or that an abrading process cannot yield a magnetic disk having a surface with a required smoothness. Moreover, the reactivity of the glass composition with materials forming a furnace used in the melting process becomes higher and the devitrification property is enhanced as well, resulting in the melt molding process having lowered productivity. In addition, the stability of the glass structure lowers, so that elution of alkali metal components becomes likely.

The crystallized glass substrate manufacturing process proceeds as follows. Raw materials containing major components of a glass substrate to be finally produced are sufficiently mixed together in predetermined proportions and then melted in a platinum or brick crucible. The resulting melt is then cast into a mold to form an approximated shape of an intended substrate, followed by annealing to room temperature. Subsequently, the molded product is kept at a primary heat treatment temperature of 500 to 600 for a primary treatment time (heat treatment) to allow nucleation to occur, followed by being kept at a secondary heat treatment temperature of 600 to 750 for a secondary treatment time to allow crystal nuclei to grow. By subjecting the resultant to slow cooling, intended crystallized glass is obtained.

Further, the crystallized glass is ground or abraded to desired shape and thickness for use as a crystallized glass substrate.

With respect to the crystallized glass substrate defined by the aforementioned essential ingredients according to the second embodiment of the present invention, the ranges specified by the conditional formulae (1) to (4), respectively, are optimized as follows:

70<Co<150 (1b)

60<C.T.E<100 (2b)

1.0<R/RLi<1.5 (3b)

29<E/ρ<36 (4b)

The following ingredients each in an amount within a predetermined value range in % by weight may be added to the second embodiment. The addition of each of the following ingredients enables adjustment of the Young's modulus E [GPa] and the specific gravity p of the substrate and hence enables adjustment of the value of E/ρ.

MgO acting as a fluxing agent may be added to the second embodiment. The addition of MgO causes granular crystals to agglomerate into a mass of crystal grains. However, if the amount of MgO is less than 0.5% by weight, the operating temperature range becomes narrower, while no improvement is made in the chemical durability of the glass matrix phase. On the other hand, if it is more than 5% by weight, other crystalline phases precipitate, making it difficult to attain a desired strength. With the addition of MgO, the Young modulus E of the substrate tends to increase, while the specific gravity p of the substrate tends to decrease. Accordingly, the value of E/ρ increases, so that the resonance frequency of the substrate tends to increase.

CaO acting as a fluxing agent may be added to the second embodiment. CaO is capable of imparting the glass composition with a higher melting property and ensuring the formation of a stabilized crystalline phase. If the amount of CaO is less than 0.5% by weight, a sufficient improvement in melting property cannot be expected. If it is more than 5% by weight, on the other hand, the glass becomes stabilized and hence is restrained from crystallizing, making it difficult to attain a desired strength. With the addition of CaO, the Young modulus E of the substrate tends to increase, while the specific: gravity p of the substrate tends to decrease. Accordingly, the value of E/ρ increases, so that the resonance frequency of the substrate tends to increase.

BaO acting as a fluxing agent may be added to the second embodiment. BaO is capable of imparting the glass composition with a higher melting property and ensuring the formation of a stabilized crystalline phase. If the amount of BaO is less than 0.5% by weight, a sufficient improvement in melting property cannot be expected. If it is more than 5% by weight, on the other hand, the glass becomes stabilized and hence is restrained from crystallizing, making it difficult to attain a desired strength. With the addition of BaO, the Young modulus E of the substrate tends to decrease, while the specific gravity ρ of the substrate tends to increase steeply. Accordingly, the value of E/ρ decreases, so that the resonance frequency of the substrate tends to lower.

SrO acting as a fluxing agent may be added to the second embodiment. SrO is capable of imparting the glass composition with a higher melting property and ensuring the formation of a stabilized crystalline phase. If the amount of SrO is less than 0.5% by weight, a sufficient improvement in melting property cannot be expected. If it is more than 5% by weight, on the other hand, the glass becomes stabilized and hence is restrained from crystallizing, making it difficult to attain a desired strength. With the addition of SrO, the Young modulus E of the substrate tends to decrease, while the specific gravity p of the substrate tends to increase. Accordingly, the value of E/ρ decreases, so that the resonance frequency of the substrate tends to lower.

Y₂O₃ acting as a fluxing agent may be added to the second embodiment. However, if the amount of Y₂O₃ is less than 0.1% by weight, a sufficient improvement in rigidity cannot be expected. If it is more than 5% by weight, the precipitation of crystal is restrained and, hence, sufficient crystallinity cannot be attained, with the result that desired characteristics cannot be attained. With the addition of Y₂O₃, the Young modulus E of the substrate tends to increase steeply, while the specific gravity p of the substrate tends to increase. Accordingly, the value of E/ρ increases, so that the resonance frequency of the substrate tends to increase.

Nb₂O₅ acting as a fluxing agent may be added to the second embodiment. Nb₂O₅ acts to cause a nucleating substance to increase. However, if the amount of Nb₂O₅ is less than 0.1% by weight, a sufficient improvement in rigidity cannot be expected. If it is more than 5% by weight, on the other hand, crystallization of glass becomes instable and, hence, control over the precipitated crystalline phases becomes impossible, resulting in a difficulty in attaining desired characteristics. With the addition of Nb₂O₅, the Young modulus E of the substrate tends to increase steeply, while the specific gravity ρ of the substrate tends to increase. Accordingly, the value of E/ρ increases, so that the resonance frequency of the substrate tends to increase.

Ta₂O₅ acting as a fluxing agent may be added to the second embodiment. Ta₂O₅ provides improvements in melting property and strength as well as in the chemical durability of the glass matrix phase. However, if the amount of Ta₂O₅ is less than 0.1% by weight, a sufficient improvement in rigidity cannot be expected. If it is more than 5% by weight, on the other hand, crystallization of glass becomes instable and, hence, control over the precipitated crystalline phases becomes impossible, resulting in a difficulty in attaining desired characteristics. With the addition of Ta₂O₅, the Young modulus E of the substrate tends to increase steeply, while the specific gravity ρ of the substrate tends to increase. Accordingly, the value of E/ρ increases, so that the resonance frequency of the substrate tends to increase.

La₂O₅ acting as a fluxing agent may be added to the second embodiment. La₂O₅ provides improvements in melting property and strength as well as in the chemical durability of the glass matrix phase. However, if the amount of La₂O₅ is less than 0.1% by weight, a sufficient improvement in rigidity cannot be expected. If it is more than 5% by weight, on the other hand, crystallization of glass becomes instable and, hence, control over the precipitated crystalline phases becomes impossible, resulting in a difficulty in attaining desired characteristics. With the addition of La₂O₅, the Young's modulus E of the substrate tends to increase steeply, while the specific gravity ρ of the substrate tends to increase. Accordingly, the value of E/ρ increases, so that the resonance frequency of the substrate tends to increase.

Sb₂O₃ working as a clarifier may be added to the second embodiment. Sb₂O₃ improves the stability of the glass composition under production. The addition of Sb₂O₃ in an amount of not more than 2% by weight is sufficient. If the amount of Sb₂O₃ is more than 2% by weight, crystallization of glass becomes instable and, hence, control over the precipitated crystalline phases becomes impossible, resulting in a difficulty in attaining desired characteristics.

[Third Embodiment]

A crystallized glass substrate according to the third embodiment contains the following ingredients in respective amounts in % by weight:

about 65% to about 70% by weight SiO₂;

about 5% to about 10% by weight Al₂O₃;

about 4% to about 8% by weight Li₂O;

about 1% to about 5% by weight ZrO₂; and

about 1% to about 3% by weight P₂O₅.

In the system having the glass ingredients stated above, SiO₂ is a glass forming oxide and is a constituent of cristobalite, cristobalite solid solution, quartz and quartz solid solution precipitated as predominant crystalline phases. In the third embodiment, the amount of SiO₂ that is less than 65% by weight is not desirable because the aforementioned crystals are hard to precipitate. The amount of SiO₂ that is more than 70% by weight is not desirable either, because the glass composition has a higher melting temperature as well as a higher devitrification property and hence exhibits an inferior melting property.

Al₂O₃ is an intermediate oxide of glass and becomes a constituent of crystalline phases of lithium alumincsilicate and lithium aluminosilicate solid solution if precipitated. In the third embodiment, if the amount of Al₂O₃is less than 5% by weight, desired mechanical strength and chemical durability cannot be obtained. On the other hand, if it is more than 10% by weight, the glass composition has a higher melting temperature, so that the melting property and devitrification property thereof become inferior.

Li₂O serves as a fluxing agent and hence improves the stability of the glass composition under production. In the case where lithium aluminosilicate, lithium aluminosilicate solid solution, lithium zinc silicate and lithium zinc silicate solid solution precipitate, Li₂O becomes a constituent of these crystalline phases. In the third embodiment, if the amount of Li₂O is less than 4% by weight, the glass composition has an inferior melting property. On the other hand, if the amount of Li₂O is more than 8% by weight, crystalline phases of lithium monosilicate (Li20 iO2), lithium disilicate (Li2O SiO2) and the like precipitate as crystalline layers, with the result that the value of corrosion due to aforementioned alkali metal components becomes large, which undesirably causes elution of the alkali metal components from the substrate to occur.

ZrO₂ effectively functions as a nucleating agent as well as a glass modifying oxide. In the third embodiment, if the amount of ZrO₂ is less than 1% by weight, required nucleation does not occur and, further, the chemical durability and the migration resistance of the substrate lower, affecting the magnetic recording layer. If it is more than 5% by weight, on the other hand, the glass composition has a higher melting temperature and is susceptible to devitrification, rendering melt molding difficult. Further, it is possible that resulting crystal grains become coarse, or that a precipitated crystalline phase varies, making it difficult to obtain desired characteristics. Furthermore, a fine and homogeneous crystalline structure cannot be obtained and, hence, an abrading process cannot yield a magnetic disk having a required surface smoothness.

P₂O₅ serves as a fluxing agent as well as a nucleating agent causing a silicate-type crystal to precipitate and is an important ingredient for crystal to uniformly precipitate throughout the overall glass. In the third embodiment, if the amount of P₂O₅ is less than 1% by weight, required nucleation does not occur and, further, the chemical durability and the migration resistance of the substrate lower, affecting the magnetic recording layer. If it is more than 3% by weight, on the other hand, the glass composition has a higher melting temperature and is susceptible to devitrification, rendering melt molding difficult. Further, it is possible that resulting crystal grains become coarse, that a precipitated crystalline phase varies, making it difficult to obtain desired characteristics, or that an abrading process cannot yield a magnetic disk having a required surface smoothness. Moreover, the reactivity of the glass composition with materials forming a furnace used in the melting process becomes higher and the devitrification property is enhanced as well, resulting in the melt molding process having lowered productivity. In addition, the stability of the glass structure lowers, so that elution of alkali metal components becomes likely.

The crystallized glass substrate manufacturing process proceeds as follows. Raw materials containing major components of a glass substrate to be finally produced are sufficiently mixed together in predetermined proportions and then melted in a platinum or brick crucible. The resulting melt is then cast into a mold to form an approximated shape of an intended substrate, followed by annealing to room temperature. Subsequently, the molded product is kept at a primary heat treatment temperature of 500 to 600 for a primary treatment time (heat treatment) to allow nucleation to occur, followed by being kept at a secondary heat treatment temperature of 600 to 750 for a secondary treatment time to allow crystal nuclei to grow. By subjecting the resultant to slow cooling, intended crystallized glass is obtained.

Further, the crystallized glass is ground or abraded to desired shape and thickness for use as a crystallized glass substrate.

With respect to the crystallized glass substrate defined by the aforementioned essential ingredients according to the third embodiment of the present invention, the ranges specified by the conditional formulae (1) to (4), respectively, are optimized as follows:

30<Co<100 (1c)

80<C.T.E<150 (2c)

1.0<R/RLi<1.5 (3c)

28<E/ρ<33 (4c)

The following ingredients each in an amount within a predetermined value range in % by weight may be added to the third embodiment. The addition of each of the following ingredients enables adjustment of the Young's modulus E [GPa] and the specific gravity ρ of the substrate and hence enables adjustment of the value of E/ρ.

ZnO serving as a fluxing agent may be added to the third embodiment. ZnO assists in precipitation of homogeneous crystal. In the case where lithium zinc silicate and lithium zinc silicate solid solution precipitate, ZnO becomes a constituent of these crystalline phases. In the third embodiment, if the amount of ZnO is less than 0.1% by weight, a sufficient improvement in homogenization of crystal is not achieved. On the other hand, if the amount of ZnO is more than 5% by weight, the glass becomes stabilized and, hence, crystallization thereof is restrained, resulting in a difficulty in attaining a desired strength.

MgO acting as a fluxing agent may be added to the third embodiment. The addition of MgO causes granular crystals to agglomerate into a mass of crystal grains. However, if the amount of MgO is less than 0.5% by weight, the operating temperature range becomes narrower, while no improvement is made in the chemical durability of the glass matrix phase. On the other hand, if it is more than 5% by weight, on the other hand, other crystalline phases precipitate, making it difficult to attain a desired strength. With the addition of MgO, the Young's modulus E of the substrate tends to increase, while the specific gravity ρ of the substrate tends to decrease. Accordingly, the value of E/ρ increases, so that the resonance frequency of the substrate tends to increase.

CaO acting as a fluxing agent may be added to the third embodiment. CaO is capable of imparting the glass composition with a higher melting property and ensuring the formation of a stabilized crystalline phase. If the amount of CaO is less than 0.5% by weight, a sufficient improvement in melting property cannot be expected. If it is more than 5% by weight, on the other hand, the glass becomes stabilized and hence is restrained from crystallizing, making it difficult to attain a desired strength. With the addition of CaO, the Young's modulus E of the substrate tends to increase, while the specific gravity ρ of the substrate tends to decrease. Accordingly, the value of E/ρ increases, so that the resonance frequency of the substrate tends to increase.

BaO acting as a fluxing agent may be added to the third embodiment. BaO is capable of imparting the glass composition with a higher melting property and ensuring the formation of a stabilized crystalline phase. If the amount of BaO is less than 0.5% by weight, a sufficient improvement in melting property cannot be expected. If it is more than 10% by weight, on the other hand, the glass becomes stabilized and hence is restrained from crystallizing, making it difficult to attain a desired strength. With the addition of BaO, the Young's modulus E of the substrate tends to decrease, while the specific gravity p of the substrate tends to increase steeply. Accordingly, the value of E/ρ decreases, so that the resonance frequency of the substrate tends to lower.

SrO acting as a fluxing agent may be added to the third embodiment. SrO is capable of imparting the glass composition with a higher melting property and ensuring the formation of a stabilized crystalline phase. If the amount of SrO is less than 0.5% by weight, a sufficient improvement in melting property cannot be expected. If it is more than 10% by weight, on the other hand, the glass becomes stabilized and hence is restrained from crystallizing, making it difficult to attain a desired strength. With the addition of SrO, the Young's modulus E of the substrate tends to decrease, while the specific gravity ρ of the substrate tends to increase. Accordingly, the value of E/ρ decreases, so that the resonance frequency of the substrate tends to lower.

Y₂O₃ acting as a fluxing agent may be added to the third embodiment. However, if the amount of Y₂O₃ is less than 0.1% by weight, a sufficient improvement in rigidity cannot be expected. If it is more than 5% by weight, the precipitation of crystal is restrained and, hence, sufficient crystallinity cannot be attained, with the result that desired characteristics cannot be attained. With the addition of Y₂O₃, the Young modulus E of the substrate tends to increase steeply, while the specific gravity p of the substrate tends to decrease. Accordingly, the value of E/ρ increases, so that the resonance frequency of the substrate tends to increase.

Sb₂O₃ working as a clarifier may be added to the third embodiment. Sb₂O₃ improves the stability of the glass composition under production. The addition of Sb₂O₃ in an amount of not more than 2% by weight is sufficient. If the amount of Sb₂O₃ is more than 2% by weight, crystallization of glass becomes instable and, hence, control over the precipitated crystalline phases becomes impossible, resulting in a difficulty in attaining desired characteristics.

Hereinafter, the present invention will be described in detail by way of examples based on specific values. However, the present invention is not limited to these examples. The contents of glass ingredients of a crystallized glass substrate according to each of these examples are all expressed in % by weight (wt%) on the basis of corresponding oxides. The glass composition of each example is treated and processed to form a crystallized glass substrate according to the foregoing manufacturing process under the conditions, i.e., the nucleating temperature and time and the nucleus growing temperature and time, shown in respective Table.

With respect to abbreviations of crystalline phases used in each Table, rist indicates cristobalite, uartz indicates (-quartz, AS indicates lithium aluminosilicate, ZS indicates lithium zinc silicate, 2S indicates lithium disilicate, and S indicates solid solution.

[First Ebodiment]

Tables 1 and 2 show the glass compositions in % by weight of respective crystallized glass substrates of A-1 to A-18, together with the manufacturing conditions employed. Tables 3 and 4 show crystallized glass substrates as A-19 to A-36 manufactured using the same glass compositions as those of A-1 to A-18 with the nucleus growing temperature varied from that employed for A-1 to A-18. Further, Tables 5 and 6 show crystallized glass substrates as A-37 to A-54 manufactured using the same glass compositions as those of A-1 to A-18 with the nucleus growing time varied from that employed for A-1 to A-18.

TABLE 1

| | A-1 | A-2 | A-3 | A-4 | A-5 | A-6 | A-7 | A-8 | A-9 |
|---|---|---|---|---|---|---|---|---|---|
| SiO₂ | 65.2 | 67.0 | 69.5 | 66.1 | 66.3 | 65.7 | 68.5 | 67.7 | 66.0 |
| Al₂O₃ | 7.4 | 7.6 | 7.0 | 3.0 | 5.0 | 7.4 | 7.6 | 7.7 | 7.6 |
| MgO | 2.0 | 2.0 | 2.0 | 2.4 | 1.0 | | 2.0 | 2.7 | 2.0 |
| CaO | 0.9 | | | | | | | | |
| BaO | 2.4 | 2.5 | 2.1 | 3.0 | 2.3 | 2.4 | 2.5 | 2.5 | 1.0 |
| SrO | | 1.7 | 1.5 | 2.1 | 1.8 | 1.7 | 1.7 | | |
| ZnO | 5.7 | 5.9 | 6.0 | 7.2 | 7.2 | 9.8 | 3.0 | 6.0 | 10.0 |
| Li₂O | 5.9 | 6.1 | 6.0 | 7.4 | 7.4 | 6.0 | 6.5 | 6.2 | 6.1 |
| K₂O | 2.1 | 2.1 | 1.0 | 2.6 | 2.6 | 2.1 | 2.2 | 2.1 | 2.1 |
| B₂O3 | 3.5 | | | | | | | | |
| TiO₂ | | | | | | | | | |
| ZrO₂ | 2.5 | 2.6 | 2.5 | 3.2 | 3.4 | 2.5 | 3.5 | 2.6 | 2.6 |
| P₂O₂ | 2.0 | 2.1 | 2.0 | 2.6 | 2.6 | 2.1 | 2.1 | 2.1 | 2.2 |
| Y₂O₃ | | | | | | | | | |
| Nb₂O₅ | | | | | | | | | |
| Ta₂O₅ | | | | | | | | | |
| La₂O₃ | | | | | | | | | |
| Sb₂O₃ | 0.4 | 0.4 | 0.4 | 0.5 | 0.5 | 0.4 | 0.4 | 0.4 | 0.4 |
| Total(100 wt%) | 100.0 | 100.0 | 100.0 | 100.0 | 100.0 | 100.0 | 100.0 | 100.0 | 100.0 |
| Melting Temperaturer??? | 1550 | 1550 | 1550 | 1550 | 1550 | 1550 | 1550 | 1550 | 1550 |
| Melting Time?hr? | 3 | 3 | 3 | 3 | 3 | 3 | 3 | 3 | 3 |
| Nucleating | 550 | 550 | 550 | 550 | 550 | 550 | 550 | 550 | 550 |
| Temperature??? | | | | | | | | | |
| Nucleating Time?hr? | 5 | 5 | 5 | 5 | 5 | 5 | 5 | 5 | 5 |
| Nucleous Growing | 700 | 700 | 700 | 700 | 700 | 700 | 700 | 700 | 700 |
| Temperature??? | | | | | | | | | |
| Nucleous Growing | 3 | 3 | 3 | 3 | 3 | 3 | 3 | 3 | 3 |
| Time?hr? | | | | | | | | | |
| Main Crystalline Phase | Quartz | Crist | Crist | Crist | Crist | Crist | Crist | Crist | LZS |
| Sub Crystalline Phase | Crist | LZS | LZS | LZS | LZS | LZS | LZS | LZS | Crist |
| Specific Gravity?g/cm³ | 2.53 | 2.53 | 2.51 | 2.55 | 2.54 | 2.58 | 2.49 | 2.52 | 2.62 |
| Yong's Modulus E??Pa | 80.9 | 78.6 | 80.0 | 76.0 | 78.0 | 79.7 | 76.0 | 76.9 | 79.0 |
| Elastic Modulus Ratio | 32.0 | 31.1 | 31.9 | 29.8 | 30.7 | 30.9 | 30.5 | 30.5 | 30.2 |
| C.T.E | 110 | 89 | 78 | 112 | 87 | 72 | 110 | 97 | 77 |
| Amount of Migration of | 56 | 52 | 49 | 63 | 56 | 47 | 59 | 54 | 49 |
| alkali metal [ppb] | | | | | | | | | |
| P/Pli | 1.3 | 1.2 | 1.1 | 1.2 | 1.1 | 1.1 | 1.2 | 1.2 | 1.1 |

TABLE 2

| | A-10 | A-11 | A-12 | A-13 | A-14 | A-15 | A-16 | A-17 | A-18 |
|---|---|---|---|---|---|---|---|---|---|
| SiO₂ | 67.5 | 65.3 | 67.5 | 66.5 | 66.6 | 66.0 | 67.7 | 67.8 | 66.5 |
| Al₂O₃ | 7.7 | 7.4 | 7.0 | 7.0 | 8.3 | 8.0 | 7.0 | 7.8 | 8.0 |
| MgO | 2.0 | 2.0 | 2.0 | | 2.2 | | 2.1 | 2.1 | 2.1 |
| CaO | 0.9 | | 0.9 | 2.4 | 2.0 | 1.0 | 1.9 | 1.9 | 1.1 |
| BaO | 2.5 | 2.4 | 2.0 | 2.5 | | | | | |
| SrO | | 1.7 | | 2.0 | | 1.5 | | | |
| ZnO | 5.9 | 8.3 | 5.9 | 6.0 | 6.4 | 6.6 | 6.4 | 6.2 | 6.3 |
| Li₂O | 4.0 | 5.9 | 8.0 | 7.1 | 6.6 | 6.9 | 6.5 | 6.5 | 7.0 |
| K₂O | 2.1 | 2.1 | 1.5 | 2.5 | 2.3 | 2.4 | 2.5 | 2.2 | 2.2 |
| B₂O₃ | 1.0 | | | | | | 1.0 | | |
| TiO₂ | 1.1 | | | | | | | | |
| ZrO₂ | 2.6 | 2.5 | 2.6 | 1.1 | 2.8 | 5.0 | 3.5 | 3.0 | 3.3 |
| P₂O₅ | 2.1 | 2.0 | 2.1 | 2.5 | 2.3 | 2.2 | 1.0 | 2.0 | 3.0 |
| Y₂O₃ | | | | | | | | | |
| Nb₂O₅ | | | | | | | | | |
| Ta₂O₅ | | | | | | | | | |
| La₂O₃ | | | | | | | | | |
| Sb₂O₃ | 0.4 | 0.4 | 0.4 | 0.5 | 0.4 | 0.4 | 0.4 | 0.4 | 0.4 |
| Total(100wt %) | 100.0 | 100.0 | 100.0 | 100.0 | 100.0 | 100.0 | 100.0 | 100.0 | 100.0 |
| Melting Temperature??? | 1550 | 1550 | 1550 | 1550 | 1550 | 1550 | 1550 | 1550 | 1550 |
| Melting Time?hr? | 3 | 3 | 3 | 3 | 3 | 3 | 3 | 3 | 3 |
| Nucleating | 550 | 550 | 550 | 550 | 550 | 550 | 550 | 550 | 550 |
| Temperature??? | | | | | | | | | |
| Nucleating Time?hr? | 5 | 5 | 5 | 5 | 5 | 5 | 5 | 5 | 5 |
| Nucleous Growing | 700 | 700 | 700 | 700 | 700 | 700 | 700 | 700 | 700 |
| Temperature??? | | | | | | | | | |
| Nucleous Growing | 3 | 3 | 3 | 3 | 3 | 3 | 3 | 3 | 3 |
| Time?hr? | | | | | | | | | |
| Main Crystalline Phase | Quartz | LZS | Crist | Crist | Crist | LZS | Quartz | Crist | Crist |
| Sub Crystalline Phase | Crist | Crist | LZS | LZS | LZS | Crist | Crist | LZS | LZS |
| Specific Gravity?g/cm³ | 2.55 | 2.58 | 2.49 | 2.48 | 2.51 | 2.55 | 2.58 | 2.50 | 2.55 |
| Yang's Modulus E??Pa | 79.3 | 80.0 | 77.0 | 76.0 | 81.6 | 84.0 | 79.3 | 78.0 | 76.0 |
| Elastic Modulus Ratio | 31.1 | 31.0 | 0.9 | 30.6 | 32.5 | 32.9 | 30.7 | 31.2 | 29.8 |
| C.T.E | 102 | 78 | 112 | 120 | 98 | 73 | 110 | 100 | 113 |
| Amount of Migration of | 46 | 49 | 66 | 64 | 56 | 50 | 58 | 56 | 62 |
| P/Pli | 1.3 | 1.1 | 1.2 | 1.2 | 1.2 | 1.1 | 1.2 | 1.2 | 1.2 |

TABLE 3

| | A-19 | A-20 | A-21 | A-22 | A-23 | A-24 | A-25 | A-26 | A-27 |
|---|---|---|---|---|---|---|---|---|---|
| SiO₂ | 65.2 | 67.0 | 69.5 | 66.1 | 66.3 | 65.7 | 68.5 | 67.7 | 66.0 |
| Al₂O₃ | 7.4 | 7.6 | 7.0 | 3.0 | 5.0 | 7.4 | 7.6 | 7.7 | 7.6 |
| MgO | 2.0 | 2.0 | 2.0 | 2.4 | 1.0 | | 2.0 | 2.7 | 2.0 |
| CaO | 0.9 | | | | | | | | |
| BaO | 2.4 | 2.5 | 2.1 | 3.0 | 2.3 | 2.4 | 2.5 | 2.5 | 1.0 |
| SrO | 1.7 | 1.5 | 2.1 | 1.8 | 1.7 | 1.7 | | | |
| ZnO | 5.7 | 5.9 | 6.0 | 7.2 | 7.2 | 9.8 | 3.0 | 6.0 | 10.0 |
| Li₂O | 5.9 | 6.1 | 6.0 | 7.4 | 7.4 | 6.0 | 6.5 | 6.2 | 6.1 |
| K₂O | 2.1 | 2.1 | 1.0 | 2.6 | 2.6 | 2.1 | 2.2 | 2.1 | 2.1 |
| B₂O₃ | 3.5 | | | | | | | | |
| TiO₂ | | | | | | | | | |
| ZrO₂ | 2.5 | 2.6 | 2.5 | 3.2 | 3.4 | 2.5 | 3.5 | 2.6 | 2.6 |
| P₂O₅ | 2.0 | 2.1 | 2.0 | 2.6 | 2.6 | 2.1 | 2.1 | 2.1 | 2.2 |
| Nb₂O₅ | | | | | | | | | |
| Ta₂O₅ | | | | | | | | | |
| La₂O₃ | | | | | | | | | |
| Sb₂O₃ | 0.4 | 0.4 | 0.4 | 0.5 | 0.5 | 0.4 | 0.4 | 0.4 | 0.4 |
| Total(100wt %) | 100.0 | 100.0 | 100.0 | 100.0 | 100.0 | 100.0 | 100.0 | 100.0 | 100.0 |
| Melting Temperature??? | 1550 | 1550 | 1550 | 1550 | 1550 | 1550 | 1550 | 1550 | 1550 |
| Melting Time?hr? | 3 | 3 | 3 | 3 | 3 | 3 | 3 | 3 | 3 |
| Nucleating | 550 | 550 | 550 | 550 | 550 | 550 | 550 | 550 | 550 |
| Temperature??? | | | | | | | | | |
| Nucleating Time?hr? | 5 | 5 | 5 | 5 | 5 | 5 | 5 | 5 | 5 |
| Nucleaus Growing | 730 | 730 | 730 | 730 | 730 | 730 | 730 | 730 | 730 |
| Temperature??? | | | | | | | | | |
| Nucleous Growing | 3 | 3 | 3 | 3 | 3 | 3 | 3 | 3 | 3 |
| Time?hr? | | | | | | | | | |
| Main Crystalline Phase | Quartz | Crist | Crist | Crist | Crist | Crist | Crist | Crist | Crist |
| Sub Crystalline Phase | Crist | LZS | LZS | LZS | LZS | LZS | LZS | LZS | LZS |
| Specific Gravity?g/cm³ | 2.55 | 2.52 | 2.50 | 2.54 | 2.53 | 2.57 | 2.48 | 2.51 | 2.61 |
| Yang's Modulus E??Pa | 84.3 | 78.1 | 79.5 | 75.5 | 77.5 | 79.2 | 75.5 | 76.4 | 78.5 |
| Elastic Modulus Ratio | 33.1 | 31.0 | 31.8 | 29.7 | 30.6 | 30.8 | 30.5 | 30.5 | 30.1 |
| C.T.E | 114 | 100 | 95 | 115 | 99 | 93 | 114 | 105 | 95 |
| Amount at Migration at | 53 | 50 | 49 | 53 | 50 | 49 | 53 | 51 | 49 |
| alkali metal [ppb] | | | | | | | | | |
| P/Pli | 1.3 | 1.3 | 1.3 | 1.3 | 1.3 | 1.2 | 1.3 | 1.3 | 1.3 |

TABLE 4

| | A-28 | A-29 | A-30 | A-31 | A-32 | A-33 | A-34 | A-35 | A-36 |
|---|---|---|---|---|---|---|---|---|---|
| SiO₂ | 67.5 | 65.3 | 67.5 | 66.5 | 66.6 | 66.0 | 67.7 | 67.8 | 66.5 |
| Al₂O₃ | 7.7 | 7.4 | 7.0 | 7.0 | 8.3 | 8.0 | 7.0 | 7.8 | 8.0 |
| MgO | 2.0 | 2.0 | 2.0 | | 2.2 | | 2.1 | 2.1 | 2.1 |
| CaO | 0.9 | | 0.9 | 2.4 | 2.0 | 1.0 | 1.9 | 1.9 | 1.1 |
| BaO | 2.5 | 2.4 | 2.0 | 2.5 | | | | | |
| SrO | | 1.7 | | 2.0 | | 1.5 | | | |
| ZnO | 5.9 | 8.3 | 5.9 | 6.0 | 6.4 | 6.6 | 6.4 | 6.2 | 6.3 |
| Li₂O | 4.0 | 5.9 | 8.0 | 7.1 | 6.6 | 6.9 | 6.5 | 6.5 | 7.0 |
| K₂O | 2.1 | 2.1 | 1.5 | 2.5 | 2.3 | 2.4 | 2.5 | 2.2 | 2.2 |
| B₂O₃ | 1.0 | | | | | 1.0 | | | |
| TiO₂ | 1.1 | | | | | | | | |
| ZrO₂ | 2.6 | 2.5 | 2.6 | 1.1 | 2.8 | 5.0 | 3.5 | 3.0 | 3.3 |
| P₂O₅ | 2.1 | 2.0 | 2.1 | 2.5 | 2.3 | 2.2 | 1.0 | 2.0 | 3.0 |
| Y₂O₃ | | | | | | | | | |
| Nb₂O₅ | | | | | | | | | |
| Ta₂O₅ | | | | | | | | | |
| La₂O₃ | | | | | | | | | |
| Sb₂O₃ | 0.4 | 0.4 | 0.4 | 0.5 | 0.4 | 0.4 | 0.4 | 0.4 | 0.4 |
| Total(100wt %) | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 |
| Temperature??? | | | | | | | | | |
| Melting Time?hr? | 3 | 3 | 3 | 3 | 3 | 3 | 3 | 3 | 3 |
| Nucleating | 550 | 550 | 550 | 550 | 550 | 550 | 550 | 550 | 550 |
| Temperature??? | | | | | | | | | |
| Nucleating Time?hr? | 5 | 5 | 5 | 5 | 5 | 5 | 5 | 5 | 5 |
| Nucleous Growing | 730 | 730 | 730 | 730 | 730 | 730 | 730 | 730 | 730 |
| Temperature??? | | | | | | | | | |
| Nucleous Growing | 3 | 3 | 3 | 3 | 3 | 3 | 3 | 3 | 3 |
| Time?hr? | | | | | | | | | |
| Main Crystalline Phase | Quartz | Crist | Crist | Crist | Crist | Crist | Quartz | Crist | Crist |
| Sub Crystalline Phase | Crist | LZS | LZS | Quartz | Quartz | LZS | Crist | LZS | LZS |
| Specific Gravity?g/cm³ | 2.57 | 2.57 | 2.48 | 2.47 | 2.50 | 2.54 | 2.60 | 2.49 | 2.54 |
| Yang's Modulus E??Pa | 82.7 | 79.5 | 76.5 | 75.5 | 81.1 | 83.5 | 82.7 | 77.5 | 75.5 |
| Elastic Modulus Ratio | 32.2 | 30.9 | 30.9 | 30.6 | 32.4 | 32.9 | 31.8 | 31.1 | 29.7 |
| C.T.E | 110 | 95 | 115 | 121 | 106 | 94 | 114 | 107 | 116 |
| Amount of Migration of | 52 | 49 | 53 | 54 | 51 | 49 | 53 | 51 | 53 |
| alkali metal [ppb] | | | | | | | | | |
| P/Pli | 1.3 | 1.3 | 1.3 | 1.3 | 1.3 | 1.2 | 1.3 | 1.3 | 1.3 |

TABLE 5

| | A-37 | A-38 | A-39 | A-40 | A-41 | A-42 | A-43 | A-44 | A-45 |
|---|---|---|---|---|---|---|---|---|---|
| SiO₂ | 65.2 | 67.0 | 69.5 | 66.1 | 66.3 | 65.7 | 68.5 | 67.7 | 66.0 |
| Al₂O₃ | 7.4 | 7.6 | 7.0 | 3.0 | 5.0 | 7.4 | 7.6 | 7.7 | 7.6 |
| MgO | 2.0 | 2.0 | 2.0 | 2.4 | 1.0 | | 2.0 | 2.7 | 2.0 |
| CaO | 0.9 | | | | | | | | |
| BaO | 2.4 | 2.5 | 2.1 | 3.0 | 2.3 | 2.4 | 2.5 | 2.5 | 1.0 |
| SrO | | 1.7 | 1.5 | 2.1 | 1.8 | 1.7 | 1.7 | | |
| ZnO | 5.7 | 5.9 | 6.0 | 7.2 | 7.2 | 9.8 | 3.0 | 6.0 | 10.0 |
| Li₂O | 5.9 | 6.1 | 6.0 | 7.4 | 7.4 | 6.0 | 6.5 | 6.2 | 6.1 |
| K₂O | 2.1 | 2.1 | 1.0 | 2.6 | 2.6 | 2.1 | 2.2 | 2.1 | 2.1 |
| B₂O₃ | 3.5 | | | | | | | | |
| TiO₂ | | | | | | | | | |
| ZrO₂ | 2.5 | 2.6 | 2.5 | 3.2 | 3.4 | 2.5 | 3.5 | 2.6 | 2.6 |
| P₂O₅ | 2.0 | 2.1 | 2.0 | 2.6 | 2.6 | 2.1 | 2.1 | 2.1 | 2.2 |
| Y₂O₃ | | | | | | | | | |
| Nb₂O₅ | | | | | | | | | |
| Ta₂O₅ | | | | | | | | | |
| La₂O₃ | | | | | | | | | |
| Sb₂O₃ | 0.4 | 0.4 | 0.4 | 0.5 | 0.5 | 0.4 | 0.4 | 0.4 | 0.4 |
| Total(100wt %) | 100.0 | 100.0 | 100.0 | 100.0 | 100.0 | 100.0 | 100.0 | 100.0 | 100.0 |
| Melting Temperature??? | 1550 | 1550 | 1550 | 1550 | 1550 | 1550 | 1550 | 1550 | 1550 |
| Melting Time?hr? | 3 | 3 | 3 | 3 | 3 | 3 | 3 | 3 | 3 |
| Nucleating | 550 | 550 | 550 | 550 | 550 | 550 | 550 | 550 | 550 |
| Temperature??? | | | | | | | | | |
| Nucleating Time?hr? | 5 | 5 | 5 | 5 | 5 | 5 | 5 | 5 | 5 |
| Nucleous Growing | 700 | 700 | 700 | 700 | 700 | 700 | 700 | 700 | 700 |
| Temperature??? | | | | | | | | | |
| Nucleous Growing | 10 | 10 | 10 | 10 | 10 | 10 | 10 | 10 | 10 |
| Time?hr? | | | | | | | | | |
| Main Crystalline Phase | Quartz | Crist | Crist | Crist | Crist | Crist | Crist | Crist | Crist |
| Sub Crystalline Phase | Crist | LZS | LZS | LZS | LZS | LZS | LZS | LZS | LZS |
| Specific Gravity?g/cm³ | 2.54 | 2.53 | 2.51 | 2.55 | 2.54 | 2.58 | 2.49 | 2.52 | 2.62 |
| Yang's Modulus E??Pa | 83.3 | 78.6 | 80.0 | 76.0 | 78.0 | 79.7 | 76.0 | 76.9 | 79.0 |
| Elastic Modulus Ratio | 32.8 | 31.1 | 31.9 | 29.8 | 30.7 | 30.9 | 30.5 | 30.5 | 30.2 |
| C.T.E | 115 | 100 | 94 | 115 | 99 | 92 | 113 | 105 | 94 |
| Amount of Migration of | 53 | 50 | 49 | 53 | 50 | 48 | 53 | 51 | 49 |
| alkali metal [ppb] | | | | | | | | | |
| P/Pli | 1.3 | 1.3 | 1.3 | 1.3 | 1.3 | 1.2 | 1.3 | 1.3 | 1.2 |

TABLE 6

| | A-46 | A-47 | A-48 | A-49 | A-50 | A-51 | A-52 | A-53 | A-54 |
|---|---|---|---|---|---|---|---|---|---|
| SiO₂ | 67.5 | 65.3 | 67.5 | 66.5 | 66.6 | 66.0 | 67.7 | 67.8 | 66.5 |
| Al₂O₃ | 7.7 | 7.4 | 7.0 | 7.0 | 8.3 | 8.0 | 7.0 | 7.8 | 8.0 |
| MgO | 2.0 | 2.0 | 2.0 | | 2.2 | | 2.1 | 2.1 | 2.1 |
| CaO | 0.9 | | 0.9 | 2.4 | 2.0 | 1.0 | 1.9 | 1.9 | 1.1 |
| BaO | 2.5 | 2.4 | 2.0 | 2.5 | | | | | |
| SrO | | 1.7 | | 2.0 | | 1.5 | | | |
| ZnO | 5.9 | 8.3 | 5.9 | 6.0 | 6.4 | 6.6 | 6.4 | 6.2 | 6.3 |
| Li₂O | 4.0 | 5.9 | 8.0 | 7.1 | 6.6 | 6.9 | 6.5 | 6.5 | 7.0 |
| K₂O | 2.1 | 2.1 | 1.5 | 2.5 | 2.3 | 2.4 | 2.5 | 2.2 | 2.2 |
| B₂O₃ | 1.0 | | | | | | 1.0 | | |
| TiO₂ | 1.1 | | | | | | | | |
| ZrO₂ | 2.6 | 2.5 | 2.6 | 1.1 | 2.8 | 5.0 | 3.5 | 3.0 | 3.3 |
| P₂O₅ | 2.1 | 2.0 | 2.1 | 2.5 | 2.3 | 2.2 | 1.0 | 2.0 | 3.0 |
| Y₂O₃ | | | | | | | | | |
| Nb₂O₅ | | | | | | | | | |
| Ta₂O₅ | | | | | | | | | |
| La₂O₃ | | | | | | | | | |
| Sb₂O₃ | 0.4 | 0.4 | 0.4 | 0.5 | 0.4 | 0.4 | 0.4 | 0.4 | 0.4 |
| Total(100wt %) | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 |
| Temperature??? | | | | | | | | | |
| Melting Time?hr? | 3 | 3 | 3 | 3 | 3 | 3 | 3 | 3 | 3 |
| Nucleating | 550 | 550 | 550 | 550 | 550 | 550 | 550 | 550 | 550 |
| Temperature??? | | | | | | | | | |
| Nucleating Time?hr? | 5 | 5 | 5 | 5 | 5 | 5 | 5 | 5 | 5 |
| Nucleous Growing | 700 | 700 | 700 | 700 | 700 | 700 | 700 | 700 | 700 |
| Temperature??? | | | | | | | | | |
| Nucleous Growing | 10 | 10 | 10 | 10 | 10 | 10 | 10 | 10 | 10 |
| Time?hr? | | | | | | | | | |
| Main Crystalline Phase | Quartz | Crist | Crist | Crist | Crist | Crist | Quartz | Crist | Crist |
| Sub Crystalline Phase | Crist | LZS | LZS | Quartz | Quartz | LZS | Crist | LZS | LZS |
| Specific Gravity?g/cm³ | 2.56 | 2.58 | 2.49 | 2.48 | 2.51 | 2.55 | 2.59 | 2.50 | 2.55 |
| Yang's Modulus E??Pa | 81.6 | 80.0 | 77.0 | 76.0 | 81.6 | 84.0 | 81.6 | 78.0 | 76.0 |
| Elastic Modulus Ratio | 31.9 | 31.0 | 30.9 | 30.6 | 32.5 | 32.9 | 31.5 | 31.2 | 29.8 |
| C.T.E | 111 | 94 | 115 | 121 | 105 | 92 | 115 | 106 | 115 |
| Amount of Migration of | 52 | 49 | 53 | 54 | 51 | 48 | 53 | 51 | 53 |
| alkali metal [ppb] | | | | | | | | | |
| P/Pli | 1.3 | 1.3 | 1.3 | 1.3 | 1.3 | 1.2 | 1.3 | 1.3 | 1.3 |

Tables 7 and 8 show the glass compositions in % by weight of respective crystallized glass substrates of A-55 to A-75, together with the manufacturing conditions employed. Tables 9 and 10 show crystallized glass substrates as A-76 to A-96 manufactured using the same glass compositions as those of A-55 to A-75 with the nucleus growing temperature varied from that employed for A-55 to A-75. Further, Tables 11 and 12 show crystallized glass substrates as A-97 to A-117 manufactured using the same glass compositions as those of A-55 to A-75 with the nucleus growing time varied from that employed for A-55 to A-75.

TABLE 7

| | A-55 | A-56 | A-57 | A-58 | A-59 | A-60 | A-61 | A-62 | A-63 | A-64 | A-65 |
|---|---|---|---|---|---|---|---|---|---|---|---|
| SiO₂ | 65.0 | 67.6 | 70.0 | 66.0 | 66.3 | 66.0 | 68.0 | 68.0 | 66.0 | 68.5 | 67.5 |
| Al₂O₃ | 7.4 | 8.0 | 7.0 | 3.0 | 5.0 | 10.0 | 7.0 | 7.0 | 7.0 | 7.6 | 7.6 |
| MgO | 1.9 | 2.1 | 2.0 | 2.5 | 2.5 | 2.0 | 0.5 | 3.0 | 5.0 | 3.0 | 3.0 |
| CaO | | 1.9 | | | | | 0.3 | 0.3 | 0.3 | | 1.1 |
| BaO | 2.4 | | 1.0 | 3.0 | 2.0 | 2.0 | 0.8 | 0.5 | 0.8 | 2.5 | |
| SrO | 1.6 | | 0.5 | 2.1 | 1.0 | 1.0 | | | 1.5 | 2.0 | |
| ZnO | 8.3 | 6.2 | 6.0 | 7.2 | 7.0 | 6.0 | 7.2 | 6.0 | 6.5 | 3.0 | 5.0 |
| Li₂O | 6.4 | 6.5 | 6.0 | 7.4 | 7.4 | 7.2 | 7.4 | 6.5 | 7.4 | 6.0 | 6.5 |
| K₂O | 2.0 | 2.2 | 1.0 | 2.6 | 2.6 | | 2.6 | 2.1 | 1.1 | 2.0 | 2.1 |
| B₂O₃ | | | | | | | | 0.4 | 0.2 | | |
| TiO₂ | 2.0 | | | | | | | | 0.7 | | |
| ZrO₂ | 2.5 | 2.8 | 2.0 | 3.2 | 3.2 | 3.0 | 3.2 | 3.2 | 2.5 | 3.5 | 2.8 |
| P₂O₅ | 2.0 | 2.2 | 2.1 | 2.6 | 2.6 | 2.3 | 2.6 | 2.6 | 2.0 | 2.0 | 2.0 |
| Y₂O₃ | | | | | | | | | | | |
| Nb₂O₅ | | | | | | | | | | | |
| Ta₂O₅ | | | | | | | | | | | |
| La₂O₃ | | | | | | | | | | | |
| Sb₂O₃ | 0.4 | 0.4 | 0.4 | 0.5 | 0.5 | 0.5 | 0.5 | 0.5 | 0.5 | 0.4 | 0.4 |
| Total(100wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 700 | 700 | 700 | 700 | 700 | 700 | 700 | 700 | 700 | 700 | 700 |
| Growing | | | | | | | | | | | |
| Temperature??? | | | | | | | | | | | |
| Nucleous | 3 | 3 | 3 | 3 | 3 | 3 | 3 | 3 | 3 | 3 | 3 |
| Growing | | | | | | | | | | | |
| Time?hr? | | | | | | | | | | | |
| Main Crystalline | Crist | Crist | Crist | Crist | Crist | LZS | LZS | Crist | Quartz | Crist | Crist |
| Phase | | | | | | | | | | | |
| Sub Crystalline | LZS | LZS | LZS | LZS | LZS | Crist | Crist | LZS | Crist | LZS | LZS |
| Phase | | | | | | | | | | | |
| Specific | 2.56 | 2.51 | 2.60 | 2.62 | 2.58 | 2.53 | 2.57 | 2.55 | 2.58 | 2.53 | 2.54 |
| Gravity?g/cm³ | | | | | | | | | | | |
| Yang's Modulus | 78.1 | 79.6 | 76.3 | 76.0 | 78.0 | 80.2 | 79.0 | 78.0 | 81.4 | 75.8 | 77.0 |
| E??Pa | | | | | | | | | | | |
| Elastic Modulus | 30.5 | 31.7 | 29.3 | 29.0 | 30.2 | 31.7 | 30.7 | 30.6 | 31.6 | 30.0 | 30.3 |
| Ratio | | | | | | | | | | | |
| C.T.E | 90 | 101 | 78 | 115 | 87 | 71 | 76 | 92 | 89 | 98 | 92 |
| Amount of | 53 | 56 | 49 | 64 | 56 | 50 | 53 | 54 | 56 | 54 | 54 |
| Migration of | | | | | | | | | | | |
| alkali metal | | | | | | | | | | | |
| [ppb] | | | | | | | | | | | |
| P/Pli | 1.2 | 1.2 | 1.1 | 1.2 | 1.1 | 1.1 | 1.1 | 1.2 | 1.1 | 1.2 | 1.2 |

TABLE 8

| | A-66 | A-67 | A-68 | A-69 | A-70 | A-71 | A-72 | A-73 | A-74 | A-75 |
|---|---|---|---|---|---|---|---|---|---|---|
| SiO₂ | 66.0 | 67.5 | 68.1 | 68.0 | 67.5 | 67.2 | 67.0 | 67.7 | 67.8 | 66.5 |
| Al₂O₃ | 7.6 | 7.5 | 7.7 | 6.7 | 7.0 | 7.6 | 6.0 | 7.0 | 7.7 | 8.0 |
| MgO | 2.5 | 2.0 | 2.0 | 2.0 | 3.0 | 2.0 | 3.0 | 3.0 | 2.0 | 3.0 |
| CaO | | 0.9 | 0.9 | 0.7 | | | | 1.0 | | 1.0 |
| BaO | 1.0 | 2.5 | | 2.0 | 1.0 | 2.5 | | | | |
| SrO | | | 1.7 | | 1.0 | | 1.8 | | 1.7 | |
| ZnO | 10.0 | 6.0 | 6.0 | 6.0 | 6.0 | 7.3 | 5.1 | 6.4 | 7.3 | 6.3 |
| Li₂O | 6.0 | 4.0 | 6.2 | 8.0 | 7.5 | 6.1 | 6.5 | 6.5 | 6.2 | 7.0 |
| K₂O | 2.1 | 2.1 | 2.1 | 1.5 | 2.5 | 2.1 | 2.0 | 2.5 | 2.1 | 2.2 |
| B₂O₃ | | 1.0 | | | | | | 1.0 | | |
| TiO₂ | | 1.1 | | | 0.6 | | 1.0 | | | |
| ZrO₂ | 2.6 | 2.7 | 2.6 | 2.6 | 1.0 | 2.6 | 5.0 | 3.5 | 2.6 | 2.5 |
| P₂O₅ | 1.8 | 2.2 | 2.1 | 2.1 | 2.5 | 2.1 | 2.2 | 1.0 | 2.1 | 3.0 |
| Nb₂O₅ | | | | | | | | | | |
| Ta₂O₅ | | | | | | | | | | |
| La₂O₃ | | | | | | | | | | |
| Sb₂O₃ | 0.4 | 0.4 | 0.4 | 0.4 | 0.5 | 0.4 | 0.4 | 0.4 | 0.4 | 0.4 |
| Total(100wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 700 | 700 | 700 | 700 | 700 | 700 | 700 | 700 | 700 | 700 |
| Temperature??? | | | | | | | | | | |
| Nucleous Growing | 3 | 3 | 3 | 3 | 3 | 3 | 3 | 3 | 3 | 3 |
| Time?hr? | | | | | | | | | | |
| Main Crystalline | LZS | Quartz | Crist | Crist | Crist | Crist | Crist | Quartz | Crist | Crist |
| Phase | | | | | | | | | | |
| Sub Crystalline | Crist | Crist | LZS | LZS | LZS | LZS | LZS | Crist | LZS | LZS |
| Phase | | | | | | | | | | |
| Specific | 2.62 | 2.57 | 2.52 | 2.53 | 2.52 | 2.52 | 2.57 | 2.57 | 2.52 | 2.56 |
| Gravity?g/cm³ | | | | | | | | | | |
| Yang's Modulus | 81.0 | 79.6 | 78.2 | 77.0 | 78.0 | 79.0 | 76.0 | 79.8 | 77.2 | 76.0 |
| E??Pa | | | | | | | | | | |
| Elastic Modulus | 30.9 | 31.0 | 31.0 | 30.4 | 31.0 | 31.3 | 29.6 | 31.1 | 30.6 | 29.7 |
| Ratio | | | | | | | | | | |
| C.T.E | 72 | 115 | 113 | 118 | 108 | 100 | 88 | 107 | 101 | 110 |
| Amount of | 47 | 48 | 58 | 68 | 62 | 54 | 53 | 58 | 55 | 61 |
| Migration of alkali | | | | | | | | | | |
| metal [ppb] | | | | | | | | | | |
| P/Pli | 1.1 | 1.4 | 1.3 | 1.2 | 1.2 | 1.2 | 1.2 | 1.2 | 1.2 | 1.2 |

TABLE 9

| | A-76 | A-77 | A-78 | A-79 | A-80 | A-81 | A-82 | A-83 | A-84 | A-85 | A-86 |
|---|---|---|---|---|---|---|---|---|---|---|---|
| SiO₂ | 65.0 | 67.6 | 70.0 | 66.0 | 66.3 | 66.0 | 68.0 | 68.0 | 66.0 | 68.5 | 67.5 |
| Al₂O₃ | 7.4 | 8.0 | 7.0 | 3.0 | 5.0 | 10.0 | 7.0 | 7.0 | 7.0 | 7.6 | 7.6 |
| MgO | 1.9 | 2.1 | 2.0 | 2.5 | 2.5 | 2.0 | 0.5 | 3.0 | 5.0 | 3.0 | 3.0 |
| CaO | | 1.9 | | | | | 0.3 | 0.3 | 0.3 | | 1.1 |
| BaO | 2.4 | | 1.0 | 3.0 | 2.0 | 2.0 | 0.8 | 0.5 | 0.8 | 2.5 | |
| SrO | 1.6 | | 0.5 | 2.1 | 1.0 | 1.0 | | | | 1.5 | 2.0 |
| ZnO | 8.3 | 6.2 | 6.0 | 7.2 | 7.0 | 6.0 | 7.2 | 6.0 | 6.5 | 3.0 | 5.0 |
| Li₂O | 6.4 | 6.5 | 6.0 | 7.4 | 7.4 | 7.2 | 7.4 | 6.5 | 7.4 | 6.0 | 6.5 |
| K₂O | 2.0 | 2.2 | 1.0 | 2.6 | 2.6 | | 2.6 | 2.1 | 1.1 | 2.0 | 2.1 |
| B₂O₃ | | | | | | | | 0.4 | 0.2 | | |
| TiO₂ | | | 2.0 | | | | | | 0.7 | | |
| ZrO₂ | 2.5 | 2.8 | 2.0 | 3.2 | 3.2 | 3.0 | 3.2 | 3.2 | 2.5 | 3.5 | 2.8 |
| P₂O₅ | 2.0 | 2.2 | 2.1 | 2.6 | 2.6 | 2.3 | 2.6 | 2.6 | 2.0 | 2.0 | 2.0 |
| Nb₂O₅ | | | | | | | | | | | |
| Ta₂O₅ | | | | | | | | | | | |
| La₂O₃ | | | | | | | | | | | |
| Sb₂O₃ | 0.4 | 0.4 | 0.4 | 0.5 | 0.5 | 0.5 | 0.5 | 0.5 | 0.5 | 0.4 | 0.4 |
| Total(100wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 730 | 730 | 730 | 730 | 730 | 730 | 730 | 730 | 730 | 730 | 730 |
| Growing | | | | | | | | | | | |
| Temperature??? | | | | | | | | | | | |
| Nucleous | 3 | 3 | 3 | 3 | 3 | 3 | 3 | 3 | 3 | 3 | 3 |
| Growing | | | | | | | | | | | |
| Time?hr? | | | | | | | | | | | |
| Main Crystalline | Crist | Crist | Crist | Crist | Crist | Crist | Crist | Crist | Quartz | Crist | Crist |
| Phase | | | | | | | | | | | |
| Sub Crystalline | LZS | LZS | LZS | LZS | LZS | LZS | LZS | LZS | Crist | LZS | LZS |
| Phase | | | | | | | | | | | |
| Specific | 2.55 | 2.50 | 2.59 | 2.61 | 2.57 | 2.52 | 2.56 | 2.54 | 2.60 | 2.52 | 2.53 |
| Gravity?g/cm³ | | | | | | | | | | | |
| Yang's Modulus | 77.6 | 79.1 | 75.8 | 75.5 | 77.5 | 79.7 | 78.5 | 77.5 | 84.8 | 75.3 | 76.5 |
| E??Pa | | | | | | | | | | | |
| Elastic Modulus | 30.4 | 31.6 | 29.3 | 28.9 | 30.2 | 31.6 | 30.7 | 30.5 | 32.6 | 29.9 | 30.3 |
| Ratio | | | | | | | | | | | |
| C.T.E | 101 | 108 | 95 | 117 | 99 | 93 | 95 | 102 | 104 | 106 | 102 |
| Amount of | 50 | 52 | 49 | 53 | 50 | 49 | 49 | 50 | 51 | 51 | 50 |
| Migration of | | | | | | | | | | | |
| alkali metal | | | | | | | | | | | |
| [ppb] | | | | | | | | | | | |
| P/Pli | 1.3 | 1.3 | 1.3 | 1.3 | 1.3 | 1.2 | 1.3 | 1.3 | 1.3 | 1.3 | 1.3 |

TABLE 10

| | A-87 | A-88 | A-89 | A-90 | A-91 | A-92 | A-93 | A-94 | A-95 | A-96 |
|---|---|---|---|---|---|---|---|---|---|---|
| SiO₂ | 66.0 | 67.5 | 68.1 | 68.0 | 67.5 | 67.2 | 67.0 | 67.7 | 67.8 | 66.5 |
| Al₂O₃ | 7.6 | 7.5 | 7.7 | 6.7 | 7.0 | 7.6 | 6.0 | 7.0 | 7.7 | 8.0 |
| MgO | 2.5 | 2.0 | 2.0 | 2.0 | 3.0 | 2.0 | 3.0 | 3.0 | 2.0 | 3.0 |
| CaO | | 0.9 | 0.9 | 0.7 | | | | 1.0 | | 1.0 |
| BaO | 1.0 | 2.5 | | 2.0 | 1.0 | 2.5 | | | | |
| SrO | | | 1.7 | | 1.0 | | 1.8 | | 1.7 | |
| ZnO | 10.0 | 6.0 | 6.0 | 6.0 | 6.0 | 7.3 | 5.1 | 6.4 | 7.3 | 6.3 |
| Li₂O | 6.0 | 4.0 | 6.2 | 8.0 | 7.5 | 6.1 | 6.5 | 6.5 | 6.2 | 7.0 |
| K₂O | 2.1 | 2.1 | 2.1 | 1.5 | 2.5 | 2.1 | 2.0 | 2.5 | 2.1 | 2.2 |
| B₂O₃ | | 1.0 | | | | | | 1.0 | | |
| TiO₂ | | 1.1 | | | 0.6 | | 1.0 | | | |
| ZrO₂ | 2.6 | 2.7 | 2.6 | 2.6 | 1.0 | 2.6 | 5.0 | 3.5 | 2.6 | 2.5 |
| P₂O₅ | 1.8 | 2.2 | 2.1 | 2.1 | 2.5 | 2.1 | 2.2 | 1.0 | 2.1 | 3.0 |
| Y₂O₃ | | | | | | | | | | |
| Nb₂O₅ | | | | | | | | | | |
| Ta₂O₅ | | | | | | | | | | |
| La₂O₃ | | | | | | | | | | |
| Sb₂O₃ | 0.4 | 0.4 | 0.4 | 0.4 | 0.5 | 0.4 | 0.4 | 0.4 | 0.4 | 0.4 |
| Total(100wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 730 | 730 | 730 | 730 | 730 | 730 | 730 | 730 | 730 | 730 |
| Temperature??? | | | | | | | | | | |
| Nucleous Growing | 3 | 3 | 3 | 3 | 3 | 3 | 3 | 3 | 3 | 3 |
| Time?hr? | | | | | | | | | | |
| Main Crystalline | Crist | Quartz | Crist | Crist | Crist | Crist | Crist | Quartz | Crist | Crist |
| Phase | | | | | | | | | | |
| Sub Crystalline | LZS | Crist | Quartz | LZS | LZS | LZS | LZS | Crist | LZS | LZS |
| Phase | | | | | | | | | | |
| Specific | 2.61 | 2.59 | 2.51 | 2.52 | 2.51 | 2.51 | 2.56 | 2.59 | 2.51 | 2.55 |
| Gravity?g/cm³ | | | | | | | | | | |
| Yang's Modulus | 80.5 | 83.0 | 77.7 | 76.5 | 77.5 | 78.5 | 75.5 | 83.2 | 76.7 | 75.5 |
| E??Pa | | | | | | | | | | |
| Elastic Modulus | 30.9 | 32.0 | 31.0 | 30.4 | 30.9 | 31.3 | 29.5 | 32.1 | 30.6 | 29.6 |
| Ratio | | | | | | | | | | |
| C.T.E | 93 | 117 | 116 | 119 | 112 | 107 | 100 | 112 | 108 | 114 |
| Amount of | 49 | 53 | 53 | 54 | 52 | 51 | 50 | 52 | 52 | 53 |
| Migration of alkali | | | | | | | | | | |
| metal [ppb] | | | | | | | | | | |
| P/Pli | 1.2 | 1.3 | 1.3 | 1.3 | 1.3 | 1.3 | 1.3 | 1.3 | 1.3 | 1.3 |

TABLE 11

| | A-97 | A-98 | A-99 | A-100 | A-101 | A-102 | A-103 | A-104 | A-105 | A-106 | A-107 |
|---|---|---|---|---|---|---|---|---|---|---|---|
| SiO₂ | 65.0 | 67.6 | 70.0 | 66.0 | 66.3 | 66.0 | 68.0 | 68.0 | 66.0 | 68.5 | 67.5 |
| Al₂O₃ | 7.4 | 8.0 | 7.0 | 3.0 | 5.0 | 10.0 | 7.0 | 7.0 | 7.0 | 7.6 | 7.6 |
| MgO | 1.9 | 2.1 | 2.0 | 2.5 | 2.5 | 2.0 | 0.5 | 3.0 | 5.0 | 3.0 | 3.0 |
| CaO | | 1.9 | | | | | 0.3 | 0.3 | 0.3 | | 1.1 |
| BaO | 2.4 | | 1.0 | 3.0 | 2.0 | 2.0 | 0.8 | 0.5 | 0.8 | 2.5 | |
| SrO | 1.6 | | 0.5 | 2.1 | 1.0 | 1.0 | | | | 1.5 | 2.0 |
| ZnO | 8.3 | 6.2 | 6.0 | 7.2 | 7.0 | 6.0 | 7.2 | 6.0 | 6.5 | 3.0 | 5.0 |
| Li₂O | 6.4 | 6.5 | 6.0 | 7.4 | 7.4 | 7.2 | 7.4 | 6.5 | 7.4 | 6.0 | 6.5 |
| K₂O | 2.0 | 2.2 | 1.0 | 2.6 | 2.6 | | 2.6 | 2.1 | 1.1 | 2.0 | 2.1 |
| B₂O₃ | | | | | | | | 0.4 | 0.2 | | |
| TiO₂ | | | 2.0 | | | | | | 0.7 | | |
| ZrO₂ | 2.5 | 2.8 | 2.0 | 3.2 | 3.2 | 3.0 | 3.2 | 3.2 | 2.5 | 3.5 | 2.8 |
| P₂O₅ | 2.0 | 2.2 | 2.1 | 2.6 | 2.6 | 2.3 | 2.6 | 2.6 | 2.0 | 2.0 | 2.0 |
| Y₂O₃₃ | | | | | | | | | | | |
| Nb₂O₅ | | | | | | | | | | | |
| Ta₂O₅ | | | | | | | | | | | |
| La₂O₃ | | | | | | | | | | | |
| Sb₂O₃ | 0.4 | 0.4 | 0.4 | 0.5 | 0.5 | 0.5 | 0.5 | 0.5 | 0.5 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 700 | 700 | 700 | 700 | 700 | 700 | 700 | 700 | 700 | 700 | 700 |
| Growing | | | | | | | | | | | |
| Temperature??? | | | | | | | | | | | |
| Nucleous | 10 | 10 | 10 | 10 | 10 | 10 | 10 | 10 | 10 | 10 | 10 |
| Growing | | | | | | | | | | | |
| Time?hr? | | | | | | | | | | | |
| Main Crystalline | Crist | Crist | Crist | Crist | Crist | Crist | Crist | Crist | Quartz | Crist | Crist |
| Phase | | | | | | | | | | | |
| Sub Crystalline | LZS | LZS | LZS | LZS | LZS | LZS | LZS | LZS | Crist | LZS | LZS |
| Phase | | | | | | | | | | | |
| Specific | 2.55 | 2.53 | 2.51 | 2.55 | 2.54 | 2.58 | 2.49 | 2.52 | 2.59 | 2.53 | 2.58 |
| Gravity?g/cm³ | | | | | | | | | | | |
| Yong's Modulus | 77.2 | 78.6 | 80.0 | 76.0 | 78.0 | 79.7 | 76.0 | 76.9 | 83.8 | 76.0 | 80.0 |
| E??Pa | | | | | | | | | | | |
| Elastic Modulus | 30.2 | 31.1 | 31.9 | 29.8 | 30.7 | 30.9 | 30.5 | 30.5 | 32.3 | 30.0 | 31.0 |
| Ratio | | | | | | | | | | | |
| C.T.E | 100 | 107 | 94 | 117 | 99 | 92 | 93 | 102 | 105 | 105 | 102 |
| Amount of | 50 | 51 | 49 | 53 | 50 | 48 | 49 | 50 | 51 | 51 | 50 |
| Migration of | | | | | | | | | | | |
| alkali metal | | | | | | | | | | | |
| [ppb] | | | | | | | | | | | |
| P/Pli | 1.3 | 1.3 | 1.3 | 1.3 | 1.3 | 1.2 | 1.2 | 1.3 | 1.3 | 1.3 | 1.3 |

TABLE 12

| | A-108 | A-109 | A-110 | A-111 | A-112 | A-113 | A-114 | A-115 | A-116 | A-117 |
|---|---|---|---|---|---|---|---|---|---|---|
| SiO₂ | 66.0 | 67.5 | 68.1 | 68.0 | 67.5 | 67.2 | 67.0 | 67.7 | 67.8 | 66.5 |
| Al₂O₃ | 7.6 | 7.5 | 7.7 | 6.7 | 7.0 | 7.6 | 6.0 | 7.0 | 7.7 | 8.0 |
| MgO | 2.5 | 2.0 | 2.0 | 2.0 | 3.0 | 2.0 | 3.0 | 3.0 | 2.0 | 3.0 |
| CaO | | 0.9 | 0.9 | 0.7 | | | | 1.0 | | 1.0 |
| BaO | 1.0 | 2.5 | | 2.0 | 1.0 | 2.5 | | | | |
| SrO | | | 1.7 | | 1.0 | | 1.8 | | 1.7 | |
| ZnO | 10.0 | 6.0 | 6.0 | 6.0 | 6.0 | 7.3 | 5.1 | 6.4 | 7.3 | 6.3 |
| Li₂O | 6.0 | 4.0 | 6.2 | 8.0 | 7.5 | 6.1 | 6.5 | 6.5 | 6.2 | 7.0 |
| K₂O | 2.1 | 2.1 | 2.1 | 1.5 | 2.5 | 2.1 | 2.0 | 2.5 | 2.1 | 2.2 |
| B₂O₃ | | 1.0 | | | | | | 1.0 | | |
| TiO₂ | | 1.1 | | | 0.6 | | 1.0 | | | |
| ZrO₂ | 2.6 | 2.7 | 2.6 | 2.6 | 1.0 | 2.6 | 5.0 | 3.5 | 2.6 | 2.5 |
| P₂O₅ | 1.8 | 2.2 | 2.1 | 2.1 | 2.5 | 2.1 | 2.2 | 1.0 | 2.1 | 3.0 |
| Y₂O₃ | | | | | | | | | | |
| Nb₂O₅ | | | | | | | | | | |
| Ta₂O₅ | | | | | | | | | | |
| La₂O₃ | | | | | | | | | | |
| Sb₂O₃ | 0.4 | 0.4 | 0.4 | 0.4 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 700 | 700 | 700 | 700 | 700 | 700 | 700 | 700 | 700 | 700 |
| Temperature??? | | | | | | | | | | |
| Nucleous Growing | 10 | 10 | 10 | 10 | 10 | 10 | 10 | 10 | 10 | 10 |
| Time?hr? | | | | | | | | | | |
| Main Crystalline | Crist | Quartz | Crist | Crist | Crist | Crist | Crist | Quartz | Crist | Crist |
| Phase | | | | | | | | | | |
| Sub Crystalline | LZS | Crist | LZS | LZS | LZS | LZS | LZS | Crist | LZS | LZS |
| Phase | | | | | | | | | | |
| Specific | 2.49 | 2.58 | 2.51 | 2.55 | 2.48 | 2.50 | 2.55 | 2.58 | 2.50 | 2.55 |
| Gravity?g/cm³ | | | | | | | | | | |
| Yong's Modulus | 77.0 | 81.9 | 81.6 | 84.0 | 78.0 | 78.0 | 76.0 | 82.2 | 78.0 | 76.0 |
| E??Pa | | | | | | | | | | |
| Elastic Modulus | 30.9 | 31.7 | 32.5 | 32.9 | 31.5 | 31.2 | 29.8 | 31.8 | 31.2 | 29.8 |
| Ratio | | | | | | | | | | |
| C.T.E | 92 | 118 | 115 | 119 | 112 | 106 | 99 | 113 | 107 | 113 |
| Amount of | 48 | 54 | 53 | 54 | 52 | 51 | 50 | 53 | 51 | 53 |
| Migration of alkali | | | | | | | | | | |
| metal [ppb] | | | | | | | | | | |
| P/Pli | 1.2 | 1.3 | 1.3 | 1.3 | 1.3 | 1.3 | 1.3 | 1.3 | 1.3 | 1.3 |

Tables 13 and 14 show the glass compositions in % by weight of respective crystallized glass substrates of A-1 18 to A-138, together with the manufacturing conditions employed. Tables 15 and 16 show crystallized glass substrates as A-139 to A-159 manufactured using the same glass compositions as those of A-118 to A-138 with the nucleus growing temperature varied from that employed for A-118 to A-138. Further, Tables 17 and 18 show crystallized glass substrates as A-160 to A-1 80 manufactured using the same glass compositions as those of A-118 to A-138 with the nucleus growing time varied from that employed for A-118 to A-138.

TABLE 13

| | A-118 | A-119 | A-120 | A-121 | A-122 | A-123 | A-124 | A-125 | A-126 | A-127 | A-128 |
|---|---|---|---|---|---|---|---|---|---|---|---|
| SiO₂ | 65.6 | 67.5 | 70.0 | 66.1 | 66.3 | 65.4 | 68.5 | 67.0 | 67.0 | 68.5 | 67.5 |
| Al₂O₃ | 8.5 | 7.7 | 7.0 | 3.0 | 5.0 | 10.0 | 7.6 | 7.6 | 7.6 | 7.6 | 7.6 |
| MgO | 2.2 | 2.0 | 2.0 | 1.6 | 2.0 | 1.0 | 2.0 | | 2.0 | 2.0 | |
| CaO | 2.1 | 0.9 | 2.0 | 3.0 | 3.0 | 3.0 | 0.5 | 3.7 | 5.0 | 2.0 | 2.0 |
| BaO | | 2.5 | 1.0 | 2.0 | | | | 2.5 | | 1.0 | 1.0 |
| SrO | | | | 1.0 | | 0.5 | | | | | 2.0 |
| ZnO | 6.6 | 5.9 | 6.0 | 7.0 | 7.2 | 5.0 | 6.0 | 5.9 | 5.0 | 3.0 | 5.0 |
| Li₂O | 6.8 | 6.1 | 6.0 | 7.5 | 8.0 | 7.2 | 7.2 | 6.1 | 6.1 | 7.0 | 6.0 |
| K₂O | 2.4 | 2.1 | 1.1 | 2.6 | 2.1 | 1.8 | 2.2 | 2.1 | 2.1 | | 2.1 |
| B₂O₃ | | | | | | | | | | 2.9 | |
| TiO₂ | | | | | | | | | | | 1.7 |
| ZrO₂ | 2.9 | 2.6 | 2.5 | 3.2 | 3.4 | 3.1 | 3.5 | 2.6 | 2.6 | 3.5 | 2.6 |
| P₂O₅ | 2.4 | 2.1 | 2.0 | 2.6 | 2.6 | 2.5 | 2.1 | 2.1 | 2.2 | 2.1 | 2.1 |
| Y₂O₃ | | | | | | | | | | | |
| Nb₂O₅ | | | | | | | | | | | |
| Ta₂O₅ | | | | | | | | | | | |
| La₂O₃ | | | | | | | | | | | |
| Sb₂O₃ | 0.4 | 0.4 | 0.4 | 0.5 | 0.5 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 700 | 700 | 700 | 700 | 700 | 700 | 700 | 700 | 700 | 700 | 700 |
| Growing | | | | | | | | | | | |
| Temperature??? | | | | | | | | | | | |
| Nucleous | 3 | 3 | 3 | 3 | 3 | 3 | 3 | 3 | 3 | 3 | 3 |
| Growing | | | | | | | | | | | |
| Time?hr? | | | | | | | | | | | |
| Main Crystalline | Crist | Crist | Crist | Crist | Crist | Crist | Crist | Crist | Crist | Quartz | Crist |
| Phase | | | | | | | | | | | |
| Sub Crystalline | LZS | LZS | LZS | Quartz | LZS | LZS | LZS | LZS | LZS | Crist | LZS |
| Phase | | | | | | | | | | | |
| Specific | 2.52 | 2.52 | 2.48 | 2.56 | 2.50 | 2.48 | 2.52 | 2.57 | 2.47 | 2.54 | 2.57 |
| Gravity?g/cm³ | | | | | | | | | | | |
| Yong's Modulus | 80.9 | 77.8 | 76.0 | 75.0 | 79.3 | 82.8 | 77.9 | 78.0 | 82.0 | 78.9 | 77.0 |
| E??Pa | | | | | | | | | | | |
| Elastic Modulus | 32.1 | 30.9 | 30.6 | 29.3 | 31.7 | 33.4 | 30.9 | 30.4 | 33.2 | 31.1 | 30.0 |
| Ratio | | | | | | | | | | | |
| C.T.E | 91 | 88 | 97 | 112 | 118 | 83 | 98 | 108 | 88 | 116 | 96 |
| Amount of | 55 | 52 | 53 | 64 | 68 | 54 | 58 | 56 | 51 | 62 | 53 |
| Migration of | | | | | | | | | | | |
| alkali metal | | | | | | | | | | | |
| [ppb] | | | | | | | | | | | |
| P/Pli | 1.2 | 1.2 | 1.2 | 1.2 | 1.2 | 1.1 | 1.2 | 1.2 | 1.2 | 1.2 | 1.2 |

TABLE 14

| | A-129 | A-130 | A-131 | A-132 | A-133 | A-134 | A-135 | A-136 | A-137 | A-138 |
|---|---|---|---|---|---|---|---|---|---|---|
| SiO₂ | 66.0 | 68.0 | 68.6 | 68.1 | 66.5 | 68.0 | 66.6 | 67.7 | 68.3 | 66.5 |
| Al₂O₃ | 6.0 | 5.9 | 7.8 | 7.0 | 6.0 | 5.0 | 5.0 | 7.0 | 7.7 | 8.0 |
| MgO | 2.3 | | 2.1 | | | | | 2.1 | 2.0 | 2.1 |
| CaO | 2.0 | 2.0 | 1.9 | 2.0 | 3.0 | 3.0 | 3.0 | 2.0 | 0.9 | 2.0 |
| BaO | 0.5 | 1.0 | | 1.0 | 2.3 | 2.0 | | | | |
| SrO | | 1.0 | | | 2.0 | 1.0 | 1.5 | | | |
| ZnO | 10.0 | 5.9 | 6.1 | 5.9 | 6.0 | 6.5 | 6.6 | 6.4 | 7.4 | 5.7 |
| Li₂O | 7.0 | 4.0 | 6.2 | 8.0 | 7.5 | 7.0 | 7.3 | 6.9 | 6.2 | 7.0 |
| K₂O | 1.0 | 2.1 | 2.2 | 1.5 | 2.7 | 1.5 | 2.4 | 2.5 | 2.2 | 2.2 |
| B₂O₃ | | 1.0 | | | | | | 1.0 | | |
| TiO₂ | | 3.0 | | | | | | | | |
| ZrO₂ | 2.6 | 3.5 | 2.7 | 4.0 | 1.1 | 3.2 | 5.0 | 3.0 | 2.7 | 3.0 |
| P₂O₅ | 2.2 | 2.1 | 2.2 | 2.1 | 2.5 | 2.4 | 2.2 | 1.0 | 2.1 | 3.0 |
| Nb₂O₅ | | | | | | | | | | |
| Ta₂O₅ | | | | | | | | | | |
| La₂O₃ | | | | | | | | | | |
| Sb₂O₃ | 0.4 | 0.4 | 0.4 | 0.4 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 700 | 700 | 700 | 700 | 700 | 700 | 700 | 700 | 700 | 700 |
| Temperature??? | | | | | | | | | | |
| Nucleous Growing | 3 | 3 | 3 | 3 | 3 | 3 | 3 | 3 | 3 | 3 |
| Time?hr? | | | | | | | | | | |
| Main Crystalline | LZS | Quartz | Crist | Crist | Crist | Crist | Crist | Quartz | Crist | Crist |
| Phase | | | | | | | | | | |
| Sub Crystalline | Crist | Crist | LZS | LZS | LZS | LZS | LZS | Crist | LZS | LZS |
| Phase | | | | | | | | | | |
| Specific | 2.63 | 2.61 | 2.51 | 2.55 | 2.54 | 2.53 | 2.50 | 2.53 | 2.51 | 2.54 |
| Gravity?g/cm³ | | | | | | | | | | |
| Yong's Modulus | 83.1 | 81.3 | 77.6 | 79.2 | 77.0 | 78.3 | 79.3 | 78.9 | 77.7 | 79.8 |
| E??Pa | | | | | | | | | | |
| Elastic Modulus | 31.6 | 31.1 | 30.9 | 31.1 | 30.3 | 30.9 | 31.7 | 31.2 | 31.0 | 31.4 |
| Ratio | | | | | | | | | | |
| C.T.E | 72 | 96 | 114 | 106 | 113 | 109 | 106 | 99 | 103 | 112 |
| Amount of | 50 | 45 | 58 | 64 | 64 | 61 | 61 | 57 | 56 | 61 |
| Migration of alkali | | | | | | | | | | |
| metal [ppb] | | | | | | | | | | |
| P/Pli | 1.1 | 1.3 | 1.3 | 1.2 | 1.2 | 1.2 | 1.2 | 1.2 | 1.2 | 1.2 |

TABLE 15

| | A-139 | A-140 | A-141 | A-142 | A-143 | A-144 | A-145 | A146 | A-147 | A-148 | A-149 |
|---|---|---|---|---|---|---|---|---|---|---|---|
| SiO₂ | 65.6 | 67.5 | 70.0 | 66.1 | 66.3 | 65.4 | 68.5 | 67.0 | 67.0 | 68.5 | 67.5 |
| Al₂O₃ | 8.5 | 7.7 | 7.0 | 3.0 | 5.0 | 10.0 | 7.6 | 7.6 | 7.6 | 7.6 | 7.6 |
| MgO | 2.2 | 2.0 | 2.0 | 1.6 | 2.0 | 1.0 | 2.0 | | 2.0 | 2.0 | |
| CaO | 2.1 | 0.9 | 2.0 | 3.0 | 3.0 | 3.0 | 0.5 | 3.7 | 5.0 | 2.0 | 2.0 |
| BaO | | 2.5 | 1.0 | 2.0 | | | | 2.5 | | 1.0 | 1.0 |
| SrO | | | | 1.0 | | 0.5 | | | | | 2.0 |
| ZnO | 6.6 | 5.9 | 6.0 | 7.0 | 7.2 | 5.0 | 6.0 | 5.9 | 5.0 | 3.0 | 5.0 |
| Li₂O | 6.8 | 6.1 | 6.0 | 7.5 | 8.0 | 7.2 | 7.2 | 6.1 | 6.1 | 7.0 | 6.0 |
| K₂O | 2.4 | 2.1 | 1.1 | 2.6 | 2.1 | 1.8 | 2.2 | 2.1 | 2.1 | | 2.1 |
| B₂O₃ | | | | | | | | | | 2.9 | |
| TiO₂ | | | | | | | | | | | 1.7 |
| ZrO₂ | 2.9 | 2.6 | 2.5 | 3.2 | 3.4 | 3.1 | 3.5 | 2.6 | 2.6 | 3.5 | 2.6 |
| P₂O₅ | 2.4 | 2.1 | 2.0 | 2.6 | 2.6 | 2.5 | 2.1 | 2.1 | 2.2 | 2.1 | 2.1 |
| Y₂O₃ | | | | | | | | | | | |
| Nb₂O₅ | | | | | | | | | | | |
| Ta₂O₅ | | | | | | | | | | | |
| La₂O₃ | | | | | | | | | | | |
| Sb₂O₃ | 0.4 | 0.4 | 0.4 | 0.5 | 0.5 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 730 | 730 | 730 | 730 | 730 | 730 | 730 | 730 | 730 | 730 | 730 |
| Growing | | | | | | | | | | | |
| Temperature??? | | | | | | | | | | | |
| Nucleous | 3 | 3 | 3 | 3 | 3 | 3 | 3 | 3 | 3 | 3 | 3 |
| Growing | | | | | | | | | | | |
| Time?hr? | | | | | | | | | | | |
| Main Crystalline | Quartz | Crist | Quartz | Quartz | Quartz | Quartz | Crist | Crist | Quartz | Quartz | Crist |
| Phase | | | | | | | | | | | |
| Sub Crystalline | Crist | LZS | Crist | Crist | LAS | LAS | LZS | Quartz | Crist | Crist | LZS |
| Phase | | | | | | | | | | | |
| Specific | 2.55 | 2.51 | 2.47 | 2.57 | 2.53 | 2.51 | 2.51 | 2.56 | 2.48 | 2.56 | 2.56 |
| Gravity?g/cm³ | | | | | | | | | | | |
| Yong's Modulus | 82.0 | 77.3 | 75.5 | 76.0 | 81.0 | 85.2 | 77.4 | 77.5 | 83.0 | 82.2 | 76.5 |
| E??Pa | | | | | | | | | | | |
| Elastic Modulus | 32.2 | 30.8 | 30.6 | 29.6 | 32.0 | 33.9 | 30.8 | 30.3 | 33.5 | 32.1 | 29.9 |
| Ratio | | | | | | | | | | | |
| C.T.E | 115 | 117 | 115 | 115 | 119 | 102 | 106 | 112 | 108 | 118 | 104 |
| Amount of | 53 | 53 | 53 | 53 | 54 | 50 | 51 | 52 | 52 | 54 | 51 |
| Migration of | | | | | | | | | | | |
| alkali metal | | | | | | | | | | | |
| [ppb] | | | | | | | | | | | |
| P/Pli | 1.3 | 1.3 | 1.3 | 1.3 | 1.3 | 1.3 | 1.3 | 1.3 | 1.3 | 1.3 | 1.3 |

TABLE 16

| | A-150 | A-151 | A-152 | A-153 | A-154 | A-155 | A-156 | A-157 | A-158 | A-159 |
|---|---|---|---|---|---|---|---|---|---|---|
| SiO₂ | 66.0 | 68.0 | 68.6 | 68.1 | 66.5 | 68.0 | 66.6 | 67.7 | 68.3 | 66.5 |
| Al₂O₃ | 6.0 | 5.9 | 7.8 | 7.0 | 6.0 | 5.0 | 5.0 | 7.0 | 7.7 | 8.0 |
| MgO | 2.3 | | 2.1 | | | | | 2.1 | 2.0 | 2.1 |
| CaO | 2.0 | 2.0 | 1.9 | 2.0 | 3.0 | 3.0 | 3.0 | 2.0 | 0.9 | 2.0 |
| BaO | 0.5 | 1.0 | | 1.0 | 2.3 | 2.0 | | | | |
| SrO | | 1.0 | | | 2.0 | 1.0 | 1.5 | | | |
| ZnO | 10.0 | 5.9 | 6.1 | 5.9 | 6.0 | 6.5 | 6.6 | 6.4 | 7.4 | 5.7 |
| Li₂O | 7.0 | 4.0 | 6.2 | 8.0 | 7.5 | 7.0 | 7.3 | 6.9 | 6.2 | 7.0 |
| K₂O | 1.0 | 2.1 | 2.2 | 1.5 | 2.7 | 1.5 | 2.4 | 2.5 | 2.2 | 2.2 |
| B₂O₃ | | 1.0 | | | | | | 1.0 | | |
| TiO₂ | | 3.0 | | | | | | | | |
| ZrO₂ | 2.6 | 3.5 | 2.7 | 4.0 | 1.1 | 3.2 | 5.0 | 3.0 | 2.7 | 3.0 |
| P₂O₅ | 2.2 | 2.1 | 2.2 | 2.1 | 2.5 | 2.4 | 2.2 | 1.0 | 2.1 | 3.0 |
| Y₂O₃ | | | | | | | | | | |
| Nb₂O₅ | | | | | | | | | | |
| Ta₂O₅ | | | | | | | | | | |
| La₂O₃ | | | | | | | | | | |
| Sb₂O₃ | 0.4 | 0.4 | 0.4 | 0.4 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 730 | 730 | 730 | 730 | 730 | 730 | 730 | 730 | 730 | 730 |
| Temperature??? | | | | | | | | | | |
| Nucleous Growing | 3 | 3 | 3 | 3 | 3 | 3 | 3 | 3 | 3 | 3 |
| Time?hr? | | | | | | | | | | |
| Main Crystalline | Crist | Quartz | Crist | Crist | Crist | Crist | Crist | Quartz | Crist | Crist |
| Phase | | | | | | | | | | |
| Sub Crystalline | LZS | Crist | Quartz | Quartz | LZS | LZS | Quartz | Crist | LZS | Quartz |
| Phase | | | | | | | | | | |
| Specific | 2.62 | 2.63 | 2.52 | 2.55 | 2.53 | 2.52 | 2.51 | 2.55 | 2.50 | 2.54 |
| Gravity?g/cm³ | | | | | | | | | | |
| Yong's Modulus | 82.6 | 84.7 | 78.2 | 79.3 | 76.5 | 77.8 | 80.2 | 82.2 | 77.2 | 80.3 |
| E??Pa | | | | | | | | | | |
| Elastic Modulus | 31.5 | 32.2 | 31.0 | 31.1 | 30.3 | 30.9 | 32.0 | 32.2 | 30.9 | 31.6 |
| Ratio | | | | | | | | | | |
| C.T.E | 88 | 107 | 116 | 111 | 116 | 113 | 116 | 108 | 109 | 115 |
| Amount of | 48 | 51 | 53 | 52 | 53 | 53 | 53 | 52 | 52 | 53 |
| Migration of alkali | | | | | | | | | | |
| metal [ppb] | | | | | | | | | | |
| P/Pli | 1.2 | 1.3 | 1.3 | 1.3 | 1.3 | 1.3 | 1.3 | 1.3 | 1.3 | 1.3 |

TABLE 17

| | A-160 | A-161 | A-162 | A-163 | A-164 | A-165 | A-166 | A-167 | A-168 | A-169 | A-170 |
|---|---|---|---|---|---|---|---|---|---|---|---|
| SiO₂ | 65.6 | 67.5 | 70.0 | 66.1 | 66.3 | 65.4 | 68.5 | 67.0 | 67.0 | 68.5 | 67.5 |
| Al₂O₃ | 8.5 | 7.7 | 7.0 | 3.0 | 5.0 | 10.0 | 7.6 | 7.6 | 7.6 | 7.6 | 7.6 |
| MgO | 2.2 | 2.0 | 2.0 | 1.6 | 2.0 | 1.0 | 2.0 | | 2.0 | 2.0 | |
| CaO | 2.1 | 0.9 | 2.0 | 3.0 | 3.0 | 3.0 | 0.5 | 3.7 | 5.0 | 2.0 | 2.0 |
| BaO | | 2.5 | 1.0 | 2.0 | | | | 2.5 | | 1.0 | 1.0 |
| SrO | | | | 1.0 | | 0.5 | | | | | 2.0 |
| ZnO | 6.6 | 5.9 | 6.0 | 7.0 | 7.2 | 5.0 | 6.0 | 5.9 | 5.0 | 3.0 | 5.0 |
| Li₂O | 6.8 | 6.1 | 6.0 | 7.5 | 8.0 | 7.2 | 7.2 | 6.1 | 6.1 | 7.0 | 6.0 |
| K₂O | 2.4 | 2.1 | 1.1 | 2.6 | 2.1 | 1.8 | 2.2 | 2.1 | 2.1 | | 2.1 |
| B₂O₃ | | | | | | | | | | 2.9 | |
| TiO₂ | | | | | | | | | | | 1 .7 |
| ZrO₂ | 2.9 | 2.6 | 2.5 | 3.2 | 3.4 | 3.1 | 3.5 | 2.6 | 2.6 | 3.5 | 2.6 |
| P₂O₅ | 2.4 | 2.1 | 2.0 | 2.6 | 2.6 | 2.5 | 2.1 | 2.1 | 2.2 | 2.1 | 2.1 |
| Y₂O₃ | | | | | | | | | | | |
| Nb₂O₅ | | | | | | | | | | | |
| Ta₂O₅ | | | | | | | | | | | |
| La₂O₃ | | | | | | | | | | | |
| Sb₂O₃ | 0.4 | 0.4 | 0.4 | 0.5 | 0.5 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 700 | 700 | 700 | 700 | 700 | 700 | 700 | 700 | 700 | 700 | 700 |
| Growing | | | | | | | | | | | |
| Temperature??? | | | | | | | | | | | |
| Nucleous | 10 | 10 | 10 | 10 | 10 | 10 | 10 | 10 | 10 | 10 | 10 |
| Growing | | | | | | | | | | | |
| Time?hr? | | | | | | | | | | | |
| Main Crystalline | Crist | Crist | Crist | Quartz | Quartz | Quartz | Crist | Crist | Crist | Quartz | Crist |
| Phase | | | | | | | | | | | |
| Sub Crystalline | Quartz | LZS | Quartz | Crist | LZS | Crist | LZS | LZS | Quartz | Crist | LZS |
| Phase | | | | | | | | | | | |
| Specific | 2.54 | 2.53 | 2.51 | 2.57 | 2.52 | 2.50 | 2.51 | 2.56 | 2.49 | 2.55 | 2.56 |
| Gravity?g/cm³ | | | | | | | | | | | |
| Yong's Modulus | 81.6 | 78.6 | 80.0 | 76.3 | 80.0 | 83.1 | 77.5 | 77.6 | 82.3 | 81.2 | 76.6 |
| E??Pa | | | | | | | | | | | |
| Elastic Modulus | 32.1 | 31.1 | 31.9 | 29.7 | 31.7 | 33.2 | 30.8 | 30.3 | 33.1 | 31.8 | 29.9 |
| Ratio | | | | | | | | | | | |
| C.T.E | 110 | 108 | 112 | 115 | 119 | 97 | 105 | 112 | 99 | 119 | 104 |
| Amount of | 52 | 52 | 52 | 53 | 54 | 49 | 51 | 52 | 50 | 54 | 51 |
| Migration of | | | | | | | | | | | |
| alkali metal | | | | | | | | | | | |
| [ppb] | | | | | | | | | | | |
| P/Pli | 1.3 | 1.3 | 1.3 | 1.3 | 1.3 | 1.3 | 1.3 | 1.3 | 1.3 | 1.3 | 1.3 |

TABLE 18

| | A-171 | A-172 | A-173 | A-174 | A-175 | A-176 | A-177 | A-178 | A-179 | A-180 |
|---|---|---|---|---|---|---|---|---|---|---|
| SiO₂ | 66.0 | 68.0 | 68.6 | 68.1 | 66.5 | 68.0 | 66.6 | 67.7 | 68.3 | 66.5 |
| Al₂O₃ | 6.0 | 5.9 | 7.8 | 7.0 | 6.0 | 5.0 | 5.0 | 7.0 | 7.7 | 8.0 |
| MgO | 2.3 | | 2.1 | | | | | 2.1 | 2.0 | 2.1 |
| CaO | 2.0 | 2.0 | 1.9 | 2.0 | 3.0 | 3.0 | 3.0 | 2.0 | 0.9 | 2.0 |
| BaO | 0.5 | 1.0 | | 1.0 | 2.3 | 2.0 | | | | |
| SrO | | 1.0 | | | 2.0 | 1.0 | 1.5 | | | |
| ZnO | 10.0 | 5.9 | 6.1 | 5.9 | 6.0 | 6.5 | 6.6 | 6.4 | 7.4 | 5.7 |
| Li₂O | 7.0 | 4.0 | 6.2 | 8.0 | 7.5 | 7.0 | 7.3 | 6.9 | 6.2 | 7.0 |
| K₂O | 1.0 | 2.1 | 2.2 | 1.5 | 2.7 | 1.5 | 2.4 | 2.5 | 2.2 | 2.2 |
| B₂O₃ | | 1.0 | | | | | | 1.0 | | |
| TiO₂ | | 3.0 | | | | | | | | |
| ZrO₂ | 2.6 | 3.5 | 2.7 | 4.0 | 1.1 | 3.2 | 5.0 | 3.0 | 2.7 | 3.0 |
| P₂O₅ | 2.2 | 2.1 | 2.2 | 2.1 | 2.5 | 2.4 | 2.2 | 1.0 | 2.1 | 3.0 |
| Y₂O₃ | | | | | | | | | | |
| Nb₂O₅ | | | | | | | | | | |
| Ta₂O₅ | | | | | | | | | | |
| La₂O₃ | | | | | | | | | | |
| Sb₂O₃ | 0.4 | 0.4 | 0.4 | 0.4 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 700 | 700 | 700 | 700 | 700 | 700 | 700 | 700 | 700 | 700 |
| Temperature??? | | | | | | | | | | |
| Nucleous Growing | 10 | 10 | 10 | 10 | 10 | 10 | 10 | 10 | 10 | 10 |
| Time?hr? | | | | | | | | | | |
| Main Crystalline | LZS | Quartz | Crist | Crist | Crist | Crist | Crist | Quartz | Crist | Crist |
| Phase | | | | | | | | | | |
| Sub Crystalline | Crist | Crist | LZS | LZS | LZS | LZS | LZS | Crist | LZS | LZS |
| Phase | | | | | | | | | | |
| Specific | 2.62 | 2.62 | 2.50 | 2.54 | 2.53 | 2.52 | 2.49 | 2.54 | 2.50 | 2.53 |
| Gravity?g/cm³ | | | | | | | | | | |
| Yong's Modulus | 82.6 | 83.7 | 77.2 | 78.8 | 76.6 | 77.9 | 78.9 | 81.2 | 77.3 | 79.4 |
| E??Pa | | | | | | | | | | |
| Elastic Modulus | 31.5 | 31.9 | 30.8 | 31.0 | 30.2 | 30.9 | 31.6 | 32.0 | 30.9 | 31.3 |
| Ratio | | | | | | | | | | |
| C.T.E | 76 | 108 | 116 | 111 | 115 | 113 | 111 | 109 | 108 | 115 |
| Amount of | 45 | 52 | 53 | 52 | 53 | 53 | 52 | 52 | 52 | 53 |
| Migration of alkali | | | | | | | | | | |
| metal [ppb] | | | | | | | | | | |
| P/Pli | 1.2 | 1.3 | 1.3 | 1.3 | 1.3 | 1.3 | 1.3 | 1.3 | 1.3 | 1.3 |

Tables 19 and 20 show the glass compositions in % by weight of respective crystallized glass substrates of A-181 to A-201, together with the manufacturing conditions employed. Tables 21 and 22 show crystallized glass substrates as A-202 to A-222 manufactured using the some glass compositions as those of A-181 to A-201 with the nucleus growing temperature varied from that employed for A-181 to A-201. Further, Tables 23 and 24 show crystallized glass substrates as A-223 to A-243 manufactured using the same glass compositions as those of A-181 to A-201 with the nucleus growing time varied from that employed for A-181 to A-201.

TABLE 19

| | A-181 | A-182 | A-183 | A-184 | A-185 | A-186 | A-187 | A-188 | A-189 | A-190 | A-191 |
|---|---|---|---|---|---|---|---|---|---|---|---|
| SiO₂ | 65.0 | 67.0 | 69.5 | 67.0 | 67.0 | 68.0 | 66.1 | 66.0 | 66.5 | 68.5 | 67.5 |
| Al₂O₃ | 4.1 | 7.6 | 7.0 | 3.0 | 5.0 | 10.0 | 6.0 | 7.8 | 7.5 | 7.6 | 7.6 |
| MgO | 2.4 | 2.0 | 2.0 | | | | | 2.1 | 2.0 | 2.0 | 2.0 |
| CaO | | | | 2.4 | 1.0 | 1.0 | | | | | 1.1 |
| BaO | 3.0 | 2.5 | 2.1 | 3.0 | 3.0 | 3.0 | 0.5 | 2.6 | 5.0 | 2.5 | 2.5 |
| SrO | 2.1 | 1.7 | 1.5 | 1.0 | 1.8 | | 2.0 | 1.8 | | 1.7 | 1.0 |
| ZnO | 7.2 | 5.9 | 6.0 | 7.2 | 7.1 | 4.0 | 7.2 | 6.1 | 5.9 | 3.0 | 5.0 |
| Li₂O | 7.4 | 6.1 | 6.0 | 7.4 | 7.4 | 7.2 | 7.4 | 6.3 | 6.1 | 6.5 | 6.1 |
| K₂O | 2.6 | 2.1 | 1.0 | 2.6 | 1.8 | 1.0 | 2.6 | 2.2 | 2.1 | 2.2 | 2.1 |
| B₂O₃ | | | | | | | | | | | |
| TiO₂ | | | | | | | 2.0 | | | | |
| ZrO₂ | 3.2 | 2.6 | 2.5 | 3.3 | 3.4 | 3.3 | 3.2 | 2.7 | 2.6 | 3.5 | 2.6 |
| P₂O₅ | 2.6 | 2.1 | 2.0 | 2.6 | 2.0 | 2.0 | 2.6 | 2.2 | 2.1 | 2.1 | 2.1 |
| Y₂O₃ | | | | | | | | | | | |
| Nb₂O₅ | | | | | | | | | | | |
| Ta₂O₅ | | | | | | | | | | | |
| La₂O₃ | | | | | | | | | | | |
| Sb₂O₃ | 0.5 | 0.4 | 0.4 | 0.5 | 0.5 | 0.5 | 0.5 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 700 | 700 | 700 | 700 | 700 | 700 | 700 | 700 | 700 | 700 | 700 |
| Growing | | | | | | | | | | | |
| Temperature??? | | | | | | | | | | | |
| Nucleous | 3 | 3 | 3 | 3 | 3 | 3 | 3 | 3 | 3 | 3 | 3 |
| Growing | | | | | | | | | | | |
| Time?hr? | | | | | | | | | | | |
| Main Crystalline | LZS | Crist | Crist | Crist | Crist | LZS | Crist | Crist | Crist | Crist | Crist |
| Phase | | | | | | | | | | | |
| Sub Crystalline | Crist | LZS | LZS | LZS | LZS | Crist | LZS | LZS | LZS | LZS | LZS |
| Phase | | | | | | | | | | | |
| Specific | 2.59 | 2.55 | 2.53 | 2.59 | 2.55 | 2.52 | 2.58 | 2.55 | 2.54 | 2.49 | 2.51 |
| Gravity?g/cm³ | | | | | | | | | | | |
| Yong's Modulus | 83.9 | 78.6 | 78.0 | 76.3 | 78.0 | 80.3 | 76.4 | 78.6 | 79.3 | 77.0 | 79.6 |
| E??Pa | | | | | | | | | | | |
| Elastic Modulus | 32.4 | 30.8 | 30.8 | 29.5 | 30.6 | 31.9 | 29.6 | 30.8 | 31.2 | 30.9 | 31.7 |
| Ratio | | | | | | | | | | | |
| C.T.E | 72 | 98 | 107 | 113 | 108 | 78 | 110 | 101 | 76 | 113 | 96 |
| Amount of | 51 | 54 | 56 | 64 | 62 | 52 | 63 | 55 | 48 | 59 | 53 |
| Migration of | | | | | | | | | | | |
| alkali metal | | | | | | | | | | | |
| [ppb] | | | | | | | | | | | |
| P/Pli | 1.1 | 1.2 | 1.2 | 1.2 | 1.2 | 1.1 | 1.2 | 1.2 | 1.1 | 1.2 | 1.2 |

TABLE 20

| | A-192 | A-193 | A-194 | A-195 | A-196 | A-197 | A-198 | A-199 | A-200 | A-201 |
|---|---|---|---|---|---|---|---|---|---|---|
| SiO₂ | 66.0 | 67.5 | 66.3 | 67.5 | 69.0 | 68.0 | 66.0 | 66.0 | 66.4 | 66.5 |
| Al₂O₃ | 5.0 | 7.7 | 7.6 | 7.0 | 7.0 | 5.4 | 6.0 | 7.0 | 7.5 | 8.0 |
| MgO | 2.0 | 2.0 | 2.0 | 2.0 | | | 1.0 | 2.1 | 2.0 | 2.1 |
| CaO | | 0.9 | 0.9 | 0.9 | | 1.0 | 1.4 | 2.0 | | 1.1 |
| BaO | 2.0 | 2.5 | 2.5 | 2.0 | 2.5 | 3.0 | 3.0 | 3.0 | 2.5 | 2.5 |
| SrO | | | | | 2.0 | 1.0 | 1.5 | | 1.7 | |
| ZnO | 10.0 | 6.0 | 7.2 | 6.0 | 6.0 | 7.2 | 5.0 | 6.0 | 5.8 | 4.0 |
| Li₂O | 7.5 | 4.0 | 6.1 | 8.0 | 7.0 | 7.0 | 7.0 | 6.5 | 7.0 | 6.8 |
| K₂O | 2.1 | 2.0 | 2.1 | 1.5 | 2.5 | 1.5 | 1.5 | 2.5 | 2.1 | 2.2 |
| B₂O₃ | | 1.0 | | | | | | | | |
| TiO₂ | | 1.1 | | | | | | | | |
| ZrO₂ | 2.8 | 2.7 | 2.6 | 2.6 | 1.1 | 3.2 | 5.0 | 3.5 | 2.6 | 3.3 |
| P₂O₅ | 2.2 | 2.1 | 2.1 | 2.0 | 2.5 | 2.4 | 2.2 | 1.0 | 2.1 | 3.0 |
| Y₂O₃ | | | | | | | | | | |
| Nb₂O₅ | | | | | | | | | | |
| Ta₂O₅ | | | | | | | | | | |
| La₂O₃ | | | | | | | | | | |
| Sb₂O₃ | 0.4 | 0.4 | 0.4 | 0.4 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 700 | 700 | 700 | 700 | 700 | 700 | 700 | 700 | 700 | 700 |
| Temperature??? | | | | | | | | | | |
| Nucleous Growing | 3 | 3 | 3 | 3 | 3 | 3 | 3 | 3 | 3 | 3 |
| Time?hr? | | | | | | | | | | |
| Main Crystalline | LZS | Quartz | Crist | Crist | Crist | Crist | Crist | Crist | Crist | Crist |
| Phase | | | | | | | | | | |
| Sub Crystalline | — | Crist | LZS | LZS | LZS | LZS | LZS | LZS | LZS | LZS |
| Phase | | | | | | | | | | |
| Specific | 2.64 | 2.59 | 2.55 | 2.54 | 2.50 | 2.55 | 2.57 | 2.53 | 2.56 | 2.50 |
| Gravity?g/cm³ | | | | | | | | | | |
| Yong's Modulus | 82.6 | 79.3 | 78.0 | 76.6 | 75.0 | 77.3 | 83.0 | 81.0 | 77.9 | 78.0 |
| E??Pa | | | | | | | | | | |
| Elastic Modulus | 31.3 | 30.6 | 30.6 | 30.2 | 30.0 | 30.3 | 32.3 | 32.0 | 30.4 | 31.2 |
| Ratio | | | | | | | | | | |
| C.T.E | 73 | 89 | 100 | 116 | 114 | 106 | 82 | 83 | 107 | 115 |
| Amount of | 52 | 44 | 54 | 67 | 62 | 60 | 53 | 51 | 60 | 61 |
| Migration of alkali | | | | | | | | | | |
| metal [ppb] | | | | | | | | | | |
| P/Pli | 1.1 | 1.3 | 1.2 | 1.2 | 1.2 | 1.2 | 1.1 | 1.2 | 1.2 | 1.2 |

TABLE 21

| | A-202 | A-203 | A-204 | A-205 | A-206 | A-207 | A-208 | A-209 | A-210 | A-211 | A-212 |
|---|---|---|---|---|---|---|---|---|---|---|---|
| SiO₂ | 65.0 | 67.0 | 69.5 | 67.0 | 67.0 | 68.0 | 66.1 | 66.0 | 66.5 | 68.5 | 67.5 |
| Al₂O₃ | 4.1 | 7.6 | 7.0 | 3.0 | 5.0 | 10.0 | 6.0 | 7.8 | 7.5 | 7.6 | 7.6 |
| MgO | 2.4 | 2.0 | 2.0 | | | | | 2.1 | 2.0 | 2.0 | 2.0 |
| CaO | | | | 2.4 | 1.0 | 1.0 | | | | | 1.1 |
| BaO | 3.0 | 2.5 | 2.1 | 3.0 | 3.0 | 3.0 | 0.5 | 2.6 | 5.0 | 2.5 | 2.5 |
| SrO | 2.1 | 1.7 | 1.5 | 1.0 | 1.8 | | 2.0 | 1.8 | | 1.7 | 1.0 |
| ZnO | 7.2 | 5.9 | 6.0 | 7.2 | 7.1 | 4.0 | 7.2 | 6.1 | 5.9 | 3.0 | 5.0 |
| Li₂O | 7.4 | 6.1 | 6.0 | 7.4 | 7.4 | 7.2 | 7.4 | 6.3 | 6.1 | 6.5 | 6.1 |
| K₂O | 2.6 | 2.1 | 1.0 | 2.6 | 1.8 | 1.0 | 2.6 | 2.2 | 2.1 | 2.2 | 2.1 |
| B₂O₃ | | | | | | | | | | | |
| TiO₂ | | | | | | | 2.0 | | | | |
| ZrO₂ | 3.2 | 2.6 | 2.5 | 3.3 | 3.4 | 3.3 | 3.2 | 2.7 | 2.6 | 3.5 | 2.6 |
| P₂O₅ | 2.6 | 2.1 | 2.0 | 2.6 | 2.0 | 2.0 | 2.6 | 2.2 | 2.1 | 2.1 | 2.1 |
| Y₂O₃ | | | | | | | | | | | |
| Nb₂O₅ | | | | | | | | | | | |
| Ta₂O₅ | | | | | | | | | | | |
| La₂O₃ | | | | | | | | | | | |
| Sb₂O₃ | 0.5 | 0.4 | 0.4 | 0.5 | 0.5 | 0.5 | 0.5 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 730 | 730 | 730 | 730 | 730 | 730 | 730 | 730 | 730 | 730 | 730 |
| Growing | | | | | | | | | | | |
| Temperature??? | | | | | | | | | | | |
| Nucleous | 3 | 3 | 3 | 3 | 3 | 3 | 3 | 3 | 3 | 3 | 3 |
| Growing | | | | | | | | | | | |
| Time?hr? | | | | | | | | | | | |
| Main Crystalline | Crist | Crist | Crist | Crist | Crist | Crist | Crist | Crist | Crist | Crist | Crist |
| Phase | | | | | | | | | | | |
| Sub Crystalline | LZS | LZS | LZS | LZS | LZS | LAS | LZS | LZS | Quartz | LZS | LZS |
| Phase | | | | | | | | | | | |
| Specific | 2.58 | 2.54 | 2.52 | 2.58 | 2.54 | 2.53 | 2.57 | 2.54 | 2.54 | 2.48 | 2.50 |
| Gravity?g/cm³ | | | | | | | | | | | |
| Yong's Modulus | 83.4 | 78.1 | 77.5 | 75.8 | 77.5 | 80.2 | 75.9 | 78.1 | 77.1 | 76.5 | 79.1 |
| E??Pa | | | | | | | | | | | |
| Elastic Modulus | 32.3 | 30.8 | 30.8 | 29.4 | 30.5 | 31.7 | 29.5 | 30.8 | 30.4 | 30.9 | 31.6 |
| Ratio | | | | | | | | | | | |
| C.T.E | 93 | 106 | 111 | 116 | 112 | 95 | 114 | 108 | 102 | 116 | 104 |
| Amount of | 49 | 51 | 52 | 53 | 52 | 49 | 53 | 52 | 50 | 53 | 51 |
| Migration of | | | | | | | | | | | |
| alkali metal | | | | | | | | | | | |
| [ppb] | | | | | | | | | | | |
| P/Pli | 1.2 | 1.3 | 1.3 | 1.3 | 1.3 | 1.3 | 1.3 | 1.3 | 1.3 | 1.3 | 1.3 |

TABLE 22

| | A-213 | A-214 | A-215 | A-216 | A-217 | A-218 | A-219 | A-220 | A-221 | A-222 |
|---|---|---|---|---|---|---|---|---|---|---|
| SiO₂ | 66.0 | 67.5 | 66.3 | 67.5 | 69.0 | 68.0 | 66.0 | 66.0 | 66.4 | 66.5 |
| Al₂O₃ | 5.0 | 7.7 | 7.6 | 7.0 | 7.0 | 5.4 | 6.0 | 7.0 | 7.5 | 8.0 |
| MgO | 2.0 | 2.0 | 2.0 | 2.0 | | | 1.0 | 2.1 | 2.0 | 2.1 |
| CaO | | 0.9 | 0.9 | 0.9 | | 1.0 | 1.4 | 2.0 | | 1.1 |
| BaO | 2.0 | 2.5 | 2.5 | 2.0 | 2.5 | 3.0 | 3.0 | 3.0 | 2.5 | 2.5 |
| SrO | | | | | 2.0 | 1.0 | 1.5 | | 1.7 | |
| ZnO | 10.0 | 6.0 | 7.2 | 6.0 | 6.0 | 7.2 | 5.0 | 6.0 | 5.8 | 4.0 |
| Li₂O | 7.5 | 4.0 | 6.1 | 8.0 | 7.0 | 7.0 | 7.0 | 6.5 | 7.0 | 6.8 |
| K₂O | 2.1 | 2.0 | 2.1 | 1.5 | 2.5 | 1.5 | 1.5 | 2.5 | 2.1 | 2.2 |
| B₂O₃ | | 1.0 | | | | | | | | |
| TiO₂ | | 1.1 | | | | | | | | |
| ZrO₂ | 2.8 | 2.7 | 2.6 | 2.6 | 1.1 | 3.2 | 5.0 | 3.5 | 2.6 | 3.3 |
| P₂O₅ | 2.2 | 2.1 | 2.1 | 2.0 | 2.5 | 2.4 | 2.2 | 1.0 | 2.1 | 3.0 |
| Y₂O₃ | | | | | | | | | | |
| Nb₂O₅ | | | | | | | | | | |
| Ta₂O₅ | | | | | | | | | | |
| La₂O₃ | | | | | | | | | | |
| Sb₂O₃ | 0.4 | 0.4 | 0.4 | 0.4 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 730 | 730 | 730 | 730 | 730 | 730 | 730 | 730 | 730 | 730 |
| Temperature??? | | | | | | | | | | |
| Nucleous Growing | 3 | 3 | 3 | 3 | 3 | 3 | 3 | 3 | 3 | 3 |
| Time?hr? | | | | | | | | | | |
| Main Crystalline | LZS | Quartz | Crist | Crist | Crist | Crist | Crist | Crist | Crist | Crist |
| Phase | | | | | | | | | | |
| Sub Crystalline | Crist | Crist | LZS | LZS | LZS | LZS | LZS | LZS | LZS | LZS |
| Phase | | | | | | | | | | |
| Specific | 2.63 | 2.61 | 2.54 | 2.53 | 2.49 | 2.54 | 2.56 | 2.52 | 2.55 | 2.49 |
| Gravity?g/cm³ | | | | | | | | | | |
| Yong's Modulus | 82.1 | 82.7 | 77.5 | 76.1 | 74.5 | 76.8 | 82.5 | 80.5 | 77.4 | 77.5 |
| E??Pa | | | | | | | | | | |
| Elastic Modulus | 31.2 | 31.7 | 30.5 | 30.1 | 29.9 | 30.2 | 32.2 | 31.9 | 30.4 | 31.1 |
| Ratio | | | | | | | | | | |
| C.T.E | 77 | 104 | 113 | 118 | 116 | 111 | 97 | 97 | 111 | 117 |
| Amount of | 45 | 51 | 53 | 54 | 53 | 52 | 49 | 49 | 52 | 53 |
| Migration of alkali | | | | | | | | | | |
| metal [ppb] | | | | | | | | | | |
| P/Pli | 1.2 | 1.3 | 1.3 | 1.3 | 1.3 | 1.3 | 1.3 | 1.3 | 1.3 | 1.3 |

TABLE 23

| | A-223 | A-224 | A-225 | A-226 | A-227 | A-228 | A-229 | A-230 | A-231 | A-232 | A-233 |
|---|---|---|---|---|---|---|---|---|---|---|---|
| SiO₂ | 65.0 | 67.0 | 69.5 | 67.0 | 67.0 | 68.0 | 66.1 | 66.0 | 66.5 | 68.5 | 67.5 |
| Al₂O₃ | 4.1 | 7.6 | 7.0 | 3.0 | 5.0 | 10.0 | 6.0 | 7.8 | 7.5 | 7.6 | 7.6 |
| MgO | 2.4 | 2.0 | 2.0 | | | | | 2.1 | 2.0 | 2.0 | 2.0 |
| CaO | | | | 2.4 | 1.0 | 1.0 | | | | | 1.1 |
| BaO | 3.0 | 2.5 | 2.1 | 3.0 | 3.0 | 3.0 | 0.5 | 2.6 | 5.0 | 2.5 | 2.5 |
| SrO | 2.1 | 1.7 | 1.5 | 1.0 | 1.8 | | 2.0 | 1.8 | | 1.7 | 1.0 |
| ZnO | 7.2 | 5.9 | 6.0 | 7.2 | 7.1 | 4.0 | 7.2 | 6.1 | 5.9 | 3.0 | 5.0 |
| Li₂O | 7.4 | 6.1 | 6.0 | 7.4 | 7.4 | 7.2 | 7.4 | 6.3 | 6.1 | 6.5 | 6.1 |
| K₂O | 2.6 | 2.1 | 1.0 | 2.6 | 1.8 | 1.0 | 2.6 | 2.2 | 2.1 | 2.2 | 2.1 |
| B₂O₃ | | | | | | | | | | | |
| TiO₂ | | | | | | | 2.0 | | | | |
| ZrO₂ | 3.2 | 2.6 | 2.5 | 3.3 | 3.4 | 3.3 | 3.2 | 2.7 | 2.6 | 3.5 | 2.6 |
| P₂O₅ | 2.6 | 2.1 | 2.0 | 2.6 | 2.0 | 2.0 | 2.6 | 2.2 | 2.1 | 2.1 | 2.1 |
| Y₂O₃ | | | | | | | | | | | |
| Nb₂O₅ | | | | | | | | | | | |
| Ta₂O₅ | | | | | | | | | | | |
| La₂O₃ | | | | | | | | | | | |
| Sb₂O₃ | 0.5 | 0.4 | 0.4 | 0.5 | 0.5 | 0.5 | 0.5 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 700 | 700 | 700 | 700 | 700 | 700 | 700 | 700 | 700 | 700 | 700 |
| Growing | | | | | | | | | | | |
| Temperature??? | | | | | | | | | | | |
| Nucleous | 10 | 10 | 10 | 10 | 10 | 10 | 10 | 10 | 10 | 10 | 10 |
| Growing | | | | | | | | | | | |
| Time?hr? | | | | | | | | | | | |
| Main Crystalline | Crist | Crist | Crist | Crist | Crist | Crist | Crist | Crist | Crist | Crist | Crist |
| Phase | | | | | | | | | | | |
| Sub Crystalline | LZS | LZS | LZS | LZS | LZS | LZS | LZS | LZS | LZS | LZS | LZS |
| Phase | | | | | | | | | | | |
| Specific | 2.58 | 2.54 | 2.52 | 2.58 | 2.54 | 2.51 | 2.57 | 2.54 | 2.53 | 2.48 | 2.50 |
| Gravity?g/cm³ | | | | | | | | | | | |
| Yong's Modulus | 83.4 | 78.2 | 77.6 | 75.9 | 77.6 | 79.9 | 76.0 | 78.2 | 78.9 | 76.6 | 79.2 |
| E??Pa | | | | | | | | | | | |
| Elastic Modulus | 32.3 | 30.7 | 30.7 | 29.4 | 30.5 | 31.8 | 29.5 | 30.7 | 31.1 | 30.8 | 31.6 |
| Ratio | | | | | | | | | | | |
| C.T.E | 92 | 105 | 111 | 115 | 112 | 94 | 113 | 107 | 93 | 115 | 104 |
| Amount of | 48 | 51 | 52 | 53 | 52 | 49 | 53 | 51 | 49 | 53 | 51 |
| Migration of | | | | | | | | | | | |
| alkali metal | | | | | | | | | | | |
| [ppb] | | | | | | | | | | | |
| P/Pli | 1.2 | 1.3 | 1.3 | 1.3 | 1.3 | 1.3 | 1.3 | 1.3 | 1.2 | 1.3 | 1.3 |

TABLE 24

| | A-234 | A-235 | A-236 | A-237 | A-238 | A-239 | A-240 | A-241 | A-242 | A-243 |
|---|---|---|---|---|---|---|---|---|---|---|
| SiO₂ | 66.0 | 67.5 | 66.3 | 67.5 | 69.0 | 68.0 | 66.0 | 66.0 | 66.4 | 66.5 |
| Al₂O₃ | 5.0 | 7.7 | 7.6 | 7.0 | 7.0 | 5.4 | 6.0 | 7.0 | 7.5 | 8.0 |
| MgO | 2.0 | 2.0 | 2.0 | 2.0 | | | 1.0 | 2.1 | 2.0 | 2.1 |
| CaO | | 0.9 | 0.9 | 0.9 | | 1.0 | 1.4 | 2.0 | | 1.1 |
| BaO | 2.0 | 2.5 | 2.5 | 2.0 | 2.5 | 3.0 | 3.0 | 3.0 | 2.5 | 2.5 |
| SrO | | | | | 2.0 | 1.0 | 1.5 | | 1.7 | |
| ZnO | 10.0 | 6.0 | 7.2 | 6.0 | 6.0 | 7.2 | 5.0 | 6.0 | 5.8 | 4.0 |
| Li₂O | 7.5 | 4.0 | 6.1 | 8.0 | 7.0 | 7.0 | 7.0 | 6.5 | 7.0 | 6.8 |
| K₂O | 2.1 | 2.0 | 2.1 | 1.5 | 2.5 | 1.5 | 1.5 | 2.5 | 2.1 | 2.2 |
| B₂O₃ | | 1.0 | | | | | | | | |
| TiO₂ | | 1.1 | | | | | | | | |
| ZrO₂ | 2.8 | 2.7 | 2.6 | 2.6 | 1.1 | 3.2 | 5.0 | 3.5 | 2.6 | 3.3 |
| P₂O₅ | 2.2 | 2.1 | 2.1 | 2.0 | 2.5 | 2.4 | 2.2 | 1.0 | 2.1 | 3.0 |
| Y₂O₃ | | | | | | | | | | |
| Nb₂O₅ | | | | | | | | | | |
| Ta₂O₅ | | | | | | | | | | |
| La₂O₃ | | | | | | | | | | |
| Sb₂O₃ | 0.4 | 0.4 | 0.4 | 0.4 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 700 | 700 | 700 | 700 | 700 | 700 | 700 | 700 | 700 | 700 |
| Temperature??? | | | | | | | | | | |
| Nucleous Growing | 10 | 10 | 10 | 10 | 10 | 10 | 10 | 10 | 10 | 10 |
| Time?hr? | | | | | | | | | | |
| Main Crystalline | LZS | Quartz | Crist | Crist | Crist | Crist | Crist | Crist | Crist | Crist |
| Phase | | | | | | | | | | |
| Sub Crystalline | Crist | Crist | LZS | LZS | LZS | LZS | LZS | LZS | LZS | LZS |
| Phase | | | | | | | | | | |
| Specific | 2.63 | 2.60 | 2.54 | 2.53 | 2.49 | 2.54 | 2.56 | 2.52 | 2.55 | 2.49 |
| Gravity?g/cm³ | | | | | | | | | | |
| Yong's Modulus | 82.1 | 81.6 | 77.6 | 76.2 | 74.6 | 76.9 | 82.5 | 80.6 | 77.5 | 77.6 |
| E??Pa | | | | | | | | | | |
| Elastic Modulus | 31.2 | 31.4 | 30.5 | 30.1 | 29.9 | 30.2 | 32.2 | 31.9 | 30.4 | 31.1 |
| Ratio | | | | | | | | | | |
| C.T.E | 76 | 105 | 106 | 118 | 116 | 111 | 96 | 97 | 111 | 117 |
| Amount of | 45 | 51 | 51 | 54 | 53 | 52 | 49 | 49 | 52 | 53 |
| Migration of alkali | | | | | | | | | | |
| metal [ppb] | | | | | | | | | | |
| P/Pli | 1.2 | 1.3 | 1.3 | 1.3 | 1.3 | 1.3 | 1.3 | 1.3 | 1.3 | 1.3 |

Tables 25 and 26 show the glass compositions in % by weight of respective crystallized glass substrates of A-244 to A-264, together with the manufacturing conditions employed. Tables 27 and 28 show crystallized glass substrates as A-265 to A-285 manufactured using the same glass compositions as those of A-244 to A-264 with the nucleus growing temperature varied from that employed for A-244 to A-264. Further, Tables 29 and 30 show crystallized glass substrates as A-286 to A-306 manufactured using the same glass compositions as those of A-244 to A-264 with the nucleus growing time varied from that employed for A-244 to A-264.

TABLE 25

| | A-244 | A-245 | A-246 | A-247 | A-248 | A-249 | A-250 | A-251 | A-252 | A-253 | A-254 |
|---|---|---|---|---|---|---|---|---|---|---|---|
| SiO₂ | 65.8 | 67.2 | 69.3 | 66.1 | 66.3 | 65.4 | 68.0 | 68.0 | 70.0 | 68.5 | 67.5 |
| Al₂O₃ | 7.6 | 7.6 | 7.9 | 3.0 | 5.0 | 10.0 | 3.0 | 5.0 | 5.0 | 7.6 | 7.6 |
| MgO | 2.0 | 0.7 | 0.7 | | | | 2.4 | | | 2.0 | 2.0 |
| CaO | | | | 2.4 | 1.0 | 2.4 | | | | | 1.1 |
| BaO | 2.5 | 1.3 | 1.3 | 3.0 | 2.3 | 2.0 | 3.0 | 1.0 | 1.0 | 1.8 | 1.5 |
| SrO | 1.7 | 0.9 | 0.9 | 2.0 | 2.0 | 2.0 | 0.5 | 2.5 | 5.0 | 2.5 | 2.0 |
| ZnO | 7.2 | 8.5 | 6.1 | 7.3 | 7.0 | 5.0 | 7.2 | 7.2 | 6.0 | 3.0 | 5.0 |
| Li₂O | 6.1 | 6.6 | 6.3 | 7.4 | 7.4 | 7.2 | 7.4 | 7.4 | 7.2 | 6.5 | 7.2 |
| K₂O | 2.1 | 2.1 | 2.2 | 2.6 | 2.6 | | 2.6 | 2.5 | | 2.2 | 1.0 |
| B₂O₃ | | | | | | | | | | | |
| TiO₂ | | | | | | | | | | | |
| ZrO₂ | 2.6 | 2.6 | 2.7 | 3.2 | 3.4 | 3.1 | 3.2 | 3.4 | 2.8 | 3.5 | 2.6 |
| P₂O₅ | 2.1 | 2.1 | 2.2 | 2.6 | 2.6 | 2.5 | 2.6 | 2.6 | 2.5 | 2.1 | 2.1 |
| Y₂O₃ | | | | | | | | | | | |
| Nb₂O₅ | | | | | | | | | | | |
| Ta₂O₅ | | | | | | | | | | | |
| La₂O₃ | | | | | | | | | | | |
| Sb₂O₃ | 0.4 | 0.4 | 0.4 | 0.5 | 0.5 | 0.5 | 0.5 | 0.5 | 0.5 | 0.4 | 0.4 |
| Total (100 wt %) | 100.0 | 100.0 | 100.0 | 100.1 | 100.0 | 100.0 | 100.3 | 100.0 | 100.0 | 100.1 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 700 | 700 | 700 | 700 | 700 | 700 | 700 | 700 | 700 | 700 | 700 |
| Growing | | | | | | | | | | | |
| Temperature??? | | | | | | | | | | | |
| Nucleous | 3 | 3 | 3 | 3 | 3 | 3 | 3 | 3 | 3 | 3 | 3 |
| Growing | | | | | | | | | | | |
| Time?hr? | | | | | | | | | | | |
| Main Crystalline | Crist | Crist | Crist | Crist | Crist | LZS | Crist | Crist | Crist | Crist | Crist |
| Phase | | | | | | | | | | | |
| Sub Crystalline | LZS | LZS | LZS | LZS | LZS | Crist | LZS | LZS | LZS | LZS | LZS |
| Phase | | | | | | | | | | | |
| Specific | 2.57 | 2.54 | 2.50 | 2.55 | 2.53 | 2.51 | 2.55 | 2.54 | 2.55 | 2.50 | 2.53 |
| Gravity?g/cm³ | | | | | | | | | | | |
| Yong's Modulus | 77.6 | 77.1 | 75.1 | 76.1 | 78.0 | 85.6 | 75.8 | 76.0 | 74.7 | 77.2 | 79.3 |
| E??Pa | | | | | | | | | | | |
| Elastic Modulus | 30.2 | 30.4 | 30.0 | 29.8 | 30.8 | 34.1 | 29.7 | 29.9 | 29.3 | 30.9 | 31.3 |
| Ratio | | | | | | | | | | | |
| C.T.E | 99 | 90 | 100 | 109 | 92 | 73 | 111 | 108 | 115 | 103 | 94 |
| Amount of | 54 | 54 | 55 | 62 | 57 | 51 | 63 | 62 | 63 | 57 | 57 |
| Migration of | | | | | | | | | | | |
| alkali metal | | | | | | | | | | | |
| [ppb] | | | | | | | | | | | |
| P/Pli | 1.2 | 1.2 | 1.2 | 1.2 | 1.1 | 1.1 | 1.2 | 1.2 | 1.2 | 1.2 | 1.2 |

TABLE 26

| | A-255 | A-256 | A-257 | A-258 | A-259 | A-260 | A-261 | A-262 | A-263 | A-264 |
|---|---|---|---|---|---|---|---|---|---|---|
| SiO₂ | 66.0 | 67.5 | 67.5 | 67.5 | 66.5 | 68.0 | 66.0 | 67.7 | 67.8 | 66.5 |
| Al₂O₃ | 7.6 | 7.7 | 7.7 | 7.0 | 7.0 | 4.1 | 6.0 | 7.0 | 7.8 | 8.0 |
| MgO | | 2.0 | 2.0 | | 2.4 | 2.2 | 1.0 | 2.1 | 2.1 | 1.0 |
| CaO | | 0.9 | 0.9 | 0.9 | | 1.0 | 2.0 | 1.9 | 1.9 | 0.7 |
| BaO | 1.0 | 0.5 | 0.5 | 1.0 | 2.5 | 2.0 | | | | |
| SrO | 2.0 | 2.0 | 2.0 | 3.0 | 2.0 | 2.0 | 2.0 | 2.0 | 2.0 | 3.0 |
| ZnO | 10.0 | 5.9 | 5.9 | 5.9 | 6.0 | 6.2 | 6.1 | 6.4 | 5.5 | 5.0 |
| Li₂O | 6.1 | 4.0 | 6.1 | 8.0 | 7.1 | 7.0 | 6.9 | 6.5 | 6.5 | 7.0 |
| K₂O | 2.1 | 2.1 | 2.1 | 1.5 | 2.5 | 1.5 | 2.4 | | 1.0 | 2.0 |
| B₂O₃ | | 1.1 | | | | | | | | |
| TiO₂ | | 1.1 | | | | | | 1.5 | | |
| ZrO₂ | 2.6 | 2.6 | 2.6 | 2.6 | 1.1 | 3.2 | 5.0 | 3.5 | 3.0 | 3.3 |
| P₂O₅ | 2.2 | 2.1 | 2.1 | 2.1 | 2.5 | 2.4 | 2.2 | 1.0 | 2.0 | 3.0 |
| Y₂O₃ | | | | | | | | | | |
| Nb₂O₅ | | | | | | | | | | |
| Ta₂O₅ | | | | | | | | | | |
| La₂O₃ | | | | | | | | | | |
| Sb₂O₃ | 0.4 | 0.4 | 0.4 | 0.4 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 700 | 700 | 700 | 700 | 700 | 700 | 700 | 700 | 700 | 700 |
| Temperature??? | | | | | | | | | | |
| Nucleous Growing | 3 | 3 | 3 | 3 | 3 | 3 | 3 | 3 | 3 | 3 |
| Time?hr? | | | | | | | | | | |
| Main Crystalline | LZS | Quartz | Crist | Crist | Crist | Crist | Crist | Crist | Crist | Crist |
| Phase | | | | | | | | | | |
| Sub Crystalline | Crist | Crist | LZS | LZS | LZS | LZS | LZS | LZS | LZS | LZS |
| Phase | | | | | | | | | | |
| Specific | 2.63 | 2.69 | 2.53 | 2.55 | 2.49 | 2.52 | 2.56 | 2.57 | 2.53 | 2.62 |
| Gravity?g/cm³ | | | | | | | | | | |
| Yong's Modulus | 82.0 | 78.9 | 76.7 | 76.3 | 75.8 | 76.8 | 79.2 | 78.6 | 77.3 | 78.0 |
| E??Pa | | | | | | | | | | |
| Elastic Modulus | 31.1 | 29.3 | 30.3 | 29.9 | 30.4 | 30.5 | 30.9 | 30.6 | 30.6 | 29.8 |
| Ratio | | | | | | | | | | |
| C.T.E | 70 | 92 | 112 | 116 | 115 | 109 | 99 | 107 | 112 | 115 |
| Amount of | 47 | 45 | 58 | 67 | 63 | 61 | 57 | 58 | 59 | 62 |
| Migration of alkali | | | | | | | | | | |
| metal [ppb] | | | | | | | | | | |
| P/Pli | 1.1 | 1.3 | 1.3 | 1.2 | 1.2 | 1.2 | 1.2 | 1.2 | 1.2 | 1.2 |

TABLE 27

| | A-265 | A-266 | A-267 | A-268 | A-269 | A-270 | A-271 | A-272 | A-273 | A-274 | A-275 |
|---|---|---|---|---|---|---|---|---|---|---|---|
| SiO₂ | 65.8 | 67.2 | 69.3 | 66.1 | 66.3 | 65.4 | 68.0 | 68.0 | 70.0 | 68.5 | 67.5 |
| Al₂O₃ | 7.6 | 7.6 | 7.9 | 3.0 | 5.0 | 10.0 | 3.0 | 5.0 | 5.0 | 7.6 | 7.6 |
| MgO | 2.0 | 0.7 | 0.7 | | | | 2.4 | | | 2.0 | 2.0 |
| CaO | | | | 2.4 | 1.0 | 2.4 | | | | | 1.1 |
| BaO | 2.5 | 1.3 | 1.3 | 3.0 | 2.3 | 2.0 | 3.0 | 1.0 | 1.0 | 1.8 | 1.5 |
| SrO | 1.7 | 0.9 | 0.9 | 2.0 | 2.0 | 2.0 | 0.5 | 2.5 | 5.0 | 2.5 | 2.0 |
| ZnO | 7.2 | 8.5 | 6.1 | 7.3 | 7.0 | 5.0 | 7.2 | 7.2 | 6.0 | 3.0 | 5.0 |
| Li₂O | 6.1 | 6.6 | 6.3 | 7.4 | 7.4 | 7.2 | 7.4 | 7.4 | 7.2 | 6.5 | 7.2 |
| K₂O | 2.1 | 2.1 | 2.2 | 2.6 | 2.6 | | 2.6 | 2.5 | | 2.2 | 1.0 |
| B₂O₃ | | | | | | | | | | | |
| TiO₂ | | | | | | | | | | | |
| ZrO₂ | 2.6 | 2.6 | 2.7 | 3.2 | 3.4 | 3.1 | 3.2 | 3.4 | 2.8 | 3.5 | 2.6 |
| P₂O₅ | 2.1 | 2.1 | 2.2 | 2.6 | 2.6 | 2.5 | 2.6 | 2.6 | 2.5 | 2.1 | 2.1 |
| Y₂O₃ | | | | | | | | | | | |
| Nb₂O₅ | | | | | | | | | | | |
| Ta₂O₅ | | | | | | | | | | | |
| La₂O₃ | | | | | | | | | | | |
| Sb₂O₃ | 0.4 | 0.4 | 0.4 | 0.5 | 0.5 | 0.5 | 0.5 | 0.5 | 0.5 | 0.4 | 0.4 |
| Total (100 wt %) | 100.0 | 100.0 | 100.0 | 100.1 | 100.0 | 100.0 | 100.3 | 100.0 | 100.0 | 100.1 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 730 | 730 | 730 | 730 | 730 | 730 | 730 | 730 | 730 | 730 | 730 |
| Growing | | | | | | | | | | | |
| Temperature??? | | | | | | | | | | | |
| Nucleous | 3 | 3 | 3 | 3 | 3 | 3 | 3 | 3 | 3 | 3 | 3 |
| Growing | | | | | | | | | | | |
| Time?hr? | | | | | | | | | | | |
| Main Crystalline | Crist | Crist | Crist | Crist | Crist | Crist | Crist | Crist | Crist | Crist | Crist |
| Phase | | | | | | | | | | | |
| Sub Crystalline | LZS | LZS | LZS | LZS | LZS | LAS | LZS | LZS | LZS | LZS | LZS |
| Phase | | | | | | | | | | | |
| Specific | 2.56 | 2.53 | 2.49 | 2.54 | 2.52 | 2.50 | 2.54 | 2.53 | 2.54 | 2.49 | 2.52 |
| Gravity?g/cm³ | | | | | | | | | | | |
| Yong's Modulus | 77.1 | 76.6 | 74.6 | 75.6 | 77.5 | 83.6 | 75.3 | 75.5 | 74.2 | 76.7 | 78.8 |
| E??Pa | | | | | | | | | | | |
| Elastic Modulus | 30.1 | 30.3 | 30.0 | 29.8 | 30.8 | 33.4 | 29.7 | 29.9 | 29.2 | 30.8 | 31.3 |
| Ratio | | | | | | | | | | | |
| C.T.E | 114 | 110 | 107 | 113 | 102 | 94 | 114 | 112 | 117 | 109 | 103 |
| Amount of | 53 | 52 | 51 | 53 | 50 | 49 | 53 | 52 | 53 | 52 | 51 |
| Migration of | | | | | | | | | | | |
| alkali metal | | | | | | | | | | | |
| [ppb] | | | | | | | | | | | |
| P/Pli | 1.3 | 1.3 | 1.3 | 1.3 | 1.3 | 1.2 | 1.3 | 1.3 | 1.3 | 1.3 | 1.3 |

TABLE 28

| | A-276 | A-277 | A-278 | A-279 | A-280 | A-281 | A-282 | A-283 | A-284 | A-285 |
|---|---|---|---|---|---|---|---|---|---|---|
| SiO₂ | 66.0 | 67.5 | 67.5 | 67.5 | 66.5 | 68.0 | 66.0 | 67.7 | 67.8 | 66.5 |
| Al₂O₃ | 7.6 | 7.7 | 7.7 | 7.0 | 7.0 | 4.1 | 6.0 | 7.0 | 7.8 | 8.0 |
| MgO | | 2.0 | 2.0 | | 2.4 | 2.2 | 1.0 | 2.1 | 2.1 | 1.0 |
| CaO | | 0.9 | 0.9 | 0.9 | | 1.0 | 2.0 | 1.9 | 1.9 | 0.7 |
| BaO | 1.0 | 0.5 | 0.5 | 1.0 | 2.5 | 2.0 | | | | |
| SrO | 2.0 | 2.0 | 2.0 | 3.0 | 2.0 | 2.0 | 2.0 | 2.0 | 2.0 | 3.0 |
| ZnO | 10.0 | 5.9 | 5.9 | 5.9 | 6.0 | 6.2 | 6.1 | 6.4 | 5.5 | 5.0 |
| Li₂O | 6.1 | 4.0 | 6.1 | 8.0 | 7.1 | 7.0 | 6.9 | 6.5 | 6.5 | 7.0 |
| K₂O | 2.1 | 2.1 | 2.1 | 1.5 | 2.5 | 1.5 | 2.4 | | 1.0 | 2.0 |
| B₂O₃ | | 1.1 | | | | | | | | |
| TiO₂ | | 1.1 | | | | | | 1.5 | | |
| ZrO₂ | 2.6 | 2.6 | 2.6 | 2.6 | 1.1 | 3.2 | 5.0 | 3.5 | 3.0 | 3.3 |
| P₂O₅ | 2.2 | 2.1 | 2.1 | 2.1 | 2.5 | 2.4 | 2.2 | 1.0 | 2.0 | 3.0 |
| Y₂O₃ | | | | | | | | | | |
| Nb₂O₅ | | | | | | | | | | |
| Ta₂O₅ | | | | | | | | | | |
| La₂O₃ | | | | | | | | | | |
| Sb₂O₃ | 0.4 | 0.4 | 0.4 | 0.4 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 730 | 730 | 730 | 730 | 730 | 730 | 730 | 730 | 730 | 730 |
| Temperature??? | | | | | | | | | | |
| Nucleous Growing | 3 | 3 | 3 | 3 | 3 | 3 | 3 | 3 | 3 | 3 |
| Time?hr? | | | | | | | | | | |
| Main Crystalline | Crist | Quartz | Crist | Crist | Crist | Crist | Crist | Crist | Crist | Crist |
| Phase | | | | | | | | | | |
| Sub Crystalline | LZS | Crist | LZS | LZS | LZS | LZS | LZS | LZS | LZS | LZS |
| Phase | | | | | | | | | | |
| Specific | 2.62 | 2.71 | 2.52 | 2.54 | 2.48 | 2.51 | 2.55 | 2.56 | 2.52 | 2.61 |
| Gravity?g/cm³ | | | | | | | | | | |
| Yong's Modulus | 81.5 | 82.2 | 76.2 | 75.8 | 75.3 | 76.3 | 78.7 | 78.1 | 76.8 | 77.5 |
| E??Pa | | | | | | | | | | |
| Elastic Modulus | 31.1 | 30.3 | 30.3 | 29.9 | 30.4 | 30.4 | 30.9 | 30.5 | 30.5 | 29.7 |
| Ratio | | | | | | | | | | |
| C.T.E | 80 | 105 | 115 | 118 | 117 | 113 | 106 | 111 | 115 | 117 |
| Amount of | 46 | 51 | 53 | 54 | 53 | 53 | 51 | 52 | 53 | 53 |
| Migration of alkali | | | | | | | | | | |
| metal [ppb] | | | | | | | | | | |
| P/Pli | 1.2 | 1.3 | 1.3 | 1.3 | 1.3 | 1.3 | 1.3 | 1.3 | 1.3 | 1.3 |

TABLE 29

| | A-286 | A-287 | A-288 | A-289 | A-290 | A-291 | A-292 | A-293 | A-294 | A-295 | A-296 |
|---|---|---|---|---|---|---|---|---|---|---|---|
| SiO₂ | 65.8 | 67.2 | 69.3 | 66.1 | 66.3 | 65.4 | 68.0 | 68.0 | 70.0 | 68.5 | 67.5 |
| Al₂O₃ | 7.6 | 7.6 | 7.9 | 3.0 | 5.0 | 10.0 | 3.0 | 5.0 | 5.0 | 7.6 | 7.6 |
| MgO | 2.0 | 0.7 | 0.7 | | | | 2.4 | | | 2.0 | 2.0 |
| CaO | | | | 2.4 | 1.0 | 2.4 | | | | | 1.1 |
| BaO | 2.5 | 1.3 | 1.3 | 3.0 | 2.3 | 2.0 | 3.0 | 1.0 | 1.0 | 1.8 | 1.5 |
| SrO | 1.7 | 0.9 | 0.9 | 2.0 | 2.0 | 2.0 | 0.5 | 2.5 | 5.0 | 2.5 | 2.0 |
| ZnO | 7.2 | 8.5 | 6.1 | 7.3 | 7.0 | 5.0 | 7.2 | 7.2 | 6.0 | 3.0 | 5.0 |
| Li₂O | 6.1 | 6.6 | 6.3 | 7.4 | 7.4 | 7.2 | 7.4 | 7.4 | 7.2 | 6.5 | 7.2 |
| K₂O | 2.1 | 2.1 | 2.2 | 2.6 | 2.6 | | 2.6 | 2.5 | | 2.2 | 1.0 |
| B₂O₃ | | | | | | | | | | | |
| TiO₂ | | | | | | | | | | | |
| ZrO₂ | 2.6 | 2.6 | 2.7 | 3.2 | 3.4 | 3.1 | 3.2 | 3.4 | 2.8 | 3.5 | 2.6 |
| P₂O₅ | 2.1 | 2.1 | 2.2 | 2.6 | 2.6 | 2.5 | 2.6 | 2.6 | 2.5 | 2.1 | 2.1 |
| Y₂O₃ | | | | | | | | | | | |
| Nb₂O₅ | | | | | | | | | | | |
| Ta₂O₅ | | | | | | | | | | | |
| La₂O₃ | | | | | | | | | | | |
| Sb₂O₃ | 0.4 | 0.4 | 0.4 | 0.5 | 0.5 | 0.5 | 0.5 | 0.5 | 0.5 | 0.4 | 0.4 |
| Total (100 wt %) | 100.0 | 100.0 | 100.0 | 100.1 | 100.0 | 100.0 | 100.3 | 100.0 | 100.0 | 100.1 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 700 | 700 | 700 | 700 | 700 | 700 | 700 | 700 | 700 | 700 | 700 |
| Growing | | | | | | | | | | | |
| Temperature??? | | | | | | | | | | | |
| Nucleous | 10 | 10 | 10 | 10 | 10 | 10 | 10 | 10 | 10 | 10 | 10 |
| Growing | | | | | | | | | | | |
| Time?hr? | | | | | | | | | | | |
| Main Crystalline | Crist | Crist | Crist | Crist | Crist | Crist | Crist | Crist | Crist | Crist | Crist |
| Phase | | | | | | | | | | | |
| Sub Crystalline | LZS | LZS | LZS | LZS | LZS | LZS | LZS | LZS | LZS | LZS | LZS |
| Phase | | | | | | | | | | | |
| Specific | 2.56 | 2.53 | 2.49 | 2.54 | 2.52 | 2.50 | 2.54 | 2.53 | 2.54 | 2.49 | 2.52 |
| Gravity?g/cm³ | | | | | | | | | | | |
| Yong's Modulus | 77.2 | 76.7 | 74.7 | 75.7 | 77.6 | 81.8 | 75.4 | 75.6 | 74.3 | 76.8 | 78.9 |
| E??Pa | | | | | | | | | | | |
| Elastic Modulus | 30.1 | 30.3 | 30.0 | 29.8 | 30.7 | 32.7 | 29.6 | 29.8 | 29.2 | 30.8 | 31.3 |
| Ratio | | | | | | | | | | | |
| C.T.E | 112 | 107 | 106 | 113 | 102 | 92 | 114 | 112 | 117 | 108 | 103 |
| Amount of | 52 | 51 | 51 | 53 | 50 | 48 | 53 | 52 | 53 | 52 | 51 |
| Migration of | | | | | | | | | | | |
| alkali metal | | | | | | | | | | | |
| [ppb] | | | | | | | | | | | |
| P/Pli | 1.3 | 1.3 | 1.3 | 1.3 | 1.3 | 1.2 | 1.3 | 1.3 | 1.3 | 1.3 | 1.3 |

TABLE 30

| | A-297 | A-298 | A-299 | A-300 | A-301 | A-302 | A-303 | A-304 | A-305 | A-306 |
|---|---|---|---|---|---|---|---|---|---|---|
| SiO₂ | 66.0 | 67.5 | 67.5 | 67.5 | 66.5 | 68.0 | 66.0 | 67.7 | 67.8 | 66.5 |
| Al₂O₃ | 7.6 | 7.7 | 7.0 | 7.0 | 7.0 | 4.1 | 6.0 | 7.0 | 7.8 | 8.0 |
| MgO | | 2.0 | 2.0 | | 2.4 | 2.2 | 1.0 | 2.1 | 2.1 | 1.0 |
| CaO | | 0.9 | 0.9 | 0.9 | | 1.0 | 2.0 | 1.9 | 1.9 | 0.7 |
| BaO | 1.0 | 0.5 | 0.5 | 1.0 | 2.5 | 2.0 | | | | |
| SrO | 2.0 | 2.0 | 2.0 | 3.0 | 2.0 | 2.0 | 2.0 | 2.0 | 2.0 | 3.0 |
| ZnO | 10.0 | 5.9 | 5.9 | 5.9 | 6.0 | 6.2 | 6.1 | 6.4 | 5.5 | 5.0 |
| Li₂O | 6.1 | 4.0 | 6.1 | 8.0 | 7.1 | 7.0 | 6.9 | 6.5 | 6.5 | 7.0 |
| K₂O | 2.1 | 2.1 | 2.1 | 1.5 | 2.5 | 1.5 | 2.4 | | 1.0 | 2.0 |
| B₂O₃ | | 1.1 | | | | | | | | |
| TiO₂ | | 1.1 | | | | | | 1.5 | | |
| ZrO₂ | 2.6 | 2.6 | 2.6 | 2.6 | 1.1 | 3.2 | 5.0 | 3.5 | 3.0 | 3.3 |
| P₂O₅ | 2.2 | 2.1 | 2.1 | 2.1 | 2.5 | 2.4 | 2.2 | 1.0 | 2.0 | 3.0 |
| Y₂O₃ | | | | | | | | | | |
| Nb₂O₅ | | | | | | | | | | |
| Ta₂O₅ | | | | | | | | | | |
| La₂O₃ | | | | | | | | | | |
| Sb₂O₃ | 0.4 | 0.4 | 0.4 | 0.4 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 700 | 700 | 700 | 700 | 700 | 700 | 700 | 700 | 700 | 700 |
| Temperature??? | | | | | | | | | | |
| Nucleous Growing | 10 | 10 | 10 | 10 | 10 | 10 | 10 | 10 | 10 | 10 |
| Time?hr? | | | | | | | | | | |
| Main Crystalline | LZS | Quartz | Crist | Crist | Crist | Crist | Crist | Crist | Crist | Crist |
| Phase | | | | | | | | | | |
| Sub Crystalline | Crist | Crist | LZS | LZS | LZS | LZS | LZS | LZS | LZS | LZS |
| Phase | | | | | | | | | | |
| Specific | 2.63 | 2.70 | 2.52 | 2.54 | 2.48 | 2.51 | 2.55 | 2.56 | 2.52 | 2.61 |
| Gravity?g/cm³ | | | | | | | | | | |
| Yong's Modulus | 81.5 | 81.2 | 76.3 | 75.9 | 75.4 | 76.4 | 78.8 | 78.2 | 76.9 | 77.6 |
| E??Pa | | | | | | | | | | |
| Elastic Modulus | 31.1 | 30.1 | 30.2 | 29.8 | 30.4 | 30.4 | 30.9 | 30.5 | 30.5 | 29.7 |
| Ratio | | | | | | | | | | |
| C.T.E | 78 | 106 | 115 | 118 | 117 | 113 | 106 | 111 | 115 | 117 |
| Amount of | 46 | 51 | 53 | 54 | 53 | 53 | 51 | 52 | 53 | 53 |
| Migration of alkali | | | | | | | | | | |
| metal [ppb] | | | | | | | | | | |
| P/Pli | 1.2 | 1.3 | 1.3 | 1.3 | 1.3 | 1.3 | 1.3 | 1.3 | 1.3 | 1.3 |

Tables 31 and 32 show the glass compositions in % by weight of respective crystallized glass substrates of A-307 to A-327, together with the manufacturing conditions employed. Tables 33 and 34 show crystallized glass substrates as A-328 to A-348 manufactured using the same glass compositions as those of A-307 to A-327 with the nucleus growing temperature varied from that employed for A-307 to A-327. Further, Tables 35 and 36 show crystallized glass substrates as A-349 to A-369 manufactured using the same glass compositions as those of A-307 to A-327 with the nucleus growing time varied from that employed for A-307 to A-327.

TABLE 31

| | A-307 | A-308 | A-309 | A-310 | A-311 | A-312 | A-313 | A-314 | A-315 | A-316 | A-317 |
|---|---|---|---|---|---|---|---|---|---|---|---|
| SiO₂ | 65.2 | 67.0 | 69.5 | 66.1 | 66.3 | 65.4 | 68.5 | 67.5 | 66.0 | 67.5 | 67.5 |
| Al₂O₃ | 7.4 | 7.6 | 7.0 | 3.0 | 5.0 | 10.0 | 7.6 | 7.6 | 5.6 | 7.7 | 7.7 |
| MgO | 2.0 | 2.0 | 1.0 | 2.4 | 1.0 | 2.4 | 2.0 | 2.0 | 2.0 | 2.0 | 2.0 |
| CaO | 0.9 | | | | | | | 1.0 | | 0.9 | 0.9 |
| BaO | 2.4 | 2.5 | 2.1 | 1.0 | | | 1.5 | 1.0 | 1.0 | 2.5 | 2.5 |
| SrO | | 1.6 | 1.5 | 2.1 | 1.8 | 1.0 | 1.7 | 1.0 | | | |
| ZnO | 5.0 | 5.9 | 6.0 | 7.2 | 7.2 | 6.0 | 3.0 | 5.0 | 10.0 | 5.9 | 5.5 |
| Li₂O | 6.1 | 6.1 | 6.0 | 7.4 | 7.4 | 7.2 | 6.5 | 6.7 | 6.1 | 4.0 | 6.0 |
| K₂O | 2.1 | | | 2.6 | 2.7 | | 1.2 | 1.1 | 2.1 | 1.0 | 1.0 |
| B₂O₃ | 3.5 | 1.4 | 1.0 | | | | | | | 1.0 | |
| TiO₂ | | | | 1.0 | 1.0 | 1.0 | 1.0 | 1.0 | 1.0 | 1.8 | 1.0 |
| ZrO₂ | 2.5 | 2.6 | 2.5 | 3.2 | 3.4 | 3.3 | 3.5 | 2.6 | 2.6 | 2.6 | 2.8 |
| P₂O₅ | 2.0 | 2.1 | 2.0 | 2.6 | 2.6 | 2.5 | 2.1 | 2.1 | 2.2 | 2.1 | 2.1 |
| Y₂O₃ | 0.5 | 0.8 | 1.0 | 1.0 | 1.2 | 0.8 | 1.0 | 1.0 | 1.0 | 0.5 | 0.5 |
| Nb₂O₅ | | | | | | | | | | | |
| Ta₂O₅ | | | | | | | | | | | |
| La₂O₃ | | | | | | | | | | | |
| Sb₂O₃ | 0.4 | 0.4 | 0.4 | 0.5 | 0.5 | 0.5 | 0.4 | 0.4 | 0.4 | 0.4 | 0.4 |
| Total(100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleaus | 700 | 700 | 700 | 700 | 700 | 700 | 700 | 700 | 700 | 700 | 700 |
| Growing | | | | | | | | | | | |
| Temperature??? | | | | | | | | | | | |
| Nucleous | 3 | 3 | 3 | 3 | 3 | 3 | 3 | 3 | 3 | 3 | 3 |
| Growing | | | | | | | | | | | |
| Time?hr? | | | | | | | | | | | |
| Main Crystalline | Crist | Crist | Crist | Crist | Crist | LZS | Crist | Crist | LZS | Crist | Crist |
| Phase | | | | | | | | | | | |
| Sub Crystalline | LZS | LZS | LZS | LZS | LZS | Crist | LZS | LZS | Crist | LZS | LZS |
| Phase | | | | | | | | | | | |
| Specific | 2.50 | 2.52 | 2.53 | 2.57 | 2.55 | 2.52 | 2.51 | 2.56 | 2.62 | 2.55 | 2.56 |
| Gravity?g/cm³ | | | | | | | | | | | |
| Yong's Modulus | 77.0 | 79.0 | 81.0 | 78.0 | 78.3 | 86.3 | 79.0 | 79.3 | 85.3 | 78.7 | 79.0 |
| E??Pa | | | | | | | | | | | |
| Elastic Modulus | 30.8 | 31.3 | 32.0 | 30.4 | 30.7 | 34.2 | 31.5 | 31.0 | 32.6 | 30.9 | 30.9 |
| Ratio | | | | | | | | | | | |
| C.T.E | 113 | 102 | 96 | 105 | 99 | 72 | 108 | 89 | 73 | 103 | 97 |
| Amount of | 58 | 55 | 53 | 61 | 59 | 51 | 58 | 54 | 48 | 46 | 53 |
| Migration of | | | | | | | | | | | |
| alkali metal | | | | | | | | | | | |
| [ppb] | | | | | | | | | | | |
| P/Pli | 1.3 | 1.2 | 1.2 | 1.2 | 1.2 | 1.1 | 1.2 | 1.2 | 1.1 | 1.3 | 1.2 |

TABLE 32

| | A-318 | A-319 | A-320 | A-321 | A-322 | A-323 | A-324 | A-325 | A-326 | A-327 |
|---|---|---|---|---|---|---|---|---|---|---|
| SiO₂ | 67.5 | 66.5 | 68.0 | 66.0 | 67.7 | 67.8 | 66.5 | 68.3 | 66.8 | 67.0 |
| Al₂O₃ | 7.0 | 7.0 | 6.0 | 6.0 | 7.0 | 7.8 | 8.0 | 7.0 | 5.8 | 5.8 |
| MgO | 2.0 | 2.4 | 1.5 | 1.0 | 1.0 | 1.0 | 1.0 | 2.3 | 2.1 | 2.0 |
| CaO | 0.9 | | | 1.1 | 1.0 | 1.0 | 1.0 | 1.9 | 1.9 | 1.1 |
| BaO | 1.5 | 2.0 | 2.0 | | | | | | | |
| SrO | | 1.5 | 1.0 | 1.0 | | | | | | |
| ZnO | 5.9 | 6.0 | 6.0 | 5.0 | 6.4 | 5.3 | 5.0 | 6.0 | 6.2 | 4.5 |
| Li₂O | 8.0 | 7.1 | 7.0 | 6.9 | 6.5 | 6.5 | 7.0 | 6.5 | 6.5 | 7.0 |
| K₂O | | | | 2.4 | 2.5 | 2.2 | 1.7 | 2.5 | 2.2 | 2.2 |
| B₂O₃ | 1.5 | 2.5 | 1.5 | 1.0 | 1.0 | 1.0 | 1.0 | | 1.0 | 1.0 |
| TiO₂ | | | | 1.0 | | | | | | 1.0 |
| ZrO₂ | 2.6 | 1.1 | 3.2 | 5.0 | 3.5 | 3.0 | 3.3 | 3.0 | 2.0 | 1.0 |
| P₂O₅ | 2.1 | 2.5 | 2.4 | 2.2 | 1.0 | 2.0 | 3.0 | 2.0 | 2.0 | 2.0 |
| Y₂O₃ | 0.5 | 1.0 | 1.0 | 1.0 | 2.0 | 2.0 | 2.0 | 0.1 | 3.0 | 5.0 |
| Nb₂O₅ | | | | | | | | | | |
| Ta₂O₅ | | | | | | | | | | |
| La₂O₃ | | | | | | | | | | |
| Sb₂O₃ | 0.4 | 0.5 | 0.4 | 0.4 | 0.4 | 0.4 | 0.4 | 0.4 | 0.4 | 0.4 |
| Total(100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 700 | 700 | 700 | 700 | 700 | 700 | 700 | 700 | 700 | 700 |
| Temperature??? | | | | | | | | | | |
| Nucleous Growing | 3 | 3 | 3 | 3 | 3 | 3 | 3 | 3 | 3 | 3 |
| Time?hr? | | | | | | | | | | |
| Main Crystalline | Crist | Crist | Crist | Crist | Crist | Crist | Crist | Crist | Crist | LZS |
| Phase | | | | | | | | | | |
| Sub Crystalline | LZS | LZS | LZS | LZS | LZS | LZS | LZS | LZS | LZS | Crist |
| Phase | | | | | | | | | | |
| Specific | 2.51 | 2.49 | 2.52 | 2.55 | 2.58 | 2.59 | 2.62 | 2.51 | 2.58 | 2.65 |
| Gravity?g/cm³ | | | | | | | | | | |
| Yong's Modulus | 78.3 | 78.0 | 79.2 | 78.0 | 85.3 | 82.1 | 80.9 | 79.8 | 82.3 | 86.6 |
| E??Pa | | | | | | | | | | |
| Elastic Modulus | 31.2 | 31.3 | 31.4 | 30.6 | 33.1 | 31.7 | 30.9 | 31.8 | 31.9 | 32.7 |
| Ratio | | | | | | | | | | |
| C.T.E | 116 | 115 | 108 | 98 | 86 | 102 | 116 | 113 | 96 | 73 |
| Amount of | 67 | 63 | 60 | 57 | 52 | 56 | 62 | 59 | 55 | 50 |
| Migration of alkali | | | | | | | | | | |
| metal [ppb] | | | | | | | | | | |
| P/Pli | 1.2 | 1.2 | 1.2 | 1.2 | 1.2 | 1.2 | 1.2 | 1.2 | 1.2 | 1.1 |

TABLE 33

| | A-328 | A-329 | A-330 | A-331 | A-332 | A-333 | A-334 | A-335 | A-336 | A-337 | A-338 |
|---|---|---|---|---|---|---|---|---|---|---|---|
| SiO₂ | 65.2 | 67.0 | 69.5 | 66.1 | 66.3 | 65.4 | 68.5 | 67.5 | 66.0 | 67.5 | 67.5 |
| Al₂O₃ | 7.4 | 7.6 | 7.0 | 3.0 | 5.0 | 10.0 | 7.6 | 7.6 | 5.6 | 7.7 | 7.7 |
| MgO | 2.0 | 2.0 | 1.0 | 2.4 | 1.0 | 2.4 | 2.0 | 2.0 | 2.0 | 2.0 | 2.0 |
| CaO | 0.9 | | | | | | | 1.0 | | 0.9 | 0.9 |
| BaO | 2.4 | 2.5 | 2.1 | 1.0 | | | 1.5 | 1.0 | 1.0 | 2.5 | 2.5 |
| SrO | | 1.6 | 1.5 | 2.1 | 1.8 | 1.0 | 1.7 | 1.0 | | | |
| ZnO | 5.0 | 5.9 | 6.0 | 7.2 | 7.2 | 6.0 | 3.0 | 5.0 | 10.0 | 5.9 | 5.5 |
| Li₂O | 6.1 | 6.1 | 6.0 | 7.4 | 7.4 | 7.2 | 6.5 | 6.7 | 6.1 | 4.0 | 6.0 |
| K₂O | 2.1 | | | 2.6 | 2.7 | | 1.2 | 1.1 | 2.1 | 1.0 | 1.0 |
| B₂O₃ | 3.5 | 1.4 | 1.0 | | | | | | | 1.0 | |
| TiO₂ | | | | 1.0 | 1.0 | 1.0 | 1.0 | 1.0 | 1.0 | 1.8 | 1.0 |
| ZrO₂ | 2.5 | 2.6 | 2.5 | 3.2 | 3.4 | 3.3 | 3.5 | 2.6 | 2.6 | 2.6 | 2.8 |
| P₂O₅ | 2.0 | 2.1 | 2.0 | 2.6 | 2.6 | 2.5 | 2.1 | 2.1 | 2.2 | 2.1 | 2.1 |
| Y₂O₃ | 0.5 | 0.8 | 1.0 | 1.0 | 1.2 | 0.8 | 1.0 | 1.0 | 1.0 | 0.5 | 0.5 |
| Nb₂O₅ | | | | | | | | | | | |
| Ta₂O₅ | | | | | | | | | | | |
| La₂O₃ | | | | | | | | | | | |
| Sb₂O₃ | 0.4 | 0.4 | 0.4 | 0.5 | 0.5 | 0.5 | 0.4 | 0.4 | 0.4 | 0.4 | 0.4 |
| Total(100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 730 | 730 | 730 | 730 | 730 | 730 | 730 | 730 | 730 | 730 | 730 |
| Growing | | | | | | | | | | | |
| Temperature??? | | | | | | | | | | | |
| Nucleous | 3 | 3 | 3 | 3 | 3 | 3 | 3 | 3 | 3 | 3 | 3 |
| Growing | | | | | | | | | | | |
| Time?hr? | | | | | | | | | | | |
| Main Crystalline | Crist | Crist | Crist | Crist | Crist | Crist | Crist | Crist | LZS | Crist | Crist |
| Phase | | | | | | | | | | | |
| Sub Crystalline | Quartz | Quartz | LZS | LZS | LZS | LZS | LZS | LZS | Crist | Quartz | LZS |
| Phase | | | | | | | | | | | |
| Specific | 2.49 | 2.51 | 2.52 | 2.56 | 2.54 | 2.51 | 2.50 | 2.55 | 2.61 | 2.54 | 2.55 |
| Gravity?g/cm³ | | | | | | | | | | | |
| Yong's Modulus | 76.5 | 78.5 | 80.5 | 77.5 | 77.8 | 84.2 | 78.5 | 78.8 | 84.8 | 78.2 | 78.5 |
| E??Pa | | | | | | | | | | | |
| Elastic Modulus | 30.7 | 31.3 | 31.9 | 30.3 | 30.6 | 33.6 | 31.4 | 30.9 | 32.5 | 30.8 | 30.8 |
| Ratio | | | | | | | | | | | |
| C.T.E | 116 | 108 | 104 | 110 | 106 | 83 | 112 | 100 | 78 | 109 | 105 |
| Amount of | 53 | 52 | 51 | 52 | 51 | 47 | 52 | 50 | 46 | 52 | 51 |
| Migration of | | | | | | | | | | | |
| alkali metal | | | | | | | | | | | |
| [ppb] | | | | | | | | | | | |
| P/Pli | 1.3 | 1.3 | 1.3 | 1.3 | 1.3 | 1.2 | 1.3 | 1.3 | 1.2 | 1.3 | 1.3 |

TABLE 34

| | A-339 | A-340 | A-341 | A-342 | A-343 | A-344 | A-345 | A-346 | A-347 | A-348 |
|---|---|---|---|---|---|---|---|---|---|---|
| SiO₂ | 67.5 | 66.5 | 68.0 | 66.0 | 67.7 | 67.8 | 66.5 | 68.3 | 66.8 | 67.0 |
| Al₂O₃ | 7.0 | 7.0 | 6.0 | 6.0 | 7.0 | 7.8 | 8.0 | 7.0 | 5.8 | 5.8 |
| MgO | 2.0 | 2.4 | 1.5 | 1.0 | 1.0 | 1.0 | 1.0 | 2.3 | 2.1 | 2.0 |
| CaO | 0.9 | | | 1.1 | 1.0 | 1.0 | 1.0 | 1.9 | 1.9 | 1.1 |
| BaO | 1.5 | 2.0 | 2.0 | | | | | | | |
| SrO | | 1.5 | 1.0 | 1.0 | | | | | | |
| ZnO | 5.9 | 6.0 | 6.0 | 5.0 | 6.4 | 5.3 | 5.0 | 6.0 | 6.2 | 4.5 |
| Li₂O | 8.0 | 7.1 | 7.0 | 6.9 | 6.5 | 6.5 | 7.0 | 6.5 | 6.5 | 7.0 |
| K₂O | | | | 2.4 | 2.5 | 2.2 | 1.7 | 2.5 | 2.2 | 2.2 |
| B₂O₃ | 1.5 | 2.5 | 1.5 | 1.0 | 1.0 | 1.0 | 1.0 | | 1.0 | 1.0 |
| TiO₂ | | | | 1.0 | | | | | | 1.0 |
| ZrO₂ | 2.6 | 1.1 | 3.2 | 5.0 | 3.5 | 3.0 | 3.3 | 3.0 | 2.0 | 1.0 |
| P₂O₅ | 2.1 | 2.5 | 2.4 | 2.2 | 1.0 | 2.0 | 3.0 | 2.0 | 2.0 | 2.0 |
| Y₂O₃ | 0.5 | 1.0 | 1.0 | 1.0 | 2.0 | 2.0 | 2.0 | 0.1 | 3.0 | 5.0 |
| Nb₂O₅ | | | | | | | | | | |
| Ta₂O₅ | | | | | | | | | | |
| La₂O₃ | | | | | | | | | | |
| Sb₂O₃ | 0.4 | 0.5 | 0.4 | 0.4 | 0.4 | 0.4 | 0.4 | 0.4 | 0.4 | 0.4 |
| Total(100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 730 | 730 | 730 | 730 | 730 | 730 | 730 | 730 | 730 | 730 |
| Temperature??? | | | | | | | | | | |
| Nucleous Growing | 3 | 3 | 3 | 3 | 3 | 3 | 3 | 3 | 3 | 3 |
| Time?hr? | | | | | | | | | | |
| Main Crystalline | Crist | Crist | Crist | Crist | Crist | Crist | Crist | Crist | Crist | LZS |
| Phase | | | | | | | | | | |
| Sub Crystalline | LZS | LZS | LZS | Quartz | LZS | LZS | LZS | LZS | LZS | Quartz |
| Phase | | | | | | | | | | |
| Specific | 2.50 | 2.48 | 2.51 | 2.55 | 2.57 | 2.58 | 2.61 | 2.50 | 2.57 | 2.64 |
| Gravity?g/cm³ | | | | | | | | | | |
| Yong's Modulus | 77.8 | 77.5 | 78.7 | 79.0 | 84.8 | 81.6 | 80.4 | 79.3 | 81.8 | 87.0 |
| E??Pa | | | | | | | | | | |
| Elastic Modulus | 31.1 | 31.3 | 31.4 | 31.0 | 33.0 | 31.6 | 30.8 | 31.7 | 31.8 | 33.0 |
| Ratio | | | | | | | | | | |
| C.T.E | 118 | 117 | 112 | 106 | 99 | 108 | 118 | 116 | 104 | 78 |
| Amount of | 54 | 53 | 52 | 51 | 50 | 52 | 54 | 53 | 51 | 46 |
| Migration of alkali | | | | | | | | | | |
| metal [ppb] | | | | | | | | | | |
| P/Pli | 1.3 | 1.3 | 1.3 | 1.3 | 1.3 | 1.3 | 1.3 | 1.3 | 1.3 | 1.2 |

TABLE 35

| | A-349 | A-350 | A-351 | A-352 | A-353 | A-354 | A-355 | A-356 | A-357 | A-358 | A-359 |
|---|---|---|---|---|---|---|---|---|---|---|---|
| SiO₂ | 65.2 | 67.0 | 69.5 | 66.1 | 66.3 | 65.4 | 68.5 | 67.5 | 66.0 | 67.5 | 67.5 |
| Al₂O₃ | 7.4 | 7.6 | 7.0 | 3.0 | 5.0 | 10.0 | 7.6 | 7.6 | 5.6 | 7.7 | 7.7 |
| MgO | 2.0 | 2.0 | 1.0 | 2.4 | 1.0 | 2.4 | 2.0 | 2.0 | 2.0 | 2.0 | 2.0 |
| CaO | 0.9 | | | | | | | 1.0 | | 0.9 | 0.9 |
| BaO | 2.4 | 2.5 | 2.1 | 1.0 | | | 1.5 | 1.0 | 1.0 | 2.5 | 2.5 |
| SrO | | 1.6 | 1.5 | 2.1 | 1.8 | 1.0 | 1.7 | 1.0 | | | |
| ZnO | 5.0 | 5.9 | 6.0 | 7.2 | 7.2 | 6.0 | 3.0 | 5.0 | 10.0 | 5.9 | 5.5 |
| Li₂O | 6.1 | 6.1 | 6.0 | 7.4 | 7.4 | 7.2 | 6.5 | 6.7 | 6.1 | 4.0 | 6.0 |
| K₂O | 2.1 | | | 2.6 | 2.7 | | 1.2 | 1.1 | 2.1 | 1.0 | 1.0 |
| B₂O₃ | 3.5 | 1.4 | 1.0 | | | | | | | 1.0 | |
| TiO2 | | | | 1.0 | 1.0 | 1.0 | 1.0 | 1.0 | 1.0 | 1.8 | 1.0 |
| ZrO₂ | 2.5 | 2.6 | 2.5 | 3.2 | 3.4 | 3.3 | 3.5 | 2.6 | 2.6 | 2.6 | 2.8 |
| P₂O₅ | 2.0 | 2.1 | 2.0 | 2.6 | 2.6 | 2.5 | 2.1 | 2.1 | 2.2 | 2.1 | 2.1 |
| Y₂O₃ | 0.5 | 0.8 | 1.0 | 1.0 | 1.2 | 0.8 | 1.0 | 1.0 | 1.0 | 0.5 | 0.5 |
| Nb₂O₅ | | | | | | | | | | | |
| Ta₂O₅ | | | | | | | | | | | |
| La₂O₃ | | | | | | | | | | | |
| Sb₂O₃ | 0.4 | 0.4 | 0.4 | 0.5 | 0.5 | 0.5 | 0.4 | 0.4 | 0.4 | 0.4 | 0.4 |
| Total(100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 700 | 700 | 700 | 700 | 700 | 700 | 700 | 700 | 700 | 700 | 700 |
| Growing | | | | | | | | | | | |
| Temperature??? | | | | | | | | | | | |
| Nucleous | 10 | 10 | 10 | 10 | 10 | 10 | 10 | 10 | 10 | 10 | 10 |
| Growing | | | | | | | | | | | |
| Time?hr? | | | | | | | | | | | |
| Main Crystalline | Crist | Crist | Crist | Crist | Crist | Crist | Crist | Crist | LZS | Crist | Crist |
| Phase | | | | | | | | | | | |
| Sub Crystalline | Quartz | LZS | LZS | LZS | LZS | LZS | LZS | LZS | Crist | Quartz | LZS |
| Phase | | | | | | | | | | | |
| Specific | 2.49 | 2.51 | 2.52 | 2.56 | 2.54 | 2.51 | 2.50 | 2.55 | 2.61 | 2.54 | 2.55 |
| Gravity?g/cm³ | | | | | | | | | | | |
| Yong's Modulus | 76.6 | 78.6 | 80.6 | 77.6 | 77.9 | 84.5 | 78.6 | 78.9 | 84.8 | 78.3 | 78.6 |
| E??Pa | | | | | | | | | | | |
| Elastic Modulus | 30.7 | 31.3 | 31.9 | 30.3 | 30.6 | 33.6 | 31.4 | 30.9 | 32.5 | 30.8 | 30.8 |
| Ratio | | | | | | | | | | | |
| C.T.E | 115 | 108 | 104 | 110 | 106 | 80 | 112 | 100 | 76 | 108 | 105 |
| Amount of | 53 | 52 | 51 | 52 | 51 | 46 | 52 | 50 | 45 | 52 | 51 |
| Migration of | | | | | | | | | | | |
| alkali metal | | | | | | | | | | | |
| [ppb] | | | | | | | | | | | |
| P/Pli | 1.3 | 1.3 | 1.3 | 1.3 | 1.3 | 1.2 | 1.3 | 1.3 | 1.2 | 1.3 | 1.3 |

TABLE 36

| | A-360 | A-361 | A-362 | A-363 | A-364 | A-365 | A-366 | A-367 | A-368 | A-369 |
|---|---|---|---|---|---|---|---|---|---|---|
| SiO₂ | 67.5 | 66.5 | 68.0 | 66.0 | 67.7 | 67.8 | 66.5 | 68.3 | 66.8 | 67.0 |
| Al₂O₃ | 7.0 | 7.0 | 6.0 | 6.0 | 7.0 | 7.8 | 8.0 | 7.0 | 5.8 | 5.8 |
| MgO | 2.0 | 2.4 | 1.5 | 1.0 | 1.0 | 1.0 | 1.0 | 2.3 | 2.1 | 2.0 |
| CaO | 0.9 | | | 1.1 | 1.0 | 1.0 | 1.0 | 1.9 | 1.9 | 1.1 |
| BaO | 1.5 | 2.0 | 2.0 | | | | | | | |
| SrO | | 1.5 | 1.0 | 1.0 | | | | | | |
| ZnO | 5.9 | 6.0 | 6.0 | 5.0 | 6.4 | 5.3 | 5.0 | 6.0 | 6.2 | 4.5 |
| Li₂O | 8.0 | 7.1 | 7.0 | 6.9 | 6.5 | 6.5 | 7.0 | 6.5 | 6.5 | 7.0 |
| K₂O | | | | 2.4 | 2.5 | 2.2 | 1.7 | 2.5 | 2.2 | 2.2 |
| B₂O₃ | 1.5 | 2.5 | 1.5 | 1.0 | 1.0 | 1.0 | 1.0 | | 1.0 | 1.0 |
| TiO₂ | | | | 1.0 | | | | | | 1.0 |
| ZrO₂ | 2.6 | 1.1 | 3.2 | 5.0 | 3.5 | 3.0 | 3.3 | 3.0 | 2.0 | 1.0 |
| P₂O₅ | 2.1 | 2.5 | 2.4 | 2.2 | 1.0 | 2.0 | 3.0 | 2.0 | 2.0 | 2.0 |
| Y₂O₃ | 0.5 | 1.0 | 1.0 | 1.0 | 2.0 | 2.0 | 2.0 | 0.1 | 3.0 | 5.0 |
| Nb₂O₅ | | | | | | | | | | |
| Ta₂O₅ | | | | | | | | | | |
| La₂O₃ | | | | | | | | | | |
| Sb₂O₃ | 0.4 | 0.5 | 0.4 | 0.4 | 0.4 | 0.4 | 0.4 | 0.4 | 0.4 | 0.4 |
| Total(100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 700 | 700 | 700 | 700 | 700 | 700 | 700 | 700 | 700 | 700 |
| Temperature??? | | | | | | | | | | |
| Nucleous Growing | 10 | 10 | 10 | 10 | 10 | 10 | 10 | 10 | 10 | 10 |
| Time?hr? | | | | | | | | | | |
| Main Crystalline | Crist | Crist | Crist | Crist | Crist | Crist | Crist | Crist | Crist | LZS |
| Phase | | | | | | | | | | |
| Sub Crystalline | LZS | LZS | LZS | LZS | LZS | LZS | LZS | LZS | LZS | Quartz |
| Phase | | | | | | | | | | |
| Specific | 2.50 | 2.48 | 2.51 | 2.54 | 2.57 | 2.58 | 2.61 | 2.50 | 2.57 | 2.64 |
| Gravity?g/cm³ | | | | | | | | | | |
| Yong's Modulus | 77.9 | 77.6 | 78.8 | 77.6 | 84.8 | 81.6 | 80.5 | 79.4 | 81.8 | 86.8 |
| E??Pa | | | | | | | | | | |
| Elastic Modulus | 31.1 | 31.2 | 31.3 | 30.5 | 33.0 | 31.6 | 30.8 | 31.7 | 31.8 | 32.8 |
| Ratio | | | | | | | | | | |
| C.T.E | 118 | 117 | 112 | 105 | 98 | 108 | 118 | 115 | 104 | 77 |
| Amount of | 54 | 53 | 52 | 51 | 50 | 52 | 54 | 53 | 51 | 45 |
| Migration at alkali | | | | | | | | | | |
| metal [ppb] | | | | | | | | | | |
| P/Pli | 1.3 | 1.3 | 1.3 | 1.3 | 1.3 | 1.3 | 1.3 | 1.3 | 1.3 | 1.2 |

Tables 37 and 38 show the glass compositions in % by weight of respective crystallized glass substrates of A-370 to A-390, together with the manufacturing conditions employed. Tables 39 and 40 show crystallized glass substrates as ex. 391 to 411 manufactured using the same glass compositions as those of A-370 to A-390 with the nucleus growing temperature varied from that employed for A-370 to A-390. Further, Tables 41 and 42 show crystallized glass substrates as A-412 to A-432 manufactured using the same glass compositions as those of A-370 to A-390 with the nucleus growing time varied from that employed for A-370 to A-390.

TABLE 37

| | A-370 | A-371 | A-372 | A-373 | A-374 | A-375 | A-376 | A-377 | A-378 | A-379 | A-380 |
|---|---|---|---|---|---|---|---|---|---|---|---|
| SiO₂ | 65.2 | 67.0 | 69.5 | 66.1 | 66.3 | 65.4 | 68.5 | 67.5 | 66.0 | 67.5 | 67.5 |
| Al₂O₃ | 7.4 | 7.6 | 7.0 | 3.0 | 5.0 | 10.0 | 7.6 | 7.6 | 5.6 | 7.7 | 7.7 |
| MgO | 2.0 | 2.0 | 1.0 | 2.4 | 1.0 | 2.4 | 2.0 | 2.0 | 2.0 | 2.0 | 2.0 |
| CaO | 0.9 | | | | | | | 1.0 | | 0.9 | 0.9 |
| BaO | 2.4 | 2.5 | 2.1 | 1.0 | | | 1.5 | 1.0 | 1.0 | 2.5 | 2.5 |
| SrO | | 1.6 | 1.5 | 2.1 | 1.8 | 1.0 | 1.7 | 1.0 | | | |
| ZnO | 5.0 | 5.9 | 6.0 | 7.2 | 7.2 | 6.0 | 3.0 | 5.0 | 10.0 | 5.9 | 5.5 |
| Li₂O | 6.1 | 6.1 | 6.0 | 7.4 | 7.4 | 7.2 | 6.5 | 6.7 | 6.1 | 4.0 | 6.0 |
| K₂O | 2.1 | 1.4 | 1.0 | 2.6 | 2.7 | | 2.2 | 2.1 | 2.1 | 1.0 | 1.0 |
| B₂O₃ | 3.5 | | | | | | | | | 1.0 | |
| TiO₂ | | | | 1.0 | 1.0 | 1.0 | | | 1.0 | 1.8 | 1.0 |
| ZrO₂ | 2.5 | 2.6 | 2.5 | 3.2 | 3.4 | 3.3 | 3.5 | 2.6 | 2.6 | 2.6 | 2.8 |
| P₂O₅ | 2.0 | 2.1 | 2.0 | 2.6 | 2.6 | 2.5 | 2.1 | 2.1 | 2.2 | 2.1 | 2.1 |
| Y₂O₃ | | | | | | | | | | | |
| Nb₂O₅ | 0.5 | 0.8 | 1.0 | 1.0 | 1.2 | 0.8 | 1.0 | 1.0 | 1.0 | 0.5 | 0.5 |
| Ta₂O₅ | | | | | | | | | | | |
| La₂O₃ | | | | | | | | | | | |
| Sb₂O₃ | 0.4 | 0.4 | 0.4 | 0.5 | 0.5 | 0.5 | 0.4 | 0.4 | 0.4 | 0.4 | 0.4 |
| Total(100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 700 | 700 | 700 | 700 | 700 | 700 | 700 | 700 | 700 | 700 | 700 |
| Growing | | | | | | | | | | | |
| Temperature??? | | | | | | | | | | | |
| Nucleous | 3 | 3 | 3 | 3 | 3 | 3 | 3 | 3 | 3 | 3 | 3 |
| Growing | | | | | | | | | | | |
| Time?hr? | | | | | | | | | | | |
| Main Crystalline | Quartz | Crist | Crist | Crist | Crist | LZS | Crist | Crist | LZS | Quartz | Crist |
| Phase | | | | | | | | | | | |
| Sub Crystalline | Crist | LZS | LZS | LZS | LZS | Crist | LZS | LZS | Crist | Crist | LZS |
| Phase | | | | | | | | | | | |
| Specific | 2.61 | 2.58 | 2.57 | 2.58 | 2.55 | 2.53 | 2.51 | 2.54 | 2.62 | 2.68 | 2.60 |
| Gravity?g/cm³ | | | | | | | | | | | |
| Yong's Modulus | 82.1 | 81.5 | 79.3 | 77.0 | 79.0 | 84.3 | 78.0 | 77.6 | 85.0 | 82.3 | 81.2 |
| E??Pa | | | | | | | | | | | |
| Elastic Modulus | 31.5 | 31.6 | 30.9 | 29.8 | 31.0 | 33.3 | 31.1 | 30.6 | 32.4 | 30.7 | 31.2 |
| Ratio | | | | | | | | | | | |
| C.T.E | 103 | 84 | 89 | 117 | 109 | 81 | 110 | 97 | 72 | 98 | 96 |
| Amount of | 55 | 50 | 51 | 65 | 62 | 53 | 59 | 56 | 48 | 46 | 53 |
| Migration of | | | | | | | | | | | |
| alkali metal | | | | | | | | | | | |
| [ppb] | | | | | | | | | | | |
| P/Pli | 1.2 | 1.2 | 1.2 | 1.2 | 1.2 | 1.1 | 1.2 | 1.2 | 1.1 | 1.3 | 1.2 |

TABLE 38

| | A-381 | A-382 | A-383 | A-384 | A-385 | A-386 | A-387 | A-388 | A-389 | A-390 |
|---|---|---|---|---|---|---|---|---|---|---|
| SiO₂ | 67.5 | 66.5 | 68.0 | 66.0 | 67.7 | 66.1 | 66.5 | 68.3 | 66.8 | 67.0 |
| Al₂O₃ | 7.0 | 7.0 | 6.0 | 6.0 | 7.0 | 7.5 | 8.0 | 7.0 | 5.8 | 5.8 |
| MgO | 2.0 | 2.4 | 1.5 | 1.0 | 1.0 | 2.0 | 1.0 | 2.3 | 2.1 | 2.0 |
| CaO | 0.9 | | | 1.1 | 1.0 | 0.9 | 1.0 | 1.9 | 1.9 | 1.1 |
| BaO | 1.5 | 2.0 | 2.0 | | | 2.5 | | | | |
| SrO | | 1.5 | 1.0 | 1.0 | | | | | | |
| ZnO | 5.9 | 6.0 | 6.0 | 5.0 | 6.4 | 5.8 | 5.0 | 6.0 | 6.2 | 4.5 |
| Li₂O | 8.0 | 7.1 | 7.0 | 6.9 | 6.5 | 6.0 | 7.0 | 6.5 | 6.5 | 7.0 |
| K₂O | 1.5 | 2.5 | 1.5 | 2.4 | 2.5 | 2.1 | 1.7 | 2.5 | 2.2 | 2.2 |
| B₂O₃ | | | | 1.0 | 1.0 | | 1.0 | | 1.0 | 1.0 |
| TiO₂ | | | | 1.0 | 1.0 | 1.0 | 1.0 | | | 1.0 |
| ZrO₂ | 2.6 | 1.1 | 3.2 | 5.0 | 2.5 | 1.6 | 2.3 | 3.0 | 2.0 | 1.0 |
| P₂O₅ | 2.1 | 2.5 | 2.4 | 2.2 | 1.0 | 2.1 | 3.0 | 2.0 | 2.0 | 2.0 |
| Y₂O₃ | | | | | | | | | | |
| Nb₂O₅ | 0.5 | 1.0 | 1.0 | 1.0 | 2.0 | 2.1 | 2.0 | 0.1 | 3.0 | 5.0 |
| Ta₂O₅ | | | | | | | | | | |
| La₂O₃ | | | | | | | | | | |
| Sb₂O₃ | 0.4 | 0.5 | 0.4 | 0.4 | 0.4 | 0.4 | 0.4 | 0.4 | 0.4 | 0.4 |
| Total(100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 700 | 700 | 700 | 700 | 700 | 700 | 700 | 700 | 700 | 700 |
| Temperature??? | | | | | | | | | | |
| Nucleous Growing | 3 | 3 | 3 | 3 | 3 | 3 | 3 | 3 | 3 | 3 |
| Time?hr? | | | | | | | | | | |
| Main Crystalline | Crist | Crist | Crist | Quartz | Quartz | Crist | Quartz | Crist | Quartz | Quartz |
| Phase | | | | | | | | | | |
| Sub Crystalline | LZS | LZS | LZS | Crist | Crist | LZS | Crist | LZS | Crist | Crist |
| Phase | | | | | | | | | | |
| Specific | 2.55 | 2.50 | 2.57 | 2.68 | 2.61 | 2.55 | 2.66 | 2.51 | 2.59 | 2.65 |
| Gravity?g/cm³ | | | | | | | | | | |
| Yong's Modulus | 78.1 | 79.0 | 82.3 | 80.8 | 81.2 | 82.1 | 79.8 | 78.5 | 78.3 | 82.1 |
| E??Pa | | | | | | | | | | |
| Elastic Modulus | 30.6 | 31.6 | 32.0 | 30.1 | 31.1 | 32.2 | 30.0 | 31.3 | 30.2 | 31.0 |
| Ratio | | | | | | | | | | |
| C.T.E | 115 | 113 | 99 | 106 | 116 | 110 | 108 | 105 | 102 | 93 |
| Amount of | 67 | 62 | 58 | 59 | 60 | 56 | 60 | 57 | 56 | 56 |
| Migration of alkali | | | | | | | | | | |
| metal [ppb] | | | | | | | | | | |
| P/Pli | 1.2 | 1.2 | 1.2 | 1.2 | 1.3 | 1.3 | 1.2 | 1.2 | 1.2 | 1.2 |

TABLE 39

| | A-391 | A-392 | A-393 | A-394 | A-395 | A-396 | A-397 | A-398 | A-399 | A-400 | A-401 |
|---|---|---|---|---|---|---|---|---|---|---|---|
| SiO₂ | 65.2 | 67.0 | 69.5 | 66.1 | 66.3 | 65.4 | 68.5 | 67.5 | 66.0 | 67.5 | 67.5 |
| Al₂O₃ | 7.4 | 7.6 | 7.0 | 3.0 | 5.0 | 10.0 | 7.6 | 7.6 | 5.6 | 7.7 | 7.7 |
| MgO | 2.0 | 2.0 | 1.0 | 2.4 | 1.0 | 2.4 | 2.0 | 2.0 | 2.0 | 2.0 | 2.0 |
| CaO | 0.9 | | | | | | | 1.0 | | 0.9 | 0.9 |
| BaO | 2.4 | 2.5 | 2.1 | 1.0 | | | 1.5 | 1.0 | 1.0 | 2.5 | 2.5 |
| SrO | | 1.6 | 1.5 | 2.1 | 1.8 | 1.0 | 1.7 | 1.0 | | | |
| ZnO | 5.0 | 5.9 | 6.0 | 7.2 | 7.2 | 6.0 | 3.0 | 5.0 | 10.0 | 5.9 | 5.5 |
| Li₂O | 6.1 | 6.1 | 6.0 | 7.4 | 7.4 | 7.2 | 6.5 | 6.7 | 6.1 | 4.0 | 6.0 |
| K₂O | 2.1 | 1.4 | 1.0 | 2.6 | 2.7 | | 2.2 | 2.1 | 2.1 | 1.0 | 1.0 |
| B₂O₃ | 3.5 | | | | | | | | | 1.0 | |
| TiO₂ | | | | 1.0 | 1.0 | 1.0 | | | 1.0 | 1.8 | 1.0 |
| ZrO₂ | 2.5 | 2.6 | 2.5 | 3.2 | 3.4 | 3.3 | 3.5 | 2.6 | 2.6 | 2.6 | 2.8 |
| P₂O₅ | 2.0 | 2.1 | 2.0 | 2.6 | 2.6 | 2.5 | 2.1 | 2.1 | 2.2 | 2.1 | 2.1 |
| Y₂O₃ | | | | | | | | | | | |
| Nb₂O₅ | 0.5 | 0.8 | 1.0 | 1.0 | 1.2 | 0.8 | 1.0 | 1.0 | 1.0 | 0.5 | 0.5 |
| Ta₂O₅ | | | | | | | | | | | |
| La₂O₃ | | | | | | | | | | | |
| Sb₂O₃ | 0.4 | 0.4 | 0.4 | 0.5 | 0.5 | 0.5 | 0.4 | 0.4 | 0.4 | 0.4 | 0.4 |
| Total(100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 730 | 730 | 730 | 730 | 730 | 730 | 730 | 730 | 730 | 730 | 730 |
| Growing | | | | | | | | | | | |
| Temperature??? | | | | | | | | | | | |
| Nucleous | 3 | 3 | 3 | 3 | 3 | 3 | 3 | 3 | 3 | 3 | 3 |
| Growing | | | | | | | | | | | |
| Time?hr? | | | | | | | | | | | |
| Main Crystalline | Quartz | Crist | Crist | Crist | Crist | Crist | Crist | Crist | Crist | Quartz | Crist |
| Phase | | | | | | | | | | | |
| Sub Crystalline | Crist | Quartz | LZS | LZS | LZS | LZS | LZS | LZS | LZS | Crist | LZS |
| Phase | | | | | | | | | | | |
| Specific | 2.63 | 2.57 | 2.56 | 2.57 | 2.54 | 2.52 | 2.50 | 2.53 | 2.61 | 2.70 | 2.59 |
| Gravity?g/cm³ | | | | | | | | | | | |
| Yong's Modulus | 85.6 | 81.0 | 78.8 | 76.5 | 78.5 | 83.8 | 77.5 | 77.1 | 84.5 | 85.8 | 80.7 |
| E??Pa | | | | | | | | | | | |
| Elastic Modulus | 32.5 | 31.5 | 30.8 | 29.8 | 30.9 | 33.2 | 31.0 | 30.5 | 32.4 | 31.8 | 31.2 |
| Ratio | | | | | | | | | | | |
| C.T.E | 110 | 98 | 100 | 119 | 113 | 105 | 114 | 105 | 81 | 108 | 104 |
| Amount of | 52 | 50 | 50 | 54 | 53 | 51 | 53 | 51 | 46 | 52 | 51 |
| Migration of | | | | | | | | | | | |
| alkali metal | | | | | | | | | | | |
| [ppb] | | | | | | | | | | | |
| P/Pli | 1.3 | 1.3 | 1.3 | 1.3 | 1.3 | 1.3 | 1.3 | 1.3 | 1.2 | 1.3 | 1.3 |

TABLE 40

| | A-402 | A-403 | A-404 | A-405 | A-406 | A-407 | A-408 | A-409 | A-410 | A-411 |
|---|---|---|---|---|---|---|---|---|---|---|
| SiO₂ | 67.5 | 66.5 | 68.0 | 66.0 | 67.7 | 66.1 | 66.5 | 68.3 | 66.8 | 67.0 |
| Al₂O₃ | 7.0 | 7.0 | 6.0 | 6.0 | 7.0 | 7.5 | 8.0 | 7.0 | 5.8 | 5.8 |
| MgO | 2.0 | 2.4 | 1.5 | 1.0 | 1.0 | 2.0 | 1.0 | 2.3 | 2.1 | 2.0 |
| CaO | 0.9 | | | 1.1 | 1.0 | 0.9 | 1.0 | 1.9 | 1.9 | 1.1 |
| BaO | 1.5 | 2.0 | 2.0 | | | 2.5 | | | | |
| SrO | | 1.5 | 1.0 | 1.0 | | | | | | |
| ZnO | 5.9 | 6.0 | 6.0 | 5.0 | 6.4 | 5.8 | 5.0 | 6.0 | 6.2 | 4.5 |
| Li₂O | 8.0 | 7.1 | 7.0 | 6.9 | 6.5 | 6.0 | 7.0 | 6.5 | 6.5 | 7.0 |
| K₂O | 1.5 | 2.5 | 1.5 | 2.4 | 2.5 | 2.1 | 1.7 | 2.5 | 2.2 | 2.2 |
| B₂O₃ | | | | 1.0 | 1.0 | | 1.0 | | 1.0 | 1.0 |
| TiO₂ | | | | 1.0 | 1.0 | 1.0 | 1.0 | | | 1.0 |
| ZrO₂ | 2.6 | 1.1 | 3.2 | 5.0 | 2.5 | 1.6 | 2.3 | 3.0 | 2.0 | 1.0 |
| P₂O₅ | 2.1 | 2.5 | 2.4 | 2.2 | 1.0 | 2.1 | 3.0 | 2.0 | 2.0 | 2.0 |
| Y₂O₃ | | | | | | | | | | |
| Nb₂O₅ | 0.5 | 1.0 | 1.0 | 1.0 | 2.0 | 2.1 | 2.0 | 0.1 | 3.0 | 5.0 |
| Ta₂O₅ | | | | | | | | | | |
| La₂O₃ | | | | | | | | | | |
| Sb₂O₃ | 0.4 | 0.5 | 0.4 | 0.4 | 0.4 | 0.4 | 0.4 | 0.4 | 0.4 | 0.4 |
| Total(100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 730 | 730 | 730 | 730 | 730 | 730 | 730 | 730 | 730 | 730 |
| Temperature??? | | | | | | | | | | |
| Nucleous Growing | 3 | 3 | 3 | 3 | 3 | 3 | 3 | 3 | 3 | 3 |
| Time?hr? | | | | | | | | | | |
| Main Crystalline | Crist | Crist | Crist | Quartz | Quartz | Crist | Quartz | Crist | Quartz | Quartz |
| Phase | | | | | | | | | | |
| Sub Crystalline | LZS | LZS | LZS | Crist | Crist | LZS | Crist | LZS | Crist | Crist |
| Phase | | | | | | | | | | |
| Specific | 2.54 | 2.49 | 2.56 | 2.70 | 2.63 | 2.54 | 2.68 | 2.50 | 2.61 | 2.67 |
| Gravity?g/cm³ | | | | | | | | | | |
| Yong's Modulus | 77.6 | 78.5 | 81.8 | 84.2 | 84.6 | 81.6 | 83.2 | 78.0 | 81.6 | 85.6 |
| E??Pa | | | | | | | | | | |
| Elastic Modulus | 30.6 | 31.5 | 32.0 | 31.2 | 32.2 | 32.1 | 31.0 | 31.2 | 31.3 | 32.0 |
| Ratio | | | | | | | | | | |
| C.T.E | 117 | 116 | 106 | 112 | 118 | 114 | 113 | 110 | 110 | 106 |
| Amount of | 53 | 53 | 51 | 52 | 54 | 53 | 53 | 52 | 52 | 51 |
| Migration of alkali | | | | | | | | | | |
| metal [ppb] | | | | | | | | | | |
| P/Pli | 1.3 | 1.3 | 1.3 | 1.3 | 1.3 | 1.3 | 1.3 | 1.3 | 1.3 | 1.3 |

TABLE 41

| | A-412 | A-413 | A-414 | A-415 | A-416 | A-417 | A-418 | A-419 | A-420 | A-421 | A-422 |
|---|---|---|---|---|---|---|---|---|---|---|---|
| SiO₂ | 65.2 | 67.0 | 69.5 | 66.1 | 66.3 | 65.4 | 68.5 | 67.5 | 66.0 | 67.5 | 67.5 |
| Al₂O₃ | 7.4 | 7.6 | 7.0 | 3.0 | 5.0 | 10.0 | 7.6 | 7.6 | 5.6 | 7.7 | 7.7 |
| MgO | 2.0 | 2.0 | 1.0 | 2.4 | 1.0 | 2.4 | 2.0 | 2.0 | 2.0 | 2.0 | 2.0 |
| CaO | 0.9 | | | | | | | 1.0 | | 0.9 | 0.9 |
| BaO | 2.4 | 2.5 | 2.1 | 1.0 | | | 1.5 | 1.0 | 1.0 | 2.5 | 2.5 |
| SrO | | 1.6 | 1.5 | 2.1 | 1.8 | 1.0 | 1.7 | 1.0 | | | |
| ZnO | 5.0 | 5.9 | 6.0 | 7.2 | 7.2 | 6.0 | 3.0 | 5.0 | 10.0 | 5.9 | 5.5 |
| Li₂O | 6.1 | 6.1 | 6.0 | 7.4 | 7.4 | 7.2 | 6.5 | 6.7 | 6.1 | 4.0 | 6.0 |
| K₂O | 2.1 | 1.4 | 1.0 | 2.6 | 2.7 | | 2.2 | 2.1 | 2.1 | 1.0 | 1.0 |
| B₂O₃ | 3.5 | | | | | | | | | 1.0 | |
| TiO₂ | | | | 1.0 | 1.0 | 1.0 | | | 1.0 | 1.8 | 1.0 |
| ZrO₂ | 2.5 | 2.6 | 2.5 | 3.2 | 3.4 | 3.3 | 3.5 | 2.6 | 2.6 | 2.6 | 2.8 |
| P₂O₅ | 2.0 | 2.1 | 2.0 | 2.6 | 2.6 | 2.5 | 2.1 | 2.1 | 2.2 | 2.1 | 2.1 |
| Y₂O₃ | | | | | | | | | | | |
| Nb₂O₅ | 0.5 | 0.8 | 1.0 | 1.0 | 1.2 | 0.8 | 1.0 | 1.0 | 1.0 | 0.5 | 0.5 |
| Ta₂O₅ | | | | | | | | | | | |
| La₂O₃ | | | | | | | | | | | |
| Sb₂O₃ | 0.4 | 0.4 | 0.4 | 0.5 | 0.5 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 700 | 700 | 700 | 700 | 700 | 700 | 700 | 700 | 700 | 700 | 700 |
| Growing | | | | | | | | | | | |
| Temperature??? | | | | | | | | | | | |
| Nucleous | 10 | 10 | 10 | 10 | 10 | 10 | 10 | 10 | 10 | 10 | 10 |
| Growing | | | | | | | | | | | |
| Time?hr? | | | | | | | | | | | |
| Main Crystalline | Quartz | Crist | Crist | Crist | Crist | Crist | Crist | Crist | Crist | Quartz | Crist |
| Phase | | | | | | | | | | | |
| Sub Crystalline | Crist | LZS | LZS | LZS | LZS | LZS | LZS | LZS | LZS | Crist | LZS |
| Phase | | | | | | | | | | | |
| Specific | 2.62 | 2.57 | 2.56 | 2.57 | 2.54 | 2.52 | 2.50 | 2.53 | 2.61 | 2.69 | 2.59 |
| Gravity?g/cm³ | | | | | | | | | | | |
| Yong's Modulus | 84.5 | 81.1 | 78.9 | 76.6 | 78.6 | 83.8 | 77.6 | 77.2 | 84.5 | 84.7 | 80.8 |
| E??Pa | | | | | | | | | | | |
| Elastic Modulus | 32.2 | 31.5 | 30.8 | 29.8 | 30.9 | 33.2 | 31.0 | 30.5 | 32.4 | 31.5 | 31.1 |
| Ratio | | | | | | | | | | | |
| C.T.E | 111 | 97 | 100 | 118 | 113 | 100 | 113 | 105 | 79 | 109 | 104 |
| Amount of | 52 | 49 | 50 | 54 | 53 | 50 | 53 | 51 | 46 | 52 | 51 |
| Migration of | | | | | | | | | | | |
| alkali metal | | | | | | | | | | | |
| [ppb] | | | | | | | | | | | |
| P/Pli | 1.3 | 1.3 | 1.3 | 1.3 | 1.3 | 1.3 | 1.3 | 1.3 | 1.2 | 1.3 | 1.3 |

TABLE 42

| | A-.423 | A-.424 | A-.425 | A-.426 | A-.427 | A-.428 | A-.429 | A-.430 | A-.431 | A-.432 |
|---|---|---|---|---|---|---|---|---|---|---|
| SiO₂ | 67.5 | 66.5 | 68.0 | 66.0 | 67.7 | 66.1 | 66.5 | 68.3 | 66.8 | 67.0 |
| Al₂O₃ | 7.0 | 7.0 | 6.0 | 6.0 | 7.0 | 7.5 | 8.0 | 7.0 | 5.8 | 5.8 |
| MgO | 2.0 | 2.4 | 1.5 | 1.0 | 1.0 | 2.0 | 1.0 | 2.3 | 2.1 | 2.0 |
| CaO | 0.9 | | | 1.1 | 1.0 | 0.9 | 1.0 | 1.9 | 1.9 | 1.1 |
| BaO | 1.5 | 2.0 | 2.0 | | | 2.5 | | | | |
| SrO | | 1.5 | 1.0 | 1.0 | | | | | | |
| ZnO | 5.9 | 6.0 | 6.0 | 5.0 | 6.4 | 5.8 | 5.0 | 6.0 | 6.2 | 4.5 |
| Li₂O | 8.0 | 7.1 | 7.0 | 6.9 | 6.5 | 6.0 | 7.0 | 6.5 | 6.5 | 7.0 |
| K₂O | 1.5 | 2.5 | 1.5 | 2.4 | 2.5 | 2.1 | 1.7 | 2.5 | 2.2 | 2.2 |
| B₂O₃ | | | | 1.0 | 1.0 | | 1.0 | | 1.0 | 1.0 |
| TiO₂ | | | | 1.0 | 1.0 | 1.0 | 1.0 | | | 1.0 |
| ZrO₂ | 2.6 | 1.1 | 3.2 | 5.0 | 2.5 | 1.6 | 2.3 | 3.0 | 2.0 | 1.0 |
| P₂O₅ | 2.1 | 2.5 | 2.4 | 2.2 | 1.0 | 2.1 | 3.0 | 2.0 | 2.0 | 2.0 |
| Y₂O₃ | | | | | | | | | | |
| Nb₂O₅ | 0.5 | 1.0 | 1.0 | 1.0 | 2.0 | 2.1 | 2.0 | 0.1 | 3.0 | 5.0 |
| Ta₂O₅ | | | | | | | | | | |
| La₂O₃ | | | | | | | | | | |
| Sb₂O₃ | 0.4 | 0.5 | 0.4 | 0.4 | 0.4 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 700 | 700 | 700 | 700 | 700 | 700 | 700 | 700 | 700 | 700 |
| Temperature??? | | | | | | | | | | |
| Nucleous Growing | 10 | 10 | 10 | 10 | 10 | 10 | 10 | 10 | 10 | 10 |
| Time?hr? | | | | | | | | | | |
| Main Crystalline | Crist | Crist | Crist | Quartz | Quartz | Crist | Quartz | Crist | Quartz | Quartz |
| Phase | | | | | | | | | | |
| Sub Crystalline | LZS | LZS | LZS | Crist | Crist | LZS | Crist | LZS | Crist | Crist |
| Phase | | | | | | | | | | |
| Specific | 2.54 | 2.49 | 2.56 | 2.69 | 2.62 | 2.54 | 2.67 | 2.50 | 2.60 | 2.66 |
| Gravity?g/cm³ | | | | | | | | | | |
| Yong's Modulus | 77.7 | 78.6 | 81.8 | 83.2 | 83.6 | 81.6 | 82.2 | 78.1 | 80.6 | 84.5 |
| E??Pa | | | | | | | | | | |
| Elastic Modulus | 30.5 | 31.5 | 31.9 | 30.9 | 31.9 | 32.1 | 30.7 | 31.2 | 31.0 | 31.8 |
| Ratio | | | | | | | | | | |
| C.T.E | 117 | 115 | 106 | 113 | 119 | 113 | 114 | 110 | 111 | 107 |
| Amount of | 53 | 53 | 51 | 53 | 54 | 53 | 53 | 52 | 52 | 51 |
| Migration of alkali | | | | | | | | | | |
| metal [ppb] | | | | | | | | | | |
| P/Pli | 1.3 | 1.3 | 1.3 | 1.3 | 1.3 | 1.3 | 1.3 | 1.3 | 1.3 | 1.3 |

Tables 43 and 44 show the glass compositions in % by weight of respective crystallized glass substrates of A-433 to A-453, together with the manufacturing conditions employed. Tables 45 and 46 show crystallized glass substrates as A-454 to A-474 manufactured using the same glass compositions as those of A-433 to A-453 with the nucleus growing temperature varied from that employed for A-433 to A-453. Further, Tables 47 and 48 show crystallized glass substrates as A-475 to A-495 manufactured using the same glass compositions as those of A-433 to A-453 with the nucleus growing time varied from that employed for A-433 to A-453.

TABLE 43

| | A-433 | A-434 | A-435 | A-436 | A-437 | A-438 | A-439 | A-440 | A-441 | A-442 | A-443 |
|---|---|---|---|---|---|---|---|---|---|---|---|
| SiO₂ | 65.2 | 67.0 | 69.5 | 66.1 | 66.3 | 65.4 | 68.5 | 67.5 | 66.0 | 67.5 | 67.5 |
| Al₂O₃ | 7.4 | 7.6 | 7.0 | 3.0 | 5.0 | 10.0 | 7.6 | 7.6 | 5.6 | 7.7 | 7.7 |
| MgO | 2.0 | 2.0 | 1.0 | 2.4 | 1.0 | 2.4 | 2.0 | 2.0 | 2.0 | 2.0 | 2.0 |
| CaO | 0.9 | | | | | | | 1.0 | | 0.9 | 0.9 |
| BaO | 2.4 | 2.5 | 2.1 | 1.0 | | | 1.5 | 1.0 | 1.0 | 2.5 | 2.5 |
| SrO | | 1.6 | 1.5 | 2.1 | 1.8 | 1.0 | 1.7 | 1.0 | | | |
| ZnO | 5.0 | 5.9 | 6.0 | 7.2 | 7.2 | 6.0 | 3.0 | 5.0 | 10.0 | 5.9 | 5.5 |
| Li₂O | 6.1 | 6.1 | 6.0 | 7.4 | 7.4 | 7.2 | 6.5 | 6.7 | 6.1 | 4.0 | 6.0 |
| K₂O | 2.1 | | | 2.6 | 2.7 | | 1.2 | 1.1 | 2.1 | 1.0 | 1.0 |
| B₂O₃ | 3.5 | 1.4 | 1.0 | | | | 1.0 | 1.0 | | 1.0 | |
| TiO₂ | | | | 1.0 | 1.0 | 1.0 | | | 1.0 | 1.8 | 1.0 |
| ZrO₂ | 2.5 | 2.6 | 2.5 | 3.2 | 3.4 | 3.3 | 3.5 | 2.6 | 2.6 | 2.6 | 2.8 |
| P₂O₅ | 2.0 | 2.1 | 2.0 | 2.6 | 2.6 | 2.5 | 2.1 | 2.1 | 2.2 | 2.1 | 2.1 |
| Y₂O₃ | | | | | | | | | | | |
| Nb₂O₅ | | | | | | | | | | | |
| Ta₂O₅ | 0.5 | 0.8 | 1.0 | 1.0 | 1.2 | 0.8 | 1.0 | 1.0 | 1.0 | 0.5 | 0.5 |
| La₂O₃ | | | | | | | | | | | |
| Sb₂O₃ | 0.4 | 0.4 | 0.4 | 0.5 | 0.5 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 700 | 700 | 700 | 700 | 700 | 700 | 700 | 700 | 700 | 700 | 700 |
| Growing | | | | | | | | | | | |
| Temperature??? | | | | | | | | | | | |
| Nucleous | 3 | 3 | 3 | 3 | 3 | 3 | 3 | 3 | 3 | 3 | 3 |
| Growing | | | | | | | | | | | |
| Time?hr? | | | | | | | | | | | |
| Main Crystalline | Quartz | Quartz | Quartz | Crist | Crist | LZS | Quartz | Quartz | LZS | Quartz | Crist |
| Phase | | | | | | | | | | | |
| Sub Crystalline | Crist | Crist | Crist | LZS | LZS | Crist | Crist | Crist | Crist | Crist | LZS |
| Phase | | | | | | | | | | | |
| Specific | 2.61 | 2.64 | 2.68 | 2.55 | 2.54 | 2.53 | 2.61 | 2.66 | 2.65 | 2.63 | 2.58 |
| Gravity?g/cm³ | | | | | | | | | | | |
| Yong's Modulus | 82.3 | 82.3 | 82.8 | 78.0 | 79.2 | 84.0 | 81.5 | 82.3 | 85.3 | 82.1 | 79.2 |
| E??Pa | | | | | | | | | | | |
| Elastic Modulus | 31.5 | 31.2 | 30.9 | 30.6 | 31.2 | 33.2 | 31.2 | 30.9 | 32.2 | 31.2 | 30.7 |
| Ratio | | | | | | | | | | | |
| C.T.E | 99 | 106 | 115 | 112 | 87 | 72 | 112 | 118 | 73 | 113 | 105 |
| Amount of | 54 | 56 | 58 | 63 | 56 | 51 | 59 | 62 | 48 | 48 | 55 |
| Migration of | | | | | | | | | | | |
| alkali metal | | | | | | | | | | | |
| [ppb] | | | | | | | | | | | |
| P/Pli | 1.2 | 1.2 | 1.3 | 1.2 | 1.1 | 1.1 | 1.2 | 1.2 | 1.1 | 1.4 | 1.2 |

TABLE 44

| | A-444 | A-445 | A-446 | A-447 | A-448 | A-449 | A-450 | A-451 | A-452 | A-453 |
|---|---|---|---|---|---|---|---|---|---|---|
| SiO₂ | 67.5 | 66.5 | 68.0 | 66.0 | 67.7 | 67.8 | 66.5 | 68.3 | 65.2 | 67.0 |
| Al₂O₃ | 7.0 | 7.0 | 6.0 | 6.0 | 7.0 | 7.8 | 8.0 | 7.0 | 7.4 | 5.8 |
| MgO | 2.0 | 2.4 | 1.5 | 1.0 | 1.0 | 1.0 | 1.0 | 2.3 | 2.0 | 2.0 |
| CaO | 0.9 | | | 1.1 | 1.0 | 1.0 | 1.0 | 2.3 | 0.9 | 1.1 |
| BaO | 1.5 | 2.0 | 2.0 | | | | | | 2.4 | |
| SrO | | 1.5 | 1.0 | 1.0 | | | | | | |
| ZnO | 5.9 | 6.0 | 6.0 | 5.0 | 6.4 | 5.3 | 5.0 | 6.0 | 5.7 | 4.5 |
| Li₂O | 8.0 | 7.1 | 7.0 | 6.9 | 6.5 | 6.5 | 7.0 | 6.5 | 5.9 | 7.0 |
| K₂O | | 1.5 | 0.5 | 2.4 | 2.5 | 2.2 | 1.7 | 2.5 | 2.1 | 2.2 |
| B₂O₃ | | 1.0 | 1.0 | 1.0 | 1.0 | 1.0 | 1.0 | | | 1.4 |
| TiO₂ | 1.5 | | | 1.0 | | | | | 1.5 | 1.0 |
| ZrO₂ | 2.6 | 1.1 | 3.2 | 5.0 | 3.5 | 3.0 | 3.3 | 3.0 | 1.0 | 1.0 |
| P₂O₅ | 2.1 | 2.5 | 2.4 | 2.2 | 1.0 | 2.0 | 3.0 | 2.0 | 2.0 | 2.0 |
| Y₂O₃ | | | | | | | | | | |
| Nb₂O₅ | | | | | | | | | | |
| Ta₂O₅ | 0.5 | 1.0 | 1.0 | 1.0 | 2.0 | 2.0 | 2.0 | 0.1 | 3.5 | 5.0 |
| La₂O₃ | | | | | | | | | | |
| Sb₂O₃ | 0.4 | 0.5 | 0.4 | 0.4 | 0.4 | 0.4 | 0.4 | | 0.4 | |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| MeltingTime?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 700 | 700 | 700 | 700 | 700 | 700 | 700 | 700 | 700 | 700 |
| Temperature??? | | | | | | | | | | |
| Nucleous Growing | 3 | 3 | 3 | 3 | 3 | 3 | 3 | 3 | 3 | 3 |
| Time?hr? | | | | | | | | | | |
| Main Crystalline | Crist | Quartz | Quartz | Quartz | Quartz | Quartz | Quartz | Crist | Crist | Quartz |
| Phase | | | | | | | | | | |
| Sub Crystalline | LZS | Crist | Crist | Crist | Crist | Crist | Crist | LZS | LZS | Crist |
| Phase | | | | | | | | | | |
| Specific | 2.54 | 2.56 | 2.62 | 2.66 | 2.58 | 2.58 | 2.58 | 2.51 | 2.59 | 2.67 |
| Gravity?g/cm³ | | | | | | | | | | |
| Yong's Modulus | 77.9 | 80.8 | 81.2 | 82.1 | 81.4 | 81.4 | 81.4 | 77.9 | 85.0 | 82.7 |
| E??Pa | | | | | | | | | | |
| Elastic Modulus | 30.7 | 31.6 | 31.0 | 30.9 | 31.6 | 31.6 | 31.6 | 31.0 | 32.8 | 31.0 |
| Ratio | | | | | | | | | | |
| C.T.E | 116 | 102 | 98 | 85 | 89 | 89 | 89 | 105 | 79 | 98 |
| Amount of | 67 | 59 | 57 | 54 | 53 | 53 | 55 | 57 | 49 | 57 |
| Migration of alkali | | | | | | | | | | |
| metal [ppb] | | | | | | | | | | |
| P/Pli | 1.2 | 1.2 | 1.2 | 1.1 | 1.2 | 1.2 | 1.2 | 1.2 | 1.2 | 1.2 |

TABLE 45

| | A-454 | A-455 | A-456 | A-457 | A-458 | A-459 | A-460 | A-461 | A-462 | A-463 | A-464 |
|---|---|---|---|---|---|---|---|---|---|---|---|
| SiO₂ | 65.2 | 67.0 | 69.5 | 66.1 | 66.3 | 65.4 | 68.5 | 67.5 | 66.0 | 67.5 | 67.5 |
| Al₂O₃ | 7.4 | 7.6 | 7.0 | 3.0 | 5.0 | 10.0 | 7.6 | 7.6 | 5.6 | 7.7 | 7.7 |
| MgO | 2.0 | 2.0 | 1.0 | 2.4 | 1.0 | 2.4 | 2.0 | 2.0 | 2.0 | 2.0 | 2.0 |
| CaO | 0.9 | | | | | | | 1.0 | | 0.9 | 0.9 |
| BaO | 2.4 | 2.5 | 2.1 | 1.0 | | | 1.5 | 1.0 | 1.0 | 2.5 | 2.5 |
| SrO | | 1.6 | 1.5 | 2.1 | 1.8 | 1.0 | 1.7 | 1.0 | | | |
| ZnO | 5.0 | 5.9 | 6.0 | 7.2 | 7.2 | 6.0 | 3.0 | 5.0 | 10.0 | 5.9 | 5.5 |
| Li₂O | 6.1 | 6.1 | 6.0 | 7.4 | 7.4 | 7.2 | 6.5 | 6.7 | 6.1 | 4.0 | 6.0 |
| K₂O | 2.1 | | | 2.6 | 2.7 | | 1.2 | 1.1 | 2.1 | 1.0 | 1.0 |
| B₂O₃ | 3.5 | 1.4 | 1.0 | | | | 1.0 | 1.0 | | 1.0 | |
| TiO₂ | | | | 1.0 | 1.0 | 1.0 | | | 1.0 | 1.8 | 1.0 |
| ZrO₂ | 2.5 | 2.6 | 2.5 | 3.2 | 3.4 | 3.3 | 3.5 | 2.6 | 2.6 | 2.6 | 2.8 |
| P₂O₅ | 2.0 | 2.1 | 2.0 | 2.6 | 2.6 | 2.5 | 2.1 | 2.1 | 2.2 | 2.1 | 2.1 |
| Y₂O₃ | | | | | | | | | | | |
| Nb₂O₅ | | | | | | | | | | | |
| Ta₂O₅ | 0.5 | 0.8 | 1.0 | 1.0 | 1.2 | 0.8 | 1.0 | 1.0 | 1.0 | 0.5 | 0.5 |
| La₂O₃ | | | | | | | | | | | |
| Sb₂O₃ | 0.4 | 0.4 | 0.4 | 0.5 | 0.5 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 730 | 730 | 730 | 730 | 730 | 730 | 730 | 730 | 730 | 730 | 730 |
| Growing | | | | | | | | | | | |
| Temperature??? | | | | | | | | | | | |
| Nucleous | 3 | 3 | 3 | 3 | 3 | 3 | 3 | 3 | 3 | 3 | 3 |
| Growing | | | | | | | | | | | |
| Time?hr? | | | | | | | | | | | |
| Main Crystalline | Quartz | Quartz | Quartz | Crist | Crist | Crist | Quartz | Quartz | Crist | Quartz | Crist |
| Phase | | | | | | | | | | | |
| Sub Crystalline | Crist | Crist | Crist | LZS | LZS | LZS | Crist | Crist | LZS | Crist | LZS |
| Phase | | | | | | | | | | | |
| Specific | 2.63 | 2.66 | 2.70 | 2.54 | 2.53 | 2.52 | 2.63 | 2.68 | 2.64 | 2.65 | 2.57 |
| Gravity?g/cm³ | | | | | | | | | | | |
| Yong's Modulus | 85.8 | 85.8 | 86.3 | 77.5 | 78.7 | 83.5 | 84.9 | 85.8 | 84.8 | 85.6 | 78.7 |
| E??Pa | | | | | | | | | | | |
| Elastic Modulus | 32.6 | 32.2 | 31.9 | 30.5 | 31.1 | 33.1 | 32.3 | 32.0 | 32.1 | 32.3 | 30.6 |
| Ratio | | | | | | | | | | | |
| C.T.E | 108 | 112 | 117 | 115 | 99 | 93 | 115 | 119 | 94 | 116 | 110 |
| Amount of | 52 | 52 | 53 | 53 | 50 | 49 | 53 | 54 | 49 | 53 | 52 |
| Migration of | | | | | | | | | | | |
| alkali metal | | | | | | | | | | | |
| [ppb] | | | | | | | | | | | |
| P/Pli | 1.3 | 1.3 | 1.3 | 1.3 | 1.3 | 1.2 | 1.3 | 1.3 | 1.2 | 1.3 | 1.3 |

TABLE 46

| | A-465 | A-466 | A-467 | A-468 | A-469 | A-470 | A-471 | A-472 | A-473 | A-474 |
|---|---|---|---|---|---|---|---|---|---|---|
| SiO₂ | 67.5 | 66.5 | 68.0 | 66.0 | 67.7 | 67.8 | 66.5 | 68.3 | 65.2 | 67.0 |
| Al₂O₃ | 7.0 | 7.0 | 6.0 | 6.0 | 7.0 | 7.8 | 8.0 | 7.0 | 7.4 | 5.8 |
| MgO | 2.0 | 2.4 | 1.5 | 1.0 | 1.0 | 1.0 | 1.0 | 2.3 | 2.0 | 2.0 |
| CaO | 0.9 | | | 1.1 | 1.0 | 1.0 | 1.0 | 2.3 | 0.9 | 1.1 |
| BaO | 1.5 | 2.0 | 2.0 | | | | | | 2.4 | |
| SrO | | 1.5 | 1.0 | 1.0 | | | | | | |
| ZnO | 5.9 | 6.0 | 6.0 | 5.0 | 6.4 | 5.3 | 5.0 | 6.0 | 5.7 | 4.5 |
| Li₂O | 8.0 | 7.1 | 7.0 | 6.9 | 6.5 | 6.5 | 7.0 | 6.5 | 5.9 | 7.0 |
| K₂O | | 1.5 | 0.5 | 2.4 | 2.5 | 2.2 | 1.7 | 2.5 | 2.1 | 2.2 |
| B₂O₃ | | 1.0 | 1.0 | 1.0 | 1.0 | 1.0 | 1.0 | | | 1.4 |
| TiO2 | 1.5 | | | 1.0 | | | | | 1.5 | 1.0 |
| ZrO₂ | 2.6 | 1.1 | 3.2 | 5.0 | 3.5 | 3.0 | 3.3 | 3.0 | 1.0 | 1.0 |
| P₂O₅ | 2.1 | 2.5 | 2.4 | 2.2 | 1.0 | 2.0 | 3.0 | 2.0 | 2.0 | 2.0 |
| Y₂O₃ | | | | | | | | | | |
| Nb₂O₅ | | | | | | | | | | |
| Ta₂O₅ | 0.5 | 1.0 | 1.0 | 1.0 | 2.0 | 2.0 | 2.0 | 0.1 | 3.5 | 5.0 |
| La₂O₃ | | | | | | | | | | |
| Sb₂O₃ | 0.4 | 0.5 | 0.4 | 0.4 | 0.4 | 0.4 | 0.4 | | 0.4 | |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 730 | 730 | 730 | 730 | 730 | 730 | 730 | 730 | 730 | 730 |
| Temperature??? | | | | | | | | | | |
| Nucleous Growing | 3 | 3 | 3 | 3 | 3 | 3 | 3 | 3 | 3 | 3 |
| Time?hr? | | | | | | | | | | |
| Main Crystalline | Crist | Quartz | Quartz | Quartz | Quartz | Quartz | Quartz | Crist | Crist | Quartz |
| Phase | | | | | | | | | | |
| Sub Crystalline | LZS | Crist | Crist | Crist | Crist | Crist | Crist | LZS | LZS | Crist |
| Phase | | | | | | | | | | |
| Specific | 2.53 | 2.58 | 2.64 | 2.68 | 2.60 | 2.60 | 2.60 | 2.50 | 2.58 | 2.69 |
| Gravity?g/cm³ | | | | | | | | | | |
| Yong's Modulus | 77.4 | 84.2 | 84.6 | 85.6 | 84.8 | 84.8 | 84.8 | 77.4 | 84.5 | 86.2 |
| E??Pa | | | | | | | | | | |
| Elastic Modulus | 30.6 | 32.6 | 32.0 | 31.9 | 32.6 | 32.6 | 32.6 | 31.0 | 32.7 | 32.0 |
| Ratio | | | | | | | | | | |
| C.T.E | 118 | 110 | 108 | 103 | 104 | 104 | 104 | 110 | 96 | 108 |
| Amount of | 54 | 52 | 52 | 51 | 51 | 51 | 51 | 52 | 49 | 52 |
| Migration of alkali | | | | | | | | | | |
| metal [ppb] | | | | | | | | | | |
| P/Pli | 1.3 | 1.3 | 1.3 | 1.3 | 1.3 | 1.3 | 1.3 | 1.3 | 1.3 | 1.3 |

TABLE 47

| | A-475 | A-476 | A-477 | A-478 | A-479 | A-480 | A-481 | A-482 | A-483 | A-484 | A-485 |
|---|---|---|---|---|---|---|---|---|---|---|---|
| SiO₂ | 65.2 | 67.0 | 69.5 | 66.1 | 66.3 | 65.4 | 68.5 | 67.5 | 66.0 | 67.5 | 67.5 |
| Al₂O₃ | 7.4 | 7.6 | 7.0 | 3.0 | 5.0 | 10.0 | 7.6 | 7.6 | 5.6 | 7.7 | 7.7 |
| MgO | 2.0 | 2.0 | 1.0 | 2.4 | 1.0 | 2.4 | 2.0 | 2.0 | 2.0 | 2.0 | 2.0 |
| CaO | 0.9 | | | | | | | 1.0 | | 0.9 | 0.9 |
| BaO | 2.4 | 2.5 | 2.1 | 1.0 | | | 1.5 | 1.0 | 1.0 | 2.5 | 2.5 |
| SrO | | 1.6 | 1.5 | 2.1 | 1.8 | 1.0 | 1.7 | 1.0 | | | |
| ZnO | 5.0 | 5.9 | 6.0 | 7.2 | 7.2 | 6.0 | 3.0 | 5.0 | 10.0 | 5.9 | 5.5 |
| Li₂O | 6.1 | 6.1 | 6.0 | 7.4 | 7.4 | 7.2 | 6.5 | 6.7 | 6.1 | 4.0 | 6.0 |
| K₂O | 2.1 | | | 2.6 | 2.7 | | 1.2 | 1.1 | 2.1 | 1.0 | 1.0 |
| B₂O₃ | 3.5 | 1.4 | 1.0 | | | | 1.0 | 1.0 | | 1.0 | |
| TiO₂ | | | | 1.0 | 1.0 | 1.0 | | | 1.0 | 1.8 | 1.0 |
| ZrO₂ | 2.5 | 2.6 | 2.5 | 3.2 | 3.4 | 3.3 | 3.5 | 2.6 | 2.6 | 2.6 | 2.8 |
| P₂O₅ | 2.0 | 2.1 | 2.0 | 2.6 | 2.6 | 2.5 | 2.1 | 2.1 | 2.2 | 2.1 | 2.1 |
| Y₂O₃ | | | | | | | | | | | |
| Nb₂O₅ | | | | | | | | | | | |
| Ta₂O₅ | 0.5 | 0.8 | 1.0 | 1.0 | 1.2 | 0.8 | 1.0 | 1.0 | 1.0 | 0.5 | 0.5 |
| La₂O₃ | | | | | | | | | | | |
| Sb₂O₃ | 0.4 | 0.4 | 0.4 | 0.5 | 0.5 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 700 | 700 | 700 | 700 | 700 | 700 | 700 | 700 | 700 | 700 | 700 |
| Growing | | | | | | | | | | | |
| Temperature??? | | | | | | | | | | | |
| Nucleous | 10 | 10 | 10 | 10 | 10 | 10 | 10 | 10 | 10 | 10 | 10 |
| Growing | | | | | | | | | | | |
| Time?hr? | | | | | | | | | | | |
| Main Crystalline | Quartz | Quartz | Quartz | Crist | Crist | Crist | Quartz | Quartz | Crist | Quartz | Crist |
| Phase | | | | | | | | | | | |
| Sub Crystalline | Crist | Crist | Crist | LZS | LZS | LZS | Crist | Crist | LZS | Crist | LZS |
| Phase | | | | | | | | | | | |
| Specific | 2.62 | 2.65 | 2.69 | 2.54 | 2.53 | 2.52 | 2.62 | 2.67 | 2.64 | 2.64 | 2.57 |
| Gravity?g/cm³ | | | | | | | | | | | |
| Yong's Modulus | 84.7 | 84.7 | 85.2 | 77.6 | 78.8 | 83.5 | 83.9 | 84.7 | 84.8 | 84.5 | 78.8 |
| E??Pa | | | | | | | | | | | |
| Elastic Modulus | 32.3 | 32.0 | 31.7 | 30.5 | 31.1 | 33.1 | 32.0 | 31.7 | 32.1 | 32.0 | 30.6 |
| Ratio | | | | | | | | | | | |
| C.T.E | 109 | 113 | 118 | 115 | 99 | 92 | 116 | 120 | 92 | 117 | 110 |
| Amount of | 52 | 53 | 54 | 53 | 50 | 48 | 53 | 54 | 48 | 53 | 52 |
| Migration of | | | | | | | | | | | |
| alkali metal | | | | | | | | | | | |
| [ppb] | | | | | | | | | | | |
| P/Pli | 1.3 | 1.3 | 1.3 | 1.3 | 1.3 | 1.2 | 1.3 | 1.3 | 1.2 | 1.3 | 1.3 |

TABLE 48

| | A-486 | A-487 | A-488 | A-489 | A-490 | A-491 | A-492 | A-493 | A-494 | A-495 |
|---|---|---|---|---|---|---|---|---|---|---|
| SiO₂ | 67.5 | 66.5 | 68.0 | 66.0 | 67.7 | 67.8 | 66.5 | 68.3 | 65.2 | 67.0 |
| Al₂O₃ | 7.0 | 7.0 | 6.0 | 6.0 | 7.0 | 7.8 | 8.0 | 7.0 | 7.4 | 5.8 |
| MgO | 2.0 | 2.4 | 1.5 | 1.0 | 1.0 | 1.0 | 1.0 | 2.3 | 2.0 | 2.0 |
| CaO | 0.9 | | | 1.1 | 1.0 | 1.0 | 1.0 | 2.3 | 0.9 | 1.1 |
| BaC | 1.5 | 2.0 | 2.0 | | | | | | 2.4 | |
| SrO | | 1.5 | 1.0 | 1.0 | | | | | | |
| ZnO | 5.9 | 6.0 | 6.0 | 5.0 | 6.4 | 5.3 | 5.0 | 6.0 | 5.7 | 4.5 |
| Li₂O | 8.0 | 7.1 | 7.0 | 6.9 | 6.5 | 6.5 | 7.0 | 6.5 | 5.9 | 7.0 |
| K₂O | | 1.5 | 0.5 | 2.4 | 2.5 | 2.2 | 1.7 | 2.5 | 2.1 | 2.2 |
| B₂O₃ | | 1.0 | 1.0 | 1.0 | 1.0 | 1.0 | 1.0 | | | 1.4 |
| TiO₂ | 1.5 | | | 1.0 | | | | | 1.5 | 1.0 |
| ZrO₂ | 2.6 | 1.1 | 3.2 | 5.0 | 3.5 | 3.0 | 3.3 | 3.0 | 1.0 | 1.0 |
| P₂O₅ | 2.1 | 2.5 | 2.4 | 2.2 | 1.0 | 2.0 | 3.0 | 2.0 | 2.0 | 2.0 |
| Y₂O₃ | | | | | | | | | | |
| Nb₂O₅ | | | | | | | | | | |
| Ta₂O₅ | 0.5 | 1.0 | 1.0 | 1.0 | 2.0 | 2.0 | 2.0 | 0.1 | 3.5 | 5.0 |
| La₂O₃ | | | | | | | | | | |
| Sb₂O₃ | 0.4 | 0.5 | 0.4 | 0.4 | 0.4 | 0.4 | 0.4 | | 0.4 | |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 700 | 700 | 700 | 700 | 700 | 700 | 700 | 700 | 700 | 700 |
| Temperature??? | | | | | | | | | | |
| Nucleous Growing | 10 | 10 | 10 | 10 | 10 | 10 | 10 | 10 | 10 | 10 |
| Time?hr? | | | | | | | | | | |
| Main Crystalline | Crist | Quartz | Quartz | Quartz | Quartz | Quartz | Quartz | Crist | Crist | Quartz |
| Phase | | | | | | | | | | |
| Sub Crystalline | LZS | Crist | Crist | Crist | Crist | Crist | Crist | LZS | LZS | Crist |
| Phase | | | | | | | | | | |
| Specific | 2.53 | 2.57 | 2.63 | 2.67 | 2.59 | 2.59 | 2.59 | 2.50 | 2.58 | 2.68 |
| Gravity?g/cm³ | | | | | | | | | | |
| Yong's Modulus | 77.5 | 83.2 | 83.6 | 84.5 | 83.8 | 83.8 | 83.8 | 77.5 | 84.5 | 85.1 |
| E??Pa | | | | | | | | | | |
| Elastic Modulus | 30.6 | 32.3 | 31.8 | 31.6 | 32.3 | 32.3 | 32.3 | 31.0 | 32.7 | 31.7 |
| Ratio | | | | | | | | | | |
| C.T.E | 118 | 111 | 109 | 104 | 105 | 105 | 105 | 110 | 95 | 109 |
| Amount of | 54 | 52 | 52 | 51 | 51 | 51 | 51 | 52 | 49 | 52 |
| Migration of alkali | | | | | | | | | | |
| metal [ppb] | | | | | | | | | | |
| P/Pli | 1.3 | 1.3 | 1.3 | 1.3 | 1.3 | 1.3 | 1.3 | 1.3 | 1.3 | 1.3 |

Tables 49 and 50 show the glass compositions in % by weight of respective crystallized glass substrates of A-496 to A-516, together with the manufacturing conditions employed. Tables 51 and 52 show crystallized glass substrates as A-517 to A-537 manufactured using the same glass compositions as those of ex. A-496 to A-516 with the nucleus growing temperature varied from that employed for A-496 to A-516. Further, Tables 53 and 54 show crystallized glass substrates as A-538 to A-558 manufactured using the same glass compositions as those of A-496 to A-516 with the nucleus growing time varied from that employed for A-496 to A-516.

TABLE 49

| | A-496 | A-497 | A-498 | A-499 | A-500 | A-501 | A-502 | A-503 | A-504 | A-505 | A-506 |
|---|---|---|---|---|---|---|---|---|---|---|---|
| SiO₂ | 65.2 | 67.0 | 69.5 | 66.1 | 66.3 | 65.4 | 68.5 | 67.5 | 66.0 | 67.5 | 67.5 |
| Al₂O₃ | 7.4 | 7.6 | 7.0 | 3.0 | 5.0 | 10.0 | 7.6 | 7.6 | 5.6 | 7.7 | 7.7 |
| MgO | 2.0 | 2.0 | 1.0 | 2.4 | 1.0 | 2.4 | 2.0 | 2.0 | 2.0 | 2.0 | 2.0 |
| CaO | 0.9 | | | | | | | 1.0 | | 0.9 | 0.9 |
| BaO | 2.4 | 2.5 | 2.1 | 1.0 | | | 1.5 | 1.0 | 1.0 | 2.5 | 2.5 |
| SrO | | 1.6 | 1.5 | 2.1 | 1.8 | 1.0 | 1.7 | 1.0 | | | |
| ZnO | 5.0 | 5.9 | 6.0 | 7.2 | 7.2 | 6.0 | 3.0 | 5.0 | 10.0 | 5.9 | 5.5 |
| Li₂O | 6.1 | 6.1 | 6.0 | 7.4 | 7.4 | 7.2 | 6.5 | 6.7 | 6.1 | 4.0 | 6.0 |
| K₂O | 2.1 | 1.4 | 1.0 | 2.6 | 2.7 | | 2.2 | 2.1 | 2.1 | 1.0 | 1.0 |
| B₂O₃ | 3.5 | | | | | | | | | 1.0 | |
| TiO₂ | | | | 1.0 | 1.0 | 1.0 | | | 1.0 | 1.8 | 1.0 |
| ZrO₂ | 2.5 | 2.6 | 2.5 | 3.2 | 3.4 | 3.3 | 3.5 | 2.6 | 2.6 | 2.6 | 2.8 |
| P₂O₅ | 2.0 | 2.1 | 2.0 | 2.6 | 2.6 | 2.5 | 2.1 | 2.1 | 2.2 | 2.1 | 2.1 |
| Y₂O₃ | | | | | | | | | | | |
| Nb₂O₅ | | | | | | | | | | | |
| Ta₂O₅ | | | | | | | | | | | |
| La₂O₃ | 0.5 | 0.8 | 1.0 | 1.0 | 1.2 | 0.8 | 1.0 | 1.0 | 1.0 | 0.5 | 0.5 |
| Sb₂O₃ | 0.4 | 0.4 | 0.4 | 0.5 | 0.5 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 700 | 700 | 700 | 700 | 700 | 700 | 700 | 700 | 700 | 700 | 700 |
| Growing | | | | | | | | | | | |
| Temperature??? | | | | | | | | | | | |
| Nucleous | 3 | 3 | 3 | 3 | 3 | 3 | 3 | 3 | 3 | 3 | 3 |
| Growing | | | | | | | | | | | |
| Time?hr? | | | | | | | | | | | |
| Main Crystalline | Crist | Crist | Crist | Crist | Crist | Crist | Crist | Crist | LZS | Crist | Crist |
| Phase | | | | | | | | | | | |
| Sub Crystalline | LZS | LZS | LZS | LZS | LZS | LZS | LZS | LZS | Crist | LZS | LZS |
| Phase | | | | | | | | | | | |
| Specific | 2.49 | 2.53 | 2.51 | 2.58 | 2.56 | 2.53 | 2.50 | 2.53 | 2.61 | 2.55 | 2.56 |
| Gravity?g/cm³ | | | | | | | | | | | |
| Yong's Modulus | 78.8 | 80.0 | 81.0 | 78.5 | 79.3 | 82.1 | 77.8 | 79.9 | 86.2 | 79.2 | 80.3 |
| E??Pa | | | | | | | | | | | |
| Elastic Modulus | 31.6 | 31.6 | 32.3 | 30.4 | 31.0 | 32.5 | 31.1 | 31.6 | 33.0 | 31.1 | 31.4 |
| Ratio | | | | | | | | | | | |
| C.T.E | 108 | 95 | 112 | 109 | 93 | 88 | 102 | 89 | 73 | 96 | 96 |
| Amount of | 56 | 53 | 57 | 62 | 58 | 55 | 57 | 54 | 48 | 45 | 53 |
| Migration of | | | | | | | | | | | |
| alkali metal | | | | | | | | | | | |
| [ppb] | | | | | | | | | | | |
| P/Pli | 1.2 | 1.2 | 1.3 | 1.2 | 1.2 | 1.1 | 1.2 | 1.2 | 1.1 | 1.3 | 1.2 |

TABLE 50

| | A-507 | A-508 | A-509 | A-510 | A-511 | A-512 | A-513 | A-514 | A-515 | A-516 |
|---|---|---|---|---|---|---|---|---|---|---|
| SiO₂ | 67.5 | 66.5 | 68.0 | 66.0 | 67.7 | 67.8 | 66.5 | 68.3 | 66.8 | 67.0 |
| Al₂O₃ | 7.0 | 7.0 | 6.0 | 6.0 | 7.0 | 7.8 | 8.0 | 7.0 | 5.8 | 5.8 |
| MgO | 2.0 | 2.4 | 1.5 | 1.0 | 1.0 | 1.0 | 1.0 | 2.3 | 2.1 | 2.0 |
| CaO | 0.9 | | | 1.1 | 1.0 | 1.0 | 1.0 | 1.9 | 1.9 | 1.1 |
| BaO | 1.5 | 2.0 | 2.0 | | | | | | | |
| SrO | | 1.5 | 1.0 | 1.0 | | | | | | |
| ZnO | 5.9 | 6.0 | 6.0 | 5.0 | 6.4 | 5.3 | 5.0 | 6.0 | 6.2 | 4.5 |
| Li₂O | 8.0 | 7.1 | 7.0 | 6.9 | 6.5 | 6.5 | 7.0 | 6.5 | 6.5 | 7.0 |
| K₂O | 1.5 | 1.0 | 0.5 | 2.4 | 2.5 | 2.2 | 1.7 | 2.5 | 2.2 | 2.2 |
| B₂O₃ | | | | 1.0 | 1.0 | 1.0 | 1.0 | | 1.0 | 1.0 |
| TiO₂ | | 1.5 | 1.0 | 1.0 | | | | | | 1.0 |
| ZrO₂ | 2.6 | 1.1 | 3.2 | 5.0 | 3.5 | 3.0 | 3.3 | 3.0 | 2.0 | 1.0 |
| P₂O₅ | 2.1 | 2.5 | 2.4 | 2.2 | 1.0 | 2.0 | 3.0 | 2.0 | 2.0 | 2.0 |
| Y₂O₃ | | | | | | | | | | |
| Nb₂O₅ | | | | | | | | | | |
| Ta₂O₅ | | | | | | | | | | |
| La₂O₃ | 0.5 | 1.0 | 1.0 | 1.0 | 2.0 | 2.0 | 2.0 | 0.1 | 3.0 | 5.0 |
| Sb₂O₃ | 0.4 | 0.5 | 0.4 | 0.4 | 0.4 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous | 700 | 700 | 700 | 700 | 700 | 700 | 700 | 700 | 700 | 700 |
| Growing | | | | | | | | | | |
| Temperature??? | | | | | | | | | | |
| Nucleous | 3 | 3 | 3 | 3 | 3 | 3 | 3 | 3 | 3 | 3 |
| Growing Time?hr? | | | | | | | | | | |
| Main Crystalline | Crist | Crist | Crist | Crist | LZS | Crist | Crist | Crist | Crist | LZS |
| Phase | | | | | | | | | | |
| Sub Crystalline | LZS | LZS | LZS | LZS | Crist | LZS | LZS | LZS | LZS | Crist |
| Phase | | | | | | | | | | |
| Specific | 2.54 | 2.50 | 2.53 | 2.57 | 2.57 | 2.61 | 2.65 | 2.50 | 2.55 | 2.65 |
| Gravity?g/cm³ | | | | | | | | | | |
| Yong's Modulus | 78.1 | 78.0 | 80.2 | 82.1 | 85.2 | 83.2 | 82.0 | 79.8 | 82.1 | 86.2 |
| E??Pa | | | | | | | | | | |
| Elastic Modulus | 30.7 | 31.2 | 31.7 | 31.9 | 33.2 | 31.9 | 30.9 | 31.9 | 32.2 | 32.5 |
| Ratio | | | | | | | | | | |
| C.T.E | 109 | 115 | 109 | 99 | 78 | 92 | 109 | 113 | 88 | 73 |
| Amounf of | 65 | 63 | 61 | 57 | 50 | 54 | 61 | 59 | 53 | 50 |
| Migration of alkali | | | | | | | | | | |
| metal [ppb] | | | | | | | | | | |
| P/PLi | 1.2 | 1.2 | 1.2 | 1.2 | 1.1 | 1.2 | 1.2 | 1.2 | 1.2 | 1.1 |

TABLE 51

| | A-517 | A-518 | A-519 | A-520 | A-521 | A-522 | A-523 | A-524 | A-525 | A-526 | A-527 |
|---|---|---|---|---|---|---|---|---|---|---|---|
| SiO₂ | 65.2 | 67.0 | 69.5 | 66.1 | 66.3 | 65.4 | 68.5 | 67.5 | 66.0 | 67.5 | 67.5 |
| Al₂O₃ | 7.4 | 7.6 | 7.0 | 3.0 | 5.0 | 10.0 | 7.6 | 7.6 | 5.6 | 7.7 | 7.7 |
| MgO | 2.0 | 2.0 | 1.0 | 2.4 | 1.0 | 2.4 | 2.0 | 2.0 | 2.0 | 2.0 | 2.0 |
| CaO | 0.9 | | | | | | | 1.0 | | 0.9 | 0.9 |
| BaO | 2.4 | 2.5 | 2.1 | 1.0 | | | 1.5 | 1.0 | 1.0 | 2.5 | 2.5 |
| SrO | | 1.6 | 1.5 | 2.1 | 1.8 | 1.0 | 1.7 | 1.0 | | | |
| ZnO | 5.0 | 5.9 | 6.0 | 7.2 | 7.2 | 6.0 | 3.0 | 5.0 | 10.0 | 5.9 | 5.5 |
| Li₂O | 6.1 | 6.1 | 6.0 | 7.4 | 7.4 | 7.2 | 6.5 | 6.7 | 6.1 | 4.0 | 6.0 |
| K₂O | 2.1 | 1.4 | 1.0 | 2.6 | 2.7 | | 2.2 | 2.1 | 2.1 | 1.0 | 1.0 |
| B₂O₃ | 3.5 | | | | | | | | | 1.0 | |
| TiO₂ | | | | 1.0 | 1.0 | 1.0 | | | 1.0 | 1.8 | 1.0 |
| ZrO₂ | 2.5 | 2.6 | 2.5 | 3.2 | 3.4 | 3.3 | 3.5 | 2.6 | 2.6 | 2.6 | 2.8 |
| P₂O₅ | 2.0 | 2.1 | 2.0 | 2.6 | 2.6 | 2.5 | 2.1 | 2.1 | 2.2 | 2.1 | 2.1 |
| Y₂O₃ | | | | | | | | | | | |
| Nb₂O₅ | | | | | | | | | | | |
| Ta₂O₅ | | | | | | | | | | | |
| La₂O₃ | 0.5 | 0.8 | 1.0 | 1.0 | 1.2 | 0.8 | 1.0 | 1.0 | 1.0 | 0.5 | 0.5 |
| Sb₂O₃ | 0.4 | 0.4 | 0.4 | 0.5 | 0.5 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 730 | 730 | 730 | 730 | 730 | 730 | 730 | 730 | 730 | 730 | 730 |
| Growing | | | | | | | | | | | |
| Temperature??? | | | | | | | | | | | |
| Nucleous | 3 | 3 | 3 | 3 | 3 | 3 | 3 | 3 | 3 | 3 | 3 |
| Growing | | | | | | | | | | | |
| Time?hr? | | | | | | | | | | | |
| Main Crystalline | Crist | Crist | Crist | Crist | Crist | Crist | Crist | Crist | Crist | Crist | Crist |
| Phase | | | | | | | | | | | |
| Sub Crystalline | Quartz | Quartz | LZS | LZS | LZS | LZS | LZS | LZS | LZS | LZS | LZS |
| Phase | | | | | | | | | | | |
| Specific | 2.48 | 2.52 | 2.50 | 2.57 | 2.55 | 2.52 | 2.49 | 2.52 | 2.60 | 2.54 | 2.55 |
| Gravity?g/cm³ | | | | | | | | | | | |
| Yong's Modulus | 78.3 | 79.5 | 80.5 | 78.0 | 78.8 | 81.6 | 77.3 | 79.4 | 85.7 | 78.7 | 79.8 |
| E??Pa | | | | | | | | | | | |
| Elastic Modulus | 31.6 | 31.6 | 32.2 | 30.4 | 30.9 | 32.4 | 31.1 | 31.5 | 33.0 | 31.0 | 31.3 |
| Ratio | | | | | | | | | | | |
| C.T.E | 112 | 104 | 115 | 113 | 103 | 100 | 108 | 100 | 94 | 104 | 104 |
| Amount of | 52 | 51 | 53 | 53 | 51 | 50 | 52 | 50 | 49 | 51 | 51 |
| Migration of | | | | | | | | | | | |
| alkali metal | | | | | | | | | | | |
| [ppb] | | | | | | | | | | | |
| P/PLi | 1.3 | 1.3 | 1.3 | 1.3 | 1.3 | 1.3 | 1.3 | 1.3 | 1.2 | 1.3 | 1.3 |

TABLE 52

| | A-528 | A-529 | A-530 | A-531 | A-532 | A-533 | A-534 | A-535 | A-536 | A-537 |
|---|---|---|---|---|---|---|---|---|---|---|
| SiO₂ | 67.5 | 66.5 | 68.0 | 66.0 | 67.7 | 67.8 | 66.5 | 68.3 | 66.8 | 67.0 |
| Al₂O₃ | 7.0 | 7.0 | 6.0 | 6.0 | 7.0 | 7.8 | 8.0 | 7.0 | 5.8 | 5.8 |
| MgO | 2.0 | 2.4 | 1.5 | 1.0 | 1.0 | 1.0 | 1.0 | 2.3 | 2.1 | 2.0 |
| CaO | 0.9 | | | 1.1 | 1.0 | 1.0 | 1.0 | 1.9 | 1.9 | 1.1 |
| BaO | 1.5 | 2.0 | 2.0 | | | | | | | |
| SrO | | 1.5 | 1.0 | 1.0 | | | | | | |
| ZnO | 5.9 | 6.0 | 6.0 | 5.0 | 6.4 | 5.3 | 5.0 | 6.0 | 6.2 | 4.5 |
| Li₂O | 8.0 | 7.1 | 7.0 | 6.9 | 6.5 | 6.5 | 7.0 | 6.5 | 6.5 | 7.0 |
| K₂O | 1.5 | 1.0 | 0.5 | 2.4 | 2.5 | 2.2 | 1.7 | 2.5 | 2.2 | 2.2 |
| B₂O₃ | | | | 1.0 | 1.0 | 1.0 | 1.0 | | 1.0 | 1.0 |
| TiO₂ | | 1.5 | 1.0 | 1.0 | | | | | | 1.0 |
| ZrO₂ | 2.6 | 1.1 | 3.2 | 5.0 | 3.5 | 3.0 | 3.3 | 3.0 | 2.0 | 1.0 |
| P₂O₅ | 2.1 | 2.5 | 2.4 | 2.2 | 1.0 | 2.0 | 3.0 | 2.0 | 2.0 | 2.0 |
| Nb₂O₅ | | | | | | | | | | |
| Ta₂O₅ | | | | | | | | | | |
| La₂O₃ | 0.5 | 1.0 | 1.0 | 1.0 | 2.0 | 2.0 | 2.0 | 0.1 | 3.0 | 5.0 |
| Sb₂O₃ | 0.4 | 0.5 | 0.4 | 0.4 | 0.4 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating Time?hr? | 5 | 5 | 5 | 5 | 5 | 5 | 5 | 5 | 5 | 5 |
| Nucleous Growing | 730 | 730 | 730 | 730 | 730 | 730 | 730 | 730 | 730 | 730 |
| Temperature??? | | | | | | | | | | |
| Nucleous Growing | 3 | 3 | 3 | 3 | 3 | 3 | 3 | 3 | 3 | 3 |
| Time?hr? | | | | | | | | | | |
| Main Crystalline Phase | Crist | Crist | Crist | Crist | Crist | Crist | Crist | Crist | Crist | LZS |
| Sub Crystalline Phase | LZS | LZS | LZS | LZS | LZS | LZS | LZS | LZS | LZS | Quartz |
| Specific Gravity?g/cm³ | 2.53 | 2.49 | 2.52 | 2.56 | 2.56 | 2.60 | 2.64 | 2.49 | 2.54 | 2.64 |
| Yong's Modulus E??Pa | 77.6 | 77.5 | 79.7 | 81.6 | 84.7 | 82.7 | 81.5 | 79.3 | 81.6 | 87.0 |
| Elastic Modulus Ratio | 30.7 | 31.1 | 31.6 | 31.9 | 33.1 | 31.8 | 30.9 | 31.9 | 32.1 | 33.0 |
| C.T.E | 113 | 117 | 113 | 106 | 95 | 102 | 113 | 116 | 100 | 78 |
| Amount of Migration of | 53 | 53 | 53 | 51 | 49 | 50 | 53 | 53 | 50 | 46 |
| alkali metal [ppb] | | | | | | | | | | |
| P/PLi | 1.3 | 1.3 | 1.3 | 1.3 | 1.3 | 1.3 | 1.3 | 1.3 | 1.3 | 1.2 |

TABLE 53

| | A-538 | A-539 | A-540 | A-541 | A-542 | A-543 | A-544 | A-545 | A-546 | A-547 | A-548 |
|---|---|---|---|---|---|---|---|---|---|---|---|
| SiO₂ | 65.2 | 67.0 | 69.5 | 66.1 | 66.3 | 65.4 | 68.5 | 67.5 | 66.0 | 67.5 | 67.5 |
| Al₂O₃ | 7.4 | 7.6 | 7.0 | 3.0 | 5.0 | 10.0 | 7.6 | 7.6 | 5.6 | 7.7 | 7.7 |
| MgO | 2.0 | 2.0 | 1.0 | 2.4 | 1.0 | 2.4 | 2.0 | 2.0 | 2.0 | 2.0 | 2.0 |
| CaO | 0.9 | | | | | | | 1.0 | | 0.9 | 0.9 |
| BaO | 2.4 | 2.5 | 2.1 | 1.0 | | | 1.5 | 1.0 | 1.0 | 2.5 | 2.5 |
| SrO | | 1.6 | 1.5 | 2.1 | 1.8 | 1.0 | 1.7 | 1.0 | | | |
| ZnO | 5.0 | 5.9 | 6.0 | 7.2 | 7.2 | 6.0 | 3.0 | 5.0 | 10.0 | 5.9 | 5.5 |
| Li₂O | 6.1 | 6.1 | 6.0 | 7.4 | 7.4 | 7.2 | 6.5 | 6.7 | 6.1 | 4.0 | 6.0 |
| K₂O | 2.1 | 1.4 | 1.0 | 2.6 | 2.7 | | 2.2 | 2.1 | 2.1 | 1.0 | 1.0 |
| B₂O₃ | 3.5 | | | | | | | | | 1.0 | |
| TiO₂ | | | | 1.0 | 1.0 | 1.0 | | | 1.0 | 1.8 | 1.0 |
| ZrO₂ | 2.5 | 2.6 | 2.5 | 3.2 | 3.4 | 3.3 | 3.5 | 2.6 | 2.6 | 2.6 | 2.8 |
| P₂O₅ | 2.0 | 2.1 | 2.0 | 2.6 | 2.6 | 2.5 | 2.1 | 2.1 | 2.2 | 2.1 | 2.1 |
| Y₂O₃ | | | | | | | | | | | |
| Nb₂O₅ | | | | | | | | | | | |
| Ta₂O₅ | | | | | | | | | | | |
| La₂O₃ | 0.5 | 0.8 | 1.0 | 1.0 | 1.2 | 0.8 | 1.0 | 1.0 | 1.0 | 0.5 | 0.5 |
| Sb₂O₃ | 0.4 | 0.4 | 0.4 | 0.5 | 0.5 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting Time?hr? | 3 | 3 | 3 | 3 | 3 | 3 | 3 | 3 | 3 | 3 | 3 |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 700 | 700 | 700 | 700 | 700 | 700 | 700 | 700 | 700 | 700 | 700 |
| Growing | | | | | | | | | | | |
| Temperature??? | | | | | | | | | | | |
| Nucleous | 10 | 10 | 10 | 10 | 10 | 10 | 10 | 10 | 10 | 10 | 10 |
| Growing | | | | | | | | | | | |
| Time?hr? | | | | | | | | | | | |
| Main Crystalline | Crist | Crist | Crist | Crist | Crist | Crist | Crist | Crist | Crist | Crist | Crist |
| Phase | | | | | | | | | | | |
| Sub Crystalline | Quartz | LZS | LZS | LZS | LZS | LZS | LZS | LZS | LZS | LZS | LZS |
| Phase | | | | | | | | | | | |
| Specific | 2.48 | 2.52 | 2.50 | 2.57 | 2.55 | 2.52 | 2.49 | 2.52 | 2.60 | 2.54 | 2.55 |
| Gravity?g/cm³ | | | | | | | | | | | |
| Yong's Modulus | 78.4 | 79.6 | 80.6 | 78.1 | 78.9 | 81.6 | 77.4 | 79.5 | 85.7 | 78.8 | 79.9 |
| E??Pa | | | | | | | | | | | |
| Elastic Modulus | 31.6 | 31.5 | 32.2 | 30.3 | 30.9 | 32.4 | 31.0 | 31.5 | 32.9 | 31.0 | 31.3 |
| Ratio | | | | | | | | | | | |
| C.T.E | 112 | 103 | 115 | 113 | 102 | 99 | 108 | 100 | 92 | 104 | 104 |
| Amount of | 52 | 51 | 53 | 53 | 50 | 50 | 52 | 50 | 48 | 51 | 51 |
| Migration of | | | | | | | | | | | |
| alkali metal [ppb] | | | | | | | | | | | |
| P/PLi | 1.3 | 1.3 | 1.3 | 1.3 | 1.3 | 1.3 | 1.3 | 1.3 | 1.2 | 1.3 | 1.3 |

TABLE 54

| | A-549 | A-550 | A-551 | A-552 | A-553 | A-554 | A-555 | A-556 | A-557 | A-558 |
|---|---|---|---|---|---|---|---|---|---|---|
| SiO₂ | 67.5 | 66.5 | 68.0 | 66.0 | 67.7 | 67.8 | 66.5 | 68.3 | 66.8 | 67.0 |
| Al₂O₃ | 7.0 | 7.0 | 6.0 | 6.0 | 7.0 | 7.8 | 8.0 | 7.0 | 5.8 | 5.8 |
| MgO | 2.0 | 2.4 | 1.5 | 1.0 | 1.0 | 1.0 | 1.0 | 2.3 | 2.1 | 2.0 |
| CaO | 0.9 | | | 1.1 | 1.0 | 1.0 | 1.0 | 1.9 | 1.9 | 1.1 |
| BaO | 1.5 | 2.0 | 2.0 | | | | | | | |
| SrO | | 1.5 | 1.0 | 1.0 | | | | | | |
| ZnO | 5.9 | 6.0 | 6.0 | 5.0 | 6.4 | 5.3 | 5.0 | 6.0 | 6.2 | 4.5 |
| Li₂O | 8.0 | 7.1 | 7.0 | 6.9 | 6.5 | 6.5 | 7.0 | 6.5 | 6.5 | 7.0 |
| K₂O | 1.5 | 1.0 | 0.5 | 2.4 | 2.5 | 2.2 | 1.7 | 2.5 | 2.2 | 2.2 |
| B₂O₃ | | | | 1.0 | 1.0 | 1.0 | 1.0 | | 1.0 | 1.0 |
| TiO₂ | | 1.5 | 1.0 | 1.0 | | | | | | 1.0 |
| ZrO₂ | 2.6 | 1.1 | 3.2 | 5.0 | 3.5 | 3.0 | 3.3 | 3.0 | 2.0 | 1.0 |
| P₂O₅ | 2.1 | 2.5 | 2.4 | 2.2 | 1.0 | 2.0 | 3.0 | 2.0 | 2.0 | 2.0 |
| Y₂O₃ | | | | | | | | | | |
| Nb₂O₅ | | | | | | | | | | |
| Ta₂O₅ | | | | | | | | | | |
| La₂O₃ | 0.5 | 1.0 | 1.0 | 1.0 | 2.0 | 2.0 | 2.0 | 0.1 | 3.0 | 5.0 |
| Sb₂O₃ | 0.4 | 0.5 | 0.4 | 0.4 | 0.4 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating Time?hr? | 5 | 5 | 5 | 5 | 5 | 5 | 5 | 5 | 5 | 5 |
| Nucleous Growing | 700 | 700 | 700 | 700 | 700 | 700 | 700 | 700 | 700 | 700 |
| Temperature??? | | | | | | | | | | |
| Nucleous Growing | 10 | 10 | 10 | 10 | 10 | 10 | 10 | 10 | 10 | 10 |
| Time?hr? | | | | | | | | | | |
| Main Crystalline Phase | Crist | Crist | Crist | Crist | Crist | Crist | Crist | Crist | Crist | LZS |
| Sub Crystalline Phase | LZS | LZS | LZS | LZS | LZS | LZS | LZS | LZS | LZS | Quartz |
| Specific Gravity?g/cm³ | 2.53 | 2.49 | 2.52 | 2.56 | 2.56 | 2.60 | 2.64 | 2.49 | 2.54 | 2.64 |
| Yong's Modulus E??Pa | 77.7 | 77.6 | 79.8 | 81.6 | 84.7 | 82.7 | 81.5 | 79.4 | 81.6 | 86.8 |
| Elastic Modulus Ratio | 30.7 | 31.1 | 31.6 | 31.9 | 33.1 | 31.8 | 30.9 | 31.8 | 32.1 | 32.8 |
| C.T.E | 113 | 117 | 113 | 106 | 94 | 102 | 113 | 115 | 99 | 77 |
| Amount of Migration of | 53 | 53 | 53 | 51 | 49 | 50 | 53 | 53 | 50 | 45 |
| alkali metal [ppb] | | | | | | | | | | |
| P/PLi | 1.3 | 1.3 | 1.3 | 1.3 | 1.3 | 1.3 | 1.3 | 1.3 | 1.3 | 1.2 |

Tables 55 and 56 show the glass compositions in % by weight of respective crystallized glass substrates of A-559 to A-579, together with the manufacturing conditions employed. Tables 57 and 58 show crystallized glass substrates as A-580 to A-600 manufactured using the same glass compositions as those of A-559 to A-579 with the nucleus growing temperature varied from that employed for A-559 to A-579. Further, Tables 59 and 60 show crystallized glass substrates as A-601 to A-621 manufactured using the same glass compositions as those of A-559 A-579 with the nucleus growing time varied from that employed for A-559 to A-579.

TABLE 55

| | A-559 | A-560 | A-561 | A-562 | A-563 | A-564 | A-565 | A-566 | A-567 | A-568 | A-569 |
|---|---|---|---|---|---|---|---|---|---|---|---|
| SiO₂ | 65.2 | 67.0 | 69.5 | 66.3 | 67.0 | 65.4 | 68.5 | 67.5 | 66.0 | 67.5 | 67.5 |
| Al₂O₃ | 7.4 | 6.0 | 5.0 | 3.0 | 5.0 | 10.0 | 7.6 | 7.6 | 5.0 | 7.0 | 6.0 |
| MgO | 2.0 | 1.0 | 1.0 | 2.4 | 1.0 | 1.6 | 2.0 | 1.0 | 2.0 | 2.0 | 2.0 |
| CaO | 0.9 | | | | | | | 1.1 | | 2.0 | 2.0 |
| BaO | 2.4 | 2.5 | 2.1 | 2.0 | 1.8 | 2.0 | 1.5 | 1.5 | 1.0 | 2.0 | 2.5 |
| SrO | | 1.3 | 1.5 | 1.0 | 1.8 | 1.0 | 1.7 | 2.0 | | | |
| ZnO | 5.7 | 5.9 | 6.0 | 7.1 | 5.0 | 5.0 | 3.0 | 5.0 | 10.0 | 5.9 | 5.9 |
| Li₂O | 5.9 | 6.1 | 6.0 | 7.4 | 7.4 | 8.0 | 6.5 | 6.1 | 8.0 | 4.0 | 6.1 |
| K₂O | 2.1 | 2.1 | 1.0 | 2.6 | 2.6 | | 2.2 | 2.1 | 2.1 | 2.1 | 1.7 |
| B₂O₃ | 3.5 | 3.0 | 3.0 | 2.0 | 2.0 | 2.0 | 1.0 | 1.0 | 1.0 | 1.0 | 1.0 |
| TiO₂ | | | | | | | | | | 2.0 | |
| ZrO₂ | 2.5 | 2.6 | 2.5 | 3.2 | 3.4 | 2.0 | 3.5 | 2.6 | 2.3 | 2.6 | 2.6 |
| P₂O₅ | 2.0 | 2.1 | 2.0 | 2.6 | 2.6 | 2.5 | 2.1 | 2.1 | 2.2 | 1.4 | 2.1 |
| Y₂O₃ | | | | | | | | | | | |
| Nb₂O₅ | | | | | | | | | | | |
| Ta₂O₅ | | | | | | | | | | | |
| La₂O₃ | | | | | | | | | | | |
| Sb₂O₃ | 0.4 | 0.4 | 0.4 | 0.5 | 0.5 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 700 | 700 | 700 | 700 | 700 | 700 | 700 | 700 | 700 | 700 | 700 |
| Growing | | | | | | | | | | | |
| Temperature??? | | | | | | | | | | | |
| Nucleous | 3 | 3 | 3 | 3 | 3 | 3 | 3 | 3 | 3 | 3 | 3 |
| Growing | | | | | | | | | | | |
| Time?hr? | | | | | | | | | | | |
| Main Crystalline | Quartz | Quartz | Quartz | Quartz | Quartz | Quartz | Quartz | Quartz | LZS | Quartz | Quartz |
| Phase | | | | | | | | | | | |
| Sub Crystalline | Crist | Crist | Crist | Crist | Crist | Crist | Crist | Crist | Crist | Crist | Crist |
| Phase | | | | | | | | | | | |
| Specific | 2.57 | 2.58 | 2.57 | 2.58 | 2.57 | 2.57 | 2.53 | 2.57 | 2.61 | 2.62 | 2.59 |
| Gravity?g/cm³ | | | | | | | | | | | |
| Yong's Modulus | 82.6 | 81.4 | 80.0 | 78.5 | 79.9 | 84.2 | 78.0 | 78.9 | 78.0 | 82.7 | 81.1 |
| E??Pa | | | | | | | | | | | |
| Elastic Modulus | 32.2 | 31.6 | 31.2 | 30.4 | 31.1 | 32.8 | 30.8 | 30.7 | 29.9 | 31.6 | 31.3 |
| Ratio | | | | | | | | | | | |
| C.T.E | 108 | 89 | 78 | 115 | 109 | 72 | 116 | 112 | 78 | 98 | 108 |
| Amount of | 56 | 52 | 49 | 64 | 62 | 53 | 60 | 57 | 55 | 46 | 57 |
| Migration of | | | | | | | | | | | |
| alkali metal | | | | | | | | | | | |
| [ppb] | | | | | | | | | | | |
| P/PLi | 1.3 | 1.2 | 1.1 | 1.2 | 1.2 | 1.1 | 1.3 | 1.3 | 1.1 | 1.3 | 1.2 |

TABLE 56

| | A-570 | A-571 | A-572 | A-573 | A-574 | A-575 | A-576 | A-577 | A-578 | A-579 |
|---|---|---|---|---|---|---|---|---|---|---|
| SiO₂ | 67.5 | 66.5 | 68.0 | 66.0 | 66.5 | 68.0 | 66.0 | 68.0 | 67.0 | 66.0 |
| Al₂O₃ | 6.0 | 5.0 | 4.1 | 6.0 | 5.0 | 5.0 | 4.0 | 7.0 | 7.0 | 7.0 |
| MgO | 2.0 | 2.0 | 2.3 | 1.0 | 2.4 | 2.3 | 2.0 | 2.1 | 2.7 | 2.1 |
| CaO | 0.9 | 2.5 | 2.0 | 1.0 | | | 1.0 | 1.0 | 1.0 | 2.0 |
| BaO | 2.0 | | | | 2.5 | 1.0 | | | | |
| SrO | | 2.0 | 1.0 | 1.5 | 2.0 | 1.0 | 1.5 | | | |
| ZnO | 5.9 | 6.0 | 5.5 | 5.0 | 6.0 | 6.3 | 6.6 | 6.0 | 6.2 | 6.0 |
| Li₂O | 8.0 | 7.1 | 7.0 | 6.9 | 7.1 | 7.0 | 6.9 | 6.5 | 6.5 | 6.0 |
| K₂O | 1.5 | 2.5 | 1.3 | 2.0 | 2.5 | 1.4 | 2.4 | 2.5 | 2.2 | 2.2 |
| B₂O₃ | 1.0 | 0.5 | 3.0 | 5.0 | 2.0 | 2.0 | 2.0 | 2.0 | 2.0 | 2.0 |
| TiO₂ | | | | | | | | | | |
| ZrO₂ | 2.6 | 3.0 | 3.0 | 3.0 | 1.1 | 3.2 | 5.0 | 3.5 | 3.0 | 3.3 |
| P₂O₅ | 2.1 | 2.5 | 2.4 | 2.2 | 2.5 | 2.4 | 2.2 | 1.0 | 2.0 | 3.0 |
| Y₂O₃ | | | | | | | | | | |
| Nb₂O₅ | | | | | | | | | | |
| Ta₂O₅ | | | | | | | | | | |
| La₂O₃ | | | | | | | | | | |
| Sb₂O₃ | 0.4 | 0.5 | 0.4 | 0.4 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 700 | 700 | 700 | 700 | 700 | 700 | 700 | 700 | 700 | 700 |
| Temperature??? | | | | | | | | | | |
| Nucleous Growing | 3 | 3 | 3 | 3 | 3 | 3 | 3 | 3 | 3 | 3 |
| Time?hr? | | | | | | | | | | |
| Main Crystalline | Quartz | Quartz | Quartz | Quartz | Quartz | Quartz | Quartz | Quartz | Quartz | Quartz |
| Phase | | | | | | | | | | |
| Sub Crystalline | Crist | Crist | Crist | Crist | Crist | Crist | Crist | Crist | Crist | Crist |
| Phase | | | | | | | | | | |
| Specific | 2.60 | 2.56 | 2.54 | 2.52 | 2.54 | 2.57 | 2.60 | 2.52 | 2.55 | 2.59 |
| Gravity?g/cm³ | | | | | | | | | | |
| Yong's Modulus | 79.0 | 78.7 | 77.9 | 79.7 | 79.0 | 80.7 | 82.9 | 79.0 | 78.6 | 78.0 |
| E??Pa | | | | | | | | | | |
| Elastic Modulus | 30.4 | 30.8 | 30.7 | 31.7 | 31.1 | 31.4 | 31.9 | 31.4 | 30.8 | 30.1 |
| Ratio | | | | | | | | | | |
| C.T.E | 112 | 108 | 116 | 121 | 116 | 110 | 88 | 99 | 115 | 119 |
| Amount of | 66 | 61 | 62 | 63 | 63 | 61 | 54 | 56 | 60 | 59 |
| Migration of alkali | | | | | | | | | | |
| metal [ppb] | | | | | | | | | | |
| P/PLi | 1.2 | 1.2 | 1.2 | 1.2 | 1.2 | 1.2 | 1.2 | 1.2 | 1.3 | 1.3 |

TABLE 57

| | A-580 | A-581 | A-582 | A-583 | A-584 | A-585 | A-586 | A-587 | A-588 | A-589 | A-590 |
|---|---|---|---|---|---|---|---|---|---|---|---|
| SiO₂ | 65.2 | 67.0 | 69.5 | 66.3 | 67.0 | 65.4 | 68.5 | 67.5 | 66.0 | 67.5 | 67.5 |
| Al₂O₃ | 7.4 | 6.0 | 5.0 | 3.0 | 5.0 | 10.0 | 7.6 | 7.6 | 5.0 | 7.0 | 6.0 |
| MgO | 2.0 | 1.0 | 1.0 | 2.4 | 1.0 | 1.6 | 2.0 | 1.0 | 2.0 | 2.0 | 2.0 |
| CaO | 0.9 | | | | | | | 1.1 | | 2.0 | 2.0 |
| BaO | 2.4 | 2.5 | 2.1 | 2.0 | 1.8 | 2.0 | 1.5 | 1.5 | 1.0 | 2.0 | 2.5 |
| SrO | | 1.3 | 1.5 | 1.0 | 1.8 | 1.0 | 1.7 | 2.0 | | | |
| ZnO | 5.7 | 5.9 | 6.0 | 7.1 | 5.0 | 5.0 | 3.0 | 5.0 | 10.0 | 5.9 | 5.9 |
| Li₂O | 5.9 | 6.1 | 6.0 | 7.4 | 7.4 | 8.0 | 6.5 | 6.1 | 8.0 | 4.0 | 6.1 |
| K₂O | 2.1 | 2.1 | 1.0 | 2.6 | 2.6 | | 2.2 | 2.1 | 2.1 | 2.1 | 1.7 |
| B₂O₃ | 3.5 | 3.0 | 3.0 | 2.0 | 2.0 | 2.0 | 1.0 | 1.0 | 1.0 | 1.0 | 1.0 |
| TiO₂ | | | | | | | | | | 2.0 | |
| ZrO₂ | 2.5 | 2.6 | 2.5 | 3.2 | 3.4 | 2.0 | 3.5 | 2.6 | 2.3 | 2.6 | 2.6 |
| P₂O₅ | 2.0 | 2.1 | 2.0 | 2.6 | 2.6 | 2.5 | 2.1 | 2.1 | 2.2 | 1.4 | 2.1 |
| Y₂O₃ | | | | | | | | | | | |
| Nb₂O₅ | | | | | | | | | | | |
| Ta₂O₅ | | | | | | | | | | | |
| La₂O₃ | | | | | | | | | | | |
| Sb₂O₃ | 0.4 | 0.4 | 0.4 | 0.5 | 0.5 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 730 | 730 | 730 | 730 | 730 | 730 | 730 | 730 | 730 | 730 | 730 |
| Growing | | | | | | | | | | | |
| Temperature??? | | | | | | | | | | | |
| Nucleous | 3 | 3 | 3 | 3 | 3 | 3 | 3 | 3 | 3 | 3 | 3 |
| Growing | | | | | | | | | | | |
| Time?hr? | | | | | | | | | | | |
| Main Crystalline | Quartz | Quartz | Quartz | Quartz | Quartz | Quartz | Quartz | Quartz | Crist | Quartz | Quartz |
| Phase | | | | | | | | | | | |
| Sub Crystalline | Crist | Crist | Crist | Crist | Crist | Crist | Crist | Crist | LZS | Crist | Crist |
| Phase | | | | | | | | | | | |
| Specific | 2.59 | 2.60 | 2.59 | 2.60 | 2.59 | 2.59 | 2.55 | 2.59 | 2.60 | 2.64 | 2.61 |
| Gravity?g/cm³ | | | | | | | | | | | |
| Yong's Modulus | 86.1 | 84.8 | 83.4 | 81.8 | 83.3 | 87.7 | 81.3 | 82.2 | 77.5 | 86.2 | 84.5 |
| E??Pa | | | | | | | | | | | |
| Elastic Modulus | 33.3 | 32.6 | 32.2 | 31.5 | 32.2 | 33.9 | 31.9 | 31.8 | 29.8 | 32.7 | 32.4 |
| Ratio | | | | | | | | | | | |
| C.T.E | 113 | 104 | 101 | 117 | 113 | 100 | 118 | 115 | 83 | 108 | 113 |
| Amount of | 53 | 51 | 50 | 53 | 53 | 50 | 54 | 53 | 47 | 52 | 53 |
| Migration of | | | | | | | | | | | |
| alkali metal | | | | | | | | | | | |
| [ppb] | | | | | | | | | | | |
| P/PLi | 1.3 | 1.3 | 1.3 | 1.3 | 1.3 | 1.3 | 1.3 | 1.3 | 1.2 | 1.3 | 1.3 |

TABLE 58

| | A-591 | A-592 | A-593 | A-594 | A-595 | A-596 | A-597 | A-598 | A-599 | A-600 |
|---|---|---|---|---|---|---|---|---|---|---|
| SiO₂ | 67.5 | 66.5 | 68.0 | 66.0 | 66.5 | 68.0 | 66.0 | 68.0 | 67.0 | 66.0 |
| Al₂O₃ | 6.0 | 5.0 | 4.1 | 6.0 | 5.0 | 5.0 | 4.0 | 7.0 | 7.0 | 7.0 |
| MgO | 2.0 | 2.0 | 2.3 | 1.0 | 2.4 | 2.3 | 2.0 | 2.1 | 2.7 | 2.1 |
| CaO | 0.9 | 2.5 | 2.0 | 1.0 | | | 1.0 | 1.0 | 1.0 | 2.0 |
| BaO | 2.0 | | | | 2.5 | 1.0 | | | | |
| SrO | | 2.0 | 1.0 | 1.5 | 2.0 | 1.0 | 1.5 | | | |
| ZnO | 5.9 | 6.0 | 5.5 | 5.0 | 6.0 | 6.3 | 6.6 | 6.0 | 6.2 | 6.0 |
| Li₂O | 8.0 | 7.1 | 7.0 | 6.9 | 7.1 | 7.0 | 6.9 | 6.5 | 6.5 | 6.0 |
| K₂O | 1.5 | 2.5 | 1.3 | 2.0 | 2.5 | 1.4 | 2.4 | 2.5 | 2.2 | 2.2 |
| B₂O₃ | 1.0 | 0.5 | 3.0 | 5.0 | 2.0 | 2.0 | 2.0 | 2.0 | 2.0 | 2.0 |
| TiO₂ | | | | | | | | | | |
| ZrO₂ | 2.6 | 3.0 | 3.0 | 3.0 | 1.1 | 3.2 | 5.0 | 3.5 | 3.0 | 3.3 |
| P₂O₅ | 2.1 | 2.5 | 2.4 | 2.2 | 2.5 | 2.4 | 2.2 | 1.0 | 2.0 | 3.0 |
| Y₂O₃ | | | | | | | | | | |
| Nb₂O₅ | | | | | | | | | | |
| Ta₂O₅ | | | | | | | | | | |
| La₂O₃ | | | | | | | | | | |
| Sb₂O₃ | 0.4 | 0.5 | 0.4 | 0.4 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 730 | 730 | 730 | 730 | 730 | 730 | 730 | 730 | 730 | 730 |
| Temperature??? | | | | | | | | | | |
| Nucleous Growing | 3 | 3 | 3 | 3 | 3 | 3 | 3 | 3 | 3 | 3 |
| Time?hr? | | | | | | | | | | |
| Main Crystalline | Quartz | Quartz | Quartz | Quartz | Quartz | Quartz | Quartz | Quartz | Quartz | Quartz |
| Phase | | | | | | | | | | |
| Sub Crystalline | Crist | Crist | Crist | Crist | Crist | Crist | Crist | Crist | Crist | Crist |
| Phase | | | | | | | | | | |
| Specific | 2.62 | 2.58 | 2.56 | 2.54 | 2.56 | 2.59 | 2.62 | 2.54 | 2.57 | 2.61 |
| Gravity?g/cm³ | | | | | | | | | | |
| Yong's Modulus | 82.4 | 82.0 | 81.2 | 83.1 | 82.4 | 84.1 | 86.5 | 82.4 | 81.9 | 81.3 |
| E??Pa | | | | | | | | | | |
| Elastic Modulus | 31.4 | 31.8 | 31.7 | 32.7 | 32.2 | 32.5 | 33.0 | 32.4 | 31.9 | 31.1 |
| Ratio | | | | | | | | | | |
| C.T.E | 115 | 113 | 118 | 121 | 118 | 114 | 104 | 108 | 117 | 119 |
| Amount of | 53 | 53 | 54 | 54 | 54 | 53 | 51 | 52 | 53 | 54 |
| Migration of alkali | | | | | | | | | | |
| metal [ppb] | | | | | | | | | | |
| P/PLi | 1.3 | 1.3 | 1.3 | 1.3 | 1.3 | 1.3 | 1.3 | 1.3 | 1.3 | 1.3 |

TABLE 59

| | A-601 | A-602 | A-603 | A-604 | A-605 | A-606 | A-607 | A-608 | A-609 | A-610 | A-611 |
|---|---|---|---|---|---|---|---|---|---|---|---|
| SiO₂ | 65.2 | 67.0 | 69.5 | 66.3 | 67.0 | 65.4 | 68.5 | 67.5 | 66.0 | 67.5 | 67.5 |
| Al₂O₃ | 7.4 | 6.0 | 5.0 | 3.0 | 5.0 | 10.0 | 7.6 | 7.6 | 5.0 | 7.0 | 6.0 |
| MgO | 2.0 | 1.0 | 1.0 | 2.4 | 1.0 | 1.6 | 2.0 | 1.0 | 2.0 | 2.0 | 2.0 |
| CaO | 0.9 | | | | | | | 1.1 | | 2.0 | 2.0 |
| BaO | 2.4 | 2.5 | 2.1 | 2.0 | 1.8 | 2.0 | 1.5 | 1.5 | 1.0 | 2.0 | 2.5 |
| SrO | | 1.3 | 1.5 | 1.0 | 1.8 | 1.0 | 1.7 | 2.0 | | | |
| ZnO | 5.7 | 5.9 | 6.0 | 7.1 | 5.0 | 5.0 | 3.0 | 5.0 | 10.0 | 5.9 | 5.9 |
| Li₂O | 5.9 | 6.1 | 6.0 | 7.4 | 7.4 | 8.0 | 6.5 | 6.1 | 8.0 | 4.0 | 6.1 |
| K₂O | 2.1 | 2.1 | 1.0 | 2.6 | 2.6 | | 2.2 | 2.1 | 2.1 | 2.1 | 1.7 |
| B₂O₃ | 3.5 | 3.0 | 3.0 | 2.0 | 2.0 | 2.0 | 1.0 | 1.0 | 1.0 | 1.0 | 1.0 |
| TiO₂ | | | | | | | | | | 2.0 | |
| ZrO₂ | 2.5 | 2.6 | 2.5 | 3.2 | 3.4 | 2.0 | 3.5 | 2.6 | 2.3 | 2.6 | 2.6 |
| P₂O₅ | 2.0 | 2.1 | 2.0 | 2.6 | 2.6 | 2.5 | 2.1 | 2.1 | 2.2 | 1.4 | 2.1 |
| Y₂O₃ | | | | | | | | | | | |
| Nb₂O₅ | | | | | | | | | | | |
| Ta₂O₅ | | | | | | | | | | | |
| La₂O₃ | | | | | | | | | | | |
| Sb₂O₃ | 0.4 | 0.4 | 0.4 | 0.5 | 0.5 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 700 | 700 | 700 | 700 | 700 | 700 | 700 | 700 | 700 | 700 | 700 |
| Growing | | | | | | | | | | | |
| Temperature??? | | | | | | | | | | | |
| Nucleous | 10 | 10 | 10 | 10 | 10 | 10 | 10 | 10 | 10 | 10 | 10 |
| Growing | | | | | | | | | | | |
| Time?hr? | | | | | | | | | | | |
| Main Crystalline | Quartz | Quartz | Quartz | Quartz | Quartz | Quartz | Quartz | Quartz | Crist | Quartz | Quartz |
| Phase | | | | | | | | | | | |
| Sub Crystalline | Crist | Crist | Crist | Crist | Crist | Crist | Crist | Crist | LZS | Crist | Crist |
| Phase | | | | | | | | | | | |
| Specific | 2.58 | 2.59 | 2.58 | 2.59 | 2.58 | 2.58 | 2.54 | 2.58 | 2.60 | 2.63 | 2.60 |
| Gravity?g/cm³ | | | | | | | | | | | |
| Yong's Modulus | 85.1 | 83.8 | 82.4 | 80.8 | 82.3 | 86.7 | 80.3 | 81.2 | 77.6 | 85.2 | 83.5 |
| E??Pa | | | | | | | | | | | |
| Elastic Modulus | 33.0 | 32.3 | 31.9 | 31.2 | 31.9 | 33.6 | 31.6 | 31.5 | 29.8 | 32.4 | 32.1 |
| Ratio | | | | | | | | | | | |
| C.T.E | 114 | 105 | 102 | 118 | 115 | 101 | 119 | 116 | 80 | 109 | 114 |
| Amount at | 53 | 51 | 50 | 54 | 53 | 50 | 54 | 53 | 46 | 52 | 53 |
| Migration of | | | | | | | | | | | |
| alkali metal | | | | | | | | | | | |
| [ppb] | | | | | | | | | | | |
| P/Pli | 1.3 | 1.3 | 1.3 | 1.3 | 1.3 | 1.3 | 1.3 | 1.3 | 1.2 | 1.3 | 1.3 |

TABLE 60

| | A-612 | A-613 | A-614 | A-615 | A-616 | A-617 | A-618 | A-619 | A-620 | A-621 |
|---|---|---|---|---|---|---|---|---|---|---|
| SiO₂ | 67.5 | 66.5 | 68.0 | 66.0 | 66.5 | 68.0 | 66.0 | 68.0 | 67.0 | 66.0 |
| Al₂O₃ | 6.0 | 5.0 | 4.1 | 6.0 | 5.0 | 5.0 | 4.0 | 7.0 | 7.0 | 7.0 |
| MgO | 2.0 | 2.0 | 2.3 | 1.0 | 2.4 | 2.3 | 2.0 | 2.1 | 2.7 | 2.1 |
| CaO | 0.9 | 2.5 | 2.0 | 1.0 | | | 1.0 | 1.0 | 1.0 | 2.0 |
| BaO | 2.0 | | | | 2.5 | 1.0 | | | | |
| SrO | | 2.0 | 1.0 | 1.5 | 2.0 | 1.0 | 1.5 | | | |
| ZnO | 5.9 | 6.0 | 5.5 | 5.0 | 6.0 | 6.3 | 6.6 | 6.0 | 6.2 | 6.0 |
| Li₂O | 8.0 | 7.1 | 7.0 | 6.9 | 7.1 | 7.0 | 6.9 | 6.5 | 6.5 | 6.0 |
| K₂O | 1.5 | 2.5 | 1.3 | 2.0 | 2.5 | 1.4 | 2.4 | 2.5 | 2.2 | 2.2 |
| B₂O₃ | 1.0 | 0.5 | 3.0 | 5.0 | 2.0 | 2.0 | 2.0 | 2.0 | 2.0 | 2.0 |
| TiO₂ | | | | | | | | | | |
| ZrO₂ | 2.6 | 3.0 | 3.0 | 3.0 | 1.1 | 3.2 | 5.0 | 3.5 | 3.0 | 3.3 |
| P₂O₅ | 2.1 | 2.5 | 2.4 | 2.2 | 2.5 | 2.4 | 2.2 | 1.0 | 2.0 | 3.0 |
| Y₂O₃ | | | | | | | | | | |
| Nb₂O₅ | | | | | | | | | | |
| Ta₂O₅ | | | | | | | | | | |
| La₂O₃ | | | | | | | | | | |
| Sb₂O₃ | 0.4 | 0.5 | 0.4 | 0.4 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 |
| Melting Temperature??? | 1550 | 1550 | 1550 | 1550 | 1550 | 1550 | 1550 | 1550 | 1550 | 1550 |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating Time?hr? | 5 | 5 | 5 | 5 | 5 | 5 | 5 | 5 | 5 | 5 |
| Nucleous Growing | 700 | 700 | 700 | 700 | 700 | 700 | 700 | 700 | 700 | 700 |
| Temperature??? | | | | | | | | | | |
| Nucleous Growing | 10 | 10 | 10 | 10 | 10 | 10 | 10 | 10 | 10 | 10 |
| Time?hr? | | | | | | | | | | |
| Main Crystalline Phase | Quartz | Quartz | Quartz | Quartz | Quartz | Quartz | Quartz | Quartz | Quartz | Quartz |
| Sub Crystalline Phase | Crist | Crist | Crist | Crist | Crist | Crist | Crist | Crist | Crist | Crist |
| Specific Gravity?g/cm³ | 2.61 | 2.57 | 2.55 | 2.53 | 2.55 | 2.58 | 2.61 | 2.53 | 2.56 | 2.60 |
| Yong's Modulus E??Pa | 81.3 | 81.0 | 80.2 | 82.1 | 81.3 | 83.0 | 85.4 | 81.3 | 80.9 | 80.3 |
| Elastic Modulus Ratio | 31.1 | 31.5 | 31.4 | 32.5 | 31.9 | 32.2 | 32.7 | 32.2 | 31.6 | 30.9 |
| C.T.E | 116 | 114 | 119 | 122 | 119 | 115 | 105 | 109 | 118 | 121 |
| Amount of Migration of | 53 | 53 | 54 | 54 | 54 | 53 | 51 | 52 | 54 | 54 |
| alkali metal [ppb] | | | | | | | | | | |
| P/PLi | 1.3 | 1.3 | 1.3 | 1.3 | 1.3 | 1.3 | 1.3 | 1.3 | 1.3 | 1.3 |

Tables 61 and 62 show the glass compositions in % by weight of respective crystallized glass substrates of A-622 to A-642, together with the manufacturing conditions employed. Tables 63 and 64 show crystallized glass substrates as A-643 to A-663 manufactured using the same glass compositions as those of A-622 to A-642 with the nucleus growing temperature varied from that employed for A-622 to A-642. Further, Tables 65 and 66 show crystallized glass substrates as A-664 to A-684 manufactured using the same glass compositions as those of A-622 to A-642 with the nucleus growing time varied from that employed for A-622 to A-642.

TABLE 61

| | A-622 | A-623 | A-624 | A-625 | A-626 | A-627 | A-628 | A-629 | A-630 | A-631 | A-.632 |
|---|---|---|---|---|---|---|---|---|---|---|---|
| SiO₂ | 65.2 | 67.0 | 69.5 | 66.3 | 67.0 | 65.4 | 68.5 | 67.5 | 66.0 | 67.5 | 67.5 |
| Al₂O₃ | 7.4 | 6.0 | 5.0 | 3.0 | 5.0 | 10.0 | 7.6 | 7.6 | 5.0 | 7.0 | 6.0 |
| MgO | 2.0 | 1.0 | 1.0 | 2.4 | 1.0 | 1.6 | 2.0 | 1.0 | 2.0 | 2.0 | 2.0 |
| CaO | 0.9 | | | | | | | 1.1 | | 2.0 | 2.0 |
| BaO | 2.4 | 2.5 | 2.1 | 2.0 | 1.8 | 2.0 | 1.5 | 1.5 | 1.0 | 2.0 | 2.5 |
| SrO | | 1.3 | 1.5 | 1.0 | 1.8 | 1.0 | 1.7 | 2.0 | | | |
| ZnO | 5.7 | 5.9 | 6.0 | 7.1 | 5.0 | 5.0 | 3.0 | 5.0 | 10.0 | 5.9 | 5.9 |
| Li₂O | 5.9 | 6.1 | 6.0 | 7.4 | 7.4 | 8.0 | 6.5 | 6.1 | 8.0 | 4.0 | 6.1 |
| K₂O | 2.1 | 2.1 | 1.0 | 2.6 | 2.6 | | 2.2 | 2.1 | 2.1 | 2.1 | 1.7 |
| B₂O₃ | | | | | | | | | | 2.0 | |
| TiO₂ | 3.5 | 3.0 | 3.0 | 2.0 | 2.0 | 2.0 | 1.0 | 1.0 | 1.0 | 1.0 | 1.0 |
| ZrO₂ | 2.5 | 2.6 | 2.5 | 3.2 | 3.4 | 2.0 | 3.5 | 2.6 | 2.3 | 2.6 | 2.6 |
| P₂O₅ | 2.0 | 2.1 | 2.0 | 2.6 | 2.6 | 2.5 | 2.1 | 2.1 | 2.2 | 1.4 | 2.1 |
| Y₂O₃ | | | | | | | | | | | |
| Nb₂O₅ | | | | | | | | | | | |
| Ta₂O₅ | | | | | | | | | | | |
| La₂O₃ | | | | | | | | | | | |
| Sb₂O₃ | 0.4 | 0.4 | 0.4 | 0.5 | 0.5 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting Temperature??? | 1550 | 1550 | 1550 | 1550 | 1550 | 1550 | 1550 | 1550 | 1550 | 1550 | 1550 |
| Melting Time?hr? | 3 | 3 | 3 | 3 | 3 | 3 | 3 | 3 | 3 | 3 | 3 |
| Nucleating Temperature??? | 550 | 550 | 550 | 550 | 550 | 550 | 550 | 550 | 550 | 550 | 550 |
| Nucleating Time?hr? | 5 | 5 | 5 | 5 | 5 | 5 | 5 | 5 | 5 | 5 | 5 |
| Nucleaus Growing | 700 | 700 | 700 | 700 | 700 | 700 | 700 | 700 | 700 | 700 | 700 |
| Temperature??? | | | | | | | | | | | |
| Nucleaus Growing Time?hr? | 3 | 3 | 3 | 3 | 3 | 3 | 3 | 3 | 3 | 3 | 3 |
| Main Crystalline Phase | Crist | Crist | Crist | Crist | Crist | Crist | Crist | Crist | LZS | Quartz | Crist |
| Sub Crystalline Phase | LZS | LZS | LZS | Quartz | LZS | LZS | Quartz | LZS | Crist | Crist | LZS |
| Specific Gravity?g/cm³ | 2.59 | 2.56 | 2.54 | 2.58 | 2.56 | 2.53 | 2.52 | 2.55 | 2.65 | 2.63 | 2.58 |
| Yong's Modulus E??Pa | 78.0 | 77.5 | 77.2 | 76.8 | 78.8 | 81.2 | 77.5 | 80.3 | 85.2 | 83.2 | 81.2 |
| Elastic Modulus Ratio | 30.1 | 30.3 | 30.4 | 29.8 | 30.8 | 32.1 | 30.8 | 31.5 | 32.2 | 31.6 | 31.5 |
| C.T.E | 111 | 116 | 118 | 118 | 110 | 81 | 116 | 97 | 81 | 89 | 85 |
| Amount of Migration of alkali | 56 | 58 | 58 | 65 | 63 | 56 | 60 | 54 | 56 | 44 | 51 |
| metal [ppb] | | | | | | | | | | | |
| P/PLi | 1.3 | 1.3 | 1.3 | 1.2 | 1.2 | 1.1 | 1.3 | 1.2 | 1.1 | 1.3 | 1.2 |

TABLE 62

| | A-633 | A-634 | A-635 | A-636 | A-637 | A-638 | A-639 | A-640 | A-641 | A-642 |
|---|---|---|---|---|---|---|---|---|---|---|
| SiO₂ | 67.5 | 66.5 | 68.0 | 66.0 | 66.5 | 68.0 | 66.0 | 68.0 | 67.0 | 66.0 |
| Al₂O₃ | 6.0 | 5.0 | 4.1 | 6.0 | 5.0 | 5.0 | 4.0 | 7.0 | 7.0 | 7.0 |
| MgO | 2.0 | 2.0 | 2.3 | 1.0 | 2.4 | 2.3 | 2.0 | 2.1 | 2.7 | 2.1 |
| CaO | 0.9 | 2.5 | 2.0 | 1.0 | | | 1.0 | 1.0 | 1.0 | 2.0 |
| BaO | 2.0 | | | | 2.5 | 1.0 | | | | |
| SrO | | 2.0 | 1.0 | 1.5 | 2.0 | 1.0 | 1.5 | | | |
| ZnO | 5.9 | 6.0 | 5.5 | 5.0 | 6.0 | 6.3 | 6.6 | 6.0 | 6.2 | 6.0 |
| Li₂O | 8.0 | 7.1 | 7.0 | 6.9 | 7.1 | 7.0 | 6.9 | 6.5 | 6.5 | 6.0 |
| K₂O | 1.5 | 2.5 | 1.3 | 2.0 | 2.5 | 1.4 | 2.4 | 2.5 | 2.2 | 2.2 |
| B₂O₃ | | | | | | | | | | |
| TiO₂ | 1.0 | 0.5 | 3.0 | 5.0 | 2.0 | 2.0 | 2.0 | 2.0 | 2.0 | 2.0 |
| ZrO₂ | 2.6 | 3.0 | 3.0 | 3.0 | 1.1 | 3.2 | 5.0 | 3.5 | 3.0 | 3.3 |
| P₂O₅ | 2.1 | 2.5 | 2.4 | 2.2 | 2.5 | 2.4 | 2.2 | 1.0 | 2.0 | 3.0 |
| Nb₂O₅ | | | | | | | | | | |
| Ta₂O₅ | | | | | | | | | | |
| La₂O₃ | | | | | | | | | | |
| Sb₂O₃ | 0.4 | 0.5 | 0.4 | 0.4 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 |
| Melting Temperature??? | 1550 | 1550 | 1550 | 1550 | 1550 | 1550 | 1550 | 1550 | 1550 | 1550 |
| Melting Time?hr? | 3 | 3 | 3 | 3 | 3 | 3 | 3 | 3 | 3 | 3 |
| Nucleating Temperature??? | 550 | 550 | 550 | 550 | 550 | 550 | 550 | 550 | 550 | 550 |
| Nucleating Time?hr? | 5 | 5 | 5 | 5 | 5 | 5 | 5 | 5 | 5 | 5 |
| Nucleous Growing | 700 | 700 | 700 | 700 | 700 | 700 | 700 | 700 | 700 | 700 |
| Temperature??? | | | | | | | | | | |
| Nucleous Growing Time?hr? | 3 | 3 | 3 | 3 | 3 | 3 | 3 | 3 | 3 | 3 |
| Main Crystalline Phase | Crist | Crist | Crist | Quartz | Quartz | Quartz | Crist | Crist | Crist | Quartz |
| Sub Crystalline Phase | LZS | LZS | LZS | Crist | Crist | Crist | LZS | LZS | Quartz | Crist |
| Specific Gravity?g/cm³ | 2.58 | 2.52 | 2.57 | 2.66 | 2.55 | 2.59 | 2.67 | 2.53 | 2.58 | 2.65 |
| Yong's Modulus E??Pa | 79.2 | 79.3 | 80.8 | 82.1 | 83.3 | 84.2 | 85.3 | 82.3 | 81.6 | 81.3 |
| Elastic Modulus Ratio | 30.7 | 31.5 | 31.4 | 30.9 | 32.7 | 32.5 | 31.9 | 32.5 | 31.6 | 30.7 |
| G.T.E | 108 | 98 | 119 | 123 | 106 | 102 | 83 | 99 | 105 | 122 |
| Amount of Migration of alkali | 65 | 58 | 63 | 64 | 60 | 59 | 53 | 56 | 57 | 59 |
| metal [ppb] | | | | | | | | | | |
| P/PLi | 1.2 | 1.2 | 1.2 | 1.2 | 1.2 | 1.2 | 1.1 | 1.2 | 1.2 | 1.3 |

TABLE 63

| | A-.643 | A-.644 | A-.645 | A-.646 | A-.647 | A-.648 | A-.649 | A-.650 | A-.651 | A-.652 | A-.653 |
|---|---|---|---|---|---|---|---|---|---|---|---|
| SiO₂ | 65.2 | 67.0 | 69.5 | 66.3 | 67.0 | 65.4 | 68.5 | 67.5 | 66.0 | 67.5 | 67.5 |
| Al₂O₃ | 7.4 | 6.0 | 5.0 | 3.0 | 5.0 | 10.0 | 7.6 | 7.6 | 5.0 | 7.0 | 6.0 |
| MgO | 2.0 | 1.0 | 1.0 | 2.4 | 1.0 | 1.6 | 2.0 | 1.0 | 2.0 | 2.0 | 2.0 |
| CaO | 0.9 | | | | | | | 1.1 | | 2.0 | 2.0 |
| BaO | 2.4 | 2.5 | 2.1 | 2.0 | 1.8 | 2.0 | 1.5 | 1.5 | 1.0 | 2.0 | 2.5 |
| SrO | | 1.3 | 1.5 | 1.0 | 1.8 | 1.0 | 1.7 | 2.0 | | | |
| ZnO | 5.7 | 5.9 | 6.0 | 7.1 | 5.0 | 5.0 | 3.0 | 5.0 | 10.0 | 5.9 | 5.9 |
| Li₂O | 5.9 | 6.1 | 6.0 | 7.4 | 7.4 | 8.0 | 6.5 | 6.1 | 8.0 | 4.0 | 6.1 |
| K₂O | 2.1 | 2.1 | 1.0 | 2.6 | 2.6 | | 2.2 | 2.1 | 2.1 | 2.1 | 1.7 |
| B₂O₃ | | | | | | | | | | 2.0 | |
| TiO₂ | 3.5 | 3.0 | 3.0 | 2.0 | 2.0 | 2.0 | 1.0 | 1.0 | 1.0 | 1.0 | 1.0 |
| LrO₂ | 2.5 | 2.6 | 2.5 | 3.2 | 3.4 | 2.0 | 3.5 | 2.6 | 2.3 | 2.6 | 2.6 |
| P₂O₅ | 2.0 | 2.1 | 2.0 | 2.6 | 2.6 | 2.5 | 2.1 | 2.1 | 2.2 | 1.4 | 2.1 |
| Y₂O₃ | | | | | | | | | | | |
| Nb₂O₅ | | | | | | | | | | | |
| Ta₂O₅ | | | | | | | | | | | |
| La₂O₃ | | | | | | | | | | | |
| Sb₂O₃ | 0.4 | 0.4 | 0.4 | 0.5 | 0.5 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting Temperature??? | 1550 | 1550 | 1550 | 1550 | 1550 | 1550 | 1550 | 1550 | 1550 | 1550 | 1550 |
| Melting Time?hr? | 3 | 3 | 3 | 3 | 3 | 3 | 3 | 3 | 3 | 3 | 3 |
| Nucleating Temperature??? | 550 | 550 | 550 | 550 | 550 | 550 | 550 | 550 | 550 | 550 | 550 |
| Nucleating Time?hr? | 5 | 5 | 5 | 5 | 5 | 5 | 5 | 5 | 5 | 5 | 5 |
| Nucleous Growing | 730 | 730 | 730 | 730 | 730 | 730 | 730 | 730 | 730 | 730 | 730 |
| Temperature??? | | | | | | | | | | | |
| Nucleous Growing Time?hr?3 | 3 | 3 | 3 | 3 | 3 | 3 3 3 | 3 | 3 | | | |
| Main Crystalline Phase | Crist | Crist | Crist | Quartz | Crist | Crist | Quartz | Crist | Crist | Quartz | Crist |
| Sub Crystalline Phase | Quartz | Quartz | Quartz | Crist | Quartz | LZS | Crist | Quartz | LZS | Crist | Quartz |
| Specific Gravity?g/cm³ | 2.58 | 2.55 | 2.53 | 2.57 | 2.55 | 2.52 | 2.51 | 2.54 | 2.64 | 2.65 | 2.57 |
| Yong's Modulus E??Pa | 77.5 | 77.0 | 76.7 | 76.3 | 78.3 | 80.7 | 77.0 | 79.8 | 84.7 | 86.7 | 80.7 |
| Elastic Modulus Ratio | 30.1 | 30.2 | 30.3 | 29.7 | 30.7 | 32.0 | 30.7 | 31.4 | 32.1 | 32.7 | 31.4 |
| C.T.E | 114 | 118 | 119 | 119 | 114 | 97 | 118 | 105 | 97 | 104 | 98 |
| Amount of Migration of alkali | 53 | 54 | 54 | 54 | 53 | 49 | 54 | 51 | 49 | 51 | 50 |
| metal [ppb] | | | | | | | | | | | |
| P/PLi | 1.3 | 1.3 | 1.3 | 1.3 | 1.3 | 1.3 | 1.3 | 1.3 | 1.3 | 1.3 | 1.3 |

TABLE 64

| | A-654 | A-655 | A-656 | A-657 | A-658 | A-659 | A-660 | A-661 | A-662 | A-663 |
|---|---|---|---|---|---|---|---|---|---|---|
| SiO₂ | 67.5 | 66.5 | 68.0 | 66.0 | 66.5 | 68.0 | 66.0 | 68.0 | 67.0 | 66.0 |
| Al₂O₃ | 6.0 | 5.0 | 4.1 | 6.0 | 5.0 | 5.0 | 4.0 | 7.0 | 7.0 | 7.0 |
| MgO | 2.0 | 2.0 | 2.3 | 1.0 | 2.4 | 2.3 | 2.0 | 2.1 | 2.7 | 2.1 |
| CaO | 0.9 | 2.5 | 2.0 | 1.0 | | | 1.0 | 1.0 | 1.0 | 2.0 |
| BaO | 2.0 | | | | 2.5 | 1.0 | | | | |
| SrO | | 2.0 | 1.0 | 1.5 | 2.0 | 1.0 | 1.5 | | | |
| ZnO | 5.9 | 6.0 | 5.5 | 5.0 | 6.0 | 6.3 | 6.6 | 6.0 | 6.2 | 6.0 |
| Li₂O | 8.0 | 7.1 | 7.0 | 6.9 | 7.1 | 7.0 | 6.9 | 6.5 | 6.5 | 6.0 |
| K₂O | 1.5 | 2.5 | 1.3 | 2.0 | 2.5 | 1.4 | 2.4 | 2.5 | 2.2 | 2.2 |
| B₂O₃ | | | | | | | | | | |
| TiO₂ | 1.0 | 0.5 | 3.0 | 5.0 | 2.0 | 2.0 | 2.0 | 2.0 | 2.0 | 2.0 |
| ZrO₂ | 2.6 | 3.0 | 3.0 | 3.0 | 1.1 | 3.2 | 5.0 | 3.5 | 3.0 | 3.3 |
| P₂O₅ | 2.1 | 2.5 | 2.4 | 2.2 | 2.5 | 2.4 | 2.2 | 1.0 | 2.0 | 3.0 |
| Y₂O₃ | | | | | | | | | | |
| Nb₂O₅ | | | | | | | | | | |
| Ta₂O₅ | | | | | | | | | | |
| La₂O₃ | | | | | | | | | | |
| Sb₂O₃ | 0.4 | 0.5 | 0.4 | 0.4 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 |
| Melting Temperature??? | 1550 | 1550 | 1550 | 1550 | 1550 | 1550 | 1550 | 1550 | 1550 | 1550 |
| Melting Time?hr? | 3 | 3 | 3 | 3 | 3 | 3 | 3 | 3 | 3 | 3 |
| Nucleating Temperature??? | 550 | 550 | 550 | 550 | 550 | 550 | 550 | 550 | 550 | 550 |
| Nucleating Time?hr? | 5 | 5 | 5 | 5 | 5 | 5 | 5 | 5 | 5 | 5 |
| Nucleous Growing | 730 | 730 | 730 | 730 | 730 | 730 | 730 | 730 | 730 | 730 |
| Temperature??? | | | | | | | | | | |
| Nucleous Growing Time?hr? | 3 | 3 | 3 | 3 | 3 | 3 | 3 | 3 | 3 | 3 |
| Main Crystalline Phase | Quartz | Crist | Quartz | Quartz | Quartz | Quartz | Quartz | Quartz | Quartz | Quartz |
| Sub Crystalline Phase | Crist | LZS | Crist | Crist | Crist | Crist | Crist | Crist | Crist | Crist |
| Specific Gravity?g/cm³ | 2.57 | 2.51 | 2.56 | 2.65 | 2.54 | 2.58 | 2.66 | 2.52 | 2.57 | 2.64 |
| Yong's Modulus E??Pa | 78.7 | 78.8 | 80.3 | 81.6 | 82.8 | 83.7 | 84.8 | 81.8 | 81.1 | 80.8 |
| Elastic Modulus Ratio | 30.6 | 31.4 | 31.4 | 30.8 | 32.6 | 32.4 | 31.9 | 32.5 | 31.6 | 30.6 |
| C.T.E | 112 | 106 | 120 | 123 | 111 | 108 | 97 | 106 | 110 | 122 |
| Amount of Migration of alkali | 52 | 51 | 54 | 55 | 52 | 52 | 49 | 51 | 52 | 54 |
| metal [ppb] | | | | | | | | | | |
| P/PLi | 1.3 | 1.3 | 1.3 | 1.3 | 1.3 | 1.3 | 1.3 | 1.3 | 1.3 | 1.3 |

TABLE 65

| | A-664 | A-665 | A-666 | A-667 | A-668 | A-669 | A-670 | A-671 | A-672 | A-673 | A-.674 |
|---|---|---|---|---|---|---|---|---|---|---|---|
| SiO₂ | 65.2 | 67.0 | 69.5 | 66.3 | 67.0 | 65.4 | 68.5 | 67.5 | 66.0 | 67.5 | 67.5 |
| Al₂O₃ | 7.4 | 6.0 | 5.0 | 3.0 | 5.0 | 10.0 | 7.6 | 7.6 | 5.0 | 7.0 | 6.0 |
| MgO | 2.0 | 1.0 | 1.0 | 2.4 | 1.0 | 1.6 | 2.0 | 1.0 | 2.0 | 2.0 | 2.0 |
| CaO | 0.9 | | | | | | | 1.1 | | 2.0 | 2.0 |
| BaO | 2.4 | 2.5 | 2.1 | 2.0 | 1.8 | 2.0 | 1.5 | 1.5 | 1.0 | 2.0 | 2.5 |
| SrO | | 1.3 | 1.5 | 1.0 | 1.8 | 1.0 | 1.7 | 2.0 | | | |
| ZnO | 5.7 | 5.9 | 6.0 | 7.1 | 5.0 | 5.0 | 3.0 | 5.0 | 10.0 | 5.9 | 5.9 |
| Li₂O | 5.9 | 6.1 | 6.0 | 7.4 | 7.4 | 8.0 | 6.5 | 6.1 | 8.0 | 4.0 | 6.1 |
| K₂O | 2.1 | 2.1 | 1.0 | 2.6 | 2.6 | | 2.2 | 2.1 | 2.1 | 2.1 | 1.7 |
| B₂O₃ | | | | | | | | | | 2.0 | |
| TiO₂ | 3.5 | 3.0 | 3.0 | 2.0 | 2.0 | 2.0 | 1.0 | 1.0 | 1.0 | 1.0 | 1.0 |
| ZrO₂ | 2.5 | 2.6 | 2.5 | 3.2 | 3.4 | 2.0 | 3.5 | 2.6 | 2.3 | 2.6 | 2.6 |
| P₂O₅ | 2.0 | 2.1 | 2.0 | 2.6 | 2.6 | 2.5 | 2.1 | 2.1 | 2.2 | 1.4 | 2.1 |
| Y₂O₃ | | | | | | | | | | | |
| Nb₂O₅ | | | | | | | | | | | |
| Ta₂O₅ | | | | | | | | | | | |
| La₂O₃ | | | | | | | | | | | |
| Sb₂O₃ | 0.4 | 0.4 | 0.4 | 0.5 | 0.5 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting Temperature??? | 1550 | 1550 | 1550 | 1550 | 1550 | 1550 | 1550 | 1550 | 1550 | 1550 | 1550 |
| Melting Time?hr? | 3 | 3 | 3 | 3 | 3 | 3 | 3 | 3 | 3 | 3 | 3 |
| Nucleating Temperature??? | 550 | 550 | 550 | 550 | 550 | 550 | 550 | 550 | 550 | 550 | 550 |
| Nucleating Time?hr? | 5 | 5 | 5 | 5 | 5 | 5 | 5 | 5 | 5 | 5 | 5 |
| Nucleous Growing | 700 | 700 | 700 | 700 | 700 | 700 | 700 | 700 | 700 | 700 | 700 |
| Temperature??? | | | | | | | | | | | |
| NucleousGrowing Time?hr? | 10 | 10 | 10 | 10 | 10 | 10 | 10 | 10 | 10 | 10 | 10 |
| Main Crystalline Phase | Crist | Crist | Crist | Quartz | Crist | Crist | Quartz | Crist | Crist | Quartz | Crist |
| Sub Crystalline Phase | Quartz | Quartz | Quartz | Crist | LZS | LZS | Crist | Quartz | LZS | Crist | Quartz |
| Specific Gravity?g/cm³ | 2.58 | 2.55 | 2.53 | 2.57 | 2.55 | 2.52 | 2.51 | 2.54 | 2.64 | 2.64 | 2.57 |
| Yong's Modulus E??Pa | 77.6 | 77.1 | 76.8 | 76.4 | 78.4 | 80.8 | 77.1 | 79.9 | 84.7 | 85.7 | 80.8 |
| Elastic Modulus Ratio | 30.0 | 30.2 | 30.3 | 29.7 | 30.7 | 32.0 | 30.7 | 31.4 | 32.1 | 32.4 | 31.4 |
| C.T.E | 114 | 118 | 119 | 119 | 113 | 96 | 118 | 105 | 96 | 105 | 98 |
| Amount of Migration of alkali | 53 | 54 | 54 | 54 | 53 | 49 | 54 | 51 | 49 | 51 | 50 |
| metal [ppb] | | | | | | | | | | | |
| P/PLi | 1.3 | 1.3 | 1.3 | 1.3 | 1.3 | 1.3 | 1.3 | 1.3 | 1.3 | 1.3 | 1.3 |

TABLE 66

| | A-675 | A-676 | A-677 | A-678 | A-679 | A-680 | A-681 | A-682 | A-683 | A-684 |
|---|---|---|---|---|---|---|---|---|---|---|
| SiO₂ | 67.5 | 66.5 | 68.0 | 66.0 | 66.5 | 68.0 | 66.0 | 68.0 | 67.0 | 66.0 |
| Al₂O₃ | 6.0 | 5.0 | 4.1 | 6.0 | 5.0 | 5.0 | 4.0 | 7.0 | 7.0 | 7.0 |
| MgO | 2.0 | 2.0 | 2.3 | 1.0 | 2.4 | 2.3 | 2.0 | 2.1 | 2.7 | 2.1 |
| CaO | 0.9 | 2.5 | 2.0 | 1.0 | | | 1.0 | 1.0 | 1.0 | 2.0 |
| BaO | 2.0 | | | | 2.5 | 1.0 | | | | |
| SrO | | 2.0 | 1.0 | 1.5 | 2.0 | 1.0 | 1.5 | | | |
| ZnO | 5.9 | 6.0 | 5.5 | 5.0 | 6.0 | 6.3 | 6.6 | 6.0 | 6.2 | 6.0 |
| Li₂O | 8.0 | 7.1 | 7.0 | 6.9 | 7.1 | 7.0 | 6.9 | 6.5 | 6.5 | 6.0 |
| K₂O | 1.5 | 2.5 | 1.3 | 2.0 | 2.5 | 1.4 | 2.4 | 2.5 | 2.2 | 2.2 |
| B₂O₃ | | | | | | | | | | |
| TiO₂ | 1.0 | 0.5 | 3.0 | 5.0 | 2.0 | 2.0 | 2.0 | 2.0 | 2.0 | 2.0 |
| ZrO₂ | 2.6 | 3.0 | 3.0 | 3.0 | 1.1 | 3.2 | 5.0 | 3.5 | 3.0 | 3.3 |
| P₂O₅ | 2.1 | 2.5 | 2.4 | 2.2 | 2.5 | 2.4 | 2.2 | 1.0 | 2.0 | 3.0 |
| Y₂O₃ | | | | | | | | | | |
| Nb₂O₅ | | | | | | | | | | |
| Ta₂O₅ | | | | | | | | | | |
| La₂O₃ | | | | | | | | | | |
| Sb₂O₃ | 0.4 | 0.5 | 0.4 | 0.4 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 |
| Melting Temperature??? | 1550 | 1550 | 1550 | 1550 | 1550 | 1550 | 1550 | 1550 | 1550 | 1550 |
| Melting Time?hr? | 3 | 3 | 3 | 3 | 3 | 3 | 3 | 3 | 3 | 3 |
| Nucleating Temperature??? | 550 | 550 | 550 | 550 | 550 | 550 | 550 | 550 | 550 | 550 |
| Nucleating Time?hr? | 5 | 5 | 5 | 5 | 5 | 5 | 5 | 5 | 5 | 5 |
| Nucleous Growing | 700 | 700 | 700 | 700 | 700 | 700 | 700 | 700 | 700 | 700 |
| Temperature??? | | | | | | | | | | |
| Nucleous Growing Time?hr? | 10 | 10 | 10 | 10 | 10 | 10 | 10 | 10 | 10 | 10 |
| Main Crystalline Phase | Quartz | Crist | Quartz | Quartz | Quartz | Quartz | Quartz | Quartz | Quartz | Quartz |
| Sub Crystalline Phase | Crist | LZS | Crist | Crist | Crist | Crist | Crist | Crist | Crist | Crist |
| Specific Gravity?g/cm³ | 2.57 | 2.51 | 2.56 | 2.65 | 2.54 | 2.58 | 2.66 | 2.52 | 2.57 | 2.64 |
| Yong's Modulus E??Pa | 78.8 | 78.9 | 80.4 | 81.6 | 82.8 | 83.7 | 84.8 | 81.8 | 81.2 | 80.9 |
| Elastic Modulus Ratio | 30.6 | 31.4 | 31.4 | 30.8 | 32.6 | 32.4 | 31.9 | 32.4 | 31.5 | 30.6 |
| C.T.E | 112 | 105 | 120 | 123 | 111 | 108 | 97 | 106 | 110 | 122 |
| Amount of Migration of alkali | 52 | 51 | 54 | 55 | 52 | 52 | 49 | 51 | 52 | 54 |
| metal [ppb] | | | | | | | | | | |
| P/PLi | 1.3 | 1.3 | 1.3 | 1.3 | 1.3 | 1.3 | 1.3 | 1.3 | 1.3 | 1.3 |

[Second Embodiment]

Tables 67 and 68 show the glass compositions in % by weight of respective crystallized glass substrates of B-1 to 18, together with the manufacturing conditions employed. Tables 69 and 70 show crystallized glass substrates as B-19 to 36 manufactured using the same glass compositions as those of B-1 to 18 with the nucleus growing temperature varied from that employed for B-1 to 18. Further, Tables 71 and 72 show crystallized glass substrates as B-37 to 54 manufactured using the same glass compositions as those of B-1 to 18 with the nucleus growing time varied from that employed for B-1 to 18.

TABLE 67

| | B-1 | B-2 | B-3 | B-4 | B-5 | B-6 | B-7 | B-8 | B-9 |
|---|---|---|---|---|---|---|---|---|---|
| SiO₂ | 55.0 | 61.1 | 64.7 | 61.0 | 60.0 | 63.0 | 62.1 | 63.0 | 60.0 |
| Al₂O₃ | 7.0 | 7.5 | 7.3 | 3.0 | 5.0 | 9.0 | 8.8 | 6.0 | 5.5 |
| MgO | 3.0 | 2.0 | 1.9 | 2.5 | 1.0 | 2.4 | 2.3 | 1.0 | 1.0 |
| CaO | 2.0 | | 0.9 | | 2.0 | 1.1 | 0.9 | 1.0 | 1.0 |
| BaO | 2.0 | 2.5 | 2.4 | 3.0 | 2.3 | | 2.9 | 1.5 | 1.0 |
| SrO | | 1.7 | | 2.1 | 1.8 | 2.0 | 2.0 | | |
| ZnO | 13.0 | 12.2 | 5.7 | 7.2 | 7.5 | 7.0 | 5.5 | 15.0 | 20.0 |
| Li₂O | 7.0 | 6.0 | 5.9 | 7.4 | 7.4 | 7.2 | 7.1 | 6.0 | 6.0 |
| K₂O | 0.5 | 2.1 | 2.0 | 2.6 | 2.6 | 2.5 | 2.4 | | |
| B₂O₃ | 3.5 | | | 3.0 | 1.0 | | | 1.0 | 1.0 |
| TiO₂ | 2.0 | | | 2.0 | 3.0 | | | 2.0 | 1.0 |
| ZrO₂ | 2.5 | 2.6 | 2.5 | 3.2 | 3.4 | 3.1 | 3.0 | 1.0 | 1.0 |
| P₂O₅ | 2.0 | 2.1 | 2.0 | 2.6 | 2.6 | 2.5 | 2.4 | 2.1 | 2.1 |
| Y₂O₃ | | | | | | | | | |
| Nb₂O₅ | | | 4.2 | | | | | | |
| Ta₂O₅ | | | | | | | | | |
| La₂O₃ | | | | | | | | | |
| Sb₂O₃ | 0.4 | 0.4 | 0.4 | 0.5 | 0.5 | 0.5 | 0.5 | 0.4 | 0.4 |
| Total (100 wt %) | 100.0 | 100.0 | 100.0 | 100.0 | 100.0 | 100.0 | 100.0 | 100.0 | 100.0 |
| Melting Temperature??? | 1550 | 1550 | 1550 | 1550 | 1550 | 1550 | 1550 | 1550 | 1550 |
| Melting Time?hr? | 3 | 3 | 3 | 3 | 3 | 3 | 3 | 3 | 3 |
| Nucleating | 550 | 550 | 550 | 550 | 550 | 550 | 550 | 550 | 550 |
| Temperature??? | | | | | | | | | |
| Nucleating Time?hr? | 5 | 5 | 5 | 5 | 5 | 5 | 5 | 5 | 5 |
| Nucleous Growing | 720 | 720 | 720 | 720 | 720 | 720 | 720 | 720 | 720 |
| Temperature??? | | | | | | | | | |
| Nucleous Growing | 3 | 3 | 3 | 3 | 3 | 3 | 3 | 3 | 3 |
| Time?hr? | | | | | | | | | |
| Main Crystalline Phase | LZS | LZS | Crist | Quartz | Quartz | Crist | Crist | LZS | LZS |
| Sub Crystalline Phase | — | — | LZS | Crist | Crist | LZS | LZS | — | — |
| Specific Gravity?g/cm³ | 2.66 | 2.65 | 2.58 | 2.66 | 2.64 | 2.55 | 2.59 | 2.65 | 2.69 |
| Yong's Modulus E??Pa | 86.2 | 86.0 | 78.3 | 79.8 | 80.0 | 83.7 | 84.6 | 83.5 | 85.1 |
| Elastic Modulus Ratio | 32.4 | 32.5 | 30.3 | 30.0 | 30.3 | 32.8 | 32.7 | 31.5 | 31.6 |
| C.T.E | 64 | 65 | 104 | 93 | 88 | 83 | 85 | 66 | 62 |
| Amount of Migration of | 52 | 49 | 59 | 62 | 60 | 58 | 58 | 50 | 49 |
| alkali metal [ppb] | | | | | | | | | |
| P/Pli | 1.0 | 1.0 | 1.2 | 1.1 | 1.1 | 1.1 | 1.1 | 1.1 | 1.0 |

TABLE 68

| | B-10 | B-11 | B-12 | B-13 | B-14 | B-15 | B-16 | B-17 | B-18 |
|---|---|---|---|---|---|---|---|---|---|
| SiO₂ | 63.0 | 63.4 | 63.0 | 63.1 | 63.9 | 60.6 | 62.0 | 61.6 | 64.0 |
| Bl₂O₃ | 6.0 | 7.5 | 9.0 | 9.0 | 8.3 | 8.6 | 7.1 | 7.5 | 8.0 |
| MgO | 2.0 | 2.0 | 2.0 | 2.4 | 2.2 | 2.3 | 2.1 | 2.0 | 2.1 |
| CaO | 0.8 | | 0.9 | | | | 2.0 | 0.9 | 2.0 |
| BaO | 2.5 | 2.5 | 2.0 | 2.9 | 2.7 | 2.8 | | 2.5 | |
| SrO | | 1.7 | | 2.0 | 1.9 | 1.9 | | | |
| ZnO | 10.0 | 9.7 | 8.0 | 7.0 | 6.5 | 6.7 | 6.4 | 12.3 | 6.5 |
| Li₂O | 4.0 | 6.0 | 8.0 | 7.2 | 6.7 | 6.9 | 7.0 | 6.0 | 7.0 |
| K₂O | 2.1 | 2.1 | 1.5 | 2.5 | 2.3 | 2.4 | 2.5 | 2.1 | 2.2 |
| B₂O₃ | 2.0 | | | | | | 3.0 | 1.0 | |
| TiO₂ | 2.0 | | | | | | 3.0 | | |
| ZrO₂ | 3.0 | 2.6 | 3.0 | 1.1 | 2.8 | 4.9 | 3.5 | 2.6 | 3.7 |
| P₂O₅ | 2.1 | 2.1 | 2.1 | 2.5 | 2.3 | 2.4 | 1.0 | 2.1 | 3.0 |
| Y₂O₃ | | | | | | | | | |
| Nb₂O₅ | | | | | | | | | |
| Ta₂O₅ | | | | | | | | | |
| La₂O₃ | | | | | | | | | |
| Sb₂O₃ | 0.4 | 0.4 | 0.4 | 0.5 | 0.4 | 0.5 | 0.4 | 0.4 | 0.4 |
| Total (100 wt %) | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 |
| Temperature??? | | | | | | | | | |
| Melting Time?hr? | 3 | 3 | 3 | 3 | 3 | 3 | 3 | 3 | 3 |
| Nucleating | 550 | 550 | 550 | 550 | 550 | 550 | 550 | 550 | 550 |
| Temperature??? | | | | | | | | | |
| Nucleating Time?hr? | 5 | 5 | 5 | 5 | 5 | 5 | 5 | 5 | 5 |
| Nucleous Growing | 720 | 720 | 720 | 720 | 720 | 720 | 720 | 720 | 720 |
| Temperature??? | | | | | | | | | |
| Nucleous Growing | 3 | 3 | 3 | 3 | 3 | 3 | 3 | 3 | 3 |
| Time?hr? | | | | | | | | | |
| Main Crystalline Phase | Quartz | LZS | LZS | Quartz | Crist | Crist | Quartz | LZS | Crist |
| Sub Crystalline Phase | Crist | — | Crist | Crist | LZS | LZS | Crist | — | Quartz |
| Specific Gravity?g/cm³ | 2.76 | 2.59 | 2.56 | 2.64 | 2.58 | 2.62 | 2.66 | 2.59 | 2.58 |
| Yong's Modulus E??Pa | 85.9 | 83.6 | 81.0 | 83.9 | 80.3 | 78.7 | 82.8 | 85.3 | 78.6 |
| Elastic Modulus Ratio | 31.1 | 32.3 | 31.6 | 31.8 | 31.1 | 30.0 | 31.1 | 32.9 | 30.5 |
| C.T.E | 98 | 65 | 76 | 98 | 95 | 95 | 98 | 62 | 119 |
| Amount of Migration at | 49 | 49 | 59 | 63 | 60 | 61 | 62 | 49 | 68 |
| alkali metal [ppb] | | | | | | | | | |
| P/Pli | 1.3 | 1.0 | 1.0 | 1.1 | 1.1 | 1.1 | 1.1 | 1.0 | 1.2 |

TABLE 69

| | B-19 | B-20 | B-21 | B-22 | B-23 | B-24 | B-25 | B-26 | 8-27 |
|---|---|---|---|---|---|---|---|---|---|
| SiO₂ | 55.0 | 61.1 | 64.7 | 61.0 | 60.0 | 63.0 | 62.1 | 63.0 | 60.0 |
| Bl₂O₃ | 7.0 | 7.5 | 7.3 | 3.0 | 5.0 | 9.0 | 8.8 | 6.0 | 5.5 |
| MgO | 3.0 | 2.0 | 1.9 | 2.5 | 1.0 | 2.4 | 2.3 | 1.0 | 1.0 |
| CaO | 2.0 | | 0.9 | | 2.0 | 1.1 | 0.9 | 1.0 | 1.0 |
| BaO | 2.0 | 2.5 | 2.4 | 3.0 | 2.3 | | 2.9 | 1.5 | 1.0 |
| SrO | | 1.7 | | 2.1 | 1.8 | 2.0 | 2.0 | | |
| ZnO | 13.0 | 12.2 | 5.7 | 7.2 | 7.5 | 7.0 | 5.5 | 15.0 | 20.0 |
| Li₂O | 7.0 | 6.0 | 5.9 | 7.4 | 7.4 | 7.2 | 7.1 | 6.0 | 6.0 |
| K₂O | 0.5 | 2.1 | 2.0 | 2.6 | 2.6 | 2.5 | 2.4 | | |
| B₂O₃ | 3.5 | | | 3.0 | 1.0 | | | 1.0 | 1.0 |
| TiO₂ | 2.0 | | | 2.0 | 3.0 | | | 2.0 | 1.0 |
| ZrO₂ | 2.5 | 2.6 | 2.5 | 3.2 | 3.4 | 3.1 | 3.0 | 1.0 | 1.0 |
| P₂O₅ | 2.0 | 2.1 | 2.0 | 2.6 | 2.6 | 2.5 | 2.4 | 2.1 | 2.1 |
| Y₂O₃ | | | | | | | | | |
| Nb₂O₅ | | | 4.2 | | | | | | |
| Ta₂O₅ | | | | | | | | | |
| La₂O₃ | | | | | | | | | |
| Sb₂O₃ | 0.4 | 0.4 | 0.4 | 0.5 | 0.5 | 0.5 | 0.5 | 0.4 | 0.4 |
| Total (100 wt %) | 100.0 | 100.0 | 100.0 | 100.0 | 100.0 | 100.0 | 100.0 | 100.0 | 100.0 |
| Melting Temperature??? | 1550 | 1550 | 1550 | 1550 | 1550 | 1550 | 1550 | 1550 | 1550 |
| Melting Time?hr? | 3 | 3 | 3 | 3 | 3 | 3 | 3 | 3 | 3 |
| Nucleating | 550 | 550 | 550 | 550 | 550 | 550 | 550 | 550 | 550 |
| Temperature??? | | | | | | | | | |
| Nucleating Time?hr? | 5 | 5 | 5 | 5 | 5 | 5 | 5 | 5 | 5 |
| Nucleous Growing | 750 | 750 | 750 | 750 | 750 | 750 | 750 | 750 | 750 |
| Temperature??? | | | | | | | | | |
| Nucleous Growing | 3 | 3 | 3 | 3 | 3 | 3 | 3 | 3 | 3 |
| Time?hr? | | | | | | | | | |
| Main Crystalline Phase | LZS | LZS | Crist | Quartz | Quartz | Crist | Crist | LZS | LZS |
| Sub Crystalline Phase | Crist | Crist | LZS | Crist | Crist | LZS | LZS | Crist | — |
| Specific Gravity?g/cm³ | 2.65 | 2.64 | 2.57 | 2.68 | 2.66 | 2.54 | 2.58 | 2.64 | 2.68 |
| Yong's Modulus E??Pa | 85.9 | 85.7 | 78.0 | 83.2 | 83.4 | 83.4 | 84.3 | 83.2 | 84.8 |
| Elastic Modulus Ratio | 32.4 | 32.4 | 30.3 | 31.0 | 31.3 | 32.8 | 32.6 | 31.5 | 31.6 |
| C.T.E | 78 | 72 | 112 | 106 | 104 | 85 | 87 | 73 | 70 |
| Amount of Migration of | 49 | 48 | 57 | 55 | 55 | 51 | 51 | 48 | 48 |
| alkali metal [ppb] | | | | | | | | | |
| P/Pli | 1.1 | 1.1 | 1.3 | 1.2 | 1.2 | 1.2 | 1.2 | 1.1 | 1.1 |

TABLE 70

| | B-28 | B-29 | B-30 | B-31 | B-32 | B-33 | B-34 | B-35 | B-36 |
|---|---|---|---|---|---|---|---|---|---|
| SiO₂ | 63.0 | 63.4 | 63.0 | 63.1 | 63.9 | 60.6 | 62.0 | 61.6 | 64.0 |
| Bl₂O₃ | 6.0 | 7.5 | 9.0 | 9.0 | 8.3 | 8.6 | 7.1 | 7.5 | 8.0 |
| MgO | 2.0 | 2.0 | 2.0 | 2.4 | 2.2 | 2.3 | 2.1 | 2.0 | 2.1 |
| CaO | 0.8 | | 0.9 | | | | 2.0 | 0.9 | 2.0 |
| BaO | 2.5 | 2.5 | 2.0 | 2.9 | 2.7 | 2.8 | | 2.5 | |
| SrO | | 1.7 | | 2.0 | 1.9 | 1.9 | | | |
| ZnO | 10.0 | 9.7 | 8.0 | 7.0 | 6.5 | 6.7 | 6.4 | 12.3 | 6.5 |
| Li₂O | 4.0 | 6.0 | 8.0 | 7.2 | 6.7 | 6.9 | 7.0 | 6.0 | 7.0 |
| K₂O | 2.1 | 2.1 | 1.5 | 2.5 | 2.3 | 2.4 | 2.5 | 2.1 | 2.2 |
| B₂O₃ | 2.0 | | | | | | 3.0 | | 1.0 |
| TiO₂ | 2.0 | | | | | | 3.0 | | |
| ZrO₂ | 3.0 | 2.6 | 3.0 | 1.1 | 2.8 | 4.9 | 3.5 | 2.6 | 3.7 |
| P₂O₅ | 2.1 | 2.1 | 2.1 | 2.5 | 2.3 | 2.4 | 1.0 | 2.1 | 3.0 |
| Y₂O₃ | | | | | | | | | |
| Nb₂O₅ | | | | | | | | | |
| Ta₂O₅ | | | | | | | | | |
| La₂O₃ | | | | | | | | | |
| Sb₂O₃ | 0.4 | 0.4 | 0.4 | 0.5 | 0.4 | 0.5 | 0.4 | 0.4 | 0.4 |
| Total (100 wt %) | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 |
| Temperature??? | | | | | | | | | |
| Melting Time?hr? | 3 | 3 | 3 | 3 | 3 | 3 | 3 | 3 | 3 |
| Nucleating | 550 | 550 | 550 | 550 | 550 | 550 | 550 | 550 | 550 |
| Temperature??? | | | | | | | | | |
| Nucleating Time?hr? | 5 | 5 | 5 | 5 | 5 | 5 | 5 | 5 | 5 |
| Nucleous Growing | 750 | 750 | 750 | 750 | 750 | 750 | 750 | 750 | 750 |
| Temperature??? | | | | | | | | | |
| Nucleous Growing | 3 | 3 | 3 | 3 | 3 | 3 | 3 | 3 | 3 |
| Time?hr? | | | | | | | | | |
| Main Crystalline Phase | Quartz | LZS | Crist | Quartz | Crist | Crist | Quartz | LZS | Quartz |
| Sub Crystalline Phase | LAS | — | LZS | LAS | LZS | LZS | LAS | — | Crist |
| Specific Gravity?g/cm³ | 2.78 | 2.58 | 2.55 | 2.63 | 2.57 | 2.61 | 2.68 | 2.58 | 2.60 |
| Yong's Modulus E??Pa | 89.5 | 83.3 | 80.7 | 83.6 | 80.0 | 78.4 | 86.3 | 85.0 | 81.9 |
| Elastic Modulus Ratio | 32.2 | 32.2 | 31.6 | 31.7 | 31.1 | 30.0 | 32.2 | 32.9 | 31.5 |
| C.T.E | 108 | 72 | 80 | 98 | 96 | 96 | 108 | 70 | 119 |
| Amount of Migration of | 56 | 48 | 50 | 54 | 53 | 53 | 56 | 48 | 58 |
| alkali metal [ppb] | | | | | | | | | |
| P/Pli | 1.3 | 1.1 | 1.2 | 1.2 | 1.2 | 1.2 | 1.3 | 1.1 | 1.3 |

TABLE 71

| | B-37 | B-38 | B-39 | B-40 | B-41 | B-42 | B-43 | B-44 | B-45 |
|---|---|---|---|---|---|---|---|---|---|
| SiO₂ | 55.0 | 61.1 | 64.7 | 61.0 | 60.0 | 63.0 | 62.1 | 63.0 | 60.0 |
| Bl₂O₃ | 7.0 | 7.5 | 7.3 | 3.0 | 5.0 | 9.0 | 8.8 | 6.0 | 5.5 |
| MgO | 3.0 | 2.0 | 1.9 | 2.5 | 1.0 | 2.4 | 2.3 | 1.0 | 1.0 |
| CaO | 2.0 | | 0.9 | | 2.0 | 1.1 | 0.9 | 1.0 | 1.0 |
| BaO | 2.0 | 2.5 | 2.4 | 3.0 | 2.3 | | 2.9 | 1.5 | 1.0 |
| SrO | | 1.7 | | 2.1 | 1.8 | 2.0 | 2.0 | | |
| ZnO | 13.0 | 12.2 | 5.7 | 7.2 | 7.5 | 7.0 | 5.5 | 15.0 | 20.0 |
| Li₂O | 7.0 | 6.0 | 5.9 | 7.4 | 7.4 | 7.2 | 7.1 | 6.0 | 6.0 |
| K₂O | 0.5 | 2.1 | 2.0 | 2.6 | 2.6 | 2.5 | 2.4 | | |
| B₂O₃ | 3.5 | | | 3.0 | 1.0 | | | 1.0 | 1.0 |
| TiO₂ | 2.0 | | | 2.0 | 3.0 | | | 2.0 | 1.0 |
| ZrO₂ | 2.5 | 2.6 | 2.5 | 3.2 | 3.4 | 3.1 | 3.0 | 1.0 | 1.0 |
| P₂O₅ | 2.0 | 2.1 | 2.0 | 2.6 | 2.6 | 2.5 | 2.4 | 2.1 | 2.1 |
| Y₂O₃ | | | | | | | | | |
| Nb₂O₅ | | | 4.2 | | | | | | |
| Ta₂O₅ | | | | | | | | | |
| La₂O₃ | | | | | | | | | |
| Sb₂O₃ | 0.4 | 0.4 | 0.4 | 0.5 | 0.5 | 0.5 | 0.5 | 0.4 | 0.4 |
| Total (100 wt %) | 100.0 | 100.0 | 100.0 | 100.0 | 100.0 | 100.0 | 100.0 | 100.0 | 100.0 |
| Melting Temperature??? | 1550 | 1550 | 1550 | 1550 | 1550 | 1550 | 1550 | 1550 | 1550 |
| Melting Time?hr? | 3 | 3 | 3 | 3 | 3 | 3 | 3 | 3 | 3 |
| Nucleating | 550 | 550 | 550 | 550 | 550 | 550 | 550 | 550 | 550 |
| Temperature??? | | | | | | | | | |
| Nucleating Time?hr? | 5 | 5 | 5 | 5 | 5 | 5 | 5 | 5 | 5 |
| Nucleous Growing | 720 | 720 | 720 | 720 | 720 | 720 | 720 | 720 | 720 |
| Temperature??? | | | | | | | | | |
| Nucleous Growing | 10 | 10 | 10 | 10 | 10 | 10 | 10 | 10 | 10 |
| Time?hr? | | | | | | | | | |
| Main Crystalline Phase | LZS | LZS | Crist | Crist | Crist | Crist | Crist | LZS | LZS |
| Sub Crystalline Phase | — | Crist | LZS | Quartz | Quartz | LZS | LZS | — | — |
| Specific Gravity?g/cm³ | 2.65 | 2.64 | 2.57 | 2.65 | 2.63 | 2.54 | 2.58 | 2.64 | 2.68 |
| Yong's Modulus E??Pa | 85.9 | 85.7 | 78.0 | 79.5 | 79.7 | 83.4 | 84.3 | 83.2 | 84.8 |
| Elastic Modulus Ratio | 32.4 | 32.4 | 30.3 | 30.0 | 30.3 | 32.8 | 32.6 | 31.5 | 31.6 |
| C.T.E | 71 | 72 | 104 | 107 | 105 | 85 | 87 | 72 | 69 |
| Amount of Migration of | 48 | 48 | 55 | 55 | 55 | 51 | 51 | 48 | 48 |
| alkali metal [ppb] | | | | | | | | | |
| P/Pli | 1.1 | 1.1 | 1.2 | 1.2 | 1.2 | 1.2 | 1.2 | 1.1 | 1.1 |

TABLE 72

| | B-46 | B-47 | B-48 | B-49 | B-50 | B-51 | B-52 | B-53 | B-54 |
|---|---|---|---|---|---|---|---|---|---|
| SiO₂ | 63.0 | 63.4 | 63.0 | 63.1 | 63.9 | 60.6 | 62.0 | 61.6 | 64.0 |
| Bl₂O₃ | 6.0 | 7.5 | 9.0 | 9.0 | 8.3 | 8.6 | 7.1 | 7.5 | 8.0 |
| MgO | 2.0 | 2.0 | 2.0 | 2.4 | 2.2 | 2.3 | 2.1 | 2.0 | 2.1 |
| CaO | 0.8 | | 0.9 | | | | 2.0 | 0.9 | 2.0 |
| BaO | 2.5 | 2.5 | 2.0 | 2.9 | 2.7 | 2.8 | | 2.5 | |
| SrO | | 1.7 | | 2.0 | 1.9 | 1.9 | | | |
| ZnO | 10.0 | 9.7 | 8.0 | 7.0 | 6.5 | 6.7 | 6.4 | 12.3 | 6.5 |
| Li₂O | 4.0 | 6.0 | 8.0 | 7.2 | 6.7 | 6.9 | 7.0 | 6.0 | 7.0 |
| K₂O | 2.1 | 2.1 | 1.5 | 2.5 | 2.3 | 2.4 | 2.5 | 2.1 | 2.2 |
| B₂O₃ | 2.0 | | | | | | 3.0 | | 1.0 |
| TiO₂ | 2.0 | | | | | | 3.0 | | |
| ZrO₂ | 3.0 | 2.6 | 3.0 | 1.1 | 2.8 | 4.9 | 3.5 | 2.6 | 3.7 |
| P₂O₅ | 2.1 | 2.1 | 2.1 | 2.5 | 2.3 | 2.4 | 1.0 | 2.1 | 3.0 |
| Y₂O₃ | | | | | | | | | |
| Nb₂O₅ | | | | | | | | | |
| Ta₂O₅ | | | | | | | | | |
| La₂O₃ | | | | | | | | | |
| Sb₂O₃ | 0.4 | 0.4 | 0.4 | 0.5 | 0.4 | 0.5 | 0.4 | 0.4 | 0.4 |
| Total (100 wt %) | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 |
| Temperature??? | | | | | | | | | |
| Melting Time?hr? | 3 | 3 | 3 | 3 | 3 | 3 | 3 | 3 | 3 |
| Nucleating | 550 | 550 | 550 | 550 | 550 | 550 | 550 | 550 | 550 |
| Temperature??? | | | | | | | | | |
| Nucleating Time?hr? | 5 | 5 | 5 | 5 | 5 | 5 | 5 | 5 | 5 |
| Nucleous Growing | 720 | 720 | 720 | 720 | 720 | 720 | 720 | 720 | 720 |
| Temperature??? | | | | | | | | | |
| Nucleous Growing | 10 | 10 | 10 | 10 | 10 | 10 | 10 | 10 | 10 |
| Time?hr? | | | | | | | | | |
| Main Crystalline Phase | Quartz | LZS | Crist | Quartz | Crist | Crist | Quartz | LZS | Crist |
| Sub Crystalline Phase | Crist | — | LZS | LAS | LZS | LZS | Crist | — | Quartz |
| Specific Gravity?g/cm³ | 2.77 | 2.58 | 2.55 | 2.63 | 2.57 | 2.61 | 2.67 | 2.58 | 2.59 |
| Yong's Modulus E??Pa | 88.4 | 83.3 | 80.7 | 83.6 | 80.0 | 78.4 | 85.2 | 85.0 | 80.9 |
| Elastic Modulus Ratio | 31.9 | 32.2 | 31.6 | 31.7 | 31.1 | 30.0 | 31.9 | 32.9 | 31.2 |
| C.T.E | 109 | 72 | 80 | 98 | 96 | 96 | 109 | 69 | 121 |
| Amount of Migration of | 56 | 48 | 50 | 54 | 53 | 53 | 56 | 48 | 58 |
| alkali metal [ppb] | | | | | | | | | |
| P/Pli | 1.3 | 1.1 | 1.1 | 1.2 | 1.2 | 1.2 | 1.3 | 1.1 | 1.3 |

Tables 73 and 74 show the glass compositions in % by weight of respective crystallized glass substrates of B—55 to 75, together with the manufacturing conditions employed. Tables 75 and 76 show crystallized glass substrates as B-76 to 96 manufactured using the same glass compositions as those of B-55 to 75 with the nucleus growing temperature varied from that employed for B-55 to 75. Further, Tables 77 and 78 show crystallized glass substrates as B-97 to 117 manufactured using the same glass compositions as those of B-55 to 75 with the nucleus growing time varied from that employed for B-55 to 75.

TABLE 73

| | B-55 | B-56 | B-57 | B-58 | B-59 | B-60 | B-61 | B-62 | B-63 | B-64 | B-65 |
|---|---|---|---|---|---|---|---|---|---|---|---|
| SiO₂ | 55.0 | 60.0 | 64.6 | 61.0 | 60.0 | 63.0 | 63.0 | 64.0 | 64.0 | 65.0 | 62.1 |
| Bl₂O₃ | 7.0 | 6.0 | 7.5 | 3.0 | 5.0 | 10.0 | 9.0 | 9.0 | 8.0 | 7.6 | 7.6 |
| MgO | 3.0 | 2.5 | 2.0 | 2.5 | 1.0 | 2.5 | 0.5 | 3.0 | 5.0 | 2.5 | 2.0 |
| CaO | 2.0 | 1.0 | | | 2.0 | | 2.0 | 2.0 | 0.5 | | |
| BaO | 2.0 | 1.0 | 2.5 | 3.0 | 2.3 | 3.0 | 1.0 | | | 2.5 | 2.5 |
| SrO | | | 1.7 | 2.1 | 1.8 | 2.0 | 2.0 | | | 1.7 | 1.7 |
| ZnO | 13.0 | 10.0 | 8.5 | 7.2 | 7.5 | 6.2 | 6.4 | 6.3 | 6.5 | 5.0 | 9.8 |
| Li₂O | 7.0 | 7.0 | 6.1 | 7.4 | 7.4 | 7.2 | 7.2 | 7.5 | 7.0 | 7.0 | 7.1 |
| K₂O | 0.5 | 1.0 | 2.1 | 2.6 | 2.6 | | 2.5 | 2.2 | 2.2 | 2.2 | 2.1 |
| B₂O₃ | 3.5 | 2.0 | | 3.0 | 1.0 | | | | | | |
| TiO₂ | 2.0 | 2.0 | | 2.0 | 3.0 | | | | | | |
| ZrO₂ | 2.5 | 4.5 | 2.6 | 3.2 | 3.4 | 3.1 | 3.5 | 3.0 | 3.7 | 4.0 | 2.6 |
| P₂O₅ | 2.0 | 2.5 | 2.1 | 2.6 | 2.6 | 2.5 | 2.5 | 2.5 | 2.6 | 2.1 | 2.1 |
| Y₂O₃ | | | | | | | | | | | |
| Nb₂O₅ | | | | | | | | | | | |
| Ta₂O₅ | | | | | | | | | | | |
| La₂O₃ | | | | | | | | | | | |
| Sb₂O₃ | 0.4 | 0.5 | 0.4 | 0.5 | 0.5 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 99.9 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 720 | 720 | 720 | 720 | 720 | 720 | 720 | 720 | 720 | 720 | 720 |
| Growing | | | | | | | | | | | |
| Temperature??? | | | | | | | | | | | |
| Nucleous | 3 | 3 | 3 | 3 | 3 | 3 | 3 | 3 | 3 | 3 | 3 |
| Growing | | | | | | | | | | | |
| Time?hr? | | | | | | | | | | | |
| Main Crystalline | LZS | Quartz | LZS | Quartz | Quartz | Crist | Crist | Crist | Crist | Crist | Crist |
| Phase | | | | | | | | | | | |
| Sub Crystalline | — | Crist | Crist | Crist | Crist | LZS | LZS | LZS | LZS | LZS | LZS |
| Phase | | | | | | | | | | | |
| Specific | 2.66 | 2.66 | 2.65 | 2.66 | 2.64 | 2.58 | 2.58 | 2.56 | 2.52 | 2.53 | 2.66 |
| Gravity?g/cm³ | | | | | | | | | | | |
| Yong's Modulus | 86.2 | 83.0 | 83.7 | 79.8 | 80.0 | 82.3 | 82.2 | 79.3 | 81.3 | 83.0 | 81.8 |
| E??Pa | | | | | | | | | | | |
| Elastic Modulus | 32.4 | 31.2 | 31.6 | 30.0 | 30.3 | 31.9 | 31.9 | 31.0 | 32.3 | 32.8 | 30.8 |
| Ratio | | | | | | | | | | | |
| C.T.E | 64 | 98 | 77 | 93 | 88 | 86 | 89 | 85 | 81 | 108 | 96 |
| Amount of | 52 | 62 | 53 | 62 | 60 | 59 | 60 | 60 | 57 | 65 | 61 |
| Migration of | | | | | | | | | | | |
| alkali metal | | | | | | | | | | | |
| [ppb] | | | | | | | | | | | |
| P/Pli | 1.0 | 1.1 | 1.1 | 1.1 | 1.1 | 1.1 | 1.1 | 1.1 | 1.1 | 1.2 | 1.1 |

TABLE 74

| | B-66 | B-67 | B-68 | B-69 | B-70 | B-71 | B-72 | B-73 | B-74 | B-75 |
|---|---|---|---|---|---|---|---|---|---|---|
| SiO₂ | 60.0 | 63.0 | 63.9 | 63.0 | 58.0 | 61.0 | 60.0 | 62.0 | 64.0 | 64.0 |
| Bl₂O₃ | 5.5 | 6.0 | 7.6 | 9.0 | 6.5 | 5.0 | 6.0 | 7.1 | 7.6 | 8.0 |
| MgO | 1.0 | 2.0 | 2.0 | 2.0 | 2.4 | 2.3 | 1.6 | 2.1 | 2.0 | 2.1 |
| CaO | 1.0 | 0.8 | 0.9 | 0.9 | | 1.1 | 2.0 | 2.0 | | 2.0 |
| BaO | 1.0 | 2.5 | 2.5 | 2.0 | 2.5 | 2.0 | | | 2.5 | |
| SrO | | | | | 2.0 | | 1.5 | | 1.7 | |
| ZnO | 20.0 | 10.0 | 9.8 | 8.0 | 9.0 | 11.0 | 10.0 | 6.4 | 8.5 | 6.5 |
| Li₂O | 6.0 | 4.0 | 6.1 | 8.0 | 7.1 | 7.0 | 6.9 | 7.0 | 6.6 | 7.0 |
| K₂O | | 2.1 | 2.1 | 1.5 | 2.5 | 2.0 | 2.4 | 2.5 | 2.1 | 2.2 |
| B₂O₃ | 1.0 | 2.0 | | | 3.0 | 3.0 | 1.0 | 3.0 | | 1.0 |
| TiO₂ | 1.0 | 2.0 | | | 3.0 | | 1.0 | 3.0 | | |
| ZrO₂ | 1.0 | 3.0 | 2.6 | 3.0 | 1.1 | 3.2 | 5.0 | 3.5 | 2.6 | 3.7 |
| P₂O₅ | 2.1 | 2.1 | 2.1 | 2.1 | 2.5 | 2.0 | 2.2 | 1.0 | 2.1 | 3.0 |
| Y₂O₃ | | | | | | | | | | |
| Nb₂O₅ | | | | | | | | | | |
| Ta₂O₅ | | | | | | | | | | |
| La₂O₃ | | | | | | | | | | |
| Sb₂O₃ | 0.4 | 0.4 | 0.4 | 0.4 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 720 | 720 | 720 | 720 | 720 | 720 | 720 | 720 | 720 | 720 |
| Temperature??? | | | | | | | | | | |
| Nucleous Growing | 3 | 3 | 3 | 3 | 3 | 3 | 3 | 3 | 3 | 3 |
| Time?hr? | | | | | | | | | | |
| Main Crystalline | LZS | Quartz | LZS | Crist | Quartz | Quartz | Quartz | Quartz | LZS | Crist |
| Phase | | | | | | | | | | |
| Sub Crystalline | — | Crist | — | LZS | Crist | Crist | Crist | Crist | Crist | Quartz |
| Phase | | | | | | | | | | |
| Specific | 2.71 | 2.76 | 2.57 | 2.55 | 2.69 | 2.65 | 2.71 | 2.66 | 2.53 | 2.58 |
| Gravity?g/cm³ | | | | | | | | | | |
| Yong's Modulus | 84.5 | 85.9 | 85.8 | 83.0 | 82.3 | 80.1 | 83.8 | 82.8 | 82.8 | 78.6 |
| E??Pa | | | | | | | | | | |
| Elastic Modulus | 31.2 | 31.1 | 33.4 | 32.5 | 30.6 | 30.2 | 30.9 | 31.1 | 32.7 | 30.5 |
| Ratio | | | | | | | | | | |
| C.T.E | 62 | 98 | 60 | 88 | 108 | 112 | 105 | 98 | 69 | 119 |
| Amount of | 49 | 49 | 48 | 63 | 65 | 66 | 64 | 62 | 52 | 68 |
| Migration of alkali | | | | | | | | | | |
| metal [ppb] | | | | | | | | | | |
| P/Pli | 1.0 | 1.3 | 1.0 | 1.1 | 1.2 | 1.2 | 1.2 | 1.1 | 1.1 | 1.2 |

TABLE 75

| | B-76 | B-77 | B-78 | B-79 | B-80 | B-81 | B-82 | B-83 | B-84 | B-85 | B-86 |
|---|---|---|---|---|---|---|---|---|---|---|---|
| SiO₂ | 55.0 | 60.0 | 64.6 | 61.0 | 60.0 | 63.0 | 63.0 | 64.0 | 64.0 | 65.0 | 62.1 |
| Bl₂O₃ | 7.0 | 6.0 | 7.5 | 3.0 | 5.0 | 10.0 | 9.0 | 9.0 | 8.0 | 7.6 | 7.6 |
| MgO | 3.0 | 2.5 | 2.0 | 2.5 | 1.0 | 2.5 | 0.5 | 3.0 | 5.0 | 2.5 | 2.0 |
| CaO | 2.0 | 1.0 | | | 2.0 | | 2.0 | 2.0 | 0.5 | | |
| BaO | 2.0 | 1.0 | 2.5 | 3.0 | 2.3 | 3.0 | 1.0 | | | 2.5 | 2.5 |
| SrO | | | 1.7 | 2.1 | 1.8 | 2.0 | 2.0 | | | 1.7 | 1.7 |
| ZnO | 13.0 | 10.0 | 8.5 | 7.2 | 7.5 | 6.2 | 6.4 | 6.3 | 6.5 | 5.0 | 9.8 |
| Li₂O | 7.0 | 7.0 | 6.1 | 7.4 | 7.4 | 7.2 | 7.2 | 7.5 | 7.0 | 7.0 | 7.1 |
| K₂O | 0.5 | 1.0 | 2.1 | 2.6 | 2.6 | | 2.5 | 2.2 | 2.2 | 2.2 | 2.1 |
| B₂O₃ | 3.5 | 2.0 | | 3.0 | 1.0 | | | | | | |
| TiO₂ | 2.0 | 2.0 | | 2.0 | 3.0 | | | | | | |
| ZrO₂ | 2.5 | 4.5 | 2.6 | 3.2 | 3.4 | 3.1 | 3.5 | 3.0 | 3.7 | 4.0 | 2.6 |
| P₂O₅ | 2.0 | 2.5 | 2.1 | 2.6 | 2.6 | 2.5 | 2.5 | 2.5 | 2.6 | 2.1 | 2.1 |
| Y₂O₃ | | | | | | | | | | | |
| Nb₂O₅ | | | | | | | | | | | |
| Ta₂O₅ | | | | | | | | | | | |
| La₂O₃ | | | | | | | | | | | |
| Sb₂O₃ | 0.4 | 0.5 | 0.4 | 0.5 | 0.5 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 99.9 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 750 | 750 | 750 | 750 | 750 | 750 | 750 | 750 | 750 | 750 | 750 |
| Growing | | | | | | | | | | | |
| Temperature??? | | | | | | | | | | | |
| Nucleous | 3 | 3 | 3 | 3 | 3 | 3 | 3 | 3 | 3 | 3 | 3 |
| Growing | | | | | | | | | | | |
| Time?hr? | | | | | | | | | | | |
| Main Crystalline | LZS | Quartz | Crist | Quartz | Quartz | Crist | Crist | Crist | Crist | Crist | Crist |
| Phase | | | | | | | | | | | |
| Sub Crystalline | Crist | Crist | LZS | Crist | Crist | LZS | LZS | Quartz | LZS | LAS | LZS |
| Phase | | | | | | | | | | | |
| Specific | 2.65 | 2.68 | 2.64 | 2.68 | 2.66 | 2.57 | 2.57 | 2.55 | 2.51 | 2.52 | 2.65 |
| Gravity?g/cm³ | | | | | | | | | | | |
| Yong's Modulus | 85.9 | 86.5 | 83.4 | 83.2 | 83.4 | 82.0 | 81.9 | 79.0 | 81.0 | 82.7 | 81.5 |
| E??Pa | | | | | | | | | | | |
| Elastic Modulus | 32.4 | 32.3 | 31.5 | 31.0 | 31.3 | 31.9 | 31.8 | 30.9 | 32.2 | 32.8 | 30.7 |
| Ratio | | | | | | | | | | | |
| C.T.E | 78 | 108 | 81 | 106 | 104 | 88 | 91 | 87 | 84 | 112 | 97 |
| Amount of | 49 | 56 | 50 | 55 | 55 | 52 | 52 | 51 | 51 | 57 | 53 |
| Migration of | | | | | | | | | | | |
| alkali metal | | | | | | | | | | | |
| [ppb] | | | | | | | | | | | |
| P/Pli | 1.1 | 1.3 | 1.2 | 1.2 | 1.2 | 1.2 | 1.2 | 1.2 | 1.2 | 1.3 | 1.2 |

TABLE 76

| | B-87 | B-88 | B-89 | B-90 | B-91 | B-92 | B-93 | B-94 | B-95 | B-96 |
|---|---|---|---|---|---|---|---|---|---|---|
| SiO₂ | 60.0 | 63.0 | 63.9 | 63.0 | 58.0 | 61.0 | 60.0 | 62.0 | 64.0 | 64.0 |
| Bl₂O₃ | 5.5 | 6.0 | 7.6 | 9.0 | 6.5 | 5.0 | 6.0 | 7.1 | 7.6 | 8.0 |
| MgO | 1.0 | 2.0 | 2.0 | 2.0 | 2.4 | 2.3 | 1.6 | 2.1 | 2.0 | 2.1 |
| CaO | 1.0 | 0.8 | 0.9 | 0.9 | | 1.1 | 2.0 | 2.0 | | 2.0 |
| BaO | 1.0 | 2.5 | 2.5 | 2.0 | 2.5 | 2.0 | | | 2.5 | |
| SrO | | | | | 2.0 | | 1.5 | | 1.7 | |
| ZnO | 20.0 | 10.0 | 9.8 | 8.0 | 9.0 | 11.0 | 10.0 | 6.4 | 8.5 | 6.5 |
| Li₂O | 6.0 | 4.0 | 6.1 | 8.0 | 7.1 | 7.0 | 6.9 | 7.0 | 6.6 | 7.0 |
| K₂O | | 2.1 | 2.1 | 1.5 | 2.5 | 2.0 | 2.4 | 2.5 | 2.1 | 2.2 |
| B₂O₃ | 1.0 | 2.0 | | | 3.0 | 3.0 | 1.0 | 3.0 | | 1.0 |
| TiO₂ | 1.0 | 2.0 | | | 3.0 | | 1.0 | 3.0 | | |
| ZrO₂ | 1.0 | 3.0 | 2.6 | 3.0 | 1.1 | 3.2 | 5.0 | 3.5 | 2.6 | 3.7 |
| P₂O₅ | 2.1 | 2.1 | 2.1 | 2.1 | 2.5 | 2.0 | 2.2 | 1.0 | 2.1 | 3.0 |
| Y₂O₃ | | | | | | | | | | |
| Nb₂O₅ | | | | | | | | | | |
| Ta₂O₅ | | | | | | | | | | |
| La₂O₃ | | | | | | | | | | |
| Sb₂O₃ | 0.4 | 0.4 | 0.4 | 0.4 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 750 | 750 | 750 | 750 | 750 | 750 | 750 | 750 | 750 | 750 |
| Temperature??? | | | | | | | | | | |
| Nucleous Growing | 3 | 3 | 3 | 3 | 3 | 3 | 3 | 3 | 3 | 3 |
| Time?hr? | | | | | | | | | | |
| Main Crystalline | LZS | Quartz | LZS | Crist | Quartz | Quartz | Quartz | Quartz | Crist | Quartz |
| Phase | | | | | | | | | | |
| Sub Crystalline | — | LAS | — | LZS | LAS | LAS | LAS | LAS | LZS | Crist |
| Phase | | | | | | | | | | |
| Specific | 2.70 | 2.78 | 2.56 | 2.54 | 2.71 | 2.67 | 2.73 | 2.68 | 2.52 | 2.60 |
| Gravity?g/cm³ | | | | | | | | | | |
| Yong's Modulus | 84.2 | 89.5 | 85.5 | 82.7 | 85.8 | 83.5 | 87.3 | 86.3 | 82.5 | 81.9 |
| E??Pa | | | | | | | | | | |
| Elastic Modulus | 31.1 | 32.2 | 33.3 | 32.5 | 31.6 | 31.3 | 32.0 | 32.2 | 32.7 | 31.5 |
| Ratio | | | | | | | | | | |
| C.T.E | 70 | 108 | 69 | 90 | 113 | 115 | 111 | 108 | 81 | 119 |
| Amount of | 48 | 56 | 47 | 52 | 57 | 57 | 56 | 56 | 50 | 58 |
| Migration of alkali | | | | | | | | | | |
| metal [ppb] | | | | | | | | | | |
| P/Pli | 1.1 | 1.3 | 1.1 | 1.2 | 1.3 | 1.3 | 1.3 | 1.3 | 1.2 | 1.3 |

TABLE 77

| | B-97 | B-98 | B-99 | B-100 | B-101 | B-102 | B-103 | B-104 | B-105 | B-106 | B-107 |
|---|---|---|---|---|---|---|---|---|---|---|---|
| SiO₂ | 55.0 | 60.0 | 64.6 | 61.0 | 60.0 | 63.0 | 63.0 | 64.0 | 64.0 | 65.0 | 62.1 |
| Bl₂O₃ | 7.0 | 6.0 | 7.5 | 3.0 | 5.0 | 10.0 | 9.0 | 9.0 | 8.0 | 7.6 | 7.6 |
| MgO | 3.0 | 2.5 | 2.0 | 2.5 | 1.0 | 2.5 | 0.5 | 3.0 | 5.0 | 2.5 | 2.0 |
| CaO | 2.0 | 1.0 | | | 2.0 | | 2.0 | 2.0 | 0.5 | | |
| BaO | 2.0 | 1.0 | 2.5 | 3.0 | 2.3 | 3.0 | 1.0 | | | 2.5 | 2.5 |
| SrO | | | 1.7 | 2.1 | 1.8 | 2.0 | 2.0 | | | 1.7 | 1.7 |
| ZnO | 13.0 | 10.0 | 8.5 | 7.2 | 7.5 | 6.2 | 6.4 | 6.3 | 6.5 | 5.0 | 9.8 |
| Li₂O | 7.0 | 7.0 | 6.1 | 7.4 | 7.4 | 7.2 | 7.2 | 7.5 | 7.0 | 7.0 | 7.1 |
| K₂O | 0.5 | 1.0 | 2.1 | 2.6 | 2.6 | | 2.5 | 2.2 | 2.2 | 2.2 | 2.1 |
| B₂O₃ | 3.5 | 2.0 | | 3.0 | 1.0 | | | | | | |
| TiO₂ | 2.0 | 2.0 | | 2.0 | 3.0 | | | | | | |
| ZrO₂ | 2.5 | 4.5 | 2.6 | 3.2 | 3.4 | 3.1 | 3.5 | 3.0 | 3.7 | 4.0 | 2.6 |
| P₂O₅ | 2.0 | 2.5 | 2.1 | 2.6 | 2.6 | 2.5 | 2.5 | 2.5 | 2.6 | 2.1 | 2.1 |
| Y₂O₃ | | | | | | | | | | | |
| Nb₂O₅ | | | | | | | | | | | |
| Ta₂O₅ | | | | | | | | | | | |
| La₂O₃ | | | | | | | | | | | |
| Sb₂O₃ | 0.4 | 0.5 | 0.4 | 0.5 | 0.5 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 99.9 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 720 | 720 | 720 | 720 | 720 | 720 | 720 | 720 | 720 | 720 | 720 |
| Growing | | | | | | | | | | | |
| Temperature??? | | | | | | | | | | | |
| Nucleous | 10 | 10 | 10 | 10 | 10 | 10 | 10 | 10 | 10 | 10 | 10 |
| Growing | | | | | | | | | | | |
| Time?hr? | | | | | | | | | | | |
| Main Crystalline | LZS | Quartz | Crist | Crist | Crist | Crist | Crist | Crist | Crist | Crist | Crist |
| Phase | | | | | | | | | | | |
| Sub Crystalline | — | Crist | LZS | Quartz | Quartz | LZS | LZS | LZS | LZS | LZS | LZS |
| Phase | | | | | | | | | | | |
| Specific | 2.65 | 2.67 | 2.64 | 2.65 | 2.63 | 2.57 | 2.57 | 2.55 | 2.51 | 2.52 | 2.65 |
| Gravity?g/cm³ | | | | | | | | | | | |
| Yong's Modulus | 85.9 | 85.4 | 83.4 | 79.5 | 79.7 | 82.0 | 81.9 | 79.0 | 81.0 | 82.7 | 81.5 |
| E??Pa | | | | | | | | | | | |
| Elastic Modulus | 32.4 | 32.0 | 31.5 | 30.0 | 30.3 | 31.9 | 31.8 | 30.9 | 32.2 | 32.8 | 30.7 |
| Ratio | | | | | | | | | | | |
| C.T.E | 71 | 109 | 81 | 107 | 105 | 88 | 91 | 87 | 84 | 110 | 97 |
| Amount of | 48 | 56 | 50 | 55 | 55 | 51 | 52 | 51 | 51 | 56 | 53 |
| Migration of | | | | | | | | | | | |
| alkali metal | | | | | | | | | | | |
| [ppb] | | | | | | | | | | | |
| P/Pli | 1.1 | 1.3 | 1.2 | 1.2 | 1.2 | 1.2 | 1.2 | 1.2 | 1.2 | 1.3 | 1.2 |

TABLE 78

| | B-108 | B-109 | B-110 | B-111 | B-112 | B-113 | B-114 | B-115 | B-116 | B-117 |
|---|---|---|---|---|---|---|---|---|---|---|
| SiO₂ | 60.0 | 63.0 | 63.9 | 63.0 | 58.0 | 61.0 | 60.0 | 62.0 | 64.0 | 64.0 |
| Bl₂O₃ | 5.5 | 6.0 | 7.6 | 9.0 | 6.5 | 5.0 | 6.0 | 7.1 | 7.6 | 8.0 |
| MgO | 1.0 | 2.0 | 2.0 | 2.0 | 2.4 | 2.3 | 1.6 | 2.1 | 2.0 | 2.1 |
| CaO | 1.0 | 0.8 | 0.9 | 0.9 | | 1.1 | 2.0 | 2.0 | | 2.0 |
| BaO | 1.0 | 2.5 | 2.5 | 2.0 | 2.5 | 2.0 | | | 2.5 | |
| SrO | | | | | 2.0 | | 1.5 | | 1.7 | |
| ZnO | 20.0 | 10.0 | 9.8 | 8.0 | 9.0 | 11.0 | 10.0 | 6.4 | 8.5 | 6.5 |
| Li₂O | 6.0 | 4.0 | 6.1 | 8.0 | 7.1 | 7.0 | 6.9 | 7.0 | 6.6 | 7.0 |
| K₂O | | 2.1 | 2.1 | 1.5 | 2.5 | 2.0 | 2.4 | 2.5 | 2.1 | 2.2 |
| B₂O₃ | 1.0 | 2.0 | | | 3.0 | 3.0 | 1.0 | 3.0 | | 1.0 |
| TiO₂ | 1.0 | 2.0 | | | 3.0 | | 1.0 | 3.0 | | |
| ZrO₂ | 1.0 | 3.0 | 2.6 | 3.0 | 1.1 | 3.2 | 5.0 | 3.5 | 2.6 | 3.7 |
| P₂O₅ | 2.1 | 2.1 | 2.1 | 2.1 | 2.5 | 2.0 | 2.2 | 1.0 | 2.1 | 3.0 |
| Y₂O₃ | | | | | | | | | | |
| Nb₂O₅ | | | | | | | | | | |
| Ta₂O₅ | | | | | | | | | | |
| La₂O₃ | | | | | | | | | | |
| Sb₂O₃ | 0.4 | 0.4 | 0.4 | 0.4 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 720 | 720 | 720 | 720 | 720 | 720 | 720 | 720 | 720 | 720 |
| Temperature??? | | | | | | | | | | |
| Nucleous Growing | 10 | 10 | 10 | 10 | 10 | 10 | 10 | 10 | 10 | 10 |
| Time?hr? | | | | | | | | | | |
| Main Crystalline | LZS | Quartz | LZS | Crist | Quartz | Quartz | Quartz | Quartz | Crist | Crist |
| Phase | | | | | | | | | | |
| Sub Crystalline | — | Crist | — | LZS | Crist | Crist | Crist | Crist | LZS | Quartz |
| Phase | | | | | | | | | | |
| Specific | 2.70 | 2.77 | 2.56 | 2.54 | 2.70 | 2.66 | 2.72 | 2.67 | 2.52 | 2.59 |
| Gravity?g/cm³ | | | | | | | | | | |
| Yong's Modulus | 84.2 | 88.4 | 85.5 | 82.7 | 84.7 | 82.5 | 86.3 | 85.2 | 82.5 | 80.9 |
| E??Pa | | | | | | | | | | |
| Elastic Modulus | 31.1 | 31.9 | 33.3 | 32.5 | 31.4 | 31.0 | 31.7 | 31.9 | 32.7 | 31.2 |
| Ratio | | | | | | | | | | |
| C.T.E | 69 | 109 | 68 | 90 | 114 | 116 | 112 | 109 | 79 | 121 |
| Amount of | 48 | 56 | 47 | 52 | 57 | 57 | 57 | 56 | 50 | 58 |
| Migration of alkali | | | | | | | | | | |
| metal [ppb] | | | | | | | | | | |
| P/Pli | 1.1 | 1.3 | 1.1 | 1.2 | 1.3 | 1.3 | 1.3 | 1.3 | 1.1 | 1.3 |

Tables 79 and 80 show the glass compositions in % by weight of respective crystallized glass substrates of B-118 to 138, together with the manufacturing conditions employed. Tables 81 and 82 show crystallized glass substrates as B-139 to 159 manufactured using the same glass compositions as those of B-118 to 138 with the nucleus growing temperature varied from that employed for B-118 to 138. Further, Tables 83 and 84 show crystallized glass substrates as B-160 to 180 manufactured using the same glass compositions as those of B-118 to 138 with the nucleus growing time varied from that employed for B-118 to 138.

TABLE 79

| | B-118 | B-119 | B-120 | B-121 | B-122 | B-123 | B-124 | B-125 | B-126 | B-127 | B-128 |
|---|---|---|---|---|---|---|---|---|---|---|---|
| SiO₂ | 55.0 | 60.0 | 65.0 | 63.1 | 63.0 | 63.6 | 63.0 | 61.3 | 64.0 | 64.0 | 63.0 |
| Bl₂O₃ | 7.0 | 5.0 | 4.5 | 3.0 | 5.0 | 9.0 | 9.0 | 8.7 | 8.0 | 7.6 | 6.0 |
| MgO | 3.0 | 2.5 | 2.5 | 2.5 | 2.5 | 2.4 | 2.0 | | 0.5 | 2.5 | 1.0 |
| CaO | 2.0 | 2.0 | 2.0 | 2.0 | 2.0 | 2.2 | 0.5 | 3.2 | 5.0 | 1.0 | 1.0 |
| BaO | 2.0 | 1.0 | 3.0 | 3.0 | 2.3 | | 1.0 | 2.9 | | 2.5 | 1.5 |
| SrO | | | | | | | 2.0 | 2.0 | | 1.7 | |
| ZnO | 13.0 | 10.0 | 7.0 | 7.2 | 7.0 | 7.0 | 6.4 | 6.8 | 6.5 | 5.0 | 15.0 |
| Li₂O | 7.0 | 7.0 | 7.5 | 7.4 | 7.5 | 7.3 | 7.2 | 7.0 | 7.0 | 7.0 | 6.0 |
| K₂O | 0.5 | 1.0 | 2.5 | 2.6 | 2.6 | 2.5 | 2.5 | 2.4 | 2.2 | 2.2 | |
| B₂O₃ | 3.5 | 2.0 | | 1.0 | 1.0 | | | | | | 1.0 |
| TiO₂ | 2.0 | 2.0 | | 2.0 | | | | | | | 2.0 |
| ZrO₂ | 2.5 | 4.5 | 3.0 | 3.2 | 4.1 | 3.1 | 3.5 | 3.0 | 3.7 | 4.0 | 1.0 |
| P₂O₅ | 2.0 | 2.5 | 2.5 | 2.6 | 2.6 | 2.5 | 2.5 | 2.4 | 2.6 | 2.1 | 2.1 |
| Y₂O₃ | | | | | | | | | | | |
| Nb₂O₅ | | | | | | | | | | | |
| Ta₂O₅ | | | | | | | | | | | |
| La₂O₃ | | | | | | | | | | | |
| Sb₂O₃ | 0.4 | 0.5 | 0.5 | 0.5 | 0.5 | 0.5 | 0.4 | 0.5 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 720 | 720 | 720 | 720 | 720 | 720 | 720 | 720 | 720 | 720 | 720 |
| Growing | | | | | | | | | | | |
| Temperature??? | | | | | | | | | | | |
| Nucleous | 3 | 3 | 3 | 3 | 3 | 3 | 3 | 3 | 3 | 3 | 3 |
| Growing | | | | | | | | | | | |
| Time?hr? | | | | | | | | | | | |
| Main Crystalline | LZS | Quartz | Crist | Crist | Crist | Crist | Crist | Quartz | Quartz | Crist | LZS |
| Phase | | | | | | | | | | | |
| Sub Crystalline | — | Crist | LZS | LZS | LZS | LZS | LZS | Crist | Crist | LZS | — |
| Phase | | | | | | | | | | | |
| Specific | 2.66 | 2.68 | 2.57 | 2.57 | 2.54 | 2.58 | 2.56 | 2.64 | 2.62 | 2.58 | 2.68 |
| Gravity?g/cm³ | | | | | | | | | | | |
| Yong's Modulus | 86.2 | 82.7 | 79.3 | 78.9 | 78.0 | 79.7 | 83.0 | 88.2 | 87.0 | 81.2 | 83.4 |
| E??Pa | | | | | | | | | | | |
| Elastic Modulus | 32.4 | 30.9 | 30.9 | 30.7 | 30.7 | 30.9 | 32.4 | 33.4 | 33.2 | 31.5 | 31.1 |
| Ratio | | | | | | | | | | | |
| C.T.E | 64 | 98 | 89 | 83 | 87 | 72 | 81 | 90 | 87 | 98 | 66 |
| Amount of | 52 | 62 | 61 | 59 | 60 | 55 | 58 | 59 | 59 | 62 | 50 |
| Migration of | | | | | | | | | | | |
| alkali metal | | | | | | | | | | | |
| [ppb] | | | | | | | | | | | |
| P/Pli | 1.0 | 1.1 | 1.1 | 1.1 | 1.1 | 1.0 | 1.1 | 1.1 | 1.1 | 1.1 | 1.1 |

TABLE 80

| | B-129 | B-130 | B-131 | B-132 | B-133 | B-134 | B-135 | B-136 | B-137 | B-138 |
|---|---|---|---|---|---|---|---|---|---|---|
| SiO₂ | 60.0 | 63.0 | 63.0 | 63.0 | 63.0 | 62.4 | 62.0 | 62.0 | 60.0 | 64.0 |
| Bl₂O₃ | 5.5 | 6.0 | 6.0 | 9.0 | 6.5 | 8.9 | 6.0 | 7.1 | 7.8 | 8.0 |
| MgO | 1.0 | 2.0 | 2.0 | 2.0 | 2.4 | 2.3 | 1.6 | 2.1 | 2.1 | 2.1 |
| CaO | 1.0 | 0.8 | 0.9 | 0.9 | 1.0 | 1.1 | 2.0 | 2.0 | 2.7 | 2.0 |
| BaO | 1.0 | 2.5 | 2.3 | 2.0 | 2.5 | 2.9 | | | | |
| SrO | | | | | 2.0 | | 1.5 | | | |
| ZnO | 20.0 | 10.0 | 10.0 | 8.0 | 6.0 | 6.9 | 10.0 | 6.4 | 6.2 | 6.5 |
| Li₂O | 6.0 | 4.0 | 6.1 | 8.0 | 7.1 | 7.1 | 6.9 | 7.0 | 7.5 | 7.0 |
| K₂O | | 2.1 | 2.1 | 1.5 | 2.5 | 2.4 | 2.4 | 2.5 | 2.2 | 2.2 |
| B₂O₃ | 1.0 | 2.0 | 2.0 | | | | | 3.0 | 3.0 | 1.0 |
| TiO₂ | 1.0 | 2.0 | | | 3.0 | | | 3.0 | 3.0 | |
| ZrO₂ | 1.0 | 3.0 | 3.0 | 3.0 | 1.1 | 3.0 | 5.0 | 3.5 | 3.0 | 3.7 |
| P₂O₅ | 2.1 | 2.1 | 2.1 | 2.1 | 2.5 | 2.4 | 2.2 | 1.0 | 2.0 | 3.0 |
| Y₂O₃ | | | | | | | | | | |
| Nb₂O₅ | | | | | | | | | | |
| Ta₂O₅ | | | | | | | | | | |
| La₂O₃ | | | | | | | | | | |
| Sb₂O₃ | 0.4 | 0.4 | 0.4 | 0.4 | 0.5 | 0.5 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 720 | 720 | 720 | 720 | 720 | 720 | 720 | 720 | 720 | 720 |
| Temperature??? | | | | | | | | | | |
| Nucleous Growing | 3 | 3 | 3 | 3 | 3 | 3 | 3 | 3 | 3 | 3 |
| Time?hr? | | | | | | | | | | |
| Main Crystalline | LZS | Quartz | LZS | Crist | Crist | Crist | LZS | Quartz | Quartz | Crist |
| Phase | | | | | | | | | | |
| Sub Crystalline | — | Crist | Crist | LZS | LZS | LZS | — | Crist | Crist | Quartz |
| Phase | | | | | | | | | | |
| Specific | 2.72 | 2.76 | 2.55 | 2.53 | 2.58 | 2.55 | 2.63 | 2.66 | 2.68 | 2.58 |
| Gravity?g/cm³ | | | | | | | | | | |
| Yong's Modulus | 84.6 | 85.9 | 81.3 | 80.1 | 84.2 | 83.7 | 87.6 | 82.8 | 83.2 | 78.6 |
| E??Pa | | | | | | | | | | |
| Elastic Modulus | 31.1 | 31.1 | 31.9 | 31.7 | 32.6 | 32.8 | 33.3 | 31.1 | 31.0 | 30.5 |
| Ratio | | | | | | | | | | |
| C.T.E | 62 | 98 | 78 | 81 | 86 | 83 | 67 | 98 | 92 | 119 |
| Amount of | 49 | 49 | 53 | 60 | 59 | 58 | 52 | 62 | 62 | 68 |
| Migration of alkali | | | | | | | | | | |
| metal [ppb] | | | | | | | | | | |
| P/Pli | 1.0 | 1.3 | 1.1 | 1.1 | 1.1 | 1.1 | 1.0 | 1.1 | 1.1 | 1.2 |

TABLE 81

| | B-139 | B-140 | B-141 | B-142 | B-143 | B-144 | B-145 | B-146 | B-147 | B-148 | B-149 |
|---|---|---|---|---|---|---|---|---|---|---|---|
| SiO₂ | 55.0 | 60.0 | 65.0 | 63.1 | 63.0 | 63.6 | 63.0 | 61.3 | 64.0 | 64.0 | 63.0 |
| Bl₂O₃ | 7.0 | 5.0 | 4.5 | 3.0 | 5.0 | 9.0 | 9.0 | 8.7 | 8.0 | 7.6 | 6.0 |
| MgO | 3.0 | 2.5 | 2.5 | 2.5 | 2.5 | 2.4 | 2.0 | | 0.5 | 2.5 | 1.0 |
| CaO | 2.0 | 2.0 | 2.0 | 2.0 | 2.0 | 2.2 | 0.5 | 3.2 | 5.0 | 1.0 | 1.0 |
| BaO | 2.0 | 1.0 | 3.0 | 3.0 | 2.3 | | 1.0 | 2.9 | | 2.5 | 1.5 |
| SrO | | | | | | | 2.0 | 2.0 | | 1.7 | |
| ZnO | 13.0 | 10.0 | 7.0 | 7.2 | 7.0 | 7.0 | 6.4 | 6.8 | 6.5 | 5.0 | 15.0 |
| Li₂O | 7.0 | 7.0 | 7.5 | 7.4 | 7.5 | 7.3 | 7.2 | 7.0 | 7.0 | 7.0 | 6.0 |
| K₂O | 0.5 | 1.0 | 2.5 | 2.6 | 2.6 | 2.5 | 2.5 | 2.4 | 2.2 | 2.2 | |
| B₂O₃ | 3.5 | 2.0 | | 1.0 | 1.0 | | | | | | 1.0 |
| TiO₂ | 2.0 | 2.0 | | 2.0 | | | | | | | 2.0 |
| ZrO₂ | 2.5 | 4.5 | 3.0 | 3.2 | 4.1 | 3.1 | 3.5 | 3.0 | 3.7 | 4.0 | 1.0 |
| P₂O₅ | 2.0 | 2.5 | 2.5 | 2.6 | 2.6 | 2.5 | 2.5 | 2.4 | 2.6 | 2.1 | 2.1 |
| Y₂O₃ | | | | | | | | | | | |
| Nb₂O₅ | | | | | | | | | | | |
| Ta₂O₅ | | | | | | | | | | | |
| La₂O₃ | | | | | | | | | | | |
| Sb₂O₃ | 0.4 | 0.5 | 0.5 | 0.5 | 0.5 | 0.5 | 0.4 | 0.5 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 750 | 750 | 750 | 750 | 750 | 750 | 750 | 750 | 750 | 750 | 750 |
| Growing | | | | | | | | | | | |
| Temperature??? | | | | | | | | | | | |
| Nucleous | 3 | 3 | 3 | 3 | 3 | 3 | 3 | 3 | 3 | 3 | 3 |
| Growing | | | | | | | | | | | |
| Time?hr? | | | | | | | | | | | |
| Main Crystalline | LZS | Quartz | Crist | Crist | LZS | Crist | Crist | Quartz | Quartz | Crist | LZS |
| Phase | | | | | | | | | | | |
| Sub Crystalline | Crist | Crist | LZS | Quartz | Crist | LZS | LZS | Crist | Crist | LZS | Crist |
| Phase | | | | | | | | | | | |
| Specific | 2.65 | 2.70 | 2.56 | 2.59 | 2.63 | 2.51 | 2.54 | 2.65 | 2.63 | 2.57 | 2.67 |
| Gravity?g/cm³ | | | | | | | | | | | |
| Yong's Modulus | 85.9 | 86.2 | 81.1 | 80.3 | 84.1 | 84.2 | 83.8 | 89.0 | 87.5 | 80.9 | 83.1 |
| E??Pa | | | | | | | | | | | |
| Elastic Modulus | 32.4 | 31.9 | 31.6 | 31.0 | 31.9 | 33.5 | 33.0 | 33.6 | 33.3 | 31.4 | 31.1 |
| Ratio | | | | | | | | | | | |
| C.T.E | 78 | 108 | 91 | 86 | 78 | 82 | 84 | 92 | 89 | 98 | 73 |
| Amount of | 49 | 56 | 52 | 51 | 49 | 50 | 51 | 52 | 52 | 54 | 48 |
| Migration of | | | | | | | | | | | |
| alkali metal | | | | | | | | | | | |
| [ppb] | | | | | | | | | | | |
| P/Pli | 1.1 | 1.3 | 1.2 | 1.2 | 1.1 | 1.2 | 1.2 | 1.2 | 1.2 | 1.2 | 1.1 |

TABLE 82

| | B-150 | B-151 | B-152 | B-153 | B-154 | B-155 | B-156 | B-157 | B-158 | B-159 |
|---|---|---|---|---|---|---|---|---|---|---|
| SiO₂ | 60.0 | 63.0 | 63.0 | 63.0 | 63.0 | 62.4 | 62.0 | 62.0 | 60.0 | 64.0 |
| Bl₂O₃ | 5.5 | 6.0 | 6.0 | 9.0 | 6.5 | 8.9 | 6.0 | 7.1 | 7.8 | 8.0 |
| MgO | 1.0 | 2.0 | 2.0 | 2.0 | 2.4 | 2.3 | 1.6 | 2.1 | 2.1 | 2.1 |
| CaO | 1.0 | 0.8 | 0.9 | 0.9 | 1.0 | 1.1 | 2.0 | 2.0 | 2.7 | 2.0 |
| BaO | 1.0 | 2.5 | 2.3 | 2.0 | 2.5 | 2.9 | | | | |
| SrO | | | | | 2.0 | | 1.5 | | | |
| ZnO | 20.0 | 10.0 | 10.0 | 8.0 | 6.0 | 6.9 | 10.0 | 6.4 | 6.2 | 6.5 |
| Li₂O | 6.0 | 4.0 | 6.1 | 8.0 | 7.1 | 7.1 | 6.9 | 7.0 | 7.5 | 7.0 |
| K₂O | | 2.1 | 2.1 | 1.5 | 2.5 | 2.4 | 2.4 | 2.5 | 2.2 | 2.2 |
| B₂O₃ | 1.0 | 2.0 | 2.0 | | | | | 3.0 | 3.0 | 1.0 |
| TiO₂ | 1.0 | 2.0 | | | 3.0 | | | 3.0 | 3.0 | |
| ZrO₂ | 1.0 | 3.0 | 3.0 | 3.0 | 1.1 | 3.0 | 5.0 | 3.5 | 3.0 | 3.7 |
| P₂O₅ | 2.1 | 2.1 | 2.1 | 2.1 | 2.5 | 2.4 | 2.2 | 1.0 | 2.0 | 3.0 |
| Y₂O₃ | | | | | | | | | | |
| Nb₂O₅ | | | | | | | | | | |
| Ta₂O₅ | | | | | | | | | | |
| La₂O₃ | | | | | | | | | | |
| Sb₂O₃ | 0.4 | 0.4 | 0.4 | 0.4 | 0.5 | 0.5 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 750 | 750 | 750 | 750 | 750 | 750 | 750 | 750 | 750 | 750 |
| Temperature??? | | | | | | | | | | |
| Nucleous Growing | 3 | 3 | 3 | 3 | 3 | 3 | 3 | 3 | 3 | 3 |
| Time?hr? | | | | | | | | | | |
| Main Crystalline | LZS | Quartz | Crist | Crist | Crist | Crist | LZS | Quartz | Quartz | Quartz |
| Phase | | | | | | | | | | |
| Sub Crystalline | — | LAS | LZS | LZS | LZS | LZS | Crist | LAS | LAS | Crist |
| Phase | | | | | | | | | | |
| Specific | 2.71 | 2.78 | 2.54 | 2.52 | 2.57 | 2.54 | 2.62 | 2.68 | 2.70 | 2.60 |
| Gravity?g/cm³ | | | | | | | | | | |
| Yong's Modulus | 84.3 | 89.5 | 81.0 | 79.8 | 83.9 | 83.4 | 87.2 | 86.3 | 86.7 | 81.9 |
| E??Pa | | | | | | | | | | |
| Elastic Modulus | 31.1 | 32.2 | 31.8 | 31.6 | 32.6 | 32.8 | 33.3 | 32.2 | 32.1 | 31.5 |
| Ratio | | | | | | | | | | |
| C.T.E | 70 | 108 | 82 | 84 | 88 | 86 | 74 | 108 | 105 | 119 |
| Amount of | 48 | 56 | 50 | 51 | 52 | 51 | 48 | 56 | 55 | 58 |
| Migration of alkali | | | | | | | | | | |
| metal [ppb] | | | | | | | | | | |
| P/Pli | 1.1 | 1.3 | 1.2 | 1.2 | 1.2 | 1.2 | 1.1 | 1.3 | 1.2 | 1.3 |

TABLE 83

| | B-160 | B-161 | B-162 | B-163 | B-164 | B-165 | B-166 | B-167 | B-168 | B-169 | B-170 |
|---|---|---|---|---|---|---|---|---|---|---|---|
| SiO₃ | 55.0 | 60.0 | 65.0 | 63.1 | 63.0 | 63.6 | 63.0 | 61.3 | 64.0 | 64.0 | 63.0 |
| Bl₂O₃ | 7.0 | 5.0 | 4.5 | 3.0 | 5.0 | 9.0 | 9.0 | 8.7 | 8.0 | 7.6 | 6.0 |
| MgO | 3.0 | 2.5 | 2.5 | 2.5 | 2.5 | 2.4 | 2.0 | | 0.5 | 2.5 | 1.0 |
| CaO | 2.0 | 2.0 | 2.0 | 2.0 | 2.0 | 2.2 | 0.5 | 3.2 | 5.0 | 1.0 | 1.0 |
| BaO | 2.0 | 1.0 | 3.0 | 3.0 | 2.3 | | 1.0 | 2.9 | | 2.5 | 1.5 |
| SrO | | | | | | | 2.0 | 2.0 | | 1.7 | |
| ZnO | 13.0 | 10.0 | 7.0 | 7.2 | 7.0 | 7.0 | 6.4 | 6.8 | 6.5 | 5.0 | 15.0 |
| Li₂O | 7.0 | 7.0 | 7.5 | 7.4 | 7.5 | 7.3 | 7.2 | 7.0 | 7.0 | 7.0 | 6.0 |
| K₂O | 0.5 | 1.0 | 2.5 | 2.6 | 2.6 | 2.5 | 2.5 | 2.4 | 2.2 | 2.2 | |
| B₂O₃ | 3.5 | 2.0 | | 1.0 | 1.0 | | | | | | 1.0 |
| TiO₂ | 2.0 | 2.0 | | 2.0 | | | | | | | 2.0 |
| ZrO₂ | 2.5 | 4.5 | 3.0 | 3.2 | 4.1 | 3.1 | 3.5 | 3.0 | 3.7 | 4.0 | 1.0 |
| P₂O₅ | 2.0 | 2.5 | 2.5 | 2.6 | 2.6 | 2.5 | 2.5 | 2.4 | 2.6 | 2.1 | 2.1 |
| Y₂O₃ | | | | | | | | | | | |
| Nb₂O₅ | | | | | | | | | | | |
| Ta₂O₅ | | | | | | | | | | | |
| La₂O₃ | | | | | | | | | | | |
| Sb₂O₃ | 0.4 | 0.5 | 0.5 | 0.5 | 0.5 | 0.5 | 0.4 | 0.5 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 720 | 720 | 720 | 720 | 720 | 720 | 720 | 720 | 720 | 720 | 720 |
| Growing | | | | | | | | | | | |
| Temperature??? | | | | | | | | | | | |
| Nucleous | 10 | 10 | 10 | 10 | 10 | 10 | 10 | 10 | 10 | 10 | 10 |
| Growing | | | | | | | | | | | |
| Time?hr? | | | | | | | | | | | |
| Main Crystalline | LZS | Quartz | Crist | Crist | Crist | Crist | Crist | Quartz | Quartz | Crist | LZS |
| Phase | | | | | | | | | | | |
| Sub Crystalline | — | Crist | LZS | LZS | LZS | LZS | LZS | Crist | Crist | LZS | — |
| Phase | | | | | | | | | | | |
| Specific | 2.65 | 2.69 | 2.56 | 2.56 | 2.53 | 2.57 | 2.55 | 2.65 | 2.63 | 2.57 | 2.67 |
| Gravity?g/cm³ | | | | | | | | | | | |
| Yong's Modulus | 85.9 | 85.1 | 79.0 | 78.6 | 77.7 | 79.4 | 82.7 | 88.3 | 87.3 | 80.9 | 83.1 |
| E??Pa | | | | | | | | | | | |
| Elastic Modulus | 32.4 | 31.6 | 30.8 | 30.7 | 30.7 | 30.9 | 32.4 | 33.3 | 33.2 | 31.4 | 31.1 |
| Ratio | | | | | | | | | | | |
| C.T.E | 71 | 109 | 91 | 85 | 89 | 77 | 84 | 91 | 89 | 98 | 72 |
| Amount of | 48 | 56 | 52 | 51 | 52 | 49 | 51 | 52 | 52 | 54 | 48 |
| Migration of | | | | | | | | | | | |
| alkali metal | | | | | | | | | | | |
| [ppb] | | | | | | | | | | | |
| P/Pli | 1.1 | 1.3 | 1.2 | 1.2 | 1.2 | 1.1 | 1.2 | 1.2 | 1.2 | 1.2 | 1.1 |

TABLE 84

| | B-171 | B-172 | B-173 | B-174 | B-175 | B-176 | B177 | B-178 | B-179 | B-180 |
|---|---|---|---|---|---|---|---|---|---|---|
| SiO₂ | 60.0 | 63.0 | 63.0 | 63.0 | 63.0 | 62.4 | 62.0 | 62.0 | 60.0 | 64.0 |
| Bl₂O₃ | 5.5 | 6.0 | 6.0 | 9.0 | 6.5 | 8.9 | 6.0 | 7.1 | 7.8 | 8.0 |
| MgO | 1.0 | 2.0 | 2.0 | 2.0 | 2.4 | 2.3 | 1.6 | 2.1 | 2.1 | 2.1 |
| CaO | 1.0 | 0.8 | 0.9 | 0.9 | 1.0 | 1.1 | 2.0 | 2.0 | 2.7 | 2.0 |
| BaO | 1.0 | 2.5 | 2.3 | 2.0 | 2.5 | 2.9 | | | | |
| SrO | | | | | 2.0 | | 1.5 | | | |
| ZnO | 20.0 | 10.0 | 10.0 | 8.0 | 6.0 | 6.9 | 10.0 | 6.4 | 6.2 | 6.5 |
| Li₂O | 6.0 | 4.0 | 6.1 | 8.0 | 7.1 | 7.1 | 6.9 | 7.0 | 7.5 | 7.0 |
| K₂O | | 2.1 | 2.1 | 1.5 | 2.5 | 2.4 | 2.4 | 2.5 | 2.2 | 2.2 |
| B₂O₃ | 1.0 | 2.0 | 2.0 | | | | | 3.0 | 3.0 | 1.0 |
| TiO₂ | 1.0 | 2.0 | | | 3.0 | | | 3.0 | 3.0 | |
| ZrO₂ | 1.0 | 3.0 | 3.0 | 3.0 | 1.1 | 3.0 | 5.0 | 3.5 | 3.0 | 3.7 |
| P₂O₅ | 2.1 | 2.1 | 2.1 | 2.1 | 2.5 | 2.4 | 2.2 | 1.0 | 2.0 | 3.0 |
| Y₂O₃ | | | | | | | | | | |
| Nb₂O₅ | | | | | | | | | | |
| Ta₂O₅ | | | | | | | | | | |
| La₂O₃ | | | | | | | | | | |
| Sb₂O₃ | 0.4 | 0.4 | 0.4 | 0.4 | 0.5 | 0.5 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 720 | 720 | 720 | 720 | 720 | 720 | 720 | 720 | 720 | 720 |
| Temperature??? | | | | | | | | | | |
| Nucleous Growing | 10 | 10 | 10 | 10 | 10 | 10 | 10 | 10 | 10 | 10 |
| Time?hr? | | | | | | | | | | |
| Main Crystalline | LZS | Quartz | Crist | Crist | Crist | Crist | LZS | Quartz | Quartz | Crist |
| Phase | | | | | | | | | | |
| Sub Crystalline | — | Crist | LZS | LZS | LZS | LZS | Crist | Crist | Crist | Quartz |
| Phase | | | | | | | | | | |
| Specific | 2.71 | 2.77 | 2.54 | 2.52 | 2.57 | 2.54 | 2.62 | 2.67 | 2.69 | 2.59 |
| Gravity?g/cm³ | | | | | | | | | | |
| Yong's Modulus | 84.3 | 88.4 | 81.0 | 79.8 | 83.9 | 83.4 | 87.3 | 85.2 | 85.7 | 80.9 |
| E??Pa | | | | | | | | | | |
| Elastic Modulus | 31.1 | 31.9 | 31.8 | 31.6 | 32.6 | 32.8 | 33.3 | 31.9 | 31.8 | 31.2 |
| Ratio | | | | | | | | | | |
| C.T.E | 69 | 109 | 81 | 84 | 88 | 85 | 73 | 109 | 106 | 121 |
| Amount of | 48 | 56 | 50 | 51 | 51 | 51 | 48 | 56 | 55 | 58 |
| Migration of alkali | | | | | | | | | | |
| metal [ppb] | | | | | | | | | | |
| P/Pli | 1.1 | 1.3 | 1.2 | 1.2 | 1.2 | 1.2 | 1.1 | 1.3 | 1.2 | 1.3 |

Tables 85 and 86 show the glass compositions in % by weight of respective crystallized glass substrates of B-181 to 201, together with the manufacturing conditions employed. Tables 87 and 88 show crystallized glass substrates as B-202 to 222 manufactured using the same glass compositions as those of B-181 to 201 with the nucleus growing temperature varied from that employed for B-181 to 201. Further, Tables 89 and 90 show crystallized glass substrates as B-223 to 243 manufactured using the same glass compositions as those of B-181 to 201 with the nucleus growing time varied from that employed for B-181 to 201.

TABLE 85

| | B-181 | B-182 | B-183 | B-184 | B-185 | B-186 | B-187 | B-188 | B-189 | B-190 | B-191 |
|---|---|---|---|---|---|---|---|---|---|---|---|
| SiO₂ | 55.0 | 60.0 | 64.9 | 61.0 | 60.0 | 63.0 | 63.0 | 63.4 | 64.0 | 65.0 | 63.0 |
| Bl₂O₃ | 7.0 | 6.0 | 8.1 | 3.0 | 5.0 | 10.0 | 9.0 | 9.0 | 8.0 | 7.6 | 6.0 |
| MgO | 3.0 | 2.5 | 2.1 | 2.5 | 1.0 | 2.5 | 2.0 | 2.4 | 0.5 | 2.5 | 1.0 |
| CaO | 2.0 | 1.0 | | | 2.0 | | 1.0 | | | | 1.0 |
| BaO | 2.0 | 1.0 | 2.7 | 3.0 | 2.3 | 3.0 | 0.5 | 3.0 | 5.0 | 2.5 | 1.5 |
| SrO | | | 1.8 | 2.1 | 1.8 | 2.0 | 2.0 | 2.0 | | 1.7 | |
| ZnO | 13.0 | 10.0 | 6.3 | 7.2 | 7.5 | 6.2 | 6.4 | 7.0 | 6.5 | 5.0 | 15.0 |
| Li₂O | 7.0 | 7.0 | 6.5 | 7.4 | 7.4 | 7.2 | 7.2 | 7.2 | 7.0 | 7.0 | 6.0 |
| K₂O | 0.5 | 1.0 | 2.2 | 2.6 | 2.6 | | 2.5 | | 2.2 | 2.2 | |
| B₂O₃ | 3.5 | 2.0 | | 3.0 | 1.0 | | | | | | 1.0 |
| TiO₂ | 2.0 | 2.0 | | 2.0 | 3.0 | | | | | | 2.0 |
| ZrO₂ | 2.5 | 4.5 | 2.8 | 3.2 | 3.4 | 3.1 | 3.5 | 3.1 | 3.7 | 4.0 | 1.0 |
| P₂O₅ | 2.0 | 2.5 | 2.2 | 2.6 | 2.6 | 2.5 | 2.5 | 2.5 | 2.6 | 2.1 | 2.1 |
| Y₂O₃ | | | | | | | | | | | |
| Nb₂O₅ | | | | | | | | | | | |
| Ta₂O₅ | | | | | | | | | | | |
| La₂O₃ | | | | | | | | | | | |
| Sb₂O₃ | 0.4 | 0.5 | 0.4 | 0.5 | 0.5 | 0.5 | 0.4 | 0.5 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 720 | 720 | 720 | 720 | 720 | 720 | 720 | 720 | 720 | 720 | 720 |
| Growing | | | | | | | | | | | |
| Temperature??? | | | | | | | | | | | |
| Nucleous | 3 | 3 | 3 | 3 | 3 | 3 | 3 | 3 | 3 | 3 | 3 |
| Growing | | | | | | | | | | | |
| Time?hr? | | | | | | | | | | | |
| Main Crystalline | LZS | Quartz | Crist | Quartz | Quartz | Crist | Crist | Crist | Crist | Crist | LZS |
| Phase | | | | | | | | | | | |
| Sub Crystalline | — | Crist | LZS | Crist | Crist | LZS | LZS | Quartz | LZS | LZS | — |
| Phase | | | | | | | | | | | |
| Specific | 2.66 | 2.66 | 2.57 | 2.66 | 2.64 | 2.51 | 2.55 | 2.61 | 2.65 | 2.63 | 2.66 |
| Gravity?g/cm³ | | | | | | | | | | | |
| Yong's Modulus | 86.2 | 83.0 | 79.0 | 79.8 | 80.0 | 82.1 | 78.9 | 77.2 | 77.8 | 78.2 | 83.1 |
| E??Pa | | | | | | | | | | | |
| Elastic Modulus | 32.4 | 31.2 | 30.7 | 30.0 | 30.3 | 32.7 | 30.9 | 29.6 | 29.4 | 29.7 | 31.2 |
| Ratio | | | | | | | | | | | |
| C.T.E | 64 | 98 | 96 | 93 | 88 | 83 | 83 | 109 | 107 | 105 | 66 |
| Amount of | 52 | 62 | 59 | 62 | 60 | 58 | 58 | 66 | 64 | 64 | 50 |
| Migration of | | | | | | | | | | | |
| alkali metal | | | | | | | | | | | |
| [ppb] | | | | | | | | | | | |
| P/Pli | 1.0 | 1.1 | 1.2 | 1.1 | 1.1 | 1.1 | 1.1 | 1.2 | 1.2 | 1.2 | 1.1 |

TABLE 86

| | B-192 | B-193 | B-194 | B-195 | B-196 | B-197 | B-198 | B-199 | B-200 | B-201 |
|---|---|---|---|---|---|---|---|---|---|---|
| SiO₂ | 60.0 | 63.0 | 63.0 | 63.0 | 58.0 | 61.0 | 60.0 | 62.0 | 62.1 | 64.0 |
| Bl₂O₃ | 5.5 | 6.0 | 6.0 | 9.0 | 6.5 | 5.0 | 6.0 | 6.1 | 8.8 | 8.0 |
| MgO | 1.0 | 2.0 | 2.0 | 2.0 | 2.4 | 2.3 | 1.6 | 2.1 | 2.3 | 2.1 |
| CaO | 1.0 | 0.8 | 0.9 | 0.9 | | 1.1 | | | | 2.0 |
| BaO | 1.0 | 2.5 | 2.3 | 2.0 | 2.5 | 2.0 | 2.0 | 3.0 | 2.9 | 2.0 |
| SrO | | | | | 2.0 | | 1.5 | | 2.0 | |
| ZnO | 20.0 | 10.0 | 10.0 | 8.0 | 9.0 | 11.0 | 10.0 | 6.4 | 6.9 | 6.5 |
| Li₂O | 6.0 | 4.0 | 6.1 | 8.0 | 7.1 | 7.0 | 6.9 | 7.0 | 7.1 | 7.0 |
| K₂O | | 2.1 | 2.1 | 1.5 | 2.5 | 2.0 | 2.4 | 2.5 | 2.4 | 2.2 |
| B₂O₃ | 1.0 | 2.0 | 2.0 | | 3.0 | 3.0 | 1.0 | 3.0 | | 1.0 |
| TiO₂ | 1.0 | 2.0 | | | 3.0 | | 1.0 | 3.0 | | |
| ZrO₂ | 1.0 | 3.0 | 3.0 | 3.0 | 1.1 | 3.2 | 5.0 | 3.5 | 3.0 | 3.7 |
| P₂O₅ | 2.1 | 2.1 | 2.1 | 2.1 | 2.5 | 2.0 | 2.2 | 1.0 | 1.9 | 3.0 |
| Y₂O₃ | | | | | | | | | | |
| Nb₂O₅ | | | | | | | | | | |
| Ta₂O₅ | | | | | | | | | | |
| La₂O₃ | | | | | | | | | | |
| Sb₂O₃ | 0.4 | 0.4 | 0.4 | 0.4 | 0.5 | 0.4 | 0.4 | 0.4 | 0.5 | 0.4 |
| Total (100 wt %) | 100.0 | 100.0 | 100.0 | 100.0 | 100.0 | 100.0 | 100.0 | 100.0 | 100.0 | 102.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 720 | 720 | 720 | 720 | 720 | 720 | 720 | 720 | 720 | 720 |
| Temperature??? | | | | | | | | | | |
| Nucleous Growing | 3 | 3 | 3 | 3 | 3 | 3 | 3 | 3 | 3 | 3 |
| Time?hr? | | | | | | | | | | |
| Main Crystalline | LZS | Quartz | Crist | Crist | Quartz | Quartz | Quartz | Quartz | LZS | Crist |
| Phase | | | | | | | | | | |
| Sub Crystalline | — | Crist | LZS | LZS | Crist | Crist | Crist | Crist | Crist | Quartz |
| Phase | | | | | | | | | | |
| Specific | 2.70 | 2.76 | 2.51 | 2.55 | 2.69 | 2.65 | 2.73 | 2.66 | 2.61 | 2.58 |
| Gravity?g/cm³ | | | | | | | | | | |
| Yong's Modulus | 84.4 | 85.9 | 81.6 | 84.0 | 82.3 | 80.1 | 83.2 | 82.8 | 84.8 | 78.6 |
| E??Pa | | | | | | | | | | |
| Elastic Modulus | 31.3 | 31.1 | 32.5 | 32.9 | 30.6 | 30.2 | 30.5 | 31.1 | 32.5 | 30.5 |
| Ratio | | | | | | | | | | |
| C.T.E | 62 | 98 | 98 | 73 | 108 | 112 | 102 | 98 | 76 | 119 |
| Amount of | 49 | 49 | 58 | 58 | 65 | 66 | 63 | 62 | 56 | 68 |
| Migration of alkali | | | | | | | | | | |
| metal [ppb] | | | | | | | | | | |
| P/Pli | 1.0 | 1.3 | 1.2 | 1.0 | 1.2 | 1.2 | 1.2 | 1.1 | 1.1 | 1.2 |

TABLE 87

| | B-202 | B-203 | B-204 | B-205 | B-206 | B-207 | B-208 | B-209 | B-210 | B-211 | B-212 |
|---|---|---|---|---|---|---|---|---|---|---|---|
| SiO₂ | 55.0 | 60.0 | 64.9 | 61.0 | 60.0 | 63.0 | 63.0 | 63.4 | 64.0 | 65.0 | 63.0 |
| Bl₂O₃ | 7.0 | 6.0 | 8.1 | 3.0 | 5.0 | 10.0 | 9.0 | 9.0 | 8.0 | 7.6 | 6.0 |
| MgO | 3.0 | 2.5 | 2.1 | 2.5 | 1.0 | 2.5 | 2.0 | 2.4 | 0.5 | 2.5 | 1.0 |
| CaO | 2.0 | 1.0 | | | 2.0 | | 1.0 | | | | 1.0 |
| BaO | 2.0 | 1.0 | 2.7 | 3.0 | 2.3 | 3.0 | 0.5 | 3.0 | 5.0 | 2.5 | 1.5 |
| SrO | | | 1.8 | 2.1 | 1.8 | 2.0 | 2.0 | 2.0 | | 1.7 | |
| ZnO | 13.0 | 10.0 | 6.3 | 7.2 | 7.5 | 6.2 | 6.4 | 7.0 | 6.5 | 5.0 | 15.0 |
| Li₂O | 7.0 | 7.0 | 6.5 | 7.4 | 7.4 | 7.2 | 7.2 | 7.2 | 7.0 | 7.0 | 6.0 |
| K₂O | 0.5 | 1.0 | 2.2 | 2.6 | 2.6 | | 2.5 | | 2.2 | 2.2 | |
| B₂O₃ | 3.5 | 2.0 | | 3.0 | 1.0 | | | | | | 1.0 |
| TiO₂ | 2.0 | 2.0 | | 2.0 | 3.0 | | | | | | 2.0 |
| ZrO₂ | 2.5 | 4.5 | 2.8 | 3.2 | 3.4 | 3.1 | 3.5 | 3.1 | 3.7 | 4.0 | 1.0 |
| P₂O₅ | 2.0 | 2.5 | 2.2 | 2.6 | 2.6 | 2.5 | 2.5 | 2.5 | 2.6 | 2.1 | 2.1 |
| Y₂O₃ | | | | | | | | | | | |
| Nb₂O₅ | | | | | | | | | | | |
| Ta₂O₅ | | | | | | | | | | | |
| La₂O₃ | | | | | | | | | | | |
| Sb₂O₃ | 0.4 | 0.5 | 0.4 | 0.5 | 0.5 | 0.5 | 0.4 | 0.5 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 750 | 750 | 750 | 750 | 750 | 750 | 750 | 750 | 750 | 750 | 750 |
| Growing | | | | | | | | | | | |
| Temperature??? | | | | | | | | | | | |
| Nucleous | 3 | 3 | 3 | 3 | 3 | 3 | 3 | 3 | 3 | 3 | 3 |
| Growing | | | | | | | | | | | |
| Time?hr? | | | | | | | | | | | |
| Main Crystalline | LZS | Quartz | Crist | Quartz | Quartz | Crist | Crist | Quartz | Quartz | Crist | LZS |
| Phase | | | | | | | | | | | |
| Sub Crystalline | Crist | Crist | LZS | Crist | Crist | LZS | LZS | Crist | Crist | LZS | Crist |
| Phase | | | | | | | | | | | |
| Specific | 2.65 | 2.68 | 2.56 | 2.68 | 2.66 | 2.50 | 2.54 | 2.63 | 2.64 | 2.62 | 2.65 |
| Gravity?g/cm³ | | | | | | | | | | | |
| Yong's Modulus | 85.9 | 86.5 | 78.7 | 83.2 | 83.4 | 81.8 | 78.6 | 78.9 | 77.5 | 77.9 | 82.8 |
| E??Pa | | | | | | | | | | | |
| Elastic Modulus | 32.4 | 32.3 | 30.7 | 31.0 | 31.3 | 32.7 | 30.9 | 30.0 | 29.3 | 29.7 | 31.2 |
| Ratio | | | | | | | | | | | |
| C.T.E | 78 | 108 | 97 | 106 | 104 | 86 | 86 | 108 | 106 | 104 | 73 |
| Amount of | 49 | 56 | 53 | 55 | 55 | 51 | 51 | 56 | 55 | 55 | 48 |
| Migration of | | | | | | | | | | | |
| alkali metal | | | | | | | | | | | |
| [ppb] | | | | | | | | | | | |
| P/Pli | 1.1 | 1.3 | 1.2 | 1.2 | 1.2 | 1.2 | 1.2 | 1.3 | 1.2 | 1.2 | 1.1 |

TABLE 88

| | B-213 | B-214 | B-215 | B-216 | B-217 | B-218 | B-219 | B-220 | B-221 | B-222 |
|---|---|---|---|---|---|---|---|---|---|---|
| SiO₂ | 60.0 | 63.0 | 63.0 | 63.0 | 58.0 | 61.0 | 60.0 | 62.0 | 62.1 | 64.0 |
| Bl₂O₃ | 5.5 | 6.0 | 6.0 | 9.0 | 6.5 | 5.0 | 6.0 | 6.1 | 8.8 | 8.0 |
| MgO | 1.0 | 2.0 | 2.0 | 2.0 | 2.4 | 2.3 | 1.6 | 2.1 | 2.3 | 2.1 |
| CaO | 1.0 | 0.8 | 0.9 | 0.9 | | 1.1 | | | | 2.0 |
| BaO | 1.0 | 2.5 | 2.3 | 2.0 | 2.5 | 2.0 | 2.0 | 3.0 | 2.9 | 2.0 |
| SrO | | | | | 2.0 | | 1.5 | | 2.0 | |
| ZnO | 20.0 | 10.0 | 10.0 | 8.0 | 9.0 | 11.0 | 10.0 | 6.4 | 6.9 | 6.5 |
| Li₂O | 6.0 | 4.0 | 6.1 | 8.0 | 7.1 | 7.0 | 6.9 | 7.0 | 7.1 | 7.0 |
| K₂O | | 2.1 | 2.1 | 1.5 | 2.5 | 2.0 | 2.4 | 2.5 | 2.4 | 2.2 |
| B₂O₃ | 1.0 | 2.0 | 2.0 | | 3.0 | 3.0 | 1.0 | 3.0 | | 1.0 |
| TiO₂ | 1.0 | 2.0 | | | 3.0 | | 1.0 | 3.0 | | |
| ZrO₂ | 1.0 | 3.0 | 3.0 | 3.0 | 1.1 | 3.2 | 5.0 | 3.5 | 3.0 | 3.7 |
| P₂O₅ | 2.1 | 2.1 | 2.1 | 2.1 | 2.5 | 2.0 | 2.2 | 1.0 | 1.9 | 3.0 |
| Y₂O₃ | | | | | | | | | | |
| Nb₂O₅ | | | | | | | | | | |
| Ta₂O₅ | | | | | | | | | | |
| La₂O₃ | | | | | | | | | | |
| Sb₂O₃ | 0.4 | 0.4 | 0.4 | 0.4 | 0.5 | 0.4 | 0.4 | 0.4 | 0.5 | 0.4 |
| Total (100 wt %) | 100.0 | 100.0 | 100.0 | 100.0 | 100.0 | 100.0 | 100.0 | 100.0 | 100.0 | 102.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 750 | 750 | 750 | 750 | 750 | 750 | 750 | 750 | 750 | 750 |
| Temperature??? | | | | | | | | | | |
| Nucleous Growing | 3 | 3 | 3 | 3 | 3 | 3 | 3 | 3 | 3 | 3 |
| Time?hr? | | | | | | | | | | |
| Main Crystalline | LZS | Quartz | LZS | Crist | Quartz | Quartz | Quartz | Quartz | Crist | Quartz |
| Phase | | | | | | | | | | |
| Sub Crystalline | — | LAS | Crist | LZS | LAS | LAS | LAS | LAS | LZS | Crist |
| Phase | | | | | | | | | | |
| Specific | 2.69 | 2.78 | 2.58 | 2.55 | 2.71 | 2.67 | 2.75 | 2.68 | 2.60 | 2.60 |
| Gravity?g/cm³ | | | | | | | | | | |
| Yong's Modulus | 84.1 | 89.5 | 80.9 | 79.8 | 85.8 | 83.5 | 86.7 | 86.3 | 84.5 | 81.9 |
| E??Pa | | | | | | | | | | |
| Elastic Modulus | 31.2 | 32.2 | 31.4 | 31.3 | 31.6 | 31.3 | 31.5 | 32.2 | 32.4 | 31.5 |
| Ratio | | | | | | | | | | |
| C.T.E | 70 | 108 | 78 | 78 | 113 | 115 | 110 | 108 | 80 | 119 |
| Amount of | 48 | 56 | 49 | 49 | 57 | 57 | 56 | 56 | 50 | 58 |
| Migration of | | | | | | | | | | |
| alkali metal | | | | | | | | | | |
| [ppb] | | | | | | | | | | |
| P/Pli | 1.1 | 1.3 | 1.1 | 1.1 | 1.3 | 1.3 | 1.3 | 1.3 | 1.2 | 1.3 |

TABLE 89

| | B-223 | B-224 | B-225 | B-226 | B-227 | B-228 | B-229 | B-230 | B-231 | B-232 | B-233 |
|---|---|---|---|---|---|---|---|---|---|---|---|
| SiO₂ | 55.0 | 60.0 | 64.9 | 61.0 | 60.0 | 63.0 | 63.0 | 63.4 | 64.0 | 65.0 | 63.0 |
| Bl₂O₃ | 7.0 | 6.0 | 8.1 | 3.0 | 5.0 | 10.0 | 9.0 | 9.0 | 8.0 | 7.6 | 6.0 |
| MgO | 3.0 | 2.5 | 2.1 | 2.5 | 1.0 | 2.5 | 2.0 | 2.4 | 0.5 | 2.5 | 1.0 |
| CaO | 2.0 | 1.0 | | | 2.0 | | 1.0 | | | | 1.0 |
| BaO | 2.0 | 1.0 | 2.7 | 3.0 | 2.3 | 3.0 | 0.5 | 3.0 | 5.0 | 2.5 | 1.5 |
| SrO | | | 1.8 | 2.1 | 1.8 | 2.0 | 2.0 | 2.0 | | 1.7 | |
| ZnO | 13.0 | 10.0 | 6.3 | 7.2 | 7.5 | 6.2 | 6.4 | 7.0 | 6.5 | 5.0 | 15.0 |
| Li₂O | 7.0 | 7.0 | 6.5 | 7.4 | 7.4 | 7.2 | 7.2 | 7.2 | 7.0 | 7.0 | 6.0 |
| K₂O | 0.5 | 1.0 | 2.2 | 2.6 | 2.6 | | 2.5 | | 2.2 | 2.2 | |
| B₂O₃ | 3.5 | 2.0 | | 3.0 | 1.0 | | | | | | 1.0 |
| TiO₂ | 2.0 | 2.0 | | 2.0 | 3.0 | | | | | | 2.0 |
| ZrO₂ | 2.5 | 4.5 | 2.8 | 3.2 | 3.4 | 3.1 | 3.5 | 3.1 | 3.7 | 4.0 | 1.0 |
| P₂O₅ | 2.0 | 2.5 | 2.2 | 2.6 | 2.6 | 2.5 | 2.5 | 2.5 | 2.6 | 2.1 | 2.1 |
| Y₂O₃ | | | | | | | | | | | |
| Nb₂O₅ | | | | | | | | | | | |
| Ta₂O₅ | | | | | | | | | | | |
| La₂O₃ | | | | | | | | | | | |
| Sb₂O₃ | 0.4 | 0.5 | 0.4 | 0.5 | 0.5 | 0.5 | 0.4 | 0.5 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 720 | 720 | 720 | 720 | 720 | 720 | 720 | 720 | 720 | 720 | 720 |
| Growing | | | | | | | | | | | |
| Temperature??? | | | | | | | | | | | |
| Nucleous | 10 | 10 | 10 | 10 | 10 | 10 | 10 | 10 | 10 | 10 | 10 |
| Growing | | | | | | | | | | | |
| Time?hr? | | | | | | | | | | | |
| Main Crystalline | LZS | Quartz | Crist | Crist | Crist | Crist | Crist | Crist | Crist | Crist | LZS |
| Phase | | | | | | | | | | | |
| Sub Crystalline | — | Crist | LZS | Quartz | Quartz | LZS | LZS | Quartz | Quartz | LZS | — |
| Phase | | | | | | | | | | | |
| Specific | 2.65 | 2.67 | 2.56 | 2.65 | 2.63 | 2.50 | 2.54 | 2.60 | 2.64 | 2.62 | 2.65 |
| Gravity?g/cm³ | | | | | | | | | | | |
| Yong's Modulus | 85.9 | 85.4 | 78.7 | 79.5 | 79.7 | 81.8 | 78.6 | 76.9 | 77.5 | 77.9 | 82.8 |
| E??Pa | | | | | | | | | | | |
| Elastic Modulus | 32.4 | 32.0 | 30.7 | 30.0 | 30.3 | 32.7 | 30.9 | 29.5 | 29.3 | 29.7 | 31.2 |
| Ratio | | | | | | | | | | | |
| C.T.E | 71 | 109 | 97 | 107 | 105 | 85 | 85 | 108 | 106 | 104 | 72 |
| Amount of | 48 | 56 | 53 | 55 | 55 | 51 | 51 | 56 | 55 | 55 | 48 |
| Migration of | | | | | | | | | | | |
| alkali metal | | | | | | | | | | | |
| [ppb] | | | | | | | | | | | |
| P/Pli | 1.1 | 1.3 | 1.2 | 1.2 | 1.2 | 1.2 | 1.2 | 1.3 | 1.2 | 1.2 | 1.1 |

TABLE 90

| | B-234 | B-235 | B-236 | B-237 | B-238 | B-239 | B-240 | B-241 | B-242 | B-243 |
|---|---|---|---|---|---|---|---|---|---|---|
| SiO₂ | 60.0 | 63.0 | 63.0 | 63.0 | 58.0 | 61.0 | 60.0 | 62.0 | 62.1 | 64.0 |
| Bl₂O₃ | 5.5 | 6.0 | 6.0 | 9.0 | 6.5 | 5.0 | 6.0 | 6.1 | 8.8 | 8.0 |
| MgO | 1.0 | 2.0 | 2.0 | 2.0 | 2.4 | 2.3 | 1.6 | 2.1 | 2.3 | 2.1 |
| CaO | 1.0 | 0.8 | 0.9 | 0.9 | | 1.1 | | | | 2.0 |
| BaO | 1.0 | 2.5 | 2.3 | 2.0 | 2.5 | 2.0 | 2.0 | 3.0 | 2.9 | 2.0 |
| SrO | | | | | 2.0 | | 1.5 | | 2.0 | |
| ZnO | 20.0 | 10.0 | 10.0 | 8.0 | 9.0 | 11.0 | 10.0 | 6.4 | 6.9 | 6.5 |
| Li₂O | 6.0 | 4.0 | 6.1 | 8.0 | 7.1 | 7.0 | 6.9 | 7.0 | 7.1 | 7.0 |
| K₂O | | 2.1 | 2.1 | 1.5 | 2.5 | 2.0 | 2.4 | 2.5 | 2.4 | 2.2 |
| B₂O₃ | 1.0 | 2.0 | 2.0 | | 3.0 | 3.0 | 1.0 | 3.0 | | 1.0 |
| TiO₂ | 1.0 | 2.0 | | | 3.0 | | 1.0 | 3.0 | | |
| ZrO₂ | 1.0 | 3.0 | 3.0 | 3.0 | 1.1 | 3.2 | 5.0 | 3.5 | 3.0 | 3.7 |
| P₂O₅ | 2.1 | 2.1 | 2.1 | 2.1 | 2.5 | 2.0 | 2.2 | 1.0 | 1.9 | 3.0 |
| Y₂O₃ | | | | | | | | | | |
| Nb₂O₅ | | | | | | | | | | |
| Ta₂O₅ | | | | | | | | | | |
| La₂O₃ | | | | | | | | | | |
| Sb₂O₃ | 0.4 | 0.4 | 0.4 | 0.4 | 0.5 | 0.4 | 0.4 | 0.4 | 0.5 | 0.4 |
| Total (100 wt %) | 100.0 | 100.0 | 100.0 | 100.0 | 100.0 | 100.0 | 100.0 | 100.0 | 100.0 | 102.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 720 | 720 | 720 | 720 | 720 | 720 | 720 | 720 | 720 | 720 |
| Temperature??? | | | | | | | | | | |
| Nucleous Growing | 10 | 10 | 10 | 10 | 10 | 10 | 10 | 10 | 10 | 10 |
| Time?hr? | | | | | | | | | | |
| Main Crystalline | LZS | Quartz | Crist | Crist | Quartz | Quartz | Quartz | Quartz | Crist | Crist |
| Phase | | | | | | | | | | |
| Sub Crystalline | — | Crist | LZS | LZS | Crist | Crist | Crist | Crist | LZS | Quartz |
| Phase | | | | | | | | | | |
| Specific | 2.69 | 2.77 | 2.50 | 2.54 | 2.70 | 2.66 | 2.74 | 2.67 | 2.60 | 2.59 |
| Gravity?g/cm³ | | | | | | | | | | |
| Yong's Modulus | 84.1 | 88.4 | 81.3 | 83.7 | 84.7 | 82.5 | 85.7 | 85.2 | 84.5 | 80.9 |
| E??Pa | | | | | | | | | | |
| Elastic Modulus | 31.2 | 31.9 | 32.5 | 32.9 | 31.4 | 31.0 | 31.2 | 31.9 | 32.4 | 31.2 |
| Ratio | | | | | | | | | | |
| C.T.E | 69 | 109 | 98 | 77 | 114 | 116 | 111 | 109 | 80 | 121 |
| Amount of | 48 | 56 | 54 | 49 | 57 | 57 | 56 | 56 | 50 | 58 |
| Migration of alkali | | | | | | | | | | |
| metal [ppb] | | | | | | | | | | |
| P/Pli | 1.1 | 1.3 | 1.2 | 1.1 | 1.3 | 1.3 | 1.3 | 1.3 | 1.1 | 1.3 |

Tables 91 and 92 show the glass compositions in % by weight of respective crystallized glass substrates of B-244 to 264, together with the manufacturing conditions employed. Tables 93 and 94 show crystallized glass substrates as B-265 to 285 manufactured using the same glass compositions as those of B-244 to 264 with the nucleus growing temperature varied from that employed for B-244 to 264. Further, Tables 95 and 96 show crystallized glass substrates as B-286 to 306 manufactured using the same glass compositions as those of B-244 to 264 with the nucleus growing time varied from that employed for B-244 to 264.

TABLE 91

| | B-244 | B-245 | B-246 | B-247 | B-248 | B-249 | B-250 | B-251 | B-252 | B-253 | B-254 |
|---|---|---|---|---|---|---|---|---|---|---|---|
| SiO₂ | 55.0 | 60.0 | 65.0 | 61.0 | 62.9 | 63.0 | 63.0 | 62.6 | 64.0 | 65.0 | 63.7 |
| Bl₂O₃ | 7.0 | 6.0 | 5.0 | 3.0 | 7.3 | 10.0 | 9.0 | 8.9 | 8.0 | 7.6 | 7.2 |
| MgO | 3.0 | 2.5 | 2.5 | 2.5 | 2.4 | 2.5 | 2.0 | 2.3 | 0.5 | 2.5 | 1.9 |
| CaO | 2.0 | 1.0 | 1.0 | | | | 2.0 | | | | |
| BaO | | | | 3.0 | 2.9 | 3.0 | 1.0 | 2.9 | | 2.5 | 2.4 |
| SrO | 2.0 | 3.0 | 2.0 | 2.1 | 2.0 | 2.0 | 0.5 | 2.0 | 5.0 | 1.7 | 1.6 |
| ZnO | 13.0 | 10.0 | 8.0 | 7.2 | 6.9 | 6.2 | 6.4 | 5.6 | 6.5 | 5.0 | 10.6 |
| Li₂O | 7.0 | 7.0 | 7.5 | 7.4 | 7.2 | 7.2 | 7.2 | 7.2 | 7.0 | 7.0 | 5.8 |
| K₂O | 0.5 | 1.0 | 2.5 | 2.6 | 2.5 | | 2.5 | 2.5 | 2.2 | 2.2 | 2.0 |
| B₂O₃ | 3.5 | 1.0 | | 3.0 | | | | | | | |
| TiO₂ | 2.0 | 1.0 | | 2.0 | | | | | | | |
| ZrO₂ | 2.5 | 4.5 | 3.0 | 3.2 | 3.1 | 3.1 | 3.5 | 3.1 | 3.7 | 4.0 | 2.5 |
| P₂O₅ | 2.0 | 2.5 | 3.0 | 2.6 | 2.5 | 2.5 | 2.5 | 2.5 | 2.6 | 2.1 | 2.0 |
| Y₂O₃ | | | | | | | | | | | |
| Nb₂O₅ | | | | | | | | | | | |
| Ta₂O₅ | | | | | | | | | | | |
| La₂O₃ | | | | | | | | | | | |
| Sb₂O₃ | 0.4 | 0.5 | 0.5 | 0.5 | 0.5 | 0.5 | 0.4 | 0.5 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 720 | 720 | 720 | 720 | 720 | 720 | 720 | 720 | 720 | 720 | 720 |
| Growing | | | | | | | | | | | |
| Temperature??? | | | | | | | | | | | |
| Nucleous | 3 | 3 | 3 | 3 | 3 | 3 | 3 | 3 | 3 | 3 | 3 |
| Growing | | | | | | | | | | | |
| Time?hr? | | | | | | | | | | | |
| Main Crystalline | LZS | Quartz | Crist | Quartz | Crist | Crist | Crist | Crist | Crist | Crist | LZS |
| Phase | | | | | | | | | | | |
| Sub Crystalline | — | Crist | LZS | Crist | LZS | LZS | LZS | LZS | LZS | LZS | — |
| Phase | | | | | | | | | | | |
| Specific | 2.65 | 2.64 | 2.59 | 2.66 | 2.60 | 2.55 | 2.51 | 2.57 | 2.58 | 2.57 | 2.62 |
| Gravity?g/cm³ | | | | | | | | | | | |
| Yong's Modulus | 86.5 | 81.2 | 79.0 | 79.8 | 80.2 | 80.4 | 83.1 | 82.6 | 82.9 | 77.9 | 83.8 |
| E??Pa | | | | | | | | | | | |
| Elastic Modulus | 32.6 | 30.8 | 30.5 | 30.0 | 30.8 | 31.5 | 33.1 | 32.1 | 32.1 | 30.3 | 32.0 |
| Ratio | | | | | | | | | | | |
| C.T.E | 64 | 92 | 97 | 93 | 103 | 92 | 83 | 86 | 88 | 102 | 61 |
| Amount of | 52 | 60 | 64 | 62 | 64 | 61 | 58 | 59 | 59 | 63 | 48 |
| Migration of | | | | | | | | | | | |
| alkali metal | | | | | | | | | | | |
| [ppb] | | | | | | | | | | | |
| P/Pli | 1.0 | 1.1 | 1.1 | 1.1 | 1.2 | 1.1 | 1.1 | 1.1 | 1.1 | 1.2 | 1.0 |

TABLE 92

| | B-255 | B-256 | B-257 | B-258 | B-259 | B-260 | B-261 | B-262 | B-263 | B-264 |
|---|---|---|---|---|---|---|---|---|---|---|
| SiO₂ | 60.0 | 63.0 | 62.1 | 63.0 | 62.0 | 61.8 | 63.0 | 64.0 | 63.9 | 64.0 |
| Bl₂O₃ | 5.0 | 8.0 | 8.8 | 9.0 | 6.5 | 8.8 | 8.0 | 6.0 | 7.2 | 6.0 |
| MgO | 1.0 | 2.0 | 2.3 | 2.0 | 2.4 | 2.3 | 1.6 | 2.1 | 1.9 | 2.1 |
| CaO | | 0.8 | | 0.9 | | | | 2.0 | | 1.0 |
| BaO | 1.0 | 2.5 | 2.9 | 2.0 | 2.5 | 2.9 | 2.0 | | 2.4 | |
| SrO | 1.5 | 2.0 | 2.0 | 2.0 | 2.0 | 2.0 | 2.0 | 2.0 | 1.6 | 1.5 |
| ZnO | 20.0 | 6.0 | 6.8 | 6.0 | 7.0 | 6.8 | 6.5 | 9.0 | 9.4 | 9.0 |
| Li₂O | 6.0 | 4.0 | 6.6 | 8.0 | 7.1 | 7.1 | 6.9 | 7.0 | 6.7 | 7.0 |
| K₂O | | 2.1 | 2.4 | 1.5 | 2.5 | 2.4 | 2.4 | 1.0 | 2.0 | 2.2 |
| B₂O₃ | 1.0 | 2.0 | | | 1.0 | | | 1.0 | | |
| TiO₂ | 1.0 | 2.0 | | | 3.0 | | | 1.0 | | |
| ZrO₂ | 1.0 | 3.0 | 3.0 | 3.0 | 1.1 | 3.0 | 5.0 | 3.5 | 2.5 | 3.7 |
| P₂O₅ | 2.1 | 2.1 | 2.4 | 2.1 | 2.5 | 2.4 | 2.2 | 1.0 | 2.0 | 3.0 |
| Y₂O₃ | | | | | | | | | | |
| Nb₂O₅ | | | | | | | | | | |
| Ta₂O₅ | | | | | | | | | | |
| La₂O₃ | | | | | | | | | | |
| Sb₂O₃ | 0.4 | 0.4 | 0.5 | 0.4 | 0.5 | 0.5 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 720 | 720 | 720 | 720 | 720 | 720 | 720 | 720 | 720 | 720 |
| Temperature??? | | | | | | | | | | |
| Nucleous Growing | 3 | 3 | 3 | 3 | 3 | 3 | 3 | 3 | 3 | 3 |
| Time?hr? | | | | | | | | | | |
| Main Crystalline | LZS | Quartz | Crist | Crist | Quartz | Crist | Crist | Quartz | LZS | LZS |
| Phase | | | | | | | | | | |
| Sub Crystalline | — | Crist | LZS | LZS | Crist | LZS | LZS | Crist | Crist | Crist |
| Phase | | | | | | | | | | |
| Specific | 2.72 | 2.68 | 2.59 | 2.55 | 2.65 | 2.60 | 2.63 | 2.61 | 2.63 | 2.59 |
| Gravity?g/cm³ | | | | | | | | | | |
| Yong's Modulus | 84.2 | 84.3 | 82.4 | 80.3 | 81.0 | 84.1 | 85.3 | 81.2 | 83.2 | 82.8 |
| E??Pa | | | | | | | | | | |
| Elastic Modulus | 31.0 | 31.5 | 31.8 | 31.5 | 30.6 | 32.3 | 32.4 | 31.1 | 31.6 | 32.0 |
| Ratio | | | | | | | | | | |
| C.T.E | 62 | 98 | 77 | 89 | 92 | 85 | 98 | 95 | 69 | 73 |
| Amount of | 49 | 49 | 54 | 63 | 60 | 58 | 61 | 61 | 53 | 54 |
| Migration of alkali | | | | | | | | | | |
| metal [ppb] | | | | | | | | | | |
| P/Pli | 1.0 | 1.3 | 1.1 | 1.1 | 1.1 | 1.1 | 1.1 | 1.1 | 1.0 | 1.1 |

TABLE 93

| | B-265 | B-266 | B-267 | B-268 | B-269 | B-270 | B-271 | B-272 | B-273 | B-274 | B-275 |
|---|---|---|---|---|---|---|---|---|---|---|---|
| SiO₂ | 55.0 | 60.0 | 65.0 | 61.0 | 62.9 | 63.0 | 63.0 | 62.6 | 64.0 | 65.0 | 63.7 |
| Bl₂O₃ | 7.0 | 6.0 | 5.0 | 3.0 | 7.3 | 10.0 | 9.0 | 8.9 | 8.0 | 7.6 | 7.2 |
| MgO | 3.0 | 2.5 | 2.5 | 2.5 | 2.4 | 2.5 | 2.0 | 2.3 | 0.5 | 2.5 | 1.9 |
| CaO | 2.0 | 1.0 | 1.0 | | | | 2.0 | | | | |
| BaO | | | | 3.0 | 2.9 | 3.0 | 1.0 | 2.9 | | 2.5 | 2.4 |
| SrO | 2.0 | 3.0 | 2.0 | 2.1 | 2.0 | 2.0 | 0.5 | 2.0 | 5.0 | 1.7 | 1.6 |
| ZnO | 13.0 | 10.0 | 8.0 | 7.2 | 6.9 | 6.2 | 6.4 | 5.6 | 6.5 | 5.0 | 10.6 |
| Li₂O | 7.0 | 7.0 | 7.5 | 7.4 | 7.2 | 7.2 | 7.2 | 7.2 | 7.0 | 7.0 | 5.8 |
| K₂O | 0.5 | 1.0 | 2.5 | 2.6 | 2.5 | | 2.5 | 2.5 | 2.2 | 2.2 | 2.0 |
| B₂O₃ | 3.5 | 1.0 | | 3.0 | | | | | | | |
| TiO₂ | 2.0 | 1.0 | | 2.0 | | | | | | | |
| ZrO₂ | 2.5 | 4.5 | 3.0 | 3.2 | 3.1 | 3.1 | 3.5 | 3.1 | 3.7 | 4.0 | 2.5 |
| P₂O₅ | 2.0 | 2.5 | 3.0 | 2.6 | 2.5 | 2.5 | 2.5 | 2.5 | 2.6 | 2.1 | 2.0 |
| Y₂O₃ | | | | | | | | | | | |
| Nb₂O₅ | | | | | | | | | | | |
| Ta₂O₅ | | | | | | | | | | | |
| La₂O₃ | | | | | | | | | | | |
| Sb₂O₃ | 0.4 | 0.5 | 0.5 | 0.5 | 0.5 | 0.5 | 0.4 | 0.5 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 750 | 750 | 750 | 750 | 750 | 750 | 750 | 750 | 750 | 750 | 750 |
| Growing | | | | | | | | | | | |
| Temperature??? | | | | | | | | | | | |
| Nucleous | 3 | 3 | 3 | 3 | 3 | 3 | 3 | 3 | 3 | 3 | 3 |
| Growing | | | | | | | | | | | |
| Time?hr? | | | | | | | | | | | |
| Main Crystalline | LZS | Quartz | Crist | Quartz | Crist | Crist | Crist | Crist | Crist | Crist | LZS |
| Phase | | | | | | | | | | | |
| Sub Crystalline | Crist | Crist | LZS | Crist | LZS | LZS | LZS | LZS | LZS | LZS | — |
| Phase | | | | | | | | | | | |
| Specific | 2.64 | 2.66 | 2.58 | 2.68 | 2.59 | 2.54 | 2.50 | 2.56 | 2.57 | 2.56 | 2.61 |
| Gravity?g/cm³ | | | | | | | | | | | |
| Yong's Modulus | 86.2 | 84.6 | 78.7 | 83.2 | 79.9 | 80.1 | 82.8 | 82.3 | 82.6 | 77.6 | 83.5 |
| E??Pa | | | | | | | | | | | |
| Elastic Modulus | 32.6 | 31.8 | 30.5 | 31.0 | 30.8 | 31.5 | 33.1 | 32.1 | 32.1 | 30.3 | 31.9 |
| Ratio | | | | | | | | | | | |
| C.T.E | 78 | 105 | 97 | 106 | 103 | 93 | 86 | 88 | 90 | 102 | 70 |
| Amount of | 49 | 55 | 53 | 55 | 55 | 53 | 51 | 52 | 52 | 54 | 48 |
| Migration of | | | | | | | | | | | |
| alkali metal | | | | | | | | | | | |
| [ppb] | | | | | | | | | | | |
| P/Pli | 1.1 | 1.2 | 1.2 | 1.2 | 1.2 | 1.2 | 1.2 | 1.2 | 1.2 | 1.2 | 1.1 |

TABLE 94

| | B-276 | B-277 | B-278 | B-279 | B-280 | B-281 | B-282 | B-283 | B-284 | B-285 |
|---|---|---|---|---|---|---|---|---|---|---|
| SiO₂ | 60.0 | 63.0 | 62.1 | 63.0 | 62.0 | 61.8 | 63.0 | 64.0 | 63.9 | 64.0 |
| Bl₂O₃ | 5.0 | 8.0 | 8.8 | 9.0 | 6.5 | 8.8 | 8.0 | 6.0 | 7.2 | 6.0 |
| MgO | 1.0 | 2.0 | 2.3 | 2.0 | 2.4 | 2.3 | 1.6 | 2.1 | 1.9 | 2.1 |
| CaO | | 0.8 | | 0.9 | | | | 2.0 | | 1.0 |
| BaO | 1.0 | 2.5 | 2.9 | 2.0 | 2.5 | 2.9 | 2.0 | | 2.4 | |
| SrO | 1.5 | 2.0 | 2.0 | 2.0 | 2.0 | 2.0 | 2.0 | 2.0 | 1.6 | 1.5 |
| ZnO | 20.0 | 6.0 | 6.8 | 6.0 | 7.0 | 6.8 | 6.5 | 9.0 | 9.4 | 9.0 |
| Li₂O | 6.0 | 4.0 | 6.6 | 8.0 | 7.1 | 7.1 | 6.9 | 7.0 | 6.7 | 7.0 |
| K₂O | | 2.1 | 2.4 | 1.5 | 2.5 | 2.4 | 2.4 | 1.0 | 2.0 | 2.2 |
| B₂O₃ | 1.0 | 2.0 | | | 1.0 | | | 1.0 | | |
| TiO₂ | 1.0 | 2.0 | | | 3.0 | | | 1.0 | | |
| ZrO₂ | 1.0 | 3.0 | 3.0 | 3.0 | 1.1 | 3.0 | 5.0 | 3.5 | 2.5 | 3.7 |
| P₂O₅ | 2.1 | 2.1 | 2.4 | 2.1 | 2.5 | 2.4 | 2.2 | 1.0 | 2.0 | 3.0 |
| Y₂O₃ | | | | | | | | | | |
| Nb₂O₅ | | | | | | | | | | |
| Ta₂O₅ | | | | | | | | | | |
| La₂O₃ | | | | | | | | | | |
| Sb₂O₃ | 0.4 | 0.4 | 0.5 | 0.4 | 0.5 | 0.5 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 750 | 750 | 750 | 750 | 750 | 750 | 750 | 750 | 750 | 750 |
| Temperature??? | | | | | | | | | | |
| Nucleous Growing | 3 | 3 | 3 | 3 | 3 | 3 | 3 | 3 | 3 | 3 |
| Time?hr? | | | | | | | | | | |
| Main Crystalline | LZS | Quartz | Crist | Crist | Quartz | Crist | Crist | Quartz | Crist | Crist |
| Phase | | | | | | | | | | |
| Sub Crystalline | — | LAS | LZS | LZS | LAS | LZS | LZS | LAS | LZS | LZS |
| Phase | | | | | | | | | | |
| Specific | 2.71 | 2.70 | 2.58 | 2.54 | 2.67 | 2.59 | 2.62 | 2.63 | 2.62 | 2.58 |
| Gravity?g/cm³ | | | | | | | | | | |
| Yong's Modulus | 83.9 | 87.9 | 82.1 | 80.0 | 84.4 | 83.8 | 85.0 | 84.6 | 82.9 | 82.5 |
| E??Pa | | | | | | | | | | |
| Elastic Modulus | 30.9 | 32.5 | 31.8 | 31.4 | 31.6 | 32.3 | 32.4 | 32.2 | 31.6 | 31.9 |
| Ratio | | | | | | | | | | |
| C.T.E | 70 | 108 | 81 | 91 | 105 | 87 | 98 | 106 | 75 | 78 |
| Amount of | 48 | 56 | 50 | 52 | 55 | 51 | 54 | 55 | 49 | 49 |
| Migration of alkali | | | | | | | | | | |
| metal [ppb] | | | | | | | | | | |
| P/Pli | 1.1 | 1.3 | 1.2 | 1.2 | 1.2 | 1.2 | 1.2 | 1.2 | 1.1 | 1.1 |

TABLE 95

| | B-286 | B-287 | B-288 | B-289 | B-290 | B-291 | B-292 | B-293 | B-294 | B-295 | B-296 |
|---|---|---|---|---|---|---|---|---|---|---|---|
| SiO₂ | 55.0 | 60.0 | 65.0 | 61.0 | 62.9 | 63.0 | 63.0 | 62.6 | 64.0 | 65.0 | 63.7 |
| Bl₂O₃ | 7.0 | 6.0 | 5.0 | 3.0 | 7.3 | 10.0 | 9.0 | 8.9 | 8.0 | 7.6 | 7.2 |
| MgO | 3.0 | 2.5 | 2.5 | 2.5 | 2.4 | 2.5 | 2.0 | 2.3 | 0.5 | 2.5 | 1.9 |
| CaO | 2.0 | 1.0 | 1.0 | | | | 2.0 | | | | |
| BaO | | | | 3.0 | 2.9 | 3.0 | 1.0 | 2.9 | | 2.5 | 2.4 |
| SrO | 2.0 | 3.0 | 2.0 | 2.1 | 2.0 | 2.0 | 0.5 | 2.0 | 5.0 | 1.7 | 1.6 |
| ZnO | 13.0 | 10.0 | 8.0 | 7.2 | 6.9 | 6.2 | 6.4 | 5.6 | 6.5 | 5.0 | 10.6 |
| Li₂O | 7.0 | 7.0 | 7.5 | 7.4 | 7.2 | 7.2 | 7.2 | 7.2 | 7.0 | 7.0 | 5.8 |
| K₂O | 0.5 | 1.0 | 2.5 | 2.6 | 2.5 | | 2.5 | 2.5 | 2.2 | 2.2 | 2.0 |
| B₂O₃ | 3.5 | 1.0 | | 3.0 | | | | | | | |
| TiO₂ | 2.0 | 1.0 | | 2.0 | | | | | | | |
| ZrO₂ | 2.5 | 4.5 | 3.0 | 3.2 | 3.1 | 3.1 | 3.5 | 3.1 | 3.7 | 4.0 | 2.5 |
| P₂O₅ | 2.0 | 2.5 | 3.0 | 2.6 | 2.5 | 2.5 | 2.5 | 2.5 | 2.6 | 2.1 | 2.0 |
| Y₂O₃ | | | | | | | | | | | |
| Nb₂O₅ | | | | | | | | | | | |
| Ta₂O₅ | | | | | | | | | | | |
| La₂O₃ | | | | | | | | | | | |
| Sb₂O₃ | 0.4 | 0.5 | 0.5 | 0.5 | 0.5 | 0.5 | 0.4 | 0.5 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 720 | 720 | 720 | 720 | 720 | 720 | 720 | 720 | 720 | 720 | 720 |
| Growing | | | | | | | | | | | |
| Temperature??? | | | | | | | | | | | |
| Nucleous | 10 | 10 | 10 | 10 | 10 | 10 | 10 | 10 | 10 | 10 | 10 |
| Growing | | | | | | | | | | | |
| Time?hr? | | | | | | | | | | | |
| Main Crystalline | LZS | Quartz | Crist | Crist | Crist | Crist | Crist | Crist | Crist | Crist | LZS |
| Phase | | | | | | | | | | | |
| Sub Crystalline | — | Crist | LZS | Quartz | LZS | LZS | LZS | LZS | LZS | LZS | — |
| Phase | | | | | | | | | | | |
| Specific | 2.64 | 2.65 | 2.58 | 2.65 | 2.59 | 2.54 | 2.50 | 2.56 | 2.57 | 2.56 | 2.61 |
| Gravity?g/cm³ | | | | | | | | | | | |
| Yong's Modulus | 86.2 | 83.6 | 78.7 | 79.5 | 79.9 | 80.1 | 82.8 | 82.3 | 82.6 | 77.6 | 83.5 |
| E??Pa | | | | | | | | | | | |
| Elastic Modulus | 32.6 | 31.5 | 30.5 | 30.0 | 30.8 | 31.5 | 33.1 | 32.1 | 32.1 | 30.3 | 31.9 |
| Ratio | | | | | | | | | | | |
| C.T.E | 71 | 106 | 97 | 107 | 103 | 93 | 85 | 88 | 90 | 102 | 69 |
| Amount of | 48 | 55 | 53 | 55 | 55 | 53 | 51 | 51 | 52 | 54 | 47 |
| Migration of | | | | | | | | | | | |
| alkali metal | | | | | | | | | | | |
| [ppb] | | | | | | | | | | | |
| P/Pli | 1.1 | 1.2 | 1.2 | 1.2 | 1.2 | 1.2 | 1.2 | 1.2 | 1.2 | 1.2 | 1.1 |

TABLE 96

| | B-297 | B-298 | B-299 | B-300 | B-301 | B-302 | B-303 | B-304 | B-305 | B-306 |
|---|---|---|---|---|---|---|---|---|---|---|
| SiO₂ | 60.0 | 63.0 | 62.1 | 63.0 | 62.0 | 61.8 | 63.0 | 64.0 | 63.9 | 64.0 |
| Bl₂O₃ | 5.0 | 8.0 | 8.8 | 9.0 | 6.5 | 8.8 | 8.0 | 6.0 | 7.2 | 6.0 |
| MgO | 1.0 | 2.0 | 2.3 | 2.0 | 2.4 | 2.3 | 1.6 | 2.1 | 1.9 | 2.1 |
| CaO | | 0.8 | | 0.9 | | | | 2.0 | | 1.0 |
| BaO | 1.0 | 2.5 | 2.9 | 2.0 | 2.5 | 2.9 | 2.0 | | 2.4 | |
| SrO | 1.5 | 2.0 | 2.0 | 2.0 | 2.0 | 2.0 | 2.0 | 2.0 | 1.6 | 1.5 |
| ZnO | 20.0 | 6.0 | 6.8 | 6.0 | 7.0 | 6.8 | 6.5 | 9.0 | 9.4 | 9.0 |
| Li₂O | 6.0 | 4.0 | 6.6 | 8.0 | 7.1 | 7.1 | 6.9 | 7.0 | 6.7 | 7.0 |
| K₂O | | 2.1 | 2.4 | 1.5 | 2.5 | 2.4 | 2.4 | 1.0 | 2.0 | 2.2 |
| B₂O₃ | 1.0 | 2.0 | | | 1.0 | | | 1.0 | | |
| TiO₂ | 1.0 | 2.0 | | | 3.0 | | | 1.0 | | |
| ZrO₂ | 1.0 | 3.0 | 3.0 | 3.0 | 1.1 | 3.0 | 5.0 | 3.5 | 2.5 | 3.7 |
| P₂O₅ | 2.1 | 2.1 | 2.4 | 2.1 | 2.5 | 2.4 | 2.2 | 1.0 | 2.0 | 3.0 |
| Y₂O₃ | | | | | | | | | | |
| Nb₂O₅ | | | | | | | | | | |
| Ta₂O₅ | | | | | | | | | | |
| La₂O₃ | | | | | | | | | | |
| Sb₂O₃ | 0.4 | 0.4 | 0.5 | 0.4 | 0.5 | 0.5 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 720 | 720 | 720 | 720 | 720 | 720 | 720 | 720 | 720 | 720 |
| Temperature??? | | | | | | | | | | |
| Nucleous Growing | 10 | 10 | 10 | 10 | 10 | 10 | 10 | 10 | 10 | 10 |
| Time?hr? | | | | | | | | | | |
| Main Crystalline | LZS | Quartz | Crist | Crist | Quartz | Crist | Crist | Quartz | Crist | Crist |
| Phase | | | | | | | | | | |
| Sub Crystalline | — | Crist | LZS | LZS | Crist | LZS | LZS | Crist | LZS | LZS |
| Phase | | | | | | | | | | |
| Specific | 2.71 | 2.69 | 2.58 | 2.54 | 2.66 | 2.59 | 2.62 | 2.62 | 2.62 | 2.58 |
| Gravity?g/cm³ | | | | | | | | | | |
| Yong's Modulus | 83.9 | 86.8 | 82.1 | 80.0 | 83.4 | 83.8 | 85.0 | 83.6 | 82.9 | 82.5 |
| E??Pa | | | | | | | | | | |
| Elastic Modulus | 30.9 | 32.2 | 31.8 | 31.4 | 31.3 | 32.3 | 32.4 | 31.9 | 31.6 | 31.9 |
| Ratio | | | | | | | | | | |
| C.T.E | 69 | 109 | 81 | 91 | 106 | 87 | 98 | 107 | 74 | 77 |
| Amount of | 48 | 56 | 50 | 52 | 55 | 51 | 54 | 56 | 49 | 49 |
| Migration of alkali | | | | | | | | | | |
| metal [ppb] | | | | | | | | | | |
| P/Pli | 1.1 | 1.3 | 1.2 | 1.2 | 1.2 | 1.2 | 1.2 | 1.3 | 1.1 | 1.1 |

Tables 97 and 98 show the glass compositions in % by weight of respective crystallized glass substrates of B-307 to 327, together with the manufacturing conditions employed. Tables 99 and 100 show crystallized glass substrates as B-328 to 348 manufactured using the same glass compositions as those of B-307 to 327 with the nucleus growing temperature varied from that employed for B-307 to 327. Further, Tables 101 and 102 show crystallized glass substrates as B-349 to 369 manufactured using the same glass compositions as those of B-307 to 327 with the nucleus growing time varied from that employed for B-307 to 327.

TABLE 97

| | B-307 | B-308 | B-309 | B-310 | B-311 | B-312 | B-313 | B-314 | B-315 | B-316 | B-317 |
|---|---|---|---|---|---|---|---|---|---|---|---|
| SiO₂ | 55.0 | 60.0 | 65.0 | 60.0 | 59.0 | 62.0 | 65.0 | 63.0 | 60.0 | 63.0 | 63.0 |
| Bl₂O₃ | 6.0 | 5.0 | 3.5 | 3.0 | 5.0 | 10.0 | 7.6 | 6.0 | 5.5 | 6.0 | 6.0 |
| MgO | 3.0 | 2.5 | 2.5 | 2.5 | 1.0 | 2.5 | 2.0 | 1.0 | 1.0 | 2.0 | 2.0 |
| CaO | 2.0 | 1.0 | | | 2.0 | | | 0.5 | 1.0 | 0.8 | 0.9 |
| BaO | 2.0 | 1.0 | 3.0 | 3.0 | 2.3 | 3.0 | 2.5 | 1.5 | 0.5 | 2.0 | 2.0 |
| SrO | | | 2.0 | 2.1 | 1.8 | 2.0 | 1.7 | | | | |
| ZnO | 13.0 | 10.0 | 7.0 | 7.2 | 7.5 | 6.2 | 5.0 | 15.0 | 20.0 | 10.0 | 10.0 |
| Li₂O | 7.0 | 7.0 | 7.5 | 7.4 | 7.4 | 7.2 | 7.0 | 6.0 | 6.0 | 4.0 | 6.0 |
| K₂O | 0.5 | 1.0 | 2.5 | 2.6 | 2.6 | | 2.2 | | | 2.1 | 2.0 |
| B₂O₃ | 3.5 | 2.0 | | 3.0 | 1.0 | | | 1.0 | 1.0 | 2.0 | 2.0 |
| TiO₂ | 2.0 | 2.0 | | 2.0 | 3.0 | | | 2.0 | 1.0 | 2.0 | |
| ZrO₂ | 2.5 | 4.5 | 3.0 | 3.2 | 3.4 | 3.1 | 4.0 | 1.0 | 1.0 | 3.0 | 3.0 |
| P₂O₅ | 2.0 | 2.5 | 2.5 | 2.6 | 2.6 | 2.5 | 2.1 | 2.1 | 2.1 | 2.1 | 2.1 |
| Y₂O₃ | 1.0 | 1.0 | 1.0 | 1.0 | 1.0 | 1.0 | 0.5 | 0.5 | 0.5 | 0.5 | 0.5 |
| Nb₂O₅ | | | | | | | | | | | |
| Ta₂O₅ | | | | | | | | | | | |
| La₂O₃ | | | | | | | | | | | |
| Sb₂O₃ | 0.4 | 0.5 | 0.5 | 0.5 | 0.5 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 720 | 720 | 720 | 720 | 720 | 720 | 720 | 720 | 720 | 720 | 720 |
| Growing | | | | | | | | | | | |
| Temperature??? | | | | | | | | | | | |
| Nucleous | 3 | 3 | 3 | 3 | 3 | 3 | 3 | 3 | 3 | 3 | 3 |
| Growing | | | | | | | | | | | |
| Time?hr? | | | | | | | | | | | |
| Main Crystalline | LZS | LZS | Crist | LZS | LZS | LZS | Crist | LZS | LZS | LZS | LZS |
| Phase | | | | | | | | | | | |
| Sub Crystalline | — | Crist | LZS | — | — | Crist | LZS | — | — | Crist | Crist |
| Phase | | | | | | | | | | | |
| Specific | 2.71 | 2.65 | 2.55 | 2.61 | 2.63 | 2.58 | 2.51 | 2.67 | 2.72 | 2.60 | 2.57 |
| Gravity?g/cm³ | | | | | | | | | | | |
| Yong's Modulus | 87.3 | 84.3 | 83.8 | 85.1 | 84.8 | 82.8 | 77.6 | 87.1 | 88.2 | 83.2 | 82.2 |
| E??Pa | | | | | | | | | | | |
| Elastic Modulus | 32.2 | 31.8 | 32.9 | 32.6 | 32.2 | 32.1 | 30.9 | 32.6 | 32.4 | 32.0 | 32.0 |
| Ratio | | | | | | | | | | | |
| C.T.E | 63 | 72 | 88 | 68 | 71 | 74 | 81 | 63 | 61 | 77 | 75 |
| Amount of | 52 | 54 | 61 | 54 | 55 | 55 | 57 | 49 | 48 | 46 | 52 |
| Migration of | | | | | | | | | | | |
| alkali metal | | | | | | | | | | | |
| [ppb] | | | | | | | | | | | |
| P/Pli | 1.0 | 1.1 | 1.1 | 1.0 | 1.0 | 1.1 | 1.1 | 1.0 | 1.0 | 1.2 | 1.1 |

TABLE 98

| | B-318 | B-319 | B-320 | B-321 | B-322 | B-323 | B-324 | B-325 | B-326 | B-327 |
|---|---|---|---|---|---|---|---|---|---|---|
| SiO₂ | 63.0 | 58.0 | 61.0 | 60.0 | 62.0 | 60.0 | 64.0 | 64.0 | 64.6 | 60.0 |
| Bl₂O₃ | 9.0 | 6.5 | 5.0 | 6.0 | 7.1 | 7.8 | 8.0 | 6.0 | 7.3 | 6.0 |
| MgO | 2.0 | 2.4 | 2.3 | 1.6 | 2.1 | 2.1 | 2.1 | 1.6 | 1.9 | 1.5 |
| CaO | 0.9 | | 1.1 | 2.0 | 1.0 | 1.7 | 1.0 | 2.0 | | 1.0 |
| BaO | 2.0 | 2.5 | 2.0 | | | | | | 2.4 | |
| SrO | | 2.0 | | 1.5 | | | | 1.5 | 1.6 | 1.5 |
| ZnO | 7.5 | 8.0 | 10.0 | 9.0 | 6.4 | 6.2 | 6.5 | 9.0 | 5.7 | 7.0 |
| Li₂O | 8.0 | 7.1 | 7.0 | 6.9 | 7.0 | 7.5 | 7.0 | 6.9 | 5.9 | 6.9 |
| K₂O | 1.5 | 2.5 | 2.0 | 2.4 | 2.5 | 2.2 | 2.2 | 2.0 | 2.0 | 2.4 |
| B₂O₃ | | 3.0 | 3.0 | 1.0 | 3.0 | 3.0 | 1.0 | 1.0 | | 1.0 |
| TiO₂ | | 3.0 | | 1.0 | 3.0 | 3.0 | | 1.0 | | 1.0 |
| ZrO₂ | 3.0 | 1.1 | 3.2 | 5.0 | 3.5 | 3.0 | 3.7 | 3.5 | 2.5 | 3.3 |
| P₂O₅ | 2.1 | 2.5 | 2.0 | 2.2 | 1.0 | 2.0 | 3.0 | 1.0 | 2.0 | 3.0 |
| Y₂O₃ | 0.5 | 1.0 | 1.0 | 1.0 | 1.0 | 1.0 | 1.0 | 0.1 | 3.5 | 5.0 |
| Nb₂O₅ | | | | | | | | | | |
| Ta₂O₅ | | | | | | | | | | |
| La₂O₃ | | | | | | | | | | |
| Sb₂O₃ | 0.4 | 0.5 | 0.4 | 0.4 | 0.4 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Meiting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 720 | 720 | 720 | 720 | 720 | 720 | 720 | 720 | 720 | 720 |
| Temperature??? | | | | | | | | | | |
| Nucleous Growing | 3 | 3 | 3 | 3 | 3 | 3 | 3 | 3 | 3 | 3 |
| Time?hr? | | | | | | | | | | |
| Main Crystalline | Crist | LZS | LZS | LZS | Crist | Crist | Crist | LZS | LZS | LZS |
| Phase | | | | | | | | | | |
| Sub Crystalline | LZS | Crist | Crist | Crist | LZS | LZS | LZS | Crist | — | — |
| Phase | | | | | | | | | | |
| Specific | 2.51 | 2.62 | 2.63 | 2.66 | 2.56 | 2.65 | 2.66 | 2.57 | 2.68 | 2.78 |
| Gravity?g/cm³ | | | | | | | | | | |
| Yong's Modulus | 78.0 | 85.7 | 86.3 | 85.3 | 81.2 | 83.1 | 79.8 | 83.1 | 87.3 | 89.1 |
| E??Pa | | | | | | | | | | |
| Elastic Modulus | 31.1 | 32.7 | 32.8 | 32.1 | 31.7 | 31.4 | 30.0 | 32.3 | 32.6 | 32.1 |
| Ratio | | | | | | | | | | |
| C.T.E | 89 | 74 | 75 | 76 | 81 | 78 | 97 | 76 | 61 | 60 |
| Amount of | 63 | 55 | 55 | 55 | 57 | 58 | 62 | 55 | 48 | 50 |
| Migration of alkali | | | | | | | | | | |
| metal [ppb] | | | | | | | | | | |
| P/Pli | 1.1 | 1.1 | 1.1 | 1.1 | 1.1 | 1.1 | 1.1 | 1.1 | 1.0 | 1.0 |

TABLE 99

| | B-328 | B-329 | B-330 | B-331 | B-332 | B-333 | B-334 | B-335 | B-336 | B-337 | B-338 |
|---|---|---|---|---|---|---|---|---|---|---|---|
| SiO₂ | 55.0 | 60.0 | 65.0 | 60.0 | 59.0 | 62.0 | 65.0 | 63.0 | 60.0 | 63.0 | 63.0 |
| Bl₂O₃ | 6.0 | 5.0 | 3.5 | 3.0 | 5.0 | 10.0 | 7.6 | 6.0 | 5.5 | 6.0 | 6.0 |
| MgO | 3.0 | 2.5 | 2.5 | 2.5 | 1.0 | 2.5 | 2.0 | 1.0 | 1.0 | 2.0 | 2.0 |
| CaO | 2.0 | 1.0 | | | 2.0 | | | 0.5 | 1.0 | 0.8 | 0.9 |
| BaO | 2.0 | 1.0 | 3.0 | 3.0 | 2.3 | 3.0 | 2.5 | 1.5 | 0.5 | 2.0 | 2.0 |
| SrO | | | 2.0 | 2.1 | 1.8 | 2.0 | 1.7 | | | | |
| ZnO | 13.0 | 10.0 | 7.0 | 7.2 | 7.5 | 6.2 | 5.0 | 15.0 | 20.0 | 10.0 | 10.0 |
| Li₂O | 7.0 | 7.0 | 7.5 | 7.4 | 7.4 | 7.2 | 7.0 | 6.0 | 6.0 | 4.0 | 6.0 |
| K₂O | 0.5 | 1.0 | 2.5 | 2.6 | 2.6 | | 2.2 | | | 2.1 | 2.0 |
| B₂O₃ | 3.5 | 2.0 | | 3.0 | 1.0 | | | 1.0 | 1.0 | 2.0 | 2.0 |
| TiO₂ | 2.0 | 2.0 | | 2.0 | 3.0 | | | 2.0 | 1.0 | 2.0 | |
| ZrO₂ | 2.5 | 4.5 | 3.0 | 3.2 | 3.4 | 3.1 | 4.0 | 1.0 | 1.0 | 3.0 | 3.0 |
| P₂O₅ | 2.0 | 2.5 | 2.5 | 2.6 | 2.6 | 2.5 | 2.1 | 2.1 | 2.1 | 2.1 | 2.1 |
| Y₂O₃ | 1.0 | 1.0 | 1.0 | 1.0 | 1.0 | 1.0 | 0.5 | 0.5 | 0.5 | 0.5 | 0.5 |
| Nb₂O₅ | | | | | | | | | | | |
| Ta₂O₅ | | | | | | | | | | | |
| La₂O₃ | | | | | | | | | | | |
| Sb₂O₃ | 0.4 | 0.5 | 0.5 | 0.5 | 0.5 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 750 | 750 | 750 | 750 | 750 | 750 | 750 | 750 | 750 | 750 | 750 |
| Growing | | | | | | | | | | | |
| Temperature??? | | | | | | | | | | | |
| Nucleous | 3 | 3 | 3 | 3 | 3 | 3 | 3 | 3 | 3 | 3 | 3 |
| Growing | | | | | | | | | | | |
| Time?hr? | | | | | | | | | | | |
| Main Crystalline | LZS | Crist | Crist | LZS | LZS | Crist | Crist | LZS | LZS | Crist | Crist |
| Phase | | | | | | | | | | | |
| Sub Crystalline | — | LZS | LZS | Crist | Crist | LZS | LZS | — | — | LZS | LZS |
| Phase | | | | | | | | | | | |
| Specific | 2.70 | 2.64 | 2.54 | 2.60 | 2.62 | 2.57 | 2.50 | 2.66 | 2.71 | 2.59 | 2.56 |
| Gravity?g/cm³ | | | | | | | | | | | |
| Yong's Modulus | 87.0 | 84.0 | 83.5 | 84.8 | 84.5 | 82.5 | 77.3 | 86.8 | 87.8 | 82.9 | 81.9 |
| E??Pa | | | | | | | | | | | |
| Elastic Modulus | 32.2 | 31.8 | 32.8 | 32.6 | 32.2 | 32.1 | 30.9 | 32.6 | 32.4 | 32.0 | 31.9 |
| Ratio | | | | | | | | | | | |
| C.T.E | 71 | 77 | 90 | 74 | 77 | 79 | 84 | 71 | 70 | 81 | 80 |
| Amount of | 48 | 49 | 52 | 49 | 49 | 50 | 51 | 48 | 48 | 50 | 50 |
| Migration of | | | | | | | | | | | |
| alkali metal | | | | | | | | | | | |
| [ppb] | | | | | | | | | | | |
| P/Pli | 1.1 | 1.1 | 1.2 | 1.1 | 1.1 | 1.1 | 1.2 | 1.1 | 1.1 | 1.2 | 1.1 |

TABLE 100

| | B-339 | B-340 | B-341 | B-342 | B-343 | B-344 | B-345 | B-346 | B-347 | B-348 |
|---|---|---|---|---|---|---|---|---|---|---|
| SiO₂ | 63.0 | 58.0 | 61.0 | 60.0 | 62.0 | 60.0 | 64.0 | 64.0 | 64.6 | 60.0 |
| Bl₂O₃ | 9.0 | 6.5 | 5.0 | 6.0 | 7.1 | 7.8 | 8.0 | 6.0 | 7.3 | 6.0 |
| MgO | 2.0 | 2.4 | 2.3 | 1.6 | 2.1 | 2.1 | 2.1 | 1.6 | 1.9 | 1.5 |
| CaO | 0.9 | | 1.1 | 2.0 | 1.0 | 1.7 | 1.0 | 2.0 | | 1.0 |
| BaO | 2.0 | 2.5 | 2.0 | | | | | | 2.4 | |
| SrO | | 2.0 | | 1.5 | | | | 1.5 | 1.6 | 1.5 |
| ZnO | 7.5 | 8.0 | 10.0 | 9.0 | 6.4 | 6.2 | 6.5 | 9.0 | 5.7 | 7.0 |
| Li₂O | 8.0 | 7.1 | 7.0 | 6.9 | 7.0 | 7.5 | 7.0 | 6.9 | 5.9 | 6.9 |
| K₂O | 1.5 | 2.5 | 2.0 | 2.4 | 2.5 | 2.2 | 2.2 | 2.0 | 2.0 | 2.4 |
| B₂O₃ | | 3.0 | 3.0 | 1.0 | 3.0 | 3.0 | 1.0 | 1.0 | | 1.0 |
| TiO₂ | | 3.0 | | 1.0 | 3.0 | 3.0 | | 1.0 | | 1.0 |
| ZrO₂ | 3.0 | 1.1 | 3.2 | 5.0 | 3.5 | 3.0 | 3.7 | 3.5 | 2.5 | 3.3 |
| P₂O₅ | 2.1 | 2.5 | 2.0 | 2.2 | 1.0 | 2.0 | 3.0 | 1.0 | 2.0 | 3.0 |
| Y₂O₃ | 0.5 | 1.0 | 1.0 | 1.0 | 1.0 | 1.0 | 1.0 | 0.1 | 3.5 | 5.0 |
| Nb₂O₅ | | | | | | | | | | |
| Ta₂O₅ | | | | | | | | | | |
| La₂O₃ | | | | | | | | | | |
| Sb₂O₃ | 0.4 | 0.5 | 0.4 | 0.4 | 0.4 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 750 | 750 | 750 | 750 | 750 | 750 | 750 | 750 | 750 | 750 |
| Temperature??? | | | | | | | | | | |
| Nucleous Growing | 3 | 3 | 3 | 3 | 3 | 3 | 3 | 3 | 3 | 3 |
| Time?hr? | | | | | | | | | | |
| Main Crystalline | Crist | Crist | Crist | Crist | Crist | Crist | Crist | Crist | LZS | LZS |
| Phase | | | | | | | | | | |
| Sub Crystalline | LZS | LZS | LZS | LZS | LZS | LZS | LZS | LZS | — | — |
| Phase | | | | | | | | | | |
| Specific | 2.50 | 2.61 | 2.62 | 2.65 | 2.55 | 2.64 | 2.65 | 2.56 | 2.67 | 2.77 |
| Gravity?g/cm³ | | | | | | | | | | |
| Yong's Modulus | 77.7 | 85.4 | 86.0 | 85.0 | 80.9 | 82.8 | 79.5 | 82.8 | 87.0 | 88.7 |
| E??Pa | | | | | | | | | | |
| Elastic Modulus | 31.0 | 32.7 | 32.8 | 32.0 | 31.7 | 31.3 | 30.0 | 32.3 | 32.5 | 32.0 |
| Ratio | | | | | | | | | | |
| C.T.E | 91 | 79 | 80 | 80 | 84 | 82 | 97 | 80 | 70 | 69 |
| Amount of | 52 | 50 | 50 | 50 | 51 | 50 | 53 | 50 | 48 | 47 |
| Migration of alkali | | | | | | | | | | |
| metal [ppb] | | | | | | | | | | |
| P/Pli | 1.2 | 1.1 | 1.1 | 1.2 | 1.2 | 1.2 | 1.2 | 1.2 | 1.1 | 1.1 |

TABLE 101

| | B-349 | B-350 | B-351 | B-352 | B-353 | B-354 | B-355 | B-356 | B-357 | B-358 | B-359 |
|---|---|---|---|---|---|---|---|---|---|---|---|
| SiO₂ | 55.0 | 60.0 | 65.0 | 60.0 | 59.0 | 62.0 | 65.0 | 63.0 | 60.0 | 63.0 | 63.0 |
| Bl₂O₃ | 6.0 | 5.0 | 3.5 | 3.0 | 5.0 | 10.0 | 7.6 | 6.0 | 5.5 | 6.0 | 6.0 |
| MgO | 3.0 | 2.5 | 2.5 | 2.5 | 1.0 | 2.5 | 2.0 | 1.0 | 1.0 | 2.0 | 2.0 |
| CaO | 2.0 | 1.0 | | | 2.0 | | | 0.5 | 1.0 | 0.8 | 0.9 |
| BaO | 2.0 | 1.0 | 3.0 | 3.0 | 2.3 | 3.0 | 2.5 | 1.5 | 0.5 | 2.0 | 2.0 |
| SrO | | | 2.0 | 2.1 | 1.8 | 2.0 | 1.7 | | | | |
| ZnO | 13.0 | 10.0 | 7.0 | 7.2 | 7.5 | 6.2 | 5.0 | 15.0 | 20.0 | 10.0 | 10.0 |
| Li₂O | 7.0 | 7.0 | 7.5 | 7.4 | 7.4 | 7.2 | 7.0 | 6.0 | 6.0 | 4.0 | 6.0 |
| K₂O | 0.5 | 1.0 | 2.5 | 2.6 | 2.6 | | 2.2 | | | 2.1 | 2.0 |
| B₂O₃ | 3.5 | 2.0 | | 3.0 | 1.0 | | | 1.0 | 1.0 | 2.0 | 2.0 |
| TiO₂ | 2.0 | 2.0 | | 2.0 | 3.0 | | | 2.01 | 1.0 | 2.0 | |
| ZrO₂ | 2.5 | 4.5 | 3.0 | 3.2 | 3.4 | 3.1 | 4.0 | 1.0 | 1.0 | 3.0 | 3.0 |
| P₂O₅ | 2.0 | 2.5 | 2.5 | 2.6 | 2.6 | 2.5 | 2.1 | 2.1 | 2.1 | 2.1 | 2.1 |
| Y₂O₃ | 1.0 | 1.0 | 1.0 | 1.0 | 1.0 | 1.0 | 0.5 | 0.5 | 0.5 | 0.5 | 0.5 |
| Nb₂O₅ | | | | | | | | | | | |
| Ta₂O₅ | | | | | | | | | | | |
| La₂O₃ | | | | | | | | | | | |
| Sb₂O₃ | 0.4 | 0.5 | 0.5 | 0.5 | 0.5 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time? hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time? hr? | | | | | | | | | | | |
| Nucleous | 720 | 720 | 720 | 720 | 720 | 720 | 720 | 720 | 720 | 720 | 720 |
| Growing | | | | | | | | | | | |
| Temperature??? | | | | | | | | | | | |
| Nucleous | 10 | 10 | 10 | 10 | 10 | 10 | 10 | 10 | 10 | 10 | 10 |
| Growing | | | | | | | | | | | |
| Time? hr? | | | | | | | | | | | |
| Main Crystalline | LZS | Crist | Crist | LZS | LZS | LZS | Crist | LZS | LZS | Crist | Crist |
| Phase | | | | | | | | | | | |
| Sub Crystalline | — | LZS | LZS | Crist | Crist | Crist | LZS | — | — | LZS | LZS |
| Phase | | | | | | | | | | | |
| Specific | 2.70 | 2.64 | 2.54 | 2.60 | 2.62 | 2.57 | 2.50 | 2.66 | 2.71 | 2.59 | 2.56 |
| Gravity? g/cm³ | | | | | | | | | | | |
| Yong's Modulus | 87.0 | 84.0 | 83.5 | 84.8 | 84.5 | 82.5 | 77.3 | 86.8 | 87.9 | 82.9 | 81.9 |
| E??Pa | | | | | | | | | | | |
| Elastic Modulus | 32.2 | 31.8 | 32.8 | 32.6 | 32.2 | 32.1 | 30.9 | 32.6 | 32.4 | 32.0 | 31.9 |
| Ratio | | | | | | | | | | | |
| C.T.E | 70 | 77 | 90 | 74 | 76 | 78 | 84 | 70 | 69 | 81 | 79 |
| Amount of | 48 | 49 | 52 | 48 | 49 | 49 | 51 | 48 | 47 | 50 | 50 |
| Migration of | | | | | | | | | | | |
| alkali metal | | | | | | | | | | | |
| [ppb] | | | | | | | | | | | |
| P/Pli | 1.1 | 1.1 | 1.2 | 1.1 | 1.1 | 1.1 | 1.2 | 1.1 | 1.1 | 1.2 | 1.1 |

TABLE 102

| | B-360 | B-361 | B-362 | B-363 | B-364 | B-365 | B-366 | B-367 | B-368 | B-369 |
|---|---|---|---|---|---|---|---|---|---|---|
| SiO₂ | 63.0 | 58.0 | 61.0 | 60.0 | 62.0 | 60.0 | 64.0 | 64.0 | 64.6 | 60.0 |
| Bl₂O₃ | 9.0 | 6.5 | 5.0 | 6.0 | 7.1 | 7.8 | 8.0 | 6.0 | 7.3 | 6.0 |
| MgO | 2.0 | 2.4 | 2.3 | 1.6 | 2.1 | 2.1 | 2.1 | 1.6 | 1.9 | 1.5 |
| CaO | 0.9 | | 1.1 | 2.0 | 1.0 | 1.7 | 1.0 | 2.0 | | 1.0 |
| BaO | 2.0 | 2.5 | 2.0 | | | | | | 2.4 | |
| SrO | | 2.0 | | 1.5 | | | | 1.5 | 1.6 | 1.5 |
| ZnO | 7.5 | 8.0 | 10.0 | 9.0 | 6.4 | 6.2 | 6.5 | 9.0 | 5.7 | 7.0 |
| Li₂O | 8.0 | 7.1 | 7.0 | 6.9 | 7.0 | 7.5 | 7.0 | 6.9 | 5.9 | 6.9 |
| K₂O | 1.5 | 2.5 | 2.0 | 2.4 | 2.5 | 2.2 | 2.2 | 2.0 | 2.0 | 2.4 |
| B₂O₃ | | 3.0 | 3.0 | 1.0 | 3.0 | 3.0 | 1.0 | 1.0 | | 1.0 |
| TiO₂ | | 3.0 | | 1.0 | 3.0 | 3.0 | | 1.0 | | 1.0 |
| ZrO₂ | 3.0 | 1.1 | 3.2 | 5.0 | 3.5 | 3.0 | 3.7 | 3.5 | 2.5 | 3.3 |
| P₂O₅ | 2.1 | 2.5 | 2.0 | 2.2 | 1.0 | 2.0 | 3.0 | 1.0 | 2.0 | 3.0 |
| Y₂O₃ | 0.5 | 1.0 | 1.0 | 1.0 | 1.0 | 1.0 | 1.0 | 0.1 | 3.5 | 5.0 |
| Nb₂O₅ | | | | | | | | | | |
| Ta₂O₅ | | | | | | | | | | |
| La₂O₃ | | | | | | | | | | |
| Sb₂O₃ | 0.4 | 0.5 | 0.4 | 0.4 | 0.4 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time? | 3 | 3 | 3 | 3 | 3 | 3 | 3 | 3 | 3 | 3 |
| hr? | | | | | | | | | | |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time? hr? | | | | | | | | | | |
| Nucleous | 720 | 720 | 720 | 720 | 720 | 720 | 720 | 720 | 720 | 720 |
| Growing | | | | | | | | | | |
| Temperature??? | | | | | | | | | | |
| Nucleous | 10 | 10 | 10 | 10 | 10 | 10 | 10 | 10 | 10 | 10 |
| Growing | | | | | | | | | | |
| Time? hr? | | | | | | | | | | |
| Main Crystalline | Crist | Crist | Crist | Crist | Crist | Crist | Crist | Crist | LZS | LZS |
| Phase | | | | | | | | | | |
| Sub Crystalline | LZS | LZS | LZS | LZS | LZS | LZS | LZS | LZS | - | - |
| Phase | | | | | | | | | | |
| Specific | 2.50 | 2.61 | 2.62 | 2.65 | 2.55 | 2.64 | 2.65 | 2.56 | 2.67 | 2.77 |
| Gravity'g/cm³ | | | | | | | | | | |
| Yong's Modulus | 77.7 | 85.4 | 86.0 | 85.0 | 80.9 | 82.8 | 79.5 | 82.8 | 87.0 | 88.8 |
| E? ? Pa | | | | | | | | | | |
| Elastic Modulus | 31.0 | 32.7 | 32.8 | 32.0 | 31.7 | 31.3 | 30.0 | 32.3 | 32.5 | 32.0 |
| Ratio | | | | | | | | | | |
| C.T.E | 91 | 78 | 79 | 80 | 84 | 81 | 97 | 80 | 69 | 68 |
| Amount of | 52 | 49 | 50 | 50 | 51 | 50 | 53 | 50 | 47 | 47 |
| Migration of | | | | | | | | | | |
| alkali | | | | | | | | | | |
| metal [ppb] | | | | | | | | | | |
| P/Pli | 1.2 | 1.1 | 1.1 | 1.1 | 1.2 | 1.2 | 1.2 | 1.1 | 1.1 | 1.1 |

Tables 103 and 104 show the glass compositions in % by weight of respective crystallized glass substrates of B-370 to 390, together with the manufacturing conditions employed. Tables 105 and 106 show crystallized glass substrates as B-391 to 411 manufactured using the same glass compositions as those of B-370 to 390 with the nucleus growing temperature varied from that employed for B-370 to 390. Further, Tables 107 and 108 show crystallized glass substrates as B-412 to 432 manufactured using the some glass compositions as those of B-370 to 390 with the nucleus growing time varied from that employed for B-370 to 390.

TABLE 103

| | B-370 | B-371 | B-372 | B-373 | B-374 | B-375 | B-376 | B-377 | B-378 | B-379 | B-380 |
|---|---|---|---|---|---|---|---|---|---|---|---|
| SiO₂ | 55.0 | 60.0 | 65.0 | 60.0 | 59.0 | 62.0 | 65.0 | 63.0 | 60.0 | 63.0 | 63.0 |
| Bl₂O₃ | 6.0 | 5.0 | 3.5 | 3.0 | 5.0 | 10.0 | 7.6 | 6.0 | 5.5 | 6.0 | 6.0 |
| MgO | 3.0 | 2.5 | 2.5 | 2.5 | 1.0 | 2.5 | 2.0 | 1.0 | 1.0 | 2.0 | 2.0 |
| CaO | 2.0 | 1.0 | | | 2.0 | | | 0.5 | 1.0 | 0.8 | 0.9 |
| BaO | 2.0 | 1.0 | 3.0 | 3.0 | 2.3 | 3.0 | 2.5 | 1.5 | 0.5 | 2.0 | 2.0 |
| SrO | | | 2.0 | 2.1 | 1.8 | 2.0 | 1.7 | | | | |
| ZnO | 13.0 | 10.0 | 7.0 | 7.2 | 7.5 | 6.2 | 5.0 | 15.0 | 20.0 | 10.0 | 10.0 |
| Li₂O | 7.0 | 7.0 | 7.5 | 7.4 | 7.4 | 7.2 | 7.0 | 6.0 | 6.0 | 4.0 | 6.0 |
| K₂O | 0.5 | 1.0 | 2.5 | 2.6 | 2.6 | | 2.2 | | | 2.1 | 2.0 |
| B₂O₃ | 3.5 | 2.0 | | 3.0 | 1.0 | | | 1.0 | 1.0 | 2.0 | 2.0 |
| TiO₂ | 2.0 | 2.0 | | 2.0 | 3.0 | | | 2.0 | 1.0 | 2.0 | |
| ZrO₂ | 2.5 | 4.5 | 3.0 | 3.2 | 3.4 | 3.1 | 4.0 | 1.0 | 1.0 | 3.0 | 3.0 |
| P₂O₅ | 2.0 | 2.5 | 2.5 | 2.6 | 2.6 | 2.5 | 2.1 | 2.1 | 2.1 | 2.1 | 2.1 |
| Y₂O₃ | | | | | | | | | | | |
| Nb₂O₅ | 1.0 | 1.0 | 1.0 | 1.0 | 1.0 | 1.0 | 0.5 | 0.5 | 0.5 | 0.5 | 0.5 |
| Ta₂O₅ | | | | | | | | | | | |
| La₂O₃ | | | | | | | | | | | |
| Sb₂O₃ | 0.4 | 0.5 | 0.5 | 0.5 | 0.5 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time? hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time? hr? | | | | | | | | | | | |
| Nucleous | 720 | 720 | 720 | 720 | 720 | 720 | 720 | 720 | 720 | 720 | 720 |
| Growing | | | | | | | | | | | |
| Temperature??? | | | | | | | | | | | |
| Nucleous | 3 | 3 | 3 | 3 | 3 | 3 | 3 | 3 | 3 | 3 | 3 |
| Growing | | | | | | | | | | | |
| Time? hr? | | | | | | | | | | | |
| Main Crystalline | LZS | LZS | Crist | LZS | LZS | LZS | Crist | LZS | LZS | LZS | LZS |
| Phase | | | | | | | | | | | |
| Sub Crystalline | — | Crist | LZS | — | — | Crist | LZS | — | — | Crist | Crist |
| Phase | | | | | | | | | | | |
| Specific | 2.71 | 2.66 | 2.58 | 2.62 | 2.63 | 2.58 | 2.53 | 2.67 | 2.72 | 2.66 | 2.62 |
| Gravity'g/cm³ | | | | | | | | | | | |
| Yong's Modulus | 88.0 | 86.3 | 83.8 | 86.0 | 85.6 | 83.1 | 79.4 | 87.1 | 88.2 | 83.2 | 82.2 |
| E?? Pa | | | | | | | | | | | |
| Elastic Modulus | 32.5 | 32.4 | 32.5 | 32.8 | 32.5 | 32.2 | 31.4 | 32.6 | 32.4 | 31.3 | 31.4 |
| Ratio | | | | | | | | | | | |
| C.T.E | 61 | 71 | 77 | 66 | 65 | 82 | 107 | 63 | 60 | 76 | 78 |
| Amount of | 51 | 54 | 57 | 54 | 53 | 58 | 64 | 49 | 48 | 46 | 53 |
| Migration of | | | | | | | | | | | |
| alkali metal | | | | | | | | | | | |
| [ppb] | | | | | | | | | | | |
| P/Pli | 1.0 | 1.0 | 1.1 | 1.0 | 1.0 | 1.1 | 1.2 | 1.0 | 1.0 | 1.2 | 1.1 |

TABLE 104

| | B-381 | B-382 | B-383 | B-384 | B-385 | B-386 | B-387 | B-388 | B-389 | B-390 |
|---|---|---|---|---|---|---|---|---|---|---|
| SiO₂ | 63.0 | 58.0 | 61.0 | 60.0 | 62.0 | 64.2 | 63.0 | 64.0 | 64.2 | 60.0 |
| Bl₂O₃ | 9.0 | 6.5 | 5.0 | 6.0 | 7.1 | 7.3 | 7.0 | 6.0 | 7.3 | 6.0 |
| MgO | 2.0 | 2.4 | 2.3 | 1.6 | 2.1 | 0.0 | 2.1 | 1.6 | 1.9 | 1.5 |
| CaO | 0.9 | | 1.1 | 2.0 | 1.0 | 3.5 | 1.0 | 2.0 | | 1.0 |
| BaO | 2.0 | 2.5 | 2.0 | | | 2.4 | | | 2.4 | |
| SrO | | 2.0 | | 1.5 | | | | 1.5 | 1.6 | 1.5 |
| ZnO | 7.5 | 8.0 | 10.0 | 9.0 | 6.4 | 5.7 | 5.5 | 9.0 | 5.7 | 7.0 |
| Li₂O | 8.0 | 7.1 | 7.0 | 6.9 | 7.0 | 5.8 | 7.0 | 6.9 | 5.8 | 6.9 |
| K2O | 1.5 | 2.5 | 2.0 | 2.4 | 2.5 | 2.0 | 2.2 | 2.0 | 2.0 | 2.4 |
| B₂O₃ | | 3.0 | 3.0 | 1.0 | 1.0 | | 1.0 | 1.0 | | 1.0 |
| TiO₂ | | 3.0 | | 1.0 | 2.0 | | | 1.0 | | 1.0 |
| ZrO₂ | 3.0 | 1.1 | 3.2 | 5.0 | 3.5 | 2.5 | 3.7 | 3.5 | 2.5 | 3.3 |
| P₂O₅ | 2.1 | 2.5 | 2.0 | 2.2 | 1.0 | 2.0 | 3.0 | 1.0 | 2.0 | 3.0 |
| Y₂O₃ | | | | | | | | | | |
| Nb₂O₅ | 0.5 | 1.0 | 1.0 | 1.0 | 4.0 | 4.1 | 4.0 | 0.1 | 4.1 | 5.0 |
| Ta₂O₅ | | | | | | | | | | |
| La₂O₃ | | | | | | | | | | |
| Sb₂O₃ | 0.4 | 0.5 | 0.4 | 0.4 | 0.4 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time? hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time? hr? | | | | | | | | | | |
| Nucleous Growing | 720 | 720 | 720 | 720 | 720 | 720 | 720 | 720 | 720 | 720 |
| Temperature??? | | | | | | | | | | |
| Nucleous Growing | 3 | 3 | 3 | 3 | 3 | 3 | 3 | 3 | 3 | 3 |
| Time? hr? | | | | | | | | | | |
| Main Crystalline | Crist | LZS | LZS | LZS | Crist | Crist | Crist | LZS | Crist | Crist |
| Phase | | | | | | | | | | |
| Sub Crystalline | LZS | Crist | Crist | Crist | LZS | LZS | LZS | Crist | LZS | LZS |
| Phase | | | | | | | | | | |
| Specific | 2.58 | 2.66 | 2.65 | 2.69 | 2.65 | 2.60 | 2.71 | 2.55 | 2.57 | 2.60 |
| Gravity? g/cm³ | | | | | | | | | | |
| Yong's Modulus | 82.1 | 85.9 | 87.1 | 86.2 | 83.2 | 78.9 | 80.4 | 82.7 | 78.7 | 79.0 |
| E?? Pa | | | | | | | | | | |
| Elastic Modulus | 31.8 | 32.3 | 32.9 | 32.0 | 31.4 | 30.3 | 29.7 | 32.4 | 30.6 | 30.4 |
| Ratio | | | | | | | | | | |
| C.T.E | 89 | 73 | 76 | 75 | 88 | 114 | 96 | 76 | 105 | 108 |
| Amount of | 63 | 55 | 55 | 55 | 59 | 61 | 61 | 55 | 59 | 64 |
| Migration of alkali | | | | | | | | | | |
| metal [ppb] | | | | | | | | | | |
| P/Pli | 1.1 | 1.1 | 1.1 | 1.1 | 1.1 | 1.2 | 1.1 | 1.1 | 1.2 | 1.2 |

TABLE 105

| | B-391 | B-392 | B-393 | B-394 | B-395 | B-396 | B-397 | B-398 | B-399 | B-400 | B-401 |
|---|---|---|---|---|---|---|---|---|---|---|---|
| SiO₂ | 55.0 | 60.0 | 65.0 | 60.0 | 59.0 | 62.0 | 65.0 | 63.0 | 60.0 | 63.0 | 63.0 |
| Bl₂O₃ | 6.0 | 5.0 | 3.5 | 3.0 | 5.0 | 10.0 | 7.6 | 6.0 | 5.5 | 6.0 | 6.0 |
| MgO | 3.0 | 2.5 | 2.5 | 2.5 | 1.0 | 2.5 | 2.0 | 1.0 | 1.0 | 2.0 | 2.0 |
| CaO | 2.0 | 1.0 | | | 2.0 | | | 0.5 | 1.0 | 0.8 | 0.9 |
| BaO | 2.0 | 1.0 | 3.0 | 3.0 | 2.3 | 3.0 | 2.5 | 1.5 | 0.5 | 2.0 | 2.0 |
| SrO | | | 2.0 | 2.1 | 1.8 | 2.0 | 1.7 | | | | |
| ZnO | 13.0 | 10.0 | 7.0 | 7.2 | 7.5 | 6.2 | 5.0 | 15.0 | 20.0 | 10.0 | 10.0 |
| Li₂O | 7.0 | 7.0 | 7.5 | 7.4 | 7.4 | 7.2 | 7.0 | 6.0 | 6.0 | 4.0 | 6.0 |
| K₂O | 0.5 | 1.0 | 2.5 | 2.6 | 2.6 | | 2.2 | | | 2.1 | 2.0 |
| B₂O₃ | 3.5 | 2.0 | | 3.0 | 1.0 | | | 1.0 | 1.0 | 2.0 | 2.0 |
| TiO₂ | 2.0 | 2.0 | | 2.0 | 3.0 | | | 2.0 | 1.0 | 2.0 | |
| ZrO₂ | 2.5 | 4.5 | 3.0 | 3.2 | 3.4 | 3.1 | 4.0 | 1.0 | 1.0 | 3.0 | 3.0 |
| P₂O₅ | 2.0 | 2.5 | 2.5 | 2.6 | 2.6 | 2.5 | 2.1 | 2.1 | 2.1 | 2.1 | 2.1 |
| Y₂O₃ | | | | | | | | | | | |
| Nb₂O₅ | 1.0 | 1.0 | 1.0 | 1.0 | 1.0 | 1.0 | 0.5 | 0.5 | 0.5 | 0.5 | 0.5 |
| Ta₂O₅ | | | | | | | | | | | |
| La₂O₃ | | | | | | | | | | | |
| Sb₂O₃ | 0.4 | 0.5 | 0.5 | 0.5 | 0.5 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time? hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time? hr? | | | | | | | | | | | |
| Nucleous | 750 | 750 | 750 | 750 | 750 | 750 | 750 | 750 | 750 | 750 | 750 |
| Growing | | | | | | | | | | | |
| Temperature??? | | | | | | | | | | | |
| Nucleous | 3 | 3 | 3 | 3 | 3 | 3 | 3 | 3 | 3 | 3 | 3 |
| Growing | | | | | | | | | | | |
| Time? hr? | | | | | | | | | | | |
| Main Crystalline | LZS | Crist | Crist | Crist | Crist | Crist | Crist | LZS | LZS | Crist | Crist |
| Phase | | | | | | | | | | | |
| Sub Crystalline | — | LZS | LZS | LZS | LZS | LZS | LZS | — | — | LZS | LZS |
| Phase | | | | | | | | | | | |
| Specific | 2.70 | 2.65 | 2.57 | 2.61 | 2.62 | 2.57 | 2.52 | 2.66 | 2.71 | 2.65 | 2.61 |
| Gravity? g/cm₃ | | | | | | | | | | | |
| Yong's Modulus | 87.6 | 86.0 | 83.5 | 85.7 | 85.3 | 82.8 | 79.1 | 86.8 | 87.8 | 82.9 | 81.9 |
| E?? Pa | | | | | | | | | | | |
| Elastic Modulus | 32.4 | 32.4 | 32.4 | 32.8 | 32.5 | 32.2 | 31.3 | 32.6 | 32.4 | 31.2 | 31.3 |
| Ratio | | | | | | | | | | | |
| C.T.E | 70 | 77 | 81 | 81 | 78 | 85 | 113 | 71 | 69 | 80 | 82 |
| Amount of | 48 | 49 | 50 | 50 | 49 | 51 | 57 | 48 | 47 | 50 | 50 |
| Migration of | | | | | | | | | | | |
| alkali metal | | | | | | | | | | | |
| [ppb] | | | | | | | | | | | |
| P/Pli | 1.1 | 1.1 | 1.2 | 1.2 | 1.1 | 1.2 | 1.3 | 1.1 | 1.1 | 1.2 | 1.2 |

TABLE 106

| | B-402 | B-403 | B-404 | B-405 | B-406 | B-407 | B-408 | B-409 | B-410 | B-411 |
|---|---|---|---|---|---|---|---|---|---|---|
| SiO₂ | 63.0 | 58.0 | 61.0 | 60.0 | 62.0 | 64.2 | 63.0 | 64.0 | 64.2 | 60.0 |
| Bl₂O₃ | 9.0 | 6.5 | 5.0 | 6.0 | 7.1 | 7.3 | 7.0 | 6.0 | 7.3 | 6.0 |
| MgO | 2.0 | 2.4 | 2.3 | 1.6 | 2.1 | 0.0 | 2.1 | 1.6 | 1.9 | 1.5 |
| CaO | 0.9 | | 1.1 | 2.0 | 1.0 | 3.5 | 1.0 | 2.0 | | 1.0 |
| BaO | 2.0 | 2.5 | 2.0 | | | 2.4 | | | 2.4 | |
| SrO | | 2.0 | | 1.5 | | | | 1.5 | 1.6 | 1.5 |
| ZnO | 7.5 | 8.0 | 10.0 | 9.0 | 6.4 | 5.7 | 5.5 | 9.0 | 5.7 | 7.0 |
| Li₂O | 8.0 | 7.1 | 7.0 | 6.9 | 7.0 | 5.8 | 7.0 | 6.9 | 5.8 | 6.9 |
| K₂O | 1.5 | 2.5 | 2.0 | 2.4 | 2.5 | 2.0 | 2.2 | 2.0 | 2.0 | 2.4 |
| B₂O₃ | | 3.0 | 3.0 | 1.0 | 1.0 | | 1.0 | 1.0 | | 1.0 |
| TiO₂ | | 3.0 | | 1.0 | 2.0 | | | 1.0 | | 1.0 |
| ZrO₂ | 3.0 | 1.1 | 3.2 | 5.0 | 3.5 | 2.5 | 3.7 | 3.5 | 2.5 | 3.3 |
| P₂O₅ | 2.1 | 2.5 | 2.0 | 2.2 | 1.0 | 2.0 | 3.0 | 1.0 | 2.0 | 3.0 |
| Y₂O₃ | | | | | | | | | | |
| Nb₂O₅ | 0.5 | 1.0 | 1.0 | 1.0 | 4.0 | 4.1 | 4.0 | 0.1 | 4.1 | 5.0 |
| Ta₂O₅ | | | | | | | | | | |
| La₂O₃ | | | | | | | | | | |
| Sb₂O₃ | 0.4 | 0.5 | 0.4 | 0.4 | 0.4 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time? hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time? hr? | | | | | | | | | | |
| Nucleous Growing | 750 | 750 | 750 | 750 | 750 | 750 | 750 | 750 | 750 | 750 |
| Temperature??? | | | | | | | | | | |
| Nucleous Growing | 3 | 3 | 3 | 3 | 3 | 3 | 3 | 3 | 3 | 3 |
| Time? hr? | | | | | | | | | | |
| Main Crystalline | Crist | Crist | Crist | Crist | Crist | Crist | Crist | Crist | Crist | Crist |
| Phase | | | | | | | | | | |
| Sub Crystalline | LZS | LZS | LZS | LZS | LZS | LZS | LZS | LZS | Quartz | Quartz |
| Phase | | | | | | | | | | |
| Specific | 2.57 | 2.65 | 2.64 | 2.68 | 2.64 | 2.59 | 2.70 | 2.54 | 2.56 | 2.59 |
| Gravity? g/cm₃ | | | | | | | | | | |
| Yong's Modulus | 81.8 | 85.6 | 86.8 | 85.9 | 82.9 | 78.6 | 80.1 | 82.4 | 78.4 | 78.7 |
| E?? Pa | | | | | | | | | | |
| Elastic Modulus | 31.8 | 32.3 | 32.8 | 32.0 | 31.4 | 30.3 | 29.6 | 32.4 | 30.6 | 30.3 |
| Ratio | | | | | | | | | | |
| C.T.E | 91 | 78 | 80 | 80 | 90 | 116 | 97 | 80 | 112 | 107 |
| Amount of | 52 | 49 | 50 | 50 | 52 | 57 | 53 | 50 | 57 | 55 |
| Migration of alkali | | | | | | | | | | |
| metal [ppb] | | | | | | | | | | |
| P/Pli | 1.2 | 1.1 | 1.2 | 1.1 | 1.2 | 1.3 | 1.2 | 1.2 | 1.3 | 1.3 |

TABLE 107

| | B-412 | B-413 | B-414 | B-415 | B-416 | B-417 | B-418 | B-419 | B-420 | B-421 | B-422 |
|---|---|---|---|---|---|---|---|---|---|---|---|
| SiO₂ | 55.0 | 60.0 | 65.0 | 60.0 | 59.0 | 62.0 | 65.0 | 63.0 | 60.0 | 63.0 | 63.0 |
| Bl₂O₃ | 6.0 | 5.0 | 3.5 | 3.0 | 5.0 | 10.0 | 7.6 | 6.0 | 5.5 | 6.0 | 6.0 |
| MgO | 3.0 | 2.5 | 2.5 | 2.5 | 1.0 | 2.5 | 2.0 | 1.0 | 1.0 | 2.0 | 2.0 |
| CaO | 2.0 | 1.0 | | | 2.0 | | | 0.5 | 1.0 | 0.8 | 0.9 |
| BaO | 2.0 | 1.0 | 3.0 | 3.0 | 2.3 | 3.0 | 2.5 | 1.5 | 0.5 | 2.0 | 2.0 |
| SrO | | | 2.0 | 2.1 | 1.8 | 2.0 | 1.7 | | | | |
| ZnO | 13.0 | 10.0 | 7.0 | 7.2 | 7.5 | 6.2 | 5.0 | 15.0 | 20.0 | 10.0 | 10.0 |
| Li₂O | 7.0 | 7.0 | 7.5 | 7.4 | 7.4 | 7.2 | 7.0 | 6.0 | 6.0 | 4.0 | 6.0 |
| K₂O | 0.5 | 1.0 | 2.5 | 2.6 | 2.6 | | 2.2 | | | 2.1 | 2.0 |
| B₂O₃ | 3.5 | 2.0 | | 3.0 | 1.0 | | | 1.0 | 1.0 | 2.0 | 2.0 |
| TiO₂ | 2.0 | 2.0 | | 2.0 | 3.0 | | | 2.0 | 1.0 | 2.0 | |
| ZrO₂ | 2.5 | 4.5 | 3.0 | 3.2 | 3.4 | 3.1 | 4.0 | 1.0 | 1.0 | 3.0 | 3.0 |
| P₂O₅ | 2.0 | 2.5 | 2.5 | 2.6 | 2.6 | 2.5 | 2.1 | 2.1 | 2.1 | 2.1 | 2.1 |
| Y₂O₃ | | | | | | | | | | | |
| Nb₂O₅ | 1.0 | 1.0 | 1.0 | 1.0 | 1.0 | 1.0 | 0.5 | 0.5 | 0.5 | 0.5 | 0.5 |
| Ta₂O₅ | | | | | | | | | | | |
| La₂O₃ | | | | | | | | | | | |
| Sb₂O₃ | 0.4 | 0.5 | 0.5 | 0.5 | 0.5 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time? hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time? hr? | | | | | | | | | | | |
| Nucleous | 720 | 720 | 720 | 720 | 720 | 720 | 720 | 720 | 720 | 720 | 720 |
| Growing | | | | | | | | | | | |
| Temperature??? | | | | | | | | | | | |
| Nucleous | 10 | 10 | 10 | 10 | 10 | 10 | 10 | 10 | 10 | 10 | 10 |
| Growing | | | | | | | | | | | |
| Time? hr? | | | | | | | | | | | |
| Main Crystalline | LZS | Crist | Crist | LZS | LZS | Crist | Crist | LZS | LZS | Crist | Crist |
| Phase | | | | | | | | | | | |
| Sub Crystalline | — | LZS | LZS | Crist | Crist | LZS | LZS | — | — | LZS | LZS |
| Phase | | | | | | | | | | | |
| Specific | 2.70 | 2.65 | 2.57 | 2.61 | 2.62 | 2.57 | 2.52 | 2.66 | 2.71 | 2.65 | 2.61 |
| Gravity? g/cm₃ | | | | | | | | | | | |
| Yong's Modulus | 87.7 | 86.0 | 83.5 | 85.7 | 85.3 | 82.8 | 79.1 | 86.8 | 87.9 | 82.9 | 81.9 |
| E?? Pa | | | | | | | | | | | |
| Elastic Modulus | 32.4 | 32.4 | 32.4 | 32.8 | 32.5 | 32.2 | 31.3 | 32.6 | 32.4 | 31.2 | 31.3 |
| Ratio | | | | | | | | | | | |
| C.T.E | 69 | 76 | 81 | 72 | 72 | 85 | 112 | 70 | 68 | 80 | 81 |
| Amount of | 47 | 49 | 50 | 48 | 48 | 51 | 57 | 48 | 47 | 50 | 50 |
| Migration of | | | | | | | | | | | |
| alkali metal | | | | | | | | | | | |
| [ppb] | | | | | | | | | | | |
| P/li | 1.1 | 1.1 | 1.2 | 1.1 | 1.1 | 1.2 | 1.3 | 1.1 | 1.1 | 1.1 | 1.2 |

TABLE 108

| | B-423 | B-424 | B-425 | B-426 | B-427 | B-428 | B-429 | B-430 | B-431 | B-432 |
|---|---|---|---|---|---|---|---|---|---|---|
| SiO₂ | 63.0 | 58.0 | 61.0 | 60.0 | 62.0 | 64.2 | 63.0 | 64.0 | 64.2 | 60.0 |
| Bl₂O₃ | 9.0 | 6.5 | 5.0 | 6.0 | 7.1 | 7.3 | 7.0 | 6.0 | 7.3 | 6.0 |
| MgO | 2.0 | 2.4 | 2.3 | 1.6 | 2.1 | 0.0 | 2.1 | 1.6 | 1.9 | 1.5 |
| CaO | 0.9 | | 1.1 | 2.0 | 1.0 | 3.5 | 1.0 | 2.0 | | 1.0 |
| BaO | 2.0 | 2.5 | 2.0 | | | 2.4 | | | 2.4 | |
| SrO | | 2.0 | | 1.5 | | | | 1.5 | 1.6 | 1.5 |
| ZnO | 7.5 | 8.0 | 10.0 | 9.0 | 6.4 | 5.7 | 5.5 | 9.0 | 5.7 | 7.0 |
| Li₂O | 8.0 | 7.1 | 7.0 | 6.9 | 7.0 | 5.8 | 7.0 | 6.9 | 5.8 | 6.9 |
| K₂O | 1.5 | 2.5 | 2.0 | 2.4 | 2.5 | 2.0 | 2.2 | 2.0 | 2.0 | 2.4 |
| B₂O₃ | | 3.0 | 3.0 | 1.0 | 1.0 | | 1.0 | 1.0 | | 1.0 |
| TiO₂ | | 3.0 | | 1.0 | 2.0 | | | 1.0 | | 1.0 |
| ZrO₂ | 3.0 | 1.1 | 3.2 | 5.0 | 3.5 | 2.5 | 3.7 | 3.5 | 2.5 | 3.3 |
| P₂O₅ | 2.1 | 2.5 | 2.0 | 2.2 | 1.0 | 2.0 | 3.0 | 1.0 | 2.0 | 3.0 |
| Y₂O₃ | | | | | | | | | | |
| Nb₂O₅ | 0.5 | 1.0 | 1.0 | 1.0 | 4.0 | 4.1 | 4.0 | 0.1 | 4.1 | 5.0 |
| Ta₂O₅ | | | | | | | | | | |
| La₂O₃ | | | | | | | | | | |
| Sb₂O₃ | 0.4 | 0.5 | 0.4 | 0.4 | 0.4 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time? hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time? hr? | | | | | | | | | | |
| Nucleous Growing | 720 | 720 | 720 | 720 | 720 | 720 | 720 | 720 | 720 | 720 |
| Temperature??? | | | | | | | | | | |
| Nucleous Growing | 10 | 10 | 10 | 10 | 10 | 10 | 10 | 10 | 10 | 10 |
| Time? hr? | | | | | | | | | | |
| Main Crystalline | Crist | Crist | Crist | Crist | Crist | Crist | Crist | Crist | Crist | Crist |
| Phase | | | | | | | | | | |
| Sub Crystalline | LZS | LZS | LZS | LZS | LZS | LZS | LZS | LZS | LZS | LZS |
| Phase | | | | | | | | | | |
| Specific | 2.57 | 2.65 | 2.64 | 2.68 | 2.64 | 2.59 | 2.70 | 2.54 | 2.56 | 2.59 |
| Gravity? g/cm₃ | | | | | | | | | | |
| Yong's Modulus | 81.8 | 85.6 | 86.8 | 85.9 | 82.9 | 78.6 | 80.1 | 82.4 | 78.4 | 78.7 |
| E?? Pa | | | | | | | | | | |
| Elastic Modulus | 31.8 | 32.3 | 32.8 | 32.0 | 31.4 | 30.3 | 29.6 | 32.4 | 30.6 | 30.3 |
| Ratio | | | | | | | | | | |
| C.T.E | 91 | 77 | 80 | 79 | 90 | 115 | 97 | 80 | 110 | 107 |
| Amount of | 52 | 49 | 50 | 50 | 52 | 57 | 53 | 50 | 56 | 56 |
| Migration of alkali | | | | | | | | | | |
| metal [ppb] | | | | | | | | | | |
| P/Pli | 1.2 | 1.1 | 1.1 | 1.1 | 1.2 | 1.3 | 1.2 | 1.1 | 1.3 | 1.3 |

Tables 109 and 110 show the glass compositions in % by weight of respective crystallized glass substrates of B-433 to 453, together with the manufacturing conditions employed. Tables 111 and 112 show crystallized glass substrates as B-454 to 474 manufactured using the same glass compositions as those of B-433 to 453 with the nucleus growing temperature varied from that employed for B-433 to 453. Further, Tables 113 and 114 show crystallized glass substrates as B-475 to 495 manufactured using the same glass compositions as those of B-433 to 453 with the nucleus growing time varied from that employed for B-433 to 453.

TABLE 109

| | B-433 | B-434 | B-435 | B-436 | B-437 | B-438 | B-439 | B-440 | B-441 | B-442 | B-443 |
|---|---|---|---|---|---|---|---|---|---|---|---|
| SiO₂ | 55.0 | 60.0 | 65.0 | 60.0 | 59.0 | 62.0 | 65.0 | 63.0 | 60.0 | 63.0 | 63.0 |
| Bl₂O₃ | 6.0 | 5.0 | 3.5 | 3.0 | 5.0 | 10.0 | 7.6 | 6.0 | 5.5 | 6.0 | 6.0 |
| MgO | 3.0 | 2.5 | 2.5 | 2.5 | 1.0 | 2.5 | 2.0 | 1.0 | 1.0 | 2.0 | 2.0 |
| CaO | 2.0 | 1.0 | | | 2.0 | | | 0.5 | 1.0 | 0.8 | 0.9 |
| BaO | 2.0 | 1.0 | 3.0 | 3.0 | 2.3 | 3.0 | 2.5 | 1.5 | 0.5 | 2.0 | 2.0 |
| SrO | | | 2.0 | 2.1 | 1.8 | 2.0 | 1.7 | | | | |
| ZnO | 13.0 | 10.0 | 7.0 | 7.2 | 7.5 | 6.2 | 5.0 | 15.0 | 20.0 | 10.0 | 10.0 |
| Li₂O | 7.0 | 7.0 | 7.5 | 7.4 | 7.4 | 7.2 | 7.0 | 6.0 | 6.0 | 4.0 | 6.0 |
| K₂O | 0.5 | 1.0 | 2.5 | 2.6 | 2.6 | | 2.2 | | | 2.1 | 2.0 |
| B₂O₃ | 3.5 | 2.0 | | 3.0 | 1.0 | | | 1.0 | 1.0 | 2.0 | 2.0 |
| TiO₂ | 2.0 | 2.0 | | 2.0 | 3.0 | | | 2.0 | 1.0 | 2.0 | |
| ZrO₂ | 2.5 | 4.5 | 3.0 | 3.2 | 3.4 | 3.1 | 4.0 | 1.0 | 1.0 | 3.0 | 3.0 |
| P₂O₅ | 2.0 | 2.5 | 2.5 | 2.6 | 2.6 | 2.5 | 2.1 | 2.1 | 2.1 | 2.1 | 2.1 |
| Y₂O₃ | | | | | | | | | | | |
| Nb₂O₅ | | | | | | | | | | | |
| Ta₂O₅ | 1.0 | 1.0 | 1.0 | 1.0 | 1.0 | 1.0 | 0.5 | 0.5 | 0.5 | 0.5 | 0.5 |
| La₂O₃ | | | | | | | | | | | |
| Sb₂O₃ | 0.4 | 0.5 | 0.5 | 0.5 | 0.5 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time? hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time? hr? | | | | | | | | | | | |
| Nucleous | 720 | 720 | 720 | 720 | 720 | 720 | 720 | 720 | 720 | 720 | 720 |
| Growing | | | | | | | | | | | |
| Temperature??? | | | | | | | | | | | |
| Nucleous | 3 | 3 | 3 | 3 | 3 | 3 | 3 | 3 | 3 | 3 | 3 |
| Growing | | | | | | | | | | | |
| Time? hr? | | | | | | | | | | | |
| Main Crystalline | LZS | LZS | LZS | LZS | LZS | LZS | Crist | LZS | LZS | LZS | LZS |
| Phase | | | | | | | | | | | |
| Sub Crystalline | — | Crist | Crist | — | — | Crist | LZS | — | — | Crist | Crist |
| Phase | | | | | | | | | | | |
| Specific | 2.73 | 2.67 | 2.60 | 2.66 | 2.65 | 2.59 | 2.53 | 2.68 | 2.73 | 2.66 | 2.62 |
| Gravity? g/cm₃ | | | | | | | | | | | |
| Yong's Modulus | 88.6 | 86.8 | 84.2 | 86.2 | 85.6 | 84.8 | 79.4 | 87.1 | 87.8 | 83.6 | 82.2 |
| E?? Pa | | | | | | | | | | | |
| Elastic Modulus | 32.5 | 32.5 | 32.4 | 32.4 | 32.3 | 32.7 | 31.4 | 32.5 | 32.2 | 31.4 | 31.4 |
| Ratio | | | | | | | | | | | |
| C.T.E | 61 | 68 | 76 | 61 | 63 | 74 | 109 | 61 | 60 | 72 | 75 |
| Amount of | 51 | 53 | 57 | 52 | 53 | 55 | 65 | 48 | 48 | 45 | 52 |
| Migration of | | | | | | | | | | | |
| alkali metal | | | | | | | | | | | |
| [ppb] | | | | | | | | | | | |
| P/Pli | 1.0 | 1.0 | 1.1 | 1.0 | 1.0 | 1.1 | 1.2 | 1.0 | 1.0 | 1.1 | 1.1 |

TABLE 110

| | B-444 | B-445 | B-446 | B-447 | B-448 | B-449 | B-450 | B-451 | B-452 | B-453 |
|---|---|---|---|---|---|---|---|---|---|---|
| SiO₂ | 63.0 | 58.0 | 61.0 | 60.0 | 62.0 | 60.0 | 64.0 | 64.0 | 60.0 | 60.0 |
| Bl₂O₃ | 9.0 | 6.5 | 5.0 | 6.0 | 7.1 | 7.8 | 8.0 | 6.0 | 6.0 | 6.0 |
| MgO | 2.0 | 2.4 | 2.3 | 1.6 | 2.1 | 2.1 | 2.1 | 1.6 | 1.5 | 1.5 |
| CaO | 0.9 | | 1.1 | 2.0 | 1.0 | 1.7 | 1.0 | 2.0 | 2.0 | 1.0 |
| BaO | 2.0 | 2.5 | 2.0 | | | | | | | |
| SrO | | 2.0 | | 1.5 | | | | 1.5 | 2.0 | 1.5 |
| ZnO | 7.5 | 8.0 | 10.0 | 9.0 | 6.4 | 6.2 | 6.5 | 9.0 | 9.0 | 7.0 |
| Li₂O | 8.0 | 7.1 | 7.0 | 6.9 | 7.0 | 7.5 | 7.0 | 6.9 | 6.7 | 6.9 |
| K₂O | 1.5 | 2.5 | 2.0 | 2.4 | 2.5 | 2.2 | 2.2 | 2.0 | 2.4 | 2.4 |
| B₂O₃ | | 3.0 | 3.0 | 1.0 | 3.0 | 3.0 | 1.0 | 1.0 | 1.0 | 1.0 |
| TiO₂ | | 3.0 | | 1.0 | 3.0 | 3.0 | | 1.0 | 1.0 | 1.0 |
| ZrO₂ | 3.0 | 1.1 | 3.2 | 5.0 | 3.5 | 3.0 | 3.7 | 3.5 | 3.0 | 3.3 |
| P₂O₅ | 2.1 | 2.5 | 2.0 | 2.2 | 1.0 | 2.0 | 3.0 | 1.0 | 2.0 | 3.0 |
| Y₂O₃ | | | | | | | | | | |
| Nb₂O₅ | | | | | | | | | | |
| Ta₂O₅ | 0.5 | 1.0 | 1.0 | 1.0 | 1.0 | 1.0 | 1.0 | 0.1 | 3.0 | 5.0 |
| La₂O₃ | | | | | | | | | | |
| Sb₂O₃ | 0.4 | 0.5 | 0.4 | 0.4 | 0.4 | 0.4 | 0.4 | | | |
| Total (100 wt %) | 100.0 | 100.0 | 100.0 | 100.0 | 100.0 | 100.0 | 100.0 | 99.6 | 99.6 | 99.6 |
| Melting | 1550 | 1550 | 1550 | 1550 | 1550 | 1550 | 1550 | 1550 | 1550 | 1550 |
| Temperature??? | | | | | | | | | | |
| Melting Time? hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time? hr? | | | | | | | | | | |
| Nucleous Growing | 720 | 720 | 720 | 720 | 720 | 720 | 720 | 720 | 720 | 720 |
| Temperature??? | | | | | | | | | | |
| Nucleous Growing | 3 | 3 | 3 | 3 | 3 | 3 | 3 | 3 | 3 | 3 |
| Time? hr? | | | | | | | | | | |
| Main Crystalline | Crist | LZS | LZS | LZS | Crist | Crist | Crist | LZS | Crist | Crist |
| Phase | | | | | | | | | | |
| Sub Crystalline | LZS | Crist | — | — | LZS | LZS | LZS | Crist | LZS | LZS |
| Phase | | | | | | | | | | |
| Specific | 2.58 | 2.66 | 2.65 | 2.69 | 2.65 | 2.63 | 2.62 | 2.53 | 2.62 | 2.66 |
| Gravity? g/cm₃ | | | | | | | | | | |
| Yong's Modulus | 83.1 | 84.0 | 86.2 | 87.3 | 83.2 | 79.3 | 78.8 | 81.3 | 78.7 | 79.0 |
| E?? Pa | | | | | | | | | | |
| Elastic Modulus | 32.2 | 31.6 | 32.5 | 32.5 | 31.4 | 30.2 | 30.1 | 32.1 | 30.0 | 29.7 |
| Ratio | | | | | | | | | | |
| C.T.E | 88 | 73 | 68 | 70 | 78 | 77 | 102 | 73 | 89 | 92 |
| Amount of | 63 | 55 | 53 | 53 | 56 | 57 | 63 | 54 | 58 | 60 |
| Migration of alkali | | | | | | | | | | |
| metal [ppb] | | | | | | | | | | |
| P/Pli | 1.1 | 1.1 | 1.0 | 1.0 | 1.1 | 1.1 | 1.2 | 1.1 | 1.1 | 1.1 |

TABLE 111

| | B-454 | B-455 | B-456 | B-457 | B-458 | B-459 | B-460 | B-461 | B-462 | B-463 | B-464 |
|---|---|---|---|---|---|---|---|---|---|---|---|
| SiO₂ | 55.0 | 60.0 | 65.0 | 60.0 | 59.0 | 62.0 | 65.0 | 63.0 | 60.0 | 63.0 | 63.0 |
| Bl₂O₃ | 6.0 | 5.0 | 3.5 | 3.0 | 5.0 | 10.0 | 7.6 | 6.0 | 5.5 | 6.0 | 6.0 |
| MgO | 3.0 | 2.5 | 2.5 | 2.5 | 1.0 | 2.5 | 2.0 | 1.0 | 1.0 | 2.0 | 2.0 |
| CaO | 2.0 | 1.0 | | | 2.0 | | | 0.5 | 1.0 | 0.8 | 0.9 |
| BaO | 2.0 | 1.0 | 3.0 | 3.0 | 2.3 | 3.0 | 2.5 | 1.5 | 0.5 | 2.0 | 2.0 |
| SrO | | | 2.0 | 2.1 | 1.8 | 2.0 | 1.7 | | | | |
| ZnO | 13.0 | 10.0 | 7.0 | 7.2 | 7.5 | 6.2 | 5.0 | 15.0 | 20.0 | 10.0 | 10.0 |
| Li₂O | 7.0 | 7.0 | 7.5 | 7.4 | 7.4 | 7.2 | 7.0 | 6.0 | 6.0 | 4.0 | 6.0 |
| K₂0 | 0.5 | 1.0 | 2.5 | 2.6 | 2.6 | | 2.2 | | | 2.1 | 2.0 |
| B₂O₃ | 3.5 | 2.0 | | 3.0 | 1.0 | | | 1.0 | 1.0 | 2.0 | 2.0 |
| TiO₂ | 2.0 | 2.0 | | 2.0 | 3.0 | | | 2.0 | 1.0 | 2.0 | |
| ZrO₂ | 2.5 | 4.5 | 3.0 | 3.2 | 3.4 | 3.1 | 4.0 | 1.0 | 1.0 | 3.0 | 3.0 |
| P₂O₅ | 2.0 | 2.5 | 2.5 | 2.6 | 2.6 | 2.5 | 2.1 | 2.1 | 2.1 | 2.1 | 2.1 |
| Y₂O₃ | | | | | | | | | | | |
| Nb₂O₅ | | | | | | | | | | | |
| Ta₂O₅ | 1.0 | 1.0 | 1.0 | 1.0 | 1.0 | 1.0 | 0.5 | 0.5 | 0.5 | 0.5 | 0.5 |
| La₂O₃ | | | | | | | | | | | |
| Sb₂O₃ | 0.4 | 0.5 | 0.5 | 0.5 | 0.5 | 0.5 | 0.4 | 0.4 | 0.4 | 0.4 | 0.4 |
| Total(100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 750 | 750 | 750 | 750 | 750 | 750 | 750 | 750 | 750 | 750 | 750 |
| Growing | | | | | | | | | | | |
| Temperature??? | | | | | | | | | | | |
| Nucleous | 3 | 3 | 3 | 3 | 3 | 3 | 3 | 3 | 3 | 3 | 3 |
| Growing | | | | | | | | | | | |
| Time?hr? | | | | | | | | | | | |
| Main Crystalline | LZS | Crist | Crist | LZS | LZS | Crist | Crist | LZS | LZS | Crist | Crist |
| Phase | | | | | | | | | | | |
| Sub Crystalline | — | LZS | LZS | Crist | Crist | LZS | LZS | — | — | LZS | LZS |
| Phase | | | | | | | | | | | |
| Specific | 2.72 | 2.66 | 2.59 | 2.65 | 2.64 | 2.58 | 2.52 | 2.67 | 2.72 | 2.65 | 2.61 |
| Gravity?g/cm³ | | | | | | | | | | | |
| Yong's Modulus | 88.2 | 86.5 | 83.9 | 85.9 | 85.3 | 84.5 | 79.1 | 86.8 | 87.4 | 83.3 | 81.9 |
| E??Pa | | | | | | | | | | | |
| Elastic Modulus | 32.4 | 32.5 | 32.3 | 32.4 | 32.3 | 32.7 | 31.3 | 32.5 | 32.1 | 31.4 | 31.3 |
| Ratio | | | | | | | | | | | |
| C.T.E | 70 | 74 | 80 | 70 | 71 | 79 | 108 | 70 | 69 | 77 | 80 |
| Amount of | 48 | 49 | 50 | 48 | 48 | 50 | 56 | 48 | 47 | 49 | 50 |
| Migration of | | | | | | | | | | | |
| alkali metal | | | | | | | | | | | |
| [ppb] | | | | | | | | | | | |
| P/Pli | 1.1 | 1.1 | 1.2 | 1.1 | 1.1 | 1.1 | 1.3 | 1.1 | 1.1 | 1.1 | 1.1 |

TABLE 112

| | B-465 | B-466 | B-467 | B-468 | B-469 | B-470 | B-471 | B-472 | B-473 | B-474 |
|---|---|---|---|---|---|---|---|---|---|---|
| SiO₂ | 63.0 | 58.0 | 61.0 | 60.0 | 62.0 | 60.0 | 64.0 | 64.0 | 60.0 | 60.0 |
| Bl₂O₃ | 9.0 | 6.5 | 5.0 | 6.0 | 7.1 | 7.8 | 8.0 | 6.0 | 6.0 | 6.0 |
| MgO | 2.0 | 2.4 | 2.3 | 1.6 | 2.1 | 2.1 | 2.1 | 1.6 | 1.5 | 1.5 |
| CaO | 0.9 | | 1.1 | 2.0 | 1.0 | 1.7 | 1.0 | 2.0 | 2.0 | 1.0 |
| BaO | 2.0 | 2.5 | 2.0 | | | | | | | |
| SrO | | 2.0 | | 1.5 | | | | 1.5 | 2.0 | 1.5 |
| ZnO | 7.5 | 8.0 | 10.0 | 9.0 | 6.4 | 6.2 | 6.5 | 9.0 | 9.0 | 7.0 |
| Li₂O | 8.0 | 7.1 | 7.0 | 6.9 | 7.0 | 7.5 | 7.0 | 6.9 | 6.7 | 6.9 |
| K₂O | 1.5 | 2.5 | 2.0 | 2.4 | 2.5 | 2.2 | 2.2 | 2.0 | 2.4 | 2.4 |
| B₂O₃ | | 3.0 | 3.0 | 1.0 | 3.0 | 3.0 | 1.0 | 1.0 | 1.0 | 1.0 |
| TiO₂ | | 3.0 | | 1.0 | 3.0 | 3.0 | | 1.0 | 1.0 | 1.0 |
| ZrO₂ | 3.0 | 1.1 | 3.2 | 5.0 | 3.5 | 3.0 | 3.7 | 3.5 | 3.0 | 3.3 |
| P₂O₅ | 2.1 | 2.5 | 2.0 | 2.2 | 1.0 | 2.0 | 3.0 | 1.0 | 2.0 | 3.0 |
| Y₂O₃ | | | | | | | | | | |
| Nb₂O₅ | | | | | | | | | | |
| Ta₂O₅ | 0.5 | 1.0 | 1.0 | 1.0 | 1.0 | 1.0 | 1.0 | 0.1 | 3.0 | 5.0 |
| La₂O₃ | | | | | | | | | | |
| Sb₂O₃ | 0.4 | 0.5 | 0.4 | 0.4 | 0.4 | 0.4 | 0.4 | | | |
| Total(100 wt %) | 100.0 | 100.0 | 100.0 | 100.0 | 100.0 | 100.0 | 100.0 | 99.6 | 99.6 | 99.6 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 750 | 750 | 750 | 750 | 750 | 750 | 750 | 750 | 750 | 750 |
| Temperature??? | | | | | | | | | | |
| Nucleous Growing | 3 | 3 | 3 | 3 | 3 | 3 | 3 | 3 | 3 | 3 |
| Time?hr? | | | | | | | | | | |
| Main Crystalline | Crist | Crist | Crist | Crist | Crist | Crist | Crist | Crist | Crist | Crist |
| Phase | | | | | | | | | | |
| Sub Crystalline | LZS | LZS | LZS | LZS | LZS | LZS | LZS | LZS | LZS | Quartz |
| Phase | | | | | | | | | | |
| Specific | 2.57 | 2.65 | 2.64 | 2.68 | 2.64 | 2.62 | 2.61 | 2.52 | 2.61 | 2.65 |
| Gravity?g/cm³ | | | | | | | | | | |
| Yong's Modulus | 82.8 | 83.7 | 85.9 | 87.0 | 82.9 | 79.0 | 78.5 | 81.0 | 78.4 | 78.7 |
| E??Pa | | | | | | | | | | |
| Elastic Modulus | 32.2 | 31.5 | 32.5 | 32.4 | 31.4 | 30.1 | 30.0 | 32.1 | 30.0 | 29.7 |
| Ratio | | | | | | | | | | |
| C.T.E | 90 | 78 | 74 | 76 | 82 | 81 | 102 | 78 | 91 | 93 |
| Amount of | 52 | 49 | 49 | 49 | 50 | 50 | 54 | 49 | 52 | 53 |
| Migration of alkali | | | | | | | | | | |
| metal [ppb] | | | | | | | | | | |
| P/Pli | 1.2 | 1.1 | 1.1 | 1.1 | 1.2 | 1.2 | 1.2 | 1.1 | 1.2 | 1.2 |

TABLE 113

| | B-475 | B-476 | B-477 | B-478 | B-479 | B-480 | B-481 | B-482 | B-483 | B-484 | B-485 |
|---|---|---|---|---|---|---|---|---|---|---|---|
| SiO₂ | 55.0 | 60.0 | 65.0 | 60.0 | 59.0 | 62.0 | 65.0 | 63.0 | 60.0 | 63.0 | 63.0 |
| Bl₂O₃ | 6.0 | 5.0 | 3.5 | 3.0 | 5.0 | 10.0 | 7.6 | 6.0 | 5.5 | 6.0 | 6.0 |
| MgO | 3.0 | 2.5 | 2.5 | 2.5 | 1.0 | 2.5 | 2.0 | 1.0 | 1.0 | 2.0 | 2.0 |
| CaO | 2.0 | 1.0 | | | 2.0 | | | 0.5 | 1.0 | 0.8 | 0.9 |
| BaO | 2.0 | 1.0 | 3.0 | 3.0 | 2.3 | 3.0 | 2.5 | 1.5 | 0.5 | 2.0 | 2.0 |
| SrO | | | 2.0 | 2.1 | 1.8 | 2.0 | 1.7 | | | | |
| ZnO | 13.0 | 10.0 | 7.0 | 7.2 | 7.5 | 6.2 | 5.0 | 15.0 | 20.0 | 10.0 | 10.0 |
| Li₂O | 7.0 | 7.0 | 7.5 | 7.4 | 7.4 | 7.2 | 7.0 | 6.0 | 6.0 | 4.0 | 6.0 |
| K₂O | 0.5 | 1.0 | 2.5 | 2.6 | 2.6 | | 2.2 | | | 2.1 | 2.0 |
| B₂O₃ | 3.5 | 2.0 | | 3.0 | 1.0 | | | 1.0 | 1.0 | 2.0 | 2.0 |
| TiO₂ | 2.0 | 2.0 | | 2.0 | 3.0 | | | 2.0 | 1.0 | 2.0 | |
| ZrO₂ | 2.5 | 4.5 | 3.0 | 3.2 | 3.4 | 3.1 | 4.0 | 1.0 | 1.0 | 3.0 | 3.0 |
| P₂O₅ | 2.0 | 2.5 | 2.5 | 2.6 | 2.6 | 2.5 | 2.1 | 2.1 | 2.1 | 2.1 | 2.1 |
| Y₂O₃ | | | | | | | | | | | |
| Nb₂O₅ | | | | | | | | | | | |
| Ta₂O₅ | 1.0 | 1.0 | 1.0 | 1.0 | 1.0 | 1.0 | 0.5 | 0.5 | 0.5 | 0.5 | 0.5 |
| La₂O₃ | | | | | | | | | | | |
| Sb₂O₃ | 0.4 | 0.5 | 0.5 | 0.5 | 0.5 | 0.5 | 0.4 | 0.4 | 0.4 | 0.4 | 0.4 |
| Total(100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 720 | 720 | 720 | 720 | 720 | 720 | 720 | 720 | 720 | 720 | 720 |
| Growing | | | | | | | | | | | |
| Temperature??? | | | | | | | | | | | |
| Nucleous | 10 | 10 | 10 | 10 | 10 | 10 | 10 | 10 | 10 | 10 | 10 |
| Growing | | | | | | | | | | | |
| Time?hr? | | | | | | | | | | | |
| Main Crystalline | LZS | Crist | Crist | LZS | LZS | Crist | Crist | LZS | LZS | Crist | Crist |
| Phase | | | | | | | | | | | |
| Sub Crystalline | — | LZS | LZS | Crist | Crist | LZS | LZS | — | — | LZS | LZS |
| Phase | | | | | | | | | | | |
| Specific | 2.72 | 2.66 | 2.59 | 2.65 | 2.64 | 2.58 | 2.52 | 2.67 | 2.72 | 2.65 | 2.61 |
| Gravity?g/cm³ | | | | | | | | | | | |
| Yong's Modulus | 88.3 | 86.5 | 83.9 | 85.9 | 85.3 | 84.5 | 79.1 | 86.8 | 87.5 | 83.3 | 81.9 |
| E??Pa | | | | | | | | | | | |
| Elastic Modulus | 32.4 | 32.5 | 32.3 | 32.4 | 32.3 | 32.7 | 31.3 | 32.5 | 32.1 | 31.4 | 31.3 |
| Ratio | | | | | | | | | | | |
| C.T.E | 69 | 74 | 80 | 69 | 70 | 78 | 108 | 69 | 68 | 77 | 79 |
| Amount of | 47 | 48 | 50 | 47 | 48 | 49 | 56 | 47 | 47 | 49 | 50 |
| Migration of | | | | | | | | | | | |
| alkali metal | | | | | | | | | | | |
| [ppb] | | | | | | | | | | | |
| P/Pli | 1.1 | 1.1 | 1.1 | 1.1 | 1.1 | 1.1 | 1.3 | 1.1 | 1.1 | 1.1 | 1.1 |

TABLE 114

| | B-486 | B-487 | B-488 | B-489 | B-490 | B-491 | B-492 | B-493 | B-494 | B-495 |
|---|---|---|---|---|---|---|---|---|---|---|
| SiO₂ | 63.0 | 58.0 | 61.0 | 60.0 | 62.0 | 60.0 | 64.0 | 64.0 | 60.0 | 60.0 |
| Bl₂O₃ | 9.0 | 6.5 | 5.0 | 6.0 | 7.1 | 7.8 | 8.0 | 6.0 | 6.0 | 6.0 |
| MgO | 2.0 | 2.4 | 2.3 | 1.6 | 2.1 | 2.1 | 2.1 | 1.6 | 1.5 | 1.5 |
| CaO | 0.9 | | 1.1 | 2.0 | 1.0 | 1.7 | 1.0 | 2.0 | 2.0 | 1.0 |
| BaO | 2.0 | 2.5 | 2.0 | | | | | | | |
| SrO | | 2.0 | | 1.5 | | | | 1.5 | 2.0 | 1.5 |
| ZnO | 7.5 | 8.0 | 10.0 | 9.0 | 6.4 | 6.2 | 6.5 | 9.0 | 9.0 | 7.0 |
| Li₂O | 8.0 | 7.1 | 7.0 | 6.9 | 7.0 | 7.5 | 7.0 | 6.9 | 6.7 | 6.9 |
| K₂O | 1.5 | 2.5 | 2.0 | 2.4 | 2.5 | 2.2 | 2.2 | 2.0 | 2.4 | 2.4 |
| B₂O₃ | | 3.0 | 3.0 | 1.0 | 3.0 | 3.0 | 1.0 | 1.0 | 1.0 | 1.0 |
| TiO₂ | | 3.0 | | 1.0 | 3.0 | 3.0 | | 1.0 | 1.0 | 1.0 |
| ZrO₂ | 3.0 | 1.1 | 3.2 | 5.0 | 3.5 | 3.0 | 3.7 | 3.5 | 3.0 | 3.3 |
| P₂O₅ | 2.1 | 2.5 | 2.0 | 2.2 | 1.0 | 2.0 | 3.0 | 1.0 | 2.0 | 3.0 |
| Y₂O₃ | | | | | | | | | | |
| Nb₂O₅ | | | | | | | | | | |
| Ta₂O₅ | 0.5 | 1.0 | 1.0 | 1.0 | 1.0 | 1.0 | 1.0 | 0.1 | 3.0 | 5.0 |
| La₂O₃ | | | | | | | | | | |
| Sb₂O₃ | 0.4 | 0.5 | 0.4 | 0.4 | 0.4 | 0.4 | 0.4 | | | |
| Total(100 wt %) | 100.0 | 100.0 | 100.0 | 100.0 | 100.0 | 100.0 | 100.0 | 99.6 | 99.6 | 99.6 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 720 | 720 | 720 | 720 | 720 | 720 | 720 | 720 | 720 | 720 |
| Temperature??? | | | | | | | | | | |
| Nucleous Growing | 10 | 10 | 10 | 10 | 10 | 10 | 10 | 10 | 10 | 10 |
| Time?hr? | | | | | | | | | | |
| Main Crystalline | Crist | Crist | Crist | Crist | Crist | Crist | Crist | Crist | Crist | Crist |
| Phase | | | | | | | | | | |
| Sub Crystalline | LZS | LZS | LZS | LZS | LZS | LZS | LZS | LZS | LZS | LZS |
| Phase | | | | | | | | | | |
| Specific | 2.57 | 2.65 | 2.64 | 2.68 | 2.64 | 2.62 | 2.61 | 2.52 | 2.61 | 2.65 |
| Gravity?g/cm³ | | | | | | | | | | |
| Yong's Modulus | 82.8 | 83.7 | 85.9 | 87.0 | 82.9 | 79.0 | 78.5 | 81.0 | 78.4 | 78.7 |
| E??Pa | | | | | | | | | | |
| Elastic Modulus | 32.2 | 31.5 | 32.5 | 32.4 | 31.4 | 30.1 | 30.0 | 32.1 | 30.0 | 29.7 |
| Ratio | | | | | | | | | | |
| C.T.E | 90 | 77 | 74 | 75 | 81 | 81 | 102 | 77 | 91 | 93 |
| Amount of | 52 | 49 | 48 | 49 | 50 | 50 | 54 | 49 | 52 | 53 |
| Migration of alkali | | | | | | | | | | |
| metal [ppb] | | | | | | | | | | |
| P/Pli | 1.2 | 1.1 | 1.1 | 1.1 | 1.2 | 1.2 | 1.2 | 1.1 | 1.2 | 1.2 |

Tables 115 and 116 show the glass compositions in % by weight of respective crystallized glass substrates of B-496 to 516, together with the manufacturing conditions employed. Tables 117 and 118 show crystallized glass substrates as B-517 to 537 manufactured using the same glass compositions as those of B-496 to 516 with the nucleus growing temperature varied from that employed for B-496 to 516. Further, Tables 119 and 120 show crystallized glass substrates as B-538 to 558 manufactured using the same glass compositions as those of B-496 to 516 with the nucleus growing time varied from that employed for B-496 to 516.

TABLE 115

| | B-496 | B-497 | B-498 | B-499 | B-500 | B-501 | B-502 | B-503 | B-504 | B-505 | B-506 |
|---|---|---|---|---|---|---|---|---|---|---|---|
| SiO₂ | 55.0 | 60.0 | 65.0 | 60.0 | 59.0 | 62.0 | 65.0 | 63.0 | 60.0 | 63.0 | 63.0 |
| Bl₂O₃ | 6.0 | 5.0 | 3.5 | 3.0 | 5.0 | 10.0 | 7.6 | 6.0 | 5.5 | 6.0 | 6.0 |
| MgO | 3.0 | 2.5 | 2.5 | 2.5 | 1.0 | 2.5 | 2.0 | 1.0 | 1.0 | 2.0 | 2.0 |
| CaO | 2.0 | 1.0 | | | 2.0 | | | 0.5 | 1.0 | 0.8 | 0.9 |
| BaO | 2.0 | 1.0 | 3.0 | 3.0 | 2.3 | 3.0 | 2.5 | 1.5 | 0.5 | 2.0 | 2.0 |
| SrO | | | 2.0 | 2.1 | 1.8 | 2.0 | 1.7 | | | | |
| ZnO | 13.0 | 10.0 | 7.0 | 7.2 | 7.5 | 6.2 | 5.0 | 15.0 | 20.0 | 10.0 | 10.0 |
| Li₂O | 7.0 | 7.0 | 7.5 | 7.4 | 7.4 | 7.2 | 7.0 | 6.0 | 6.0 | 4.0 | 6.0 |
| K₂O | 0.5 | 1.0 | 2.5 | 2.6 | 2.6 | | 2.2 | | | 2.1 | 2.0 |
| B₂O₃ | 3.5 | 2.0 | | 3.0 | 1.0 | | | 1.0 | 1.0 | 2.0 | 2.0 |
| TiO₂ | 2.0 | 2.0 | | 2.0 | 3.0 | | | 2.0 | 1.0 | 2.0 | |
| ZrO₂ | 2.5 | 4.5 | 3.0 | 3.2 | 3.4 | 3.1 | 4.0 | 1.0 | 1.0 | 3.0 | 3.0 |
| P₂O₅ | 2.0 | 2.5 | 2.5 | 2.6 | 2.6 | 2.5 | 2.1 | 2.1 | 2.1 | 2.1 | 2.1 |
| Y₂O₃ | | | | | | | | | | | |
| Nb₂O₅ | | | | | | | | | | | |
| Ta₂O₅ | | | | | | | | | | | |
| La₂O₃ | 1.0 | 1.0 | 1.0 | 1.0 | 1.0 | 1.0 | 0.5 | 0.5 | 0.5 | 0.5 | 0.5 |
| Sb₂O₃ | 0.4 | 0.5 | 0.5 | 0.5 | 0.5 | 0.5 | 0.4 | 0.4 | 0.4 | 0.4 | 0.4 |
| Total(100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 720 | 720 | 720 | 720 | 720 | 720 | 720 | 720 | 720 | 720 | 720 |
| Growing | | | | | | | | | | | |
| Temperature | | | | | | | | | | | |
| Nucleous | 3 | 3 | 3 | 3 | 3 | 3 | 3 | 3 | 3 | 3 | 3 |
| Growing | | | | | | | | | | | |
| Time hr | | | | | | | | | | | |
| Main Crystalline | LZS | LZS | Crist | LZS | LZS | LZS | Crist | LZS | LZS | LZS | LZS |
| Phase | | | | | | | | | | | |
| Sub Crystalline | — | Crist | LZS | — | — | Crist | LZS | — | — | Crist | Crist |
| Phase | | | | | | | | | | | |
| Specific | 2.72 | 2.66 | 2.56 | 2.61 | 2.63 | 2.58 | 2.52 | 2.69 | 2.73 | 2.63 | 2.61 |
| Gravity?g/cm³ | | | | | | | | | | | |
| Yong's Modulus | 87.0 | 85.0 | 84.1 | 85.3 | 85.0 | 83.1 | 77.3 | 87.3 | 87.9 | 84.3 | 83.2 |
| E??Pa | | | | | | | | | | | |
| Elastic Modulus | 32.0 | 32.0 | 32.9 | 32.7 | 32.3 | 32.2 | 30.7 | 32.5 | 32.2 | 32.1 | 31.9 |
| Ratio | | | | | | | | | | | |
| C.T.E | 62 | 73 | 91 | 66 | 73 | 72 | 85 | 62 | 60 | 75 | 71 |
| Amount of | 51 | 54 | 62 | 54 | 56 | 55 | 58 | 49 | 48 | 46 | 51 |
| Migration of | | | | | | | | | | | |
| alkali metal | | | | | | | | | | | |
| [ppb] | | | | | | | | | | | |
| P/Pli | 1.0 | 1.1 | 1.1 | 1.0 | 1.0 | 1.0 | 1.1 | 1.0 | 1.0 | 1.2 | 1.1 |

TABLE 116

| | B-507 | B-508 | B-509 | B-510 | B-511 | B-512 | B-513 | B-514 | B-515 | B-516 |
|---|---|---|---|---|---|---|---|---|---|---|
| SiO₂ | 63.0 | 58.0 | 61.0 | 60.0 | 62.0 | 60.0 | 64.0 | 64.0 | 60.0 | 60.0 |
| Bl₂O₃ | 9.0 | 6.5 | 5.0 | 6.0 | 7.1 | 7.8 | 8.0 | 6.0 | 6.0 | 6.0 |
| MgO | 2.0 | 2.4 | 2.3 | 1.6 | 2.1 | 2.1 | 2.1 | 1.6 | 1.5 | 1.5 |
| CaO | 0.9 | | 1.1 | 2.0 | 1.0 | 1.7 | 1.0 | 2.0 | 2.0 | 1.0 |
| BaO | 2.0 | 2.5 | 2.0 | | | | | | | |
| SrO | | 2.0 | | 1.5 | | | | 1.5 | 2.0 | 1.5 |
| ZnO | 7.5 | 8.0 | 10.0 | 9.0 | 6.4 | 6.2 | 6.5 | 9.0 | 9.0 | 7.0 |
| Li₂O | 8.0 | 7.1 | 7.0 | 6.9 | 7.0 | 7.5 | 7.0 | 6.9 | 6.7 | 6.9 |
| K₂O | 1.5 | 2.5 | 2.0 | 2.4 | 2.5 | 2.2 | 2.2 | 2.0 | 2.4 | 2.4 |
| B₂O₃ | | 3.0 | 3.0 | 1.0 | 3.0 | 3.0 | 1.0 | 1.0 | 1.0 | 1.0 |
| TiO₂ | | 3.0 | | 1.0 | 3.0 | 3.0 | | 1.0 | 1.0 | 1.0 |
| ZrO₂ | 3.0 | 1.1 | 3.2 | 5.0 | 3.5 | 3.0 | 3.7 | 3.5 | 3.0 | 3.3 |
| P₂O₅ | 2.1 | 2.5 | 2.0 | 2.2 | 1.0 | 2.0 | 3.0 | 1.0 | 2.0 | 3.0 |
| Y₂O₃ | | | | | | | | | | |
| Nb₂O₅ | | | | | | | | | | |
| Ta₂O₅ | | | | | | | | | | |
| La₂O₃ | 0.5 | 1.0 | 1.0 | 1.0 | 1.0 | 1.0 | 1.0 | 0.1 | 3.0 | 5.0 |
| Sb₂O₃ | 0.4 | 0.5 | 0.4 | 0.4 | 0.4 | 0.4 | 0.4 | 0.4 | 0.4 | 0.4 |
| Total(100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous | 720 | 720 | 720 | 720 | 720 | 720 | 720 | 720 | 720 | 720 |
| Growing | | | | | | | | | | |
| Temperature??? | | | | | | | | | | |
| Nucleous | 3 | 3 | 3 | 3 | 3 | 3 | 3 | 3 | 3 | 3 |
| Growing Time?hr? | | | | | | | | | | |
| Main Crystalline | Crist | LZS | LZS | LZS | Crist | Crist | Crist | LZS | LZS | LZS |
| Phase | | | | | | | | | | |
| Sub Crystalline | LZS | Crist | Crist | Crist | LZS | LZS | LZS | Crist | — | — |
| Phase | | | | | | | | | | |
| Specific | 2.55 | 2.61 | 2.67 | 2.69 | 2.56 | 2.65 | 2.67 | 2.59 | 2.71 | 2.76 |
| Gravity?g/cm³ | | | | | | | | | | |
| Yong's Modulus | 77.7 | 85.7 | 86.3 | 85.3 | 81.5 | 83.0 | 79.5 | 83.6 | 87.4 | 88.8 |
| E??Pa | | | | | | | | | | |
| Elastic Modulus | 30.5 | 32.8 | 32.3 | 31.7 | 31.8 | 31.3 | 29.8 | 32.3 | 32.3 | 32.2 |
| Ratio | | | | | | | | | | |
| C.T.E | 96 | 72 | 73 | 77 | 80 | 77 | 102 | 78 | 62 | 63 |
| Amount of | 65 | 54 | 54 | 55 | 57 | 57 | 63 | 56 | 50 | 51 |
| Migration of alkali | | | | | | | | | | |
| metal [ppb] | | | | | | | | | | |
| P/Pli | 1.1 | 1.1 | 1.1 | 1.1 | 1.1 | 1.1 | 1.2 | 1.1 | 1.0 | 1.0 |

TABLE 117

| | B-517 | B-518 | B-519 | B-520 | B-521 | B-522 | B-523 | B-524 | B-525 | B-526 | B-527 |
|---|---|---|---|---|---|---|---|---|---|---|---|
| SiO₂ | 55.0 | 60.0 | 65.0 | 60.0 | 59.0 | 62.0 | 65.0 | 63.0 | 60.0 | 63.0 | 63.0 |
| Bl₂O₃ | 6.0 | 5.0 | 3.5 | 3.0 | 5.0 | 10.0 | 7.6 | 6.0 | 5.5 | 6.0 | 6.0 |
| MgO | 3.0 | 2.5 | 2.5 | 2.5 | 1.0 | 2.5 | 2.0 | 1.0 | 1.0 | 2.0 | 2.0 |
| CaO | 2.0 | 1.0 | | | 2.0 | | | 0.5 | 1.0 | 0.8 | 0.9 |
| BaO | 2.0 | 1.0 | 3.0 | 3.0 | 2.3 | 3.0 | 2.5 | 1.5 | 0.5 | 2.0 | 2.0 |
| SrO | | | 2.0 | 2.1 | 1.8 | 2.0 | 1.7 | | | | |
| ZnO | 13.0 | 10.0 | 7.0 | 7.2 | 7.5 | 6.2 | 5.0 | 15.0 | 20.0 | 10.0 | 10.0 |
| Li₂O | 7.0 | 7.0 | 7.5 | 7.4 | 7.4 | 7.2 | 7.0 | 6.0 | 6.0 | 4.0 | 6.0 |
| K₂O | 0.5 | 1.0 | 2.5 | 2.6 | 2.6 | | 2.2 | | | 2.1 | 2.0 |
| B₂O₃ | 3.5 | 2.0 | | 3.0 | 1.0 | | | 1.0 | 1.0 | 2.0 | 2.0 |
| TiO₂ | 2.0 | 2.0 | | 2.0 | 3.0 | | | 2.0 | 1.0 | 2.0 | |
| ZrO₂ | 2.5 | 4.5 | 3.0 | 3.2 | 3.4 | 3.1 | 4.0 | 1.0 | 1.0 | 3.0 | 3.0 |
| P₂O₅ | 2.0 | 2.5 | 2.5 | 2.6 | 2.6 | 2.5 | 2.1 | 2.1 | 2.1 | 2.1 | 2.1 |
| Y₂O₃ | | | | | | | | | | | |
| Nb₂O₅ | | | | | | | | | | | |
| Ta₂O₅ | | | | | | | | | | | |
| La₂O₃ | 1.0 | 1.0 | 1.0 | 1.0 | 1.0 | 1.0 | 0.5 | 0.5 | 0.5 | 0.5 | 0.5 |
| Sb₂O₃ | 0.4 | 0.5 | 0.5 | 0.5 | 0.5 | 0.5 | 0.4 | 0.4 | 0.4 | 0.4 | 0.4 |
| Total(100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 750 | 750 | 750 | 750 | 750 | 750 | 750 | 750 | 750 | 750 | 750 |
| Growing | | | | | | | | | | | |
| Temperature??? | | | | | | | | | | | |
| Nucleous | 3 | 3 | 3 | 3 | 3 | 3 | 3 | 3 | 3 | 3 | 3 |
| Growing | | | | | | | | | | | |
| Time?hr? | | | | | | | | | | | |
| Main Crystalline | LZS | Crist | Crist | LZS | LZS | Crist | Crist | LZS | LZS | Crist | Crist |
| Phase | | | | | | | | | | | |
| Sub Crystalline | — | LZS | LZS | Crist | Crist | LZS | LZS | — | — | LZS | LZS |
| Phase | | | | | | | | | | | |
| Specific | 2.71 | 2.65 | 2.55 | 2.60 | 2.62 | 2.57 | 2.51 | 2.68 | 2.72 | 2.62 | 2.60 |
| Gravity?g/cm³ | | | | | | | | | | | |
| Yong's Modulus | 86.7 | 84.7 | 83.8 | 85.0 | 84.7 | 82.8 | 77.0 | 87.0 | 87.5 | 84.0 | 82.9 |
| E?Pa | | | | | | | | | | | |
| Elastic Modulus | 31.9 | 31.9 | 32.8 | 32.6 | 32.3 | 32.2 | 30.6 | 32.4 | 32.2 | 32.0 | 31.8 |
| Ratio | | | | | | | | | | | |
| C.T.E | 70 | 78 | 92 | 73 | 78 | 77 | 87 | 70 | 69 | 80 | 77 |
| Amount of | 48 | 49 | 52 | 48 | 49 | 49 | 51 | 48 | 47 | 50 | 49 |
| Migration of | | | | | | | | | | | |
| alkali metal | | | | | | | | | | | |
| [ppb] | | | | | | | | | | | |
| P/Pli | 1.1 | 1.1 | 1.2 | 1.1 | 1.1 | 1.1 | 1.2 | 1.1 | 1.1 | 1.1 | 1.1 |

TABLE 118

| | B-528 | B-529 | B-530 | B-531 | B-532 | B-533 | B-534 | B-535 | B-536 | B-537 |
|---|---|---|---|---|---|---|---|---|---|---|
| SiO₂ | 63.0 | 58.0 | 61.0 | 60.0 | 62.0 | 60.0 | 64.0 | 64.0 | 60.0 | 60.0 |
| Bl₂O₃ | 9.0 | 6.5 | 5.0 | 6.0 | 7.1 | 7.8 | 8.0 | 6.0 | 6.0 | 6.0 |
| MgO | 2.0 | 2.4 | 2.3 | 1.6 | 2.1 | 2.1 | 2.1 | 1.6 | 1.5 | 1.5 |
| CaO | 0.9 | | 1.1 | 2.0 | 1.0 | 1.7 | 1.0 | 2.0 | 2.0 | 1.0 |
| BaO | 2.0 | 2.5 | 2.0 | | | | | | | |
| SrO | | 2.0 | | 1.5 | | | | 1.5 | 2.0 | 1.5 |
| ZnO | 7.5 | 8.0 | 10.0 | 9.0 | 6.4 | 6.2 | 6.5 | 9.0 | 9.0 | 7.0 |
| Li₂O | 8.0 | 7.1 | 7.0 | 6.9 | 7.0 | 7.5 | 7.0 | 6.9 | 6.7 | 6.9 |
| K₂O | 1.5 | 2.5 | 2.0 | 2.4 | 2.5 | 2.2 | 2.2 | 2.0 | 2.4 | 2.4 |
| B₂O₃ | | 3.0 | 3.0 | 1.0 | 3.0 | 3.0 | 1.0 | 1.0 | 1.0 | 1.0 |
| TiO₂ | | 3.0 | | 1.0 | 3.0 | 3.0 | | 1.0 | 1.0 | 1.0 |
| ZrO₂ | 3.0 | 1.1 | 3.2 | 5.0 | 3.5 | 3.0 | 3.7 | 3.5 | 3.0 | 3.3 |
| P₂O₅ | 2.1 | 2.5 | 2.0 | 2.2 | 1.0 | 2.0 | 3.0 | 1.0 | 2.0 | 3.0 |
| Y₂O₃ | | | | | | | | | | |
| Nb₂O₅ | | | | | | | | | | |
| Ta₂O₅ | | | | | | | | | | |
| La₂O₃ | 0.5 | 1.0 | 1.0 | 1.0 | 1.0 | 1.0 | 1.0 | 0.1 | 3.0 | 5.0 |
| Sb₂O₃ | 0.4 | 0.5 | 0.4 | 0.4 | 0.4 | 0.4 | 0.4 | 0.4 | 0.4 | 0.4 |
| Total(100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous | 750 | 750 | 750 | 750 | 750 | 750 | 750 | 750 | 750 | 750 |
| Growing | | | | | | | | | | |
| Temperature??? | | | | | | | | | | |
| Nucleous | 3 | 3 | 3 | 3 | 3 | 3 | 3 | 3 | 3 | 3 |
| Growing Time?hr? | | | | | | | | | | |
| Main Crystalline | Crist | Crist | Crist | Crist | Crist | Crist | Crist | Crist | LZS | LZS |
| Phase | | | | | | | | | | |
| Sub Crystalline | LZS | LZS | LZS | LZS | LZS | LZS | LZS | LZS | — | — |
| Phase | | | | | | | | | | |
| Specific | 2.54 | 2.60 | 2.66 | 2.68 | 2.55 | 2.64 | 2.66 | 2.58 | 2.70 | 2.75 |
| Gravity?g/cm³ | | | | | | | | | | |
| Yong's Modulus | 77.4 | 85.4 | 86.0 | 85.0 | 81.2 | 82.7 | 79.2 | 83.3 | 87.1 | 88.4 |
| E??Pa | | | | | | | | | | |
| Elastic Modulus | 30.4 | 32.8 | 32.3 | 31.7 | 31.8 | 31.3 | 29.7 | 32.2 | 32.2 | 32.1 |
| Ratio | | | | | | | | | | |
| C.T.E | 97 | 77 | 78 | 81 | 83 | 81 | 102 | 82 | 70 | 71 |
| Amount of | 53 | 49 | 49 | 50 | 51 | 50 | 54 | 50 | 48 | 48 |
| Migration of alkali | | | | | | | | | | |
| metal [ppb] | | | | | | | | | | |
| P/Pli | 1.2 | 1.1 | 1.1 | 1.2 | 1.2 | 1.2 | 1.2 | 1.2 | 1.1 | 1.1 |

TABLE 119

| | B-538 | B-539 | B-540 | B-541 | B-542 | B-543 | B-544 | B-545 | B-546 | B-547 | B-548 |
|---|---|---|---|---|---|---|---|---|---|---|---|
| SiO₂ | 55.0 | 60.0 | 65.0 | 60.0 | 59.0 | 62.0 | 65.0 | 63.0 | 60.0 | 63.0 | 63.0 |
| Bl₂O₃ | 6.0 | 5.0 | 3.5 | 3.0 | 5.0 | 10.0 | 7.6 | 6.0 | 5.5 | 6.0 | 6.0 |
| MgO | 3.0 | 2.5 | 2.5 | 2.5 | 1.0 | 2.5 | 2.0 | 1.0 | 1.0 | 2.0 | 2.0 |
| CaO | 2.0 | 1.0 | | | 2.0 | | | 0.5 | 1.0 | 0.8 | 0.9 |
| BaO | 2.0 | 1.0 | 3.0 | 3.0 | 2.3 | 3.0 | 2.5 | 1.5 | 0.5 | 2.0 | 2.0 |
| SrO | | | 2.0 | 2.1 | 1.8 | 2.0 | 1.7 | | | | |
| ZnO | 13.0 | 10.0 | 7.0 | 7.2 | 7.5 | 6.2 | 5.0 | 15.0 | 20.0 | 10.0 | 10.0 |
| Li₂O | 7.0 | 7.0 | 7.5 | 7.4 | 7.4 | 7.2 | 7.0 | 6.0 | 6.0 | 4.0 | 6.0 |
| K₂O | 0.5 | 1.0 | 2.5 | 2.6 | 2.6 | | 2.2 | | | 2.1 | 2.0 |
| B₂O₃ | 3.5 | 2.0 | | 3.0 | 1.0 | | | 1.0 | 1.0 | 2.0 | 2.0 |
| TiO₂ | 2.0 | 2.0 | | 2.0 | 3.0 | | | 2.0 | 1.0 | 2.0 | |
| ZrO₂ | 2.5 | 4.5 | 3.0 | 3.2 | 3.4 | 3.1 | 4.0 | 1.0 | 1.0 | 3.0 | 3.0 |
| P₂O₅ | 2.0 | 2.5 | 2.5 | 2.6 | 2.6 | 2.5 | 2.1 | 2.1 | 2.1 | 2.1 | 2.1 |
| Y₂O₃ | | | | | | | | | | | |
| Nb₂O₅ | | | | | | | | | | | |
| Ta₂O₅ | | | | | | | | | | | |
| La₂O₃ | 1.0 | 1.0 | 1.0 | 1.0 | 1.0 | 1.0 | 0.5 | 0.5 | 0.5 | 0.5 | 0.5 |
| Sb₂O₃ | 0.4 | 0.5 | 0.5 | 0.5 | 0.5 | 0.5 | 0.4 | 0.4 | 0.4 | 0.4 | 0.4 |
| Total(100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 720 | 720 | 720 | 720 | 720 | 720 | 720 | 720 | 720 | 720 | 720 |
| Growing | | | | | | | | | | | |
| Temperature??? | | | | | | | | | | | |
| Nucleous | 10 | 10 | 10 | 10 | 10 | 10 | 10 | 10 | 10 | 10 | 10 |
| Growing | | | | | | | | | | | |
| Time?hr? | | | | | | | | | | | |
| Main Crystalline | LZS | Crist | Crist | LZS | LZS | LZS | Crist | LZS | LZS | Crist | Crist |
| Phase | | | | | | | | | | | |
| Sub Crystalline | — | LZS | LZS | Crist | Crist | Crist | LZS | — | — | LZS | LZS |
| Phase | | | | | | | | | | | |
| Specific | 2.71 | 2.65 | 2.55 | 2.60 | 2.62 | 2.57 | 2.51 | 2.68 | 2.72 | 2.62 | 2.60 |
| Gravity?g/cm³ | | | | | | | | | | | |
| Yong's Modulus | 86.7 | 84.7 | 83.8 | 85.0 | 84.7 | 82.8 | 77.0 | 87.0 | 87.6 | 84.0 | 82.9 |
| E??Pa | | | | | | | | | | | |
| Elastic Modulus | 31.9 | 31.9 | 32.8 | 32.6 | 32.3 | 32.2 | 30.6 | 32.4 | 32.2 | 32.0 | 31.8 |
| Ratio | | | | | | | | | | | |
| C.T.E | 69 | 77 | 92 | 72 | 77 | 77 | 87 | 69 | 68 | 79 | 76 |
| Amount of | 48 | 49 | 52 | 48 | 49 | 49 | 51 | 48 | 47 | 50 | 49 |
| Migration of | | | | | | | | | | | |
| alkali metal | | | | | | | | | | | |
| [ppb] | | | | | | | | | | | |
| P/Pli | 1.1 | 1.1 | 1.2 | 1.1 | 1.1 | 1.1 | 1.2 | 1.1 | 1.1 | 1.1 | 1.1 |

TABLE 120

| | B-549 | B-550 | B-551 | B-552 | B-553 | B-554 | B-555 | B-556 | B-557 | B-558 |
|---|---|---|---|---|---|---|---|---|---|---|
| SiO₂ | 63.0 | 58.0 | 61.0 | 60.0 | 62.0 | 60.0 | 64.0 | 64.0 | 60.0 | 60.0 |
| Bl₂O₃ | 9.0 | 6.5 | 5.0 | 6.0 | 7.1 | 7.8 | 8.0 | 6.0 | 6.0 | 6.0 |
| MgO | 2.0 | 2.4 | 2.3 | 1.6 | 2.1 | 2.1 | 2.1 | 1.6 | 1.5 | 1.5 |
| CaO | 0.9 | | 1.1 | 2.0 | 1.0 | 1.7 | 1.0 | 2.0 | 2.0 | 1.0 |
| BaO | 2.0 | 2.5 | 2.0 | | | | | | | |
| SrO | | 2.0 | | 1.5 | | | | 1.5 | 2.0 | 1.5 |
| ZnO | 7.5 | 8.0 | 10.0 | 9.0 | 6.4 | 6.2 | 6.5 | 9.0 | 9.0 | 7.0 |
| Li₂O | 8.0 | 7.1 | 7.0 | 6.9 | 7.0 | 7.5 | 7.0 | 6.9 | 6.7 | 6.9 |
| K₂O | 1.5 | 2.5 | 2.0 | 2.4 | 2.5 | 2.2 | 2.2 | 2.0 | 2.4 | 2.4 |
| B₂O₃ | | 3.0 | 3.0 | 1.0 | 3.0 | 3.0 | 1.0 | 1.0 | 1.0 | 1.0 |
| TiO₂ | | 3.0 | | 1.0 | 3.0 | 3.0 | | 1.0 | 1.0 | 1.0 |
| ZrO₂ | 3.0 | 1.1 | 3.2 | 5.0 | 3.5 | 3.0 | 3.7 | 3.5 | 3.0 | 3.3 |
| P₂O₅ | 2.1 | 2.5 | 2.0 | 2.2 | 1.0 | 2.0 | 3.0 | 1.0 | 2.0 | 3.0 |
| Y₂O₃ | | | | | | | | | | |
| Nb₂O₅ | | | | | | | | | | |
| Ta₂O₅ | | | | | | | | | | |
| La₂O₃ | 0.5 | 1.0 | 1.0 | 1.0 | 1.0 | 1.0 | 1.0 | 0.1 | 3.0 | 5.0 |
| Sb₂O₃ | 0.4 | 0.5 | 0.4 | 0.4 | 0.4 | 0.4 | 0.4 | 0.4 | 0.4 | 0.4 |
| Total(100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous | 720 | 720 | 720 | 720 | 720 | 720 | 720 | 720 | 720 | 720 |
| Growing | | | | | | | | | | |
| Temperature??? | | | | | | | | | | |
| Nucleous | 10 | 10 | 10 | 10 | 10 | 10 | 10 | 10 | 10 | 10 |
| Growing Time?hr? | | | | | | | | | | |
| Main Crystalline | Crist | Crist | Crist | Crist | Crist | Crist | Crist | Crist | LZS | LZS |
| Phase | | | | | | | | | | |
| Sub Crystalline | LZS | LZS | LZS | LZS | LZS | LZS | LZS | LZS | — | — |
| Phase | | | | | | | | | | |
| Specific | 2.54 | 2.60 | 2.66 | 2.68 | 2.55 | 2.64 | 2.66 | 2.58 | 2.70 | 2.75 |
| Gravity?g/cm³ | | | | | | | | | | |
| Yong's Modulus | 77.4 | 85.4 | 86.0 | 85.0 | 81.2 | 82.7 | 79.2 | 83.3 | 87.1 | 88.5 |
| E??Pa | | | | | | | | | | |
| Elastic Modulus | 30.4 | 32. | 8 32.3 | 31.7 | 31.8 | 31.3 | 29.7 | 32.2 | 32.2 | 32.1 |
| Ratio | | | | | | | | | | |
| C.T.E | 97 | 77 | 77 | 81 | 83 | 81 | 102 | 81 | 69 | 70 |
| Amount of | 53 | 49 | 49 | 50 | 50 | 50 | 54 | 50 | 48 | 48 |
| Migration of alkali | | | | | | | | | | |
| metal [ppb] | | | | | | | | | | |
| P/Pli | 1.2 | 1.1 | 1.1 | 1.2 | 1.2 | 1.2 | 1.2 | 1.2 | 1.1 | 1.1 |

Tables 121 and 122 show the glass compositions in % by weight of respective crystallized glass substrates of B-559 to 579, together with the manufacturing conditions employed. Tables 123 and 124 show crystallized glass substrates as B-580 to 600 manufactured using the same glass compositions as those of B-559 to 579 with the nucleus growing temperature varied from that employed for B-559 to 579. Further, Tables 125 and 126 show crystallized glass substrates as B-601 to 621 manufactured using the same glass compositions as those of B-559 to 579 with the nucleus growing time varied from that employed for B-559 to 579.

TABLE 121

| | B-559 | B-560 | B-561 | B-562 | B-563 | B-564 | B-565 | B-566 | B-567 | B-568 | B-569 |
|---|---|---|---|---|---|---|---|---|---|---|---|
| SiO₂ | 55.0 | 60.0 | 65.0 | 61.0 | 60.0 | 63.0 | 65.0 | 63.0 | 60.0 | 63.0 | 63.0 |
| Bl₂O₃ | 7.0 | 6.0 | 4.5 | 3.0 | 5.0 | 10.0 | 7.6 | 6.0 | 5.5 | 6.0 | 6.0 |
| MgO | 3.0 | 2.5 | 2.5 | 2.5 | 1.0 | 2.5 | 2.0 | | | 2.0 | 2.0 |
| CaO | 2.0 | 1.0 | | | 2.0 | | | 2.0 | 2.0 | 0.8 | 0.9 |
| BaO | 2.0 | 1.0 | 1.0 | 3.0 | 2.3 | 2.0 | 2.0 | 1.5 | 1.0 | 2.5 | 2.3 |
| SrO | | | 2.0 | 2.1 | 1.8 | 1.0 | 1.7 | | | | |
| ZnO | 13.0 | 10.0 | 7.0 | 7.2 | 7.5 | 6.2 | 5.0 | 15.0 | 20.0 | 10.0 | 10.0 |
| Li₂O | 7.0 | 7.0 | 7.5 | 7.4 | 7.4 | 7.2 | 7.0 | 6.0 | 6.0 | 4.0 | 6.1 |
| K₂O | 0.5 | 1.0 | 2.5 | 2.6 | 2.6 | | 2.2 | | | 2.1 | 2.1 |
| B₂O₃ | 3.5 | 2.0 | 2.0 | 3.0 | 1.0 | 2.0 | 1.0 | 1.0 | 1.0 | 2.0 | 2.0 |
| TiO₂ | 2.0 | 2.0 | | 2.0 | 3.0 | | | 2.0 | 1.0 | 2.0 | |
| ZrO₂ | 2.5 | 4.5 | 3.0 | 3.2 | 3.4 | 3.1 | 4.0 | 1.0 | 1.0 | 3.0 | 3.0 |
| P₂O₅ | 2.0 | 2.5 | 2.5 | 2.6 | 2.6 | 2.5 | 2.1 | 2.1 | 2.1 | 2.1 | 2.1 |
| Y₂O₃ | | | | | | | | | | | |
| Nb₂O₅ | | | | | | | | | | | |
| Ta₂O₅ | | | | | | | | | | | |
| La₂O₃ | | | | | | | | | | | |
| Sb₂O₃ | 0.4 | 0.5 | 0.5 | 0.5 | 0.5 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature?? | | | | | | | | | | | |
| ? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature?? | | | | | | | | | | | |
| ? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 720 | 720 | 720 | 720 | 720 | 720 | 720 | 720 | 720 | 720 | 720 |
| Growing | | | | | | | | | | | |
| Temperature?? | | | | | | | | | | | |
| ? | | | | | | | | | | | |
| Nucleous | 3 | 3 | 3 | 3 | 3 | 3 | 3 | 3 | 3 | 3 | 3 |
| Growing | | | | | | | | | | | |
| Time?hr? | | | | | | | | | | | |
| Main Crystalline | LZS | Quartz | Quartz | Quartz | Quartz | Quartz | Quartz | LZS | LZS | Quartz | Quartz |
| Phase | | | | | | | | | | | |
| Sub Crystalline | — | Crist | Crist | Crist | Crist | Crist | Crist | — | — | Crist | Crist |
| Phase | | | | | | | | | | | |
| Specific | 2.66 | 2.66 | 2.64 | 2.66 | 2.64 | 2.58 | 2.56 | 2.67 | 2.71 | 2.76 | 2.68 |
| Gravity?g/cm³ | | | | | | | | | | | |
| Yong's Modulus | 86.2 | 83.0 | 79.0 | 79.8 | 80.0 | 81.2 | 78.8 | 83.2 | 84.5 | 85.9 | 84.7 |
| E??Pa | | | | | | | | | | | |
| Elastic Modulus | 32.4 | 31.2 | 29.9 | 30.0 | 30.3 | 31.5 | 30.8 | 31.2 | 31.2 | 31.1 | 31.6 |
| Ratio | | | | | | | | | | | |
| C.T.E | 64 | 98 | 110 | 93 | 88 | 97 | 118 | 66 | 62 | 98 | 109 |
| Amount of | 52 | 62 | 68 | 62 | 60 | 62 | 68 | 50 | 49 | 49 | 61 |
| Migration of | | | | | | | | | | | |
| alkali metal | | | | | | | | | | | |
| [ppb] | | | | | | | | | | | |
| P/Pli | 1.0 | 1.1 | 1.2 | 1.1 | 1.1 | 1.1 | 1.2 | 1.1 | 1.0 | 1.3 | 1.2 |

TABLE 122

| | B-570 | B-571 | B-572 | B-573 | B-574 | B-575 | B-576 | B-577 | B-578 | B-579 |
|---|---|---|---|---|---|---|---|---|---|---|
| SiO₂ | 63.0 | 65.0 | 61.3 | 65.0 | 58.0 | 61.0 | 60.0 | 62.0 | 62.7 | 64.0 |
| Bl₂O₃ | 9.0 | 4.5 | 7.3 | 5.0 | 6.5 | 5.0 | 6.0 | 7.1 | 7.4 | 8.0 |
| MgO | 2.0 | 2.0 | 1.9 | 2.5 | 2.4 | 2.3 | 1.6 | 2.1 | 2.0 | 2.1 |
| CaO | 0.9 | | | | | 1.1 | 2.0 | 2.0 | | 2.0 |
| BaO | | 3.0 | 2.4 | 2.0 | 2.5 | 2.0 | | | 2.4 | |
| SrO | | 2.0 | 1.6 | 1.0 | 2.0 | | 1.5 | | 1.7 | |
| ZnO | 8.0 | 7.0 | 9.4 | 5.0 | 9.0 | 11.0 | 10.0 | 6.4 | 9.6 | 6.5 |
| Li₂O | 8.0 | 7.5 | 5.8 | 7.5 | 7.1 | 7.0 | 6.9 | 7.0 | 6.0 | 7.0 |
| K₂O | 1.5 | 2.5 | 2.0 | 1.0 | 2.5 | 2.0 | 2.4 | 2.5 | 2.1 | 2.2 |
| B₂O₃ | 2.0 | 0.5 | 3.3 | 5.0 | 3.0 | 3.0 | 1.0 | 3.0 | 1.1 | 1.0 |
| TiO₂ | | | | | 3.0 | | 1.0 | 3.0 | | |
| ZrO₂ | 3.0 | 3.0 | 2.5 | 3.0 | 1.1 | 3.2 | 5.0 | 3.5 | 2.5 | 3.7 |
| P₂O₅ | 2.1 | 2.5 | 2.0 | 2.5 | 2.5 | 2.0 | 2.2 | 1.0 | 2.1 | 3.0 |
| Y₂O₃ | | | | | | | | | | |
| Nb₂O₅ | | | | | | | | | | |
| Ta₂O₅ | | | | | | | | | | |
| La₂O₃ | | | | | | | | | | |
| Sb₂O₃ | 0.4 | 0.5 | 0.4 | 0.5 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous | 720 | 720 | 720 | 720 | 720 | 720 | 720 | 720 | 720 | 720 |
| Growing | | | | | | | | | | |
| Temperature??? | | | | | | | | | | |
| Nucleous | 3 | 3 | 3 | 3 | 3 | 3 | 3 | 3 | 3 | 3 |
| Growing Time?hr? | | | | | | | | | | |
| Main Crystalline | Quartz | Crist | Quartz | Quartz | Quartz | Quartz | Quartz | Quartz | Quartz | Crist |
| Phase | | | | | | | | | | |
| Sub Crystalline | Crist | LZS | Crist | Crist | Crist | Crist | Crist | Crist | Crist | Quartz |
| Phase | | | | | | | | | | |
| Specific | 2.61 | 2.51 | 2.63 | 2.57 | 2.69 | 2.65 | 2.71 | 2.66 | 2.66 | 2.58 |
| Gravity?g/cm³ | | | | | | | | | | |
| Yong's Modulus | 83.1 | 80.3 | 81.9 | 78.2 | 82.3 | 80.1 | 83.8 | 82.8 | 82.1 | 78.6 |
| E??Pa | | | | | | | | | | |
| Elastic Modulus | 31.8 | 32.0 | 31.1 | 30.4 | 30.6 | 30.2 | 30.9 | 31.1 | 30.9 | 30.5 |
| Ratio | | | | | | | | | | |
| C.T.E | 117 | 112 | 108 | 118 | 108 | 112 | 105 | 98 | 92 | 119 |
| Amount of | 72 | 68 | 60 | 70 | 65 | 66 | 64 | 62 | 56 | 68 |
| Migration af alkali | | | | | | | | | | |
| metal [ppb] | | | | | | | | | | |
| P/Pli | 1.2 | 1.2 | 1.2 | 1.2 | 1.2 | 1.2 | 1.2 | 1.1 | 1.2 | 1.2 |

TABLE 123

| | B-580 | B-581 | B-582 | B-583 | B-584 | B-585 | B-586 | B-587 | B-588 | B-589 | B-590 |
|---|---|---|---|---|---|---|---|---|---|---|---|
| SiO₂ | 55.0 | 60.0 | 65.0 | 61.0 | 60.0 | 63.0 | 65.0 | 63.0 | 60.0 | 63.0 | 63.0 |
| Bl₂O₃ | 7.0 | 6.0 | 4.5 | 3.0 | 5.0 | 10.0 | 7.6 | 6.0 | 5.5 | 6.0 | 6.0 |
| MgO | 3.0 | 2.5 | 2.5 | 2.5 | 1.0 | 2.5 | 2.0 | | | 2.0 | 2.0 |
| CaO | 2.0 | 1.0 | | | 2.0 | | | 2.0 | 2.0 | 0.8 | 0.9 |
| BaO | 2.0 | 1.0 | 1.0 | 3.0 | 2.3 | 2.0 | 2.0 | 1.5 | 1.0 | 2.5 | 2.3 |
| SrO | | | 2.0 | 2.1 | 1.8 | 1.0 | 1.7 | | | | |
| ZnO | 13.0 | 10.0 | 7.0 | 7.2 | 7.5 | 6.2 | 5.0 | 15.0 | 20.0 | 10.0 | 10.0 |
| Li₂O | 7.0 | 7.0 | 7.5 | 7.4 | 7.4 | 7.2 | 7.0 | 6.0 | 6.0 | 4.0 | 6.1 |
| K₂O | 0.5 | 1.0 | 2.5 | 2.6 | 2.6 | | 2.2 | | | 2.1 | 2.1 |
| B₂O₃ | 3.5 | 2.0 | 2.0 | 3.0 | 1.0 | 2.0 | 1.0 | 1.0 | 1.0 | 2.0 | 2.0 |
| TiO₂ | 2.0 | 2.0 | | 2.0 | 3.0 | | | 2.0 | 1.0 | 2.0 | |
| ZrO₂ | 2.5 | 4.5 | 3.0 | 3.2 | 3.4 | 3.1 | 4.0 | 1.0 | 1.0 | 3.0 | 3.0 |
| P₂O₅ | 2.0 | 2.5 | 2.5 | 2.6 | 2.6 | 2.5 | 2.1 | 2.1 | 2.1 | 2.1 | 2.1 |
| Y₂O₃ | | | | | | | | | | | |
| Nb₂O₅ | | | | | | | | | | | |
| Ta₂O₅ | | | | | | | | | | | |
| La₂O₃ | | | | | | | | | | | |
| Sb₂O₃ | 0.4 | 0.5 | 0.5 | 0.5 | 0.5 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature?? | | | | | | | | | | | |
| ? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature?? | | | | | | | | | | | |
| ? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 750 | 750 | 750 | 750 | 750 | 750 | 750 | 750 | 750 | 750 | 750 |
| Growing | | | | | | | | | | | |
| Temperature?? | | | | | | | | | | | |
| ? | | | | | | | | | | | |
| Nucleous | 3 | 3 | 3 | 3 | 3 | 3 | 3 | 3 | 3 | 3 | 3 |
| Growing | | | | | | | | | | | |
| Time?hr? | | | | | | | | | | | |
| Main Crystalline | LZS | Quartz | Quartz | Quartz | Quartz | Quartz | Quartz | LZS | LZS | Quartz | Quartz |
| Phase | | | | | | | | | | | |
| Sub Crystalline | Crist | Crist | Crist | Crist | Crist | Crist | LAS | Crist | — | LAS | LAS |
| Phase | | | | | | | | | | | |
| Specific | 2.65 | 2.68 | 2.66 | 2.68 | 2.66 | 2.60 | 2.58 | 2.66 | 2.70 | 2.78 | 2.70 |
| Gravity?g/cm³ | | | | | | | | | | | |
| Yong's Modulus | 85.9 | 86.5 | 82.3 | 83.2 | 83.4 | 84.6 | 82.1 | 82.9 | 84.2 | 89.5 | 88.3 |
| E??Pa | | | | | | | | | | | |
| Elastic Modulus | 32.4 | 32.3 | 30.9 | 31.0 | 31.3 | 32.5 | 31.8 | 31.1 | 31.1 | 32.2 | 32.7 |
| Ratio | | | | | | | | | | | |
| C.T.E | 78 | 108 | 114 | 106 | 104 | 107 | 119 | 73 | 70 | 108 | 113 |
| Amount of | 49 | 56 | 57 | 55 | 55 | 56 | 58 | 48 | 48 | 56 | 57 |
| Migration of | | | | | | | | | | | |
| alkali metal | | | | | | | | | | | |
| [ppb] | | | | | | | | | | | |
| P/Pli | 1.1 | 1.3 | 1.3 | 1.2 | 1.2 | 1.3 | 1.3 | 1.1 | 1.1 | 1.3 | 1.3 |

TABLE 124

| | B-591 | B-592 | B-593 | B-594 | B-595 | B-596 | B-597 | B-598 | B-599 | B-600 |
|---|---|---|---|---|---|---|---|---|---|---|
| SiO₂ | 63.0 | 65.0 | 61.3 | 65.0 | 58.0 | 61.0 | 60.0 | 62.0 | 62.7 | 64.0 |
| Bl₂O₃ | 9.0 | 4.5 | 7.3 | 5.0 | 6.5 | 5.0 | 6.0 | 7.1 | 7.4 | 8.0 |
| MgO | 2.0 | 2.0 | 1.9 | 2.5 | 2.4 | 2.3 | 1.6 | 2.1 | 2.0 | 2.1 |
| CaO | 0.9 | | | | | 1.1 | 2.0 | 2.0 | | 2.0 |
| BaO | | 3.0 | 2.4 | 2.0 | 2.5 | 2.0 | | | 2.4 | |
| SrO | | 2.0 | 1.6 | 1.0 | 2.0 | | 1.5 | | 1.7 | |
| ZnO | 8.0 | 7.0 | 9.4 | 5.0 | 9.0 | 11.0 | 10.0 | 6.4 | 9.6 | 6.5 |
| Li₂O | 8.0 | 7.5 | 5.8 | 7.5 | 7.1 | 7.0 | 6.9 | 7.0 | 6.0 | 7.0 |
| K₂O | 1.5 | 2.5 | 2.0 | 1.0 | 2.5 | 2.0 | 2.4 | 2.5 | 2.1 | 2.2 |
| B₂O₃ | 2.0 | 0.5 | 3.3 | 5.0 | 3.0 | 3.0 | 1.0 | 3.0 | 1.1 | 1.0 |
| TiO₂ | | | | | 3.0 | | 1.0 | 3.0 | | |
| ZrO₂ | 3.0 | 3.0 | 2.5 | 3.0 | 1.1 | 3.2 | 5.0 | 3.5 | 2.5 | 3.7 |
| P₂O₅ | 2.1 | 2.5 | 2.0 | 2.5 | 2.5 | 2.0 | 2.2 | 1.0 | 2.1 | 3.0 |
| Y₂O₃ | | | | | | | | | | |
| Nb₂O₅ | | | | | | | | | | |
| Ta₂O₅ | | | | | | | | | | |
| La₂O₃ | | | | | | | | | | |
| Sb₂O₃ | 0.4 | 0.5 | 0.4 | 0.5 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous | 750 | 750 | 750 | 750 | 750 | 750 | 750 | 750 | 750 | 750 |
| Growing | | | | | | | | | | |
| Temperature??? | | | | | | | | | | |
| Nucleous | 3 | 3 | 3 | 3 | 3 | 3 | 3 | 3 | 3 | 3 |
| Growing Time?hr? | | | | | | | | | | |
| Main Crystalline | Quartz | Crist | Quartz | Quartz | Quartz | Quartz | Quartz | Quartz | Quartz | Quartz |
| Phase | | | | | | | | | | |
| Sub Crystalline | LAS | Quartz | LAS | LAS | LAS | LAS | LAS | LAS | LAS | Crist |
| Phase | | | | | | | | | | |
| Specific | 2.63 | 2.53 | 2.65 | 2.59 | 2.71 | 2.67 | 2.73 | 2.68 | 2.68 | 2.60 |
| Gravity?g/cm³ | | | | | | | | | | |
| Yong's Modulus | 86.6 | 83.7 | 85.4 | 81.5 | 85.8 | 83.5 | 87.3 | 86.3 | 85.6 | 81.9 |
| E??Pa | | | | | | | | | | |
| Elastic Modulus | 32.9 | 33.1 | 32.2 | 31.5 | 31.6 | 31.3 | 32.0 | 32.2 | 31.9 | 31.5 |
| Ratio | | | | | | | | | | |
| C.T.E | 118 | 115 | 113 | 119 | 113 | 115 | 111 | 108 | 105 | 119 |
| Amount of | 58 | 57 | 57 | 58 | 57 | 57 | 56 | 56 | 55 | 58 |
| Migration of alkali | | | | | | | | | | |
| metal [ppb] | | | | | | | | | | |
| P/Pli | 1.3 | 1.3 | 1.3 | 1.3 | 1.3 | 1.3 | 1.3 | 1.3 | 1.2 | 1.3 |

TABLE 125

| | B-601 | B-602 | B-603 | B-604 | B-605 | B-606 | B-607 | B-608 | B-609 | B-610 | B-611 |
|---|---|---|---|---|---|---|---|---|---|---|---|
| SiO₂ | 55.0 | 60.0 | 65.0 | 61.0 | 60.0 | 63.0 | 65.0 | 63.0 | 60.0 | 63.0 | 63.0 |
| Bl₂O₃ | 7.0 | 6.0 | 4.5 | 3.0 | 5.0 | 10.0 | 7.6 | 6.0 | 5.5 | 6.0 | 6.0 |
| MgO | 3.0 | 2.5 | 2.5 | 2.5 | 1.0 | 2.5 | 2.0 | | | 2.0 | 2.0 |
| CaO | 2.0 | 1.0 | | | 2.0 | | | 2.0 | 2.0 | 0.8 | 0.9 |
| BaO | 2.0 | 1.0 | 1.0 | 3.0 | 2.3 | 2.0 | 2.0 | 1.5 | 1.0 | 2.5 | 2.3 |
| SrO | | | 2.0 | 2.1 | 1.8 | 1.0 | 1.7 | | | | |
| ZnO | 13.0 | 10.0 | 7.0 | 7.2 | 7.5 | 6.2 | 5.0 | 15.0 | 20.0 | 10.0 | 10.0 |
| Li₂O | 7.0 | 7.0 | 7.5 | 7.4 | 7.4 | 7.2 | 7.0 | 6.0 | 6.0 | 4.0 | 6.1 |
| K₂O | 0.5 | 1.0 | 2.5 | 2.6 | 2.6 | | 2.2 | | | 2.1 | 2.1 |
| B₂O₃ | 3.5 | 2.0 | 2.0 | 3.0 | 1.0 | 2.0 | 1.0 | 1.0 | 1.0 | 2.0 | 2.0 |
| TiO₂ | 2.0 | 2.0 | | 2.0 | 3.0 | | | 2.0 | 1.0 | 2.0 | |
| ZrO₂ | 2.5 | 4.5 | 3.0 | 3.2 | 3.4 | 3.1 | 4.0 | 1.0 | 1.0 | 3.0 | 3.0 |
| P₂O₅ | 2.0 | 2.5 | 2.5 | 2.6 | 2.6 | 2.5 | 2.1 | 2.1 | 2.1 | 2.1 | 2.1 |
| Y₂O₃ | | | | | | | | | | | |
| Nb₂O₅ | | | | | | | | | | | |
| Ta₂O₅ | | | | | | | | | | | |
| La₂O₃ | | | | | | | | | | | |
| Sb₂O₃ | 0.4 | 0.5 | 0.5 | 0.5 | 0.5 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature?? | | | | | | | | | | | |
| ? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature?? | | | | | | | | | | | |
| ? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 720 | 720 | 720 | 720 | 720 | 720 | 720 | 720 | 720 | 720 | 720 |
| Growing | | | | | | | | | | | |
| Temperature?? | | | | | | | | | | | |
| ? | | | | | | | | | | | |
| Nucleous | 10 | 10 | 10 | 10 | 10 | 10 | 10 | 10 | 10 | 10 | 10 |
| Growing | | | | | | | | | | | |
| Time?hr? | | | | | | | | | | | |
| Main Crystalline | LZS | Quartz | Quartz | Crist | Crist | Crist | Quartz | LZS | LZS | Quartz | Quartz |
| Phase | | | | | | | | | | | |
| Sub Crystalline | — | Crist | Crist | Quartz | Quartz | Quartz | Crist | — | — | Crist | Crist |
| Phase | | | | | | | | | | | |
| Specific | 2.65 | 2.67 | 2.65 | 2.65 | 2.63 | 2.57 | 2.57 | 2.66 | 2.70 | 2.77 | 2.69 |
| Gravity?g/cm³ | | | | | | | | | | | |
| Yong's Modulus | 85.9 | 85.4 | 81.3 | 79.5 | 79.7 | 80.9 | 81.1 | 82.9 | 84.2 | 88.4 | 87.2 |
| E??Pa | | | | | | | | | | | |
| Elastic Modulus | 32.4 | 32.0 | 30.7 | 30.0 | 30.3 | 31.4 | 31.5 | 31.1 | 31.1 | 31.9 | 32.4 |
| Ratio | | | | | | | | | | | |
| C.T.E | 71 | 109 | 115 | 107 | 105 | 108 | 120 | 72 | 69 | 109 | 115 |
| Amount of | 48 | 56 | 57 | 55 | 55 | 56 | 58 | 48 | 48 | 56 | 57 |
| Migration of | | | | | | | | | | | |
| alkali metal | | | | | | | | | | | |
| [ppb] | | | | | | | | | | | |
| P/Pli | 1.1 | 1.3 | 1.3 | 1.2 | 1.2 | 1.3 | 1.3 | 1.1 | 1.1 | 1.3 | 1.3 |

TABLE 126

| | B-612 | B-613 | B-614 | B-615 | B-616 | B-617 | B-618 | B-619 | B-620 | B-621 |
|---|---|---|---|---|---|---|---|---|---|---|
| SiO₂ | 63.0 | 65.0 | 61.3 | 65.0 | 58.0 | 61.0 | 60.0 | 62.0 | 62.7 | 64.0 |
| Bl₂O₃ | 9.0 | 4.5 | 7.3 | 5.0 | 6.5 | 5.0 | 6.0 | 7.1 | 7.4 | 8.0 |
| MgO | 2.0 | 2.0 | 1.9 | 2.5 | 2.4 | 2.3 | 1.6 | 2.1 | 2.0 | 2.1 |
| CaO | 0.9 | | | | | 1.1 | 2.0 | 2.0 | | 2.0 |
| BaO | | 3.0 | 2.4 | 2.0 | 2.5 | 2.0 | | | 2.4 | |
| SrO | | 2.0 | 1.6 | 1.0 | 2.0 | | 1.5 | | 1.7 | |
| ZnO | 8.0 | 7.0 | 9.4 | 5.0 | 9.0 | 11.0 | 10.0 | 6.4 | 9.6 | 6.5 |
| Li₂O | 8.0 | 7.5 | 5.8 | 7.5 | 7.1 | 7.0 | 6.9 | 7.0 | 6.0 | 7.0 |
| K₂O | 1.5 | 2.5 | 2.0 | 1.0 | 2.5 | 2.0 | 2.4 | 2.5 | 2.1 | 2.2 |
| B₂O₃ | 2.0 | 0.5 | 3.3 | 5.0 | 3.0 | 3.0 | 1.0 | 3.0 | 1.1 | 1.0 |
| TiO₂ | | | | | 3.0 | | 1.0 | 3.0 | | |
| ZrO₂ | 3.0 | 3.0 | 2.5 | 3.0 | 1.1 | 3.2 | 5.0 | 3.5 | 2.5 | 3.7 |
| P₂O₅ | 2.1 | 2.5 | 2.0 | 2.5 | 2.5 | 2.0 | 2.2 | 1.0 | 2.1 | 3.0 |
| Y₂O₃ | | | | | | | | | | |
| Nb₂O₅ | | | | | | | | | | |
| Ta₂O₅ | | | | | | | | | | |
| La₂O₃ | | | | | | | | | | |
| Sb₂O₃ | 0.4 | 0.5 | 0.4 | 0.5 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 550 | 550 | 550 | 550 | 550 | 550 | 550 | 550 | 550 | 550 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous | 720 | 720 | 720 | 720 | 720 | 720 | 720 | 720 | 720 | 720 |
| Growing | | | | | | | | | | |
| Temperature??? | | | | | | | | | | |
| Nucleous | 10 | 10 | 10 | 10 | 10 | 10 | 10 | 10 | 10 | 10 |
| Growing Time?hr? | | | | | | | | | | |
| Main Crystalline | Quartz | Crist | Quartz | Quartz | Quartz | Quartz | Quartz | Quartz | Quartz | Crist |
| Phase | | | | | | | | | | |
| Sub Crystalline | Crist | Quartz | Crist | Crist | Crist | Crist | Crist | Crist | Crist | Quartz |
| Phase | | | | | | | | | | |
| Specific | 2.62 | 2.52 | 2.64 | 2.58 | 2.70 | 2.66 | 2.72 | 2.67 | 2.67 | 2.59 |
| Gravity?g/cm³ | | | | | | | | | | |
| Yong's Modulus | 85.6 | 82.7 | 84.3 | 80.5 | 84.7 | 82.5 | 86.3 | 85.2 | 84.5 | 80.9 |
| E??Pa | | | | | | | | | | |
| Elastic Modulus | 32.6 | 32.8 | 31.9 | 31.2 | 31.4 | 31.0 | 31.7 | 31.9 | 31.6 | 31.2 |
| Ratio | | | | | | | | | | |
| C.T.E | 119 | 116 | 114 | 120 | 114 | 116 | 112 | 109 | 106 | 121 |
| Amount of | 58 | 57 | 57 | 58 | 57 | 57 | 57 | 56 | 55 | 58 |
| Migration of alkali | | | | | | | | | | |
| metal [ppb] | | | | | | | | | | |
| P/Pli | 1.3 | 1.3 | 1.3 | 1.3 | 1.3 | 1.3 | 1.3 | 1.3 | 1.2 | 1.3 |

Tables 127 and 128 show the glass compositions in % byweight of respective crystallized glass substrates of B-622 to 643, together with the manufacturing conditions employed. Tables 129 and 130 show crystallized glass substrates as B-644 to 665 manufactured using the same glass compositions as those of B-622 to 643 with the nucleus growing temperature varied from that employed for B-622 to 643. Further, Tables 131 and 132 show crystallized glass substrates as B-666 to 687 manufactured using the same glass compositions as those of B-622 to 643 with the nucleus growing time varied from that employed for B-622 to 643.

TABLE 127

| | B-622 | B-623 | B-624 | B-625 | B-626 | B-627 | B-628 | B-629 | B-630 | B-631 | B-632 |
|---|---|---|---|---|---|---|---|---|---|---|---|
| SiO₂ | 55.0 | 60.0 | 65.0 | 61.0 | 60.0 | 63.0 | 65.0 | 65.0 | 63.0 | 60.0 | 63.0 |
| Bl₂O₃ | 7.0 | 6.0 | 4.5 | 3.0 | 5.0 | 10.0 | 7.6 | 7.6 | 6.0 | 5.5 | 6.0 |
| MgO | 3.0 | 2.5 | 2.5 | 2.5 | 1.0 | 2.5 | 2.0 | 2.0 | | | 2.0 |
| CaO | 2.0 | 1.0 | | | 2.0 | | | | 2.0 | 2.0 | 0.8 |
| BaO | 2.0 | 1.0 | 1.0 | 3.0 | 2.3 | 2.0 | 2.0 | 2.0 | 1.5 | 1.0 | 2.5 |
| SrO | | | 2.0 | 2.1 | 1.8 | 1.0 | 1.7 | 1.7 | | | |
| ZnO | 13.0 | 10.0 | 7.0 | 7.2 | 7.5 | 6.2 | 5.0 | 5.0 | 15.0 | 20.0 | 10.0 |
| Li₂O | 7.0 | 7.0 | 7.5 | 7.4 | 7.4 | 7.2 | 7.0 | 7.0 | 6.0 | 6.0 | 4.0 |
| K₂O | 0.5 | 1.0 | 2.5 | 2.6 | 2.6 | | 2.2 | 2.2 | | | 2.1 |
| B₂O₃ | 2.0 | 2.0 | | 2.0 | 3.0 | | | 1.0 | 2.0 | 1.0 | 2.0 |
| TiO₂ | 3.5 | 2.0 | 2.0 | 3.0 | 1.0 | 2.0 | 1.0 | | 1.0 | 1.0 | 2.0 |
| ZrO₂ | 2.5 | 4.5 | 3.0 | 3.2 | 3.4 | 3.1 | 4.0 | 4.0 | 1.0 | 1.0 | 3.0 |
| P₂O₅ | 2.0 | 2.5 | 2.5 | 2.6 | 2.6 | 2.5 | 2.1 | 2.1 | 2.1 | 2.1 | 2.1 |
| Y₂O₃ | | | | | | | | | | | |
| Nb₂O₅ | | | | | | | | | | | |
| Ta₂O₅ | | | | | | | | | | | |
| La₂O₃ | | | | | | | | | | | |
| Sb₂O₃ | 0.4 | 0.5 | 0.5 | 0.5 | 0.5 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature?? | | | | | | | | | | | |
| ? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature?? | | | | | | | | | | | |
| ? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 720 | 720 | 720 | 720 | 720 | 720 | 720 | 720 | 720 | 720 | 720 |
| Growing | | | | | | | | | | | |
| Temperature?? | | | | | | | | | | | |
| ? | | | | | | | | | | | |
| Nucleous | 3 | 3 | 3 | 3 | 3 | 3 | 3 | 3 | 3 | 3 | 3 |
| Growing | | | | | | | | | | | |
| Time?hr? | | | | | | | | | | | |
| Main Crystalline | LZS | Quartz | Crist | Quartz | Quartz | Crist | Crist | Quartz | LZS | LZS | Quartz |
| Phase | | | | | | | | | | | |
| Sub Crystalline | — | Crist | LZS | Crist | Crist | LZS | LZS | Crist | — | — | Crist |
| Phase | | | | | | | | | | | |
| Specific | 2.66 | 2.66 | 2.65 | 2.66 | 2.64 | 2.57 | 2.49 | 2.56 | 2.67 | 2.71 | 2.76 |
| Gravity?g/cm³ | | | | | | | | | | | |
| Yong's Modulus | 86.2 | 83.0 | 80.5 | 79.8 | 80.0 | 81.1 | 76.0 | 78.8 | 83.2 | 84.5 | 85.9 |
| E??Pa | | | | | | | | | | | |
| Elastic Modulus | 32.4 | 31.2 | 30.4 | 30.0 | 30.3 | 31.6 | 30.5 | 30.8 | 31.2 | 31.2 | 31.1 |
| Ratio | | | | | | | | | | | |
| C.T.E | 64 | 98 | 115 | 93 | 88 | 89 | 110 | 118 | 66 | 62 | 98 |
| Amount of | 52 | 62 | 69 | 62 | 60 | 60 | 65 | 68 | 50 | 49 | 49 |
| Migration of | | | | | | | | | | | |
| alkali metal | | | | | | | | | | | |
| [ppb] | | | | | | | | | | | |
| P/Pli | 1.0 | 1.1 | 1.2 | 1.1 | 1.1 | 1.1 | 1.2 | 1.2 | 1.1 | 1.0 | 1.3 |

TABLE 128

| | B-633 | B-634 | B-635 | B-636 | B-637 | B-638 | B-639 | B-640 | B-641 | B-642 | B-643 |
|---|---|---|---|---|---|---|---|---|---|---|---|
| SiO₂ | 63.0 | 63.0 | 65.0 | 65.0 | 65.0 | 58.0 | 61.0 | 60.0 | 62.0 | 60.0 | 64.0 |
| Bl₂O₃ | 6.0 | 9.0 | 4.5 | 4.5 | 5.0 | 6.5 | 7.2 | 6.0 | 7.1 | 7.8 | 8.0 |
| MgO | 2.0 | 2.0 | 2.0 | 3.0 | 2.5 | 2.4 | 1.9 | 1.6 | 2.1 | 2.1 | 2.1 |
| CaO | 0.9 | 0.9 | | | | | | 2.0 | 2.0 | 2.7 | 2.0 |
| BaO | 2.3 | | 3.0 | 2.0 | 2.0 | 2.5 | 2.4 | | | | |
| SrO | | | 2.0 | 1.0 | 1.0 | 2.0 | 1.6 | 1.5 | | | |
| ZnO | 10.0 | 8.0 | 7.0 | 6.0 | 5.0 | 9.0 | 9.4 | 10.0 | 6.4 | 6.2 | 6.5 |
| Li₂O | 6.1 | 8.0 | 7.5 | 7.0 | 7.5 | 7.1 | 5.8 | 6.9 | 7.0 | 7.5 | 7.0 |
| K₂O | 2.1 | 1.5 | 2.5 | 2.5 | 1.0 | 2.5 | 2.0 | 2.4 | 2.5 | 2.2 | 2.2 |
| B₂O₃ | | | | | | 3.0 | | 1.0 | 3.0 | 3.0 | |
| TiO₂ | 2.0 | 2.0 | 0.5 | 3.0 | 5.0 | 3.0 | 3.8 | 1.0 | 3.0 | 3.0 | 1.0 |
| ZrO₂ | 3.0 | 3.0 | 3.0 | 3.0 | 3.0 | 1.1 | 2.5 | 5.0 | 3.5 | 3.0 | 3.7 |
| P₂O₅ | 2.1 | 2.1 | 2.5 | 2.5 | 2.5 | 2.5 | 2.0 | 2.2 | 1.0 | 2.0 | 3.0 |
| Y₂O₃ | | | | | | | 0.0 | | | | |
| Nb₂O₅ | | | | | | | | | | | |
| Ta₂O₅ | | | | | | | | | | | |
| La₂O₃ | | | | | | | | | | | |
| Sb₂O₃ | 0.4 | 0.4 | 0.5 | 0.5 | 0.5 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature?? | | | | | | | | | | | |
| ? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature?? | | | | | | | | | | | |
| ? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 720 | 720 | 720 | 720 | 720 | 720 | 720 | 720 | 720 | 720 | 720 |
| Growing | | | | | | | | | | | |
| Temperature?? | | | | | | | | | | | |
| ? | | | | | | | | | | | |
| Nucleous | 3 | 3 | 3 | 3 | 3 | 3 | 3 | 3 | 3 | 3 | 3 |
| Growing | | | | | | | | | | | |
| Time?hr? | | | | | | | | | | | |
| Main Crystalline | Crist | Crist | Crist | Crist | Crist | Quartz | LZS | Quartz | Quartz | Quartz | Crist |
| Phase | | | | | | | | | | | |
| Sub Crystalline | LZS | LZS | LZS | Quartz | Quartz | Crist | — | Crist | Crist | Crist | LZS |
| Phase | | | | | | | | | | | |
| Specific | 2.59 | 2.55 | 2.53 | 2.65 | 2.71 | 2.69 | 2.66 | 2.71 | 2.66 | 2.71 | 2.59 |
| Gravity?g/cm³ | | | | | | | | | | | |
| Yong's Modulus | 85.1 | 79.2 | 81.2 | 82.1 | 81.5 | 82.3 | 85.5 | 83.8 | 82.8 | 83.1 | 77.9 |
| E??Pa | | | | | | | | | | | |
| Elastic Modulus | 32.9 | 31.1 | 32.1 | 31.0 | 30.1 | 30.6 | 32.1 | 30.9 | 31.1 | 30.7 | 30.1 |
| Ratio | | | | | | | | | | | |
| C.T.E | 83 | 102 | 108 | 103 | 109 | 108 | 71 | 105 | 98 | 103 | 115 |
| Amount of | 54 | 67 | 67 | 63 | 67 | 65 | 50 | 64 | 62 | 65 | 67 |
| Migration of | | | | | | | | | | | |
| alkali metal | | | | | | | | | | | |
| [ppb] | | | | | | | | | | | |
| P/Pli | 1.1 | 1.1 | 1.2 | 1.2 | 1.2 | 1.2 | 1.1 | 1.2 | 1.1 | 1.1 | 1.2 |

TABLE 129

| | B-644 | B-645 | B-646 | B-647 | B-648 | B-649 | B-650 | B-651 | B-652 | B-653 | B-654 |
|---|---|---|---|---|---|---|---|---|---|---|---|
| SiO₂ | 55.0 | 60.0 | 65.0 | 61.0 | 60.0 | 63.0 | 65.0 | 65.0 | 63.0 | 60.0 | 63.0 |
| Bl₂O₃ | 7.0 | 6.0 | 4.5 | 3.0 | 5.0 | 10.0 | 7.6 | 7.6 | 6.0 | 5.5 | 6.0 |
| MgO | 3.0 | 2.5 | 2.5 | 2.5 | 1.0 | 2.5 | 2.0 | 2.0 | | | 2.0 |
| CaO | 2.0 | 1.0 | | | 2.0 | | | | 2.0 | 2.0 | 0.8 |
| BaO | 2.0 | 1.0 | 1.0 | 3.0 | 2.3 | 2.0 | 2.0 | 2.0 | 1.5 | 1.0 | 2.5 |
| SrO | | | 2.0 | 2.1 | 1.8 | 1.0 | 1.7 | 1.7 | | | |
| ZnO | 13.0 | 10.0 | 7.0 | 7.2 | 7.5 | 6.2 | 5.0 | 5.0 | 15.0 | 20.0 | 10.0 |
| Li₂O | 7.0 | 7.0 | 7.5 | 7.4 | 7.4 | 7.2 | 7.0 | 7.0 | 6.0 | 6.0 | 4.0 |
| K₂O | 0.5 | 1.0 | 2.5 | 2.6 | 2.6 | | 2.2 | 2.2 | | | 2.1 |
| B₂O₃ | 2.0 | 2.0 | | 2.0 | 3.0 | | | 1.0 | 2.0 | 1.0 | 2.0 |
| TiO₂ | 3.5 | 2.0 | 2.0 | 3.0 | 1.0 | 2.0 | 1.0 | | 1.0 | 1.0 | 2.0 |
| ZrO₂ | 2.5 | 4.5 | 3.0 | 3.2 | 3.4 | 3.1 | 4.0 | 4.0 | 1.0 | 1.0 | 3.0 |
| P₂O₅ | 2.0 | 2.5 | 2.5 | 2.6 | 2.6 | 2.5 | 2.1 | 2.1 | 2.1 | 2.1 | 2.1 |
| Y₂O₃ | | | | | | | | | | | |
| Nb₂O₅ | | | | | | | | | | | |
| Ta₂O₅ | | | | | | | | | | | |
| La₂O₃ | | | | | | | | | | | |
| Sb₂O₃ | 0.4 | 0.5 | 0.5 | 0.5 | 0.5 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature?? | | | | | | | | | | | |
| ? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature?? | | | | | | | | | | | |
| ? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 750 | 750 | 750 | 750 | 750 | 750 | 750 | 750 | 750 | 750 | 750 |
| Growing | | | | | | | | | | | |
| Temperature?? | | | | | | | | | | | |
| ? | | | | | | | | | | | |
| Nucleous | 3 | 3 | 3 | 3 | 3 | 3 | 3 | 3 | 3 | 3 | 3 |
| Growing | | | | | | | | | | | |
| Time?hr? | | | | | | | | | | | |
| Main Crystalline | LZS | Quartz | Quartz | Quartz | Quartz | Quartz | Crist | Quartz | LZS | LZS | Quartz |
| Phase | | | | | | | | | | | |
| Sub Crystalline | Crist | Crist | Crist | Crist | Crist | Crist | LZS | LAS | Crist | — | LAS |
| Phase | | | | | | | | | | | |
| Specific | 2.65 | 2.68 | 2.67 | 2.68 | 2.66 | 2.59 | 2.48 | 2.58 | 2.66 | 2.70 | 2.78 |
| Gravity?g/cm³ | | | | | | | | | | | |
| Yong's Modulus | 85.9 | 86.5 | 83.9 | 83.2 | 83.4 | 84.5 | 75.7 | 82.1 | 82.9 | 84.2 | 89.5 |
| E??Pa | | | | | | | | | | | |
| Elastic Modulus | 32.4 | 32.3 | 31.4 | 31.0 | 31.3 | 32.6 | 30.5 | 31.8 | 31.1 | 31.1 | 32.2 |
| Ratio | | | | | | | | | | | |
| C.T.E | 78 | 108 | 117 | 106 | 104 | 104 | 109 | 119 | 73 | 70 | 108 |
| Amount of | 49 | 56 | 58 | 55 | 55 | 55 | 56 | 58 | 48 | 48 | 56 |
| Migration of | | | | | | | | | | | |
| alkali metal | | | | | | | | | | | |
| [ppb] | | | | | | | | | | | |
| P/Pli | 1.1 | 1.3 | 1.3 | 1.2 | 1.2 | 1.2 | 1.3 | 1.3 | 1.1 | 1.1 | 1.3 |

TABLE 130

| | B-655 | B-656 | B-657 | B-658 | B-659 | B-660 | B-661 | B-662 | B-663 | B-664 | B-665 |
|---|---|---|---|---|---|---|---|---|---|---|---|
| SiO₂ | 55.0 | 60.0 | 65.0 | 61.0 | 60.0 | 63.0 | 65.0 | 65.0 | 63.0 | 60.0 | 63.0 |
| Bl₂O₃ | 7.0 | 6.0 | 4.5 | 3.0 | 5.0 | 10.0 | 7.6 | 7.6 | 6.0 | 5.5 | 6.0 |
| MgO | 3.0 | 2.5 | 2.5 | 2.5 | 1.0 | 2.5 | 2.0 | 2.0 | | | 2.0 |
| CaO | 2.0 | 1.0 | | | 2.0 | | | | 2.0 | 2.0 | 0.8 |
| BaO | 2.0 | 1.0 | 1.0 | 3.0 | 2.3 | 2.0 | 2.0 | 2.0 | 1.5 | 1.0 | 2.5 |
| SrO | | | 2.0 | 2.1 | 1.8 | 1.0 | 1.7 | 1.7 | | | |
| ZnO | 13.0 | 10.0 | 7.0 | 7.2 | 7.5 | 6.2 | 5.0 | 5.0 | 15.0 | 20.0 | 10.0 |
| Li₂O | 7.0 | 7.0 | 7.5 | 7.4 | 7.4 | 7.2 | 7.0 | 7.0 | 6.0 | 6.0 | 4.0 |
| K₂O | 0.5 | 1.0 | 2.5 | 2.6 | 2.6 | | 2.2 | 2.2 | | | 2.1 |
| B₂O₃ | 2.0 | 2.0 | | 2.0 | 3.0 | | | 1.0 | 2.0 | 1.0 | 2.0 |
| TiO₂ | 3.5 | 2.0 | 2.0 | 3.0 | 1.0 | 2.0 | 1.0 | | 1.0 | 1.0 | 2.0 |
| ZrO₂ | 2.5 | 4.5 | 3.0 | 3.2 | 3.4 | 3.1 | 4.0 | 4.0 | 1.0 | 1.0 | 3.0 |
| P₂O₅ | 2.0 | 2.5 | 2.5 | 2.6 | 2.6 | 2.5 | 2.1 | 2.1 | 2.1 | 2.1 | 2.1 |
| Y₂O₃ | | | | | | | | | | | |
| Nb₂O₅ | | | | | | | | | | | |
| Ta₂O₅ | | | | | | | | | | | |
| La₂O₃ | | | | | | | | | | | |
| Sb₂O₃ | 0.4 | 0.5 | 0.5 | 0.5 | 0.5 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature?? | | | | | | | | | | | |
| ? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature?? | | | | | | | | | | | |
| ? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 720 | 720 | 720 | 720 | 720 | 720 | 720 | 720 | 720 | 720 | 720 |
| Growing | | | | | | | | | | | |
| Temperature?? | | | | | | | | | | | |
| ? | | | | | | | | | | | |
| Nucleous | 10 | 10 | 10 | 10 | 10 | 10 | 10 | 10 | 10 | 10 | 10 |
| Growing | | | | | | | | | | | |
| Time?hr? | | | | | | | | | | | |
| Main Crystalline | LZS | Quartz | Quartz | Crist | Crist | Crist | Crist | Quartz | LZS | LZS | Quartz |
| Phase | | | | | | | | | | | |
| Sub Crystalline | — | Crist | Crist | Quartz | Quartz | Quartz | LZS | Crist | — | — | Crist |
| Phase | | | | | | | | | | | |
| Specific | 2.65 | 2.67 | 2.66 | 2.65 | 2.63 | 2.56 | 2.48 | 2.57 | 2.66 | 2.70 | 2.77 |
| Gravity?g/cm³ | | | | | | | | | | | |
| Yong's Modulus | 85.9 | 85.4 | 82.9 | 79.5 | 79.7 | 80.8 | 75.7 | 81.1 | 82.9 | 84.2 | 88.4 |
| E??Pa | | | | | | | | | | | |
| Elastic Modulus | 32.4 | 32.0 | 31.1 | 30.0 | 30.3 | 31.5 | 30.5 | 31.5 | 31.1 | 31.1 | 31.9 |
| Ratio | | | | | | | | | | | |
| C.T.E | 71 | 109 | 118 | 107 | 105 | 105 | 109 | 120 | 72 | 69 | 109 |
| Amount of | 48 | 56 | 58 | 55 | 55 | 55 | 56 | 58 | 48 | 48 | 56 |
| Migration of | | | | | | | | | | | |
| alkali metal | | | | | | | | | | | |
| [ppb] | | | | | | | | | | | |
| P/Pli | 1.1 | 1.3 | 1.3 | 1.2 | 1.2 | 1.2 | 1.3 | 1.3 | 1.1 | 1.1 | 1.3 |

TABLE 131

| | B-666 | B-667 | B-668 | B-669 | B-670 | B-671 | B-672 | B-673 | B-674 | B-675 | B-676 |
|---|---|---|---|---|---|---|---|---|---|---|---|
| SiO₂ | 55.0 | 60.0 | 65.0 | 61.0 | 60.0 | 63.0 | 65.0 | 65.0 | 63.0 | 60.0 | 63.0 |
| Bl₂O₃ | 7.0 | 6.0 | 4.5 | 3.0 | 5.0 | 10.0 | 7.6 | 7.6 | 6.0 | 5.5 | 6.0 |
| MgO | 3.0 | 2.5 | 2.5 | 2.5 | 1.0 | 2.5 | 2.0 | 2.0 | | | 2.0 |
| CaO | 2.0 | 1.0 | | | 2.0 | | | | 2.0 | 2.0 | 0.8 |
| BaO | 2.0 | 1.0 | 1.0 | 3.0 | 2.3 | 2.0 | 2.0 | 2.0 | 1.5 | 1.0 | 2.5 |
| SrO | | | 2.0 | 2.1 | 1.8 | 1.0 | 1.7 | 1.7 | | | |
| ZnO | 13.0 | 10.0 | 7.0 | 7.2 | 7.5 | 6.2 | 5.0 | 5.0 | 15.0 | 20.0 | 10.0 |
| Li₂O | 7.0 | 7.0 | 7.5 | 7.4 | 7.4 | 7.2 | 7.0 | 7.0 | 6.0 | 6.0 | 4.0 |
| K₂O | 0.5 | 1.0 | 2.5 | 2.6 | 2.6 | | 2.2 | 2.2 | | | 2.1 |
| B₂O₃ | 2.0 | 2.0 | | 2.0 | 3.0 | | | 1.0 | 2.0 | 1.0 | 2.0 |
| TiO₂ | 3.5 | 2.0 | 2.0 | 3.0 | 1.0 | 2.0 | 1.0 | | 1.0 | 1.0 | 2.0 |
| ZrO₂ | 2.5 | 4.5 | 3.0 | 3.2 | 3.4 | 3.1 | 4.0 | 4.0 | 1.0 | 1.0 | 3.0 |
| P₂O₅ | 2.0 | 2.5 | 2.5 | 2.6 | 2.6 | 2.5 | 2.1 | 2.1 | 2.1 | 2.1 | 2.1 |
| Y₂O₃ | | | | | | | | | | | |
| Nb₂O₅ | | | | | | | | | | | |
| Ta₂O₅ | | | | | | | | | | | |
| La₂O₃ | | | | | | | | | | | |
| Sb₂O₃ | 0.4 | 0.5 | 0.5 | 0.5 | 0.5 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 720 | 720 | 720 | 720 | 720 | 720 | 720 | 720 | 720 | 720 | 720 |
| Growing | | | | | | | | | | | |
| Temperature??? | | | | | | | | | | | |
| Nucleous | 10 | 10 | 10 | 10 | 10 | 10 | 10 | 10 | 10 | 10 | 10 |
| Growing | | | | | | | | | | | |
| Time?hr? | | | | | | | | | | | |
| Main Crystalline | LZS | Quartz | Quartz | Crist | Crist | Crist | Crist | Quartz | LZS | LZS | Quartz |
| Phase | | | | | | | | | | | |
| Sub Crystalline | — | Crist | Crist | Quartz | Quartz | Quartz | LZS | Crist | — | — | Crist |
| Phase | | | | | | | | | | | |
| Specific | 2.65 | 2.67 | 2.66 | 2.65 | 2.63 | 2.56 | 2.48 | 2.57 | 2.66 | 2.70 | 2.77 |
| Gravity?g/cm³ | | | | | | | | | | | |
| Yong's Modulus | 85.9 | 85.4 | 82.9 | 79.5 | 79.7 | 80.8 | 75.7 | 81.1 | 82.9 | 84.2 | 88.4 |
| E??Pa | | | | | | | | | | | |
| Elastic Modulus | 32.4 | 32.0 | 31.1 | 30.0 | 30.3 | 31.5 | 30.5 | 31.5 | 31.1 | 31.1 | 31.9 |
| Ratio | | | | | | | | | | | |
| C.T.E | 71 | 109 | 118 | 107 | 105 | 105 | 109 | 120 | 72 | 69 | 109 |
| Amount of | 48 | 56 | 58 | 55 | 55 | 55 | 56 | 58 | 48 | 48 | 56 |
| Migration of | | | | | | | | | | | |
| alkali metal | | | | | | | | | | | |
| [ppb] | | | | | | | | | | | |
| P/Pli | 1.1 | 1.3 | 1.3 | 1.2 | 1.2 | 1.2 | 1.3 | 1.3 | 1.1 | 1.1 | 1.3 |

TABLE 132

| | B-677 | B-678 | B-679 | B-680 | B-681 | B-682 | B-683 | B-684 | B-685 | B-686 | B-687 |
|---|---|---|---|---|---|---|---|---|---|---|---|
| SiO₂ | 63.0 | 63.0 | 65.0 | 65.0 | 65.0 | 58.0 | 61.0 | 60.0 | 62.0 | 60.0 | 64.0 |
| Bl₂O₃ | 6.0 | 9.0 | 4.5 | 4.5 | 5.0 | 6.5 | 7.2 | 6.0 | 7.1 | 7.8 | 8.0 |
| MgO | 2.0 | 2.0 | 2.0 | 3.0 | 2.5 | 2.4 | 1.9 | 1.6 | 2.1 | 2.1 | 2.1 |
| CaO | 0.9 | 0.9 | | | | | | 2.0 | 2.0 | 2.7 | 2.0 |
| BaO | 2.3 | | 3.0 | 2.0 | 2.0 | 2.5 | 2.4 | | | | |
| SrO | | | 2.0 | 1.0 | 1.0 | 2.0 | 1.6 | 1.5 | | | |
| ZnO | 10.0 | 8.0 | 7.0 | 6.0 | 5.0 | 9.0 | 9.4 | 10.0 | 6.4 | 6.2 | 6.5 |
| Li₂O | 6.1 | 8.0 | 7.5 | 7.0 | 7.5 | 7.1 | 5.8 | 6.9 | 7.0 | 7.5 | 7.0 |
| K₂O | 2.1 | 1.5 | 2.5 | 2.5 | 1.0 | 2.5 | 2.0 | 2.4 | 2.5 | 2.2 | 2.2 |
| B₂O₃ | | | | | | 3.0 | | 1.0 | 3.0 | 3.0 | |
| TiO₂ | 2.0 | 2.0 | 0.5 | 3.0 | 5.0 | 3.0 | 3.8 | 1.0 | 3.0 | 3.0 | 1.0 |
| ZrO₂ | 3.0 | 3.0 | 3.0 | 3.0 | 3.0 | 1.1 | 2.5 | 5.0 | 3.5 | 3.0 | 3.7 |
| P₂O₅ | 2.1 | 2.1 | 2.5 | 2.5 | 2.5 | 2.5 | 2.0 | 2.2 | 1.0 | 2.0 | 3.0 |
| Y₂O₃ | | | | | | | 0.0 | | | | |
| Nb₂O₅ | | | | | | | | | | | |
| Ta₂O₅ | | | | | | | | | | | |
| La₂O₃ | | | | | | | | | | | |
| Sb₂O₃ | 0.4 | 0.4 | 0.5 | 0.5 | 0.5 | 0.5 | 0.4 | 0.4 | 0.4 | 0.4 | 0.4 |
| Total (100 wt %) | 100.0 | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 | 1550 |
| Temperature??? | | | | | | | | | | | |
| Melting | 3 | 3 | 3 | 3 | 3 | 3 | 3 | 3 | 3 | 3 | 3 |
| Time?hr? | | | | | | | | | | | |
| Nucleating | 550 | 550 | 550 | 550 | 550 | 550 | 550 | 550 | 550 | 550 | 550 |
| Temperature??? | | | | | | | | | | | |
| Nucleating | 5 | 5 | 5 | 5 | 5 | 5 | 5 | 5 | 5 | 5 | 5 |
| Time?hr? | | | | | | | | | | | |
| Nucleous | 720 | 720 | 720 | 720 | 720 | 720 | 720 | 720 | 720 | 720 | 720 |
| Growing | | | | | | | | | | | |
| Temperature??? | | | | | | | | | | | |
| Nucleous | 10 | 10 | 10 | 10 | 10 | 10 | 10 | 10 | 10 | 10 | 10 |
| Growing | | | | | | | | | | | |
| Time?hr? | | | | | | | | | | | |
| Main Crystalline | Quartz | Quartz | Crist | Quartz | Quartz | Quartz | LZS | Quartz | Quartz | Quartz | Crist |
| Phase | | | | | | | | | | | |
| Sub Crystalline | Crist | Crist | Quartz | Crist | Crist | Crist | — | Crist | Crist | Crist | LZS |
| Phase | | | | | | | | | | | |
| Specific | 2.60 | 2.56 | 2.54 | 2.66 | 2.72 | 2.70 | 2.65 | 2.72 | 2.67 | 2.72 | 2.58 |
| Gravity?g/cm³ | | | | | | | | | | | |
| Yong's Modulus | 87.6 | 81.5 | 83.6 | 84.5 | 83.9 | 84.7 | 85.2 | 86.3 | 85.2 | 85.6 | 77.6 |
| E??Pa | | | | | | | | | | | |
| Elastic Modulus | 33.7 | 31.8 | 32.9 | 31.8 | 30.8 | 31.4 | 32.1 | 31.7 | 31.9 | 31.4 | 30.0 |
| Ratio | | | | | | | | | | | |
| C.T.E | 103 | 111 | 114 | 111 | 115 | 114 | 76 | 112 | 109 | 111 | 118 |
| Amount of | 55 | 56 | 57 | 56 | 57 | 57 | 49 | 57 | 56 | 56 | 58 |
| Migration of | | | | | | | | | | | |
| alkali metal | | | | | | | | | | | |
| [ppb] | | | | | | | | | | | |
| P/Pli | 1.2 | 1.3 | 1.3 | 1.3 | 1.3 | 1.3 | 1.1 | 1.3 | 1.3 | 1.3 | 1.3 |

[Third Embodiment]

Tables 133 and 134 show the glass compositions in % by weight of respective crystallized glass substrates of C-1 to 18, together with the manufacturing conditions employed. Tables 135 and 136 show crystallized glass substrates as C-19 to 36 manufactured using the same glass compositions as those of C-1 to 18 with the nucleus growing temperature varied from that employed for C-1 to 18. Further, Tables 137 and 138 show crystallized glass substrates as C-37 to 54 manufactured using the same glass compositions as those of C-1 to 18 with the nucleus growing time varied from that employed for C-1 to 18.

TABLE 133

| | C-1 | C-2 | C-3 | C-4 | C-5 | C-6 | C-7 | C-8 | C-9 |
|---|---|---|---|---|---|---|---|---|---|
| SiO₂ | 65.0 | 65.4 | 65.0 | 69.4 | 69.0 | 69.0 | 68.0 | 68.0 | 65.0 |
| Al₂O₃ | 7.0 | 7.0 | 7.0 | 6.0 | 6.0 | 6.0 | 5.0 | 9.0 | 7.0 |
| MgO | | 2.0 | 2.5 | | | 3.0 | 1.8 | | 2.0 |
| CaO | | | | 3.0 | | | | | |
| BaO | 9.0 | 9.0 | | 6.0 | 9.0 | | 9.0 | | 9.0 |
| SrO | 3.0 | | 9.0 | | | 6.0 | | 8.0 | |
| ZnO | 2.5 | 2.6 | | 2.6 | 2.5 | 2.6 | | 2.0 | 2.6 |
| Li₂O | 5.0 | 6.0 | 6.0 | 6.0 | 8.0 | 6.0 | 6.0 | 7.5 | 4.0 |
| K₂O | 3.0 | 2.0 | 2.0 | 2.0 | | 2.0 | 2.0 | 0.5 | 2.0 |
| TiO₂ | | | 3.0 | | | | 3.0 | | |
| ZrO₂ | 3.0 | 4.0 | 3.0 | 3.0 | 3.0 | 3.0 | 3.0 | 3.0 | 3.0 |
| P₂O₅ | 2.0 | 2.0 | 2.0 | 2.0 | 2.0 | 2.0 | 2.0 | 2.0 | 2.0 |
| Y₂O₃ | | | | | | | | | 3.0 |
| Nb₂O₅ | | | | | | | | | |
| Ta₂O₅ | | | | | | | | | |
| La₂O₃ | | | | | | | | | |
| Sb₂O₃ | 0.5 | | 0.5 | | 0.5 | 0.4 | 0.2 | | 0.4 |
| Total (100 wt %) | 100.0 | 100.0 | 100.0 | 100.0 | 100.0 | 100.0 | 100.0 | 100.0 | 100.0 |
| Melting Temperature??? | 1550 | 1550 | 1550 | 1550 | 1550 | 1550 | 1550 | 1550 | 1550 |
| Melting Time?hr? | 3 | 3 | 3 | 3 | 3 | 3 | 3 | 3 | 3 |
| Nucleating | 580 | 580 | 580 | 580 | 580 | 580 | 580 | 580 | 580 |
| Temperature??? | | | | | | | | | |
| Nucleating Time?hr? | 5 | 5 | 5 | 5 | 5 | 5 | 5 | 5 | 5 |
| Nucleous Growing | 680 | 680 | 680 | 680 | 680 | 680 | 680 | 680 | 680 |
| Temperature??? | | | | | | | | | |
| Nucleous Growing | 2 | 2 | 2 | 2 | 2 | 2 | 2 | 2 | 2 |
| Time?hr? | | | | | | | | | |
| Main Crystalline Phase | Crist.ss | Crist | Crist | a-Q | a-Q.ss | Crist | a-Q | Crist | Crist |
| Sub Crystalline Phase | — | — | — | — | LAS | LZS | LAS | LZS | — |
| Specific Gravity?g/cm³ | 2.53 | 2.56 | 2.56 | 2.61 | 2.62 | 2.58 | 2.64 | 2.60 | 2.55 |
| Yong's Modulus E??Pa | 78.2 | 77.0 | 76.2 | 85.1 | 83.1 | 79.2 | 83.5 | 78.3 | 77.2 |
| Elastic Modulus Ratio | 30.9 | 30.1 | 29.8 | 32.6 | 31.7 | 30.7 | 31.6 | 30.1 | 30.3 |
| C.T.E | 105 | 108 | 122 | 143 | 95 | 102 | 83 | 99 | 102 |
| Amount of Migration of | 40 | 35 | 50 | 60 | 85 | 80 | 90 | 80 | 85 |
| alkali metal [ppb] | | | | | | | | | |
| P/Pli | 1.2 | 1.2 | 1.4 | 1.2 | 1.1 | 1.2 | 1.2 | 1.2 | 1.3 |

TABLE 134

| | C-10 | C-11 | C-12 | C-13 | C-14 | C-15 | C-16 | C-17 | C-18 |
|---|---|---|---|---|---|---|---|---|---|
| SiO₂ | 68.0 | 66.5 | 67.0 | 68.0 | 68.0 | 65.0 | 65.0 | 68.0 | 65.0 |
| Al₂O₃ | 6.0 | 7.0 | 7.4 | 6.0 | 7.0 | 7.0 | 7.0 | 6.0 | 5.5 |
| MgO | | | 2.0 | 0.5 | | | | | 2.0 |
| CaO | | | | | 1.5 | | | | |
| BaO | 5.0 | 9.0 | | 7.5 | 6.0 | 9.0 | | 9.0 | 6.0 |
| SrO | 7.0 | | 7.0 | | | | 8.0 | | 3.0 |
| ZnO | | 4.0 | 2.0 | 5.0 | 2.0 | 2.5 | 2.5 | | 2.5 |
| Li₂O | 8.0 | 6.0 | 6.0 | 6.0 | 6.0 | 6.0 | 6.0 | 6.0 | 6.0 |
| K₂O | | 2.0 | 2.0 | 2.0 | 2.0 | 2.0 | 2.0 | 2.0 | 2.0 |
| TiO₂ | 1.0 | | | | 2.0 | | | | |
| ZrO₂ | 3.0 | 1.5 | 4.5 | 4.0 | 2.0 | 3.0 | 3.0 | 3.0 | 3.0 |
| P₂O₅ | 2.0 | 2.0 | 1.1 | 1.0 | 3.0 | 2.0 | 2.0 | 2.0 | 2.0 |
| Y₂O₃ | | | | | | 3.0 | | | |
| Nb₂O₅ | | | | | | | 4.0 | | |
| Ta₂O₅ | | | | | | | | 4.0 | |
| La₂O₃ | | | | | | | | | 3.0 |
| Sb₂O₃ | | 2.0 | 1.0 | | 0.5 | 0.5 | 0.5 | | |
| Total (100 wt %) | 100.0 | 100.0 | 100.0 | 100.0 | 100.0 | 100.0 | 100.0 | 100.0 | 100.0 |
| Melting Temperature??? | 1550 | 1550 | 1550 | 1550 | 1550 | 1550 | 1550 | 1550 | 1550 |
| Melting Time?hr? | 3 | 3 | 3 | 3 | 3 | 3 | 3 | 3 | 3 |
| Nucleating | 580 | 580 | 580 | 580 | 580 | 580 | 580 | 580 | 580 |
| Temperature??? | | | | | | | | | |
| Nucleating Time?hr? | 5 | 5 | 5 | 5 | 5 | 5 | 5 | 5 | 5 |
| Nucleous Growing | 680 | 680 | 680 | 680 | 680 | 680 | 680 | 680 | 680 |
| Temperature??? | | | | | | | | | |
| Nucleous Growing | 2 | 2 | 2 | 2 | 2 | 2 | 2 | 2 | 2 |
| Time?hr? | | | | | | | | | |
| Main Crystalline Phase | Crist | Crist | Crist | Crist | a-Q | Crist | Crist | Crist | Crist |
| Sub Crystalline Phase | LAS | LZS | — | LZS | — | — | — | LAS | — |
| Specific Gravity?g/cm³ | 2.61 | 2.62 | 2.51 | 2.59 | 2.58 | 2.50 | 2.62 | 2.64 | 2.65 |
| Yong's Modulus E??Pa | 80.2 | 81.0 | 77.0 | 79.5 | 83.1 | 79.3 | 79.3 | 80.2 | 80.4 |
| Elastic Modulus Ratio | 30.7 | 30.9 | 30.7 | 30.7 | 32.2 | 31.7 | 30.3 | 30.4 | 30.3 |
| C.T.E | 83 | 82 | 120 | 88 | 133 | 101 | 111 | 91 | 99 |
| Amount of Migration of | 80 | 50 | 40 | 75 | 65 | 40 | 60 | 85 | 60 |
| alkali metal [ppb] | | | | | | | | | |
| P/Pli | 1.2 | 1.3 | 1.4 | 1.2 | 1.2 | 1.2 | 1.2 | 1.3 | 1.2 |

TABLE 135

| | C-19 | C-20 | C-21 | C-22 | C-23 | C-24 | C-25 | C-26 | C-27 |
|---|---|---|---|---|---|---|---|---|---|
| SiO₂ | 65.0 | 65.4 | 65.0 | 69.4 | 69.0 | 69.0 | 68.0 | 68.0 | 65.0 |
| Al₂O₃ | 7.0 | 7.0 | 7.0 | 6.0 | 6.0 | 6.0 | 5.0 | 9.0 | 7.0 |
| MgO | | 2.0 | 2.5 | | | 3.0 | 1.8 | | 2.0 |
| CaO | | | | 3.0 | 3.0 | | | | |
| BaO | 9.0 | 9.0 | | 6.0 | 6.0 | | 9.0 | | 9.0 |
| SrO | 3.0 | | 9.0 | | | 6.0 | | 8.0 | |
| ZnO | 2.5 | 2.6 | | 2.6 | 2.5 | 2.6 | | 2.0 | 2.6 |
| Li₂O | 5.0 | 6.0 | 6.0 | 6.0 | 8.0 | 6.0 | 6.0 | 7.5 | 4.0 |
| K₂O | 3.0 | 2.0 | 2.0 | 2.0 | | 2.0 | 2.0 | 0.5 | 2.0 |
| TiO₂ | | | 3.0 | | | | 3.0 | | |
| ZrO₂ | 3.0 | 4.0 | 3.0 | 3.0 | 3.0 | 3.0 | 3.0 | 3.0 | 3.0 |
| P₂O₅ | 2.0 | 2.0 | 2.0 | 2.0 | 2.0 | 2.0 | 2.0 | 2.0 | 2.0 |
| Y₂O₃ | | | | | | | | | 3.0 |
| Nb₂O₅ | | | | | | | | | |
| Ta₂O₅ | | | | | | | | | |
| La₂O₃ | | | | | | | | | |
| Sb₂O₃ | 0.5 | | 0.5 | | 0.5 | 0.4 | 0.2 | | 0.4 |
| Total (100 wt %) | 100.0 | 100.0 | 100.0 | 100.0 | 100.0 | 100.0 | 100.0 | 100.0 | 100.0 |
| Melting Temperature??? | 1550 | 1550 | 1550 | 1550 | 1550 | 1550 | 1550 | 1550 | 1550 |
| Melting Time?hr? | 3 | 3 | 3 | 3 | 3 | 3 | 3 | 3 | 3 |
| Nucleating | 580 | 580 | 580 | 580 | 580 | 580 | 580 | 580 | 580 |
| Temperature??? | | | | | | | | | |
| Nucleating Time?hr? | 5 | 5 | 5 | 5 | 5 | 5 | 5 | 5 | 5 |
| Nucleous Growing | 700 | 700 | 700 | 700 | 700 | 700 | 700 | 700 | 700 |
| Temperature??? | | | | | | | | | |
| Nucleous Growing | 2 | 2 | 2 | 2 | 2 | 2 | 2 | 2 | 2 |
| Time?hr? | | | | | | | | | |
| Main Crystalline Phase | Crist.ss | Crist | Crist | a-Q | a-Q.ss | Crist.ss | a-Q | Crist | Crist.ss |
| Sub Crystalline Phase | — | — | — | — | LAS | LZS | LAS | LZS | — |
| Specific Gravity?g/cm³ | 2.49 | 2.59 | 2.59 | 2.64 | 2.65 | 2.61 | 2.67 | 2.63 | 2.58 |
| Yong's Modulus E??Pa | 77.6 | 76.4 | 75.6 | 84.5 | 82.5 | 78.6 | 82.9 | 77.7 | 76.6 |
| Elastic Modulus Ratio | 31.2 | 29.5 | 29.2 | 32.0 | 31.1 | 30.1 | 31.0 | 29.5 | 29.7 |
| C.T.E | 102 | 105 | 119 | 140 | 92 | 99 | 83 | 96 | 99 |
| Amount of Migration of | 40 | 35 | 55 | 65 | 85 | 80 | 90 | 80 | 85 |
| alkali metal [ppb] | | | | | | | | | |
| P/Pli | 1.2 | 1.2 | 1.4 | 1.2 | 1.1 | 1.2 | 1.2 | 1.2 | 1.3 |

TABLE 136

| | C-28 | C-29 | C-30 | C-31 | C-32 | C-33 | C-34 | C-35 | C-36 |
|---|---|---|---|---|---|---|---|---|---|
| SiO₂ | 68.0 | 66.5 | 67.0 | 68.0 | 68.0 | 65.0 | 65.0 | 68.0 | 65.0 |
| Al₂O₃ | 6.0 | 7.0 | 7.4 | 6.0 | 7.0 | 7.0 | 7.0 | 6.0 | 5.5 |
| MgO | | | 2.0 | 0.5 | | | | | 2.0 |
| CaO | | | | | 1.5 | | | | |
| BaO | 5.0 | 9.0 | | 7.5 | 6.0 | 9.0 | | 9.0 | 6.0 |
| SrO | 7.0 | | 7.0 | | | | 8.0 | | 3.0 |
| ZnO | | 4.0 | 2.0 | 5.0 | 2.0 | 2.5 | 2.5 | | 2.5 |
| Li₂O | 8.0 | 6.0 | 6.0 | 6.0 | 6.0 | 6.0 | 6.0 | 6.0 | 6.0 |
| K₂O | | 2.0 | 2.0 | 2.0 | 2.0 | 2.0 | 2.0 | 2.0 | 2.0 |
| TiO₂ | 1.0 | | | | 2.0 | | | | |
| ZrO₂ | 3.0 | 1.5 | 4.5 | 4.0 | 2.0 | 3.0 | 3.0 | 3.0 | 3.0 |
| P₂O₅ | 2.0 | 2.0 | 1.1 | 1.0 | 3.0 | 2.0 | 2.0 | 2.0 | 2.0 |
| Y₂O₃ | | | | | | 3.0 | | | |
| Nb₂O₅ | | | | | | | 4.0 | | |
| Ta₂O₅ | | | | | | | | 4.0 | |
| La₂O₃ | | | | | | | | | 3.0 |
| Sb₂O₃ | | 2.0 | 1.0 | | 0.5 | 0.5 | 0.5 | | |
| Total (100 wt %) | 100.0 | 100.0 | 100.0 | 100.0 | 100.0 | 100.0 | 100.0 | 100.0 | 100.0 |
| Melting Temperature??? | 1550 | 1550 | 1550 | 1550 | 1550 | 1550 | 1550 | 1550 | 1550 |
| Melting Time?hr? | 3 | 3 | 3 | 3 | 3 | 3 | 3 | 3 | 3 |
| Nucleating | 580 | 580 | 580 | 580 | 580 | 580 | 580 | 580 | 580 |
| Temperature??? | | | | | | | | | |
| Nucleating Time?hr? | 5 | 5 | 5 | 5 | 5 | 5 | 5 | 5 | 5 |
| Nucleous Growing | 700 | 700 | 700 | 700 | 700 | 700 | 700 | 700 | 700 |
| Temperature??? | | | | | | | | | |
| Nucleous Growing | 2 | 2 | 2 | 2 | 2 | 2 | 2 | 2 | 2 |
| Time?hr? | | | | | | | | | |
| Main Crystalline Phase | Crist | Crist | Crist.ss | Crist | a-Q | Crist | Crist | Crist | Crist |
| Sub Crystalline Phase | LAS | LZS | — | LZS | — | — | — | LAS | — |
| Specific Gravity?g/cm³ | 2.64 | 2.65 | 2.54 | 2.62 | 2.61 | 2.53 | 2.65 | 2.67 | 2.68 |
| Yong's Modulus E??Pa | 79.6 | 80.4 | 76.4 | 78.9 | 82.5 | 78.7 | 78.7 | 79.6 | 79.8 |
| Elastic Modulus Ratio | 30.2 | 30.3 | 30.1 | 30.1 | 31.6 | 31.1 | 29.7 | 29.8 | 29.8 |
| C.T.E | 82 | 81 | 117 | 85 | 130 | 98 | 108 | 88 | 96 |
| Amount of Migration of | 80 | 40 | 40 | 75 | 65 | 40 | 55 | 90 | 60 |
| alkali metal [ppb] | | | | | | | | | |
| P/Pli | 1.2 | 1.3 | 1.4 | 1.2 | 1.2 | 1.2 | 1.2 | 1.3 | 1.2 |

TABLE 137

| | C-37 | C-38 | C-39 | C-40 | C-41 | C-42 | C-43 | C-44 | C-45 |
|---|---|---|---|---|---|---|---|---|---|
| SiO₂ | 65.0 | 65.4 | 65.0 | 69.4 | 69.0 | 69.0 | 68.0 | 68.0 | 65.0 |
| Al₂O₃ | 7.0 | 7.0 | 7.0 | 6.0 | 6.0 | 6.0 | 5.0 | 9.0 | 7.0 |
| MgO | | 2.0 | 2.5 | | | 3.0 | 1.8 | | 2.0 |
| CaO | | | | 3.0 | 3.0 | | | | |
| BaO | 9.0 | 9.0 | | 6.0 | 6.0 | | 9.0 | | 9.0 |
| SrO | 3.0 | | 9.0 | | | 6.0 | | 8.0 | |
| ZnO | 2.5 | 2.6 | | 2.6 | 2.5 | 2.6 | | 2.0 | 2.6 |
| Li₂O | 5.0 | 6.0 | 6.0 | 6.0 | 8.0 | 6.0 | 6.0 | 7.5 | 4.0 |
| K₂O | 3.0 | 2.0 | 2.0 | 2.0 | | 2.0 | 2.0 | 0.5 | 2.0 |
| TiO₂ | | | 3.0 | | | | 3.0 | | |
| ZrO₂ | 3.0 | 4.0 | 3.0 | 3.0 | 3.0 | 3.0 | 3.0 | 3.0 | 3.0 |
| P₂O₅ | 2.0 | 2.0 | 2.0 | 2.0 | 2.0 | 2.0 | 2.0 | 2.0 | 2.0 |
| Y₂O₃ | | | | | | | | | 3.0 |
| Nb₂O₅ | | | | | | | | | |
| Ta₂O₅ | | | | | | | | | |
| La₂O₃ | | | | | | | | | |
| Sb₂O₃ | 0.5 | | 0.5 | | 0.5 | 0.4 | 0.2 | | 0.4 |
| Total (100 wt %) | 100.0 | 100.0 | 100.0 | 100.0 | 100.0 | 100.0 | 100.0 | 100.0 | 100.0 |
| Melting Temperature??? | 1550 | 1550 | 1550 | 1550 | 1550 | 1550 | 1550 | 1550 | 1550 |
| Melting Time?hr? | 3 | 3 | 3 | 3 | 3 | 3 | 3 | 3 | 3 |
| Nucleating | 580 | 580 | 580 | 580 | 580 | 580 | 580 | 580 | 580 |
| Temperature??? | | | | | | | | | |
| Nucleating Time?hr? | 5 | 5 | 5 | 5 | 5 | 5 | 5 | 5 | 5 |
| Nucleous Growing | 680 | 680 | 680 | 680 | 680 | 680 | 680 | 680 | 680 |
| Temperature??? | | | | | | | | | |
| Nucleous Growing | 5 | 5 | 5 | 5 | 5 | 5 | 5 | 5 | 5 |
| Time?hr? | | | | | | | | | |
| Main Crystalline Phase | Crist.ss | Crist | Crist | a-Q | a-Q.ss | Crist | a-Q | Crist | Crist |
| Sub Crystalline Phase | — | — | — | — | LAS | LZS | LAS | LZS | — |
| Specific Gravity?g/cm³ | 2.51 | 2.54 | 2.54 | 2.59 | 2.60 | 2.56 | 2.62 | 2.58 | 2.53 |
| Yong's Modulus E??Pa | 77.9 | 76.7 | 75.9 | 84.8 | 82.8 | 78.9 | 83.2 | 78.0 | 76.9 |
| Elastic Modulus Ratio | 31.0 | 30.2 | 29.9 | 32.7 | 31.8 | 30.8 | 31.8 | 30.2 | 30.4 |
| C.T.E | 107 | 110 | 124 | 145 | 97 | 104 | 85 | 101 | 104 |
| Amount of Migration of | 40 | 35 | 50 | 65 | 85 | 80 | 85 | 80 | 85 |
| alkali metal [ppb] | | | | | | | | | |
| P/Pli | 1.2 | 1.2 | 1.4 | 1.2 | 1.1 | 1.2 | 1.2 | 1.2 | 1.3 |

TABLE 138

| | C-46 | C-47 | C-48 | C-49 | C-50 | C-51 | C-52 | C-53 | C-54 |
|---|---|---|---|---|---|---|---|---|---|
| SiO₂ | 68.0 | 66.5 | 67.0 | 68.0 | 68.0 | 65.0 | 65.0 | 68.0 | 65.0 |
| Al₂O₃ | 6.0 | 7.0 | 7.4 | 6.0 | 7.0 | 7.0 | 7.0 | 6.0 | 5.5 |
| MgO | | | 2.0 | 0.5 | | | | | 2.0 |
| CaO | | | | | 1.5 | | | | |
| BaO | 5.0 | 9.0 | | 7.5 | 6.0 | 9.0 | | 9.0 | 6.0 |
| SrO | 7.0 | | 7.0 | | | | 8.0 | | 3.0 |
| ZnO | | 4.0 | 2.0 | 5.0 | 2.0 | 2.5 | 2.5 | | 2.5 |
| Li₂O | 8.0 | 6.0 | 6.0 | 6.0 | 6.0 | 6.0 | 6.0 | 6.0 | 6.0 |
| K₂O | | 2.0 | 2.0 | 2.0 | 2.0 | 2.0 | 2.0 | 2.0 | 2.0 |
| TiO₂ | 1.0 | | | | 2.0 | | | | |
| ZrO₂ | 3.0 | 1.5 | 4.5 | 4.0 | 2.0 | 3.0 | 3.0 | 3.0 | 3.0 |
| P₂O₅ | 2.0 | 2.0 | 1.1 | 1.0 | 3.0 | 2.0 | 2.0 | 2.0 | 2.0 |
| Y₂O₃ | | | | | | 3.0 | | | |
| Nb₂O₅ | | | | | | | 4.0 | | |
| Ta₂O₅ | | | | | | | | 4.0 | |
| La₂O₃ | | | | | | | | | 3.0 |
| Sb₂O₃ | | | 2.0 | 1.0 | | 0.5 | 0.5 | 0.5 | |
| Total (100 wt %) | 100.0 | 100.0 | 100.0 | 100.0 | 100.0 | 100.0 | 100.0 | 100.0 | 100.0 |
| Melting Temperature??? | 1550 | 1550 | 1550 | 1550 | 1550 | 1550 | 1550 | 1550 | 1550 |
| Melting Time?hr? | 3 | 3 | 3 | 3 | 3 | 3 | 3 | 3 | 3 |
| Nucleating | 580 | 580 | 580 | 580 | 580 | 580 | 580 | 580 | 580 |
| Temperature??? | | | | | | | | | |
| Nucleating Time?hr? | 5 | 5 | 5 | 5 | 5 | 5 | 5 | 5 | 5 |
| Nucleous Growing | 680 | 680 | 680 | 680 | 680 | 680 | 680 | 680 | 680 |
| Temperature??? | | | | | | | | | |
| Nucleous Growing | 5 | 5 | 5 | 5 | 5 | 5 | 5 | 5 | 5 |
| Time?hr? | | | | | | | | | |
| Main Crystalline Phase | Crist | Crist | Crist | Crist | a-Q | Crist | Crist | Crist | Crist |
| Sub Crystalline Phase | LAS | LZS | — | LZS | — | — | — | LAS | — |
| Specific Gravity?g/cm³ | 2.59 | 2.60 | 2.49 | 2.57 | 2.56 | 2.48 | 2.60 | 2.62 | 2.63 |
| Yong's Modulus E??Pa | 79.9 | 80.7 | 76.7 | 79.2 | 82.8 | 79.0 | 79.0 | 79.9 | 80.1 |
| Elastic Modulus Ratio | 30.8 | 31.0 | 30.8 | 30.8 | 32.3 | 31.9 | 30.4 | 30.5 | 30.5 |
| C.T.E | 85 | 84 | 122 | 90 | 135 | 103 | 113 | 93 | 101 |
| Amount of Migration of | 75 | 50 | 40 | 80 | 65 | 40 | 60 | 95 | 60 |
| alkali metal [ppb] | | | | | | | | | |
| P/Pli | 1.2 | 1.3 | 1.4 | 1.2 | 1.2 | 1.2 | 1.2 | 1.3 | 1.2 |

Tables 139 and 140 show the glass compositions in % by weight of respective crystallized glass substrates of C-55 to 74, together with the manufacturing conditions employed. Tables 141 and 142 show crystallized glass substrates as C-75 to 94 manufactured using the same glass compositions as those of C-55 to 74 with the nucleus growing temperature varied from that employed for C-55 to 74. Further, Tables 143 and 144 show crystallized glass substrates as C-95 to 114 manufactured using the same glass compositions as those of C-55 to 74 with the nucleus growing time varied from that employed for C-55 to 74.

TABLE 139

| | C-55 | C-56 | C-57 | C-58 | C-59 | C-60 | C-61 | C-62 | C-63 | C-64 |
|---|---|---|---|---|---|---|---|---|---|---|
| SiO₂ | 65.0 | 65.4 | 65.0 | 69.4 | 69.0 | 69.0 | 68.0 | 68.0 | 65.0 | 68.0 |
| Al₂O₃ | 7.0 | 7.0 | 7.0 | 5.5 | 6.0 | 6.0 | 5.0 | 9.0 | 7.0 | 6.0 |
| MgO | 0.5 | 2.0 | 2.5 | 1.0 | 0.5 | 3.0 | 1.8 | 1.0 | 2.0 | 1.0 |
| CaO | | | | 3.0 | | | | | | |
| BaO | 8.5 | 9.0 | | 6.0 | 9.0 | | 9.0 | | 9.0 | 5.0 |
| SrO | 3.0 | | 9.0 | | | 6.0 | | 7.0 | | 6.0 |
| ZnO | 2.5 | 2.6 | | 2.1 | 2.5 | 2.6 | | 2.0 | 2.6 | |
| Li₂O | 5.0 | 6.0 | 6.0 | 6.0 | 7.5 | 6.0 | 6.0 | 7.5 | 4.0 | 8.0 |
| K₂O | 3.0 | 2.0 | 2.0 | 2.0 | | 2.0 | 2.0 | 0.5 | 2.0 | |
| TiO₂ | | | 3.0 | | | | 3.0 | | | 1.0 |
| ZrO₂ | 3.0 | 4.0 | 3.0 | 3.0 | 3.0 | 3.0 | 3.0 | 3.0 | 3.0 | 3.0 |
| P₂O₅ | 2.0 | 2.0 | 2.0 | 2.0 | 2.0 | 2.0 | 2.0 | 2.0 | 2.0 | 2.0 |
| Y₂O₃ | | | | | | | | | 3.0 | |
| Nb₂O₅ | | | | | | | | | | |
| Ta₂O₅ | | | | | | | | | | |
| La₂O₃ | | | | | | | | | | |
| Sb₂O₃ | 0.5 | | 0.5 | | 0.5 | 0.4 | 0.2 | | 0.4 | |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 580 | 580 | 580 | 580 | 580 | 580 | 580 | 580 | 580 | 580 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 680 | 680 | 680 | 680 | 680 | 680 | 680 | 680 | 680 | 680 |
| Temperature??? | | | | | | | | | | |
| Nucleous Growing | 2 | 2 | 2 | 2 | 2 | 2 | 2 | 2 | 2 | 2 |
| Time?hr? | | | | | | | | | | |
| Main Crystalline | Crist.ss | Crist | Crist | a-Q | a-Q.ss | Crist | a-Q | Crist | Crist | Crist |
| Phase | | | | | | | | | | |
| Sub Crystalline | — | — | — | — | LAS | LZS | LAS | LZS | — | LAS |
| Phase | | | | | | | | | | |
| Specific | 2.50 | 2.56 | 2.56 | 2.60 | 2.60 | 2.58 | 2.62 | 2.58 | 2.55 | 2.63 |
| Gravity?g/cm³ | | | | | | | | | | |
| Yong's Modulus | 79.2 | 77.0 | 76.2 | 85.4 | 83.6 | 79.2 | 83.7 | 78.5 | 77.2 | 80.5 |
| E??Pa | | | | | | | | | | |
| Elastic Modulus | 31.7 | 30.1 | 29.8 | 32.8 | 32.2 | 30.7 | 31.9 | 30.4 | 30.3 | 30.6 |
| Ratio | | | | | | | | | | |
| C.T.E | 103 | 105 | 120 | 141 | 92 | 99 | 81 | 97 | 101 | 82 |
| Amount of | 40 | 35 | 50 | 60 | 85 | 80 | 90 | 80 | 85 | 80 |
| Migration of alkali | | | | | | | | | | |
| metal [ppb] | | | | | | | | | | |
| P/Pli | 1.2 | 1.2 | 1.4 | 1.2 | 1.1 | 1.2 | 1.2 | 1.2 | 1.3 | 1.2 |

TABLE 140

| | C-65 | C-66 | C-67 | C-68 | C-69 | C-70 | C-71 | C-72 | C-73 | C-74 |
|---|---|---|---|---|---|---|---|---|---|---|
| SiO₂ | 66.5 | 67.0 | 68.0 | 68.0 | 65.0 | 65.0 | 67.0 | 65.0 | 65.0 | 69.0 |
| Al₂O₃ | 7.0 | 7.4 | 6.0 | 7.0 | 7.0 | 7.0 | 6.0 | 5.5 | 7.0 | 6.0 |
| MgO | 0.5 | 2.0 | 0.5 | 1.0 | 1.0 | 0.5 | 1.5 | 2.0 | 0.5 | 5.0 |
| CaO | | | | 0.5 | | | | | | |
| BaO | 8.5 | | 7.5 | 6.0 | 9.0 | | 8.5 | 6.0 | 8.5 | |
| SrO | | 7.0 | | | | 8.0 | | 3.0 | 2.5 | 5.1 |
| ZnO | 4.0 | 2.0 | 5.0 | 2.0 | 2.5 | 2.5 | | 2.5 | 2.5 | 1.5 |
| Li₂O | 6.0 | 6.0 | 6.0 | 6.0 | 6.0 | 6.0 | 6.0 | 6.0 | 5.0 | 6.0 |
| K₂O | 2.0 | 2.0 | 2.0 | 2.0 | 2.0 | 2.0 | 2.0 | 2.0 | 3.0 | 2.0 |
| TiO₂ | | | | 2.0 | | | | | | |
| ZrO₂ | 1.5 | 4.5 | 4.0 | 2.0 | 3.0 | 3.0 | 3.0 | 3.0 | 3.0 | 3.0 |
| P₂O₅ | 2.0 | 1.1 | 1.0 | 3.0 | 2.0 | 2.0 | 2.0 | 2.0 | 2.0 | 2.0 |
| Y₂O₃ | | | | | 3.0 | | | | | |
| Nb₂O₅ | | | | | | 4.0 | | | | |
| Ta₂O₅ | | | | | | | 4.0 | | | |
| La₂O₃ | | | | | | | | 3.0 | | |
| Sb₂O₃ | 2.0 | 1.0 | | 0.5 | 0.5 | | | | 1.0 | 0.4 |
| Total (100 wt %) | 100.0 | 100.0 | 100.0 | 100.0 | 101.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 580 | 580 | 580 | 580 | 580 | 580 | 580 | 580 | 580 | 580 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 680 | 680 | 680 | 680 | 680 | 680 | 680 | 680 | 680 | 680 |
| Temperature??? | | | | | | | | | | |
| Nucleous Growing | 2 | 2 | 2 | 2 | 2 | 2 | 2 | 2 | 2 | 2 |
| Time?hr? | | | | | | | | | | |
| Main Crystalline | Crist | Crist | Crist | a-Q | Crist | Crist | Crist | Crist | Crist | Crist |
| Phase | | | | | | | | | | |
| Sub Crystalline | LZS | — | LZS | — | — | — | LAS | — | — | — |
| Phase | | | | | | | | | | |
| Specific | 2.60 | 2.51 | 2.59 | 2.55 | 2.48 | 2.60 | 2.62 | 2.63 | 2.59 | 2.48 |
| Gravity?g/cm³ | | | | | | | | | | |
| Yong's Modulus | 81.2 | 77.0 | 79.5 | 83.3 | 79.1 | 79.7 | 80.5 | 81.0 | 78.4 | 80.5 |
| E??Pa | | | | | | | | | | |
| Elastic Modulus | 31.2 | 30.7 | 30.7 | 32.7 | 31.9 | 30.7 | 30.7 | 30.8 | 30.3 | 32.5 |
| Ratio | | | | | | | | | | |
| C.T.E | 81 | 117 | 86 | 131 | 100 | 118 | 89 | 97 | 105 | 91 |
| Amount of | 50 | 40 | 75 | 65 | 40 | 60 | 85 | 60 | 60 | 60 |
| Migration of alkali | | | | | | | | | | |
| metal [ppb] | | | | | | | | | | |
| P/Pli | 1.3 | 1.4 | 1.2 | 1.2 | 1.2 | 1.2 | 1.3 | 1.2 | 1.2 | 1.2 |

TABLE 141

| | C-75 | C-76 | C-77 | C-78 | C-79 | C-80 | C-81 | C-82 | C-83 | C-84 |
|---|---|---|---|---|---|---|---|---|---|---|
| SiO₂ | 65.0 | 65.4 | 65.0 | 69.4 | 69.0 | 69.0 | 68.0 | 68.0 | 65.0 | 68.0 |
| Al₂O₃ | 7.0 | 7.0 | 7.0 | 5.5 | 6.0 | 6.0 | 5.0 | 9.0 | 7.0 | 6.0 |
| MgO | 0.5 | 2.0 | 2.5 | 1.0 | 0.5 | 3.0 | 1.8 | 1.0 | 2.0 | 1.0 |
| CaO | | | | 3.0 | | | | | | |
| BaO | 8.5 | 9.0 | | 6.0 | 9.0 | | 9.0 | | 9.0 | 5.0 |
| SrO | 3.0 | | 9.0 | | | 6.0 | | 7.0 | | 6.0 |
| ZnO | 2.5 | 2.6 | | 2.1 | 2.5 | 2.6 | | 2.0 | 2.6 | |
| Li₂O | 5.0 | 6.0 | 6.0 | 6.0 | 7.5 | 6.0 | 6.0 | 7.5 | 4.0 | 8.0 |
| K₂O | 3.0 | 2.0 | 2.0 | 2.0 | | 2.0 | 2.0 | 0.5 | 2.0 | |
| TiO₂ | | | 3.0 | | | | 3.0 | | | 1.0 |
| ZrO₂ | 3.0 | 4.0 | 3.0 | 3.0 | 3.0 | 3.0 | 3.0 | 3.0 | 3.0 | 3.0 |
| P₂O₅ | 2.0 | 2.0 | 2.0 | 2.0 | 2.0 | 2.0 | 2.0 | 2.0 | 2.0 | 2.0 |
| Y₂O₃ | | | | | | | | | 3.0 | |
| Nb₂O₅ | | | | | | | | | | |
| Ta₂O₅ | | | | | | | | | | |
| La₂O₃ | | | | | | | | | | |
| Sb₂O₃ | 0.5 | | 0.5 | | 0.5 | 0.4 | 0.2 | | 0.4 | |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 580 | 580 | 580 | 580 | 580 | 580 | 580 | 580 | 580 | 580 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 700 | 700 | 700 | 700 | 700 | 700 | 700 | 700 | 700 | 700 |
| Temperature??? | | | | | | | | | | |
| Nucleous Growing | 2 | 2 | | 2 | 2 | 2 | 2 | 2 | 2 | 2 |
| Time?hr? | | | | | | | | | | |
| Main Crystalline | Crist.ss | Crist | Crist | a-Q | a-Q.ss | Crist | a-Q | Crist | Crist | Crist |
| Phase | | | | | | | | | | |
| Sub Crystalline | — | — | — | — | LAS | LZS | LAS | LZS | — | LAS |
| Phase | | | | | | | | | | |
| Specific | 2.46 | 2.52 | 2.52 | 2.56 | 2.56 | 2.54 | 2.58 | 2.54 | 2.51 | 2.59 |
| Gravity?g/cm³ | | | | | | | | | | |
| Yong's Modulus | 78.6 | 76.4 | 75.6 | 84.8 | 83.0 | 78.6 | 83.1 | 77.9 | 76.6 | 79.9 |
| E??Pa | | | | | | | | | | |
| Elastic Modulus | 32.0 | 30.3 | 30.0 | 33.1 | 32.4 | 30.9 | 32.2 | 30.7 | 30.5 | 30.8 |
| Ratio | | | | | | | | | | |
| C.T.E | 100 | 102 | 117 | 138 | 89 | 96 | 81 | 94 | 98 | 83 |
| Amount of | 40 | 35 | 50 | 60 | 85 | 80 | 90 | 80 | 85 | 80 |
| Migration of alkali | | | | | | | | | | |
| metal [ppb] | | | | | | | | | | |
| P/Pli | 1.2 | 1.2 | 1.4 | 1.2 | 1.1 | 1.2 | 1.2 | 1.2 | 1.3 | 1.2 |

TABLE 142

| | C-85 | C-86 | C-87 | C-88 | C-89 | C-90 | C-91 | C-92 | C-93 | C-94 |
|---|---|---|---|---|---|---|---|---|---|---|
| SiO₂ | 66.5 | 67.0 | 68.0 | 68.0 | 65.0 | 65.0 | 67.0 | 65.0 | 65.0 | 69.0 |
| Al₂O₃ | 7.0 | 7.4 | 6.0 | 7.0 | 7.0 | 7.0 | 6.0 | 5.5 | 7.0 | 6.0 |
| MgO | 0.5 | 2.0 | 0.5 | 1.0 | 1.0 | 0.5 | 1.5 | 2.0 | 0.5 | 5.0 |
| CaO | | | | 0.5 | | | | | | |
| BaO | 8.5 | | 7.5 | 6.0 | 9.0 | | 8.5 | 6.0 | 8.5 | |
| SrO | | 7.0 | | | | 8.0 | | 3.0 | 2.5 | 5.1 |
| ZnO | 4.0 | 2.0 | 5.0 | 2.0 | 2.5 | 2.5 | | 2.5 | 2.5 | 1.5 |
| Li₂O | 6.0 | 6.0 | 6.0 | 6.0 | 6.0 | 6.0 | 6.0 | 6.0 | 5.0 | 6.0 |
| K₂O | 2.0 | 2.0 | 2.0 | 2.0 | 2.0 | 2.0 | 2.0 | 2.0 | 3.0 | 2.0 |
| TiO₂ | | | | 2.0 | | | | | | |
| ZrO₂ | 1.5 | 4.5 | 4.0 | 2.0 | 3.0 | 3.0 | 3.0 | 3.0 | 3.0 | 3.0 |
| P₂O₅ | 2.0 | 1.1 | 1.0 | 3.0 | 2.0 | 2.0 | 2.0 | 2.0 | 2.0 | 2.0 |
| Y₂O₃ | | | | | 3.0 | | | | | |
| Nb₂O₅ | | | | | | 4.0 | | | | |
| Ta₂O₅ | | | | | | | 4.0 | | | |
| La₂O₃ | | | | | | | | 3.0 | | |
| Sb₂O₃ | 2.0 | 1.0 | | 0.5 | 0.5 | | | | 1.0 | 0.4 |
| Total (100 wt %) | 100.0 | 100.0 | 100.0 | 100.0 | 101.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 580 | 580 | 580 | 580 | 580 | 580 | 580 | 580 | 580 | 580 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 700 | 700 | 700 | 700 | 700 | 700 | 700 | 700 | 700 | 700 |
| Temperature??? | | | | | | | | | | |
| Nucleous Growing | 2 | 2 | 2 | 2 | 2 | 2 | 2 | 2 | 2 | 2 |
| Time?hr? | | | | | | | | | | |
| Main Crystalline | Crist | Crist | Crist | a-Q | Crist | Crist | Crist | Crist | Crist | Crist |
| Phase | | | | | | | | | | |
| Sub Crystalline | LZS | — | LZS | — | — | — | LAS | — | — | — |
| Phase | | | | | | | | | | |
| Specific | 2.56 | 2.47 | 2.55 | 2.51 | 2.44 | 2.56 | 2.58 | 2.59 | 2.55 | 2.44 |
| Gravity?g/cm³ | | | | | | | | | | |
| Yong's Modulus | 80.6 | 76.4 | 78.9 | 82.7 | 78.5 | 79.1 | 79.9 | 80.4 | 77.8 | 79.9 |
| E??Pa | | | | | | | | | | |
| Elastic Modulus | 31.5 | 30.9 | 30.9 | 32.9 | 32.2 | 30.9 | 31.0 | 31.0 | 30.5 | 32.7 |
| Ratio | | | | | | | | | | |
| C.T.E | 87 | 114 | 83 | 128 | 97 | 115 | 86 | 94 | 102 | 88 |
| Amount of | 50 | 40 | 75 | 65 | 40 | 60 | 85 | 60 | 60 | 60 |
| Migration of alkali | | | | | | | | | | |
| metal [ppb] | | | | | | | | | | |
| P/Pli | 1.3 | 1.4 | 1.2 | 1.2 | 1.2 | 1.2 | 1.3 | 1.2 | 1.2 | 1.2 |

TABLE 143

| | C-95 | C-96 | C-97 | C-98 | C-99 | C-100 | C-101 | C-102 | C-103 | C-104 |
|---|---|---|---|---|---|---|---|---|---|---|
| SiO₂ | 65.0 | 65.4 | 65.0 | 69.4 | 69.0 | 69.0 | 68.0 | 68.0 | 65.0 | 68.0 |
| Al₂O₃ | 7.0 | 7.0 | 7.0 | 5.5 | 6.0 | 6.0 | 5.0 | 9.0 | 7.0 | 6.0 |
| MgO | 0.5 | 2.0 | 2.5 | 1.0 | 0.5 | 3.0 | 1.8 | 1.0 | 2.0 | 1.0 |
| CaO | | | | 3.0 | | | | | | |
| BaO | 8.5 | 9.0 | | 6.0 | 9.0 | | 9.0 | | 9.0 | 5.0 |
| SrO | 3.0 | | 9.0 | | | 6.0 | | 7.0 | | 6.0 |
| ZnO | 2.5 | 2.6 | | 2.1 | 2.5 | 2.6 | | 2.0 | 2.6 | |
| Li₂O | 5.0 | 6.0 | 6.0 | 6.0 | 7.5 | 6.0 | 6.0 | 7.5 | 4.0 | 8.0 |
| K₂O | 3.0 | 2.0 | 2.0 | 2.0 | | 2.0 | 2.0 | 0.5 | 2.0 | |
| TiO₂ | | | 3.0 | | | | 3.0 | | | 1.0 |
| ZrO₂ | 3.0 | 4.0 | 3.0 | 3.0 | 3.0 | 3.0 | 3.0 | 3.0 | 3.0 | 3.0 |
| P₂O₅ | 2.0 | 2.0 | 2.0 | 2.0 | 2.0 | 2.0 | 2.0 | 2.0 | 2.0 | 2.0 |
| Y₂O₃ | | | | | | | | | 3.0 | |
| Nb₂O₅ | | | | | | | | | | |
| Ta₂O₅ | | | | | | | | | | |
| La₂O₃ | | | | | | | | | | |
| Sb₂O₃ | 0.5 | | 0.5 | | 0.5 | 0.4 | 0.2 | | 0.4 | |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 580 | 580 | 580 | 580 | 580 | 580 | 580 | 580 | 580 | 580 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 680 | 680 | 680 | 680 | 680 | 680 | 680 | 680 | 680 | 680 |
| Temperature??? | | | | | | | | | | |
| Nucleous Growing | 2 | 2 | 2 | 2 | 2 | 2 | 2 | 2 | 2 | 2 |
| Time?hr? | | | | | | | | | | |
| Main Crystalline | Crist.ss | Crist | Crist | a-Q | a-Q.ss | Crist | a-Q | Crist | Crist | Crist |
| Phase | | | | | | | | | | |
| Sub Crystalline | — | — | — | — | LAS | LZS | LAS | LZS | — | LAS |
| Phase | | | | | | | | | | |
| Specific | 2.48 | 2.54 | 2.54 | 2.58 | 2.58 | 2.56 | 2.60 | 2.56 | 2.53 | 2.61 |
| Gravity?g/cm³ | | | | | | | | | | |
| Yong's Modulus | 78.9 | 76.7 | 75.9 | 85.1 | 83.3 | 78.9 | 83.4 | 78.2 | 76.9 | 80.2 |
| E??Pa | | | | | | | | | | |
| Elastic Modulus | 31.8 | 30.2 | 29.9 | 33.0 | 32.3 | 30.8 | 32.1 | 30.5 | 30.4 | 30.7 |
| Ratio | | | | | | | | | | |
| C.T.E | 105 | 107 | 122 | 143 | 94 | 101 | 83 | 99 | 103 | 84 |
| Amount of | 40 | 35 | 50 | 60 | 85 | 80 | 90 | 80 | 85 | 80 |
| Migration of alkali | | | | | | | | | | |
| metal [ppb] | | | | | | | | | | |
| P/Pli | 1.2 | 1.2 | 1.4 | 1.2 | 1.1 | 1.2 | 1.2 | 1.2 | 1.3 | 1.2 |

TABLE 144

| | C-105 | C-106 | C-107 | C-108 | C-109 | C-110 | C-111 | C-112 | C-113 | C-114 |
|---|---|---|---|---|---|---|---|---|---|---|
| SiO₂ | 66.5 | 67.0 | 68.0 | 68.0 | 65.0 | 65.0 | 67.0 | 65.0 | 65.0 | 69.0 |
| Al₂O₃ | 7.0 | 7.4 | 6.0 | 7.0 | 7.0 | 7.0 | 6.0 | 5.5 | 7.0 | 6.0 |
| MgO | 0.5 | 2.0 | 0.5 | 1.0 | 1.0 | 0.5 | 1.5 | 2.0 | 0.5 | 5.0 |
| CaO | | | | 0.5 | | | | | | |
| BaO | 8.5 | | 7.5 | 6.0 | 9.0 | | 8.5 | 6.0 | 8.5 | |
| SrO | | 7.0 | | | | 8.0 | | 3.0 | 2.5 | 5.1 |
| ZnO | 4.0 | 2.0 | 5.0 | 2.0 | 2.5 | 2.5 | | 2.5 | 2.5 | 1.5 |
| Li₂O | 6.0 | 6.0 | 6.0 | 6.0 | 6.0 | 6.0 | 6.0 | 6.0 | 5.0 | 6.0 |
| K₂O | 2.0 | 2.0 | 2.0 | 2.0 | 2.0 | 2.0 | 2.0 | 2.0 | 3.0 | 2.0 |
| TiO₂ | | | | 2.0 | | | | | | |
| ZrO₂ | 1.5 | 4.5 | 4.0 | 2.0 | 3.0 | 3.0 | 3.0 | 3.0 | 3.0 | 3.0 |
| P₂O₅ | 2.0 | 1.1 | 1.0 | 3.0 | 2.0 | 2.0 | 2.0 | 2.0 | 2.0 | 2.0 |
| Y₂O₃ | | | | | 3.0 | | | | | |
| Nb₂O₅ | | | | | | 4.0 | | | | |
| Ta₂O₅ | | | | | | | 4.0 | | | |
| La₂O₃ | | | | | | | | 3.0 | | |
| Sb₂O₃ | 2.0 | 1.0 | | 0.5 | 0.5 | | | | 1.0 | 0.4 |
| Total (100 wt %) | 100.0 | 100.0 | 100.0 | 100.0 | 101.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 580 | 580 | 580 | 580 | 580 | 580 | 580 | 580 | 580 | 580 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 680 | 680 | 680 | 680 | 680 | 680 | 680 | 680 | 680 | 680 |
| Temperature??? | | | | | | | | | | |
| Nucleous Growing | 2 | 2 | 2 | 2 | 2 | 2 | 2 | 2 | 2 | 2 |
| Time?hr? | | | | | | | | | | |
| Main Crystalline | Crist | Crist | Crist | a-Q | Crist | Crist | Crist | Crist | Crist | Crist |
| Phase | | | | | | | | | | |
| Sub Crystalline | LZS | — | LZS | — | — | — | LAS | — | — | — |
| Phase | | | | | | | | | | |
| Specific | 2.58 | 2.49 | 2.57 | 2.53 | 2.46 | 2.58 | 2.60 | 2.61 | 2.57 | 2.46 |
| Gravity?g/cm³ | | | | | | | | | | |
| Yong's Modulus | 80.9 | 76.7 | 79.2 | 83.0 | 78.8 | 79.4 | 80.2 | 80.7 | 78.1 | 80.2 |
| E??Pa | | | | | | | | | | |
| Elastic Modulus | 31.4 | 30.8 | 30.8 | 32.8 | 32.0 | 30.8 | 30.8 | 30.9 | 30.4 | 32.6 |
| Ratio | | | | | | | | | | |
| C.T.E | 83 | 119 | 88 | 133 | 102 | 120 | 91 | 99 | 107 | 93 |
| Amount of | 50 | 40 | 75 | 65 | 40 | 60 | 85 | 60 | 60 | 60 |
| Migration of alkali | | | | | | | | | | |
| metal [ppb] | | | | | | | | | | |
| P/Pli | 1.3 | 1.4 | 1.2 | 1.2 | 1.2 | 1.2 | 1.3 | 1.2 | 1.2 | 1.2 |

Tables 145 and 146 show the glass compositions in % by weight of respective crystallized glass substrates of C-115 to 134, together with the manufacturing conditions employed. Tables 147 and 148 show crystallized glass substrates as C-135 to 154 manufactured using the same glass compositions as those of C-115 to 134 with the nucleus growing temperature varied from that employed for C-115 to 134. Further, Tables 149 and 150 show crystallized glass substrates as C-155 to 174 manufactured using the same glass compositions as those of C-115 to 134 with the nucleus growing time varied from that employed for C-115to 134.

TABLE 145

| | C-115 | C-116 | C-117 | C-118 | C-119 | C-120 | C-121 | C-122 | C-123 | C-124 |
|---|---|---|---|---|---|---|---|---|---|---|
| SiO₂ | 65.0 | 65.4 | 65.0 | 69.4 | 69.0 | 69.0 | 68.0 | 68.0 | 65.0 | 68.0 |
| Al₂O₃ | 7.0 | 7.0 | 7.0 | 6.0 | 6.0 | 6.0 | 5.0 | 9.0 | 7.0 | 6.0 |
| MgO | | 2.0 | 2.5 | | | 3.0 | 1.8 | | | |
| CaO | 1.0 | 1.0 | 1.0 | 3.0 | 0.5 | 0.5 | 1.0 | 0.5 | 2.0 | 1.0 |
| BaO | 8.0 | 8.0 | | 6.0 | 8.5 | | 8.0 | | 9.0 | 5.0 |
| SrO | 3.0 | | 8.0 | | | 5.5 | | 7.5 | | 6.0 |
| ZnO | 2.5 | 2.6 | | 2.6 | 2.5 | 2.6 | | 2.0 | 2.6 | |
| Li₂O | 5.0 | 6.0 | 6.0 | 6.0 | 8.0 | 6.0 | 6.0 | 7.5 | 4.0 | 8.0 |
| K₂O | 3.0 | 2.0 | 2.0 | 2.0 | | 2.0 | 2.0 | 0.5 | 2.0 | |
| TiO₂ | | | 3.0 | | | | 3.0 | | | 1.0 |
| ZrO₂ | 3.0 | 4.0 | 3.0 | 3.0 | 3.0 | 3.0 | 3.0 | 3.0 | 3.0 | 3.0 |
| P₂O₅ | 2.0 | 2.0 | 2.0 | 2.0 | 2.0 | 2.0 | 2.0 | 2.0 | 2.0 | 2.0 |
| Y₂O₃ | | | | | | | | | 3.0 | |
| Nb₂O₅ | | | | | | | | | | |
| Ta₂O₅ | | | | | | | | | | |
| La₂O₃ | | | | | | | | | | |
| Sb₂O₃ | 0.5 | | 0.5 | | 0.5 | 0.4 | 0.2 | | 0.4 | |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 580 | 580 | 580 | 580 | 580 | 580 | 580 | 580 | 580 | 580 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous | 680 | 680 | 680 | 680 | 680 | 680 | 680 | 680 | 680 | 680 |
| Growing | | | | | | | | | | |
| Temperature??? | | | | | | | | | | |
| Nucleous | 2 | 2 | 2 | 2 | 2 | 2 | 2 | 2 | 2 | 2 |
| Growing Time?hr? | | | | | | | | | | |
| Main Crystalline | Crist.ss | Crist | Crist | a-Q | a-Q.ss | Crist | a-Q | Crist | Crist | Crist |
| Phase | | | | | | | | | | |
| Sub Crystalline | — | — | — | — | LAS | LZS | LAS | LZS | — | LAS |
| Phase | | | | | | | | | | |
| Specific | 2.51 | 2.53 | 2.54 | 2.61 | 2.62 | 2.57 | 2.62 | 2.58 | 2.50 | 2.60 |
| Gravity?g/cm³ | | | | | | | | | | |
| Yong's Modulus | 80.2 | 78.1 | 77.3 | 85.1 | 83.1 | 79.7 | 83.9 | 78.5 | 78.6 | 81.2 |
| E??Pa | | | | | | | | | | |
| Elastic Modulus | 32.0 | 30.9 | 30.4 | 32.6 | 31.7 | 31.0 | 32.0 | 30.4 | 31.4 | 31.2 |
| Ratio | | | | | | | | | | |
| C.T.E | 103 | 106 | 120 | 143 | 95 | 101 | 83 | 98 | 101 | 83 |
| Amount of | 40 | 35 | 50 | 60 | 85 | 80 | 90 | 80 | 85 | 80 |
| Migration of alkali | | | | | | | | | | |
| metal [ppb] | | | | | | | | | | |
| P/Pli | 1.2 | 1.2 | 1.4 | 1.2 | 1.1 | 1.2 | 1.2 | 1.2 | 1.3 | 1.2 |

TABLE 146

| | C-125 | C-126 | C-127 | C-128 | C-129 | C-130 | C-131 | C-132 | C-133 | C-134 |
|---|---|---|---|---|---|---|---|---|---|---|
| SiO₂ | 66.5 | 67.0 | 68.0 | 68.0 | 65.0 | 65.0 | 68.0 | 65.0 | 65.0 | 69.0 |
| Al₂O₃ | 7.0 | 6.9 | 6.0 | 7.0 | 7.0 | 7.0 | 6.0 | 5.5 | 7.0 | 6.0 |
| MgO | | 2.0 | 0.5 | | | | | 2.0 | | |
| CaO | 0.5 | 0.5 | 0.5 | 1.5 | 0.5 | 1.0 | 0.5 | 1.0 | 0.5 | 5.0 |
| BaO | 8.5 | | 7.0 | 6.0 | 8.5 | | 8.5 | 6.0 | 7.0 | |
| SrO | | 7.0 | | | | 7.0 | | 3.0 | 4.5 | 5.1 |
| ZnO | 4.0 | 2.0 | 5.0 | 2.0 | 2.5 | 2.5 | | 1.5 | 2.5 | 1.5 |
| Li₂O | 6.0 | 6.0 | 6.0 | 6.0 | 6.0 | 6.0 | 6.0 | 6.0 | 5.0 | 6.0 |
| K₂O | 2.0 | 2.0 | 2.0 | 2.0 | 2.0 | 2.0 | 2.0 | 2.0 | 3.0 | 2.0 |
| TiO₂ | | | | 2.0 | | | | | | |
| ZrO₂ | 1.5 | 4.5 | 4.0 | 2.0 | 3.0 | 3.0 | 3.0 | 3.0 | 3.0 | 3.0 |
| P₂O₅ | 2.0 | 1.1 | 1.0 | 3.0 | 2.0 | 2.0 | 2.0 | 2.0 | 2.0 | 2.0 |
| Y₂O₃ | | | | | 3.0 | | | | | |
| Nb₂O₅ | | | | | | 4.0 | | | | |
| Ta₂O₅ | | | | | | | 4.0 | | | |
| La₂O₃ | | | | | | | | 3.0 | | |
| Sb₂O₃ | 2.0 | 1.0 | | 0.5 | 0.5 | 0.5 | | | 0.5 | 0.4 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 580 | 580 | 580 | 580 | 580 | 580 | 580 | 580 | 580 | 580 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 680 | 680 | 680 | 680 | 680 | 680 | 680 | 680 | 680 | 680 |
| Temperature??? | | | | | | | | | | |
| Nucleous Growing | 2 | 2 | 2 | 2 | 2 | 2 | 2 | 2 | 2 | 2 |
| Time?hr? | | | | | | | | | | |
| Main Crystalline | Crist | Crist | Crist | a-Q | Crist | Crist | Crist | Crist | Crist | Crist.ss |
| Phase | | | | | | | | | | |
| Sub Crystalline | LZS | — | LZS | — | — | — | LAS | — | LZS | LZS |
| Phase | | | | | | | | | | |
| Specific | 2.61 | 2.50 | 2.58 | 2.58 | 2.48 | 2.60 | 2.63 | 2.62 | 2.58 | 2.50 |
| Gravity?g/cm³ | | | | | | | | | | |
| Yong's Modulus | 81.2 | 77.5 | 79.9 | 83.1 | 79.5 | 80.0 | 80.4 | 80.6 | 79.8 | 80.2 |
| E??Pa | | | | | | | | | | |
| Elastic Modulus | 31.1 | 31.0 | 31.0 | 32.2 | 32.1 | 30.8 | 30.6 | 30.8 | 30.9 | 32.1 |
| Ratio | | | | | | | | | | |
| C.T.E | 82 | 120 | 87 | 133 | 100 | 108 | 89 | 98 | 89 | 100 |
| Amount of | 50 | 40 | 75 | 65 | 40 | 60 | 85 | 60 | 75 | 40 |
| Migration of alkali | | | | | | | | | | |
| metal [ppb] | | | | | | | | | | |
| P/Pli | 1.3 | 1.4 | 1.2 | 1.2 | 1.2 | 1.2 | 1.3 | 1.2 | 1.2 | 1.2 |

TABLE 147

| | C-135 | C-136 | C-137 | C-138 | C-139 | C-140 | C-141 | C-142 | C-143 | C-144 |
|---|---|---|---|---|---|---|---|---|---|---|
| SiO₂ | 65.0 | 65.4 | 65.0 | 69.4 | 69.0 | 69.0 | 68.0 | 68.0 | 65.0 | 68.0 |
| Al₂O₃ | 7.0 | 7.0 | 7.0 | 6.0 | 6.0 | 6.0 | 5.0 | 9.0 | 7.0 | 6.0 |
| MgO | | 2.0 | 2.5 | | | 3.0 | 1.8 | | | |
| CaO | 1.0 | 1.0 | 1.0 | 3.0 | 0.5 | 0.5 | 1.0 | 0.5 | 2.0 | 1.0 |
| BaO | 8.0 | 8.0 | | 6.0 | 8.5 | | 8.0 | | 9.0 | 5.0 |
| SrO | 3.0 | | 8.0 | | | 5.5 | | 7.5 | | 6.0 |
| ZnO | 2.5 | 2.6 | | 2.6 | 2.5 | 2.6 | | 2.0 | 2.6 | |
| Li₂O | 5.0 | 6.0 | 6.0 | 6.0 | 8.0 | 6.0 | 6.0 | 7.5 | 4.0 | 8.0 |
| K₂O | 3.0 | 2.0 | 2.0 | 2.0 | | 2.0 | 2.0 | 0.5 | 2.0 | |
| TiO₂ | | | 3.0 | | | | 3.0 | | | 1.0 |
| ZrO₂ | 3.0 | 4.0 | 3.0 | 3.0 | 3.0 | 3.0 | 3.0 | 3.0 | 3.0 | 3.0 |
| P₂O₅ | 2.0 | 2.0 | 2.0 | 2.0 | 2.0 | 2.0 | 2.0 | 2.0 | 2.0 | 2.0 |
| Y₂O₃ | | | | | | | | | 3.0 | |
| Nb₂O₅ | | | | | | | | | | |
| Ta₂O₅ | | | | | | | | | | |
| La₂O₃ | | | | | | | | | | |
| Sb₂O₃ | 0.5 | | 0.5 | | 0.5 | 0.4 | 0.2 | | 0.4 | |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 580 | 580 | 580 | 580 | 580 | 580 | 580 | 580 | 580 | 580 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 700 | 700 | 700 | 700 | 700 | 700 | 700 | 700 | 700 | 700 |
| Temperature??? | | | | | | | | | | |
| Nucleous Growing | 2 | 2 | 2 | 2 | 2 | 2 | 2 | 2 | 2 | 2 |
| Time?hr? | | | | | | | | | | |
| Main Crystalline | Crist.ss | Crist | Crist | a-Q | a-Q.ss | Crist | a-Q | Crist | Crist | Crist |
| Phase | | | | | | | | | | |
| Sub Crystalline | — | — | — | — | LAS | LZS | LAS | LZS | — | LAS |
| Phase | | | | | | | | | | |
| Specific | 2.47 | 2.49 | 2.50 | 2.57 | 2.58 | 2.53 | 2.58 | 2.54 | 2.46 | 2.56 |
| Gravity?g/cm³ | | | | | | | | | | |
| Yong's Modulus | 79.6 | 77.5 | 76.7 | 84.5 | 82.5 | 79.1 | 83.3 | 77.9 | 78.0 | 80.6 |
| E??Pa | | | | | | | | | | |
| Elastic Modulus | 32.2 | 31.1 | 30.7 | 32.9 | 32.0 | 31.3 | 32.3 | 30.7 | 31.7 | 31.5 |
| Ratio | | | | | | | | | | |
| C.T.E | 100 | 103 | 117 | 140 | 92 | 98 | 82 | 95 | 98 | 82 |
| Amount of | 40 | 35 | 50 | 60 | 85 | 80 | 90 | 80 | 85 | 80 |
| Migration of alkali | | | | | | | | | | |
| metal [ppb] | | | | | | | | | | |
| P/Pli | 1.2 | 1.2 | 1.4 | 1.2 | 1.1 | 1.2 | 1.2 | 1.2 | 1.3 | 1.2 |

TABLE 148

| | C-145 | C-146 | C-147 | C-148 | C-149 | C-150 | C-151 | C-152 | C-153 | C-154 |
|---|---|---|---|---|---|---|---|---|---|---|
| SiO₂ | 66.5 | 67.0 | 68.0 | 68.0 | 65.0 | 65.0 | 68.0 | 65.0 | 65.0 | 69.0 |
| Al₂O₃ | 7.0 | 6.9 | 6.0 | 7.0 | 7.0 | 7.0 | 6.0 | 5.5 | 7.0 | 6.0 |
| MgO | | 2.0 | 0.5 | | | | | 2.0 | | |
| CaO | 0.5 | 0.5 | 0.5 | 1.5 | 0.5 | 1.0 | 0.5 | 1.0 | 0.5 | 5.0 |
| BaO | 8.5 | | 7.0 | 6.0 | 8.5 | | 8.5 | 6.0 | 7.0 | |
| SrO | | 7.0 | | | | 7.0 | | 3.0 | 4.5 | 5.1 |
| ZnO | 4.0 | 2.0 | 5.0 | 2.0 | 2.5 | 2.5 | | 1.5 | 2.5 | 1.5 |
| Li₂O | 6.0 | 6.0 | 6.0 | 6.0 | 6.0 | 6.0 | 6.0 | 6.0 | 5.0 | 6.0 |
| K₂O | 2.0 | 2.0 | 2.0 | 2.0 | 2.0 | 2.0 | 2.0 | 2.0 | 3.0 | 2.0 |
| TiO₂ | | | | 2.0 | | | | | | |
| ZrO₂ | 1.5 | 4.5 | 4.0 | 2.0 | 3.0 | 3.0 | 3.0 | 3.0 | 3.0 | 3.0 |
| P₂O₅ | 2.0 | 1.1 | 1.0 | 3.0 | 2.0 | 2.0 | 2.0 | 2.0 | 2.0 | 2.0 |
| Y₂O₃ | | | | | 3.0 | | | | | |
| Nb₂O₅ | | | | | | 4.0 | | | | |
| Ta₂O₅ | | | | | | | 4.0 | | | |
| La₂O₃ | | | | | | | | 3.0 | | |
| Sb₂O₃ | 2.0 | 1.0 | | 0.5 | 0.5 | 0.5 | | | 0.5 | 0.4 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 580 | 580 | 580 | 580 | 580 | 580 | 580 | 580 | 580 | 580 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 700 | 700 | 700 | 700 | 700 | 700 | 700 | 700 | 700 | 700 |
| Temperature??? | | | | | | | | | | |
| Nucleous Growing | 2 | 2 | 2 | 2 | 2 | 2 | 2 | 2 | 2 | 2 |
| Time?hr? | | | | | | | | | | |
| Main Crystalline | Crist | Crist | Crist | a-Q | Crist | Crist | Crist | Crist | Crist | Crist.ss |
| Phase | | | | | | | | | | |
| Sub Crystalline | LZS | — | LZS | — | — | — | LAS | — | LZS | LZS |
| Phase | | | | | | | | | | |
| Specific | 2.57 | 2.46 | 2.54 | 2.54 | 2.44 | 2.56 | 2.59 | 2.58 | 2.54 | 2.46 |
| Gravity?g/cm³ | | | | | | | | | | |
| Yong's Modulus | 80.6 | 76.9 | 79.3 | 82.5 | 78.9 | 79.4 | 79.8 | 80.0 | 79.2 | 79.6 |
| E??Pa | | | | | | | | | | |
| Elastic Modulus | 31.4 | 31.3 | 31.2 | 32.5 | 32.3 | 31.0 | 30.8 | 31.0 | 31.2 | 32.4 |
| Ratio | | | | | | | | | | |
| C.T.E | 81 | 117 | 84 | 130 | 97 | 105 | 86 | 95 | 86 | 97 |
| Amount of | 50 | 40 | 75 | 65 | 40 | 60 | 85 | 60 | 75 | 40 |
| Migration of alkali | | | | | | | | | | |
| metal [ppb] | | | | | | | | | | |
| P/Pli | 1.3 | 1.4 | 1.2 | 1.2 | 1.2 | 1.2 | 1.3 | 1.2 | 1.2 | 1.2 |

TABLE 149

| | C-155 | C-156 | C-157 | C-158 | C-159 | C-160 | C-161 | C-162 | C-163 | C-164 |
|---|---|---|---|---|---|---|---|---|---|---|
| SiO₂ | 65.0 | 65.4 | 65.0 | 69.4 | 69.0 | 69.0 | 68.0 | 68.0 | 65.0 | 68.0 |
| Al₂O₃ | 7.0 | 7.0 | 7.0 | 6.0 | 6.0 | 6.0 | 5.0 | 9.0 | 7.0 | 6.0 |
| MgO | | 2.0 | 2.5 | | | 3.0 | 1.8 | | | |
| CaO | 1.0 | 1.0 | 1.0 | 3.0 | 0.5 | 0.5 | 1.0 | 0.5 | 2.0 | 1.0 |
| BaO | 8.0 | 8.0 | | 6.0 | 8.5 | | 8.0 | | 9.0 | 5.0 |
| SrO | 3.0 | | 8.0 | | | 5.5 | | 7.5 | | 6.0 |
| ZnO | 2.5 | 2.6 | | 2.6 | 2.5 | 2.6 | | 2.0 | 2.6 | |
| Li₂O | 5.0 | 6.0 | 6.0 | 6.0 | 8.0 | 6.0 | 6.0 | 7.5 | 4.0 | 8.0 |
| K₂O | 3.0 | 2.0 | 2.0 | 2.0 | | 2.0 | 2.0 | 0.5 | 2.0 | |
| TiO₂ | | | 3.0 | | | | 3.0 | | | 1.0 |
| ZrO₂ | 3.0 | 4.0 | 3.0 | 3.0 | 3.0 | 3.0 | 3.0 | 3.0 | 3.0 | 3.0 |
| P₂O₅ | 2.0 | 2.0 | 2.0 | 2.0 | 2.0 | 2.0 | 2.0 | 2.0 | 2.0 | 2.0 |
| Y₂O₃ | | | | | | | | | 3.0 | |
| Nb₂O₅ | | | | | | | | | | |
| Ta₂O₅ | | | | | | | | | | |
| La₂O₃ | | | | | | | | | | |
| Sb₂O₃ | 0.5 | | 0.5 | | 0.5 | 0.4 | 0.2 | | 0.4 | |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 580 | 580 | 580 | 580 | 580 | 580 | 580 | 580 | 580 | 580 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 680 | 680 | 680 | 680 | 680 | 680 | 680 | 680 | 680 | 680 |
| Temperature??? | | | | | | | | | | |
| Nucleous Growing | 5 | 5 | 5 | 5 | 5 | 5 | 5 | 5 | 5 | 5 |
| Time?hr? | | | | | | | | | | |
| Main Crystalline | Crist.ss | Crist | Crist | a-Q | a-Q.ss | Crist | a-Q | Crist | Crist | Crist |
| Phase | | | | | | | | | | |
| Sub Crystalline | — | — | — | — | LAS | LZS | LAS | LZS | — | LAS |
| Phase | | | | | | | | | | |
| Specific | 2.49 | 2.51 | 2.52 | 2.59 | 2.60 | 2.55 | 2.60 | 2.56 | 2.48 | 2.58 |
| Gravity?g/cm³ | | | | | | | | | | |
| Yong's Modulus | 79.9 | 77.8 | 77.0 | 84.8 | 82.8 | 79.4 | 83.6 | 78.2 | 78.3 | 80.9 |
| E??Pa | | | | | | | | | | |
| Elastic Modulus | 32.1 | 31.0 | 30.6 | 32.7 | 31.8 | 31.1 | 32.2 | 30.5 | 31.6 | 31.4 |
| Ratio | | | | | | | | | | |
| C.T.E | 105 | 108 | 122 | 145 | 97 | 103 | 85 | 100 | 103 | 85 |
| Amount of | 40 | 35 | 50 | 60 | 85 | 80 | 90 | 80 | 85 | 80 |
| Migration of alkali | | | | | | | | | | |
| metal [ppb] | | | | | | | | | | |
| P/Pli | 1.2 | 1.2 | 1.4 | 1.2 | 1.1 | 1.2 | 1.2 | 1.2 | 1.3 | 1.2 |

TABLE 150

| | C-165 | C-166 | C-167 | C-168 | C-169 | C-170 | C-171 | C-172 | C-173 | C-174 |
|---|---|---|---|---|---|---|---|---|---|---|
| SiO₂ | 66.5 | 67.0 | 68.0 | 68.0 | 65.0 | 65.0 | 68.0 | 65.0 | 65.0 | 69.0 |
| Al₂O₃ | 7.0 | 6.9 | 6.0 | 7.0 | 7.0 | 7.0 | 6.0 | 5.5 | 7.0 | 6.0 |
| MgO | | 2.0 | 0.5 | | | | | 2.0 | | |
| CaO | 0.5 | 0.5 | 0.5 | 1.5 | 0.5 | 1.0 | 0.5 | 1.0 | 0.5 | 5.0 |
| BaO | 8.5 | | 7.0 | 6.0 | 8.5 | | 8.5 | 6.0 | 7.0 | |
| SrO | | 7.0 | | | | 7.0 | | 3.0 | 4.5 | 5.1 |
| ZnO | 4.0 | 2.0 | 5.0 | 2.0 | 2.5 | 2.5 | | 1.5 | 2.5 | 1.5 |
| Li₂O | 6.0 | 6.0 | 6.0 | 6.0 | 6.0 | 6.0 | 6.0 | 6.0 | 5.0 | 6.0 |
| K₂O | 2.0 | 2.0 | 2.0 | 2.0 | 2.0 | 2.0 | 2.0 | 2.0 | 3.0 | 2.0 |
| TiO₂ | | | | 2.0 | | | | | | |
| ZrO₂ | 1.5 | 4.5 | 4.0 | 2.0 | 3.0 | 3.0 | 3.0 | 3.0 | 3.0 | 3.0 |
| P₂O₅ | 2.0 | 1.1 | 1.0 | 3.0 | 2.0 | 2.0 | 2.0 | 2.0 | 2.0 | 2.0 |
| Y₂O₃ | | | | | 3.0 | | | | | |
| Nb₂O₅ | | | | | | 4.0 | | | | |
| Ta₂O₅ | | | | | | | 4.0 | | | |
| La₂O₃ | | | | | | | | 3.0 | | |
| Sb₂O₃ | 2.0 | 1.0 | | 0.5 | 0.5 | 0.5 | | | 0.5 | 0.4 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time?hr? | 3 | 3 | 3 | 3 | 3 | 3 | 3 | 3 | 3 | 3 |
| Nucleating | 580 | 580 | 580 | 580 | 580 | 580 | 580 | 580 | 580 | 580 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 680 | 680 | 680 | 680 | 680 | 680 | 680 | 680 | 680 | 680 |
| Temperature??? | | | | | | | | | | |
| Nucleous Growing | 5 | 5 | 5 | 5 | 5 | 5 | 5 | 5 | 5 | 5 |
| Time?hr? | | | | | | | | | | |
| Main Crystalline | Crist | Crist | Crist | a-Q | Crist | Crist | Crist | Crist | Crist | Crist.ss |
| Phase | | | | | | | | | | |
| Sub Crystalline | LZS | — | LZS | — | — | — | LAS | — | LZS | LZS |
| Phase | | | | | | | | | | |
| Specific | 2.59 | 2.48 | 2.56 | 2.56 | 2.46 | 2.58 | 2.61 | 2.60 | 2.56 | 2.48 |
| Gravity?g/cm³ | | | | | | | | | | |
| Yong's Modulus | 80.9 | 77.2 | 79.6 | 82.8 | 79.2 | 79.7 | 80.1 | 80.3 | 79.5 | 79.9 |
| E??Pa | | | | | | | | | | |
| Elastic Modulus | 31.2 | 31.1 | 31.1 | 32.3 | 32.2 | 30.9 | 30.7 | 30.9 | 31.1 | 32.2 |
| Ratio | | | | | | | | | | |
| C.T.E | 84 | 122 | 89 | 135 | 102 | 110 | 91 | 100 | 91 | 102 |
| Amount of | 50 | 40 | 75 | 65 | 40 | 60 | 85 | 60 | 75 | 40 |
| Migration of alkali | | | | | | | | | | |
| metal [ppb] | | | | | | | | | | |
| P/Pli | 1.3 | 1.4 | 1.2 | 1.2 | 1.2 | 1.2 | 1.3 | 1.2 | 1.2 | 1.2 |

Tables 151 and 152 show the glass compositions in % by weight of respective crystallized glass substrates of C-175 to 194, together with the manufacturing conditions employed. Tables 153 and 154 show crystallized glass substrates as C-195 to 214 manufactured using the same glass compositions as those of C-175 to 194 with the nucleus growing temperature varied from that employed for C-175 to 194. Further, Tables 155 and 156 show crystallized glass substrates as C-215 to 234 manufactured using the same glass compositions as those of C-175 to 194 with the nucleus growing time varied from that employed for C-175 to 194.

TABLE 151

| | C-175 | C-176 | C-177 | C-178 | C-179 | C-180 | C-181 | C-182 | C-183 | C-184 |
|---|---|---|---|---|---|---|---|---|---|---|
| SiO₂ | 65.0 | 65.4 | 65.0 | 69.4 | 69.0 | 69.0 | 68.0 | 68.0 | 65.0 | 68.0 |
| Al₂O₃ | 7.0 | 7.0 | 7.0 | 6.0 | 6.0 | 6.0 | 5.0 | 9.0 | 7.0 | 6.0 |
| MgO | | 2.0 | 2.5 | | | 3.0 | 1.8 | | 2.0 | |
| CaO | | | | 3.0 | | | | | | |
| BaO | 9.0 | 9.0 | 2.0 | 6.0 | 9.0 | 1.0 | 9.0 | 2.0 | 9.0 | 5.0 |
| SrO | 3.0 | | 7.0 | | | 5.0 | | 8.0 | | 7.0 |
| ZnO | 2.5 | 2.6 | | 2.6 | 2.5 | 2.6 | | | 2.6 | |
| Li₂O | 5.0 | 6.0 | 6.0 | 6.0 | 8.0 | 6.0 | 6.0 | 7.5 | 4.0 | 8.0 |
| K₂O | 3.0 | 2.0 | 2.0 | 2.0 | | 2.0 | 2.0 | 0.5 | 2.0 | |
| TiO₂ | | | 3.0 | | | | 3.0 | | | 1.0 |
| ZrO₂ | 3.0 | 4.0 | 3.0 | 3.0 | 3.0 | 3.0 | 3.0 | 3.0 | 3.0 | 3.0 |
| P₂O₅ | 2.0 | 2.0 | 2.0 | 2.0 | 2.0 | 2.0 | 2.0 | 2.0 | 2.0 | 2.0 |
| Y₂O₃ | | | | | | | | | 3.0 | |
| Nb₂O₅ | | | | | | | | | | |
| Ta₂O₅ | | | | | | | | | | |
| La₂O₃ | | | | | | | | | | |
| Sb₂O₃ | 0.5 | | 0.5 | | 0.5 | 0.4 | 0.2 | | 0.4 | |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time? hr? | 3 | 3 | 3 | 3 | 3 | 3 | 3 | 3 | 3 | 3 |
| Nucleating | 580 | 580 | 580 | 580 | 580 | 580 | 580 | 580 | 580 | 580 |
| Temperature??? | | | | | | | | | | |
| Nucleating | 5 | 5 | 5 | 5 | 5 | 5 | 5 | 5 | 5 | 5 |
| Time? hr? | | | | | | | | | | |
| Nucleous Growing | 680 | 680 | 680 | 680 | 680 | 680 | 680 | 680 | 680 | 680 |
| Temperature??? | | | | | | | | | | |
| Nucleous Growing | 2 | 2 | 2 | 2 | 2 | 2 | 2 | 2 | 2 | 2 |
| Time? hr? | | | | | | | | | | |
| Main Crystalline | Crist.ss | Crist | Crist | a-Q | a-Q.ss | Crist | a-Q | Crist | Crist | Crist |
| Phase | | | | | | | | | | |
| Sub Crystalline | — | — | — | — | LAS | LZS | LAS | LZS | — | LAS |
| Phase | | | | | | | | | | |
| Specific | 2.53 | 2.56 | 2.60 | 2.61 | 2.62 | 2.56 | 2.64 | 2.66 | 2.55 | 2.61 |
| Gravity? g/cm₃ | | | | | | | | | | |
| Yang's Modulus | 78.2 | 77.0 | 77.2 | 85.1 | 83.1 | 79.4 | 83.5 | 78.6 | 77.2 | 80.2 |
| E?? Pa | | | | | | | | | | |
| Elastic Modulus | 30.9 | 30.1 | 29.7 | 32.6 | 31.7 | 31.0 | 31.6 | 29.5 | 30.3 | 30.7 |
| Ratio | | | | | | | | | | |
| C.T.E | 105 | 108 | 124 | 143 | 95 | 104 | 83 | 97 | 102 | 83 |
| Amount of | 40 | 35 | 50 | 60 | 85 | 80 | 90 | 80 | 85 | 80 |
| Migration of alkali | | | | | | | | | | |
| metal [ppb] | | | | | | | | | | |
| P/Pli | 1.2 | 1,2 | 1.4 | 1.2 | 1.1 | 1.2 | 1.2 | 1.2 | 1.3 | 1.2 |

TABLE 152

| | C-185 | C-186 | C-187 | C-188 | C-189 | C-190 | C-191 | C-192 | C-193 | C-194 |
|---|---|---|---|---|---|---|---|---|---|---|
| SiO₂ | 66.5 | 67.0 | 68.0 | 68.0 | 65.0 | 65.0 | 68.0 | 65.0 | 65.4 | 65.0 |
| Al₂O₃ | 7.0 | 7.4 | 6.0 | 7.0 | 7.0 | 7.0 | 6.0 | 5.5 | 7.0 | 7.0 |
| MgO | | 2.0 | 0.5 | | | | | 2.0 | 2.0 | 2.5 |
| CaO | | | | 1.5 | | | | | | |
| BaO | 9.0 | 1.0 | 7.5 | 6.0 | 9.0 | 2.0 | 9.0 | 6.0 | 9.5 | 0.5 |
| SrO | | 6.0 | | | | 6.0 | | 3.0 | | 8.5 |
| ZnO | 4.0 | 2.0 | 5.0 | 2.0 | 2.5 | 2.5 | | 2.5 | 2.6 | |
| Li₂O | 6.0 | 6.0 | 6.0 | 6.0 | 6.0 | 6.0 | 6.0 | 6.0 | 6.0 | 6.0 |
| K₂O | 2.0 | 2.0 | 2.0 | 2.0 | 2.0 | 2.0 | 2.0 | 2.0 | 2.0 | 2.0 |
| TiO₂ | | | | 2.0 | | | | | | 3.0 |
| ZrO₂ | 1.5 | 4.5 | 4.0 | 2.0 | 3.0 | 3.0 | 3.0 | 3.0 | 3.5 | 3.0 |
| P₂O₅ | 2.0 | 1.1 | 1.0 | 3.0 | 2.0 | 2.0 | 2.0 | 2.0 | 2.0 | 2.0 |
| Y₂O₃ | | | | | 3.0 | | | | | |
| Nb₂O₅ | | | | | | 4.0 | | | | |
| Ta₂O₅ | | | | | | | 4.0 | | | |
| La₂O₃ | | | | | | | | 3.0 | | |
| Sb₂O₃ | 2.0 | 1.0 | | 0.5 | 0.5 | 0.5 | | | | 0.5 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time? hr? | 3 | 3 | 3 | 3 | 3 | 3 | 3 | 3 | 3 | 3 |
| Nucleating | 580 | 580 | 580 | 580 | 580 | 580 | 580 | 580 | 580 | 580 |
| Temperature??? | | | | | | | | | | |
| Nucleating | 5 | 5 | 5 | 5 | 5 | 5 | 5 | 5 | 5 | 5 |
| Time? hr? | | | | | | | | | | |
| Nucleous Growing | 680 | 680 | 680 | 680 | 680 | 680 | 680 | 680 | 680 | 680 |
| Temperature??? | | | | | | | | | | |
| Nucleous Growing | 2 | 2 | 2 | 2 | 2 | 2 | 2 | 2 | 2 | 2 |
| Time? hr? | | | | | | | | | | |
| Main Crystalline | Crist | Crist | Crist | a-Q | Crist | Crist | Crist | Crist | Crist.ss | Crist |
| Phase | | | | | | | | | | |
| Sub Crystalline | LZS | — | LZS | — | — | — | LAS | — | — | — |
| Phase | | | | | | | | | | |
| Specific | 2.62 | 2.53 | 2.59 | 2.58 | 2.50 | 2.60 | 2.64 | 2.65 | 2.51 | 2.58 |
| Gravity? g/cm₃ | | | | | | | | | | |
| Yong's Modulus | 81.0 | 76.9 | 79.5 | 83.1 | 79.3 | 79.6 | 80.2 | 80.4 | 78.0 | 77.4 |
| E?? Pa | | | | | | | | | | |
| Elastic Modulus | 30.9 | 30.4 | 30.7 | 32.2 | 31.7 | 30.6 | 30.4 | 30.3 | 31.1 | 30.0 |
| Ratio | | | | | | | | | | |
| C.T.E | 82 | 122 | 88 | 133 | 101 | 114 | 91 | 99 | 102 | 110 |
| Amount of | 50 | 40 | 75 | 65 | 40 | 60 | 85 | 60 | 40 | 35 |
| Migration of alkali | | | | | | | | | | |
| metal [ppb] | | | | | | | | | | |
| P/Pli | 1.3 | 1.4 | 1.2 | 1.2 | 1.2 | 1.2 | 1.3 | 1.2 | 1.2 | 1.2 |

TABLE 153

| | C-195 | C-196 | C-197 | C-198 | C-199 | C-200 | C-201 | C-202 | C-203 | C-204 |
|---|---|---|---|---|---|---|---|---|---|---|
| SiO₂ | 65.0 | 65.4 | 65.0 | 69.4 | 69.0 | 69.0 | 68.0 | 68.0 | 65.0 | 68.0 |
| Al₂O₃ | 7.0 | 7.0 | 7.0 | 6.0 | 6.0 | 6.0 | 5.0 | 9.0 | 7.0 | 6.0 |
| MgO | | 2.0 | 2.5 | | | 3.0 | 1.8 | | 2.0 | |
| CaO | | | | 3.0 | | | | | | |
| BaO | 9.0 | 9.0 | 2.0 | 6.0 | 9.0 | 1.0 | 9.0 | 2.0 | 9.0 | 5.0 |
| SrO | 3.0 | | 7.0 | | | 5.0 | | 8.0 | | 7.0 |
| ZnO | 2.5 | 2.6 | | 2.6 | 2.5 | 2.6 | | | 2.6 | |
| Li₂O | 5.0 | 6.0 | 6.0 | 6.0 | 8.0 | 6.0 | 6.0 | 7.5 | 4.0 | 8.0 |
| K₂O | 3.0 | 2.0 | 2.0 | 2.0 | | 2.0 | 2.0 | 0.5 | 2.0 | |
| TiO₂ | | | 3.0 | | | | 3.0 | | | 1.0 |
| ZrO₂ | 3.0 | 4.0 | 3.0 | 3.0 | 3.0 | 3.0 | 3.0 | 3.0 | 3.0 | 3.0 |
| P₂O₅ | 2.0 | 2.0 | 2.0 | 2.0 | 2.0 | 2.0 | 2.0 | 2.0 | 2.0 | 2.0 |
| Y₂O₃ | | | | | | | | | 3.0 | |
| Nb₂O₅ | | | | | | | | | | |
| Ta₂O₅ | | | | | | | | | | |
| La₂O₃ | | | | | | | | | | |
| Sb₂O₃ | 0.5 | | 0.5 | | 0.5 | 0.4 | 0.2 | | 0.4 | |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time? hr? | 3 | 3 | 3 | 3 | 3 | 3 | 3 | 3 | 3 | 3 |
| Nucleating | 580 | 580 | 580 | 580 | 580 | 580 | 580 | 580 | 580 | 580 |
| Temperature??? | | | | | | | | | | |
| Nucleating | 5 | 5 | 5 | 5 | 5 | 5 | 5 | 5 | 5 | 5 |
| Time? hr? | | | | | | | | | | |
| Nucleaus Growing | 700 | 700 | 700 | 700 | 700 | 700 | 700 | 700 | 700 | 700 |
| Temperature??? | | | | | | | | | | |
| Nucleaus Growing | 2 | 2 | 2 | 2 | 2 | 2 | 2 | 2 | 2 | 2 |
| Time? hr? | | | | | | | | | | |
| Main Crystalline | Crist.ss | Crist | Crist | a-Q | aQ.ss | Crist | a-Q | Crist | Crist | Crist |
| Phase | | | | | | | | | | |
| Sub Crystalline | — | — | — | — | LAS | LZS | LAS | LZS | — | LAS |
| Phase | | | | | | | | | | |
| Specific | 2.49 | 2.52 | 2.56 | 2.57 | 2.58 | 2.52 | 2.60 | 2.62 | 2.51 | 2.57 |
| Gravity? g/cm₃ | | | | | | | | | | |
| Yong's Modulus | 77.6 | 76.4 | 76.6 | 84.5 | 82.5 | 78.8 | 82.9 | 78.0 | 76.6 | 79.6 |
| E?? Pa | | | | | | | | | | |
| Elastic Modulus | 31.2 | 30.3 | 29.9 | 32.9 | 32.0 | 31.3 | 31.9 | 29.8 | 30.5 | 31.0 |
| Ratio | | | | | | | | | | |
| C.T.E | 102 | 105 | 121 | 140 | 92 | 101 | 82 | 94 | 99 | 83 |
| Amount of | 40 | 35 | 50 | 60 | 85 | 80 | 90 | 80 | 85 | 80 |
| Migration of alkali | | | | | | | | | | |
| metal [ppb] | | | | | | | | | | |
| P/Pli | 1.2 | 1.2 | 1.4 | 1.2 | 1.1 | 1.2 | 1.2 | 1.2 | 1.3 | 1.2 |

TABLE 154

| | C-205 | C-206 | C-207 | C-208 | C-209 | C-210 | C-211 | C-212 | C-213 | C-214 |
|---|---|---|---|---|---|---|---|---|---|---|
| SiO₂ | 66.5 | 67.0 | 68.0 | 68.0 | 65.0 | 65.0 | 68.0 | 65.0 | 65.4 | 65.0 |
| Al₂O₃ | 7.0 | 7.4 | 6.0 | 7.0 | 7.0 | 7.0 | 6.0 | 5.5 | 7.0 | 7.0 |
| MgO | | 2.0 | 0.5 | | | | | 2.0 | 2.0 | 2.5 |
| CaO | | | | 1.5 | | | | | | |
| BaO | 9.0 | 1.0 | 7.5 | 6.0 | 9.0 | 2.0 | 9.0 | 6.0 | 9.5 | 0.5 |
| SrO | | 6.0 | | | | 6.0 | | 3.0 | | 8.5 |
| ZnO | 4.0 | 2.0 | 5.0 | 2.0 | 2.5 | 2.5 | | 2.5 | 2.6 | |
| Li₂O | 6.0 | 6.0 | 6.0 | 6.0 | 6.0 | 6.0 | 6.0 | 6.0 | 6.0 | 6.0 |
| K₂O | 2.0 | 2.0 | 2.0 | 2.0 | 2.0 | 2.0 | 2.0 | 2.0 | 2.0 | 2.0 |
| TiO₂ | | | | 2.0 | | | | | | 3.0 |
| ZrO₂ | 1.5 | 4.5 | 4.0 | 2.0 | 3.0 | 3.0 | 3.0 | 3.0 | 3.5 | 3.0 |
| P₂O₅ | 2.0 | 1.1 | 1.0 | 3.0 | 2.0 | 2.0 | 2.0 | 2.0 | 2.0 | 2.0 |
| Y₂O₃ | | | | 3.0 | | | | | | |
| Nb₂O₅ | | | | | 4.0 | | | | | |
| Ta₂O₅ | | | | | | 4.0 | | | | |
| La₂O₃ | | | | | | | 3.0 | | | |
| Sb₂O₃ | 2.0 | 1.0 | | 0.5 | 0.5 | 0.5 | | | | 0.5 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time | 3 | 3 | 3 | 3 | 3 | 3 | 3 | 3 | 3 | 3 |
| Nucleating | 580 | 580 | 580 | 580 | 580 | 580 | 580 | 580 | 580 | 580 |
| Temperature??? | | | | | | | | | | |
| Nucleating | 5 | 5 | 5 | 5 | 5 | 5 | 5 | 5 | 5 | 5 |
| Time? hr? | | | | | | | | | | |
| Nucleous Growing | 700 | 700 | 700 | 700 | 700 | 700 | 700 | 700 | 700 | 700 |
| Temperature??? | | | | | | | | | | |
| Nucleous Growing | 2 | 2 | 2 | 2 | 2 | 2 | 2 | 2 | 2 | 2 |
| Time? hr? | | | | | | | | | | |
| Main Crystalline | Crist | Crist | Crist | a-Q | Crist | Crist | Crist | Crist | Crist.ss | Crist |
| Phase | | | | | | | | | | |
| Sub Crystalline | LZS | — | LZS | — | — | — | LAS | — | — | — |
| Phase | | | | | | | | | | |
| Specific | 2.58 | 2.49 | 2.55 | 2.54 | 2.46 | 2.56 | 2.60 | 2.61 | 2.47 | 2.54 |
| Gravity? g/cm₃ | | | | | | | | | | |
| Yong's Modulus | 80.4 | 76.3 | 78.9 | 82.5 | 78.7 | 79.0 | 79.6 | 79.8 | 77.4 | 76.8 |
| E?? Pa | | | | | | | | | | |
| Elastic Modulus | 31.2 | 30.6 | 30.9 | 32.5 | 32.0 | 30.9 | 30.6 | 30.6 | 31.3 | 30.2 |
| Ratio | | | | | | | | | | |
| C.T.E | 82 | 119 | 85 | 130 | 98 | 111 | 88 | 96 | 99 | 107 |
| Amount of | 50 | 40 | 75 | 65 | 40 | 60 | 85 | 60 | 40 | 35 |
| Migration of alkali | | | | | | | | | | |
| metal [ppb] | | | | | | | | | | |
| P/Pli | 1.3 | 1.4 | 1.2 | 1.2 | 1.2 | 1.2 | 1.3 | 1.2 | 1.2 | 1.2 |

TABLE 155

| | C-215 | C-216 | C-217 | C-218 | C-219 | C-220 | C-221 | C-222 | C-223 | C-224 |
|---|---|---|---|---|---|---|---|---|---|---|
| SiO₂ | 65.0 | 65.4 | 65.0 | 69.4 | 69.0 | 69.0 | 68.0 | 68.0 | 65.0 | 68.0 |
| Al₂O₃ | 7.0 | 7.0 | 7.0 | 6.0 | 6.0 | 6.0 | 5.0 | 9.0 | 7.0 | 6.0 |
| MgO | | 2.0 | 2.5 | | | 3.0 | 1.8 | | 2.0 | |
| CaO | | | | 3.0 | | | | | | |
| BaO | 9.0 | 9.0 | 2.0 | 6.0 | 9.0 | 1.0 | 9.0 | 2.0 | 9.0 | 5.0 |
| SrO | 3.0 | | 7.0 | | | 5.0 | | 8.0 | | 7.0 |
| ZnO | 2.5 | 2.6 | | 2.6 | 2.5 | 2.6 | | | 2.6 | |
| Li₂O | 5.0 | 6.0 | 6.0 | 6.0 | 8.0 | 6.0 | 6.0 | 7.5 | 4.0 | 8.0 |
| K₂O | 3.0 | 2.0 | 2.0 | 2.0 | | 2.0 | 2.0 | 0.5 | 2.0 | |
| TiO₂ | | | 3.0 | | | | 3.0 | | | 1.0 |
| ZrO₂ | 3.0 | 4.0 | 3.0 | 3.0 | 3.0 | 3.0 | 3.0 | 3.0 | 3.0 | 3.0 |
| P₂O₅ | 2.0 | 2.0 | 2.0 | 2.0 | 2.0 | 2.0 | 2.0 | 2.0 | 2.0 | 2.0 |
| Y₂O₃ | | | | | | | | | 3.0 | |
| Nb₂O₅ | | | | | | | | | | |
| Ta₂O₅ | | | | | | | | | | |
| La₂O₃ | | | | | | | | | | |
| Sb₂O₃ | 0.5 | | 0.5 | | 0.5 | 0.4 | 0.2 | | 0.4 | |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time? hr? | 3 | 3 | 3 | 3 | 3 | 3 | 3 | 3 | 3 | 3 |
| Nucleating | 580 | 580 | 580 | 580 | 580 | 580 | 580 | 580 | 580 | 580 |
| Temperature??? | | | | | | | | | | |
| Nucleating | 5 | 5 | 5 | 5 | 5 | 5 | 5 | 5 | 5 | 5 |
| Time? hr? | | | | | | | | | | |
| Nucleous Growing | 680 | 680 | 680 | 680 | 680 | 680 | 680 | 680 | 680 | 680 |
| Temperature??? | | | | | | | | | | |
| Nucleous Growing | 5 | 5 | 5 | 5 | 5 | 5 | 5 | 5 | 5 | 5 |
| Time? hr? | | | | | | | | | | |
| Main Crystalline | Crist.ss | Crist | Crist | a-Q | a-Q.ss | Crist | a-Q | Crist | Crist | Crist |
| Phase | | | | | | | | | | |
| Sub Crystalline | — | — | — | — | LAS | LZS | LAS | LZS | — | LAS |
| Phase | | | | | | | | | | |
| Specific | 2.51 | 2.54 | 2.58 | 2.59 | 2.60 | 2.54 | 2.62 | 2.64 | 2.53 | 2.59 |
| Gravity? g/cm₃ | | | | | | | | | | |
| Yong's Modulus | 77.9 | 76.7 | 76.9 | 84.8 | 82.8 | 79.1 | 83.2 | 78.3 | 76.9 | 79.9 |
| E?? Pa | | | | | | | | | | |
| Elastic Modulus | 31.0 | 30.2 | 29.8 | 32.7 | 31.8 | 31.1 | 31.8 | 29.7 | 30.4 | 30.8 |
| Ratio | | | | | | | | | | |
| C.T.E | 107 | 110 | 126 | 145 | 97 | 106 | 85 | 99 | 104 | 85 |
| Amount of | 40 | 35 | 50 | 60 | 85 | 80 | 90 | 80 | 85 | 80 |
| Migration of alkali | | | | | | | | | | |
| metal [ppb] | | | | | | | | | | |
| P/Pli | 1.2 | 1.2 | 1.4 | 1.2 | 1.1 | 1.2 | 1.2 | 1.2 | 1.3 | 1.2 |

TABLE 156

| | C-225 | C-226 | C-227 | C-228 | C-229 | C-230 | C-231 | C-232 | C-233 | C-234 |
|---|---|---|---|---|---|---|---|---|---|---|
| SiO₂ | 66.5 | 67.0 | 68.0 | 68.0 | 65.0 | 65.0 | 68.0 | 65.0 | 65.4 | 65.0 |
| Al₂O₃ | 7.0 | 7.4 | 6.0 | 7.0 | 7.0 | 7.0 | 6.0 | 5.5 | 7.0 | 7.0 |
| MgO | | 2.0 | 0.5 | | | | | 2.0 | 2.0 | 2.5 |
| CaO | | | | 1.5 | | | | | | |
| BaO | 9.0 | 1.0 | 7.5 | 6.0 | 9.0 | 2.0 | 9.0 | 6.0 | 9.5 | 0.5 |
| SrO | | 6.0 | | | | 6.0 | | 3.0 | | 8.5 |
| ZnO | 4.0 | 2.0 | 5.0 | 2.0 | 2.5 | 2.5 | | 2.5 | 2.6 | |
| Li₂O | 6.0 | 6.0 | 6.0 | 6.0 | 6.0 | 6.0 | 6.0 | 6.0 | 6.0 | 6.0 |
| K₂O | 2.0 | 2.0 | 2.0 | 2.0 | 2.0 | 2.0 | 2.0 | 2.0 | 2.0 | 2.0 |
| TiO₂ | | | | 2.0 | | | | | | 3.0 |
| ZrO₂ | 1.5 | 4.5 | 4.0 | 2.0 | 3.0 | 3.0 | 3.0 | 3.0 | 3.5 | 3.0 |
| P₂O₅ | 2.0 | 1.1 | 1.0 | 3.0 | 2.0 | 2.0 | 2.0 | 2.0 | 2.0 | 2.0 |
| Y₂O₃ | | | | | 3.0 | | | | | |
| Nb₂O₅ | | | | | | 4.0 | | | | |
| Ta₂O₅ | | | | | | | 4.0 | | | |
| La₂O₃ | | | | | | | | 3.0 | | |
| Sb₂O₃ | 2.0 | 1.0 | | 0.5 | 0.5 | 0.5 | | | | 0.5 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time? hr?3 | 3 | 3 | 3 | 3 | 3 | 3 | 3 | 3 | 3 | |
| Nucleating | 580 | 580 | 580 | 580 | 580 | 580 | 580 | 580 | 580 | 580 |
| Temperature??? | | | | | | | | | | |
| Nucleating | 5 | 5 | 5 | 5 | 5 | 5 | 5 | 5 | 5 | 5 |
| Time? hr? | | | | | | | | | | |
| Nucleous Growing | 680 | 680 | 680 | 680 | 680 | 680 | 680 | 680 | 680 | 680 |
| Temperature??? | | | | | | | | | | |
| Nucleous Growing | 5 | 5 | 5 | 5 | 5 | 5 | 5 | 5 | 5 | 5 |
| Time? hr? | | | | | | | | | | |
| Main Crystalline | Crist | Crist | Crist | a-Q | Crist | Crist | Crist | Crist | Crist.ss | Crist |
| Phase | | | | | | | | | | |
| Sub Crystalline | LZS | — | LZS | — | — | — | LAS | — | — | — |
| Phase | | | | | | | | | | |
| Specific | 2.60 | 2.51 | 2.57 | 2.56 | 2.48 | 2.58 | 2.62 | 2.63 | 2.49 | 2.56 |
| Gravity? g/cm₃ | | | | | | | | | | |
| Yong's Modulus | 80.7 | 76.6 | 79.2 | 82.8 | 79.0 | 79.3 | 79.9 | 80.1 | 77.7 | 77.1 |
| E?? Pa | | | | | | | | | | |
| Elastic Modulus | 31.0 | 30.5 | 30.8 | 32.3 | 31.9 | 30.7 | 30.5 | 30.5 | 31.2 | 30.1 |
| Ratio | | | | | | | | | | |
| C.T.E | 84 | 124 | 90 | 135 | 103 | 116 | 93 | 101 | 104 | 112 |
| Amount of | 50 | 40 | 75 | 65 | 40 | 60 | 85 | 60 | 40 | 35 |
| Migration of alkali | | | | | | | | | | |
| metal [ppb] | | | | | | | | | | |
| P/Pli | 1.3 | 1.4 | 1.2 | 1.2 | 1.2 | 1.2 | 1.3 | 1.2 | 1.2 | 1.2 |

Tables 157 and 158 show the glass compositions in % by weight of respective crystallized glass substrates of C-235 to 254, together with the manufacturing conditions employed. Tables 159 and 160 show crystallized glass substrates as C-255 to 274 manufactured using the same glass compositions as those of C-235 to 254 with the nucleus growing temperature varied from that employed for C-235 to 254. Further, Tables 161 and 162 show crystallized glass substrates as C-275 to 294 manufactured using the same glass compositions as those of C-235 to 254 with the nucleus growing time varied from that employed for C-235 to 254.

TABLE 157

| | C-235 | C-236 | C-237 | C-238 | C-239 | C-240 | C-241 | C-242 | C-243 | C-244 |
|---|---|---|---|---|---|---|---|---|---|---|
| SiO₂ | 65.0 | 65.4 | 65.0 | 69.4 | 69.0 | 69.0 | 68.0 | 68.0 | 65.0 | 68.0 |
| Al₂O₃ | 7.0 | 7.0 | 7.0 | 6.0 | 6.0 | 6.0 | 5.0 | 9.0 | 7.0 | 6.0 |
| MgO | | 2.0 | 2.5 | | | 3.0 | 1.8 | | 2.0 | |
| CaO | | | | 3.0 | 3.0 | | | | | |
| BaO | 9.0 | | | | | | | | | 5.0 |
| SrO | 3.0 | 9.0 | 9.0 | 6.0 | 6.0 | 6.0 | 9.0 | 8.0 | 9.0 | 7.0 |
| ZnO | 2.5 | 2.6 | | 2.6 | 2.5 | 2.6 | | 2.0 | 2.6 | |
| U2O | 5.0 | 6.0 | 6.0 | 6.0 | 8.0 | 6.0 | 6.0 | 7.5 | 4.0 | 8.0 |
| K₂O | 3.0 | 2.0 | 2.0 | 2.0 | | 2.0 | 2.0 | 0.5 | 2.0 | |
| TiO₂ | | | 3.0 | | | | 3.0 | | | 1.0 |
| ZrO₂ | 3.0 | 4.0 | 3.0 | 3.0 | 3.0 | 3.0 | 3.0 | 3.0 | 3.0 | 3.0 |
| P₂O₅ | 2.0 | 2.0 | 2.0 | 2.0 | 2.0 | 2.0 | 2.0 | 2.0 | 2.0 | 2.0 |
| Y₂O₃ | | | | | | | | | 3.0 | |
| Nb₂O₅ | | | | | | | | | | |
| Ta₂O₅ | | | | | | | | | | |
| La₂O₃ | | | | | | | | | | |
| Sb₂O₃ | 0.5 | | 0.5 | | 0.5 | 0.4 | 0.2 | | 0.4 | |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time? hr? | 3 | 3 | 3 | 3 | 3 | 3 | 3 | 3 | 3 | 3 |
| Nucleating | 580 | 580 | 580 | 580 | 580 | 580 | 580 | 580 | 580 | 580 |
| Temperature??? | | | | | | | | | | |
| Nucleating | 5 | 5 | 5 | 5 | 5 | 5 | 5 | 5 | 5 | 5 |
| Time? hr? | | | | | | | | | | |
| Nucleous Growing | 680 | 680 | 680 | 680 | 680 | 680 | 680 | 680 | 680 | 680 |
| Temperature??? | | | | | | | | | | |
| Nucleous Growing | 2 | 2 | 2 | 2 | 2 | 2 | 2 | 2 | 2 | 2 |
| Time? hr? | | | | | | | | | | |
| Main Crystalline | Crist.ss | Crist | Crist | a-Q | a-Q.ss | Crist | a-Q | Crist | Crist | Crist |
| Phase | | | | | | | | | | |
| Sub Crystalline | — | — | — | — | LAS | LZS | LAS | LZS | — | LAS |
| Phase | | | | | | | | | | |
| Specific | 2.53 | 2.52 | 2.56 | 2.59 | 2.59 | 2.58 | 2.61 | 2.60 | 2.51 | 2.61 |
| Gravity? g/cm₃ | | | | | | | | | | |
| Yong's Modulus | 78.2 | 78.3 | 76.2 | 85.2 | 83.5 | 79.2 | 83.8 | 78.3 | 78.5 | 80.2 |
| E?? Pa | | | | | | | | | | |
| Elastic Modulus | 30.9 | 31.1 | 29.8 | 32.9 | 32.2 | 30.7 | 32.1 | 30.1 | 31.3 | 30.7 |
| Ratio | | | | | | | | | | |
| C.T.E | 105 | 110 | 122 | 145 | 97 | 102 | 89 | 99 | 109 | 83 |
| Amount of | 40 | 35 | 50 | 60 | 85 | 80 | 90 | 80 | 85 | 80 |
| Migration of alkali | | | | | | | | | | |
| metal [ppb] | | | | | | | | | | |
| P/Pli | 1.2 | 1.2 | 1.4 | 1.2 | 1.1 | 1.2 | 1.2 | 1.2 | 1.3 | 1.2 |

TABLE 158

| | C-245 | C-246 | C-247 | C-248 | C-249 | C-250 | C-251 | C-252 | C-253 | C-254 |
|---|---|---|---|---|---|---|---|---|---|---|
| SiO₂ | 66.5 | 67.0 | 68.0 | 68.0 | 65.0 | 65.0 | 68.0 | 65.0 | 65.4 | 65.0 |
| Al₂O₃ | 7.0 | 7.4 | 6.0 | 7.0 | 7.0 | 7.0 | 6.0 | 5.5 | 7.0 | 7.0 |
| MgO | | 2.0 | 0.5 | | | | | 2.0 | 2.0 | 2.5 |
| CaO | | | | 1.5 | | | | | | |
| BaO | | | | | | | 9.0 | 6.0 | | 8.5 |
| SrO | 9.0 | 7.0 | 7.5 | 6.0 | 9.0 | 8.0 | 9.0 | 3.0 | 9.5 | 0.5 |
| ZnO | 4.0 | 2.0 | 5.0 | 2.0 | 2.5 | 2.5 | | 2.5 | 2.6 | |
| Li₂O | 6.0 | 6.0 | 6.0 | 6.0 | 6.0 | 6.0 | 6.0 | 6.0 | 6.0 | 6.0 |
| K₂O | 2.0 | 2.0 | 2.0 | 2.0 | 2.0 | 2.0 | 2.0 | 2.0 | 2.0 | 2.0 |
| TiO₂ | | | | 2.0 | | | | | | 3.0 |
| ZrO₂ | 1.5 | 4.5 | 4.0 | 2.0 | 3.0 | 3.0 | 3.0 | 3.0 | 3.5 | 3.0 |
| P₂O₅ | 2.0 | 1.1 | 1.0 | 3.0 | 2.0 | 2.0 | 2.0 | 2.0 | 2.0 | 2.0 |
| Y₂O₃ | | | | | 3.0 | | | | | |
| Nb₂O₅ | | | | | | 4.0 | | | | |
| Ta₂O₅ | | | | | | | 4.0 | | | |
| La₂O₃ | | | | | | | | 3.0 | | |
| Sb₂O₃ | 2.0 | 1.0 | | 0.5 | 0.5 | 0.5 | | | | 0.5 |
| Total (100 wt %) | 100.0 | 100.0 | 100.0 | 100.0 | 100.0 | 100.0 | 109.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time? hr? | 3 | 3 | 3 | 3 | 3 | 3 | 3 | 3 | 3 | 3 |
| Nucleating | 580 | 580 | 580 | 580 | 580 | 580 | 580 | 580 | 580 | 580 |
| Temperature??? | | | | | | | | | | |
| Nucleating | 5 | 5 | 5 | 5 | 5 | 5 | 5 | 5 | 5 | 5 |
| Time? hr? | | | | | | | | | | |
| Nucleous Growing | 680 | 680 | 680 | 680 | 680 | 680 | 680 | 680 | 680 | 680 |
| Temperature??? | | | | | | | | | | |
| Nucleous Growing | 2 | 2 | 2 | 2 | 2 | 2 | 2 | 2 | 2 | 2 |
| Time? hr? | | | | | | | | | | |
| Main Crystalline | Crist | Crist | Crist | a-Q | Crist | Crist | Crist | Crist | Crist.ss | Crist |
| Phase | | | | | | | | | | |
| Sub Crystalline | LZS | — | LZS | — | — | — | LAS | — | — | — |
| Phase | | | | | | | | | | |
| Specific | 2.59 | 2.51 | 2.54 | 2.55 | 2.48 | 2.62 | 2.64 | 2.63 | 2.51 | 2.51 |
| Gravity? g/cm₃ | | | | | | | | | | |
| Yong's Modulus | 82.5 | 77.0 | 79.9 | 83.5 | 80.2 | 79.3 | 81.2 | 80.9 | 78.9 | 78.8 |
| E?? Pa | | | | | | | | | | |
| Elastic Modulus | 31.9 | 30.7 | 31.5 | 32.7 | 32.3 | 30.3 | 30.8 | 30.8 | 31.4 | 31.4 |
| Ratio | | | | | | | | | | |
| C.T.E | 88 | 120 | 90 | 135 | 106 | 111 | 99 | 103 | 108 | 113 |
| Amount of | 50 | 40 | 75 | 65 | 40 | 60 | 85 | 60 | 40 | 35 |
| Migration of alkali | | | | | | | | | | |
| metal [ppb] | | | | | | | | | | |
| P/Pli | 1.3 | 1.4 | 1.2 | 1.2 | 1.2 | 1.2 | 1.3 | 1.2 | 1.2 | 1.2 |

TABLE 159

| | C-255 | C-256 | C-257 | C-258 | C-259 | C-260 | C-261 | C-262 | C-263 | C-264 |
|---|---|---|---|---|---|---|---|---|---|---|
| SiO₂ | 65.0 | 65.4 | 65.0 | 69.4 | 69.0 | 69.0 | 68.0 | 68.0 | 65.0 | 68.0 |
| AlO₂O₃ | 7.0 | 7.0 | 7.0 | 6.0 | 6.0 | 6.0 | 5.0 | 9.0 | 7.0 | 6.0 |
| MgO | | 2.0 | 2.5 | | | 3.0 | 1.8 | | 2.0 | |
| CaO | | | | 3.0 | 3.0 | | | | | |
| BaO | 9.0 | | | | | | | | | 5.0 |
| SrO | 3.0 | 9.0 | 9.0 | 6.0 | 6.0 | 6.0 | 9.0 | 8.0 | 9.0 | 7.0 |
| ZnO | 2.5 | 2.6 | | 2.6 | 2.5 | 2.6 | | 2.0 | 2.6 | |
| Li₂O | 5.0 | 6.0 | 6.0 | 6.0 | 8.0 | 6.0 | 6.0 | 7.5 | 4.0 | 8.0 |
| K₂O | 3.0 | 2.0 | 2.0 | 2.0 | | 2.0 | 2.0 | 0.5 | 2.0 | |
| TiO₂ | | | 3.0 | | | | 3.0 | | | 1.0 |
| ZrO₂ | 3.0 | 4.0 | 3.0 | 3.0 | 3.0 | 3.0 | 3.0 | 3.0 | 3.0 | 3.0 |
| P₂O₅ | 2.0 | 2.0 | 2.0 | 2.0 | 2.0 | 2.0 | 2.0 | 2.0 | 2.0 | 2.0 |
| Y₂O₃ | | | | | | | | | 3.0 | |
| Nb₂ O₅ | | | | | | | | | | |
| Ta₂O₅ | | | | | | | | | | |
| La₂O₃ | | | | | | | | | | |
| Sb₂O₃ | 0.5 | | 0.5 | | 0.5 | 0.4 | 0.2 | | 0.4 | |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time? hr?3 | 3 | 3 | 3 | 3 | 3 | 3 | 3 | 3 | 3 | |
| Nucleating | 580 | 580 | 580 | 580 | 580 | 580 | 580 | 580 | 580 | 580 |
| Temperature??? | | | | | | | | | | |
| Nucleating | 5 | 5 | 5 | 5 | 5 | 5 | 5 | 5 | 5 | 5 |
| Time? hr? | | | | | | | | | | |
| Nucleous Growing | 700 | 700 | 700 | 700 | 700 | 700 | 700 | 700 | 700 | 700 |
| Temperature??? | | | | | | | | | | |
| Nucleous Growing | 2 | 2 | 2 | 2 | 2 | 2 | 2 | 2 | 2 | 2 |
| Time? hr? | | | | | | | | | | |
| Main Crystalline | Crist.ss | Crist | Crist | a-Q | a-Q.ss | Crist | a-Q | Crist | Crist | Crist |
| Phase | | | | | | | | | | |
| Sub Crystalline | — | — | — | — | LAS | LZS | LAS | LZS | — | LAS |
| Phase | | | | | | | | | | |
| Specific | 2.49 | 2.48 | 2.52 | 2.57 | 2.55 | 2.54 | 2.57 | 2.56 | 2.47 | 2.57 |
| Gravity? g/cm₃ | | | | | | | | | | |
| Yong's Modulus | 77.6 | 77.7 | 75.6 | 84.6 | 82.9 | 78.6 | 83.2 | 77.7 | 77.9 | 79.6 |
| E?? Pa | | | | | | | | | | |
| Elastic Modulus | 31.2 | 31.3 | 30.0 | 32.9 | 32.5 | 30.9 | 32.4 | 30.4 | 31.5 | 31 .0 |
| Ratio | | | | | | | | | | |
| C.T.E | 102 | 107 | 119 | 142 | 94 | 99 | 86 | 96 | 106 | 82 |
| Amount of | 40 | 35 | 50 | 60 | 85 | 80 | 90 | 80 | 85 | 80 |
| Migration of alkali | | | | | | | | | | |
| metal [ppb] | | | | | | | | | | |
| P/Pli | 1.2 | 1.2 | 1.4 | 1.2 | 1.1 | 1.2 | 1.2 | 1.2 | 1.3 | 1.2 |

TABLE 160

| | C-265 | C-266 | C-267 | C-268 | C-269 | C-270 | C-271 | C-272 | C-273 | C-274 |
|---|---|---|---|---|---|---|---|---|---|---|
| SiO₂ | 66.5 | 67.0 | 68.0 | 68.0 | 65.0 | 65.0 | 68.0 | 65.0 | 65.4 | 65.0 |
| Al₂O₃ | 7.0 | 7.4 | 6.0 | 7.0 | 7.0 | 7.0 | 6.0 | 5.5 | 7.0 | 7.0 |
| MgO | | 2.0 | 0.5 | | | | | 2.0 | 2.0 | 2.5 |
| CaO | | | | 1.5 | | | | | | |
| BaO | | | | | | | 9.0 | 6.0 | | 8.5 |
| SrO | 9.0 | 7.0 | 7.5 | 6.0 | 9.0 | 8.0 | 9.0 | 3.0 | 9.5 | 0.5 |
| ZnO | 4.0 | 2.0 | 5.0 | 2.0 | 2.5 | 2.5 | | 2.5 | 2.6 | |
| Li₂O | 6.0 | 6.0 | 6.0 | 6.0 | 6.0 | 6.0 | 6.0 | 6.0 | 6.0 | 6.0 |
| K₂O | 2.0 | 2.0 | 2.0 | 2.0 | 2.0 | 2.0 | 2.0 | 2.0 | 2.0 | 2.0 |
| TiO₂ | | | | 2.0 | | | | | | 3.0 |
| ZrO₂ | 1.5 | 4.5 | 4.0 | 2.0 | 3.0 | 3.0 | 3.0 | 3.0 | 3.5 | 3.0 |
| P₂O₅ | 2.0 | 1.1 | 1.0 | 3.0 | 2.0 | 2.0 | 2.0 | 2.0 | 2.0 | 2.0 |
| Y₂O₃ | | | | | 3.0 | | | | | |
| Nb₂O₅ | | | | | | 4.0 | | | | |
| Ta₂O₅ | | | | | | | 4.0 | | | |
| La₂O₃ | | | | | | | | 3.0 | | |
| Sb₂O₃ | 2.0 | 1.0 | | 0.5 | 0.5 | 0.5 | | | | 0.5 |
| Total (100 wt %) | 100.0 | 100.0 | 100.0 | 100.0 | 100.0 | 100.0 | 109.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time? hr? | 3 | 3 | 3 | 3 | 3 | 3 | 3 | 3 | 3 | 3 |
| Nucleating | 580 | 580 | 580 | 580 | 580 | 580 | 580 | 580 | 580 | 580 |
| Temperature??? | | | | | | | | | | |
| Nucleating | 5 | 5 | 5 | 5 | 5 | 5 | 5 | 5 | 5 | 5 |
| Time? hr? | | | | | | | | | | |
| Nucleous Growing | 700 | 700 | 700 | 700 | 700 | 700 | 700 | 700 | 700 | 700 |
| Temperature??? | | | | | | | | | | |
| Nucleaus Growing | 2 | 2 | 2 | 2 | 2 | 2 | 2 | 2 | 2 | 2 |
| Time? hr? | | | | | | | | | | |
| Main Crystalline | Crist | Crist | Crist | a-Q | Crist | Crist | Crist | Crist | Crist.ss | Crist |
| Phase | | | | | | | | | | |
| Sub Crystalline | LZS | — | LZS | — | — | — | LAS | — | — | — |
| Phase | | | | | | | | | | |
| Specific | 2.55 | 2.47 | 2.50 | 2.51 | 2.44 | 2.58 | 2.60 | 2.59 | 2.47 | 2.47 |
| Gravity? g/cm₃ | | | | | | | | | | |
| Yong's Modulus | 81.9 | 76.4 | 79.3 | 82.7 | 79.6 | 78.7 | 80.6 | 80.3 | 78.3 | 78.2 |
| E?? Pa | | | | | | | | | | |
| Elastic Modulus | 32.1 | 30.9 | 31.7 | 32.9 | 32.6 | 30.5 | 31.0 | 31.0 | 31.7 | 31.7 |
| Ratio | | | | | | | | | | |
| C.T.E | 85 | 117 | 87 | 132 | 103 | 108 | 96 | 100 | 105 | 110 |
| Amount of | 50 | 40 | 75 | 65 | 40 | 60 | 85 | 60 | 40 | 35 |
| Migration of alkali | | | | | | | | | | |
| metal [ppb] | | | | | | | | | | |
| P/Pli | 1.3 | 1.4 | 1.2 | 1.2 | 1.2 | 1.2 | 1.3 | 1.2 | 1.2 | 1.2 |

TABLE 161

| | C-275 | C-276 | C-277 | C-278 | C-279 | C-280 | C-281 | C-282 | C-283 | C-284 |
|---|---|---|---|---|---|---|---|---|---|---|
| SiO₂ | 65.0 | 65.4 | 65.0 | 69.4 | 69.0 | 69.0 | 68.0 | 68.0 | 65.0 | 68.0 |
| Al₂O₃ | 7.0 | 7.0 | 7.0 | 6.0 | 6.0 | 6.0 | 5.0 | 9.0 | 7.0 | 6.0 |
| MgO | | 2.0 | 2.5 | | | 3.0 | 1.8 | | 2.0 | |
| CaO | | | | 3.0 | 3.0 | | | | | |
| BaO | 9.0 | | | | | | | | | 5.0 |
| SrO | 3.0 | 9.0 | 9.0 | 6.0 | 6.0 | 6.0 | 9.0 | 8.0 | 9.0 | 7.0 |
| ZnO | 2.5 | 2.6 | | 2.6 | 2.5 | 2.6 | | 2.0 | 2.6 | |
| Li₂O | 5.0 | 6.0 | 6.0 | 6.0 | 8.0 | 6.0 | 6.0 | 7.5 | 4.0 | 8.0 |
| K₂O | 3.0 | 2.0 | 2.0 | 2.0 | | 2.0 | 2.0 | 0.5 | 2.0 | |
| TiO₂ | | | 3.0 | | | | 3.0 | | | 1.0 |
| ZrO₂ | 3.0 | 4.0 | 3.0 | 3.0 | 3.0 | 3.0 | 3.0 | 3.0 | 3.0 | 3.0 |
| P₂O₅ | 2.0 | 2.0 | 2.0 | 2.0 | 2.0 | 2.0 | 2.0 | 2.0 | 2.0 | 2.0 |
| Y₂O₃ | | | | | | | | | 3.0 | |
| Nb₂O₅ | | | | | | | | | | |
| Ta₂O₅ | | | | | | | | | | |
| La₂O₃ | | | | | | | | | | |
| Sb₂O₃ | 0.5 | | 0.5 | | 0.5 | 0.4 | 0.2 | | 0.4 | |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time? hr? | 3 | 3 | 3 | 3 | 3 | 3 | 3 | 3 | 3 | 3 |
| Nucleating | 580 | 580 | 580 | 580 | 580 | 580 | 580 | 580 | 580 | 580 |
| Temperature??? | | | | | | | | | | |
| Nucleating | 5 | 5 | 5 | 5 | 5 | 5 | 5 | 5 | 5 | 5 |
| Time? hr? | | | | | | | | | | |
| Nucleous Growing | 680 | 680 | 680 | 680 | 680 | 680 | 680 | 680 | 680 | 680 |
| Temperature??? | | | | | | | | | | |
| Nucleous Growing | 5 | 5 | 5 | 5 | 5 | 5 | 5 | 5 | 5 | 5 |
| Time? hr? | | | | | | | | | | |
| Main Crystalline | Crist.ss | Crist | Crist | a-Q | a-Q.ss | Crist | a-Q | Crist | Crist | Crist |
| Phase | | | | | | | | | | |
| Sub Crystalline | — | — | — | — | LAS | LZS | LAS | LZS | — | LAS |
| Phase | | | | | | | | | | |
| Specific | 2.51 | 2.50 | 2.54 | 2.58 | 2.57 | 2.56 | 2.59 | 2.58 | 2.49 | 2.59 |
| Gravity? g/cm³ | | | | | | | | | | |
| Yong's Modulus | 77.9 | 78.0 | 75.9 | 84.8 | 83.2 | 78.9 | 83.5 | 78.0 | 78.2 | 79.9 |
| E?? Pa | | | | | | | | | | |
| Elastic Modulus | 31.0 | 31.2 | 29.9 | 32.9 | 32.4 | 30.8 | 32.2 | 30.2 | 31.4 | 30.8 |
| Ratio | | | | | | | | | | |
| C.T.E | 105 | 110 | 122 | 145 | 97 | 102 | 89 | 99 | 109 | 83 |
| Amount of | 40 | 35 | 50 | 60 | 85 | 80 | 90 | 80 | 85 | 80 |
| Migration of alkali | | | | | | | | | | |
| metal [ppb] | | | | | | | | | | |
| P/Pli | 1.2 | 1.2 | 1.4 | 1.2 | 1.1 | 1.2 | 1.2 | 1.2 | 1.3 | 1.2 |

TABLE 162

| | C-285 | C-286 | C-287 | C-288 | C-289 | C-290 | C-291 | C-292 | C-293 | C-294 |
|---|---|---|---|---|---|---|---|---|---|---|
| SiO₂ | 66.5 | 67.0 | 68.0 | 68.0 | 65.0 | 65.0 | 68.0 | 65.0 | 65.4 | 65.0 |
| Al₂O₃ | 7.0 | 7.4 | 6.0 | 7.0 | 7.0 | 7.0 | 6.0 | 5.5 | 7.0 | 7.0 |
| MgO | | 2.0 | 0.5 | | | | | 2.0 | 2.0 | 2.5 |
| CaO | | | | 1.5 | | | | | | |
| BaO | | | | | | | 9.0 | 6.0 | | 8.5 |
| SrO | 9.0 | 7.0 | 7.5 | 6.0 | 9.0 | 8.0 | 9.0 | 3.0 | 9.5 | 0.5 |
| ZnO | 4.0 | 2.0 | 5.0 | 2.0 | 2.5 | 2.5 | | 2.5 | 2.6 | |
| Li₂O | 6.0 | 6.0 | 6.0 | 6.0 | 6.0 | 6.0 | 6.0 | 6.0 | 6.0 | 6.0 |
| K₂O | 2.0 | 2.0 | 2.0 | 2.0 | 2.0 | 2.0 | 2.0 | 2.0 | 2.0 | 2.0 |
| TiO₂ | | | | 2.0 | | | | | | 3.0 |
| ZrO₂ | 1.5 | 4.5 | 4.0 | 2.0 | 3.0 | 3.0 | 3.0 | 3.0 | 3.5 | 3.0 |
| P₂O₅ | 2.0 | 1.1 | 1.0 | 3.0 | 2.0 | 2.0 | 2.0 | 2.0 | 2.0 | 2.0 |
| Y₂O₃ | | | | | 3.0 | | | | | |
| Nb₂O₅ | | | | | | 4.0 | | | | |
| Ta₂O₅ | | | | | | | 4.0 | | | |
| La₂O₃ | | | | | | | | 3.0 | | |
| Sb₂O₃ | 2.0 | 1.0 | | 0.5 | 0.5 | 0.5 | | | | 0.5 |
| Total (100 wt %) | 100.0 | 100.0 | 100.0 | 100.0 | 100.0 | 100.0 | 109.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time? hr? | 3 | 3 | 3 | 3 | 3 | 3 | 3 | 3 | 3 | 3 |
| Nucleating | 580 | 580 | 580 | 580 | 580 | 580 | 580 | 580 | 580 | 580 |
| Temperature??? | | | | | | | | | | |
| Nucleating | 5 | 5 | 5 | 5 | 5 | 5 | 5 | 5 | 5 | 5 |
| Time? hr? | | | | | | | | | | |
| Nucleous Growing | 680 | 680 | 680 | 680 | 680 | 680 | 680 | 680 | 680 | 680 |
| Temperature??? | | | | | | | | | | |
| Nucleous Growing | 5 | 5 | 5 | 5 | 5 | 5 | 5 | 5 | 5 | 5 |
| Time? hr? | | | | | | | | | | |
| Main Crystalline | Crist | Crist | Crist | a-Q | Crist | Crist | Crist | Crist | Crist.ss | Crist |
| Phase | | | | | | | | | | |
| Sub Crystalline | LZS | — | LZS | — | — | — | LAS | — | — | — |
| Phase | | | | | | | | | | |
| Specific | 2.57 | 2.49 | 2.52 | 2.53 | 2.46 | 2.60 | 2.62 | 2.61 | 2.49 | 2.49 |
| Gravity? g/cm³ | | | | | | | | | | |
| Yong's Modulus | 82.2 | 76.7 | 79.6 | 83.2 | 79.9 | 79.0 | 80.9 | 80.6 | 78.6 | 78.5 |
| E?? Pa | | | | | | | | | | |
| Elastic Modulus | 32.0 | 30.8 | 31.6 | 32.9 | 32.5 | 30.4 | 30.9 | 30.9 | 31.6 | 31.5 |
| Ratio | | | | | | | | | | |
| C.T.E | 88 | 120 | 90 | 135 | 106 | 111 | 99 | 103 | 108 | 113 |
| Amount of | 50 | 40 | 75 | 65 | 40 | 60 | 85 | 60 | 40 | 35 |
| Migration of alkali | | | | | | | | | | |
| metal [ppb] | | | | | | | | | | |
| P/Pli | 1.3 | 1.4 | 1.2 | 1.2 | 1.2 | 1.2 | 1.3 | 1.2 | 1.2 | 1.2 |

Tables 163 and 164 show the glass compositions in % by weight of respective crystallized glass substrates of C-295 to 314, together with the manufacturing conditions employed. Tables 165 and 166 show crystallized glass substrates as C-315 to 334 manufactured using the same glass compositions as those of C-295 to 314 with the nucleus growing temperature varied from that employed for C-295 to 314. Further, Tables 167 and 168 show crystallized glass substrates as C-335 to 354 manufactured using the same glass compositions as those of C-295 to 314 with the nucleus growing time varied from that employed for C-295 to 314.

TABLE 163

| | C-295 | C-296 | C-297 | C-298 | C-299 | C-300 | C-301 | C-302 | C-303 | C-304 |
|---|---|---|---|---|---|---|---|---|---|---|
| SiO₂ | 65.0 | 65.4 | 65.0 | 69.4 | 69.0 | 69.0 | 68.0 | 68.0 | 65.0 | 68.0 |
| Al₂O₃ | 7.0 | 7.0 | 7.0 | 6.0 | 6.0 | 6.0 | 5.0 | 9.0 | 7.0 | 6.0 |
| MgO | | 2.0 | 2.5 | | | 3.0 | 1.8 | | 2.0 | |
| CaO | | | | 3.0 | | | | | | |
| BaO | 9.0 | 9.0 | | 6.0 | 9.0 | | 8.5 | | 9.0 | 5.0 |
| SrO | 3.0 | | 8.0 | | | 6.0 | | 8.0 | | 6.0 |
| ZnO | 2.5 | 2.6 | 1.0 | 2.6 | 2.5 | 2.6 | 0.5 | 2.0 | 2.6 | 1.0 |
| Li₂O | 5.0 | 6.0 | 6.0 | 6.0 | 8.0 | 6.0 | 6.0 | 7.5 | 4.0 | 8.0 |
| K₂O | 3.0 | 2.0 | 2.0 | 2.0 | | 2.0 | 2.0 | 0.5 | 2.0 | |
| TiO₂ | | | 3.0 | | | | 3.0 | | | 1.0 |
| ZrO₂ | 3.0 | 4.0 | 3.0 | 3.0 | 3.0 | 3.0 | 3.0 | 3.0 | 3.0 | 3.0 |
| P₂O₅ | 2.0 | 2.0 | 2.0 | 2.0 | 2.0 | 2.0 | 2.0 | 2.0 | 2.0 | 2.0 |
| Y₂O₃ | | | | | | | | | 3.0 | |
| Nb₂O₅ | | | | | | | | | | |
| Ta₂O₅ | | | | | | | | | | |
| La₂O₃ | | | | | | | | | | |
| Sb₂O₃ | 0.5 | | 0.5 | | 0.5 | 0.4 | 0.2 | | 0.4 | |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time? hr? | 3 | 3 | 3 | 3 | 3 | 3 | 3 | 3 | 3 | 3 |
| Nucleating | 580 | 580 | 580 | 580 | 580 | 580 | 580 | 580 | 580 | 580 |
| Temperature??? | | | | | | | | | | |
| Nucleating | 5 | 5 | 5 | 5 | 5 | 5 | 5 | 5 | 5 | 5 |
| Time? hr? | | | | | | | | | | |
| Nucleous Growing | 680 | 680 | 680 | 680 | 680 | 680 | 680 | 680 | 680 | 680 |
| Temperature??? | | | | | | | | | | |
| Nucleous Growing | 2 | 2 | 2 | 2 | 2 | 2 | 2 | 2 | 2 | 2 |
| Time? hr? | | | | | | | | | | |
| Main Crystalline | Crist.ss | Crist | Crist | a-Q | a-Q.ss | Crist | a-Q | Crist | Crist | Crist |
| Phase | | | | | | | | | | |
| Sub Crystalline | — | — | — | — | LAS | LZS | LAS | LZS | — | LAS |
| Phase | | | | | | | | | | |
| Specific | 2.53 | 2.56 | 2.53 | 2.61 | 2.62 | 2.58 | 2.63 | 2.60 | 2.55 | 2.58 |
| Gravity? g/cm³ | | | | | | | | | | |
| Yong's Modulus | 78.2 | 77.0 | 77.2 | 85.1 | 83.1 | 79.2 | 83.7 | 78.3 | 77.2 | 80.4 |
| E?? Pa | | | | | | | | | | |
| Elastic Modulus | 30.9 | 30.1 | 30.5 | 32.6 | 31.7 | 30.7 | 31.8 | 30.1 | 30.3 | 31.2 |
| Ratio | | | | | | | | | | |
| C.T.E | 105 | 108 | 126 | 143 | 95 | 102 | 86 | 99 | 102 | 86 |
| Amount of | 40 | 35 | 50 | 60 | 85 | 80 | 90 | 80 | 85 | 80 |
| Migration at alkali | | | | | | | | | | |
| metal [ppb] | | | | | | | | | | |
| P/Pli | 1.2 | 1.2 | 1.4 | 1.2 | 1.1 | 1.2 | 1.2 | 1.2 | 1.3 | 1.2 |

TABLE 164

| | C-305 | C-306 | C-307 | C-308 | C-309 | C-310 | C-311 | C-312 | C-313 | C-314 |
|---|---|---|---|---|---|---|---|---|---|---|
| SiO₂ | 66.5 | 67.0 | 68.0 | 68.0 | 65.0 | 65.0 | 68.0 | 65.0 | 68.0 | 66.5 |
| Al₂O₃ | 7.0 | 7.4 | 6.0 | 7.0 | 7.0 | 7.0 | 6.0 | 5.5 | 5.0 | 7.0 |
| MgO | | 2.0 | 0.5 | | | | | 2.0 | 1.8 | |
| CaO | | | | 1.5 | | | | | | |
| BaO | 8.5 | | 7.5 | 6.0 | 9.0 | | 8.5 | 6.0 | 7.0 | 7.5 |
| SrO | 0.5 | 7.0 | | | | 8.0 | | 3.0 | 1.5 | 0.5 |
| ZnO | 4.0 | 2.0 | 5.0 | 2.0 | 2.5 | 2.5 | 0.5 | 2.5 | 0.5 | 5.0 |
| Li₂O | 6.0 | 6.0 | 6.0 | 6.0 | 6.0 | 6.0 | 6.0 | 6.0 | 6.0 | 6.0 |
| K₂O | 2.0 | 2.0 | 2.0 | 2.0 | 2.0 | 2.0 | 2.0 | 2.0 | 2.0 | 2.0 |
| TiO₂ | | | | 2.0 | | | | | 3.0 | |
| ZrO₂ | 1.5 | 4.5 | 4.0 | 2.0 | 3.0 | 3.0 | 3.0 | 3.0 | 3.5 | 1.5 |
| P₂O₅ | 2.0 | 1.1 | 1.0 | 3.0 | 2.0 | 2.0 | 2.0 | 2.0 | 1.5 | 2.0 |
| Y₂O₃ | | | | | 3.0 | | | | | |
| Nb₂O₅ | | | | | | 4.0 | | | | |
| Ta₂O₅ | | | | | | | 4.0 | | | |
| La₂O₃ | | | | | | | | 3.0 | | |
| Sb₂O₃ | 2.0 | 1.0 | | 0.5 | 0.5 | 0.5 | | | 0.2 | 2.0 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time? hr? | 3 | 3 | 3 | 3 | 3 | 3 | 3 | 3 | 3 | 3 |
| Nucleating | 580 | 580 | 580 | 580 | 580 | 580 | 580 | 580 | 580 | 580 |
| Temperature??? | | | | | | | | | | |
| Nucleating | 5 | 5 | 5 | 5 | 5 | 5 | 5 | 5 | 5 | 5 |
| Time? hr? | | | | | | | | | | |
| Nucleous Growing | 680 | 680 | 680 | 680 | 680 | 680 | 680 | 680 | 680 | 680 |
| Temperature??? | | | | | | | | | | |
| Nucleous Growing | 2 | 2 | 2 | 2 | 2 | 2 | 2 | 2 | 2 | 2 |
| Time? hr? | | | | | | | | | | |
| Main Crystalline | Crist | Crist | Crist | a-Q | Crist | Crist | Crist | Crist | a-Q | Crist |
| Phase | | | | | | | | | | |
| Sub Crystalline | LZS | — | LZS | — | LZS | LZS | LAS | — | LAS | |
| Phase | | | | | | | | | | |
| Specific | 2.62 | 2.51 | 2.59 | 2.58 | 2.50 | 2.62 | 2.62 | 2.65 | 2.60 | 2.60 |
| Gravity? g/cm³ | | | | | | | | | | |
| Yong's Modulus | 81.0 | 77.0 | 79.5 | 83.1 | 79.3 | 79.3 | 80.5 | 80.4 | 83.5 | 82.6 |
| E?? Pa | | | | | | | | | | |
| Elastic Modulus | 30.9 | 30.7 | 30.7 | 32.2 | 31.7 | 30.3 | 30.7 | 30.3 | 32.1 | 31.8 |
| Ratio | | | | | | | | | | |
| C.T.E | 82 | 120 | 88 | 133 | 101 | 111 | 93 | 99 | 89 | 87 |
| Amount of | 50 | 40 | 75 | 65 | 40 | 60 | 85 | 60 | 90 | 50 |
| Migration of alkali | | | | | | | | | | |
| metal [ppb] | | | | | | | | | | |
| P/Pli | 1.3 | 1.4 | 1.2 | 1.2 | 1.2 | 1.2 | 1.3 | 1.2 | 1.2 | 1.3 |

TABLE 165

| | C-315 | C-36 | C-317 | C-318 | C-319 | C-320 | C-321 | C-322 | C-323 | C-324 |
|---|---|---|---|---|---|---|---|---|---|---|
| SiO₂ | 65.0 | 65.4 | 65.0 | 69.4 | 69.0 | 69.0 | 68.0 | 68.0 | 65.0 | 68.0 |
| Al₂O₃ | 7.0 | 7.0 | 7.0 | 6.0 | 6.0 | 6.0 | 5.0 | 9.0 | 7.0 | 6.0 |
| MgO | | 2.0 | 2.5 | | | 3.0 | 1.8 | | 2.0 | |
| CaO | | | | 3.0 | | | | | | |
| BaO | 9.0 | 9.0 | | 6.0 | 9.0 | | 8.5 | | 9.0 | 5.0 |
| SrO | 3.0 | | 8.0 | | | 6.0 | | 8.0 | | 6.0 |
| ZnO | 2.5 | 2.6 | 1.0 | 2.6 | 2.5 | 2.6 | 0.5 | 2.0 | 2.6 | 1.0 |
| Li₂O | 5.0 | 6.0 | 6.0 | 6.0 | 8.0 | 6.0 | 6.0 | 7.5 | 4.0 | 8.0 |
| K₂O | 3.0 | 2.0 | 2.0 | 2.0 | | 2.0 | 2.0 | 0.5 | 2.0 | |
| TiO₂ | | | 3.0 | | | | 3.0 | | | 1.0 |
| ZrO₂ | 3.0 | 4.0 | 3.0 | 3.0 | 3.0 | 3.0 | 3.0 | 3.0 | 3.0 | 3.0 |
| P₂O₅ | 2.0 | 2.0 | 2.0 | 2.0 | 2.0 | 2.0 | 2.0 | 2.0 | 2.0 | 2.0 |
| Y₂O₃ | | | | | | | | | 3.0 | |
| Nb₂O₅ | | | | | | | | | | |
| Ta₂O₅ | | | | | | | | | | |
| La₂O₃ | | | | | | | | | | |
| Sb₂O₃ | 0.5 | | 0.5 | | 0.5 | 0.4 | 0.2 | | 0.4 | |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time? hr? | 3 | 3 | 3 | 3 | 3 | 3 | 3 | 3 | 3 | 3 |
| Nucleating | 580 | 580 | 580 | 580 | 580 | 580 | 580 | 580 | 580 | 580 |
| Temperature??? | | | | | | | | | | |
| Nucleating | 5 | 5 | 5 | 5 | 5 | 5 | 5 | 5 | 5 | 5 |
| Time? hr? | | | | | | | | | | |
| Nucleous Growing | 700 | 700 | 700 | 700 | 700 | 700 | 700 | 700 | 700 | 700 |
| Temperature??? | | | | | | | | | | |
| Nucleus Growing | 2 | 2 | 2 | 2 | 2 | 2 | 2 | 2 | 2 | 2 |
| Time? hr? | | | | | | | | | | |
| Main Crystalline | Crist.ss | Crist | Crist | a-Q | a-Q.ss | Crist | a-Q | Crist | Crist | Crist |
| Phase | | | | | | | | | | |
| Sub Crystalline | — | — | — | — | LAS | LZS | LAS | LZS | — | LAS |
| Phase | | | | | | | | | | |
| Specific | 2.49 | 2.52 | 2.49 | 2.57 | 2.58 | 2.54 | 2.59 | 2.56 | 2.51 | 2.54 |
| Gravity? g/cm³ | | | | | | | | | | |
| Yong's Modulus | 78.2 | 77.6 | 76.4 | 76.6 | 84.5 | 82.5 | 78.6 | 83.1 | 77.7 | 76.6 |
| E?? Pa | | | | | | | | | | |
| Elastic Modulus | 31.4 | 30.8 | 30.7 | 29.8 | 32.8 | 32.5 | 30.3 | 32.5 | 31.0 | 30.2 |
| Ratio | | | | | | | | | | |
| C.T.E | 102 | 105 | 123 | 140 | 92 | 99 | 83 | 96 | 99 | 83 |
| Amount of | 40 | 35 | 50 | 60 | 85 | 80 | 90 | 80 | 85 | 80 |
| Migration of alkali | | | | | | | | | | |
| metal [ppb] | | | | | | | | | | |
| P/Pli | 1.2 | 1.2 | 1.4 | 1.2 | 1.1 | 1.2 | 1.2 | 1.2 | 1.3 | 1.2 |

TABLE 166

| | C-325 | C-326 | C-327 | C-328 | C-329 | C-320 | C-331 | C-332 | C-333 | C-334 |
|---|---|---|---|---|---|---|---|---|---|---|
| SiO₂ | 66.5 | 67.0 | 68.0 | 68.0 | 65.0 | 65.0 | 68.0 | 65.0 | 68.0 | 66.5 |
| Al₂O₃ | 7.0 | 7.4 | 6.0 | 7.0 | 7.0 | 7.0 | 6.0 | 5.5 | 5.0 | 7.0 |
| MgO | | 2.0 | 0.5 | | | | | 2.0 | 1.8 | |
| CaO | | | | 1.5 | | | | | | |
| BaO | 8.5 | | 7.5 | 6.0 | 9.0 | | 8.5 | 6.0 | 7.0 | 7.5 |
| SrO | 0.5 | 7.0 | | | | 8.0 | | 3.0 | 1.5 | 0.5 |
| ZnO | 4.0 | 2.0 | 5.0 | 2.0 | 2.5 | 2.5 | 0.5 | 2.5 | 0.5 | 5.0 |
| Li₂O | 6.0 | 6.0 | 6.0 | 6.0 | 6.0 | 6.0 | 6.0 | 6.0 | 6.0 | 6.0 |
| K₂O | 2.0 | 2.0 | 2.0 | 2.0 | 2.0 | 2.0 | 2.0 | 2.0 | 2.0 | 2.0 |
| TiO₂ | | | | 2.0 | | | | | 3.0 | |
| ZrO₂ | 1.5 | 4.5 | 4.0 | 2.0 | 3.0 | 3.0 | 3.0 | 3.0 | 3.5 | 1.5 |
| P₂O₅ | 2.0 | 1.1 | 1.0 | 3.0 | 2.0 | 2.0 | 2.0 | 2.0 | 1.5 | 2.0 |
| Y₂O₃ | | | | | 3.0 | | | | | |
| Nb₂O₅ | | | | | | 4.0 | | | | |
| Ta₂O₅ | | | | | | | 4.0 | | | |
| La₂O₃ | | | | | | | | 3.0 | | |
| Sb₂O₃ | 2.0 | 1.0 | | 0.5 | 0.5 | 0.5 | | | 0.2 | 2.0 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time? hr? | 3 | 3 | 3 | 3 | 3 | 3 | 3 | 3 | 3 | 3 |
| Nucleating | 580 | 580 | 580 | 580 | 580 | 580 | 580 | 580 | 580 | 580 |
| Temperature??? | | | | | | | | | | |
| Nucleating | 5 | 5 | 5 | 5 | 5 | 5 | 5 | 5 | 5 | 5 |
| Time? hr? | | | | | | | | | | |
| Nucleous Growing | 700 | 700 | 700 | 700 | 700 | 700 | 700 | 700 | 700 | 700 |
| Temperature??? | | | | | | | | | | |
| Nucleous Growing | 2 | 2 | 2 | 2 | 2 | 2 | 2 | 2 | 2 | 2 |
| Time? hr? | | | | | | | | | | |
| Main Crystalline | Crist | Crist | Crist | a-Q | Crist | Crist | Crist | Crist | a-Q | Crist |
| Phase | | | | | | | | | | |
| Sub Crystalline | LZS | — | LZS | — | LZS | LZS | LAS | — | LAS | |
| Phase | | | | | | | | | | |
| Specific | 2.58 | 2.47 | 2.55 | 2.54 | 2.52 | 2.58 | 2.58 | 2.61 | 2.56 | 2.56 |
| Gravity? g/cm³ | | | | | | | | | | |
| Yong's Modulus | 79.8 | 80.4 | 76.4 | 78.9 | 82.3 | 78.7 | 78.7 | 79.9 | 79.8 | 82.9 |
| E?? Pa | | | | | | | | | | |
| Elastic Modulus | 30.9 | 32.6 | 30.0 | 31.1 | 32.7 | 30.5 | 30.5 | 30.6 | 31.2 | 32.4 |
| Ratio | | | | | | | | | | |
| C.T.E | 82 | 117 | 85 | 130 | 98 | 108 | 90 | 96 | 86 | 84 |
| Amount of | 50 | 40 | 75 | 65 | 40 | 60 | 85 | 60 | 90 | 50 |
| Migration of alkali | | | | | | | | | | |
| metal [ppb] | | | | | | | | | | |
| P/Pli | 1.3 | 1.4 | 1.2 | 1.2 | 1.2 | 1.2 | 1.3 | 1.2 | 1.2 | 1.3 |

TABLE 167

| | C-335 | C-336 | C-337 | C-338 | C-339 | C-340 | C-341 | C-342 | C-343 | C-344 |
|---|---|---|---|---|---|---|---|---|---|---|
| SiO₂ | 65.0 | 65.4 | 65.0 | 69.4 | 69.0 | 69.0 | 68.0 | 68.0 | 65.0 | 68.0 |
| Al₂O₃ | 7.0 | 7.0 | 7.0 | 6.0 | 6.0 | 6.0 | 5.0 | 9.0 | 7.0 | 6.0 |
| MgO | | 2.0 | 2.5 | | | 3.0 | 1.8 | | 2.0 | |
| CaO | | | | 3.0 | | | | | | |
| BaO | 9.0 | 9.0 | | 6.0 | 9.0 | | 8.5 | | 9.0 | 5.0 |
| SrO | 3.0 | | 8.0 | | | 6.0 | | 8.0 | | 6.0 |
| ZnO | 2.5 | 2.6 | 1.0 | 2.6 | 2.5 | 2.6 | 0.5 | 2.0 | 2.6 | 1.0 |
| Li₂O | 5.0 | 6.0 | 6.0 | 6.0 | 8.0 | 6.0 | 6.0 | 7.5 | 4.0 | 8.0 |
| K₂O | 3.0 | 2.0 | 2.0 | 2.0 | | 2.0 | 2.0 | 0.5 | 2.0 | |
| TiO₂ | | | 3.0 | | | | 3.0 | | | 1.0 |
| ZrO₂ | 3.0 | 4.0 | 3.0 | 3.0 | 3.0 | 3.0 | 3.0 | 3.0 | 3.0 | 3.0 |
| P₂O₅ | 2.0 | 2.0 | 2.0 | 2.0 | 2.0 | 2.0 | 2.0 | 2.0 | 2.0 | 2.0 |
| Y₂O₃ | | | | | | | | | 3.0 | |
| Nb₂O₅ | | | | | | | | | | |
| Ta₂O₅ | | | | | | | | | | |
| La₂O₃ | | | | | | | | | | |
| Sb₂O₃ | 0.5 | | 0.5 | | 0.5 | 0.4 | 0.2 | | 0.4 | |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time? hr? | 3 | 3 | 3 | 3 | 3 | 3 | 3 | 3 | 3 | 3 |
| Nucleating | 580 | 580 | 580 | 580 | 580 | 580 | 580 | 580 | 580 | 580 |
| Temperature??? | | | | | | | | | | |
| Nucleating | 5 | 5 | 5 | 5 | 5 | 5 | 5 | 5 | 5 | 5 |
| Time?hr? | | | | | | | | | | |
| Nucleous Growing | 680 | 680 | 680 | 680 | 680 | 680 | 680 | 680 | 680 | 680 |
| Temperature??? | | | | | | | | | | |
| Nucleous Growing | 5 | 5 | 5 | 5 | 5 | 5 | 5 | 5 | 5 | 5 |
| Time?hr? | | | | | | | | | | |
| Main Crystalline | Crist.ss | Crist | Crist | a-Q | a-Q.ss | Crist | a-Q | Crist | Crist | Crist |
| Phase | | | | | | | | | | |
| Sub Crystalline | — | — | — | — | LAS | LZS | LAS | LZS | — | LAS |
| Phase | | | | | | | | | | |
| Specific | 2.51 | 2.54 | 2.51 | 2.59 | 2.60 | 2.56 | 2.61 | 2.58 | 2.53 | 2.56 |
| Gravity? g/cm³ | | | | | | | | | | |
| Yong's Modulus | 77.9 | 76.7 | 76.9 | 84.8 | 82.8 | 78.9 | 83.4 | 78.0 | 76.9 | 80.1 |
| E?? Pa | | | | | | | | | | |
| Elastic Modulus | 31.0 | 30.2 | 30.6 | 32.7 | 31.8 | 30.8 | 32.0 | 30.2 | 30.4 | 31.3 |
| Ratio | | | | | | | | | | |
| C.T.E | 107 | 110 | 128 | 145 | 97 | 104 | 88 | 101 | 104 | 88 |
| Amount of | 40 | 35 | 50 | 60 | 85 | 80 | 90 | 80 | 85 | 80 |
| Migration of alkali | | | | | | | | | | |
| metal [ppb] | | | | | | | | | | |
| P/Pli | 1.2 | 1.2 | 1.4 | 1.2 | 1.1 | 1.2 | 1.2 | 1.2 | 1.3 | 1.2 |

TABLE 168

| | C-345 | C-346 | C-347 | C-348 | C-349 | C-350 | C-351 | C-352 | C-353 | C-354 |
|---|---|---|---|---|---|---|---|---|---|---|
| SiO₂ | 66.5 | 67.0 | 68.0 | 68.0 | 65.0 | 65.0 | 68.0 | 65.0 | 68.0 | 66.5 |
| Al₂O₃ | 7.0 | 7.4 | 6.0 | 7.0 | 7.0 | 7.0 | 6.0 | 5.5 | 5.0 | 7.0 |
| MgO | | 2.0 | 0.5 | | | | | 2.0 | 1.8 | |
| CaO | | | | 1.5 | | | | | | |
| BaO | 8.5 | | 7.5 | 6.0 | 9.0 | | 8.5 | 6.0 | 7.0 | 7.5 |
| SrO | 0.5 | 7.0 | | | | 8.0 | | 3.0 | 1.5 | 0.5 |
| ZnO | 4.0 | 2.0 | 5.0 | 2.0 | 2.5 | 2.5 | 0.5 | 2.5 | 0.5 | 5.0 |
| Li₂O | 6.0 | 6.0 | 6.0 | 6.0 | 6.0 | 6.0 | 6.0 | 6.0 | 6.0 | 6.0 |
| K₂O | 2.0 | 2.0 | 2.0 | 2.0 | 2.0 | 2.0 | 2.0 | 2.0 | 2.0 | 2.0 |
| TiO₂ | | | | 2.0 | | | | | 3.0 | |
| ZrO₂ | 1.5 | 4.5 | 4.0 | 2.0 | 3.0 | 3.0 | 3.0 | 3.0 | 3.5 | 1.5 |
| P₂O₅ | 2.0 | 1.1 | 1.0 | 3.0 | 2.0 | 2.0 | 2.0 | 2.0 | 1.5 | 2.0 |
| Y₂O₃ | | | | | 3.0 | | | | | |
| Nb₂O₅ | | | | | | 4.0 | | | | |
| Ta₂O₅ | | | | | | | 4.0 | | | |
| La₂O₃ | | | | | | | | 3.0 | | |
| Sb₂O₃ | 2.0 | 1.0 | | 0.5 | 0.5 | 0.5 | | | 0.2 | 2.0 |
| Total (100 wt %) | 100.0 | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 | 1550 |
| Temperature??? | | | | | | | | | | |
| Melting Time? hr? | 3 | 3 | 3 | 3 | 3 | 3 | 3 | 3 | 3 | 3 |
| Nucleating | 580 | 580 | 580 | 580 | 580 | 580 | 580 | 580 | 580 | 580 |
| Temperature??? | | | | | | | | | | |
| Nucleating | 5 | 5 | 5 | 5 | 5 | 5 | 5 | 5 | 5 | 5 |
| Time? hr? | | | | | | | | | | |
| Nucleous Growing | 680 | 680 | 680 | 680 | 680 | 680 | 680 | 680 | 680 | 680 |
| Temperature??? | | | | | | | | | | |
| Nucleous Growing | 5 | 5 | 5 | 5 | 5 | 5 | 5 | 5 | 5 | 5 |
| Time? hr? | | | | | | | | | | |
| Main Crystalline | Crist | Crist | Crist | a-Q | Crist | Crist | Crist | Crist | a-Q | Crist |
| Phase | | | | | | | | | | |
| Sub Crystalline | LZS | — | LZS | — | LZS | LZS | LAS | — | LAS | |
| Phase | | | | | | | | | | |
| Specific | 2.60 | 2.49 | 2.57 | 2.56 | 2.48 | 2.60 | 2.60 | 2.63 | 2.58 | 2.58 |
| Gravity? g/cm³ | | | | | | | | | | |
| Yong's Modulus | 80.7 | 76.7 | 79.2 | 82.8 | 79.0 | 79.0 | 80.2 | 80.1 | 83.2 | 82.3 |
| E?? Pa | | | | | | | | | | |
| Elastic Modulus | 31.0 | 30.8 | 30.8 | 32.3 | 31.9 | 30.4 | 30.8 | 30.5 | 32.2 | 31.9 |
| Ratio | | | | | | | | | | |
| C.T.E | 84 | 122 | 90 | 135 | 103 | 113 | 95 | 101 | 91 | 89 |
| Amount of | 50 | 40 | 75 | 65 | 40 | 60 | 85 | 60 | 90 | 50 |
| Migration of alkali | | | | | | | | | | |
| metal [ppb] | | | | | | | | | | |
| P/Pli | 1.3 | 1.4 | 1.2 | 1.2 | 1.2 | 1.2 | 1.3 | 1.2 | 1.2 | 1.3 |

Tables 169 and 170 show the glass compositions in % by weight of respective crystallized glass substrates of C-355 to 363, together with the manufacturing conditions employed. Tables 171 and 172 show crystallized glass substates as C-373 to 390 manufactured using the same glass compositions as those of C-355 to 363 with the nucleus growing temperature varied from that employed for C-355 to 363. Further Tables 173 and 174 show crystallized glass substtrates as C-391 to 408 manufactured using the same glass compositions as those of C-355 to 363 with the nucleus growing time varied from that employed for C-355 to 363.

TABLE 169

| | C-355 | C-356 | C-357 | C-358 | C-359 | C-360 | C-361 | C-362 | C-363 |
|---|---|---|---|---|---|---|---|---|---|
| SiO₂ | 65.0 | 65.4 | 65.0 | 69.4 | 68.0 | 69.0 | 68.0 | 68.0 | 65.0 |
| Al₂O₃ | 7.0 | 7.0 | 7.0 | 6.0 | 6.0 | 6.0 | 5.0 | 9.0 | 7.0 |
| MgO | | 2.0 | 2.5 | | | 3.0 | 1.8 | | 2.0 |
| CaO | | | | 3.0 | | | | | |
| BaO | 8.9 | 8.5 | | 6.0 | 9.0 | | 8.9 | | 9.0 |
| SrO | 3.0 | | 8.0 | | | 5.0 | | 7.5 | |
| ZnO | 2.5 | 2.6 | | 1.1 | 1.5 | 2.6 | | 2.0 | 2.6 |
| Li₂O | 5.0 | 6.0 | 6.0 | 6.0 | 8.0 | 6.0 | 6.0 | 7.5 | 4.0 |
| K₂O | 3.0 | 2.0 | 2.0 | 2.0 | | 2.0 | 2.0 | 0.5 | 2.0 |
| TiO₂ | | | 3.0 | | | | 3.0 | | |
| ZrO₂ | 3.0 | 4.0 | 3.0 | 3.0 | 2.0 | 3.0 | 3.0 | 3.0 | 3.0 |
| P₂O₅ | 2.0 | 2.0 | 2.0 | 2.0 | 1.0 | 2.0 | 2.0 | 2.0 | 2.0 |
| Y₂O₃ | 0.1 | 0.5 | 1.0 | 1.5 | 5.0 | 1.0 | 0.1 | 0.5 | 3.0 |
| Nb₂O₅ | | | | | | | | | |
| Ta₂O₅ | | | | | | | | | |
| La₂O₃ | | | | | | | | | |
| Sb₂O₃ | 0.5 | | 0.5 | | 0.5 | 0.4 | 0.2 | | 0.4 |
| Total (100 wt %) | 100.0 | 100.0 | 100.0 | 100.0 | 101.0 | 100.0 | 100.0 | 100.0 | 100.0 |
| Melting | 1550 | 1550 | 1550 | 1550 | 1550 | 1550 | 1550 | 1550 | 1550 |
| Temperature??? | | | | | | | | | |
| Melting Time? hr? | 3 | 3 | 3 | 3 | 3 | 3 | 3 | 3 | 3 |
| Nucleating | 580 | 580 | 580 | 580 | 580 | 580 | 580 | 580 | 580 |
| Temperature??? | | | | | | | | | |
| Nucleating | 5 | 5 | 5 | 5 | 5 | 5 | 5 | 5 | 5 |
| Time? hr? | | | | | | | | | |
| Nucleous Growing | 680 | 680 | 680 | 680 | 680 | 680 | 680 | 680 | 680 |
| Temperature??? | | | | | | | | | |
| Nucleous Growing | 2 | 2 | 2 | 2 | 2 | 2 | 2 | 2 | 2 |
| Time? hr? | | | | | | | | | |
| Main Crystalline | Crist.ss | Crist | Crist | a-Q | a-Q.ss | Crist | a-Q | Crist | Crist |
| Phase | | | | | | | | | |
| Sub Crystalline | — | — | — | — | LAS | LZS | LAS | LZS | — |
| Phase | | | | | | | | | |
| Specific | 2.54 | 2.58 | 2.58 | 2.69 | 2.71 | 2.61 | 2.65 | 2.62 | 2.61 |
| Gravity? g/cm³ | | | | | | | | | |
| Yong's Modulus | 78.4 | 77.3 | 77.5 | 85.3 | 84.6 | 80.2 | 84.7 | 78.9 | 78.3 |
| E?? Pa | | | | | | | | | |
| Elastic Modulus | 30.9 | 30.0 | 30.0 | 31.7 | 31.2 | 30.7 | 32.0 | 30.1 | 30.0 |
| Ratio | | | | | | | | | |
| C.T.E | 104 | 106 | 120 | 140 | 93 | 100 | 83 | 98 | 100 |
| Amount of | 40 | 35 | 50 | 60 | 85 | 80 | 90 | 80 | 85 |
| Migration of | | | | | | | | | |
| alkali metal [ppb] | | | | | | | | | |
| P/Pli | 1.2 | 1.2 | 1.4 | 1.2 | 1.1 | 1.2 | 1.2 | 1.2 | 1.3 |

TABLE 170

| | C-364 | C-365 | C-366 | C-367 | C-368 | C-369 | C-370 | C-371 | C-372 |
|---|---|---|---|---|---|---|---|---|---|
| SiO₂ | 68.0 | 66.5 | 67.0 | 68.0 | 68.0 | 65.0 | 65.0 | 68.0 | 65.0 |
| Al₂O₃ | 6.0 | 7.0 | 7.4 | 6.0 | 7.0 | 7.0 | 7.0 | 6.0 | 5.5 |
| MgO | | | 2.0 | 0.5 | | | | | 1.0 |
| CaO | | | | | 1.0 | | | | |
| BaO | 4.5 | 7.0 | | 7.4 | 6.0 | 9.0 | | 8.0 | 5.5 |
| SrO | 6.0 | | 6.0 | | | | 8.0 | | 2.5 |
| ZnO | | 3.0 | 2.0 | 5.0 | 2.0 | 2.5 | 2.5 | | 2.5 |
| Li₂O | 8.0 | 6.0 | 6.0 | 6.0 | 6.0 | 6.0 | 6.0 | 6.0 | 6.0 |
| K₂O | | 2.0 | 2.0 | 2.0 | 2.0 | 2.0 | 2.0 | 2.0 | 2.0 |
| TiO₂ | 1.0 | | | | 2.0 | | | | |
| ZrO₂ | 3.0 | 1.5 | 4.5 | 4.0 | 2.0 | 3.0 | 3.0 | 3.0 | 3.0 |
| P₂O₅ | 2.0 | 2.0 | 1.1 | 1.0 | 3.0 | 2.0 | 2.0 | 2.0 | 2.0 |
| Y₂O₃ | 1.5 | 3.0 | 1.0 | 0.1 | 0.5 | 3.0 | 0.5 | 1.0 | 2.0 |
| Nb₂O₅ | | | | | | | 3.5 | | |
| Ta₂O₅ | | | | | | | | | 4.0 |
| La₂O₃ | | | | | | | | | 3.0 |
| Sb₂O₃ | | 2.0 | 1.0 | | 0.5 | 0.5 | 0.5 | | |
| Total (100 wt %) | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 |
| Temperature??? | | | | | | | | | |
| Melting Time? hr? | 3 | 3 | 3 | 3 | 3 | 3 | 3 | 3 | 3 |
| Nucleating | 580 | 580 | 580 | 580 | 580 | 580 | 580 | 580 | 580 |
| Temperature??? | | | | | | | | | |
| Nucleating | 5 | 5 | 5 | 5 | 5 | 5 | 5 | 5 | 5 |
| Time? hr? | | | | | | | | | |
| Nucleous Growing | 680 | 680 | 680 | 680 | 680 | 680 | 680 | 680 | 680 |
| Temperature??? | | | | | | | | | |
| Nucleous Growing | 2 | 2 | 2 | 2 | 2 | 2 | 2 | 2 | 2 |
| Time? hr? | | | | | | | | | |
| Main Crystalline | Crist | Crist | Crist | Crist | a-Q | Crist | Crist | Crist | Crist |
| Phase | | | | | | | | | |
| Sub Crystalline | LAS | LZS | — | LZS | — | — | — | LAS | — |
| Phase | | | | | | | | | |
| Specific Gravity | 2.64 | 2.69 | 2.57 | 2.60 | 2.59 | 2.54 | 2.70 | 2.72 | 2.70 |
| ? g/cm³ | | | | | | | | | |
| Yong's Modulus | 80.6 | 81.8 | 77.5 | 79.6 | 83.3 | 79.6 | 80.4 | 81.1 | 81.1 |
| E?? Pa | | | | | | | | | |
| Elastic Modulus | 30.5 | 30.4 | 30.2 | 30.6 | 32.2 | 31.3 | 29.8 | 29.8 | 30.0 |
| Ratio | | | | | | | | | |
| C.T.E | 84 | 83 | 118 | 87 | 131 | 99 | 108 | 90 | 95 |
| Amount of | 80 | 50 | 40 | 75 | 65 | 40 | 60 | 85 | 60 |
| Migration of | | | | | | | | | |
| alkali metal [ppb] | | | | | | | | | |
| P/Pli | 1.2 | 1.3 | 1.4 | 1.2 | 1.2 | 1.2 | 1.2 | 1.3 | 1.2 |

TABLE 171

| | C-373 | C-374 | C-375 | C-376 | C-377 | C-378 | C-379 | C-380 | C-381 |
|---|---|---|---|---|---|---|---|---|---|
| SiO₂ | 65.0 | 65.4 | 65.0 | 69.4 | 68.0 | 69.0 | 68.0 | 68.0 | 65.0 |
| Al₂O₃ | 7.0 | 7.0 | 7.0 | 6.0 | 6.0 | 6.0 | 5.0 | 9.0 | 7.0 |
| MgO | | 2.0 | 2.5 | | | 3.0 | 1.8 | | 2.0 |
| CaO | | | | 3.0 | | | | | |
| BaO | 8.9 | 8.5 | | 6.0 | 9.0 | | 8.9 | | 9.0 |
| SrO | 3.0 | | 8.0 | | | 5.0 | | 7.5 | |
| ZnO | 2.5 | 2.6 | | 1.1 | 1.5 | 2.6 | | 2.0 | 2.6 |
| Li₂O | 5.0 | 6.0 | 6.0 | 6.0 | 8.0 | 6.0 | 6.0 | 7.5 | 4.0 |
| K₂O | 3.0 | 2.0 | 2.0 | 2.0 | | 2.0 | 2.0 | 0.5 | 2.0 |
| TiO₂ | | | 3.0 | | | | 3.0 | | |
| ZrO₂ | 3.0 | 4.0 | 3.0 | 3.0 | 2.0 | 3.0 | 3.0 | 3.0 | 3.0 |
| P₂O₅ | 2.0 | 2.0 | 2.0 | 2.0 | 1.0 | 2.0 | 2.0 | 2.0 | 2.0 |
| Y₂O₃ | 0.1 | 0.5 | 1.0 | 1.5 | 5.0 | 1.0 | 0.1 | 0.5 | 3.0 |
| Nb₂O₅ | | | | | | | | | |
| Ta₂O₅ | | | | | | | | | |
| La₂O₃ | | | | | | | | | |
| Sb₂O₃ | 0.5 | | 0.5 | | 0.5 | 0.4 | 0.2 | | 0.4 |
| Total(100 wt %) | 100.0 | 100.0 | 100.0 | 100.0 | 101.0 | 100.0 | 100.0 | 100.0 | 100.0 |
| Melting | 1550 | 1550 | 1550 | 1550 | 1550 | 1550 | 1550 | 1550 | 1550 |
| Temperature??? | | | | | | | | | |
| MeltingTime?hr? | 3 | 3 | 3 | 3 | 3 | 3 | 3 | 3 | 3 |
| Nucleating | 580 | 580 | 580 | 580 | 580 | 580 | 580 | 580 | 580 |
| Temperature??? | | | | | | | | | |
| Nucleating Time?hr? | 5 | 5 | 5 | 5 | 5 | 5 | 5 | 5 | 5 |
| Nucleous Growing | 700 | 700 | 700 | 700 | 700 | 700 | 700 | 700 | 700 |
| Temperature??? | | | | | | | | | |
| Nucleous Growing | 2 | 2 | 2 | 2 | 2 | 2 | 2 | 2 | 2 |
| Time?hr? | | | | | | | | | |
| Main Crystalline Phase | Crist.ss | Crist | Crist | a-Q | a-Q.ss | Crist | a-Q | Crist | Crist |
| Sub Crystalline Phase | — | — | — | — | LAS | LZS | LAS | LZS | — |
| Specific Gravity?g/cm³ | 2.50 | 2.54 | 2.54 | 2.65 | 2.67 | 2.57 | 2.61 | 2.58 | 2.57 |
| Yong's Modulus E??Pa | 77.8 | 76.7 | 76.9 | 84.7 | 84.0 | 79.6 | 84.1 | 78.3 | 77.7 |
| Elastic Modulus Ratio | 31.1 | 30.2 | 30.3 | 32.0 | 31.5 | 31.0 | 32.2 | 30.3 | 30.2 |
| C.T.E | 101 | 103 | 117 | 137 | 90 | 97 | 82 | 95 | 97 |
| Amount of Migration of | 40 | 35 | 50 | 60 | 85 | 80 | 90 | 80 | 85 |
| alkali metal [ppb] | | | | | | | | | |
| P/Pli | 1.2 | 1.2 | 1.4 | 1.2 | 1.1 | 1.2 | 1.2 | 1.2 | 1.3 |

TABLE 172

| | C-382 | C-383 | C-384 | C-385 | C-386 | C-387 | C-388 | C-389 | C-390 |
|---|---|---|---|---|---|---|---|---|---|
| SiO₂ | 68.0 | 66.5 | 67.0 | 68.0 | 68.0 | 65.0 | 65.0 | 68.0 | 65.0 |
| Al₂O₃ | 6.0 | 7.0 | 7.4 | 6.0 | 7.0 | 7.0 | 7.0 | 6.0 | 5.5 |
| MgO | | | 2.0 | 0.5 | | | | | 1.0 |
| CaO | | | | | 1.0 | | | | |
| BaO | 4.5 | 7.0 | | 7.4 | 6.0 | 9.0 | | 8.0 | 5.5 |
| SrO | 6.0 | | 6.0 | | | | 8.0 | | 2.5 |
| ZnO | | 3.0 | 2.0 | 5.0 | 2.0 | 2.5 | 2.5 | | 2.5 |
| Li₂O | 8.0 | 6.0 | 6.0 | 6.0 | 6.0 | 6.0 | 6.0 | 6.0 | 6.0 |
| K₂O | | 2.0 | 2.0 | 2.0 | 2.0 | 2.0 | 2.0 | 2.0 | 2.0 |
| TiO₂ | 1.0 | | | | 2.0 | | | | |
| ZrO₂ | 3.0 | 1.5 | 4.5 | 4.0 | 2.0 | 3.0 | 3.0 | 3.0 | 3.0 |
| P₂O₅ | 2.0 | 2.0 | 1.1 | 1.0 | 3.0 | 2.0 | 2.0 | 2.0 | 2.0 |
| Y₂O₃ | 1.5 | 3.0 | 1.0 | 0.1 | 0.5 | 3.0 | 0.5 | 1.0 | 2.0 |
| Nb₂O₅ | | | | | | | 3.5 | | |
| Ta₂O₅ | | | | | | | | 4.0 | |
| La₂O₃ | | | | | | | | | 3.0 |
| Sb₂O₃ | | 2.0 | 1.0 | | 0.5 | 0.5 | 0.5 | | |
| Total(100 wt %) | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 |
| Temperature??? | | | | | | | | | |
| MeltingTime?hr? | 3 | 3 | 3 | 3 | 3 | 3 | 3 | 3 | 3 |
| Nucleating | 580 | 580 | 580 | 580 | 580 | 580 | 580 | 580 | 580 |
| Temperature??? | | | | | | | | | |
| Nucleating Time?hr? | 5 | 5 | 5 | 5 | 5 | 5 | 5 | 5 | 5 |
| Nucleous Growing | 700 | 700 | 700 | 700 | 700 | 700 | 700 | 700 | 700 |
| Temperature??? | | | | | | | | | |
| Nucleous Growing | 2 | 2 | 2 | 2 | 2 | 2 | 2 | 2 | 2 |
| Time?hr? | | | | | | | | | |
| Main Crystalline Phase | Crist | Crist | Crist | Crist | a-Q | Crist | Crist | Crist | Crist |
| Sub Crystalline Phase | LAS | LZS | — | LZS | — | — | — | LAS | — |
| Specific Gravity?g/cm³ | 2.60 | 2.65 | 2.53 | 2.56 | 2.55 | 2.50 | 2.66 | 2.68 | 2.66 |
| Yong's Modulus E??Pa | 80.0 | 81.2 | 76.9 | 79.0 | 82.7 | 79.0 | 79.8 | 80.5 | 80.5 |
| Elastic Modulus Ratio | 30.8 | 30.6 | 30.4 | 30.9 | 32.4 | 31.6 | 30.0 | 30.0 | 30.3 |
| C.T.E | 83 | 81 | 115 | 84 | 128 | 96 | 105 | 87 | 92 |
| Amount of Migration of | 80 | 50 | 40 | 75 | 65 | 40 | 60 | 85 | 60 |
| alkali metal [ppb] | | | | | | | | | |
| P/Pli | 1.2 | 1.3 | 1.4 | 1.2 | 1.2 | 1.2 | 1.2 | 1.3 | 1.2 |

TABLE 173

| | C-391 | C-392 | C-393 | C-394 | C-395 | C-396 | C-397 | C-398 | C-399 |
|---|---|---|---|---|---|---|---|---|---|
| SiO₂ | 65.0 | 65.4 | 65.0 | 69.4 | 68.0 | 69.0 | 68.0 | 68.0 | 65.0 |
| Al₂O₃ | 7.0 | 7.0 | 7.0 | 6.0 | 6.0 | 6.0 | 5.0 | 9.0 | 7.0 |
| MgO | | 2.0 | 2.5 | | | 3.0 | 1.8 | | 2.0 |
| CaO | | | | 3.0 | | | | | |
| BaO | 8.9 | 8.5 | | 6.0 | 9.0 | | 8.9 | | 9.0 |
| SrO | 3.0 | | 8.0 | | | 5.0 | | 7.5 | |
| ZnO | 2.5 | 2.6 | | 1.1 | 1.5 | 2.6 | | 2.0 | 2.6 |
| Li₂O | 5.0 | 6.0 | 6.0 | 6.0 | 8.0 | 6.0 | 6.0 | 7.5 | 4.0 |
| K₂O | 3.0 | 2.0 | 2.0 | 2.0 | | 2.0 | 2.0 | 0.5 | 2.0 |
| TiO₂ | | | 3.0 | | | | 3.0 | | |
| ZrO₂ | 3.0 | 4.0 | 3.0 | 3.0 | 2.0 | 3.0 | 3.0 | 3.0 | 3.0 |
| P₂O₅ | 2.0 | 2.0 | 2.0 | 2.0 | 1.0 | 2.0 | 2.0 | 2.0 | 2.0 |
| Y₂O₃ | 0.1 | 0.5 | 1.0 | 1.5 | 5.0 | 1.0 | 0.1 | 0.5 | 3.0 |
| Nb₂O₅ | | | | | | | | | |
| Ta₂O₅ | | | | | | | | | |
| La₂O₃ | | | | | | | | | |
| Sb₂O₃ | 0.5 | | 0.5 | | 0.5 | 0.4 | 0.2 | | 0.4 |
| Total(100 wt %) | 100.0 | 100.0 | 100.0 | 100.0 | 101.0 | 100.0 | 100.0 | 100.0 | 100.0 |
| Melting | 1550 | 1550 | 1550 | 1550 | 1550 | 1550 | 1550 | 1550 | 1550 |
| Temperature??? | | | | | | | | | |
| MeltingTime?hr? | 3 | 3 | 3 | 3 | 3 | 3 | 3 | 3 | 3 |
| Nucleating | 580 | 580 | 580 | 580 | 580 | 580 | 580 | 580 | 580 |
| Temperature??? | | | | | | | | | |
| Nucleating Time?hr? | 5 | 5 | 5 | 5 | 5 | 5 | 5 | 5 | 5 |
| Nucleous Growing | 680 | 680 | 680 | 680 | 680 | 680 | 680 | 680 | 680 |
| Temperature??? | | | | | | | | | |
| Nucleous Growing | 5 | 5 | 5 | 5 | 5 | 5 | 5 | 5 | 5 |
| Time?hr? | | | | | | | | | |
| Main Crystalline Phase | Crist.ss | Crist | Crist | a-Q | a-Q.ss | Crist | a-Q | Crist | Crist |
| Sub Crystalline Phase | — | — | — | — | LAS | LZS | LAS | LZS | — |
| Specific Gravity?g/cm³ | 2.52 | 2.56 | 2.56 | 2.67 | 2.69 | 2.59 | 2.63 | 2.60 | 2.59 |
| Yong's Modulus E??Pa | 78.1 | 77.0 | 77.2 | 85.0 | 84.3 | 79.9 | 84.4 | 78.6 | 78.0 |
| Elastic Modulus Ratio | 31.0 | 30.1 | 30.2 | 31.8 | 31.3 | 30.8 | 32.1 | 30.2 | 30.1 |
| C.T.E | 106 | 108 | 122 | 142 | 95 | 102 | 85 | 100 | 102 |
| Amount of Migration of | 80 | 35 | 50 | 60 | 85 | 80 | 90 | 80 | 85 |
| alkali metal [ppb] | | | | | | | | | |
| P/Pli | 1.2 | 1.2 | 1.4 | 1.2 | 1.1 | 1.2 | 1.2 | 1.2 | 1.3 |

TABLE 174

| | C-400 | C-401 | C-402 | C-403 | C-404 | C-405 | C-406 | C-407 | C-408 |
|---|---|---|---|---|---|---|---|---|---|
| SiO₂ | 68.0 | 66.5 | 67.0 | 68.0 | 68.0 | 65.0 | 65.0 | 68.0 | 65.0 |
| Al₂O₃ | 6.0 | 7.0 | 7.4 | 6.0 | 7.0 | 7.0 | 7.0 | 6.0 | 5.5 |
| MgO | | | 2.0 | 0.5 | | | | | 1.0 |
| CaO | | | | | 1.0 | | | | |
| BaO | 4.5 | 7.0 | | 7.4 | 6.0 | 9.0 | | 8.0 | 5.5 |
| SrO | 6.0 | | 6.0 | | | | 8.0 | | 2.5 |
| ZnO | | 3.0 | 2.0 | 5.0 | 2.0 | 2.5 | 2.5 | | 2.5 |
| Li₂O | 8.0 | 6.0 | 6.0 | 6.0 | 6.0 | 6.0 | 6.0 | 6.0 | 6.0 |
| K₂O | | 2.0 | 2.0 | 2.0 | 2.0 | 2.0 | 2.0 | 2.0 | 2.0 |
| TiO₂ | 1.0 | | | | 2.0 | | | | |
| ZrO₂ | 3.0 | 1.5 | 4.5 | 4.0 | 2.0 | 3.0 | 3.0 | 3.0 | 3.0 |
| P₂O₅ | 2.0 | 2.0 | 1.1 | 1.0 | 3.0 | 2.0 | 2.0 | 2.0 | 2.0 |
| Y₂O₃ | 1.5 | 3.0 | 1.0 | 0.1 | 0.5 | 3.0 | 0.5 | 1.0 | 2.0 |
| Nb₂O₅ | | | | | | | 3.5 | | |
| Ta₂O₅ | | | | | | | | 4.0 | |
| La₂O₃ | | | | | | | | | 3.0 |
| Sb₂O₃ | | 2.0 | 1.0 | | 0.5 | 0.5 | 0.5 | | |
| Total(100 wt %) | 100.0 | 100.0 | 100.0 | 100.0 | 100.0 | 100.0 | 100.0 | 100.0 | 100.0 |
| Melting | 1550 | 1550 | 1550 | 1550 | 1550 | 1550 | 1550 | 1550 | 1550 |
| Temperature??? | | | | | | | | | |
| MeltingTime?hr? | 3 | 3 | 3 | 3 | 3 | 3 | 3 | 3 | 3 |
| Nucleating | 580 | 580 | 580 | 580 | 580 | 580 | 580 | 580 | 580 |
| Temperature??? | | | | | | | | | |
| Nucleating Time?hr? | 5 | 5 | 5 | 5 | 5 | 5 | 5 | 5 | 5 |
| Nucleous Growing | 680 | 680 | 680 | 680 | 680 | 680 | 680 | 680 | 680 |
| Temperature??? | | | | | | | | | |
| Nucleous Growing | 5 | 5 | 5 | 5 | 5 | 5 | 5 | 5 | 5 |
| Time?hr? | | | | | | | | | |
| Main Crystalline Phase | Crist | Crist | Crist | Crist | a-Q | Crist | Crist | Crist | Crist |
| Sub Crystalline Phase | LAS | LZS | — | LZS | — | — | — | LAS | — |
| Specific Gravity?g/cm³ | 2.62 | 2.67 | 2.55 | 2.58 | 2.57 | 2.52 | 2.68 | 2.70 | 2.68 |
| Yong's Modulus E??Pa | 80.3 | 81.5 | 77.2 | 79.3 | 83.0 | 79.3 | 80.1 | 80.8 | 80.8 |
| Elastic Modulus Ratio | 30.6 | 30.5 | 30.3 | 30.7 | 32.3 | 31.5 | 29.9 | 29.9 | 30.1 |
| C.T.E | 86 | 85 | 120 | 89 | 133 | 101 | 110 | 92 | 97 |
| Amount of Migration of | 80 | 50 | 40 | 75 | 65 | 40 | 60 | 85 | 60 |
| alkali metal [ppb] | | | | | | | | | |
| P/Pli | 1.2 | 1.3 | 1.4 | 1.2 | 1.2 | 1.2 | 1.2 | 1.3 | 1.2 |

[Comparative Sample]

The following Table shows a prior art crystallized glass substrate having a lithium disilicate-type crystal as a predominant crystalline phase, as a comparative Sample.

TABLE 174

| | Comarative |
|---|---|
| | Sample |
| SiO₂ | 75.0 |
| Al₂O₃ | 7.5 |
| MgO | |
| CaO | |
| BaO | |
| SrO | |
| ZnO | 0.5 |
| Li₂O | 10.0 |
| K₂O | 2.0 |
| TiO₂ | |
| ZrO₂ | 1.5 |
| P₂O₅ | 2.0 |
| Y₂O₃ | |
| Nb₂O₅ | |
| Ta₂O₅ | |
| La₂O₃ | |
| Sb₂O₃ | 0.5 |
| Total (100 wt %) | 100.0 |
| Melting Temperature??? | 1550 |
| Melting Time?hr? | 3 |
| Nucleating Temperature??? | 550 |
| Nucleating Time?hr? | 5 |
| Nucleous Growing Temperature??? | 740 |
| Nucleous Growing Time?hr? | 3 |
| Main Crystalline Phase | L-2S |
| Sub Crystalline Phase | Quartz |
| Specific Gravity?g/cm³ | 2.50 |
| Yong's Modulus E??Pa | 92.0 |
| Elastic Modulus Ratio | 30.8 |
| C.T.E | 90 |
| Amount of Migration of alkali metal [ppb] | 350 |
| P/Pli | 1.0 |

As has been described in detail, the present invention has made it possible to provide a crystallized glass substrate which has a high thermal C-pansion coefficient and satisfactory workability while causing less corrosion due to its alkali metal components.

Although the present invention has been fully described by way of C-ample with reference to the accompanying drawings, it is to be understood that various changes and modifications will be apparent to those skilled in the art. Therefore, unless otherwise such changes and modification depart from the scope of the present invention, they should be construed as being included therein.

What is claimed is:

1. A polished glass disk medium substrate which satisfies following conditional formulas (1) and (2):
0<Co<150 (1)
70<C.T.E<150 (2)
where Co represents the amount [ppb] of migration of alkali metal components with respect to water per substrate for a 2.5-inch disk [ppb], and C.T.E represents a thermal expansion coefficient [×10⁻⁷/?] at 25? to 100?.

2. A polished glass disk medium substrate as claimed in claim 1, the substrate formed of a mixture of glass forming raw materials comprising:
about 65% to about 70% by weight SiO₂;
about 3% to about 10% by weight Al₂O₃;
about 3% to about 10% by weight ZnO:
about 4% to about 8% by weight Li₂O;
about 1% to about 5% by weight ZrO₂; and
about 1% to about 5% by weight P₂O₅.

3. A polished glass disk medium substrate as claimed in claim 2, wherein the substrate satisfies following conditional formula (1)′:
30<Co<100 (1)′

4. A polished glass disk medium substrate as claimed in claim 2, wherein the substrate satisfies following conditional formula (2)′:
70<C.T.E<120 (2)′

5. A polished glass disk medium substrate as claimed in claim 1, the substrate formed of a mixture of glass forming raw materials comprising:
about 55% to about 65% by weight SiO₂:
about 3% to about 10% by weight Al₂O₃;
about 5% to about 20% by weight ZnO;
about 4% to about 8% by weight Li₂O;
about 1% to about 5% by weight ZrO₂; and
about 1% to about 5% by weight P₂O₅.

6. A polished glass disk medium substrate as claimed in claim 5, wherein the substrate satisfies following conditional formula (1)′:
70<Co<150 (1)′

7. A polished glass disk medium substrate as claimed in claim 5, wherein the substrate satisfies following conditional formula (2)′:
60<C.T.E<100 (2)′

8. A polished glass disk medium substrate as claimed in claim 1, the substrate formed of a mixture of glass forming raw materials comprising:
about 65% to about 70% by weight SiO₂,
about 5% to about 10% by weight Al₂O₃;
about 4% to about 8% by weight Li₂O;
about 1% to about 5% by weight ZrO₂; and
about 1% to about 3% by weight P₂O₅.

9. A polished glass disk medium substrate as claimed in claim 8, wherein the substrate satisfies following conditional formula (1)′:
30<Co<100 (1)′

10. A polished glass disk medium substrate as claimed in claim 8, wherein the substrate satisfies following conditional formula (2)′:
80<C.T.E<150 (2)′

11. A polished glass mediurn substrate as claimed in claim 1, wherein a main crystalline phase of the substrate is at least one phase selected from christbalite, christbalite solid solution, α-quartz, α-quartz solid solution, lithium aluminosilicate, lithium aluminosilicate solid solution, lithium zinc silicate and lithium zinc silicate solid solution.

12. A polished glass medium substrate as claimed in claim 1, wherein a secondary crystalline phase of the substrate is at least one phase selected from christbalite, christbalite solid solution, α-quartz, α-quartz solid solution, lithium aluminosilicate, lithium aluminosilicate solid solution, lithium zinc silicate and lithium zinc silicate solid solution.

13. A recording medium comprising the polished glass disk medium substrate defined in claim 1.

14. A polished glass disk medium substrate which satisfies following conditional formulas (1) and (3)
0<Co<150 (1)
1.0<P/PLi<1.5 (3)
where where Co represents the amount [ppb] of migration of alkali metal components with respect to water per substrate for a 2.5-inch disk [ppb], and P represents the amount of a loss [ig/min] per unit time resulting from grinding or abrading when the substrate is abraded using cerium oxide (average particle diameter: 0.5 ìm) as an abrasive under a pressure of 100 g/cm² to attain a surface smoothness of 3 Å; and PLi represents the amount of a loss [ìg/min] per unit time resulting from grinding or abrading when a lithium disilicate-type crystallized glass substrate is ground or abraded under the same conditions as above to attain a surface smoothness of 3.

15. A polished glass disk medium substrate as claimed in claim 14, the substrate formed of a mixture of glass forming raw materials comprising:
about 65% to about 70% by weight SiO₂;
about 3% to about 10% by weight Al₂O₃;
about 3% to about 10% by weight ZnO;
about 4% to about 8% by weight Li₂O;
about 1% to about 5% by weight ZrO₂: and
about 1% to about 5% by weight P₂O₅.

16. A polished glass disk medium substrate as claimed in claim 15, wherein the substrate satisfies following conditional formula (1)′:
30<Co<100 (1)′

17. A polished glass disk medium substrate as claimed in claim 15, wherein the substrate satisfies following conditional formula (2)′:
70<C.T.E<120 (2)′

18. A polished glass disk medium substrate as claimed in claim 14, the substrate formed of a mixture of glass forming raw materials comprising:
about 55% to about 65% by weight SiO₂;
about 3% to about 10% by weight Al₂O₃;
about 5% to about 20% by weight ZnO;
about 4% to about 8% by weight Li₂O;
about 1% to about 5% by weight ZrO₂; and
about 1% to about 5% by weight P₂O₅.

19. A polished glass disk medium substrate as claimed in claim 18, wherein the substrate satisfies following conditional formula (1)′:
70<Co 150 (1)′

20. A polished glass disk medium substrate as claimed in claim 18, wherein the substrate satisfies following conditional formula (2)′:
60<C.T.E<100 (2)′

21. A polished glass disk medium substrate as claimed in claim 14, the substrate formed of a mixture of glass forming raw materials comprising:
about 65% to about 70% by weight SiO₂;
about 5% to about 10% by weight Al₂O₃;
about 4% to about 8% by weight Li₂O;
about 1% to about 5% by weight ZrO₂; and
about 1% to about 3% by weight P₂O₅.

22. A polished glass disk medium substrate as claimed in claim 21, wherein the substrate satisfies following conditional formula (1)′:
30<Co<100 (1)′

23. A polished glass disk medium substrate as claimed in claim 21, wherein the substrate satisfies following conditional formula (2)′:
80<C.T.E<150 (2)′

24. A polished glass medium substrate as claimed in claim 14, wherein a main crystalline phase of the substrate is at least one phase selected from christbalite, christbalite solid solution, α-quartz, α-quartz solid solution, lithium aluminosilicate, lithium aluminosilicate solid solution, lithium zinc silicate and lithium zinc silicate solid solution.

25. A polished glass medium substrate as claimed in claim 14, wherein a secondary crystalline phase of the substrate is at least one phase selected from christbalite, christbalite solid solution, α-quartz, α-quartz solid solution, lithium aluminosilicate, lithium aluminosilicate solid solution, lithium zinc silicate and lithium zinc silicate solid solution.

26. A recording medium comprising the polished glass disk medium substrate defined in claim 14.

27. A polished glass disk medium substrate which satisfies following conditional formulas (1) and (3)
0<Co<150 (1)
28<E/ñ<36 (4)
where Co represents the amount [ppb] of migration of alkali metal components with respect to water per substrate for a 2.5-inch disk [ppb], and E represents the Young's modulus [GPa] of the substrate, and ñ represents the specific gravity of the substrate.

28. A polished glass disk medium substrate as claimed in claim 27, the substrate formed of a mixture of glass forming raw materials comprising:
about 65% to about 70% by weight SiO₂;
about 3% to about 10% by weight Al₂O₃;
about 3% to about 10% by weight ZnO;
about 4% to about 8% by weight Li₂O;
about 1% to about 5% by weight ZrO₂; and
about 1% to about 5% by weight P₂O₅.

29. A polished glass disk medium substrate as claimed in claim 28, wherein the substrate satisfies following conditional formula (1)′:
30<Co<100 (I)′

30. A polished glass disk medium substrate as claimed in claim 28, wherein the substrate satisfies following conditional formula (2)′:
70<C.T.E<120 (2)′

31. A polished glass disk medium substrate as claimed in claim 27, the substrate formed of a mixture of glass forming raw materials comprising:
about 55% to about 65% by weight SiO₂,
about 3% to about 10% by weight Ai₂O₃;
about 5% to about 20% by weight ZnO;
about 4% to about 8% by weight Li₂O;
about 1% to about 5% by weight ZrO₂; and
about 1% to about 5% by weight P₂O₅.

32. A polished glass disk medium substrate as claimed in claim 31, wherein the substrate satisfies following conditional formula (1)′:
70<Co<150 (1)′

33. A polished glass disk medium substrate as claimed in claim 31, wherein the substrate satisfies following conditional formula (2)′:
60<C.T.E<100 (2)′

34. A polished glass disk medium substrate as claimed in claim 27, the substrate formed of a mixture of glass forming raw materials comprising:
about 65% to about 70% by weight SiO₂;
about 5% to about 10% by weight Al₂O₃;
about 4% to about 8% by weight Li₂O;
about 1% to about 5% by weight ZrO₂; and
about 1% to about 3% by weight P₂O₅.

35. A polished glass disk medium substrate as claimed in claim 34, wherein the substrate satisfies following conditional formula (1)′:
30<Co<100 (1)′

36. A polished glass disk medium substrate as claimed in claim 34, wherein the substrate satisfies following conditional formula (2)′:
80<C.T.E<150 (2)′

37. A polished glass medium substrate as claimed in claim 27, wherein a main crystalline phase of the substrate is at least one phase selected from christbalite, christbalite solid solution, α-quartz, α-quartz solid solution, lithium aluminosilicate, lithium aluminosilicate solid solution, lithium Zinc silicate and lithium zinc silicate solid solution.

38. A polished glass medium substrate as claimed in claim 27, wherein a secondary crystalline phase of the substrate is at least one phase selected from christbalite, christbalite solid solution, α-quartz, α-quartz solid solution, lithium aluminosilicate, lithium aluminosilicate solid solution, lithium zinc silicate and lithium zinc silicate solid solution.

39. A recording medium comprising the polished glass disk medium substrate defined in claim 27.
